(19) United States
(12) Patent Application Publication
(10) Pub. No.: US 2025/0215263 A1
(43) Pub. Date: Jul. 3, 2025

(54) COMPOSITE POLYMERIC MATERIALS, AND PRODUCTS AND METHODS OF PREPARING THE SAME

(71) Applicant: EVOLVED BY NATURE, INC., Needham, MA (US)

(72) Inventors: Enrico Mortarino, Hickory, NC (US); Jason Cox, Needham, MA (US); Sara Ann Johnson, Cambridge, MA (US); Murat Tonga, Needham, MA (US); Ziyang Zhang, Arlington, MA (US); Lam Tran, Needham, MA (US); Joshua Davis

(21) Appl. No.: 18/843,036

(22) PCT Filed: Mar. 2, 2023
(86) PCT No.: PCT/US2023/063629

§ 371 Date: Aug. 30, 2024

Related U.S. Application Data
(60) Provisional application No. 63/315,945, filed on Mar. 2, 2022.
(60) Provisional application No. 63/355,412, filed on Jun. 24, 2022.
(60) Provisional application No. 63/376,219, filed on Sep. 19, 2022.
(60) Provisional application No. 63/376,224, filed on Sep. 19, 2022.
(60) Provisional application No. 63/376,229, filed on Sep. 19, 2022.
(60) Provisional application No. 63/383,196, filed on Nov. 10, 2022.
(60) Provisional application No. 63/479,947, filed on Jan. 13, 2023.

(51) Int. Cl. C09D 189/00; C09D 7/20; C09D 7/65; C09D 167/04; C09D 175/04; C09J 11/08; C09J 167/04; C09J 175/04; C09J 189/00; C14C 11/00

(52) U.S. Cl. CPC C09D 189/00; C09D 7/20; C09D 7/65; C09D 167/04; C09D 175/04; C09J 11/08; C09J 167/04; C09J 175/04; C09J 189/00; C14C 11/003

(57) ABSTRACT

The disclosure provides leather articles and a method for making leather articles comprising a substrate and a coating comprising a cellulose derivative having improved colorfastness to rubbing. The cellulose derivative may be methyl cellulose, ethyl cellulose, ethyl methyl cellulose, carboxymethyl cellulose, hydroxyethyl cellulose, hydroxypropyl cellulose, hydroxyethyl methyl cellulose, hydroxypropyl methyl cellulose, ethyl hydroxyethyl cellulose, cellulose acetate, cellulose triacetate, cellulose propionate, cellulose acetate propionate, cellulose acetate butyrate, microcrystalline cellulose, cellulose nitrate, or cellulose sulfate.

### CROSS REFERENCE TO RELATED APPLICATIONS

This application claims priority to and claims the benefit of U.S. Provisional Application No. 63/315,945, filed Mar. 2, 2022, U.S. Provisional Application No. 63/355,412, filed Jun. 24, 2022, U.S. Provisional Application No. 63/376,219, filed Sep. 19, 2022, U.S. Provisional Application No. 63/376,224, filed Sep. 19, 2022, U.S. Provisional Application No. 63/376,229, filed Sep. 19, 2022, U.S. Provisional Application No. 63/383,196, filed Nov. 10, 2022, and U.S. Provisional Application No. 63/479,947, filed Jan. 13, 2023. The contents of each of these applications are incorporated herein by reference in their entireties.

### FIELD

The disclosure relates to composite polymeric materials, including in part a cellulose-derivative coating composition, optionally including silk fibroin proteins or fragments thereof and various additional agents, for coating various substrates.

### BACKGROUND

Silk is a natural polymer produced by a variety of insects and spiders, and comprises a filament core protein, silk fibroin, and a glue-like coating consisting of a non-filamentous protein, sericin. Silk fibers are lightweight, breathable, and hypoallergenic.

### SUMMARY

The disclosure provides an article comprising one or more surfaces coated with: silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5; and one or more components selected from a cellulose derivative, a plasticizer, and a crosslinker. In some embodiments, the cellulose derivative is selected from methyl cellulose, ethyl cellulose, carboxymethyl cellulose, hydroxyethyl cellulose, hydroxypropyl cellulose, cellulose acetate, cellulose acetate propionate, cellulose acetate butyrate, and microcrystalline cellulose. In some embodiments, the plasticizer is selected from triethyl citrate, dibutyl sebacate, triacetin, glycerol, 1,3-propanediol, propylene glycol, pentylene glycol, epoxidized vegetable oils, isosorbide esters, succinic acid derivatives, and acetic acid ester of monoglycerides. In some embodiments, the crosslinker is selected from polyisocyanates, polycarbodiimides, polyaziridines, polyureas, glutaraldehyde, and starch dialdehyde. In some embodiments, the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5. In some embodiments, the composition further comprises about 0.001% (w/w) to about 10% (w/w) sericin relative to the silk fibroin proteins or fragments thereof. In some embodiments, the silk fibroin proteins or fragments thereof do not spontaneously or gradually gelate and do not visibly change in color or turbidity when in an aqueous solution for at least 10 days prior to being added to the article. In some embodiments, a portion of the silk fibroin proteins or fragments thereof is coated on a surface of the leather substrate. In some embodiments, a portion of the silk fibroin proteins or fragments thereof is infused into a layer of the leather substrate. In some embodiments, a portion of the silk fibroin proteins or fragments thereof is in a recessed portion of the leather substrate. In some embodiments, the article further comprises one or more polysaccharides selected from starch, cellulose, gum arabic, guar gum, xanthan gum, alginate, pectin, chitin, chitosan, carrageenan, inulin, and gellan gum. In some embodiments, the gellan gum comprises low-acyl content gellan gum. In some embodiments, the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5. In some embodiments, the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1. In some embodiments, the article further comprises one or more polyols, and/or one or more polyethers. In some embodiments, the polyols comprise one or more of glycol, glycerol, sorbitol, D-sorbitol, glucose, sucrose, mannitol, D-mannitol, and dextrose. In some embodiments, the polyethers comprise one or more polyethyleneglycols (PEGs). In some embodiments, the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1. about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5. In some embodiments, the article further comprises one or more of a silicone, a dye, a pigment, and a polyurethane. In some embodiments, the article further comprises one or more of a crosslinker, a crosslinker adduct, or a crosslinker reaction derivative. In some embodiments, the article further comprises one or more of: an isocyanate, isocyanate adduct, and/or isocyanate reaction derivative; a poly diisocyanate, poly diisocyanate adduct, and/or poly diisocyanate reaction derivative; an aziridine, aziridine adduct, and/or aziridine reaction derivative; a carbodiimide, carbodiimide adduct, and/or carbodiimide reaction derivative; an aldehyde, aldehyde adduct, and/or aldehyde reaction derivative; a polyisocyanate, polyisocyanate adduct, and/or polyisocyanate reaction derivative; a polyaziridine, polyaziridine adduct, and/or polyaziridine reaction derivative; a polycarbodiimide, polycarbodiimide adduct, and/or polycarbodiimide reaction derivative; a polyaldehyde, polyaldehyde adduct, and/or polyaldehyde reaction derivative; a polyurethane, polyurethane adduct, and/or polyurethane reaction derivative; a polyacrylate, polyacrylate adduct, and/or polyacrylate reaction derivative; a polyester, polyester adduct, and/or polyester reaction derivative; a wax, wax adduct, and/or wax reaction derivative; a protein, protein adduct, and/or protein reaction derivative; or an alcohol, alcohol adduct, and/or alcohol reaction derivative.

In some embodiments, the one or more surfaces of the article have a higher colorfastness to rubbing than one or more surfaces of a similar article not similarly coated. In some embodiments, the article comprises leather.

The disclosure also provides a method of coating one or more surfaces of an article, the method comprising: applying a first composition comprising silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5, and applying a second composition comprising one or more components selected from a cellulose derivative and a plasticizer. In some embodiments, the first composition further comprises a crosslinker. In some embodiments, the crosslinker is selected from polyisocyanates, polycarbodiimides, polyaziridines, polyureas, glutaraldehyde, and starch dialdehyde. In some embodiments, the cellulose derivative is selected from methyl cellulose, ethyl cellulose, carboxymethyl cellulose, hydroxyethyl cellulose, hydroxypropyl cellulose, cellulose acetate, cellulose acetate propionate, cellulose acetate butyrate, and microcrystalline cellulose. In some embodiments, the plasticizer is selected from triethyl citrate, dibutyl sebacate, triacetin, glycerol, 1,3-propanediol, propylene glycol, pentylene glycol, epoxidized vegetable oils, isosorbide esters, succinic acid derivatives, and acetic acid ester of monoglycerides. In some embodiments, the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5. In some embodiments, the first composition further comprises about 0.001% (w/w) to about 10% (w/w) sericin relative to the silk fibroin proteins or fragments thereof. In some embodiments, the silk fibroin proteins or fragments thereof do not spontaneously or gradually gelate and do not visibly change in color or turbidity when in an aqueous solution for at least 10 days prior to being formulated into the composition and applied to one or more surfaces of the article. In some embodiments, the article comprises leather. In some embodiments, a portion of the silk formulation is coated on a surface of the leather substrate, and/or a portion of the silk formulation is infused into a layer of the leather substrate, and/or a portion of the silk formulation enters a recessed portion of the leather substrate. In some embodiments, the silk formulation further comprises a rheology modifier.

In some embodiments, the rheology modifier comprises one or more polysaccharides selected from starch, cellulose, gum arabic, guar gum, xanthan gum, alginate, pectin, chitin, chitosan, carrageenan gum, inulin, and gellan gum. In some embodiments, the gellan gum comprises low-acyl content gellan gum. In some embodiments, the w/w ratio between the silk fibroin proteins or fragments thereof and the rheology modifier in the silk formulation is selected from about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5. In some embodiments, the w/w ratio between the silk fibroin proteins or fragments thereof and the rheology modifier in the silk formulation is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1. In some embodiments, the w/v concentration of the rheology modifier in the silk formulation is between about 0.01% and about 5%, or between about 0.1% and about 1%. In some embodiments, the silk formulation further comprises a plasticizer. In some embodiments, the plasticizer comprises one or more polyols, and/or one or more polyethers. In some embodiments, the polyols are selected from one or more of glycol, glycerol, sorbitol, D-sorbitol, glucose, sucrose, mannitol, mannitol, D-mannitol, and dextrose. In some embodiments, the polyethers are one or more polyethyleneglycols (PEGs). In some embodiments, the w/w ratio between the silk fibroin proteins or fragments thereof and the plasticizer in the silk formulation is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5. In some embodiments, the w/v concentration of the plasticizer in the silk formulation is between about 0.01% and about 10%. In some embodiments, the silk formulation further comprises a defoaming agent at a concentration between about 0.001% and about 1%. In some embodiments, the defoaming agent comprises a silicone. In some embodiments, the silk formulation further comprises one or more of an isocyanate, a poly diisocyanate, an aziridine, a carbodiimide, an aldehyde, a polyisocyanate, a polyaziridine, a polycarbodiimide, a polyaldehyde, a polyurethane, a polyacrylate, a polyester, a wax, a protein, and/or an alcohol. In some embodiments, the silk formulation is a liquid, a gel, a paste, a wax, or a cream. In some embodiments, the silk formulation comprises one or more sub-formulations to be applied at the same time or at different times. In some embodiments, the concentration of silk fibroin proteins or fragments thereof in the silk formulation is between about 0.1% w/v and about 15% w/v. In some embodiments, the concentration of silk fibroin proteins or fragments thereof in the silk formulation is between about 0.5% w/v and about 12% w/v. In some embodiments, the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v. In some embodiments, the concentration of silk fibroin proteins or fragments thereof in the silk formulation is about 3% w/v, about 3.25% w/v, about 3.5% w/v, about 30.75%% w/v, about 4% w/v, about 40.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 90.25% w/v, about 9.5% w/v, about 90.75% w/v, or about 10% w/v. In some embodiments, the concentration of silk fibroin proteins or fragments thereof in the silk formulation is between about 5 mg/mL and about 125 mg/mL. In some embodiments, the concentration of silk fibroin proteins or fragments thereof in the silk formulation is about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL. about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, or about 90 mg/mL. In some embodiments, the method further comprises one or more additional steps selected from dyeing, drying, water annealing, mechanical stretching, trimming, polishing, applying a pigment, applying a colorant, applying an acrylic formulation, applying an urethane formulation, chemical fixing, stamping, applying a silicone finish, providing a Uniflex treatment, and/or providing a Finiflex treatment, wherein the step of applying the silk formulation on a surface of the leather is performed before, during, or after the one or more additional steps. In some embodiments, treating the leather substrate with the silk formulation results in one or more of the following: increase in gloss, increase in color saturation, color enhancement, increase in color fixation, reduced dye use, and/or improved colorfastness. In some embodiments, the improvement is as to a leather substrate not similarly treated with a silk formulation. into the composition and applied to one or more surfaces of the article. In some embodiments, the article comprises leather.

Silk coated leather products and methods of preparing the same are disclosed herein.

Silk and silk protein fragments, and silk and silk protein fragments (SPF) compositions as described herein, may be used to lock in color, as a surface treatment, in place or in addition to of any chemical used during any chemical processing step, to alter appearance, hand, texture, and/or quality of leather.

In some embodiments, silk and silk protein fragments, and silk and silk protein fragments compositions as described herein, may be used for finishing leather, for example to alter the sheen or luster of leather, and/or to achieve finishes such as matte, glossy, mirror, embossed, etc.

In some embodiments, silk and silk protein fragments, and silk and silk protein fragments compositions as described herein, may be used for repairing, masking, or hiding defects in leather or in hides, for example follicle defects, or other mechanical defects, whether superficial, or within the leather or hide.

In some embodiments, silk and silk protein fragments, and silk and silk protein fragments compositions as described herein, may be used to alter and/or improve the appearance of leather, hides, and/or leather products, or to change the grade of leather or hides, and thus to widen the array of applicable market areas for a given leather type.

In some embodiments, silk and silk protein fragments, and silk and silk protein fragments compositions as described herein may be used to improve the hand of leather, for example its feel, or description of softness.

In some embodiments, silk and silk protein fragments, and silk and silk protein fragments compositions as described herein, may be used as a pigment delivery system during the finishing phase, or at any other appropriate process step, to lock in color, adjust final coloration, or alter pigment chemistry or to improve colorant delivery.

In some embodiments, silk and silk protein fragments, and silk and silk protein fragments compositions as described herein, may be used before or after any mechanical processing step typical of leather processing, including, but not limited to, before or after Uniflex treatment, Finiflex treatment, heat stamping treatment, polishing treatment, skin trimming, or drying. In some embodiments, silk and silk protein fragments, and silk and silk protein fragments compositions as described herein, may be used prior to any mechanical process described herein. In some embodiments, silk and silk protein fragments, and silk and silk protein fragments compositions as described herein, may be used during a finishing or dyeing process. In some embodiments, silk and silk protein fragments, and silk and silk protein fragments compositions as described herein, may be used prior to any press treatment described herein In some embodiments, silk and silk protein fragments, and silk and silk protein fragments compositions as described herein, may be used by spraying on leather.

In some embodiments, silk and silk protein fragments, and silk and silk protein fragments compositions as described herein, may be used by stamping on leather.

In some embodiments, silk and silk protein fragments, and silk and silk protein fragments compositions as described herein, may be integrated into and onto leather.

In some embodiments, silk and silk protein fragments, and silk and silk protein fragments compositions as described herein, may be used prior, during, or after a leather processing step, for example a finishing process, in lieu of any chemistry used for stabilizing, altering sheen, luster, color, darkness, tone, finish, hand, weight, etc.

In some embodiments, silk and silk protein fragments, and silk and silk protein fragments compositions as described herein, may be used prior, during, or after a leather processing step, for example a finishing process, in addition to any chemistry used for stabilizing, altering sheen, luster, color, darkness, tone, finish, hand, etc.

In some embodiments, silk and silk protein fragments, and silk and silk protein fragments compositions as described herein, may be used to serve one or more chemical function during the tanning stage up to and through the dyeing stage of leather processing.

In some embodiments, silk and silk protein fragments, and silk and silk protein fragments compositions as described herein, may be used to serve one or more or mechanical function during the tanning stage up to and through the dyeing stage of leather processing.

In some embodiments, silk and silk protein fragments, and silk and silk protein fragments compositions as described herein, may be used to serve one or more functions during the tanning stage up to and through the dyeing stage of leather processing.

In some embodiments, silk and silk protein fragments, and silk and silk protein fragments compositions as described herein, may be used prior, during, or after a leather processing step, for example a finishing process, to alter the contact angle of solvents applied to semi-finished or finished leathers.

In some embodiments, silk and silk protein fragments, and silk and silk protein fragments compositions as described herein, may be used prior, during, or after a leather processing step, for example a finishing process, as a defect filling agent of either pre- or post-dyed skins. In some embodiments, such use includes combination with a pigment, dye, blending agent, softening agent, rheology modifier etc.

In some embodiments, silk and silk protein fragments, and silk and silk protein fragments compositions as described herein, may be used prior to, during, or after any process described herein, and for any purpose described herein, and such use be augmented by the additional use of one or more physicochemical processing treatments, including but not limited to 02 plasma, use of a crosslinking agent, a photo-crosslinking agent, or an ultraviolet treatment.

In some embodiments, silk and silk protein fragments, and/or silk and silk protein fragments compositions as described herein, can be mixed with, or replace classes of materials including, but not limited to, aqueous lacquers, waxes, oils, protein or other binders, fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, dye dispersing agents, acidic dyes, basic dyes, chromium-based or other dyes, and/or colorants.

In some embodiments, the leather preparation process may include the treating of leather with a silk and/or SPF composition described herein. In some embodiments, the silk and/or SPF composition may include one or more chemical agents as described hereinbelow (e.g., silicone, polyurethane, etc.).

In an embodiment, the disclosure provides a method of treating leather with a silk and/or SPF composition described herein, wherein the method may include the steps of: dyeing the leather; mechanically stretching the leather; trimming the leather; polishing the leather; applying (optionally by spray application) a pigment, and/or an acrylic coating to the leather; chemically fixing the leather, stamping the leather, applying a silicone or other finish to the leather; providing a Uniflex treatment to the leather; and/or filling a defect on the surface or within the leather with a silk or SPF composition; wherein one or more of the foregoing steps includes applying the silk and/or SPF composition to the leather before, during, or after the recited steps.

In an embodiment, the disclosure provides a method of treating leather with a silk and/or SPF composition described herein, wherein the method may include the steps of: dyeing the leather, drying the leather; mechanically stretching the leather; trimming the leather; performing a first polish of the leather; applying (optionally by spray application) a colorant, and/or an acrylic to the leather; performing a second polish of the leather, providing a Finiflex treatment to the leather; and/or filling a defect on the surface or within the leather with a silk or SPF composition; wherein one or more of the foregoing steps includes applying the silk composition to the leather before, during, or after the recited steps.

In some embodiments, a silk and/or SPF composition described herein may be applied to leather or a leather article by any of the methods described herein, but also by hand-spraying, spraying using a mechanical spray setup, applying by brush, bath coating, rubbing, wet-mixing, washing, drumming, soaking, extruding, injecting, plastering, roller coating, and/or filling.

In some embodiments, a silk and/or SPF composition described herein may be applied alone, mixed with one or several chemicals (e.g., chemical agents), as one coat or multiple coats at multiple times using varied application methods, to leathers that have or have not been: dyed, chrome-treated, sprayed with: pigment, acrylic, fixation agents, finishing agents, and/or colorants. In some embodiments, a silk and/or SPF composition described herein may be applied to a finished leather or leather article, a mechanically treated leather or leather article, or a drummed leather or leather article. In some embodiments, a silk and/or SPF composition described herein may be applied into a defect of a finished leather or leather article, a mechanically treated leather or leather article, or a drummed leather or leather article.

In some embodiments, a silk and/or SPF composition described herein may be applied to leather or a leather article as a defect filler pre-dyeing and prior to finishing. In some embodiments, a silk and/or SPF composition described herein may be applied to leather or a leather article as a defect filler after dyeing and prior to finishing. In some embodiments, a silk and/or SPF composition described herein may be applied to leather or a leather article as a defect filler after dyeing and after finishing.

In some embodiments, a silk and/or SPF composition described herein may be applied to leather or a leather article as a defect filler, wherein application is by hand. In some embodiments, a silk and/or SPF composition described herein may be applied to leather or a leather article as a defect filler, wherein application is by finger. In some embodiments, a silk and/or SPF composition described herein may be applied to leather or a leather article as a defect filler, wherein application is by using a brush-type applicator. In some embodiments, a silk and/or SPF composition described herein may be applied to leather or a leather article as a defect filler, wherein application is by using a marker-type applicator. In some embodiments, a silk and/or SPF composition described herein may be applied to leather or a leather article as a defect filler, wherein application is by using a pen-type applicator. In some embodiments, a silk and/or SPF composition described herein may be applied to leather or a leather article as a defect filler, wherein application is by using a pipette-type applicator. In some embodiments, a silk and/or SPF composition described herein may be applied to leather or a leather article as a defect filler, wherein application is by using a syringe-type applicator.

In some embodiments, a silk and/or SPF composition described herein may be applied to leather or a leather article as a defect filler, wherein application is by using an eyeliner brush-type applicator and any brush or brush-like applicator. In some embodiments, a silk and/or SPF composition described herein may be applied to leather or a leather article as a defect filler, wherein application is by using a heated stamp device applicator. In some embodiments, a silk and/or SPF composition described herein may be applied to leather or a leather article as a defect filler, wherein application is by using a sponge applicator. In some embodiments, a silk and/or SPF composition described herein may be applied to leather or a leather article as a defect filler, wherein application is by using a roller-coater In some embodiments, a silk and/or SPF composition described herein may be applied to leather or a leather article as a defect filler, wherein application is by “glue-gun”-like applicator.

In some embodiments, a silk and/or SPF composition described herein may be applied as a defect filler to bovine skin leather or leather article. In some embodiments, a silk and/or SPF composition described herein may be applied as a defect filler to sheep skin leather or leather article. In some embodiments, a silk and/or SPF composition described herein may be applied as a defect filler to lamb skin leather or leather article. In some embodiments, a silk and/or SPF composition described herein may be applied as a defect filler to horse skin leather or leather article. In some embodiments, a silk and/or SPF composition described herein may be applied as a defect filler to crocodile skin leather or leather article. In some embodiments, a silk and/or SPF composition described herein may be applied as a defect filler to alligator skin leather or leather article. In some embodiments, a silk and/or SPF composition described herein may be applied as a defect filler to avian skin leather or leather article. In some embodiments, a silk and/or SPF composition described herein may be applied as a defect filler to animal skin leather or leather article. In some embodiments, a silk and/or SPF composition described herein may be applied as a defect filler to split leather or leather article. In some embodiments, a silk and/or SPF composition described herein may be applied as a defect filler to suede leather or leather article. In some embodiments, a silk and/or SPF composition described herein may be applied as a defect filler to wet blue leather or leather article. In some embodiments, a silk and/or SPF composition described herein may be applied as a defect filler to altered leather or leather article. In some embodiments, a silk and/or SPF composition described herein may be applied as a defect filler to aniline leather or leather article. In some embodiments, a silk and/or SPF composition described herein may be applied as a defect filler to bonded leather or leather article. In some embodiments, a silk and/or SPF composition described herein may be applied as a defect filler to brushed leather or leather article. In some embodiments, a silk and/or SPF composition described herein may be applied as a defect filler to buffed leather or leather article. In some embodiments, a silk and/or SPF composition described herein may be applied as a defect filler to Bycast leather or leather article. In some embodiments, a silk and/or SPF composition described herein may be applied as a defect filler to chamois leather or leather article. In some embodiments, a silk and/or SPF composition described herein may be applied as a defect filler to plongé leather or leather article. In some embodiments, a silk and/or SPF composition described herein may be applied as a defect filler to chrome-tanned leather or leather article. In some embodiments, a silk and/or SPF composition described herein may be applied as a defect filler to combination tanned leather or leather article. In some embodiments, a silk and/or SPF composition described herein may be applied as a defect filler to Cordovan leather or leather article. In some embodiments, a silk and/or SPF composition described herein may be applied as a defect filler to corrected grain leather or leather article. In some embodiments, a silk and/or SPF composition described herein may be applied as a defect filler to crockproof leather or leather article. In some embodiments, a silk and/or SPF composition described herein may be applied as a defect filler to drummed leather or leather article. In some embodiments, a silk and/or SPF composition described herein may be applied as a defect filler to embossed leather or leather article. In some embodiments, a silk and/or SPF composition described herein may be applied as a defect filler to enhanced grain leather or leather article. In some embodiments, a silk and/or SPF composition described herein may be applied as a defect filler to grained leather or leather article. In some embodiments, a silk and/or SPF composition described herein may be applied as a defect filler to metallized leather or leather article. In some embodiments, a silk and/or SPF composition described herein may be applied as a defect filler to naked leather or leather article. In some embodiments, a silk and/or SPF composition described herein may be applied as a defect filler to natural grain leather or leather article. In some embodiments, a silk and/or SPF composition described herein may be applied as a defect filler to Nubuck leather or leather article. In some embodiments, a silk and/or SPF composition described herein may be applied as a defect filler to patent leather or leather article. In some embodiments, a silk and/or SPF composition described herein may be applied as a defect filler to pearlized leather or leather article. In some embodiments, a silk and/or SPF composition described herein may be applied as a defect filler to plated leather or leather article. In some embodiments, a silk and/or SPF composition described herein may be applied as a defect filler to printed leather or leather article. In some embodiments, a silk and/or SPF composition described herein may be applied as a defect filler to protected leather or leather article. In some embodiments, a silk and/or SPF composition described herein may be applied as a defect filler to pure aniline leather or leather article. In some embodiments, a silk and/or SPF composition described herein may be applied as a defect filler to tanned/retanned leather or leather article. In some embodiments, a silk and/or SPF composition described herein may be applied as a defect filler to round hand leather or leather article. In some embodiments, a silk and/or SPF composition described herein may be applied as a defect filler to saddle leather or leather article. In some embodiments, a silk and/or SPF composition described herein may be applied as a defect filler to semi-aniline leather or leather article. In some embodiments, a silk and/or SPF composition described herein may be applied as a defect filler to shrunken grain leather or leather article. In some embodiments, a silk and/or SPF composition described herein may be applied as a defect filler to side leather or leather article.

In some embodiments, a silk and/or SPF composition described herein (with or without one or more chemical agents) may be used to treat leather before or after the liming step. In some embodiments, a silk and/or SPF composition described herein (with or without one or more chemical agents) may be used to treat leather before or after the deliming and/or bateing steps. In some embodiments, a silk and/or SPF composition described herein (with or without one or more chemical agents) may be used to treat leather before or after the pickling step. In some embodiments, a silk and/or SPF composition described herein (with or without one or more chemical agents) may be used to treat leather before or after the tanning step. In some embodiments, a silk and/or SPF composition described herein (with or without one or more chemical agents) may be used to treat leather before or after the neutralizing, dyeing, and/or fat liquoring steps. In some embodiments, a silk and/or SPF composition described herein (with or without one or more chemical agents) may be used to treat leather before or after any drying step. In some embodiments, a silk and/or SPF composition described herein (with or without one or more chemical agents) may be used to treat leather before or after the finishing step. In some embodiments, a silk and/or SPF composition described herein (with or without one or more chemical agents) may be used during the finishing step or as part of the finishing step. In some embodiments, a silk and/or SPF composition described herein (with or without one or more chemical agents) may be used in a stand-alone silk and/or SPF treatment step.

In some embodiments, a silk and/or SPF composition described herein (with or without one or more chemical agents) may be used to treat leather during the liming step. In some embodiments, a silk and/or SPF composition described herein (with or without one or more chemical agents) may be used to treat leather during the deliming and/or bateing steps.

In some embodiments, a silk and/or SPF composition described herein (with or without one or more chemical agents) may be used to treat leather during the pickling step. In some embodiments, a silk and/or SPF composition described herein (with or without one or more chemical agents) may be used to treat leather during the tanning step. In some embodiments, a silk and/or SPF composition described herein (with or without one or more chemical agents) may be used to treat leather during the neutralizing, dyeing, and/or fat liquoring steps.

In some embodiments, a silk and/or SPF composition described herein (with or without one or more chemical agents) may be used to treat leather during the drying step. In some embodiments, a silk and/or SPF composition described herein (with or without one or more chemical agents) may be used to treat leather during the finishing step. In some embodiments, a silk and/or SPF composition described herein (with or without one or more chemical agents) may be used during the finishing step or as part of the finishing step.

In some embodiments, a silk and/or SPF composition described herein (with or without one or more chemical agents) may be used to treat leather during a process including one or more steps, for example one or more dyeing steps. In some embodiments, the silk and/or SPF composition can be used prior, during, or after a dyeing step. In some embodiments, a silk and/or SPF composition described herein (with or without one or more chemical agents) may be used to treat leather during a process including one or more steps, for example one or more mechanical processing steps. In some embodiments, the silk and/or SPF composition can be used prior, during, or after a mechanical processing step. Mechanical steps include, but are not limited to drying, polishing, stamping, Uniflex and/or Finiflex, stretching, and/or trimming. In some embodiments, a silk and/or SPF composition described herein (with or without one or more chemical agents) may be used to treat leather during a process including one or more steps, for example one or more polishing steps. In some embodiments, the silk and/or SPF composition can be used prior, during, or after a polishing step. In some embodiments, a silk and/or SPF composition described herein (with or without one or more chemical agents) may be used to treat leather during a process including one or more steps, for example one or more chemical treatment steps. In some embodiments, the silk and/or SPF composition can be used prior, during, or after a chemical treatment step.

Chemical treatment steps include, but are not limited to one or more pigment treatment steps, one or more acrylic, silicone, and/or polyurethane treatment steps, and/or one or more chemical fixation treatment steps.

In an embodiment, a method is provided for processing leather with silk fibroin and/or SPF that may include silk-based proteins or fragments thereof to provide a silk fibroin processed leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w).

In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, processing a surface of the leather material with a silk fibroin solution or composition before, during, or after any processing step. In some embodiments, the method may include, processing a surface of the leather material with a silk fibroin solution or composition before, during, or after pigment delivery.

In some embodiments, the method may include, processing a surface of the leather material with a silk fibroin solution or composition before, during, or after color locking. In some embodiments, the method may include, processing a surface of the leather material with a silk fibroin solution or composition before, during, or after final coloration adjustment. In some embodiments, the method may include, processing a surface of the leather material with a silk fibroin solution or composition before, during, or after pigment chemistry alteration. In some embodiments, the method may include, processing a surface of the leather material with a silk fibroin solution or composition before, during, or after colorant delivery improvement. In some embodiments, the method may include, processing a surface of the leather material with a silk fibroin solution or composition before, during, or after Uniflex treatment. In some embodiments, the method may include, processing a surface of the leather material with a silk fibroin solution or composition before, during, or after Finiflex treatment. In some embodiments, the method may include, processing a surface of the leather material with a silk fibroin solution or composition before, during, or after heat stamping treatment. In some embodiments, the method may include, processing a surface of the leather material with a silk fibroin solution or composition before, during, or after polishing treatment. In some embodiments, the method may include, processing a surface of the leather material with a silk fibroin solution or composition before, during, or after skin trimming. In some embodiments, the method may include, processing a surface of the leather material with a silk fibroin solution or composition before, during, or after a finishing process. In some embodiments, the method may include, processing a surface of the leather material with a silk fibroin solution or composition before, during, or after tanning. In some embodiments, the method may include, processing a surface of the leather material with a silk fibroin solution or composition before, during, or after dyeing. In some embodiments, the method may include, processing a surface of the leather material with a silk fibroin solution or composition before, during, or after stretching. In some embodiments, the method may include, processing a surface of the leather material with a silk fibroin solution or composition before, during, or after drying. In some embodiments, the method may include, processing a surface of the leather material with a silk fibroin solution or composition before, during, or after trimming. In some embodiments, the method may include, processing a surface of the leather material with a silk fibroin solution or composition before, during, or after polishing.

In an embodiment, a method is provided for coating leather with silk fibroin and/or SPF that may include silk-based proteins or fragments thereof to provide a silk fibroin coated leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution before, during, or after any processing step. In some embodiments, the method may include, coating a surface of the leather material with the silk fibroin solution before, during, or after pigment delivery. In some embodiments, the method may include, coating a surface of the leather material with the silk fibroin solution before, during, or after color locking. In some embodiments, the method may include, coating a surface of the leather material with the silk fibroin solution before, during, or after final coloration adjustment. In some embodiments, the method may include, coating a surface of the leather material with the silk fibroin solution before, during, or after pigment chemistry alteration. In some embodiments, the method may include, coating a surface of the leather material with the silk fibroin solution before, during, or after colorant delivery improvement. In some embodiments, the method may include, coating a surface of the leather material with the silk fibroin solution before, during, or after Uniflex treatment. In some embodiments, the method may include, coating a surface of the leather material with the silk fibroin solution before, during, or after Finiflex treatment. In some embodiments, the method may include, coating a surface of the leather material with the silk fibroin solution before, during, or after heat stamping treatment. In some embodiments, the method may include, coating a surface of the leather material with the silk fibroin solution before, during, or after polishing treatment. In some embodiments, the method may include, coating a surface of the leather material with the silk fibroin solution before, during, or after skin trimming. In some embodiments, the method may include, coating a surface of the leather material with the silk fibroin solution before, during, or after a finishing process. In some embodiments, the method may include, coating a surface of the leather material with the silk fibroin solution before, during, or after tanning. In some embodiments, the method may include, coating a surface of the leather material with the silk fibroin solution before, during, or after dyeing. In some embodiments, the method may include, coating a surface of the leather material with the silk fibroin solution before, during, or after stretching. In some embodiments, the method may include, coating a surface of the leather material with the silk fibroin solution before, during, or after drying. In some embodiments, the method may include, coating a surface of the leather material with the silk fibroin solution before, during, or after trimming. In some embodiments, the method may include, coating a surface of the leather material with the silk fibroin solution before, during, or after polishing.

In some embodiments, the method may include, filing and/or repairing a defect on the surface of the leather material with a silk fibroin composition, for example silk fibroin glue, paste, gel, wax, putty, or the like. In an embodiment, a method is provided for repairing leather with silk fibroin and/or SPF that may include silk-based proteins or fragments thereof to provide a silk fibroin repaired leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 210% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, repairing a surface and/or defect of the leather material with the silk fibroin solution or composition before, during, or after any processing step. In some embodiments, the method may include, repairing a surface and/or defect of the leather material with the silk fibroin solution or composition before, during, or after pigment delivery. In some embodiments, the method may include, repairing a surface and/or defect of the leather material with the silk fibroin solution or composition before, during, or after color locking. In some embodiments, the method may include, repairing a surface and/or defect of the leather material with the silk fibroin solution or composition before, during, or after final coloration adjustment. In some embodiments, the method may include, repairing a surface and/or defect of the leather material with the silk fibroin solution or composition before, during, or after pigment chemistry alteration. In some embodiments, the method may include, repairing a surface and/or defect of the leather material with the silk fibroin solution or composition before, during, or after colorant delivery improvement. In some embodiments, the method may include, repairing a surface and/or defect of the leather material with the silk fibroin solution or composition before, during, or after Uniflex treatment. In some embodiments, the method may include, repairing a surface and/or defect of the leather material with the silk fibroin solution or composition before, during, or after Finiflex treatment. In some embodiments, the method may include, repairing a surface and/or defect of the leather material with the silk fibroin solution or composition before, during, or after heat stamping treatment. In some embodiments, the method may include, repairing a surface and/or defect of the leather material with the silk fibroin solution or composition before, during, or after polishing treatment. In some embodiments, the method may include, repairing a surface and/or defect of the leather material with the silk fibroin solution or composition before, during, or after skin trimming. In some embodiments, the method may include, repairing a surface and/or defect of the leather material with the silk fibroin solution or composition before, during, or after a finishing process. In some embodiments, the method may include, repairing a surface and/or defect of the leather material with the silk fibroin solution or composition before, during, or after tanning. In some embodiments, the method may include, repairing a surface and/or defect of the leather material with the silk fibroin solution or composition before, during, or after dyeing. In some embodiments, the method may include, repairing a surface and/or defect of the leather material with the silk fibroin solution or composition before, during, or after stretching. In some embodiments, the method may include, repairing a surface and/or defect of the leather material with the silk fibroin solution or composition before, during, or after drying. In some embodiments, the method may include, repairing a surface and/or defect of the leather material with the silk fibroin solution or composition before, during, or after trimming. In some embodiments, the method may include, repairing a surface and/or defect of the leather material with the silk fibroin solution or composition before, during, or after polishing.

In an embodiment, a method is provided for coating leather with silk fibroin and/or SPF that may include silk-based proteins or fragments thereof to provide a silk fibroin coated leather, wherein the silk fibroin coated upon the silk fibroin coated leather may be heat resistant to a selected temperature. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution. In some embodiments, the method may include drying the surface of the leather material that has been coated with the silk fibroin solution or composition to provide the silk fibroin coated leather material, wherein drying the surface of the leather material comprises heating the surface of the material without substantially decreasing silk fibroin coating performance. In some embodiments, the method may include, filing a defect on the surface of the leather material with a silk fibroin composition, for example silk fibroin glue, paste, gel, wax, putty, or the like.

In an embodiment, the silk fibroin processed leather materials of the disclosure may be processed with one or more of low molecular weight silk, medium molecular weight silk, and high molecular weight silk to provide resulting coated leather materials having enhanced hydrophobic or hydrophilic properties. In an embodiment, the silk fibroin coated leather materials of the disclosure may be coated with one or more of low molecular weight silk, medium molecular weight silk, and high molecular weight silk to provide resulting coated leather materials having enhanced hydrophobic or hydrophilic properties. In an embodiment, the silk fibroin repaired leather materials of the disclosure may have one or more defects repaired, masked, or hidden with one or more of low molecular weight silk, medium molecular weight silk, and high molecular weight silk to provide resulting leather materials having enhanced properties, including an enhanced quality grade.

In an embodiment, the silk fibroin processed leather materials of the disclosure may be processed with compositions including low molecular weight silk and medium molecular weight silk. In an embodiment, the silk fibroin coated leather materials of the disclosure may be coated with compositions including low molecular weight silk and medium molecular weight silk. In an embodiment, the silk fibroin defect-repaired leather materials of the disclosure may be repaired with compositions including low molecular weight silk and medium molecular weight silk. In some embodiments, the w/w ratio between low molecular weight silk and medium molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and medium molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and medium molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including low molecular weight silk and high molecular weight silk. In an embodiment, the silk fibroin coated leather materials of the disclosure may be coated with compositions including low molecular weight silk and high molecular weight silk. In an embodiment, the silk fibroin defect-repaired leather materials of the disclosure may be repaired with compositions including low molecular weight silk and high molecular weight silk. In some embodiments, the w/w ratio between low molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including medium molecular weight silk and high molecular weight silk. In an embodiment, the silk fibroin coated leather materials of the disclosure may be coated with compositions including medium molecular weight silk and high molecular weight silk. In an embodiment, the silk fibroin defect-repaired leather materials of the disclosure may be repaired with compositions including medium molecular weight silk and high molecular weight silk. In some embodiments, the w/w ratio between medium molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the disclosure may be processed with compositions including low molecular weight silk, medium molecular weight silk, and high molecular weight silk. In an embodiment, the silk fibroin coated leather materials of the disclosure may be coated with compositions including low molecular weight silk, medium molecular weight silk, and high molecular weight silk. In an embodiment, the silk fibroin defect-repaired leather materials of the disclosure may be repaired with compositions including low molecular weight silk, medium molecular weight silk, and high molecular weight silk. In an embodiment, the w/w ratio between low molecular weight silk, medium molecular weight silk, and high molecular weight silk is about 1:1:8, 1:2:7, 1:3:6, 1:4:5, 1:5:4, 1:63, 1:7:2, 1:8:1, 2:1:7, 2:2:6, 2:3:5, 2:4:4, 2:5:3, 2:6:2, 2:7:1, 3:1:6, 3:2:5, 3:3.4, 3:4:3, 3:5:2, 3:6:1, 4:1:5, 4:2:4, 4:3:3, 4:4:2, 4:5:1, 5:1:4, 5:2:3, 5:3:2, 5:4:1, 6:1:3, 6:2:2, 6:3:1, 7:1:2, 7:2:1, or 8:1:1.

In an embodiment, the disclosure provides a silk and/or SPF processed leather article, wherein the processing comprises silk based proteins or fragments thereof having a weight average molecular weight range of about 5 kDa to about 144 kDa. In an embodiment, the disclosure provides a silk and/or SPF coated leather article, wherein the coating comprises silk based proteins or fragments thereof having a weight average molecular weight range of about 5 kDa to about 144 kDa. In an embodiment, the disclosure provides a silk and/or SPF defect-repaired leather article, wherein the defect filling comprises silk based proteins or fragments thereof having a weight average molecular weight range of about 5 kDa to about 144 kDa.

In an embodiment, the disclosure provides a silk and/or SPF processed leather article, wherein the processing comprises silk based proteins or fragments thereof having average weight average molecular weights of about 5 kDa to about 144 kDa. In an embodiment, the disclosure provides a silk and/or SPF coated leather article, wherein the coating comprises silk based proteins or fragments thereof having average weight average molecular weights of about 5 kDa to about 144 kDa. In an embodiment, the disclosure provides a silk and/or SPF defect-repaired leather article, wherein the defect filling comprises silk based proteins or fragments thereof having average weight average molecular weights of about 5 kDa to about 144 kDa.

In an embodiment, the disclosure provides a leather article processed with silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the disclosure provides a leather article having a coating wherein the coating comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the disclosure provides a leather article including a one or more leather defect-filling portions, wherein the composition comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues.

In an embodiment, the disclosure provides a leather article processed with silk based proteins or fragments thereof having a weight average molecular weight range of about 5 kDa to about 144 kDa. In an embodiment, the disclosure provides a leather article having a coating wherein the coating comprises silk based proteins or fragments thereof having a weight average molecular weight range of about 5 kDa to about 144 kDa. In an embodiment, the disclosure provides a leather article including a leather defect-filling composition, wherein the composition comprises silk based proteins or fragments thereof having a weight average molecular weight range of about 5 kDa to about 144 kDa.

In an embodiment, the disclosure provides a leather article processed with silk based proteins or fragments thereof having average weight average molecular weights of about 5 kDa to about 144 kDa. In an embodiment, the disclosure provides a leather article having a coating wherein the coating comprises silk based proteins or fragments thereof having average weight average molecular weights of about 5 kDa to about 144 kDa. In an embodiment, the disclosure provides a leather article including a leather defect-filling composition, wherein the composition comprises silk based proteins or fragments thereof having average weight average molecular weights of about 5 kDa to about 144 kDa.

In an embodiment, the disclosure provides a leather article processed with silk proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article including a leather defect-filling composition, coating wherein the composition comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin.

In an embodiment, the disclosure provides a leather article processed with silk proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article having a coating wherein the coating comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the disclosure provides a leather article including a leather defect-filling composition, coating wherein the composition comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article including a leather defect-filling compositions, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the disclosure provides a leather article including a leather defect-filling compositions, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article including a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the disclosure provides a leather article including a leather defect-filling composition, wherein the composition comprises silk based proteins or fragments thereof having average weight average molecular weight of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the disclosure provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the disclosure provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the disclosure provides a leather article having a leather defect-filling composition, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the disclosure provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the disclosure provides a leather article processed with a composition comprising silk based proteins or fragments thereof and a pigment and/or a colorant, the silk based proteins or fragments thereof having a weight average molecular weight range of about 5 kDa to about 144 kDa. In an embodiment, the disclosure provides a leather article having a coating comprising silk based proteins or fragments thereof and a pigment and/or a colorant, the silk based proteins or fragments thereof having a weight average molecular weight range of about 5 kDa to about 144 kDa. In an embodiment, the disclosure provides a leather article including a defect-filling composition comprising silk based proteins or fragments thereof and a pigment and/or a colorant, the silk based proteins or fragments thereof having a weight average molecular weight range of about 5 kDa to about 144 kDa.

In an embodiment, the disclosure provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the disclosure provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the disclosure provides a leather article processed with a composition comprising silk based proteins or fragments thereof and a pigment and/or a colorant, the silk based proteins or fragments thereof having average weight average molecular weights of about 5 kDa to about 144 kDa. In an embodiment, the disclosure provides a leather article having a coating comprising silk based proteins or fragments thereof and a pigment and/or a colorant, the silk based proteins or fragments thereof having average weight average molecular weights of about 5 kDa to about 144 kDa. In an embodiment, the disclosure provides a leather article including a defect-filling composition comprising silk based proteins or fragments thereof and a pigment and/or a colorant, the silk based proteins or fragments thereof having average weight average molecular weights of about 5 kDa to about 144 kDa.

In an embodiment, the disclosure provides a leather article processed with silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to processing the leather article, do not spontaneously or gradually gelate and do not visibly change in color or turbidity when in a solution for at least 10 days. In an embodiment, the disclosure provides a leather article having a coating wherein the coating comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to coating the leather article, do not spontaneously or gradually gelate and do not visibly change in color or turbidity when in a solution for at least 10 days. In an embodiment, the disclosure provides a leather article including a leather defect-filling composition, wherein the composition comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to repairing the leather article, do not spontaneously or gradually gelate and do not visibly change in color or turbidity when in a solution for at least 10 days.

In an embodiment, the disclosure provides a leather article processed with silk based proteins or fragments thereof having a weight average molecular weight range of about 5 kDa to about 144 kDa. In an embodiment, the disclosure provides a leather article having a coating wherein the coating comprises silk based proteins or fragments thereof having a weight average molecular weight range of about 5 kDa to about 144 kDa. In an embodiment, the disclosure provides a leather article including a leather defect-filling composition, wherein the composition comprises silk based proteins or fragments thereof having a weight average molecular weight range of about 5 kDa to about 144 kDa.

In an embodiment, the disclosure provides a leather article processed with silk based proteins or fragments thereof having average weight average molecular weights of about 5 kDa to about 144 kDa. In an embodiment, the disclosure provides a leather article having a coating wherein the coating comprises silk based proteins or fragments thereof having average weight average molecular weights of about 5 kDa to about 144 kDa. In an embodiment, the disclosure provides a leather article including a leather defect-filling composition, wherein the composition comprises silk based proteins or fragments thereof having average weight average molecular weights of about 5 kDa to about 144 kDa.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 is a flow chart showing various embodiments for producing pure silk fibroin-based protein fragments (SPFs) of the present disclosure.

FIG. 2 is a flow chart showing various parameters that can be modified during the process of producing SPFs of the present disclosure during the extraction and the dissolution steps.

FIG. 3 illustrates general steps used in leather processing.

FIG. 4 is a photograph of the felt pads (and associated leather samples) after 600 continuous cycles of Wet Veslic Rubbing, comparing silk fibroin fragment compositions (bottom sample—Entry B2) treated leather samples to polyurethane (top 2 samples) treated leather samples. Note the damage to the polyurethane samples and loss of dye from the leather to the felt after 600 cycles).

FIG. 5 is a photograph of the felt pads after 10 cycles of Wet Veslic Rubbing on Entries A1, A2, B1 and B2 (Table 1) treated leather samples.

FIG. 6 is a photograph of water droplets placed on samples treated either with silk fibroin fragments or a crosslinked polyurethane coating system after Wet Veslic Rubbing has been performed. In the case of silk fibroin fragments (Entry B2), the sample was exposed to 600 cycles of rubbing whereas the polyurethane samples only endured 10 cycles. The photograph was taken 5 minutes after placing the water droplets. Note the penetration of water into the leather matrix when using the commercial reference systems designed as top-coats.

FIGS. 7A-7B is a graphical analysis illustrating the results of Water Vapor Transmission Test #1 on coated leather (8A) and uncoated leather (8B).

FIGS. 8A-8B is a graphical analysis illustrating the results of Water Vapor Transmission Test #2 on coated leather (9A) and uncoated leather (9B).

FIGS. 9A-9B is a graphical analysis illustrating the results of Water Vapor Transmission Test #3 on coated leather (10A) and uncoated leather (10B).

FIGS. 10A-10B are photographs of uncoated plain leather.

FIGS. 11A-11B show an FTIR analysis of uncoated plain leather.

FIGS. 12A-12B are photographs of leather treated with an adhesive coating of a coating system disclosed herein.

FIGS. 13A-13B show an FTIR analysis of leather treated with an adhesive coating of a coating system disclosed herein.

FIGS. 14A-14B are photographs of treated leather finished with a top coat of a coating system disclosed herein.

FIGS. 14C-14D show an FTIR analysis of treated leather finished with a top coat of a coating system disclosed herein.

FIG. 15A is an IR Spectra of leather samples treated with a coating system disclosed herein by LN-MCT Detector.

FIG. 15B shows Macro ATR Imaging of a leather sample treated with an adhesive base coat of a coating system disclosed herein.

FIG. 15C shows Macro ATR Imaging of a leather sample treated with a top coat of a coating system disclosed herein.

FIGS. 16A-16H are photographs illustrating the results of the soil release test with various stain sources on leather treated with a coating system disclosed herein. 16A: Mud, 16B: Water, 16C: Mustard, 16D: Corn Oil, 16E: Wine, 16F: Ketchup, 16G: French Dressing, 16H: Coffee.

FIGS. 17A-17C are photographs of the leather samples treated with a coating system disclosed herein used in the Industrialization Trial.

FIGS. 18A-18I are photographs of the felt pads (and associated leather samples treated with a coating system disclosed herein) after 600 continuous cycles of Wet Veslic Rubbing (Note: FIG. 18H was only subject to 360 cycles).

FIGS. 19A-19D are photographs illustrating the results of a Bally Flex Test conducted on various leather samples treated with a coating system disclosed herein.

FIGS. 20A-201 are photographs illustrating the results of an Adhesive Tape Test conducted on various leather samples treated with an adhesive coating system.

FIG. 21 is a photograph illustrating the difference between leather samples treated with an adhesive coating system disclosed herein before and after milling.

FIGS. 22A-221 are photographs illustrating the results of an Adhesive Tape Test conducted on various leather samples treated with an adhesive coating system disclosed herein.

FIG. 23 is a photograph illustrating the difference between leather samples treated with an adhesive coating system disclosed herein before and after milling.

FIGS. 24A-24B are photographs illustrating the difference in an Adhesive Tape Test conducted on a leather sample treated with an adhesive coating system disclosed herein before and after milling.

FIGS. 25A-25C are microscopic cross-sectional images of a leather surface treated with a coating system disclosed herein.

FIGS. 26A-26C are microscopic top view images of a leather surface treated with a coating system disclosed herein.

FIGS. 27A-27C are images showing a wet blue leather strip treated with a coating system disclosed herein under a digital microscope. 27A: side view, 27B: top grain view, 27C: flesh view.

FIGS. 28A-28C are images showing a paper strip treated with a coating system disclosed herein under a digital microscope. 28A: top view, 28B: side view, 28C: back view.

FIGS. 29A-29C are images showing a fabric strip treated with a coating system disclosed herein under a digital microscope. 29A: top view, 29B: side view, 29C: back view.

FIGS. 30A-30C are images showing a fabric strip with blue tape treated with a coating system disclosed herein under a digital microscope. 30A: top view, 30B: side view, 30C: back view.

FIG. 31 shows pictures of AS-104+2% Glycerol+50 mM magnesium sulfate films tensile testing process.

FIG. 32 shows proposed formulation mechanism incorporating AS-104, 2% glycerol and salts at various concentrations.

FIG. 33A shows elongation at break of AS-104, 2% glycerol and guanidinium hydrochloride (5, 10, 25 and 50 mM).

FIG. 33B shows ultimate tensile strength of AS-104, 2% glycerol and guanidinium hydrochloride (5, 10, 25 and 50 mM).

FIG. 34A shows elongation at break of AS-104, 2% glycerol and sodium chloride (5, 10, 25 and 50 mM).

FIG. 34B shows ultimate tensile strength of AS-104, 2% glycerol and sodium chloride (5, 10, 25 and 50 mM).

FIG. 35A shows elongation at break of AS-104, 2% glycerol and urea (5, 10, 25 and 50 mM).

FIG. 35B shows ultimate tensile strength of AS-104, 2% glycerol and urea (5, 10, 25 and 50 mM).

FIG. 36A shows elongation at break of AS-104, 2% glycerol and L-Arginine hydrochloride (5, 10, 25 and 50 mM).

FIG. 36B shows ultimate tensile strength of AS-104, 2% glycerol and L-Arginine hydrochloride (5, 10, 25 and 50 mM).

FIG. 37A shows elongation at break of AS-104, 2% glycerol and magnesium sulfate heptahydrate (5, 10, 25 and 50 mM).

FIG. 37B shows ultimate tensile strength of AS-104, 2% glycerol and magnesium sulfate heptahydrate (5, 10, 25 and 50 mM).

FIG. 38A shows elongation at break of AS-104, 2% glycerol and ammonium sulfate (5, 10, 25 and 50 mM).

FIG. 38B shows ultimate tensile strength of AS-104, 2% glycerol and ammonium sulfate (5, 10, 25 and 50 mM).

FIG. 39A shows elongation at break of AS-104, 2% glycerol and calcium chloride (5, 10, 25 and 50 mM).

FIG. 39B shows ultimate tensile strength of AS-104, 2% glycerol and calcium chloride (5, 10, 25 and 50 mM).

FIG. 40A shows elongation at break of AS-104, 2% glycerol and magnesium chloride (5, 10, 25 and 50 mM).

FIG. 40B shows ultimate tensile strength of AS-104, 2% glycerol and magnesium chloride (5, 10, 25 and 50 mM).

FIG. 41A shows elongation at break of AS-104, 2% glycerol and calcium sulfate dihydrate (5, 10, 25 and 50 mM).

FIG. 41B shows ultimate tensile strength of AS-104, 2% glycerol and calcium sulfate dihydrate (5, 10, 25 and 50 mM).

FIG. 42A shows elongation at break of AS-104, 2% glycerol and calcium lactobionate (5, 10, 25 and 50 mM).

FIG. 42B shows ultimate tensile strength of AS-104, 2% glycerol and calcium lactobionate (5, 10, 25 and 50 mM).

FIG. 43 compiles all data on elongation at break.

FIG. 44 compiles all data on ultimate tensile strength.

FIG. 45 shows Veslic wet and dry testing results of Bodin Basic Black leather coated with 17% AS-104-5% Melio-9S11, 17% AS-104-5% Melio-9S11-10 mM CaCl₂), 17% AS-104-5% Melio-9S11-50 mM MgSO4 and 17% AS-104-5% Melio-9S11-25 mM L-Arginine hydrochloride FIG. 46 shows Veslic wet and dry Testing results of Bodin Brown leather coated with 17% AS-104-5% Melio-9S11, 17% AS-104-5% Melio-9S11-10 mM CaCl₂), 17% AS-104-5% Melio-9S11-50 mM MgSO4 and 17% AS-104-5% Melio-9S11-25 mM L-Arginine hydrochloride FIG. 47 shows Veslic scores for Bodin Basic Black leather coated with 17% AS-104-5% Melio-9S11, 17% AS-104-5% Melio-9S11-10 mM CaCl₂), 17% AS-104-5% Melio-9S11-50 mM MgSO4 and 17% AS-104-5% Melio-9S11-25 mM L-Arginine hydrochloride FIG. 48 shows Veslic scores for Bodin Brown leather coated with 17% AS-104-5% Melio-9S11, 17% AS-104-5% Melio-9S11-10 mM CaCl₂), 17% AS-104-5% Melio-9S11-50 mM MgSO4 and 17% AS-104-5% Melio-9S11-25 mM L-Arginine hydrochloride FIGS. 49A and 49B illustrate before and after topography traces of a leather sample coated with GG-silk before (FIG. 23A) and after (FIG. 23B) coating with Silk+0.5% wt. GG via point filling. Traces were captured using a Taylor Hobson CCI HD optical profilometer.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In some embodiments, the disclosure provides a composition comprising a coating comprising two components. In some embodiments, the second component is impregnated onto the first component. In some embodiments, the second component goes through a phase change (e.g., and without limitation, Tg, polymerization, etc.). A first coating described herein may include without limitation a polymer or any protein disclosed herein, such as a biodegradable polyurethane, a silk protein, a collagen, casein, elastin, etc. A second coating described herein may include without limitation a cellulose derivative disclosed herein. A first coating and a second coating should not be limited in that order, as any coating disclosed herein may be interchanged with any other coating disclosed herein. While an ethyl cellulose may be usually brittle and can crack, in some embodiments, this disclosure provides for a flexible ethyl cellulose coating. Ten disclosure provides for coating any surface, without limitation, e.g., leather, fabric, wood, protective coating for food (fruit, vegetables, etc.). In some embodiments, a coating disclosed herein is made with two or more films (maybe starting from one film made of the two polymers) with a monolayer distribution for coating on substrates. As disclosed herein, a composite material and/or coating disclosed herein can be based, without limitation, on a molecular entanglement whereby EC is free of crosslinker. In some embodiments, all the layers are fixed together with molecular interaction. In some embodiments, all molecular interactions are cured or set or polymerized. In some embodiments, a molecular interaction of the two layers whereby the film is cured and the molecules form larger polymeric structures. In some embodiments, an outer layer described herein comprises between 1% and 100% EC on the surface. In some embodiments, a first layer (in application against the surface to be coated): engages in molecular entanglement such as the first layer and the second layer became adhered; a first layer can adhere to uneven surface; a first layer is: thermoplastic, self-assembled, soluble in the solvent used for the second layer; first layer polymerize through crosslinking, self-assembly. In some embodiments, a first layer is resoluble and can be cured. In some embodiments, a polymer or protein, e.g., and without limitation, a silk protein, has a role in the first layer. In some embodiments, a second layer (deposited on top of the first layer and the outside layer): it is made by Ethyl Cellulose (EC) or a biomaterial or a polymer, in a dispersion of molecules; In some embodiments, this layer in solvent contains between about 1-5 gr/L by volume EC. In some embodiments, this layer can deliver dye, silk or other molecule to modify optical, haptics and mechanical properties. In some embodiments, EC is a protective barrier that can enhance the performance and characteristics of the first layer. In some embodiments, EC is mechanically resilient and enhance the water resistance properties. In some embodiments, EC can adhere to a dynamic first layer substrate. In some embodiments, EC can adhere to uneven first layer surface. In some embodiments, the majority of the EC faces outwardly to the external environment/forces. In some embodiments, a protein or polymer, e.g., and without limitation, silk has a role in the second layer.

Silk coated leather articles and methods of making thereof have been described in WO 2020/018821 and WO 2021/146654, each of which is incorporated herein by reference in its entirety.

Leather is a material manufactured by treating the skin peeled off from an animal body with a series of physical mechanic and chemical methods, followed by tanning. The leather materials are composed of weaved collagen fiber bundles and trace amount of elastic fibers and reticular fibers, of which the collagen fiber is between 95 and 98 percent. The natural weaving structure of collagen fiber in natural leather is that the thicker fiber bundles sometimes are divided into several strands of thinner fiber bundles and the resulting thinner fiber bundles sometimes incorporate other fiber bundles to form another larger fiber bundle.

Leather in its natural state is a nonwoven material where the fibrils of the fiber have grown together. The silk fibroin protein and collagen fibers in the leather are natural proteins composed of 22 proteinogenic amino acids. The silk protein has high affinity to the leather fibers (collagen fibers) resulted from the presence of hydrophilic amino acid residue in the silk fibroin protein (e.g., physical entanglement due to forming hydrogen bonding between silk protein fragments and leather fibers), for example, —OH group from serine, guanidine group from arginine, free amine group from lysine, —COOH group from aspartic acid and glutamic acid.

In some embodiments, herein described silk fibroin-based protein fragments and solutions may find application as color performance enhancer for leather or leather articles. In some embodiments, this disclosure provides silk treated leather or leather articles exhibiting good dyeability, excellent color fastness and enhanced color saturation.

The treatment on the leather and leather articles with silk fibroin-based protein fragments and solutions enhances the quality and aesthetic properties of the natural leather using non-toxic, sustainable and natural silk based composition. The silk treatment process disclosed herein advances leather products while respecting its heritage and craft without disruption to the leather tanning and creating process.

### SPF Definitions and Properties

As used herein, “silk protein fragments” (SPF) include, without limitation, one or more of: “silk fibroin fragments” as defined herein; “recombinant silk fragments” as defined herein; “spider silk fragments” as defined herein; “silk fibroin-like protein fragments” as defined herein; “chemically modified silk fragments” as defined herein; and/or “sericin or sericin fragments” as defined herein. SPF may have any molecular weight values or ranges described herein, and any polydispersity values or ranges described herein. As used herein, in some embodiments the term “silk protein fragment” also refers to a silk protein that comprises or consists of at least two identical repetitive units which each independently selected from naturally-occurring silk polypeptides or of variations thereof, amino acid sequences of naturally-occurring silk polypeptides, or of combinations of both.

### SPF Molecular Weight and Polydispersity

In an embodiment, a composition of the present disclosure includes SPF having an average weight average molecular weight selected from between about 1 to about 5 kDa. In an embodiment, a composition of the present disclosure includes SPF having an average weight average molecular weight selected from between about 5 to about 10 kDa. In an embodiment, a composition of the present disclosure includes SPF having an average weight average molecular weight selected from between about 10 to about 15 kDa. In an embodiment, a composition of the present disclosure includes SPF having an average weight average molecular weight selected from between about 15 to about 20 kDa. In an embodiment, a composition of the present disclosure includes SPF having an average weight average molecular weight selected from between about 14 to about 30 kDa. In an embodiment, a composition of the present disclosure includes SPF having an average weight average molecular weight selected from between about 20 to about 25 kDa. In an embodiment, a composition of the present disclosure includes SPF having an average weight average molecular weight selected from between about 25 to about 30 kDa. In an embodiment, a composition of the present disclosure includes SPF having an average weight average molecular weight selected from between about 30 to about 35 kDa. In an embodiment, a composition of the present disclosure includes SPF having an average weight average molecular weight selected from between about 35 to about 40 kDa. In an embodiment, a composition of the present disclosure includes SPF having an average weight average molecular weight selected from between about 39 to about 54 kDa. In an embodiment, a composition of the present disclosure includes SPF having an average weight average molecular weight selected from between about 40 to about 45 kDa. In an embodiment, a composition of the present disclosure includes SPF having an average weight average molecular weight selected from between about 45 to about 50 kDa. In an embodiment, a composition of the present disclosure includes SPF having an average weight average molecular weight selected from between about 50 to about 55 kDa. In an embodiment, a composition of the present disclosure includes SPF having an average weight average molecular weight selected from between about 55 to about 60 kDa. In an embodiment, a composition of the present disclosure includes SPF having an average weight average molecular weight selected from between about 60 to about 65 kDa. In an embodiment, a composition of the present disclosure includes SPF having an average weight average molecular weight selected from between about 65 to about 70 kDa. In an embodiment, a composition of the present disclosure includes SPF having an average weight average molecular weight selected from between about 70 to about 75 kDa. In an embodiment, a composition of the present disclosure includes SPF having an average weight average molecular weight selected from between about 75 to about 80 kDa. In an embodiment, a composition of the present disclosure includes SPF having an average weight average molecular weight selected from between about 80 to about 85 kDa. In an embodiment, a composition of the present disclosure includes SPF having an average weight average molecular weight selected from between about 85 to about 90 kDa. In an embodiment, a composition of the present disclosure includes SPF having an average weight average molecular weight selected from between about 90 to about 95 kDa. In an embodiment, a composition of the present disclosure includes SPF having an average weight average molecular weight selected from between about 95 to about 100 kDa. In an embodiment, a composition of the present disclosure includes SPF having an average weight average molecular weight selected from between about 100 to about 105 kDa. In an embodiment, a composition of the present disclosure includes SPF having an average weight average molecular weight selected from between about 105 to about 110 kDa. In an embodiment, a composition of the present disclosure includes SPF having an average weight average molecular weight selected from between about 110 to about 115 kDa. In an embodiment, a composition of the present disclosure includes SPF having an average weight average molecular weight selected from between about 115 to about 120 kDa. In an embodiment, a composition of the present disclosure includes SPF having an average weight average molecular weight selected from between about 120 to about 125 kDa. In an embodiment, a composition of the present disclosure includes SPF having an average weight average molecular weight selected from between about 125 to about 130 kDa. In an embodiment, a composition of the present disclosure includes SPF having an average weight average molecular weight selected from between about 130 to about 135 kDa. In an embodiment, a composition of the present disclosure includes SPF having an average weight average molecular weight selected from between about 135 to about 140 kDa. In an embodiment, a composition of the present disclosure includes SPF having an average weight average molecular weight selected from between about 140 to about 145 kDa. In an embodiment, a composition of the present disclosure includes SPF having an average weight average molecular weight selected from between about 145 to about 150 kDa. In an embodiment, a composition of the present disclosure includes SPF having an average weight average molecular weight selected from between about 150 to about 155 kDa. In an embodiment, a composition of the present disclosure includes SPF having an average weight average molecular weight selected from between about 155 to about 160 kDa. In an embodiment, a composition of the present disclosure includes SPF having an average weight average molecular weight selected from between about 160 to about 165 kDa. In an embodiment, a composition of the present disclosure includes SPF having an average weight average molecular weight selected from between about 165 to about 170 kDa. In an embodiment, a composition of the present disclosure includes SPF having an average weight average molecular weight selected from between about 170 to about 175 kDa. In an embodiment, a composition of the present disclosure includes SPF having an average weight average molecular weight selected from between about 175 to about 180 kDa. In an embodiment, a composition of the present disclosure includes SPF having an average weight average molecular weight selected from between about 180 to about 185 kDa. In an embodiment, a composition of the present disclosure includes SPF having an average weight average molecular weight selected from between about 185 to about 190 kDa. In an embodiment, a composition of the present disclosure includes SPF having an average weight average molecular weight selected from between about 190 to about 195 kDa. In an embodiment, a composition of the present disclosure includes SPF having an average weight average molecular weight selected from between about 195 to about 200 kDa. In an embodiment, a composition of the present disclosure includes SPF having an average weight average molecular weight selected from between about 200 to about 205 kDa. In an embodiment, a composition of the present disclosure includes SPF having an average weight average molecular weight selected from between about 205 to about 210 kDa. In an embodiment, a composition of the present disclosure includes SPF having an average weight average molecular weight selected from between about 210 to about 215 kDa. In an embodiment, a composition of the present disclosure includes SPF having an average weight average molecular weight selected from between about 215 to about 220 kDa. In an embodiment, a composition of the present disclosure includes SPF having an average weight average molecular weight selected from between about 220 to about 225 kDa. In an embodiment, a composition of the present disclosure includes SPF having an average weight average molecular weight selected from between about 225 to about 230 kDa. In an embodiment, a composition of the present disclosure includes SPF having an average weight average molecular weight selected from between about 230 to about 235 kDa. In an embodiment, a composition of the present disclosure includes SPF having an average weight average molecular weight selected from between about 235 to about 240 kDa. In an embodiment, a composition of the present disclosure includes SPF having an average weight average molecular weight selected from between about 240 to about 245 kDa. In an embodiment, a composition of the present disclosure includes SPF having an average weight average molecular weight selected from between about 245 to about 250 kDa. In an embodiment, a composition of the present disclosure includes SPF having an average weight average molecular weight selected from between about 250 to about 255 kDa. In an embodiment, a composition of the present disclosure includes SPF having an average weight average molecular weight selected from between about 255 to about 260 kDa. In an embodiment, a composition of the present disclosure includes SPF having an average weight average molecular weight selected from between about 260 to about 265 kDa. In an embodiment, a composition of the present disclosure includes SPF having an average weight average molecular weight selected from between about 265 to about 270 kDa. In an embodiment, a composition of the present disclosure includes SPF having an average weight average molecular weight selected from between about 270 to about 275 kDa. In an embodiment, a composition of the present disclosure includes SPF having an average weight average molecular weight selected from between about 275 to about 280 kDa. In an embodiment, a composition of the present disclosure includes SPF having an average weight average molecular weight selected from between about 280 to about 285 kDa. In an embodiment, a composition of the present disclosure includes SPF having an average weight average molecular weight selected from between about 285 to about 290 kDa. In an embodiment, a composition of the present disclosure includes SPF having an average weight average molecular weight selected from between about 290 to about 295 kDa. In an embodiment, a composition of the present disclosure includes SPF having an average weight average molecular weight selected from between about 295 to about 300 kDa. In an embodiment, a composition of the present disclosure includes SPF having an average weight average molecular weight selected from between about 300 to about 305 kDa. In an embodiment, a composition of the present disclosure includes SPF having an average weight average molecular weight selected from between about 305 to about 310 kDa. In an embodiment, a composition of the present disclosure includes SPF having an average weight average molecular weight selected from between about 310 to about 315 kDa. In an embodiment, a composition of the present disclosure includes SPF having an average weight average molecular weight selected from between about 315 to about 320 kDa. In an embodiment, a composition of the present disclosure includes SPF having an average weight average molecular weight selected from between about 320 to about 325 kDa. In an embodiment, a composition of the present disclosure includes SPF having an average weight average molecular weight selected from between about 325 to about 330 kDa. In an embodiment, a composition of the present disclosure includes SPF having an average weight average molecular weight selected from between about 330 to about 335 kDa. In an embodiment, a composition of the present disclosure includes SPF having an average weight average molecular weight selected from between about 335 to about 340 kDa. In an embodiment, a composition of the present disclosure includes SPF having an average weight average molecular weight selected from between about 340 to about 345 kDa. In an embodiment, a composition of the present disclosure includes SPF having an average weight average molecular weight selected from between about 345 to about 350 kDa.

In some embodiments, compositions of the present disclosure include SPF compositions selected from compositions #1001 to #2450, having weight average molecular weights selected from about 1 kDa to about 145 kDa, and a polydispersity selected from between 1 and about 5 (including, without limitation, a polydispersity of 1), between 1 and about 1.5 (including, without limitation, a polydispersity of 1), between about 1.5 and about 2, between about 1.5 and about 3, between about 2 and about 2.5, between about 2.5 and about 3, between about 3 and about 3.5, between about 3.5 and about 4, between about 4 and about 4.5, and between about 4.5 and about 5:

| | | PDI | | | | | | | | | |
|---|---|---|---|---|---|---|---|---|---|---|---|
| MW | | (about) | | | | | | | | | |
| (about) | | 1-5 | 1-1.5 | 1.5-2 | 1.5-3 | 2-2.5 | 2.5-3 | 3-3.5 | 3.5-4 | 4-4.5 | 4.5-5 |
| 1 | kDa | 1001 | 1002 | 1003 | 1004 | 1005 | 1006 | 1007 | 1008 | 1009 | 1010 |
| 2 | kDa | 1011 | 1012 | 1013 | 1014 | 1015 | 1016 | 1017 | 1018 | 1019 | 1020 |
| 3 | kDa | 1021 | 1022 | 1023 | 1024 | 1025 | 1026 | 1027 | 1028 | 1029 | 1030 |
| 4 | kDa | 1031 | 1032 | 1033 | 1034 | 1035 | 1036 | 1037 | 1038 | 1039 | 1040 |
| 5 | kDa | 1041 | 1042 | 1043 | 1044 | 1045 | 1046 | 1047 | 1048 | 1049 | 1050 |
| 6 | kDa | 1051 | 1052 | 1053 | 1054 | 1055 | 1056 | 1057 | 1058 | 1059 | 1060 |
| 7 | kDa | 1061 | 1062 | 1063 | 1064 | 1065 | 1066 | 1067 | 1068 | 1069 | 1070 |
| 8 | kDa | 1071 | 1072 | 1073 | 1074 | 1075 | 1076 | 1077 | 1078 | 1079 | 1080 |
| 9 | kDa | 1081 | 1082 | 1083 | 1084 | 1085 | 1086 | 1087 | 1088 | 1089 | 1090 |
| 10 | kDa | 1091 | 1092 | 1093 | 1094 | 1095 | 1096 | 1097 | 1098 | 1099 | 1100 |
| 11 | kDa | 1101 | 1102 | 1103 | 1104 | 1105 | 1106 | 1107 | 1108 | 1109 | 1110 |
| 12 | kDa | 1111 | 1112 | 1113 | 1114 | 1115 | 1116 | 1117 | 1118 | 1119 | 1120 |
| 13 | kDa | 1121 | 1122 | 1123 | 1124 | 1125 | 1126 | 1127 | 1128 | 1129 | 1130 |
| 14 | kDa | 1131 | 1132 | 1133 | 1134 | 1135 | 1136 | 1137 | 1138 | 1139 | 1140 |
| 15 | kDa | 1141 | 1142 | 1143 | 1144 | 1145 | 1146 | 1147 | 1148 | 1149 | 1150 |
| 16 | kDa | 1151 | 1152 | 1153 | 1154 | 1155 | 1156 | 1157 | 1158 | 1159 | 1160 |
| 17 | kDa | 1161 | 1162 | 1163 | 1164 | 1165 | 1166 | 1167 | 1168 | 1169 | 1170 |
| 18 | kDa | 1171 | 1172 | 1173 | 1174 | 1175 | 1176 | 1177 | 1178 | 1179 | 1180 |
| 19 | kDa | 1181 | 1182 | 1183 | 1184 | 1185 | 1186 | 1187 | 1188 | 1189 | 1190 |
| 20 | kDa | 1191 | 1192 | 1193 | 1194 | 1195 | 1196 | 1197 | 1198 | 1199 | 1200 |
| 21 | kDa | 1201 | 1202 | 1203 | 1204 | 1205 | 1206 | 1207 | 1208 | 1209 | 1210 |
| 22 | kDa | 1211 | 1212 | 1213 | 1214 | 1215 | 1216 | 1217 | 1218 | 1219 | 1220 |
| 23 | kDa | 1221 | 1222 | 1223 | 1224 | 1225 | 1226 | 1227 | 1228 | 1229 | 1230 |
| 24 | kDa | 1231 | 1232 | 1233 | 1234 | 1235 | 1236 | 1237 | 1238 | 1239 | 1240 |
| 25 | kDa | 1241 | 1242 | 1243 | 1244 | 1245 | 1246 | 1247 | 1248 | 1249 | 1250 |
| 26 | kDa | 1251 | 1252 | 1253 | 1254 | 1255 | 1256 | 1257 | 1258 | 1259 | 1260 |
| 27 | kDa | 1261 | 1262 | 1263 | 1264 | 1265 | 1266 | 1267 | 1268 | 1269 | 1270 |
| 28 | kDa | 1271 | 1272 | 1273 | 1274 | 1275 | 1276 | 1277 | 1278 | 1279 | 1280 |
| 29 | kDa | 1281 | 1282 | 1283 | 1284 | 1285 | 1286 | 1287 | 1288 | 1289 | 1290 |
| 30 | kDa | 1291 | 1292 | 1293 | 1294 | 1295 | 1296 | 1297 | 1298 | 1299 | 1300 |
| 31 | kDa | 1301 | 1302 | 1303 | 1304 | 1305 | 1306 | 1307 | 1308 | 1309 | 1310 |
| 32 | kDa | 1311 | 1312 | 1313 | 1314 | 1315 | 1316 | 1317 | 1318 | 1319 | 1320 |
| 33 | kDa | 1321 | 1322 | 1323 | 1324 | 1325 | 1326 | 1327 | 1328 | 1329 | 1330 |
| 34 | kDa | 1331 | 1332 | 1333 | 1334 | 1335 | 1336 | 1337 | 1338 | 1339 | 1340 |
| 35 | kDa | 1341 | 1342 | 1343 | 1344 | 1345 | 1346 | 1347 | 1348 | 1349 | 1350 |
| 36 | kDa | 1351 | 1352 | 1353 | 1354 | 1355 | 1356 | 1357 | 1358 | 1359 | 1360 |
| 37 | kDa | 1361 | 1362 | 1363 | 1364 | 1365 | 1366 | 1367 | 1368 | 1369 | 1370 |
| 38 | kDa | 1371 | 1372 | 1373 | 1374 | 1375 | 1376 | 1377 | 1378 | 1379 | 1380 |
| 39 | kDa | 1381 | 1382 | 1383 | 1384 | 1385 | 1386 | 1387 | 1388 | 1389 | 1390 |
| 40 | kDa | 1391 | 1392 | 1393 | 1394 | 1395 | 1396 | 1397 | 1398 | 1399 | 1400 |
| 41 | kDa | 1401 | 1402 | 1403 | 1404 | 1405 | 1406 | 1407 | 1408 | 1409 | 1410 |
| 42 | kDa | 1411 | 1412 | 1413 | 1414 | 1415 | 1416 | 1417 | 1418 | 1419 | 1420 |
| 43 | kDa | 1421 | 1422 | 1423 | 1424 | 1425 | 1426 | 1427 | 1428 | 1429 | 1430 |
| 44 | kDa | 1431 | 1432 | 1433 | 1434 | 1435 | 1436 | 1437 | 1438 | 1439 | 1440 |
| 45 | kDa | 1441 | 1442 | 1443 | 1444 | 1445 | 1446 | 1447 | 1448 | 1449 | 1450 |
| 46 | kDa | 1451 | 1452 | 1453 | 1454 | 1455 | 1456 | 1457 | 1458 | 1459 | 1460 |
| 47 | kDa | 1461 | 1462 | 1463 | 1464 | 1465 | 1466 | 1467 | 1468 | 1469 | 1470 |
| 48 | kDa | 1471 | 1472 | 1473 | 1474 | 1475 | 1476 | 1477 | 1478 | 1479 | 1480 |
| 49 | kDa | 1481 | 1482 | 1483 | 1484 | 1485 | 1486 | 1487 | 1488 | 1489 | 1490 |
| 50 | kDa | 1491 | 1492 | 1493 | 1494 | 1495 | 1496 | 1497 | 1498 | 1499 | 1500 |
| 51 | kDa | 1501 | 1502 | 1503 | 1504 | 1505 | 1506 | 1507 | 1508 | 1509 | 1510 |
| 52 | kDa | 1511 | 1512 | 1513 | 1514 | 1515 | 1516 | 1517 | 1518 | 1519 | 1520 |
| 53 | kDa | 1521 | 1522 | 1523 | 1524 | 1525 | 1526 | 1527 | 1528 | 1529 | 1530 |
| 54 | kDa | 1531 | 1532 | 1533 | 1534 | 1535 | 1536 | 1537 | 1538 | 1539 | 1540 |
| 55 | kDa | 1541 | 1542 | 1543 | 1544 | 1545 | 1546 | 1547 | 1548 | 1549 | 1550 |
| 56 | kDa | 1551 | 1552 | 1553 | 1554 | 1555 | 1556 | 1557 | 1558 | 1559 | 1560 |
| 57 | kDa | 1561 | 1562 | 1563 | 1564 | 1565 | 1566 | 1567 | 1568 | 1569 | 1570 |
| 58 | kDa | 1571 | 1572 | 1573 | 1574 | 1575 | 1576 | 1577 | 1578 | 1579 | 1580 |
| 59 | kDa | 1581 | 1582 | 1583 | 1584 | 1585 | 1586 | 1587 | 1588 | 1589 | 1590 |
| 60 | kDa | 1591 | 1592 | 1593 | 1594 | 1595 | 1596 | 1597 | 1598 | 1599 | 1600 |
| 61 | kDa | 1601 | 1602 | 1603 | 1604 | 1605 | 1606 | 1607 | 1608 | 1609 | 1610 |
| 62 | kDa | 1611 | 1612 | 1613 | 1614 | 1615 | 1616 | 1617 | 1618 | 1619 | 1620 |
| 63 | kDa | 1621 | 1622 | 1623 | 1624 | 1625 | 1626 | 1627 | 1628 | 1629 | 1630 |
| 64 | kDa | 1631 | 1632 | 1633 | 1634 | 1635 | 1636 | 1637 | 1638 | 1639 | 1640 |
| 65 | kDa | 1641 | 1642 | 1643 | 1644 | 1645 | 1646 | 1647 | 1648 | 1649 | 1650 |
| 66 | kDa | 1651 | 1652 | 1653 | 1654 | 1655 | 1656 | 1657 | 1658 | 1659 | 1660 |
| 67 | kDa | 1661 | 1662 | 1663 | 1664 | 1665 | 1666 | 1667 | 1668 | 1669 | 1670 |
| 68 | kDa | 1671 | 1672 | 1673 | 1674 | 1675 | 1676 | 1677 | 1678 | 1679 | 1680 |
| 69 | kDa | 1681 | 1682 | 1683 | 1684 | 1685 | 1686 | 1687 | 1688 | 1689 | 1690 |
| 70 | kDa | 1691 | 1692 | 1693 | 1694 | 1695 | 1696 | 1697 | 1698 | 1699 | 1700 |
| 71 | kDa | 1701 | 1702 | 1703 | 1704 | 1705 | 1706 | 1707 | 1708 | 1709 | 1710 |
| 72 | kDa | 1711 | 1712 | 1713 | 1714 | 1715 | 1716 | 1717 | 1718 | 1719 | 1720 |
| 73 | kDa | 1721 | 1722 | 1723 | 1724 | 1725 | 1726 | 1727 | 1728 | 1729 | 1730 |
| 74 | kDa | 1731 | 1732 | 1733 | 1734 | 1735 | 1736 | 1737 | 1738 | 1739 | 1740 |
| 75 | kDa | 1741 | 1742 | 1743 | 1744 | 1745 | 1746 | 1747 | 1748 | 1749 | 1750 |
| 76 | kDa | 1751 | 1752 | 1753 | 1754 | 1755 | 1756 | 1757 | 1758 | 1759 | 1760 |
| 77 | kDa | 1761 | 1762 | 1763 | 1764 | 1765 | 1766 | 1767 | 1768 | 1769 | 1770 |
| 78 | kDa | 1771 | 1772 | 1773 | 1774 | 1775 | 1776 | 1777 | 1778 | 1779 | 1780 |
| 79 | kDa | 1781 | 1782 | 1783 | 1784 | 1785 | 1786 | 1787 | 1788 | 1789 | 1790 |
| 80 | kDa | 1791 | 1792 | 1793 | 1794 | 1795 | 1796 | 1797 | 1798 | 1799 | 1800 |
| 81 | kDa | 1801 | 1802 | 1803 | 1804 | 1805 | 1806 | 1807 | 1808 | 1809 | 1810 |
| 82 | kDa | 1811 | 1812 | 1813 | 1814 | 1815 | 1816 | 1817 | 1818 | 1819 | 1820 |
| 83 | kDa | 1821 | 1822 | 1823 | 1824 | 1825 | 1826 | 1827 | 1828 | 1829 | 1830 |
| 84 | kDa | 1831 | 1832 | 1833 | 1834 | 1835 | 1836 | 1837 | 1838 | 1839 | 1840 |
| 85 | kDa | 1841 | 1842 | 1843 | 1844 | 1845 | 1846 | 1847 | 1848 | 1849 | 1850 |
| 86 | kDa | 1851 | 1852 | 1853 | 1854 | 1855 | 1856 | 1857 | 1858 | 1859 | 1860 |
| 87 | kDa | 1861 | 1862 | 1863 | 1864 | 1865 | 1866 | 1867 | 1868 | 1869 | 1870 |
| 88 | kDa | 1871 | 1872 | 1873 | 1874 | 1875 | 1876 | 1877 | 1878 | 1879 | 1880 |
| 89 | kDa | 1881 | 1882 | 1883 | 1884 | 1885 | 1886 | 1887 | 1888 | 1889 | 1890 |
| 90 | kDa | 1891 | 1892 | 1893 | 1894 | 1895 | 1896 | 1897 | 1898 | 1899 | 1900 |
| 91 | kDa | 1901 | 1902 | 1903 | 1904 | 1905 | 1906 | 1907 | 1908 | 1909 | 1910 |
| 92 | kDa | 1911 | 1912 | 1913 | 1914 | 1915 | 1916 | 1917 | 1918 | 1919 | 1920 |
| 93 | kDa | 1921 | 1922 | 1923 | 1924 | 1925 | 1926 | 1927 | 1928 | 1929 | 1930 |
| 94 | kDa | 1931 | 1932 | 1933 | 1934 | 1935 | 1936 | 1937 | 1938 | 1939 | 1940 |
| 95 | kDa | 1941 | 1942 | 1943 | 1944 | 1945 | 1946 | 1947 | 1948 | 1949 | 1950 |
| 96 | kDa | 1951 | 1952 | 1953 | 1954 | 1955 | 1956 | 1957 | 1958 | 1959 | 1960 |
| 97 | kDa | 1961 | 1962 | 1963 | 1964 | 1965 | 1966 | 1967 | 1968 | 1969 | 1970 |
| 98 | kDa | 1971 | 1972 | 1973 | 1974 | 1975 | 1976 | 1977 | 1978 | 1979 | 1980 |
| 99 | kDa | 1981 | 1982 | 1983 | 1984 | 1985 | 1986 | 1987 | 1988 | 1989 | 1990 |
| 100 | kDa | 1991 | 1992 | 1993 | 1994 | 1995 | 1996 | 1997 | 1998 | 1999 | 2000 |
| 101 | kDa | 2001 | 2002 | 2003 | 2004 | 2005 | 2006 | 2007 | 2008 | 2009 | 2010 |
| 102 | kDa | 2011 | 2012 | 2013 | 2014 | 2015 | 2016 | 2017 | 2018 | 2019 | 2020 |
| 103 | kDa | 2021 | 2022 | 2023 | 2024 | 2025 | 2026 | 2027 | 2028 | 2029 | 2030 |
| 104 | kDa | 2031 | 2032 | 2033 | 2034 | 2035 | 2036 | 2037 | 2038 | 2039 | 2040 |
| 105 | kDa | 2041 | 2042 | 2043 | 2044 | 2045 | 2046 | 2047 | 2048 | 2049 | 2050 |
| 106 | kDa | 2051 | 2052 | 2053 | 2054 | 2055 | 2056 | 2057 | 2058 | 2059 | 2060 |
| 107 | kDa | 2061 | 2062 | 2063 | 2064 | 2065 | 2066 | 2067 | 2068 | 2069 | 2070 |
| 108 | kDa | 2071 | 2072 | 2073 | 2074 | 2075 | 2076 | 2077 | 2078 | 2079 | 2080 |
| 109 | kDa | 2081 | 2082 | 2083 | 2084 | 2085 | 2086 | 2087 | 2088 | 2089 | 2090 |
| 110 | kDa | 2091 | 2092 | 2093 | 2094 | 2095 | 2096 | 2097 | 2098 | 2099 | 2100 |
| 111 | kDa | 2101 | 2102 | 2103 | 2104 | 2105 | 2106 | 2107 | 2108 | 2109 | 2110 |
| 112 | kDa | 2111 | 2112 | 2113 | 2114 | 2115 | 2116 | 2117 | 2118 | 2119 | 2120 |
| 113 | kDa | 2121 | 2122 | 2123 | 2124 | 2125 | 2126 | 2127 | 2128 | 2129 | 2130 |
| 114 | kDa | 2131 | 2132 | 2133 | 2134 | 2135 | 2136 | 2137 | 2138 | 2139 | 2140 |
| 115 | kDa | 2141 | 2142 | 2143 | 2144 | 2145 | 2146 | 2147 | 2148 | 2149 | 2150 |
| 116 | kDa | 2151 | 2152 | 2153 | 2154 | 2155 | 2156 | 2157 | 2158 | 2159 | 2160 |
| 117 | kDa | 2161 | 2162 | 2163 | 2164 | 2165 | 2166 | 2167 | 2168 | 2169 | 2170 |
| 118 | kDa | 2171 | 2172 | 2173 | 2174 | 2175 | 2176 | 2177 | 2178 | 2179 | 2180 |
| 119 | kDa | 2181 | 2182 | 2183 | 2184 | 2185 | 2186 | 2187 | 2188 | 2189 | 2190 |
| 120 | kDa | 2191 | 2192 | 2193 | 2194 | 2195 | 2196 | 2197 | 2198 | 2199 | 2200 |
| 121 | kDa | 2201 | 2202 | 2203 | 2204 | 2205 | 2206 | 2207 | 2208 | 2209 | 2210 |
| 122 | kDa | 2211 | 2212 | 2213 | 2214 | 2215 | 2216 | 2217 | 2218 | 2219 | 2220 |
| 123 | kDa | 2221 | 2222 | 2223 | 2224 | 2225 | 2226 | 2227 | 2228 | 2229 | 2230 |
| 124 | kDa | 2231 | 2232 | 2233 | 2234 | 2235 | 2236 | 2237 | 2238 | 2239 | 2240 |
| 125 | kDa | 2241 | 2242 | 2243 | 2244 | 2245 | 2246 | 2247 | 2248 | 2249 | 2250 |
| 126 | kDa | 2251 | 2252 | 2253 | 2254 | 2255 | 2256 | 2257 | 2258 | 2259 | 2260 |
| 127 | kDa | 2261 | 2262 | 2263 | 2264 | 2265 | 2266 | 2267 | 2268 | 2269 | 2270 |
| 128 | kDa | 2271 | 2272 | 2273 | 2274 | 2275 | 2276 | 2277 | 2278 | 2279 | 2280 |
| 129 | kDa | 2281 | 2282 | 2283 | 2284 | 2285 | 2286 | 2287 | 2288 | 2289 | 2290 |
| 130 | kDa | 2291 | 2292 | 2293 | 2294 | 2295 | 2296 | 2297 | 2298 | 2299 | 2300 |
| 131 | kDa | 2301 | 2302 | 2303 | 2304 | 2305 | 2306 | 2307 | 2308 | 2309 | 2310 |
| 132 | kDa | 2311 | 2312 | 2313 | 2314 | 2315 | 2316 | 2317 | 2318 | 2319 | 2320 |
| 133 | kDa | 2321 | 2322 | 2323 | 2324 | 2325 | 2326 | 2327 | 2328 | 2329 | 2330 |
| 134 | kDa | 2331 | 2332 | 2333 | 2334 | 2335 | 2336 | 2337 | 2338 | 2339 | 2340 |
| 135 | kDa | 2341 | 2342 | 2343 | 2344 | 2345 | 2346 | 2347 | 2348 | 2349 | 2350 |
| 136 | kDa | 2351 | 2352 | 2353 | 2354 | 2355 | 2356 | 2357 | 2358 | 2359 | 2360 |
| 137 | kDa | 2361 | 2362 | 2363 | 2364 | 2365 | 2366 | 2367 | 2368 | 2369 | 2370 |
| 138 | kDa | 2371 | 2372 | 2373 | 2374 | 2375 | 2376 | 2377 | 2378 | 2379 | 2380 |
| 139 | kDa | 2381 | 2382 | 2383 | 2384 | 2385 | 2386 | 2387 | 2388 | 2389 | 2390 |
| 140 | kDa | 2391 | 2392 | 2393 | 2394 | 2395 | 2396 | 2397 | 2398 | 2399 | 2400 |
| 141 | kDa | 2401 | 2402 | 2403 | 2404 | 2405 | 2406 | 2407 | 2408 | 2409 | 2410 |
| 142 | kDa | 2411 | 2412 | 2413 | 2414 | 2415 | 2416 | 2417 | 2418 | 2419 | 2420 |
| 143 | kDa | 2421 | 2422 | 2423 | 2424 | 2425 | 2426 | 2427 | 2428 | 2429 | 2430 |
| 144 | kDa | 2431 | 2432 | 2433 | 2434 | 2435 | 2436 | 2437 | 2438 | 2439 | 2440 |
| 145 | kDa | 2441 | 2442 | 2443 | 2444 | 2445 | 2446 | 2447 | 2448 | 2449 | 2450 |

As used herein, “low molecular weight,” “low MW,” or “low-MW” SPF may include SPF having a weight average molecular weight, or average weight average molecular weight selected from between about 5 kDa to about 38 kDa, about 14 kDa to about 30 kDa, or about 6 kDa to about 17 kDa. In some embodiments, a target low molecular weight for certain SPF may be weight average molecular weight of about 5 kDa, about 6 kDa, about 7 kDa, about 8 kDa, about 9 kDa, about 10 kDa, about 11 kDa, about 12 kDa, about 13 kDa, about 14 kDa, about 15 kDa, about 16 kDa, about 17 kDa, about 18 kDa, about 19 kDa, about 20 kDa, about 21 kDa, about 22 kDa, about 23 kDa, about 24 kDa, about 25 kDa, about 26 kDa, about 27 kDa, about 28 kDa, about 29 kDa, about 30 kDa, about 31 kDa, about 32 kDa, about 33 kDa, about 34 kDa, about 35 kDa, about 36 kDa, about 37 kDa, or about 38 kDa.

As used herein, “medium molecular weight,” “medium MW,” or “mid-MW” SPF may include SPF having a weight average molecular weight, or average weight average molecular weight selected from between about 31 kDa to about 55 kDa, or about 39 kDa to about 54 kDa. In some embodiments, a target medium molecular weight for certain SPF may be weight average molecular weight of about 31 kDa, about 32 kDa, about 33 kDa, about 34 kDa, about 35 kDa, about 36 kDa, about 37 kDa, about 38 kDa, about 39 kDa, about 40 kDa, about 41 kDa, about 42 kDa, about 43 kDa, about 44 kDa, about 45 kDa, about 46 kDa, about 47 kDa, about 48 kDa, about 49 kDa, about 50 kDa, about 51 kDa, about 52 kDa, about 53 kDa, about 54 kDa, or about 55 kDa.

As used herein, “high molecular weight,” “high MW,” or “high-MW” SPF may include SPF having a weight average molecular weight, or average weight average molecular weight selected from between about 55 kDa to about 150 kDa. In some embodiments, a target high molecular weight for certain SPF may be about 55 kDa, about 56 kDa, about 57 kDa, about 58 kDa, about 59 kDa, about 60 kDa, about 61 kDa, about 62 kDa, about 63 kDa, about 64 kDa, about 65 kDa, about 66 kDa, about 67 kDa, about 68 kDa, about 69 kDa, about 70 kDa, about 71 kDa, about 72 kDa, about 73 kDa, about 74 kDa, about 75 kDa, about 76 kDa, about 77 kDa, about 78 kDa, about 79 kDa, or about 80 kDa.

In some embodiments, the molecular weights described herein (e.g., low molecular weight silk, medium molecular weight silk, high molecular weight silk) may be converted to the approximate number of amino acids contained within the respective SPF, as would be understood by a person having ordinary skill in the art. For example, the average weight of an amino acid may be about 110 daltons (i.e., 110 g/mol). Therefore, in some embodiments, dividing the molecular weight of a linear protein by 110 daltons may be used to approximate the number of amino acid residues contained therein.

In an embodiment, SPF in a composition of the present disclosure have a polydispersity selected from between 1 to about 5.0, including, without limitation, a polydispersity of 1. In an embodiment, SPF in a composition of the present disclosure have a polydispersity selected from between about 1.5 to about 3.0. In an embodiment, SPF in a composition of the present disclosure have a polydispersity selected from between 1 to about 1.5, including, without limitation, a poly dispersity of 1. In an embodiment, SPF in a composition of the present disclosure have a polydispersity selected from between about 1.5 to about 2.0. In an embodiment, SPF in a composition of the present disclosure have a polydispersity selected from between about 2.0 to about 2.5. In an embodiment, SPF in a composition of the present disclosure have a polydispersity selected from between about 2.5 to about 3.0. In an embodiment, SPF in a composition of the present disclosure have a polydispersity selected from between about 3.0 to about 3.5. In an embodiment, SPF in a composition of the present disclosure have a polydispersity selected from between about 3.5 to about 4.0. In an embodiment, SPF in a composition of the present disclosure have a polydispersity selected from between about 4.0 to about 4.5. In an embodiment, SPF in a composition of the present disclosure have a polydispersity selected from between about 4.5 to about 5.0.

In an embodiment, SPF in a composition of the present disclosure have a polydispersity of 1. In an embodiment, SPF in a composition of the present disclosure have a polydispersity of about 1.1. In an embodiment, SPF in a composition of the present disclosure have a polydispersity of about 1.2. In an embodiment, SPF in a composition of the present disclosure have a polydispersity of about 1.3. In an embodiment, SPF in a composition of the present disclosure have a polydispersity of about 1.4. In an embodiment, SPF in a composition of the present disclosure have a polydispersity of about 1.5. In an embodiment, SPF in a composition of the present disclosure have a polydispersity of about 1.6. In an embodiment, SPF in a composition of the present disclosure have a polydispersity of about 1.7. In an embodiment, SPF in a composition of the present disclosure have a polydispersity of about 1.8. In an embodiment, SPF in a composition of the present disclosure have a polydispersity of about 1.9. In an embodiment, SPF in a composition of the present disclosure have a polydispersity of about 2.0. In an embodiment, SPF in a composition of the present disclosure have a polydispersity of about 2.1. In an embodiment, SPF in a composition of the present disclosure have a polydispersity of about 2.2. In an embodiment, SPF in a composition of the present disclosure have a polydispersity of about 2.3. In an embodiment, SPF in a composition of the present disclosure have a polydispersity of about 2.4. In an embodiment, SPF in a composition of the present disclosure have a polydispersity of about 2.5. In an embodiment, SPF in a composition of the present disclosure have a polydispersity of about 2.6. In an embodiment, SPF in a composition of the present disclosure have a polydispersity of about 2.7. In an embodiment, SPF in a composition of the present disclosure have a polydispersity of about 2.8. In an embodiment, SPF in a composition of the present disclosure have a polydispersity of about 2.9. In an embodiment, SPF in a composition of the present disclosure have a polydispersity of about 3.0. In an embodiment, SPF in a composition of the present disclosure have a polydispersity of about 3.1. In an embodiment, SPF in a composition of the present disclosure have a polydispersity of about 3.2. In an embodiment, SPF in a composition of the present disclosure have a polydispersity of about 3.3. In an embodiment, SPF in a composition of the present disclosure have a polydispersity of about 3.4. In an embodiment, SPF in a composition of the present disclosure have a polydispersity of about 3.5. In an embodiment, SPF in a composition of the present disclosure have a polydispersity of about 3.6. In an embodiment, SPF in a composition of the present disclosure have a polydispersity of about 3.7. In an embodiment, SPF in a composition of the present disclosure have a polydispersity of about 3.8. In an embodiment, SPF in a composition of the present disclosure have a polydispersity of about 3.9. In an embodiment, SPF in a composition of the present disclosure have a polydispersity of about 4.0. In an embodiment, SPF in a composition of the present disclosure have a polydispersity of about 4.1. In an embodiment, SPF in a composition of the present disclosure have a polydispersity of about 4.2. In an embodiment, SPF in a composition of the present disclosure have a polydispersity of about 4.3. In an embodiment, SPF in a composition of the present disclosure have a polydispersity of about 4.4. In an embodiment, SPF in a composition of the present disclosure have a polydispersity of about 4.5. In an embodiment, SPF in a composition of the present disclosure have a polydispersity of about 4.6. In an embodiment, SPF in a composition of the present disclosure have a polydispersity of about 4.7. In an embodiment, SPF in a composition of the present disclosure have a polydispersity of about 4.8. In an embodiment, SPF in a composition of the present disclosure have a polydispersity of about 4.9. In an embodiment, SPF in a composition of the present disclosure have a polydispersity of about 5.0.

In some embodiments, in compositions described herein having combinations of low, medium, and/or high molecular weight SPF, such low, medium, and/or high molecular weight SPF may have the same or different polydispersities.

### Silk Fibroin Fragments

Methods of making silk fibroin or silk fibroin protein fragments and their applications in various fields are known and are described for example in U.S. Pat. Nos. 9,187,538, 9,511,012, 9,517,191, 9,522,107, 9,522,108, 9,545,369, and 10,166,177, 10,287,728 and 10,301,768, all of which are incorporated herein in their entireties. Raw silk from silkworm Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. The crude silkworm fiber consists of a double thread of fibroin. The adhesive substance holding these double fibers together is sericin. The silk fibroin is composed of a heavy chain having a weight average molecular weight of about 350,000 Da (H chain), and a light chain having a weight average molecular weight about 25,000 Da (L chain). Silk fibroin is an amphiphilic polymer with large hydrophobic domains occupying the major component of the polymer, which has a high molecular weight. The hydrophobic regions are interrupted by small hydrophilic spacers, and the N- and C-termini of the chains are also highly hydrophilic. The hydrophobic domains of the H-chain contain a repetitive hexapeptide sequence of Gly-Ala-Gly-Ala-Gly-Ser and repeats of Gly-Ala/Ser/Tyr dipeptides, which can form stable anti-parallel-sheet crystallites. The amino acid sequence of the L-chain is non-repetitive, so the L-chain is more hydrophilic and relatively elastic. The hydrophilic (Tyr, Ser) and hydrophobic (Gly, Ala) chain segments in silk fibroin molecules are arranged alternatively such that allows self-assembling of silk fibroin molecules.

Provided herein are methods for producing pure and highly scalable silk fibroin-protein fragment mixture solutions that may be used across multiple industries for a variety of applications. Without wishing to be bound by any particular theory, it is believed that these methods are equally applicable to fragmentation of any SPF described herein, including without limitation recombinant silk proteins, and fragmentation of silk-like or fibroin-like proteins.

As used herein, the term “fibroin” includes silk worm fibroin and insect or spider silk protein. In an embodiment, fibroin is obtained from Bombyx mori. Raw silk from Bombyx mori is composed of two primary proteins: silk fibroin (approximately 75%) and sericin (approximately 25%). Silk fibroin is a fibrous protein with a semi-crystalline structure that provides stiffness and strength. As used herein, the term “silk fibroin” means the fibers of the cocoon of Bombyx mori having a weight average molecular weight of about 370,000 Da. Conversion of these insoluble silk fibroin fibrils into water-soluble silk fibroin protein fragments requires the addition of a concentrated neutral salt (e.g., 8-10 M lithium bromide), which interferes with inter- and intramolecular ionic and hydrogen bonding that would otherwise render the fibroin protein insoluble in water. Methods of making silk fibroin protein fragments, and/or compositions thereof, are known and are described for example in U.S. Pat. Nos. 9,187,538, 9,511,012, 9,517,191, 9,522,107, 9,522,108, 9,545,369, and 10,166,177.

The raw silk cocoons from the silkworm Bombyx mori was cut into pieces. The pieces silk cocoons were processed in an aqueous solution of Na₂CO₃ at about 100° C. for about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L×the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at about 100° C. for about 60 minutes to achieve complete dissolution of the native silk protein. The resulting silk fibroin solution was filtered and dialyzed using Tangential Flow Filtration (TFF) and a 10 kDa membrane against deionized water for 72 hours. The resulting silk fibroin aqueous solution has a concentration of about 8.5 wt. %. Then, 8.5% silk solution was diluted with water to result in a 1.0% w/v silk solution. TFF can then be used to further concentrate the pure silk solution to a concentration of 20.0% w/w silk to water.

Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

In some embodiments, the silk solutions are prepared under various preparation condition parameters such as: 90° C. 30 min, 90° C. 60 min, 100° C. 30 min, and 100° C. 60 min. Briefly, 9.3 M LiBr was prepared and allowed to sit at room temperature for at least 30 minutes. 5 mL of LiBr solution was added to 1.25 g of silk and placed in the 60° C. oven. Samples from each set were removed at 4, 6, 8, 12, 24, 168 and 192 hours.

In some embodiments, the silk solutions are prepared under various preparation condition parameters such as: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the 60° C. oven. Samples from each set were removed at 1, 4 and 6 hours.

In some embodiments, the silk solutions are prepared under various preparation condition parameters such as: Four different silk extraction combinations were used: 90° C. 30 min, 90° C. 60 min, 100° C. 30 min, and 100° C. 60 min. Briefly, 9.3 M LiBr solution was heated to one of four temperatures: 60° C., 80° C., 100° C. or boiling. 5 mL of hot LiBr solution was added to 1.25 g of silk and placed in the oven at the same temperature of the LiBr. Samples from each set were removed at 1, 4 and 6 hours. 1 mL of each sample was added to 7.5 mL of 9.3 M LiBr and refrigerated for viscosity testing.

In some embodiments, SPF are obtained by dissolving raw unscoured, partially scoured, or scoured silkworm fibers with a neutral lithium bromide salt. The raw silkworm silks are processed under selected temperature and other conditions in order to remove any sericin and achieve the desired weight average molecular weight (Mw) and polydispersity (PD) of the fragment mixture. Selection of process parameters may be altered to achieve distinct final silk protein fragment characteristics depending upon the intended use. The resulting final fragment solution is silk fibroin protein fragments and water with parts per million (ppm) to non-detectable levels of process contaminants, levels acceptable in the pharmaceutical, medical and consumer eye care markets. The concentration, size and polydispersity of SPF may further be altered depending upon the desired use and performance requirements.

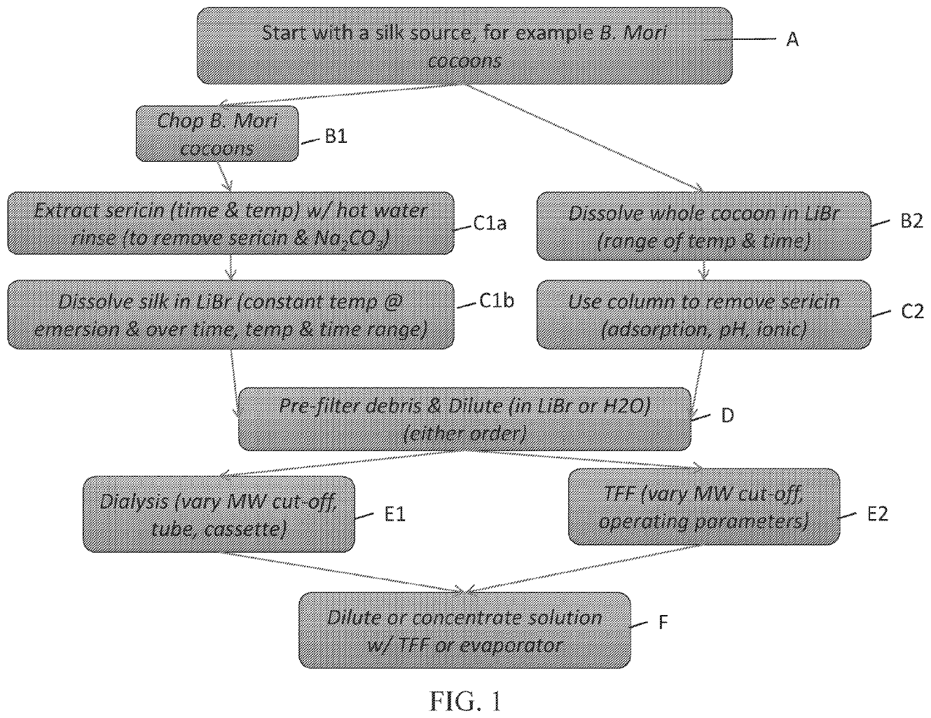

FIG. 1 is a flow chart showing various embodiments for producing pure silk fibroin protein fragments (SPFs) of the present disclosure. It should be understood that not all of the steps illustrated are necessarily required to fabricate all silk solutions of the present disclosure. As illustrated in FIG. 1, step A, cocoons (heat-treated or non-heat-treated), silk fibers, silk powder, spider silk or recombinant spider silk can be used as the silk source. If starting from raw silk cocoons from Bombyx mori, the cocoons can be cut into small pieces, for example pieces of approximately equal size, step B1. The raw silk is then extracted and rinsed to remove any sericin, step Cia. This results in substantially sericin free raw silk. In an embodiment, water is heated to a temperature between 84° C. and 100° C. (ideally boiling) and then Na₂CO₃ (sodium carbonate) is added to the boiling water until the Na₂CO₃ is completely dissolved. The raw silk is added to the boiling water/Na₂CO₃ (100° C.) and submerged for approximately 15-90 minutes, where boiling for a longer time results in smaller silk protein fragments. In an embodiment, the water volume equals about 0.4× raw silk weight and the Na₂CO₃ volume equals about 0.848× raw silk weight. In an embodiment, the water volume equals 0.1× raw silk weight and the Na₂CO₃ volume is maintained at 2.12 g/L.

Subsequently, the water dissolved Na₂CO₃ solution is drained and excess water/Na₂CO₃ is removed from the silk fibroin fibers (e.g., ring out the fibroin extract by hand, spin cycle using a machine, etc.). The resulting silk fibroin extract is rinsed with warm to hot water to remove any remaining adsorbed sericin or contaminate, typically at a temperature range of about 40° C. to about 80° C., changing the volume of water at least once (repeated for as many times as required). The resulting silk fibroin extract is a substantially sericin-depleted silk fibroin. In an embodiment, the resulting silk fibroin extract is rinsed with water at a temperature of about 60° C. In an embodiment, the volume of rinse water for each cycle equals 0.1 L to 0.2 L×raw silk weight. It may be advantageous to agitate, turn or circulate the rinse water to maximize the rinse effect. After rinsing, excess water is removed from the extracted silk fibroin fibers (e.g., ring out fibroin extract by hand or using a machine). Alternatively, methods known to one skilled in the art such as pressure, temperature, or other reagents or combinations thereof may be used for the purpose of sericin extraction. Alternatively, the silk gland (100% sericin free silk protein) can be removed directly from a worm. This would result in liquid silk protein, without any alteration of the protein structure, free of sericin.

The extracted fibroin fibers are then allowed to dry completely. Once dry, the extracted silk fibroin is dissolved using a solvent added to the silk fibroin at a temperature between ambient and boiling, step C1b. In an embodiment, the solvent is a solution of Lithium bromide (LiBr) (boiling for LiBr is 140° C.). Alternatively, the extracted fibroin fibers are not dried but wet and placed in the solvent; solvent concentration can then be varied to achieve similar concentrations as to when adding dried silk to the solvent. The final concentration of LiBr solvent can range from 0.1 M to 9.3 M. Complete dissolution of the extracted fibroin fibers can be achieved by varying the treatment time and temperature along with the concentration of dissolving solvent. Other solvents may be used including, but not limited to, phosphate phosphoric acid, calcium nitrate, calcium chloride solution or other concentrated aqueous solutions of inorganic salts. To ensure complete dissolution, the silk fibers should be fully immersed within the already heated solvent solution and then maintained at a temperature ranging from about 60° C. to about 140° C. for 1-168 hrs. In an embodiment, the silk fibers should be fully immersed within the solvent solution and then placed into a dry oven at a temperature of about 100° C. for about 1 hour.

The temperature at which the silk fibroin extract is added to the LiBr solution (or vice versa) has an effect on the time required to completely dissolve the fibroin and on the resulting molecular weight and polydispersity of the final SPF mixture solution. In an embodiment, silk solvent solution concentration is less than or equal to 20% w/v. In addition, agitation during introduction or dissolution may be used to facilitate dissolution at varying temperatures and concentrations. The temperature of the LiBr solution will provide control over the silk protein fragment mixture molecular weight and polydispersity created. In an embodiment, a higher temperature will more quickly dissolve the silk offering enhanced process scalability and mass production of silk solution. In an embodiment, using a LiBr solution heated to a temperature from 80° C. to 140° C. reduces the time required in an oven in order to achieve full dissolution. Varying time and temperature at or above 60° C. of the dissolution solvent will alter and control the MW and polydispersity of the SPF mixture solutions formed from the original molecular weight of the native silk fibroin protein.

Alternatively, whole cocoons may be placed directly into a solvent, such as LiBr, bypassing extraction, step B2. This requires subsequent filtration of silk worm particles from the silk and solvent solution and sericin removal using methods know in the art for separating hydrophobic and hydrophilic proteins such as a column separation and/or chromatography, ion exchange, chemical precipitation with salt and/or pH, and or enzymatic digestion and filtration or extraction, all methods are common examples and without limitation for standard protein separation methods, step C2. Non-heat treated cocoons with the silkworm removed, may alternatively be placed into a solvent such as LiBr, bypassing extraction. The methods described above may be used for sericin separation, with the advantage that non-heat treated cocoons will contain significantly less worm debris.

Dialysis may be used to remove the dissolution solvent from the resulting dissolved fibroin protein fragment solution by dialyzing the solution against a volume of water, step E1. Pre-filtration prior to dialysis is helpful to remove any debris (i.e., silk worm remnants) from the silk and LiBr solution, step D. In one example, a 3 μm or 5 μm filter is used with a flow-rate of 200-300 mL/min to filter a 0.1% to 1.0% silk-LiBr solution prior to dialysis and potential concentration if desired. A method disclosed herein, as described above, is to use time and/or temperature to decrease the concentration from 9.3 M LiBr to a range from 0.1 M to 9.3 M to facilitate filtration and downstream dialysis, particularly when considering creating a scalable process method. Alternatively, without the use of additional time or temperate, a 9.3 M LiBr-silk protein fragment solution may be diluted with water to facilitate debris filtration and dialysis. The result of dissolution at the desired time and temperate filtration is a translucent particle-free room temperature shelf-stable silk protein fragment-LiBr solution of a known MW and polydispersity. It is advantageous to change the dialysis water regularly until the solvent has been removed (e.g., change water after 1 hour, 4 hours, and then every 12 hours for a total of 6 water changes). The total number of water volume changes may be varied based on the resulting concentration of solvent used for silk protein dissolution and fragmentation. After dialysis, the final silk solution maybe further filtered to remove any remaining debris (i.e., silk worm remnants).

Alternatively, Tangential Flow Filtration (TFF), which is a rapid and efficient method for the separation and purification of biomolecules, may be used to remove the solvent from the resulting dissolved fibroin solution, step E2. TFF offers a highly pure aqueous silk protein fragment solution and enables scalability of the process in order to produce large volumes of the solution in a controlled and repeatable manner. The silk and LiBr solution may be diluted prior to TFF (20% down to 0.1% silk in either water or LiBr). Pre-filtration as described above prior to TFF processing may maintain filter efficiency and potentially avoids the creation of silk gel boundary layers on the filter's surface as the result of the presence of debris particles. Pre-filtration prior to TFF is also helpful to remove any remaining debris (i.e., silk worm remnants) from the silk and LiBr solution that may cause spontaneous or long-term gelation of the resulting water only solution, step D. TFF, recirculating or single pass, may be used for the creation of water-silk protein fragment solutions ranging from 0.1% silk to 30.0% silk (more preferably, 0.1%-6.0% silk). Different cutoff size TFF membranes may be required based upon the desired concentration, molecular weight and polydispersity of the silk protein fragment mixture in solution. Membranes ranging from 1-100 kDa may be necessary for varying molecular weight silk solutions created for example by varying the length of extraction boil time or the time and temperate in dissolution solvent (e.g., LiBr). In an embodiment, a TFF 5 or 10 kDa membrane is used to purify the silk protein fragment mixture solution and to create the final desired silk-to-water ratio. As well, TFF single pass, TFF, and other methods known in the art, such as a falling film evaporator, may be used to concentrate the solution following removal of the dissolution solvent (e.g., LiBr) (with resulting desired concentration ranging from 0.10% to 30% silk). This can be used as an alternative to standard HFIP concentration methods known in the art to create a water-based solution. A larger pore membrane could also be utilized to filter out small silk protein fragments and to create a solution of higher molecular weight silk with and/or without tighter polydispersity values.

An assay for LiBr and Na₂CO₃ detection can be performed using an HPLC system equipped with evaporative light scattering detector (ELSD). The calculation was performed by linear regression of the resulting peak areas for the analyte plotted against concentration.

More than one sample of a number of formulations of the present disclosure was used for sample preparation and analysis. Generally, four samples of different formulations were weighed directly in a 10 mL volumetric flask. The samples were suspended in 5 mL of 20 mM ammonium formate (pH 3.0) and kept at 2-8° C. for 2 hours with occasional shaking to extract analytes from the film. After 2 hours the solution was diluted with 20 mM ammonium formate (pH 3.0). The sample solution from the volumetric flask was transferred into HPLC vials and injected into the HPLC-ELSD system for the estimation of sodium carbonate and lithium bromide.

The analytical method developed for the quantitation of Na₂CO₃ and LiBr in silk protein formulations was found to be linear in the range 10-165 μg/mL, with RSD for injection precision as 2% and 1% for area and 0.38% and 0.19% for retention time for sodium carbonate and lithium bromide respectively. The analytical method can be applied for the quantitative determination of sodium carbonate and lithium bromide in silk protein formulations.

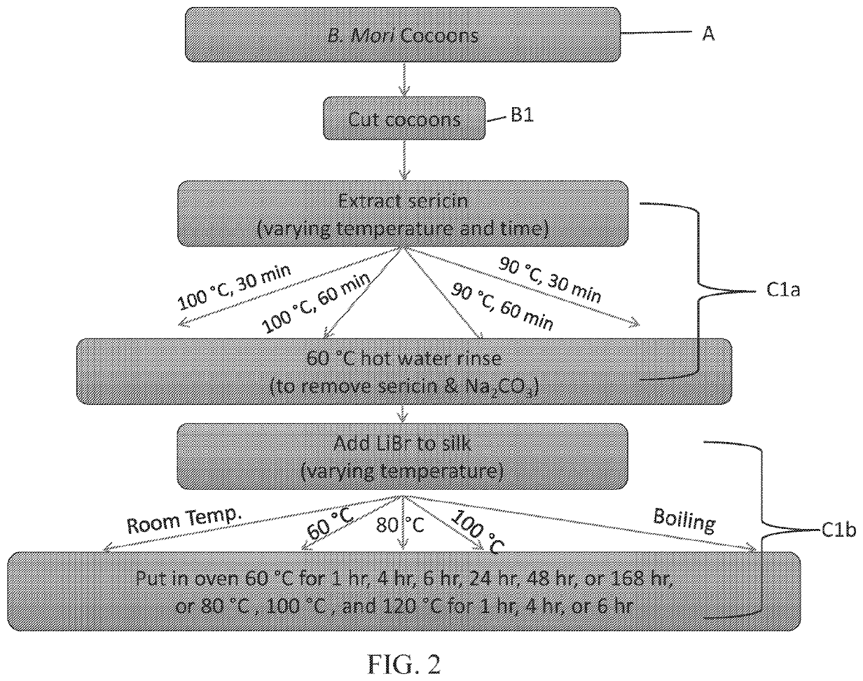

FIG. 2 is a flow chart showing various parameters that can be modified during the process of producing a silk protein fragment solution of the present disclosure during the extraction and the dissolution steps. Select method parameters may be altered to achieve distinct final solution characteristics depending upon the intended use, e.g., molecular weight and polydispersity. It should be understood that not all of the steps illustrated are necessarily required to fabricate all silk solutions of the present disclosure.

In an embodiment, silk protein fragment solutions useful for a wide variety of applications are prepared according to the following steps: forming pieces of silk cocoons from the Bombyx mori silkworm; extracting the pieces at about 100° C. in a Na₂CO₃ water solution for about 60 minutes, wherein a volume of the water equals about 0.4× raw silk weight and the amount of Na₂CO₃ is about 0.848× the weight of the pieces to form a silk fibroin extract; triple rinsing the silk fibroin extract at about 60° C. for about 20 minutes per rinse in a volume of rinse water, wherein the rinse water for each cycle equals about 0.2 L×the weight of the pieces; removing excess water from the silk fibroin extract; drying the silk fibroin extract; dissolving the dry silk fibroin extract in a LiBr solution, wherein the LiBr solution is first heated to about 100° C. to create a silk and LiBr solution and maintained; placing the silk and LiBr solution in a dry oven at about 100° C. for about 60 minutes to achieve complete dissolution and further fragmentation of the native silk protein structure into mixture with desired molecular weight and polydispersity; filtering the solution to remove any remaining debris from the silkworm; diluting the solution with water to result in a 1.0 wt. % silk solution; and removing solvent from the solution using Tangential Flow Filtration (TFF). In an embodiment, a 10 kDa membrane is utilized to purify the silk solution and create the final desired silk-to-water ratio. TFF can then be used to further concentrate the silk solution to a concentration of 2.0 wt. % silk in water.

Without wishing to be bound by any particular theory, varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Also without wishing to be bound by any particular theory, increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions.

The extraction step could be completed in a larger vessel, for example an industrial washing machine where temperatures at or in between 60° C. to 100° C. can be maintained. The rinsing step could also be completed in the industrial washing machine, eliminating the manual rinse cycles. Dissolution of the silk in LiBr solution could occur in a vessel other than a convection oven, for example a stirred tank reactor. Dialyzing the silk through a series of water changes is a manual and time intensive process, which could be accelerated by changing certain parameters, for example diluting the silk solution prior to dialysis. The dialysis process could be scaled for manufacturing by using semi-automated equipment, for example a tangential flow filtration system.

Varying extraction (i.e., time and temperature), LiBr (i.e., temperature of LiBr solution when added to silk fibroin extract or vice versa) and dissolution (i.e., time and temperature) parameters results in solvent and silk solutions with different viscosities, homogeneities, and colors. Increasing the temperature for extraction, lengthening the extraction time, using a higher temperature LiBr solution at emersion and over time when dissolving the silk and increasing the time at temperature (e.g., in an oven as shown here, or an alternative heat source) all resulted in less viscous and more homogeneous solvent and silk solutions. While almost all parameters resulted in a viable silk solution, methods that allow complete dissolution to be achieved in fewer than 4 to 6 hours are preferred for process scalability.

In an embodiment, solutions of silk fibroin protein fragments having a weight average selected from between about 6 kDa to about 17 kDa are prepared according to following steps: degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at most 1 hour; removing the lithium bromide from the silk fibroin extract; and producing an aqueous solution of silk protein fragments, the aqueous solution comprising: fragments having a weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. The aqueous solution of silk fibroin protein fragments may be lyophilized. In some embodiments, the silk fibroin protein fragment solution may be further processed into various forms including gel, powder, and nanofiber.

In an embodiment, solutions of silk fibroin protein fragments having a weight average molecular weight selected from between about 17 kDa to about 39 kDa are prepared according to the following steps: adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of silk fibroin protein fragments comprises fragments having a weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay.

In some embodiments, a method for preparing an aqueous solution of silk fibroin protein fragments having an average weight average molecular weight selected from between about 6 kDa to about 17 kDa includes the steps of degumming a silk source by adding the silk source to a boiling (100° C.) aqueous solution of sodium carbonate for a treatment time of between about 30 minutes to about 60 minutes; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 60° C. to about 140° C.; maintaining the solution of silk fibroin-lithium bromide in an oven having a temperature of about 140° C. for a period of at least 1 hour; removing the lithium bromide from the silk fibroin extract; and producing an aqueous solution of silk protein fragments, the aqueous solution comprising: fragments having an average weight average molecular weight selected from between about 6 kDa to about 17 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay. The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In some embodiments, a method for preparing an aqueous solution of silk fibroin protein fragments having an average weight average molecular weight selected from between about 17 kDa to about 39 kDa includes the steps of adding a silk source to a boiling (100° C.) aqueous solution of sodium carbonate for a treatment time of between about 30 minutes to about 60 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at least 1 hour; removing the lithium bromide from the silk fibroin extract; and producing an aqueous solution of pure silk fibroin protein fragments, wherein the aqueous solution of pure silk fibroin protein fragments comprises lithium bromide residuals of between about 10 ppm and about 300 ppm, wherein the aqueous solution of silk protein fragments comprises sodium carbonate residuals of between about 10 ppm and about 100 ppm, wherein the aqueous solution of pure silk fibroin protein fragments comprises fragments having an average weight average molecular weight selected from between about 17 kDa to about 39 kDa, and a polydispersity of between 1 and about 5, or between about 1.5 and about 3.0. The method may further comprise drying the silk fibroin extract prior to the dissolving step. The aqueous solution of pure silk fibroin protein fragments may comprise lithium bromide residuals of less than 300 ppm as measured using a high-performance liquid chromatography lithium bromide assay. The aqueous solution of pure silk fibroin protein fragments may comprise sodium carbonate residuals of less than 100 ppm as measured using a high-performance liquid chromatography sodium carbonate assay.

The method may further comprise adding a therapeutic agent to the aqueous solution of pure silk fibroin protein fragments. The method may further comprise adding a molecule selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof.

The aqueous solution of pure silk fibroin protein fragments may be lyophilized. The method may further comprise adding an alpha hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. The method may further comprise adding at least one of zinc oxide or titanium dioxide. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2% and a vitamin content of at least 20%.

In an embodiment, solutions of silk fibroin protein fragments having a weight average molecular weight selected from between about 39 kDa to about 80 kDa are prepared according to the following steps: adding a silk source to a boiling (100° C.) aqueous solution of sodium carbonate for a treatment time of about 30 minutes so as to result in degumming; removing sericin from the solution to produce a silk fibroin extract comprising non-detectable levels of sericin; draining the solution from the silk fibroin extract; dissolving the silk fibroin extract in a solution of lithium bromide having a starting temperature upon placement of the silk fibroin extract in the lithium bromide solution that ranges from about 80° C. to about 140° C.; maintaining the solution of silk fibroin-lithium bromide in a dry oven having a temperature in the range between about 60° C. to about 100° C. for a period of at most 1 hour; removing the lithium bromide from the silk fibroin extract; and producing an aqueous solution of silk fibroin protein fragments, wherein the aqueous solution of silk fibroin protein fragments comprises lithium bromide residuals of between about 10 ppm and about 300 ppm, sodium carbonate residuals of between about 10 ppm and about 100 ppm, fragments having a weight average molecular weight selected from between about 39 kDa to about 80 kDa, and a polydispersity of between 1 and about 5, or between about 1.5 and about 3.0. The method may further comprise drying the silk fibroin extract prior to the dissolving step. The aqueous solution of silk fibroin protein fragments may comprise lithium bromide residuals of less than 300 ppm as measured using a high-performance liquid chromatography lithium bromide assay. The aqueous solution of silk fibroin protein fragments may comprise sodium carbonate residuals of less than 100 ppm as measured using a high-performance liquid chromatography sodium carbonate assay. In some embodiments, the method may further comprise adding an active agent (e.g., therapeutic agent) to the aqueous solution of pure silk fibroin protein fragments. The method may further comprise adding an active agent selected from one of an antioxidant or an enzyme to the aqueous solution of pure silk fibroin protein fragments. The method may further comprise adding a vitamin to the aqueous solution of pure silk fibroin protein fragments. The vitamin may be vitamin C or a derivative thereof. The aqueous solution of pure silk fibroin protein fragments may be lyophilized. The method may further comprise adding an alpha-hydroxy acid to the aqueous solution of pure silk fibroin protein fragments. The alpha hydroxy acid may be selected from the group consisting of glycolic acid, lactic acid, tartaric acid and citric acid. The method may further comprise adding hyaluronic acid or its salt form at a concentration of about 0.5% to about 10.0% to the aqueous solution of pure silk fibroin protein fragments. A film may be fabricated from the aqueous solution of pure silk fibroin protein fragments produced by this method. The film may comprise from about 1.0 wt. % to about 50.0 wt. % of vitamin C or a derivative thereof. The film may have a water content ranging from about 2.0 wt. % to about 20.0 wt. %. The film may comprise from about 30.0 wt. % to about 99.5 wt. % of pure silk fibroin protein fragments. A gel may be fabricated from the aqueous solution of pure silk fibroin protein fragments produced by this method. The gel may comprise from about 0.5 wt. % to about 20.0 wt. % of vitamin C or a derivative thereof. The gel may have a silk content of at least 2 wt. % and a vitamin content of at least 20 wt. %.

Molecular weight of the silk protein fragments may be controlled based upon the specific parameters utilized during the extraction step, including extraction time and temperature; specific parameters utilized during the dissolution step, including the LiBr temperature at the time of submersion of the silk in to the lithium bromide and time that the solution is maintained at specific temperatures; and specific parameters utilized during the filtration step. By controlling process parameters using the disclosed methods, it is possible to create silk fibroin protein fragment solutions with polydispersity equal to or lower than 2.5 at a variety of different molecular weight selected from between 5 kDa to 200 kDa, or between 10 kDa and 80 kDa. By altering process parameters to achieve silk solutions with different molecular weights, a range of fragment mixture end products, with desired polydispersity of equal to or less than 2.5 may be targeted based upon the desired performance requirements.

For example, a higher molecular weight silk film containing an ophthalmic drug may have a controlled slow release rate compared to a lower molecular weight film making it ideal for a delivery vehicle in eye care products. Additionally, the silk fibroin protein fragment solutions with a polydispersity of greater than 2.5 can be achieved. Further, two solutions with different average molecular weights and polydispersity can be mixed to create combination solutions. Alternatively, a liquid silk gland (100% sericin free silk protein) that has been removed directly from a worm could be used in combination with any of the silk fibroin protein fragment solutions of the present disclosure. Molecular weight of the pure silk fibroin protein fragment composition was determined using High Pressure Liquid Chromatography (HPLC) with a Refractive Index Detector (RID). Polydispersity was calculated using Cirrus GPC Online GPC/SEC Software Version 3.3 (Agilent).

Differences in the processing parameters can result in regenerated silk fibroins that vary in molecular weight, and peptide chain size distribution (polydispersity, PD). This, in turn, influences the regenerated silk fibroin performance, including mechanical strength, water solubility etc.

Parameters were varied during the processing of raw silk cocoons into the silk solution. Varying these parameters affected the MW of the resulting silk solution. Parameters manipulated included (i) time and temperature of extraction, (ii) temperature of LiBr, (iii) temperature of dissolution oven, and (iv) dissolution time. Experiments were carried out to determine the effect of varying the extraction time. Tables A-G summarize the results. Below is a summary:
A sericin extraction time of 30 minutes resulted in larger molecular weight than a sericin extraction time of 60 minutes
Molecular weight decreases with time in the oven
140° C. LiBr and oven resulted in the low end of the confidence interval to be below a molecular weight of 9500 Da
30 min extraction at the 1 hour and 4 hour time points have undigested silk
30 min extraction at the 1 hour time point resulted in a significantly high molecular weight with the low end of the confidence interval being 35,000 Da
The range of molecular weight reached for the high end of the confidence interval was 18000 to 216000 Da (important for offering solutions with specified upper limit).

TABLE A
The effect of extraction time (30 min vs 60 min) on molecular
weight of silk processed under the conditions of 100°
C. Extraction Temperature, 100° C. Lithium Bromide (LiBr)
and 100° C. Oven Dissolution (Oven/Dissolution Time was varied).

| Boil | Oven | Average | Std | | | |
|---|---|---|---|---|---|---|
| Time | Time | Mw | dev | Confidence Interval | | PD |
| 30 | 1 | 57247 | 12780 | 35093 | 93387 | 1.63 |
| 60 | 1 | 31520 | 1387 | 11633 | 85407 | 2.71 |
| 30 | 4 | 40973 | 2632 | 14268 | 117658 | 2.87 |
| 60 | 4 | 25082 | 1248 | 10520 | 59803 | 2.38 |
| 30 | 6 | 25604 | 1405 | 10252 | 63943 | 2.50 |
| 60 | 6 | 20980 | 1262 | 10073 | 43695 | 2.08 |

TABLE B
The effect of extraction time (30 min vs 60 min) on
molecular weight of silk processed under the conditions
of 100° C. Extraction Temperature, boiling Lithium
Bromide (LiBr) and 60° C. Oven Dissolution for 4 hr.

| | Boil | Average | Std | | | |
|---|---|---|---|---|---|---|
| Sample | Time | Mw | dev | Confidence Interval | | PD |
| 30 min, 4 hr | 30 | 49656 | 4580 | 17306 | 142478 | 2.87 |
| 60 min, 4 hr | 60 | 30042 | 1536 | 11183 | 80705 | 2.69 |

TABLE C
The effect of extraction time (30 min vs 60 min) on molecular
weight of silk processed under the conditions of 100°
C. Extraction Temperature, 60° C. Lithium Bromide (LiBr)
and 60° C. Oven Dissolution (Oven/Dissolution Time was varied).

| | Boil | Oven | Average | Std | | | |
|---|---|---|---|---|---|---|---|
| Sample | Time | Time | Mw | dev | Confidence Interval | | PD |
| 30 min, | 30 | 1 | 58436 | | 22201 | 153809 | 2.63 |
| 1 hr | | | | | | | |
| 60 min, | 60 | 1 | 31700 | | 11931 | 84224 | 2.66 |
| 1 hr | | | | | | | |
| 30 min, | 30 | 4 | 61956.5 | 13337 | 21463 | 178847 | 2.89 |
| 4 hr | | | | | | | |
| 60 min, | 60 | 4 | 25578.5 | 2446 | 9979 | 65564 | 2.56 |
| 4 hr | | | | | | | |

TABLE D
The effect of extraction time (30 min vs 60 min) on
molecular weight of silk processed under the conditions
of 100° C. Extraction Temperature, 80° C.
Lithium Bromide (LiBr) and 80° C. Oven Dissolution for 6 hr.

| | Boil | Average | Std | | | |
|---|---|---|---|---|---|---|
| Sample | Time | Mw | dev | Confidence Interval | | PD |
| 30 min, 6 hr | 30 | 63510 | | 18693 | 215775 | 3.40 |
| 60 min, 6 hr | 60 | 25164 | 238 | 9637 | 65706 | 2.61 |

TABLE E
The effect of extraction time (30 min vs 60 min) on molecular
weight of silk processed under the conditions of 100°
C. Extraction Temperature, 80° C. Lithium Bromide (LiBr)
and 60° C. Oven Dissolution (Oven/Dissolution Time was varied).

| | Boil | Oven | Average | Std | | | |
|---|---|---|---|---|---|---|---|
| Sample | Time | Time | Mw | dev | Confidence Interval | | PD |
| 30 min, | 30 | 4 | 59202 | 14028 | 19073 | 183760 | 3.10 |
| 4 hr | | | | | | | |
| 60 min, | 60 | 4 | 26312.5 | 637 | 10266 | 67442 | 2.56 |
| 4 hr | | | | | | | |
| 30 min, | 30 | 6 | 46824 | | 18076 | 121293 | 2.59 |
| 6 hr | | | | | | | |
| 60 min, | 60 | 6 | 26353 | | 10168 | 68302 | 2.59 |
| 6 hr | | | | | | | |

TABLE F
The effect of extraction time (30 min vs 60 min) on molecular
weight of silk processed under the conditions of 100°
C. Extraction Temperature, 140° C. Lithium Bromide (LiBr)
and 140° C. Oven Dissolution (Oven/Dissolution Time was varied).

| | Boil | Oven | Average | Std | Confidence | | |
|---|---|---|---|---|---|---|---|
| Sample | Time | Time | Mw | dev | Interval | | PD |
| 30 min, 4 hr | 30 | 4 | 9024.5 | 1102 | 4493 | 18127 | 2.00865 |
| 60 min, 4 hr | 60 | 4 | 15548 | | 6954 | 34762 | 2.2358 |
| 30 min, 6 hr | 30 | 6 | 13021 | | 5987 | 28319 | 2.1749 |
| 60 min, 6 hr | 60 | 6 | 10888 | | 5364 | 22100 | 2.0298 |

Experiments were carried out to determine the effect of varying the extraction temperature. Table G summarizes the results. Below is a summary:
Sericin extraction at 90° C. resulted in higher MW than sericin extraction at 100° C. extraction
Both 90° C. and 100° C. show decreasing MW over time in the oven.

TABLE G
The effect of extraction temperature (90° C. vs.
100° C.) on molecular weight of silk processed
under the conditions of 60 min. Extraction Temperature,
100° C. Lithium Bromide (LiBr) and 100° C.
Oven Dissolution (Oven/Dissolution Time was varied).

| | Boil | Oven | Average | Std | | | |
|---|---|---|---|---|---|---|---|
| Sample | Time | Time | Mw | dev | Confidence Interval | | PD |
| 90° C., 4 hr | 60 | 4 | 37308 | 4204 | 13368 | 104119 | 2.79 |
| 100° C., 4 hr | 60 | 4 | 25082 | 1248 | 10520 | 59804 | 2.38 |
| 90° C., 6 hr | 60 | 6 | 34224 | 1135 | 12717 | 92100 | 2.69 |
| 100° C., 6 hr | 60 | 6 | 20980 | 1262 | 10073 | 43694 | 2.08 |

Experiments were carried out to determine the effect of varying the Lithium Bromide (LiBr) temperature when added to silk. Tables H-I summarize the results. Below is a summary:
No impact on molecular weight or confidence interval (all CI ˜10500-6500 Da)
Studies illustrated that the temperature of LiBr-silk dissolution, as LiBr is added and begins dissolving, rapidly drops below the original LiBr temperature due to the majority of the mass being silk at room temperature

TABLE H
The effect of Lithium Bromide (LiBr) temperature on molecular
weight of silk processed under the conditions of 60 min.
Extraction Time., 100° C. Extraction Temperature and
60° C. Oven Dissolution (Oven/Dissolution Time was varied).

| | LiBr | | | | | | |
|---|---|---|---|---|---|---|---|
| | Temp | Oven | Average | Std | | | |
| Sample | (° C.) | Time | Mw | dev | Confidence Interval | | PD |
| 60° C. | 60 | 1 | 31700 | | 11931 | 84223 | 2.66 |
| LiBr, | | | | | | | |
| 1 hr | | | | | | | |
| 100° C. | 100 | 1 | 27907 | 200 | 10735 | 72552 | 2.60 |
| LiBr, | | | | | | | |
| 1 hr | | | | | | | |
| RT LiBr, | RT | 4 | 29217 | 1082 | 10789 | 79119 | 2.71 |
| 4 hr | | | | | | | |
| 60° C. | 60 | 4 | 25578 | 2445 | 9978 | 65564 | 2.56 |
| LiBr, | | | | | | | |
| 4 hr | | | | | | | |
| 80° C. | 80 | 4 | 26312 | 637 | 10265 | 67441 | 2.56 |
| LiBr, | | | | | | | |
| 4 hr | | | | | | | |
| 100° C. | 100 | 4 | 27681 | 1729 | 11279 | 67931 | 2.45 |
| LiBr, | | | | | | | |
| 4 hr | | | | | | | |
| Boil LiBr, | Boil | 4 | 30042 | 1535 | 11183 | 80704 | 2.69 |
| 4 hr | | | | | | | |
| RT LiBr, | RT | 6 | 26543 | 1893 | 10783 | 65332 | 2.46 |
| 6 hr | | | | | | | |
| 80° C. | 80 | 6 | 26353 | | 10167 | 68301 | 2.59 |
| LiBr, | | | | | | | |
| 6 hr | | | | | | | |
| 100° C. | 100 | 6 | 27150 | 916 | 11020 | 66889 | 2.46 |
| LiBr, | | | | | | | |
| 6 hr | | | | | | | |

TABLE I
The effect of Lithium Bromide (LiBr) temperature on molecular
weight of silk processed under the conditions of 30 min.
Extraction Time, 100° C. Extraction Temperature and
60° C. Oven Dissolution (Oven/Dissolution Time was varied).

| | LiBr | | | | | | |
|---|---|---|---|---|---|---|---|
| | Temp | Oven | Average | Std | Confidence | | |
| Sample | (° C.) | Time | Mw | dev | Interval | | PD |
| 60° C. | 60 | 4 | 61956 | 13336 | 21463 | 178847 | 2.89 |
| LiBr, | | | | | | | |
| 4 hr | | | | | | | |
| 80° C. | 80 | 4 | 59202 | 14027 | 19073 | 183760 | 3.10 |
| LiBr, | | | | | | | |
| 4 hr | | | | | | | |
| 100° C. | 100 | 4 | 47853 | | 19757 | 115899 | 2.42 |
| LiBr, | | | | | | | |
| 4 hr | | | | | | | |
| 80° C. | 80 | 6 | 46824 | | 18075 | 121292 | 2.59 |
| LiBr, | | | | | | | |
| 6 hr | | | | | | | |
| 100° C. | 100 | 6 | 55421 | 8991 | 19152 | 160366 | 2.89 |
| LiBr, | | | | | | | |
| 6 hr | | | | | | | |

Experiments were carried out to determine the effect of v oven/dissolution temperature. Tables J-N summarize the results. Below is a summary:
Oven temperature has less of an effect on 60 min extracted silk than 30 mi extracted silk. Without wishing to be bound by theory, it is believed that the 30 min silk is less degraded during extraction and therefore the oven temperature has more of an effect on the larger MW, less degraded portion of the silk.
For 60 CC vs. 140° C. oven the 30 min extracted silk showed a very significant effect of lower MW at higher oven temp, while 60 min extracted silk had an effect but much less
The 140° C. oven resulted in a low end in the confidence interval at −6000 Da.

TABLE J
The effect of oven/dissolution temperature on molecular weight
of silk processed under the conditions of 100° C. Extraction
Temperature, 30 min. Extraction Time, and 100° C. Lithium
Bromide (LiBr) (Oven/Dissolution Time was varied).

| | Oven | | | | | | |
|---|---|---|---|---|---|---|---|
| Boil | Temp | Oven | Average | Std | Confidence | | |
| Time | (° C.) | Time | Mw | dev | Interval | | PD |
| 30 | 60 | 4 | 47853 | | 19758 | 115900 | 2.42 |
| 30 | 100 | 4 | 40973 | 2632 | 14268 | 117658 | 2.87 |
| 30 | 60 | 6 | 55421 | 8992 | 19153 | 160366 | 2.89 |
| 30 | 100 | 6 | 25604 | 1405 | 10252 | 63943 | 2.50 |

TABLE K
The effect of oven/dissolution temperature on molecular weight
of silk processed under the conditions of 100° C. Extraction
Temperature, 60 min. Extraction Time, and 100° C. Lithium
Bromide (LiBr) (Oven/Dissolution Time was varied).

| Boil Time | Oven | Oven | Average | Std | Confidence | | |
|---|---|---|---|---|---|---|---|
| (minutes) | Temp | Time | Mw | dev | Interval | | PD |
| 60 | 60 | 1 | 27908 | 200 | 10735 | 72552 | 2.60 |
| 60 | 100 | 1 | 31520 | 1387 | 11633 | 85407 | 2.71 |
| 60 | 60 | 4 | 27681 | 1730 | 11279 | 72552 | 2.62 |
| 60 | 100 | 4 | 25082 | 1248 | 10520 | 59803 | 2.38 |
| 60 | 60 | 6 | 27150 | 916 | 11020 | 66889 | 2.46 |
| 60 | 100 | 6 | 20980 | 1262 | 10073 | 43695 | 2.08 |

TABLE L
The effect of oven/dissolution temperature on molecular weight of silk processed
under the conditions of 100° C. Extraction Temperature, 60 min. Extraction
Time, and 140° C. Lithium Bromide (LiBr) (Oven/Dissolution Time was varied).

| Boil Time | Oven | Oven | | Std | Confidence | | |
|---|---|---|---|---|---|---|---|
| (minutes) | Temp(° C.) | Time | Average | dev | Interval | | PD |
| 60 | 60 | 4 | 30042 | 1536 | 11183 | 80705 | 2.69 |
| 60 | 140 | 4 | 15548 | | 7255 | 33322 | 2.14 |

TABLE M
The effect of oven/dissolution temperature on molecular weight
of silk processed under the conditions of 100° C. Extraction
Temperature, 30 min. Extraction Time, and 140° C. Lithium
Bromide (LiBr) (Oven/Dissolution Time was varied).

| | Oven | | | | | | |
|---|---|---|---|---|---|---|---|
| Boil Time | Temp | Oven | Average | Std | Confidence | | |
| (minutes) | (° C.) | Time | Mw | dev | Interval | | PD |
| 30 | 60 | 4 | 49656 | 4580 | 17306 | 142478 | 2.87 |
| 30 | 140 | 4 | 9025 | 1102 | 4493 | 18127 | 2.01 |
| 30 | 60 | 6 | 59383 | 11640 | 17641 | 199889 | 3.37 |
| 30 | 140 | 6 | 13021 | | 5987 | 28319 | 2.17 |

TABLE N
The effect of oven/dissolution temperature on molecular weight
of silk processed under the conditions of 100° C. Extraction
Temperature, 60 min. Extraction Time, and 80° C. Lithium
Bromide (LiBr) (Oven/Dissolution Time was varied).

| | Oven | | | | | | |
|---|---|---|---|---|---|---|---|
| Boil Time | Temp | Oven | Average | Std | Confidence | | |
| (minutes) | (° C.) | Time | Mw | dev | Interval | | PD |
| 60 | 60 | 4 | 26313 | 637 | 10266 | 67442 | 2.56 |
| 60 | 80 | 4 | 30308 | 4293 | 12279 | 74806 | 2.47 |
| 60 | 60 | 6 | 26353 | | 10168 | 68302 | 2.59 |
| 60 | 80 | 6 | 25164 | 238 | 9637 | 65706 | 2.61 |

The raw silk cocoons from the silkworm Bombyx mori was cut into pieces. The pieces of raw silk cocoons were boiled in an aqueous solution of Na₂CO₃ (about 100° C.) for a period of time between about 30 minutes to about 60 minutes to remove sericin (degumming). The volume of the water used equals about 0.4× raw silk weight and the amount of Na₂CO₃ is about 0.848× the weight of the raw silk cocoon pieces. The resulting degummed silk cocoon pieces were rinsed with deionized water three times at about 60° C. (20 minutes per rinse). The volume of rinse water for each cycle was 0.2 L×the weight of the raw silk cocoon pieces. The excess water from the degummed silk cocoon pieces was removed. After the DI water washing step, the wet degummed silk cocoon pieces were dried at room temperature. The degummed silk cocoon pieces were mixed with a LiBr solution, and the mixture was heated to about 100° C. The warmed mixture was placed in a dry oven and was heated at a temperature ranging from about 60° C. to about 140° C. for about 60 minutes to achieve complete dissolution of the native silk protein. The resulting solution was allowed to cool to room temperature and then was dialyzed to remove LiBr salts using a 3,500 Da MWCO membrane. Multiple exchanges were performed in Di water until Br ions were less than 1 ppm as determined in the hydrolyzed fibroin solution read on an Oakton Bromide (Br) double-junction ion-selective electrode.

The resulting silk fibroin aqueous solution has a concentration of about 8.0% w/v containing pure silk fibroin protein fragments having an average weight average molecular weight selected from between about 6 kDa to about 16 kDa, about 17 kDa to about 39 kDa, and about 39 kDa to about 80 kDa and a polydispersity of between about 1.5 and about 3.0. The 8.0% w/v was diluted with DI water to provide a 1.0% w/v, 2.0% w/v, 3.0% w/v, 4.0% w/v, 5.0% w/v by the coating solution.

A variety of % silk concentrations have been produced through the use of Tangential Flow Filtration (TFF). In all cases a 1% silk solution was used as the input feed. A range of 750-18,000 mL of 1% silk solution was used as the starting volume. Solution is diafiltered in the TFF to remove lithium bromide. Once below a specified level of residual LiBr, solution undergoes ultrafiltration to increase the concentration through removal of water. See examples below.

Six (6) silk solutions were utilized in standard silk structures with the following results:

Solution #1 is a silk concentration of 5.9 wt. %, average MW of 19.8 kDa and 2.2 PDI (made with a 60 min boil extraction, 100° C. LiBr dissolution for 1 hour).

Solution #2 is a silk concentration of 6.4 wt. % (made with a 30 min boil extraction, 60° C. LiBr dissolution for 4 hrs).

Solution #3 is a silk concentration of 6.17 wt. % (made with a 30 min boil extraction 100° C. LiBr dissolution for 1 hour).

Solution #4 is a silk concentration of 7.30 wt. %: A 7.30% silk solution was produced beginning with 30 minute extraction batches of 100 g silk cocoons per batch. Extracted silk fibers were then dissolved using 100° C. 9.3 M LiBr in a 100° C. oven for 1 hour. 100 g of silk fibers were dissolved per batch to create 20% silk in LiBr. Dissolved silk in LiBr was then diluted to 1% silk and filtered through a 5 μm filter to remove large debris. 15,500 mL of 1%, filtered silk solution was used as the starting volume/diafiltration volume for TFF. Once LiBr was removed, the solution was ultrafiltered to a volume around 1300 mL. 1262 mL of 7.30% silk was then collected. Water was added to the feed to help remove the remaining solution and 547 mL of 3.91% silk was then collected.

Solution #5 is a silk concentration of 6.44 wt. %: A 6.44 wt. % silk solution was produced beginning with 60 minute extraction batches of a mix of 25, 33, 50, 75 and 100 g silk cocoons per batch. Extracted silk fibers were then dissolved using 100° C. 9.3 M LiBr in a 100° C. oven for 1 hour. 35, 42, 50 and 71 g per batch of silk fibers were dissolved to create 20% silk in LiBr and combined. Dissolved silk in LiBr was then diluted to 1% silk and filtered through a 5 μm filter to remove large debris. 17,000 mL of 1%, filtered silk solution was used as the starting volume/diafiltration volume for TFF. Once LiBr was removed, the solution was ultrafiltered to a volume around 3000 mL. 1490 mL of 6.44% silk was then collected. Water was added to the feed to help remove the remaining solution and 1454 mL of 4.88% silk was then collected.

Solution #6 is a silk concentration of 2.70 wt. %: A 2.70% silk solution was produced beginning with 60-minute extraction batches of 25 g silk cocoons per batch. Extracted silk fibers were then dissolved using 100° C. 9.3 M LiBr in a 100° C. oven for 1 hour. 35.48 g of silk fibers were dissolved per batch to create 20% silk in LiBr. Dissolved silk in LiBr was then diluted to 1% silk and filtered through a 5 μm filter to remove large debris. 1000 mL of 1%, filtered silk solution was used as the starting volume/diafiltration volume for TFF. Once LiBr was removed, the solution was ultrafiltered to a volume around 300 mL. 312 mL of 2.7% silk was then collected.

The preparation of silk fibroin solutions with higher molecular weights is given in Table O.

TABLE O
Preparation and properties of silk fibroin solutions.

| | | | | | Average | |
|---|---|---|---|---|---|---|
| | | | | | weight | |
| | | | | | average | |
| | Extraction | Extraction | LiBr | | molecular | Average |
| Sample | Time | Temp | Temp | Oven/Sol'n | weight | poly- |
| Name | (mins) | (° C.) | (° C.) | Temp | (kDa) | dispersity |
| Group A | 60 | 100 | 100 | 100° C. | 34.7 | 2.94 |
| TFF | | | | oven | | |
| Group A | 60 | 100 | 100 | 100° C. | 44.7 | 3.17 |
| DIS | | | | oven | | |
| Group B | 60 | 100 | 100 | 100° C. | 41.6 | 3.07 |
| TFF | | | | sol'n | | |
| Group B | 60 | 100 | 100 | 100° C. | 44.0 | 3.12 |
| DIS | | | | sol'n | | |
| Group D | 30 | 90 | 60 | 60° C. | 129.7 | 2.56 |
| DIS | | | | sol'n | | |
| Group D | 30 | 90 | 60 | 60° C. | 144.2 | 2.73 |
| FIL | | | | sol'n | | |
| Group E | 15 | 100 | RT | 60° C. | 108.8 | 2.78 |
| DIS | | | | sol'n | | |
| Group E | 15 | 100 | RT | 60° C. | 94.8 | 2.62 |
| FIL | | | | sol'n | | |

Silk aqueous coating composition for application to fabrics are given in Tables P and Q below.

TABLE P
Silk Solution Characteristics

| | Molecular Weight: | 57 | kDa | | | |
|---|---|---|---|---|---|---|
| | Polydispersity: | 1.6 | | | | |
| | % Silk | 5.0% | | 3.0% | 1.0% | 0.5% |
| Process | Extraction | | | | | |
| Parameters | Boil Time: | 30 | minutes | | | |
| | Boil Temperature: | 100° | C. | | | |
| | Rinse Temperature: | 60° | C. | | | |
| | Dissolution | | | | | |
| | LiBr Temperature: | 100 | | | | |
| | Oven Temperature: | 100° | C. | | | |
| | Oven Time: | 60 | minutes | | | |

TABLE Q
Silk Solution Characteristics

| | Molecular Weight: | 25 | kDa | | | |
|---|---|---|---|---|---|---|
| | Polydispersity: | 2.4 | | | | |
| | % Silk | 5.0% | | 3.0% | 1.0% | 0.5% |
| Process | Extraction | | | | | |
| Parameters | Boil Time: | 60 | minutes | | | |
| | Boil Temperature: | 100° | C. | | | |
| | Rinse Temperature: | 60° | C. | | | |
| | Dissolution | | | | | |
| | LiBr Temperature: | 100° | C. | | | |
| | Oven Temperature: | 100° | C. | | | |
| | Oven Time: | 60 | minutes | | | |

Three (3) silk solutions were utilized in film making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

Films were made in accordance with Rockwood et al. (Nature Protocols; Vol. 6; No. 10; published on-line Sep. 22, 2011; doi:10.1038/nprot.2011.379). 4 mL of 1% or 2% (wt/vol) aqueous silk solution was added into 100 mm Petri dish (Volume of silk can be varied for thicker or thinner films and is not critical) and allowed to dry overnight uncovered. The bottom of a vacuum desiccator was filled with water. Dry films were placed in the desiccator and vacuum applied, allowing the films to water anneal for 4 hours prior to removal from the dish. Films cast from solution #1 did not result in a structurally continuous film; the film was cracked in several pieces. These pieces of film dissolved in water in spite of the water annealing treatment.

Silk solutions of various molecular weights and/or combinations of molecular weights can be optimized for gel applications. The following provides an example of this process but it not intended to be limiting in application or formulation. Three (3) silk solutions were utilized in gel making with the following results:

Solution #1 is a silk concentration of 5.9%, average MW of 19.8 kDa and 2.2 PD (made with a 60 min boil extraction, 100° C. LiBr dissolution for 1 hr).

Solution #2 is a silk concentration of 6.4% (made with a 30 min boil extraction, 60° C. LiBr dissolution for 4 hrs).

Solution #3 is a silk concentration of 6.17% (made with a 30 min boil extraction, 100° C. LiBr dissolution for 1 hour).

“Egel” is an electrogelation process as described in Rockwood of al. Briefly, 10 ml of aqueous silk solution is added to a 50 ml conical tube and a pair of platinum wire electrodes immersed into the silk solution. A 20 volt potential was applied to the platinum electrodes for 5 minutes, the power supply turned off and the gel collected. Solution #1 did not form an EGEL over the 5 minutes of applied electric current.

Solutions #2 and #3 were gelled in accordance with the published horseradish peroxidase (HRP) protocol. Behavior seemed typical of published solutions.

Materials and Methods: the following equipment and material are used in determination of Silk Molecular weight: Agilent 1100 with chemstation software ver. 10.01; Refractive Index Detector (RID); analytical balance; volumetric flasks (1000 mL, 10 mL and 5 mL); HPLC grade water; ACS grade sodium chloride; ACS grade sodium phosphate dibasic heptahydrate; phosphoric acid; dextran MW Standards-Nominal Molecular Weights of 5 kDa, 11.6 kDa, 23.8 kDa, 48.6 kDa, and 148 kDa; 50 mL PET or polypropylene disposable centrifuge tubes; graduated pipettes; amber glass HPLC vials with Teflon caps; Phenomenex PolySep GFC P-4000 column (size: 7.8 mm×300 mm).

### Procedural Steps

A) Preparation of 1 L Mobile Phase (0.1 M Sodium Chloride solution in 0.0125 M Sodium phosphate buffer)

Take a 250 mL clean and dry beaker, place it on the balance and tare the weight. Add about 3.3509 g of sodium phosphate dibasic heptahydrate to the beaker. Note down the exact weight of sodium phosphate dibasic weighed. Dissolve the weighed sodium phosphate by adding 100 mL of HPLC water into the beaker. Take care not to spill any of the content of the beaker. Transfer the solution carefully into a clean and dry 1000 mL volumetric flask. Rinse the beaker and transfer the rinse into the volumetric flask. Repeat the rinse 4-5 times. In a separate clean and dry 250 mL beaker weigh exactly about 5.8440 g of sodium chloride. Dissolve the weighed sodium chloride in 50 mL of water and transfer the solution to the sodium phosphate solution in the volumetric flask. Rinse the beaker and transfer the rinse into the volumetric flask. Adjust the pH of the solution to 7.0±0.2 with phosphoric acid. Make up the volume in volumetric flask with HPLC water to 1000 mL and shake it vigorously to homogeneously mix the solution. Filter the solution through 0.45 μm polyamide membrane filter. Transfer the solution to a clean and dry solvent bottle and label the bottle. The volume of the solution can be varied to the requirement by correspondingly varying the amount of sodium phosphate dibasic heptahydrate and sodium chloride.

### B) Preparation of Dextran Molecular Weight Standard Solutions

At least five different molecular weight standards are used for each batch of samples that are run so that the expected value of the sample to be tested is bracketed by the value of the standard used. Label six 20 mL scintillation glass vials respective to the molecular weight standards. Weigh accurately about 5 mg of each of dextran molecular weight standards and record the weights. Dissolve the dextran molecular weight standards in 5 mL of mobile phase to make a 1 mg/mL standard solution.

### C) Preparation of Sample Solutions

When preparing sample solutions, if there are limitations on how much sample is available, the preparations may be scaled as long as the ratios are maintained. Depending on sample type and silk protein content in sample weigh enough sample in a 50 mL disposable centrifuge tube on an analytical balance to make a 1 mg/mL sample solution for analysis. Dissolve the sample in equivalent volume of mobile phase make a 1 mg/mL solution. Tightly cap the tubes and mix the samples (in solution). Leave the sample solution for 30 minutes at room temperature. Gently mix the sample solution again for 1 minute and centrifuge at 4000 RPM for 10 minutes.

### D) HPLC Analysis of the Samples

Transfer 1.0 mL of all the standards and sample solutions into individual HPLC vials. Inject the molecular weight standards (one injection each) and each sample in duplicate. Analyze all the standards and sample solutions using the following HPLC conditions:

| | |
|---|---|
| Column | PolySep GFC P-4000 (7.8 × 300 mm) |
| Column Temperature | 25° C. |
| Detector | Refractive Index Detector (Temperature @ |
| | 35° C.) |
| Injection Volume | 25.0 μL |
| Mobile Phase | 0.1M Sodium Chloride solution in 0.0125M |
| | sodium phosphate buffer |
| Flow Rate | 1.0 mL/min |
| Run Time | 20.0 min |

### E) Data Analysis and Calculations—Calculation of Average Molecular Weight Using Cirrus Software

Upload the chromatography data files of the standards and the analytical samples into Cirrus SEC data collection and molecular weight analysis software. Calculate the weight average molecular weight (M_{w}), number average molecular weight (Mₙ), peak average molecular weight (Mₚ), and polydispersity for each injection of the sample.

### Spider Silk Fragments

Spider silks are natural polymers that consist of three domains: a repetitive middle core domain that dominates the protein chain, and non-repetitive N-terminal and C-terminal domains. The large core domain is organized in a block copolymer-like arrangement, in which two basic sequences, crystalline [poly(A) or poly(GA)] and less crystalline (GGX or GPGXX) polypeptides alternate. Dragline silk is the protein complex composed of major ampullate dragline silk protein 1 (MaSp1) and major ampullate dragline silk protein 2 (MaSp2). Both silks are approximately 3500 amino acid long. MaSp1 can be found in the fibre core and the periphery, whereas MaSp2 forms clusters in certain core areas. The large central domains of MaSp1 and MaSp2 are organized in block copolymer-like arrangements, in which two basic sequences, crystalline [poly(A) or poly(GA)] and less crystalline (GGX or GPGXX) polypeptides alternate in core domain. Specific secondary structures have been assigned to poly(A)/(GA), GGX and GPGXX motifs including β-sheet, α-helix and β-spiral respectively. The primary sequence, composition and secondary structural elements of the repetitive core domain are responsible for mechanical properties of spider silks; whereas, non-repetitive N- and C-terminal domains are essential for the storage of liquid silk dope in a lumen and fibre formation in a spinning duct.

The main difference between MaSp1 and MaSp2 is the presence of proline (P) residues accounting for 15% of the total amino acid content in MaSp2, whereas MaSp1 is proline-free. By calculating the number of proline residues in N. clavipes dragline silk, it is possible to estimate the presence of the two proteins in fibres; 81% MaSp1 and 19% MaSp2. Different spiders have different ratios of MaSp1 and MaSp2. For example, a dragline silk fibre from the orb weaver Argiope aurantia contains 41% MaSp1 and 59% MaSp2. Such changes in the ratios of major ampullate silks can dictate the performance of the silk fibre.

At least seven different types of silk proteins are known for one orb-weaver species of spider. Silks differ in primary sequence, physical properties and functions. For example, dragline silks used to build frames, radii and lifelines are known for outstanding mechanical properties including strength, toughness and elasticity. On an equal weight basis, spider silk has a higher toughness than steel and Kevlar. Flageliform silk found in capture spirals has extensibility of up to 500%. Minor ampullate silk, which is found in auxiliary spirals of the orb-web and in prey wrapping, possesses high toughness and strength almost similar to major ampullate silks, but does not supercontract in water.

Spider silks are known for their high tensile strength and toughness. The recombinant silk proteins also confer advantageous properties to cosmetic or dermatological compositions, in particular to be able to improve the hydrating or softening action, good film forming property and low surface density. Diverse and unique biomechanical properties together with biocompatibility and a slow rate of degradation make spider silks excellent candidates as biomaterials for tissue engineering, guided tissue repair and drug delivery, for cosmetic products (e.g. nail and hair strengthener, skin care products), and industrial materials (e.g. nanowires, nanofibers, surface coatings).

In an embodiment, a silk protein may include a polypeptide derived from natural spider silk proteins. The polypeptide is not limited particularly as long as it is derived from natural spider silk proteins, and examples of the polypeptide include natural spider silk proteins and recombinant spider silk proteins such as variants, analogs, derivatives or the like of the natural spider silk proteins. In terms of excellent tenacity, the polypeptide may be derived from major dragline silk proteins produced in major ampullate glands of spiders. Examples of the major dragline silk proteins include major ampullate spidroin MaSp1 and MaSp2 from Nephila clavipes, and ADF3 and ADF4 from Araneus diadematus, etc. Examples of the polypeptide derived from major dragline silk proteins include variants, analogs, derivatives or the like of the major dragline silk proteins. Further, the polypeptide may be derived from flagelliform silk proteins produced in flagelliform glands of spiders. Examples of the flagelliform silk proteins include flagelliform silk proteins derived from Nephila clavipes, etc.

Examples of the polypeptide derived from major dragline silk proteins include a polypeptide containing two or more units of an amino acid sequence represented by the formula 1: REP1-REP2 (1), preferably a polypeptide containing five or more units thereof, and more preferably a polypeptide containing ten or more units thereof. Alternatively, the polypeptide derived from major dragline silk proteins may be a polypeptide that contains units of the amino acid sequence represented by the formula 1: REP1-REP2 (1) and that has, at a C-terminal, an amino acid sequence represented by any of SEQ ID NOS: 1 to 3 of U.S. Pat. No. 9,051,453 or an amino acid sequence having a homology of 90% or more with the amino acid sequence represented by any of SEQ ID NOS: 1 to 3 of U.S. Pat. No. 9,051,453. In the polypeptide derived from major dragline silk proteins, units of the amino acid sequence represented by the formula 1: REP1-REP2 (1) may be the same or may be different from each other. In the case of producing a recombinant protein using a microbe such as Escherichia coli as a host, the molecular weight of the polypeptide derived from major dragline silk proteins is 500 kDa or less, or 300 kDa or less, or 200 kDa or less, in terms of productivity.

In the formula (1), the REP1 indicates polyalanine. In the REP1, the number of alanine residues arranged in succession is preferably 2 or more, more preferably 3 or more, further preferably 4 or more, and particularly preferably 5 or more. Further, in the REP1, the number of alanine residues arranged in succession is preferably 20 or less, more preferably 16 or less, further preferably 12 or less, and particularly preferably 10 or less. In the formula (1), the REP2 is an amino acid sequence composed of 10 to 200 amino acid residues. The total number of glycine, serine, glutamine and alanine residues contained in the amino acid sequence is 40% or more, preferably 60% or more, and more preferably 70% or more with respect to the total number of amino acid residues contained therein.

In the major dragline silk, the REP1 corresponds to a crystal region in a fiber where a crystal β sheet is formed, and the REP2 corresponds to an amorphous region in a fiber where most of the parts lack regular configurations and that has more flexibility. Further, the [REP1-REP2] corresponds to a repetitious region (repetitive sequence) composed of the crystal region and the amorphous region, which is a characteristic sequence of dragline silk proteins.

### Recombinant Silk Fragments

In some embodiments, the recombinant silk protein refers to recombinant spider silk polypeptides, recombinant insect silk polypeptides, or recombinant mussel silk polypeptides. In some embodiments, the recombinant silk protein fragment disclosed herein include recombinant spider silk polypeptides of Araneidae or Araneoids, or recombinant insect silk polypeptides of Bombyx mori. In some embodiments, the recombinant silk protein fragment disclosed herein include recombinant spider silk polypeptides of Araneidae or Araneoids. In some embodiments, the recombinant silk protein fragment disclosed herein include block copolymer having repetitive units derived from natural spider silk polypeptides of Araneidae or Araneoids. In some embodiments, the recombinant silk protein fragment disclosed herein include block copolymer having synthetic repetitive units derived from spider silk polypeptides of Araneidae or Araneoids and non-repetitive units derived from natural repetitive units of spider silk polypeptides of Araneidae or Araneoids.

Recent advances in genetic engineering have provided a route to produce various types of recombinant silk proteins. Recombinant DNA technology has been used to provide a more practical source of silk proteins. As used herein “recombinant silk protein” refers to synthetic proteins produced heterologously in prokaryotic or eukaryotic expression systems using genetic engineering methods.

Various methods for synthesizing recombinant silk peptides are known and have been described by Ausubel et al., Current Protocols in Molecular Biology § 8 (John Wiley & Sons 1987, (1990)), incorporated herein by reference. A gram-negative, rod-shaped bacterium E. coli is a well-established host for industrial scale production of proteins. Therefore, the majority of recombinant silks have been produced in E. coli. E. coli which is easy to manipulate, has a short generation time, is relatively low cost and can be scaled up for larger amounts protein production.

The recombinant silk proteins can be produced by transformed prokaryotic or eukaryotic systems containing the cDNA coding for a silk protein, for a fragment of this protein or for an analog of such a protein. The recombinant DNA approach enables the production of recombinant silks with programmed sequences, secondary structures, architectures and precise molecular weight. There are four main steps in the process: (i) design and assembly of synthetic silk-like genes into genetic ‘cassettes’ (ii) insertion of this segment into a DNA recombinant vector, (iii) transformation of this recombinant DNA molecule into a host cell and (iv) expression and purification of the selected clones.

The term “recombinant vectors”, as used herein, includes any vectors known to the skilled person including plasmid vectors, cosmid vectors, phage vectors such as lambda phage, viral vectors such as adenoviral or baculoviral vectors, or artificial chromosome vectors such as bacterial artificial chromosomes (BAC), yeast artificial chromosomes (YAC), or P1 artificial chromosomes (PAC). Said vectors include expression as well as cloning vectors. Expression vectors comprise plasmids as well as viral vectors and generally contain a desired coding sequence and appropriate DNA sequences necessary for the expression of the operably linked coding sequence in a particular host organism (e.g., bacteria, yeast, or plant) or in in vitro expression systems. Cloning vectors are generally used to engineer and amplify a certain desired DNA fragment and may lack functional sequences needed for expression of the desired DNA fragments.

The prokaryotic systems include Gram-negative bacteria or Gram-positive bacteria. The prokaryotic expression vectors can include an origin of replication which can be recognized by the host organism, a homologous or heterologous promoter which is functional in the said host, the DNA sequence coding for the spider silk protein, for a fragment of this protein or for an analogous protein. Nonlimiting examples of prokaryotic expression organisms are Escherichia coli, Bacillus subtilis, Bacillus megaterium, Corynebacterium glutamicum, Anabaena, Caulobacter, Gluconobacter, Rhodobacter, Pseudomonas, Para coccus, Bacillus (e.g. Bacillus subtilis) Brevibacterium, Corynebacterium, Rhizobium (Sinorhizobium), Flavobacterium, Klebsiella, Enterobacter, Lactobacillus, Lactococcus, Methylobacterium, Propionibacterium, Staphylococcus or Streptomyces cells.

The eukaryotic systems include yeasts and insect, mammalian or plant cells. In this case, the expression vectors can include a yeast plasmid origin of replication or an autonomous replication sequence, a promoter, a DNA sequence coding for a spider silk protein, for a fragment or for an analogous protein, a polyadenylation sequence, a transcription termination site and, lastly, a selection gene. Nonlimiting examples of eukaryotic expression organisms include yeasts, such as Saccharomyces cerevisiae, Pichia pastoris, basidiosporogenous, ascosporogenous, filamentous fungi, such as Aspergillus niger, Aspergillus oryzae, Aspergillus nidulans, Trichoderma reesei, Acremonium chrysogenum, Candida, Hansenula, Kluyveromyces, Saccharomyces (e.g. Saccharomyces cerevisiae), Schizosaccharomyces, Pichia (e.g. Pichia pastoris) or Yarrowia cells etc., mammalian cells, such as HeLa cells, COS cells, CHO cells etc., insect cells, such as Sf9 cells, MEL cells, etc., “insect host cells” such as Spodopterafrugiperda or Trichoplusia ni cells. SF9 cells, SF-21 cells or High-Five cells, wherein SF-9 and SF-21 are ovarian cells from Spodopterafrugiperda, and High-Five cells are egg cells from Trichoplusia ni., “plant host cells”, such as tobacco, potato or pea cells.

A variety of heterologous host systems have been explored to produce different types of recombinant silks. Recombinant partial spidroins as well as engineered silks have been cloned and expressed in bacteria (Escherichia coli), yeast (Pichia pastoris), insects (silkworm larvae), plants (tobacco, soybean, potato, Arabidopsis), mammalian cell lines (BHT/hamster) and transgenic animals (mice, goats). Most of the silk proteins are produced with an N- or C-terminal His-tags to make purification simple and produce enough amounts of the protein.

In some embodiments, the host suitable for expressing the recombinant spider silk protein using heterogeneous system may include transgenic animals and plants. In some embodiments, the host suitable for expressing the recombinant spider silk protein using heterogeneous system comprises bacteria, yeasts, mammalian cell lines. In some embodiments, the host suitable for expressing the recombinant spider silk protein using heterogeneous system comprises E. coli. In some embodiments, the host suitable for expressing the recombinant spider silk protein using heterogeneous system comprises transgenic B. mori silkworm generated using genome editing technologies (e.g. CRISPR).

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences.

In some embodiments, “recombinant silk protein” refers to recombinant silkworm silk protein or fragments thereof. The recombinant production of silk fibroin and silk sericin has been reported. A variety of hosts are used for the production including E. coli, Saccharomyces cerevisiae, Pseudomonas sp., Rhodopseudomonas sp., Bacillus sp., and Strepomyces. See EP 0230702, which is incorporate by reference herein by its entirety.

Provided herein also include design and biological-synthesis of silk fibroin protein-like multiblock polymer comprising GAGAGX hexapeptide (X is A, Y, V or S) derived from the repetitive domain of B. mori silk heavy chain (H chain) In some embodiments, this disclosure provides silk protein-like multiblock polymers derived from the repetitive domain of B. mori silk heavy chain (H chain) comprising the GAGAGS hexapeptide repeating units. The GAGAGS hexapeptide is the core unit of H-chain and plays an important role in the formation of crystalline domains. The silk protein-like multiblock polymers containing the GAGAGS hexapeptide repeating units spontaneously aggregate into β-sheet structures, similar to natural silk fibroin protein, where in the silk protein-like multiblock polymers having any weight average molecular weight described herein.

In some embodiments, this disclosure provides silk-peptide like multiblock copolymers composed of the GAGAGS hexapeptide repetitive fragment derived from H chain of B. mori silk heavy chain and mammalian elastin VPGVG motif produced by E. coli.

In some embodiments, this disclosure provides fusion silk fibroin proteins composed of the GAGAGS hexapeptide repetitive fragment derived from H chain of B. mori silk heavy chain and GVGVP produced by E. coli, where in the silk protein-like multiblock polymers having any weight average molecular weight described herein.

In some embodiments, this disclosure provides B. mori silkworm recombinant proteins composed of the (GAGAGS)₁₆ repetitive fragment. In some embodiments, this disclosure provides recombinant proteins composed of the (GAGAGS)₁₆ repetitive fragment and the non-repetitive (GAGAGS)₁₆—F—COOH, (GAGAGS)₁₆—F—F—COOH, (GAGAGS)₁₆—F—F—F—COOH, (GAGAGS)₁₆—F—F—F—F—COOH, (GAGAGS)₁₆—F—F—F—F—F—F—F—F—COOH, (GAGAGS)₁₆—F—F—F—F—F—F—F—F—F—F—F—F—COOH produced by E. coli, where F has the following amino acid sequence SGFGPVANGGSGEASSESDFGSSGFGPVANASSGEASSESDFAG, and where in the silk protein-like multiblock polymers having any weight average molecular weight described herein.

In some embodiments, “recombinant silk protein” refers to recombinant spider silk protein or fragments thereof. The productions of recombinant spider silk proteins based on a partial cDNA clone have been reported. The recombinant spider silk proteins produced as such comprise a portion of the repetitive sequence derived from a dragline spider silk protein, Spidroin 1, from the spider Nephila clavipes. see Xu et al. (Proc. Natl. Acad. Sci. U.S.A., 87:7120-7124 (1990). cDNA clone encoding a portion of the repeating sequence of a second fibroin protein, Spidroin 2, from dragline silk of Nephila clavipes and the recombinant synthesis thereof is described in J. Biol. Chem., 1992, volume 267, pp. 19320-19324. The recombinant synthesis of spider silk proteins including protein fragments and variants of Nephila clavipes from transformed E. coli is described in U.S. Pat. Nos. 5,728,810 and 5,989,894. cDNA clones encoding minor ampullate spider silk proteins and the expression thereof is described in U.S. Pat. Nos. 5,733,771 and 5,756,677. cDNA clone encoding the flagelliform silk protein from an orb-web spinning spider is described in U.S. Pat. No. 5,994,099. U.S. Pat. No. 6,268,169 describes the recombinant synthesis of spider silk like proteins derived from the repeating peptide sequence found in the natural spider dragline of Nephila clavipes by E. coli, Bacillus subtilis, and Pichia pastoris recombinant expression systems. WO 03/020916 describes the cDNA clone encoding and recombinant production of spider spider silk proteins having repeative sequences derived from the major ampullate glands of Nephila madagascariensis, Nephila senegalensis, Tetragnatha kauaiensis, Tetragnatha versicolor, Argiope aurantia, Argiope trifasciata, Gasteracantha mammosa, and Latrodectus geometricus, the flagelliform glands of Argiope trifasciata, the ampullate glands of Dolomedes tenebrosus, two sets of silk glands from Plectreurys tristis, and the silk glands of the mygalomorph Euagrus chisoseus. Each of the above reference is incorporated herein by reference in its entirety.

In some embodiments, the recombinant spider silk protein is a hybrid protein of a spider silk protein and an insect silk protein, a spider silk protein and collagen, a spider silk protein and resilin, or a spider silk protein and keratin. The spider silk repetitive unit comprises or consists of an amino acid sequence of a region that comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide.

In some embodiments, the recombinant spider silk protein in this disclosure comprises synthetic spider silk proteins derived from repetitive units of natural spider silk proteins, consensus sequence, and optionally one or more natural non-repetitive spider silk protein sequences. The repeated units of natural spider silk polypeptide may include dragline spider silk polypeptides or flagelliform spider silk polypeptides of Araneidae or Araneoids.

As used herein, the spider silk “repetitive unit” comprises or consists of at least one peptide motif that repetitively occurs within a naturally occurring major ampullate gland polypeptide, such as a dragline spider silk polypeptide, a minor ampullate gland polypeptide, a flagelliform polypeptide, an aggregate spider silk polypeptide, an aciniform spider silk polypeptide or a pyriform spider silk polypeptide. A “repetitive unit” refers to a region which corresponds in amino acid sequence to a region that comprises or consists of at least one peptide motif (e.g. AAAAAA) or GPGQQ) that repetitively occurs within a naturally occurring silk polypeptide (e.g. MaSp1, ADF-3, ADF-4, or Flag) (i.e. identical amino acid sequence) or to an amino acid sequence substantially similar thereto (i.e. variational amino acid sequence). A “repetitive unit” having an amino acid sequence which is “substantially similar” to a corresponding amino acid sequence within a naturally occurring silk polypeptide (i.e. wild-type repetitive unit) is also similar with respect to its properties, e.g. a silk protein comprising the “substantially similar repetitive unit” is still insoluble and retains its insolubility. A “repetitive unit” having an amino acid sequence which is “identical” to the amino acid sequence of a naturally occurring silk polypeptide, for example, can be a portion of a silk polypeptide corresponding to one or more peptide motifs of MaSpI, MaSpII, ADF-3 and/or ADF-4. A “repetitive unit” having an amino acid sequence which is “substantially similar” to the amino acid sequence of a naturally occurring silk polypeptide, for example, can be a portion of a silk polypeptide corresponding to one or more peptide motifs of MaSp1, MaSpII, ADF-3 and/or ADF-4, but having one or more amino acid substitution at specific amino acid positions.

As used herein, the term “consensus peptide sequence” refers to an amino acid sequence which contains amino acids which frequently occur in a certain position (e.g. “G”) and wherein, other amino acids which are not further determined are replaced by the place holder “X”. In some embodiments, the consensus sequence is at least one of (i) GPGXX, wherein X is an amino acid selected from A, S, G, Y, P and Q; (ii) GGX, wherein X is an amino acid selected from Y, P, R, S, A, T, N and Q, preferably Y, P and Q; (iii) Ax, wherein x is an integer from 5 to 10.

The consensus peptide sequences GPGXX and GGX, i.e. glycine rich motifs, provide flexibility to the silk polypeptide and thus, to the thread formed from the silk protein containing said motifs. In detail, the iterated GPGXX motif forms turn spiral structures, which imparts elasticity to the silk polypeptide. Major ampullate and flagelliform silks both have a GPGXX motif. The iterated GGX motif is associated with a helical structure having three amino acids per turn and is found in most spider silks. The GGX motif may provide additional elastic properties to the silk. The iterated polyalanine Ax (peptide) motif forms a crystalline β-sheet structure that provides strength to the silk polypeptide, as described for example in WO 03/057727.

In some embodiments, the recombinant spider silk protein in this disclosure comprises two identical repetitive units each comprising at least one, preferably one, amino acid sequence selected from the group consisting of: GGRPSDTYG and GGRPSSSYG derived from Resilin. Resilin is an elastomeric protein found in most arthropods that provides low stiffness and high strength.

As used herein, “non-repetitive units” refers to an amino acid sequence which is “substantially similar” to a corresponding non-repetitive (carboxy terminal) amino acid sequence within a naturally occurring dragline polypeptide (i.e. wild-type non-repetitive (carboxy terminal) unit), preferably within ADF-3 (SEQ ID NO:1), ADF-4 (SEQ ID NO:2), NR3 (SEQ ID NO:41), NR4 (SEQ ID NO:42), ADF-4 of the spider Araneus diadematus as described in U.S. Pat. No. 8,367,803, C16 peptide (spider silk protein eADF4, molecular weight of 47.7 kDa, AMSilk) comprising the 16 repeats of the sequence GSSAAAAAAAASGPGGYGPENQGPSGPGGYGPGGP, an amino acid sequence adapted from the natural sequence of ADF4 from A. diadematus. Non-repetitive ADF-4 and variants thereof display efficient assembly behavior.

Among the synthetic spider silk proteins, the recombinant silk protein in this disclosure comprises in some embodiments the C16-protein having the polypeptide sequence SEQ ID NO: 1 as described in U.S. Pat. No. 8,288,512. Besides the polypeptide sequence shown in SEQ ID NO:1, particularly functional equivalents, functional derivatives and salts of this sequence are also included.

As used herein, “functional equivalents” refers to mutant which, in at least one sequence position of the abovementioned amino acid sequences, have an amino acid other than that specifically mentioned.

In some embodiments, the recombinant spider silk protein in this disclosure comprises, in an effective amount, at least one natural or recombinant silk protein including spider silk protein, corresponding to Spidroin major 1 described by Xu et al., PNAS, USA, 87, 7120, (1990), Spidroin major 2 described by Hinman and Lewis, J. Biol. Chem., 267, 19320, (1922), recombinant spider silk protein as described in U.S. Patent Application No. 2016/0222174 and U.S. Pat. Nos. 9,051,453, 9,617.315, 9,689,089, 8,173,772, 8,642,734, 8,367,803 8,097,583, 8,030,024, 7,754,851, 7,148,039, 7,060,260, or alternatively the minor Spidroins described in patent application WO 95/25165. Each of the above-cited references is incorporated herein by reference in its entirety. Additional recombinant spider silk proteins suitable for the recombinant RSPF of this disclosure include ADF3 and ADF4 from the “Major Ampullate” gland of Araneus diadematus.

Recombinant silk is also described in other patents and patent applications, incorporated by reference herein: US 2004590196, U.S. Pat. No. 7,754,851, US 2007654470, U.S. Pat. No. 7,951,908, US 2010785960, U.S. Pat. No. 8,034,897, US 20090263430, US 2008226854, US 20090123967, US 2005712095, US 2007991037, US 20090162896, US 200885266, U.S. Pat. No. 8,372,436, US 2007989907, US 2009267596, US 2010319542, US 2009265344, US 2012684607, US 2004583227, U.S. Pat. No. 8,030,024, US 2006643569, U.S. Pat. No. 7,868,146, US 2007991916, U.S. Pat. No. 8,097,583, US 2006643200, U.S. Pat. Nos. 8,729,238, 8,877,903, US 20190062557, US 20160280960, US 20110201783, US 2008991916, US 2011986662, US 2012697729, US 20150328363, U.S. Pat. No. 9,034,816, US 20130172478, U.S. Pat. No. 9,217,017, US 20170202995, U.S. Pat. No. 8,721,991, US 2008227498, U.S. Pat. Nos. 9,233,067, 8,288,512, US 2008161364, U.S. Pat. No. 7,148,039, U.S. Ser. No. 19/992,47806, US 2001861597, US 2004887100, U.S. Pat. Nos. 9,481,719, 8,765,688, US 200880705, US 2010809102, U.S. Pat. No. 8,367,803, US 2010664902, U.S. Pat. No. 7,569,660, U.S. Ser. No. 19/991,38833, US 2000591632, US 20120065126, US 20100278882, US 2008161352, US 20100015070, US 2009513709, US 20090194317, US 2004559286, US 200589551, US 2008187824, US 20050266242, US 20050227322, and US 20044418.

Recombinant silk is also described in other patents and patent applications, incorporated by reference herein: US 20190062557, US 20150284565, US 20130225476, US 20130172478, US 20130136779, US 20130109762, US 20120252294, US 20110230911, US 20110201783, US 20100298877, U.S. Pat. Nos. 10,478,520, 10,253,213, 10,072,152, 9,233,067, 9,217,017, 9,034,816, 8,877,903, 8,729,238, 8,721,991, 8,097,583, 8,034,897, 8,030,024, 7,951,908, 7,868,146, and 7,754,851.

In some embodiments, the recombinant spider silk protein in this disclosure comprises or consists of 2 to 80 repetitive units, each independently selected from GPGXX, GGX and Ax as defined herein.

In some embodiments, the recombinant spider silk protein in this disclosure comprises or consists of repetitive units each independently selected from selected from the group consisting of GPGAS, GPGSG, GPGGY, GPGGP, GPGGA, GPGQQ, GPGGG, GPGQG, GPGGS, GGY, GGP, GGA, GGR, GGS, GGT, GGN, GGQ, AAAAA, AAAAAA, AAAAAAA, AAAAAAAA, AAAAAAAAA, AAAAAAAAAA, GGRPSDTYG and GGRPSSSYG, (i) GPYGPGASAAAAAAGGYGPGSGQQ, (ii) GSSAAAAAAAASGPGGYGPENQGPSGPGGYGPGGP, (iii) GPGQQGPGQQGPGQQGPGQQ: (iv) GPGGAGGPYGPGGAGGPYGPGGAGGPY, (v) GGTTIIEDLDITIDGADGPITISEELTI, (vi) PGSSAAAAAAAASGPGQGQGQGQGQGGRPSDTYG, (vii) SAAAAAAAAGPGGGNGGRPSDTYGAPGGGNGGRPSSSYG, (viii) GGAGGAGGAGGSGGAGGS (SEQ ID NO: 27), (ix) GPGGAGPGGYGPGGSGPGGYGPGGSGPGGY, (x) GPYGPGASAAAAAAGGYGPGCGQQ, (xi) GPYGPGASAAAAAAGGYGPGKGQQ, (xii) GSSAAAAAAAASGPGGYGPENQGPCGPGGYGPGGP, (xiii) GSSAAAAAAAASGPGGYGPKNQGPSGPGGYGPGGP, (xiv) GSSAAAAAAAASGPGGYGPKNQGPSGPGGYGPGGP, or variants thereof as described in U.S. Pat. No. 8,877,903, for example, a synthetic spider peptide having sequential order of GPGAS, GGY, GPGSG in the peptide chain, or sequential order of AAAAAAAA, GPGGY, GPGGP in the peptide chain, sequential order of AAAAAAAA, GPGQG, GGR in the peptide chain.

In some embodiments, this disclosure provides silk protein-like multiblock peptides that imitate the repeating units of amino acids derived from natural spider silk proteins such as Spidroin major 1 domain, Spidroin major 2 domain or Spidroin minor 1 domain and the profile of variation between the repeating units without modifying their three-dimensional conformation, wherein these silk protein-like multiblock peptides comprise a repeating unit of amino acids corresponding to one of the sequences (I), (II), (III) and/or (IV) below.
[(XGG)_{w}(XGA)(GXG)ₓ(AGA)_{y}(G)_{z}AG]ₚ Formula (I) in which: X corresponds to tyrosine or to glutamine, w is an integer equal to 2 or 3, x is an integer from 1 to 3, y is an integer from 5 to 7, z is an integer equal to 1 or 2, and p is an integer and having any weight average molecular weight described herein, and/or
[(GPG₂YGPGQ₂)ₐ(X′)₂S(A)_{b}]ₚ Formula (II) in which: X′ corresponds to the amino acid sequence GPS or GPG, a is equal to 2 or 3, b is an integer from 7 to 10, and p is an integer and having any weight average molecular weight described herein, and/or
[(GR)(GA)ₗ(A)ₘ(GGX)ₙ(GA)ₗ(A)ₘ]ₚ Formula (III) and/or [(GGX)ₙ(GA)ₘ(A)ₗ]ₚFormula (IV) in which: X″ corresponds to tyrosine, glutamine or alanine, 1 is an integer from 1 to 6, m is an integer from 0 to 4, n is an integer from 1 to 4, and p is an integer.

In some embodiments, the recombinant spider silk protein or an analog of a spider silk protein comprising an amino acid repeating unit of sequence (V):
[(Xaa Gly Gly)_{w}(Xaa Gly Ala)(Gly Xaa Gly)ₓ(Ala Gly Ala)_{y}(Gly)_{z}Ala Gly]ₚ Formula (V), wherein Xaa is tyrosine or glutamine, w is an integer equal to 2 or 3, x is an integer from 1 to 3, y is an integer from 5 to 7, z is an integer equal to 1 or 2, and p is an integer.

In some embodiments, the recombinant spider silk protein in this disclosure is selected from the group consisting of ADF-3 or variants thereof, ADF-4 or variants thereof, MaSp1 (SEQ ID NO: 43) or variants thereof, MaSpII (SEQ ID NO: 44) or variants thereof as described in U.S. Pat. No. 8,367,803.

In some embodiments, this disclosure provides water soluble recombinant spider silk proteins produced in mammalian cells. The solubility of the spider silk proteins produced in mammalian cells was attributed to the presence of the COOH-terminus in these proteins, which makes them more hydrophilic. These COOH-terminal amino acids are absent in spider silk proteins expressed in microbial hosts.

In some embodiments, the recombinant spider silk protein in this disclosure comprises water soluble recombinant spider silk protein C16 modified with an amino or carboxyl terminal selected from the amino acid sequences consisting of: GCGGGGGG, GKGGGGGG, GCGGSGGGGSGGGG, GKGGGGGGSGGGG, and GCGGGGGGSGGGG. In some embodiments, the recombinant spider silk protein in this disclosure comprises C₁₆NR4, C₃₂NR4, C16, C32, NR4C₁₆NR4, NR4C₃₂NR4, NR3C₁₆NR3, or NR3C₃₂NR3 such that the molecular weight of the protein ranges as described herein.

In some embodiments, the recombinant spider silk protein in this disclosure comprises recombinant spider silk protein having a synthetic repetitive peptide segments and an amino acid sequence adapted from the natural sequence of ADF4 from A. diadematus as described in U.S. Pat. No. 8,877,903. In some embodiments, the RSPF in this disclosure comprises the recombinant spider silk proteins having repeating peptide units derived from natural spider silk proteins such as Spidroin major 1 domain, Spidroin major 2 domain or Spidroin minor 1 domain, wherein the repeating peptide sequence is GSSAAAAAAAASGPGQGQGQGQGQGGRPSDTYG or SAAAAAAAAGPGGGNGGRPSDTYGAPGGGNGGRPSSSYG, as described in U.S. Pat. No. 8,367,803.

In some embodiments, this disclosure provides recombinant spider proteins composed of the GPGGAGPGGYGPGGSGPGGYGPGGSGPGGY repetitive fragment and having a molecular weight as described herein.

As used herein, the term “recombinant silk” refers to recombinant spider and/or silkworm silk protein or fragments thereof. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk). For example, recombinant spider silk protein, as described herein, includes the proteins described in U.S. Patent Application No. 2016/0222174 and U.S. Pat. Nos. 9,051,453, 9,617,315, 9,689,089, 8,173,772, and 8,642,734.

Some organisms make multiple silk fibers with unique sequences, structural elements, and mechanical properties. For example, orb weaving spiders have six unique types of glands that produce different silk polypeptide sequences that are polymerized into fibers tailored to fit an environmental or lifecycle niche. The fibers are named for the gland they originate from and the polypeptides are labeled with the gland abbreviation (e.g. “Ma”) and “Sp” for spidroin (short for spider fibroin). In orb weavers, these types include Major Ampullate (MaSp, also called dragline), Minor Ampullate (MiSp), Flagelliform (Flag), Aciniform (AcSp), Tubuliform (TuSp), and Pyriform (PySp). This combination of polypeptide sequences across fiber types, domains, and variation amongst different genus and species of organisms leads to a vast array of potential properties that can be harnessed by commercial production of the recombinant fibers. To date, the vast majority of the work with recombinant silks has focused on the Major Ampullate Spidroins (MaSp).

Aciniform (AcSp) silks tend to have high toughness, a result of moderately high strength coupled with moderately high extensibility. AcSp silks are characterized by large block (“ensemble repeat”) sizes that often incorporate motifs of poly serine and GPX.

Tubuliform (TuSp or Cylindrical) silks tend to have large diameters, with modest strength and high extensibility. TuSp silks are characterized by their poly serine and poly threonine content, and short tracts of poly alanine. Major Ampullate (MaSp) silks tend to have high strength and modest extensibility. MaSp silks can be one of two subtypes: MaSp1 and MaSp2. MaSp1 silks are generally less extensible than MaSp2 silks, and are characterized by poly alanine, GX, and GGX motifs. MaSp2 silks are characterized by poly alanine, GGX, and GPX motifs. Minor Ampullate (MiSp) silks tend to have modest strength and modest extensibility. MiSp silks are characterized by GGX, GA, and poly A motifs, and often contain spacer elements of approximately 100 amino acids. Flagelliform (Flag) silks tend to have very high extensibility and modest strength. Flag silks are usually characterized by GPG, GGX, and short spacer motifs.

Silk polypeptides are characteristically composed of a repeat domain (REP) flanked by non-repetitive regions (e.g., C-terminal and N-terminal domains). In an embodiment, both the C-terminal and N-terminal domains are between 75-350 amino acids in length. The repeat domain exhibits a hierarchical architecture. The repeat domain comprises a series of blocks (also called repeat units). The blocks are repeated, sometimes perfectly and sometimes imperfectly (making up a quasi-repeat domain), throughout the silk repeat domain. The length and composition of blocks varies among different silk types and across different species. Table 1 of U.S. Published Application No. 2016/0222174, the entirety of which is incorporated herein, lists examples of block sequences from selected species and silk types, with further examples presented in Rising, A. et al., Spider silk proteins: recent advances in recombinant production, structure-function relationships and biomedical applications, Cell Mol. Life Sci., 68:2, pg 169-184 (2011); and Gatesy, J. et al., Extreme diversity, conservation, and convergence of spider silk fibroin sequences, Science, 291:5513, pg. 2603-2605 (2001). In some cases, blocks may be arranged in a regular pattern, forming larger macro-repeats that appear multiple times (usually 2-8) in the repeat domain of the silk sequence. Repeated blocks inside a repeat domain or macro-repeat, and repeated macro-repeats within the repeat domain, may be separated by spacing elements.

The construction of certain spider silk block copolymer polypeptides from the blocks and/or macro-repeat domains, according to certain embodiments of the disclosure, is illustrated in U.S. Published Patent Application No. 2016/0222174.

The recombinant block copolymer polypeptides based on spider silk sequences produced by gene expression in a recombinant prokaryotic or eukaryotic system can be purified according to methods known in the art. In a preferred embodiment, a commercially available expression/secretion system can be used, whereby the recombinant polypeptide is expressed and thereafter secreted from the host cell, to be easily purified from the surrounding medium. If expression/secretion vectors are not used, an alternative approach involves purifying the recombinant block copolymer polypeptide from cell lysates (remains of cells following disruption of cellular integrity) derived from prokaryotic or eukaryotic cells in which a polypeptide was expressed. Methods for generation of such cell lysates are known to those of skill in the art. In some embodiments, recombinant block copolymer polypeptides are isolated from cell culture supernatant.

Recombinant block copolymer polypeptide may be purified by affinity separation, such as by immunological interaction with antibodies that bind specifically to the recombinant polypeptide or nickel columns for isolation of recombinant polypeptides tagged with 6-8 histidine residues at their N-terminus or C-terminus Alternative tags may comprise the FLAG epitope or the hemagglutinin epitope. Such methods are commonly used by skilled practitioners.

A solution of such polypeptides (i.e., recombinant silk protein) may then be prepared and used as described herein.

In another embodiment, recombinant silk protein may be prepared according to the methods described in U.S. Pat. No. 8,642,734, the entirety of which is incorporated herein, and used as described herein.

In an embodiment, a recombinant spider silk protein is provided. The spider silk protein typically consists of from 170 to 760 amino acid residues, such as from 170 to 600 amino acid residues, preferably from 280 to 600 amino acid residues, such as from 300 to 400 amino acid residues, more preferably from 340 to 380 amino acid residues. The small size is advantageous because longer spider silk proteins tend to form amorphous aggregates, which require use of harsh solvents for solubilization and polymerization. The recombinant spider silk protein may contain more than 760 residues, in particular in cases where the spider silk protein contains more than two fragments derived from the N-terminal part of a spider silk protein, The spider silk protein comprises an N-terminal fragment consisting of at least one fragment (NT) derived from the corresponding part of a spider silk protein, and a repetitive fragment (REP) derived from the corresponding internal fragment of a spider silk protein.

Optionally, the spider silk protein comprises a C-terminal fragment (CT) derived from the corresponding fragment of a spider silk protein. The spider silk protein comprises typically a single fragment (NT) derived from the N-terminal part of a spider silk protein, but in preferred embodiments, the N-terminal fragment include at least two, such as two fragments (NT) derived from the N-terminal part of a spider silk protein. Thus, the spidroin can schematically be represented by the formula NTₘ-REP, and alternatively NTₘ-REP-CT, where m is an integer that is 1 or higher, such as 2 or higher, preferably in the ranges of 1-2, 1-4, 1-6, 2-4 or 2-6. Preferred spidroins can schematically be represented by the formulas NT₂-REP or NT-REP, and alternatively NT₂-REP-CT or NT-REP-CT. The protein fragments are covalently coupled, typically via a peptide bond. In one embodiment, the spider silk protein consists of the NT fragment(s) coupled to the REP fragment, which REP fragment is optionally coupled to the CT fragment.

In one embodiment, the first step of the method of producing polymers of an isolated spider silk protein involves expression of a polynucleic acid molecule which encodes the spider silk protein in a suitable host, such as Escherichia coli. The thus obtained protein is isolated using standard procedures. Optionally, lipopolysaccharides and other pyrogens are actively removed at this stage.

In the second step of the method of producing polymers of an isolated spider silk protein, a solution of the spider silk protein in a liquid medium is provided. By the terms “soluble” and “in solution” is meant that the protein is not visibly aggregated and does not precipitate from the solvent at 60,000×g. The liquid medium can be any suitable medium, such as an aqueous medium, preferably a physiological medium, typically a buffered aqueous medium, such as a 10-50 mM Tris-HCl buffer or phosphate buffer. The liquid medium has a pH of 6.4 or higher and/or an ion composition that prevents polymerization of the spider silk protein. That is, the liquid medium has either a pH of 6.4 or higher or an ion composition that prevents polymerization of the spider silk protein, or both.

Ion compositions that prevent polymerization of the spider silk protein can readily be prepared by the skilled person utilizing the methods disclosed herein. A preferred ion composition that prevents polymerization of the spider silk protein has an ionic strength of more than 300 mM. Specific examples of ion compositions that prevent polymerization of the spider silk protein include above 300 mM NaCl, 100 mM phosphate and combinations of these ions having desired preventive effect on the polymerization of the spider silk protein, e.g. a combination of 10 mM phosphate and 300 mM NaCl.

The presence of an NT fragment improves the stability of the solution and prevents polymer formation under these conditions. This can be advantageous when immediate polymerization may be undesirable, e.g. during protein purification, in preparation of large batches, or when other conditions need to be optimized. It is preferred that the pH of the liquid medium is adjusted to 6.7 or higher, such as 7.0 or higher, or even 8.0 or higher, such as up to 10.5, to achieve high solubility of the spider silk protein. It can also be advantageous that the pH of the liquid medium is adjusted to the range of 6.4-6.8, which provides sufficient solubility of the spider silk protein but facilitates subsequent pH adjustment to 6.3 or lower.

In the third step, the properties of the liquid medium are adjusted to a pH of 6.3 or lower and ion composition that allows polymerization. That is, if the liquid medium wherein the spider silk protein is dissolved has a pH of 6.4 or higher, the pH is decreased to 6.3 or lower. The skilled person is well aware of various ways of achieving this, typically involving addition of a strong or weak acid. If the liquid medium wherein the spider silk protein is dissolved has an ion composition that prevents polymerization, the ion composition is changed so as to allow polymerization. The skilled person is well aware of various ways of achieving this, e.g. dilution, dialysis or gel filtration. If required, this step involves both decreasing the pH of the liquid medium to 6.3 or lower and changing the ion composition so as to allow polymerization. It is preferred that the pH of the liquid medium is adjusted to 6.2 or lower, such as 6.0 or lower. In particular, it may be advantageous from a practical point of view to limit the pH drop from 6.4 or 6.4-6.8 in the preceding step to 6.3 or 6.0-6.3, e.g. 6.2 in this step. In a preferred embodiment, the pH of the liquid medium of this step is 3 or higher, such as 4.2 or higher. The resulting pH range, e.g. 4.2-6.3 promotes rapid polymerization,

In the fourth step, the spider silk protein is allowed to polymerize in the liquid medium having pH of 6.3 or lower and an ion composition that allows polymerization of the spider silk protein. Although the presence of the NT fragment improves solubility of the spider silk protein at a pH of 6.4 or higher and/or an ion composition that prevents polymerization of the spider silk protein, it accelerates polymer formation at a pH of 6.3 or lower when the ion composition allows polymerization of the spider silk protein. The resulting polymers are preferably solid and macroscopic, and they are formed in the liquid medium having a pH of 6.3 or lower and an ion composition that allows polymerization of the spider silk protein. In a preferred embodiment, the pH of the liquid medium of this step is 3 or higher, such as 4.2 or higher. The resulting pH range, e.g. 4.2-6.3 promotes rapid polymerization, Resulting polymer may be provided at the molecular weights described herein and prepared as a solution form that may be used as necessary for article coatings.

Ion compositions that allow polymerization of the spider silk protein can readily be prepared by the skilled person utilizing the methods disclosed herein. A preferred ion composition that allows polymerization of the spider silk protein has an ionic strength of less than 300 mM. Specific examples of ion compositions that allow polymerization of the spider silk protein include 150 mM NaCl, 10 mM phosphate, 20 mM phosphate and combinations of these ions lacking preventive effect on the polymerization of the spider silk protein, e.g. a combination of 10 mM phosphate or 20 mM phosphate and 150 mM NaCl. It is preferred that the ionic strength of this liquid medium is adjusted to the range of 1-250 mM.

Without desiring to be limited to any specific theory, it is envisaged that the NT fragments have oppositely charged poles, and that environmental changes in pH affects the charge balance on the surface of the protein followed by polymerization, whereas salt inhibits the same event.

At neutral pH, the energetic cost of burying the excess negative charge of the acidic pole may be expected to prevent polymerization. However, as the dimer approaches its isoelectric point at lower pH, attractive electrostatic forces will eventually become dominant, explaining the observed salt and pH-dependent polymerization behavior of NT and NT-containing minispidroins. It is proposed that, in some embodiments, pH-induced NT polymerization, and increased efficiency of fiber assembly of NT-minispidroins, are due to surface electrostatic potential changes, and that clustering of acidic residues at one pole of NT shifts its charge balance such that the polymerization transition occurs at pH values of 6.3 or lower.

In a fifth step, the resulting, preferably solid spider silk protein polymers are isolated from said liquid medium. Optionally, this step involves actively removing lipopolysaccharides and other pyrogens from the spidroin polymers.

Without desiring to be limited to any specific theory, it has been observed that formation of spidroin polymers progresses via formation of water-soluble spidroin dimers. The present disclosure thus also provides a method of producing dimers of an isolated spider silk protein, wherein the first two method steps are as described above. The spider silk proteins are present as dimers in a liquid medium at a pH of 6.4 or higher and/or an ion composition that prevents polymerization of said spider silk protein. The third step involves isolating the dimers obtained in the second step, and optionally removal of lipopolysaccharides and other pyrogens. In a preferred embodiment, the spider silk protein polymer of the disclosure consists of polymerized protein dimers. The present disclosure thus provides a novel use of a spider silk protein, preferably those disclosed herein, for producing dimers of the spider silk protein.

According to another aspect, the disclosure provides a polymer of a spider silk protein as disclosed herein. In an embodiment, the polymer of this protein is obtainable by any one of the methods therefor according to the disclosure. Thus, the disclosure provides various uses of recombinant spider silk protein, preferably those disclosed herein, for producing polymers of the spider silk protein as recombinant silk based coatings. According to one embodiment, the present disclosure provides a novel use of a dimer of a spider silk protein, preferably those disclosed herein, for producing polymers of the isolated spider silk protein as recombinant silk based coatings. In these uses, it is preferred that the polymers are produced in a liquid medium having a pH of 6.3 or lower and an ion composition that allows polymerization of said spider silk protein. In an embodiment, the pH of the liquid medium is 3 or higher, such as 4.2 or higher. The resulting pH range, e.g. 4.2-6.3 promotes rapid polymerization,

Using the method(s) of the present disclosure, it is possible to control the polymerization process, and this allows for optimization of parameters for obtaining silk polymers with desirable properties and shapes.

In an embodiment, the recombinant silk proteins described herein, include those described in U.S. Pat. No. 8,642,734, the entirety of which is incorporated by reference.

In another embodiment, the recombinant silk proteins described herein may be prepared according to the methods described in U.S. Pat. No. 9,051,453, the entirety of which is incorporated herein by reference.

An amino acid sequence represented by SEQ ID NO: 1 of U.S. Pat. No. 9,051,453 is identical to an amino acid sequence that is composed of 50 amino acid residues of an amino acid sequence of ADF3 at the C-terminal (NCBI Accession No.: AAC47010, GI: 1263287). An amino acid sequence represented by SEQ ID NO: 2 of U.S. Pat. No. 9,051,453 is identical to an amino acid sequence represented by SEQ ID NO: 1 of U.S. Pat. No. 9,051,453 from which 20 residues have been removed from the C-terminal. An amino acid sequence represented by SEQ ID NO: 3 of U.S. Pat. No. 9,051,453 is identical to an amino acid sequence represented by SEQ ID NO: 1 from which 29 residues have been removed from the C-terminal.

An example of the polypeptide that contains units of the amino acid sequence represented by the formula 1: REP1-REP2 (1) and that has, at a C-terminal, an amino acid sequence represented by any of SEQ ID NOS: 1 to 3 or an amino acid sequence having a homology of 90% or more with the amino acid sequence represented by any of SEQ ID NOS: 1 to 3 of U.S. Pat. No. 9,051,453 is a polypeptide having an amino acid sequence represented by SEQ ID NO: 8 of U.S. Pat. No. 9,051,453. The polypeptide having the amino acid sequence represented by SEQ ID NO: 8 of U.S. Pat. No. 9,051,453 is obtained by the following mutation: in an amino acid sequence of ADF3 (NCBI Accession No.: AAC47010, GI: 1263287) to the N-terminal of which has been added an amino acid sequence (SEQ ID NO: 5 of U.S. Pat. No. 9,051,453) composed of a start codon, His 10 tags and an HRV3C Protease (Human rhinovirus 3C Protease) recognition site, 1^{st} to 13^{th} repetitive regions are about doubled and the translation ends at the 1154^{th} amino acid residue. In the polypeptide having the amino acid sequence represented by SEQ ID NO: 8 of U.S. Pat. No. 9,051,453, the C-terminal sequence is identical to the amino acid sequence represented by SEQ ID NO: 3.

Further, the polypeptide that contains units of the amino acid sequence represented by the formula 1: REP1-REP2 (1) and that has, at a C-terminal, an amino acid sequence represented by any of SEQ ID NOS: 1 to 3 of U.S. Pat. No. 9,051,453 or an amino acid sequence having a homology of 90% or more with the amino acid sequence represented by any of SEQ ID NOS: 1 to 3 of U.S. Pat. No. 9,051,453 may be a protein that has an amino acid sequence represented by SEQ ID NO: 8 of U.S. Pat. No. 9,051,453 in which one or a plurality of amino acids have been substituted, deleted, inserted and/or added and that has a repetitious region composed of a crystal region and an amorphous region.

Further, an example of the polypeptide containing two or more units of the amino acid sequence represented by the formula 1: REP1-REP2 (1) is a recombinant protein derived from ADF4 having an amino acid sequence represented by SEQ ID NO: 15 of U.S. Pat. No. 9,051,453. The amino acid sequence represented by SEQ ID NO: 15 of U.S. Pat. No. 9,051,453 is an amino acid sequence obtained by adding the amino acid sequence (SEQ ID NO: 5 of U.S. Pat. No. 9,051,453) composed of a start codon, His 10 tags and an HRV3C Protease (Human rhinovirus 3C Protease) recognition site, to the N-terminal of a partial amino acid sequence of ADF4 obtained from the NCBI database (NCBI Accession No.: AAC47011, GI: 1263289). Further, the polypeptide containing two or more units of the amino acid sequence represented by the formula 1: REP1-REP2 (1) may be a polypeptide that has an amino acid sequence represented by SEQ ID NO: 15 of U.S. Pat. No. 9,051,453 in which one or a plurality of amino acids have been substituted, deleted, inserted and/or added and that has a repetitious region composed of a crystal region and an amorphous region.

Further, an example of the polypeptide containing two or more units of the amino acid sequence represented by the formula 1: REP1-REP2 (1) is a recombinant protein derived from MaSp2 that has an amino acid sequence represented by SEQ ID NO: 17 of U.S. Pat. No. 9,051,453. The amino acid sequence represented by SEQ ID NO: 17 of U.S. Pat. No. 9,051,453 is an amino acid sequence obtained by adding the amino acid sequence (SEQ ID NO: 5 of U.S. Pat. No. 9,051,453) composed of a start codon, His 10 tags and an HRV3C Protease (Human rhinovirus 3C Protease) recognition site, to the N-terminal of a partial sequence of MaSp2 obtained from the NCBI web database (NCBI Accession No.: AAT75313, GI: 50363147). Furthermore, the polypeptide containing two or more units of the amino acid sequence represented by the formula 1: REP1-REP2 (1) may be a polypeptide that has an amino acid sequence represented by SEQ ID NO: 17 of U.S. Pat. No. 9,051,453 in which one or a plurality of amino acids have been substituted, deleted, inserted and/or added and that has a repetitious region composed of a crystal region and an amorphous region.

Examples of the polypeptide derived from flagelliform silk proteins include a polypeptide containing 10 or more units of an amino acid sequence represented by the formula 2: REP3 (2), preferably a polypeptide containing 20 or more units thereof, and more preferably a polypeptide containing 30 or more units thereof. In the case of producing a recombinant protein using a microbe such as Escherichia coli as a host, the molecular weight of the polypeptide derived from flagelliform silk proteins is preferably 500 kDa or less, more preferably 300 kDa or less, and further preferably 200 kDa or less, in terms of productivity.

In the formula (2), the REP 3 indicates an amino acid sequence composed of Gly-Pro-Gly-Gly-X, where X indicates an amino acid selected from the group consisting of Ala, Ser, Tyr and Val.

A major characteristic of the spider silk is that the flagelliform silk does not have a crystal region, but has a repetitious region composed of an amorphous region. Since the major dragline silk and the like have a repetitious region composed of a crystal region and an amorphous region, they are expected to have both high stress and stretchability. Meanwhile, as to the flagelliform silk, although the stress is inferior to that of the major dragline silk, the stretchability is high. The reason for this is considered to be that most of the flagelliform silk is composed of amorphous regions.

An example of the polypeptide containing 10 or more units of the amino acid sequence represented by the formula 2: REP3 (2) is a recombinant protein derived from flagelliform silk proteins having an amino acid sequence represented by SEQ ID NO: 19 of U.S. Pat. No. 9,051,453. The amino acid sequence represented by SEQ ID NO: 19 of U.S. Pat. No. 9,051,453 is an amino acid sequence obtained by combining a partial sequence of flagelliform silk protein of Nephila clavipes obtained from the NCBI database (NCBI Accession No.: AAF36090, GI: 7106224), specifically, an amino acid sequence thereof from the 1220^{th} residue to the 1659^{th} residue from the N-terminal that corresponds to repetitive sections and motifs (referred to as a PR1 sequence), with a partial sequence of flagelliform silk protein of Nephila clavipes obtained from the NCBI database (NCBI Accession No.: AAC38847, GI: 2833649), specifically, a C-terminal amino acid sequence thereof from the 816^{th} residue to the 907^{th} residue from the C-terminal, and thereafter adding the amino acid sequence (SEQ ID NO: 5 of U.S. Pat. No. 9,051,453) composed of a start codon, His 10 tags and an HRV3C Protease recognition site, to the N-terminal of the combined sequence. Further, the polypeptide containing 10 or more units of the amino acid sequence represented by the formula 2: REP3 (2) may be a polypeptide that has an amino acid sequence represented by SEQ ID NO: 19 of U.S. Pat. No. 9,051,453 in which one or a plurality of amino acids have been substituted, deleted, inserted and/or added and that has a repetitious region composed of an amorphous region.

The polypeptide can be produced using a host that has been transformed by an expression vector containing a gene encoding a polypeptide. A method for producing a gene is not limited particularly, and it may be produced by amplifying a gene encoding a natural spider silk protein from a cell derived from spiders by a polymerase chain reaction (PCR), etc., and cloning it, or may be synthesized chemically. Also, a method for chemically synthesizing a gene is not limited particularly, and it can be synthesized as follows, for example: based on information of amino acid sequences of natural spider silk proteins obtained from the NCBI web database, etc., oligonucleotides that have been synthesized automatically with AKTA oligopilot plus 10/100 (GE Healthcare Japan Corporation) are linked by PCR, etc. At this time, in order to facilitate the purification and observation of protein, it is possible to synthesize a gene that encodes a protein having an amino acid sequence of the above-described amino acid sequence to the N-terminal of which has been added an amino acid sequence composed of a start codon and His 10 tags.

Examples of the expression vector include a plasmid, a phage, a virus, and the like that can express protein based on a DNA sequence. The plasmid-type expression vector is not limited particularly as long as it allows a target gene to be expressed in a host cell and it can amplify itself. For example, in the case of using Escherichia coli Rosetta (DE3) as a host, a pET22b(+) plasmid vector, a pCold plasmid vector, and the like can be used. Among these, in terms of productivity of protein, it is preferable to use the pET22b(+) plasmid vector. Examples of the host include animal cells, plant cells, microbes, etc.

The polypeptide used in the present disclosure is preferably a polypeptide derived from ADF3, which is one of two principal dragline silk proteins of Araneus diadematus. This polypeptide has advantages of basically having high strength-elongation and toughness and of being synthesized easily.

Accordingly, the recombinant silk protein (e.g., the recombinant spider silk-based protein) used in accordance with the embodiments, articles, and/or methods described herein, may include one or more recombinant silk proteins described above or recited in U.S. Pat. Nos. 8,173,772, 8,278,416, 8,618,255, 8,642,734, 8,691,581, 8,729,235, 9,115,204, 9,157,070, 9,309,299, 9,644,012, 9,708,376, 9,051,453, 9,617,315, 9,968,682, 9,689,089, 9,732,125, 9,856,308, 9,926,348, 10,065,997, 10,316,069, and 10,329,332; and U.S. Patent Publication Nos. 2009/0226969, 2011/0281273, 2012/0041177, 2013/0065278, 2013/0115698, 2013/0316376, 2014/0058066, 2014/0079674, 2014/0245923, 2015/0087046, 2015/0119554, 2015/0141618, 2015/0291673, 2015/0291674, 2015/0239587, 2015/0344542, 2015/0361144, 2015/0374833, 2015/0376247, 2016/0024464, 2017/0066804, 2017/0066805, 2015/0293076, 2016/0222174, 2017/0283474, 2017/0088675, 2019/0135880, 2015/0329587, 2019/0040109, 2019/0135881, 2019/0177363, 2019/0225646, 2019/0233481, 2019/0031842, 2018/0355120, 2019/0186050, 2019/0002644, 2020/0031887, 2018/0273590, 20191/094403, 2019/0031843, 2018/0251501, 2017/0066805, 2018/0127553, 2019/0329526, 2020/0031886, 2018/0080147, 2019/0352349, 2020/0043085, 2019/0144819, 2019/0228449, 2019/0340666, 2020/0000091, 2019/0194710, 2019/0151505, 2018/0265555, 2019/0352330, 2019/0248847, and 2019/0378191, the entirety of which are incorporated herein by reference.

### Silk Fibroin-Like Protein Fragments

The recombinant silk protein in this disclosure comprises synthetic proteins which are based on repeat units of natural silk proteins. Besides the synthetic repetitive silk protein sequences, these can additionally comprise one or more natural nonrepetitive silk protein sequences. As used herein, “silk fibroin-like protein fragments” refer to protein fragments having a molecular weight and polydispersity as defined herein, and a certain degree of homology to a protein selected from native silk protein, fibroin heavy chain, fibroin light chain, or any protein comprising one or more GAGAGS hexa amino acid repeating units. In some embodiments, a degree of homology is selected from about 99%, about 98%, about 97%, about 96%, about 95%, about 94%, about 93%, about 92%, about 91%, about 90%, about 89%, about 88%, about 87%, about 86%, about 85%, about 84%, about 83%, about 82%, about 81%, about 80%, about 79%, about 78%, about 77%, about 76%, about 75%, or less than 75%.

As described herein, a protein such as native silk protein, fibroin heavy chain, fibroin light chain, or any protein comprising one or more GAGAGS hexa amino acid repeating units includes between about 9% and about 45% glycine, or about 9% glycine, or about 10% glycine, about 43% glycine, about 44% glycine, about 45% glycine, or about 46% glycine. As described herein, a protein such as native silk protein, fibroin heavy chain, fibroin light chain, or any protein comprising one or more GAGAGS hexa amino acid repeating units includes between about 13% and about 30% alanine, or about 13% alanine, or about 28% alanine, or about 29% alanine, or about 30% alanine, or about 31% alanine. As described herein, a protein such as native silk protein, fibroin heavy chain, fibroin light chain, or any protein comprising one or more GAGAGS hexa amino acid repeating units includes between 9% and about 12% serine, or about 9% serine, or about 10% serine, or about 11% serine, or about 12% serine.

In some embodiments, a silk fibroin-like protein described herein includes about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, or about 55% glycine. In some embodiments, a silk fibroin-like protein described herein includes about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, or about 39% alanine. In some embodiments, a silk fibroin-like protein described herein includes about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, or about 22% serine. In some embodiments, a silk fibroin-like protein described herein may include independently any amino acid known to be included in natural fibroin. In some embodiments, a silk fibroin-like protein described herein may exclude independently any amino acid known to be included in natural fibroin. In some embodiments, on average 2 out of 6 amino acids, 3 out of 6 amino acids, or 4 out of 6 amino acids in a silk fibroin-like protein described herein is glycine. In some embodiments, on average 1 out of 6 amino acids, 2 out of 6 amino acids, or 3 out of 6 amino acids in a silk fibroin-like protein described herein is alanine. In some embodiments, on average none out of 6 amino acids, 1 out of 6 amino acids, or 2 out of 6 amino acids in a silk fibroin-like protein described herein is serine.

### Sericin or Sericin Fragments

The main body of the raw silk is silk fibroin fiber, and the silk fibroin fiber is coated with an adhesive substance silk sericin. Sericin is a colloidal silk protein that covers the surface of the silk thread and is composed of bulky amino acids rich in chemical reactivity such as serine, threonine, and aspartic acid, in addition to glycine and alanine. In the various processes of producing silk from raw silk, sericin is important in controlling the solubility of silk and producing high quality silk. Moreover, it plays an extremely important role as an adhesion functional protein. When silk fiber is used as a clothing material, most of the silk sericin covering the silk thread is removed and discarded, so sericin is a valuable unused resource.

In some embodiments, the silk protein fragments described herein include sericin or sericin fragments. Methods of preparing sericin or sericin fragments and their applications in various fields are known and are described herein, and are also described, for example, in U.S. Pat. Nos. 7,115,388, 7,157,273, and 9,187,538, all of which are incorporated by reference herein in their entireties.

In some embodiments, sericin removed from the raw silk cocoons, such as in a degumming step, can be collected and used in the methods described herein. Sericin can also be reconstituted from a powder, and used within the compositions and methods of the disclosure.

### Other Properties of SPF

Compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In an embodiment, the stability of a composition of the present disclosure is about 1 day. In an embodiment, the stability of a composition of the present disclosure is about 2 days. In an embodiment, the stability of a composition of the present disclosure is about 3 days. In an embodiment, the stability of a composition of the present disclosure is about 4 days. In an embodiment, the stability of a composition of the present disclosure is about 5 days. In an embodiment, the stability of a composition of the present disclosure is about 6 days. In an embodiment, the stability of a composition of the present disclosure is about 7 days. In an embodiment, the stability of a composition of the present disclosure is about 8 days. In an embodiment, the stability of a composition of the present disclosure is about 9 days. In an embodiment, the stability of a composition of the present disclosure is about 10 days.

In an embodiment, the stability of a composition of the present disclosure is about 11 days, about 12 days, about 13 days, about 14 days, about 15 days, about 16 days, about 17 days, about 18 days, about 19 days, about 20 days, about 21 days, about 22 days, about 23 days, about 24 days, about 25 days, about 26 days, about 27 days, about 28 days, about 29 days, or about 30 days.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a SPF composition of the present disclosure is not soluble in an aqueous solution due to the crystallinity of the protein. In an embodiment, a SPF composition of the present disclosure is soluble in an aqueous solution. In an embodiment, the SPF of a composition of the present disclosure include a crystalline portion of about two-thirds and an amorphous region of about one-third. In an embodiment, the SPF of a composition of the present disclosure include a crystalline portion of about one-half and an amorphous region of about one-half. In an embodiment, the SPF of a composition of the present disclosure include a 99% crystalline portion and a 1% amorphous region. In an embodiment, the SPF of a composition of the present disclosure include a 95% crystalline portion and a 5% amorphous region. In an embodiment, the SPF of a composition of the present disclosure include a 90% crystalline portion and a 10% amorphous region. In an embodiment, the SPF of a composition of the present disclosure include a 85% crystalline portion and a 15% amorphous region. In an embodiment, the SPF of a composition of the present disclosure include a 80% crystalline portion and a 20% amorphous region. In an embodiment, the SPF of a composition of the present disclosure include a 75% crystalline portion and a 25% amorphous region. In an embodiment, the SPF of a composition of the present disclosure include a 70% crystalline portion and a 30% amorphous region. In an embodiment, the SPF of a composition of the present disclosure include a 65% crystalline portion and a 35% amorphous region. In an embodiment, the SPF of a composition of the present disclosure include a 60% crystalline portion and a 40% amorphous region. In an embodiment, the SPF of a composition of the present disclosure include a 50% crystalline portion and a 50% amorphous region. In an embodiment, the SPF of a composition of the present disclosure include a 40% crystalline portion and a 60% amorphous region. In an embodiment, the SPF of a composition of the present disclosure include a 35% crystalline portion and a 65% amorphous region. In an embodiment, the SPF of a composition of the present disclosure include a 30% crystalline portion and a 70% amorphous region. In an embodiment, the SPF of a composition of the present disclosure include a 25% crystalline portion and a 75% amorphous region. In an embodiment, the SPF of a composition of the present disclosure include a 20% crystalline portion and a 80% amorphous region. In an embodiment, the SPF of a composition of the present disclosure include a 15% crystalline portion and a 85% amorphous region. In an embodiment, the SPF of a composition of the present disclosure include a 10% crystalline portion and a 90% amorphous region. In an embodiment, the SPF of a composition of the present disclosure include a 5% crystalline portion and a 90% amorphous region. In an embodiment, the SPF of a composition of the present disclosure include a T % crystalline portion and a 99% amorphous region.

As used herein, the term “substantially free of inorganic residuals” means that the composition exhibits residuals of 0.1% (w/w) or less. In an embodiment, substantially free of inorganic residuals refers to a composition that exhibits residuals of 0.05% (w/w) or less. In an embodiment, substantially free of inorganic residuals refers to a composition that exhibits residuals of 0.01% (w/w) or less. In an embodiment, the amount of inorganic residuals is between 0 ppm (“non-detectable” or “ND”) and 1000 ppm. In an embodiment, the amount of inorganic residuals is ND to about 500 ppm. In an embodiment, the amount of inorganic residuals is ND to about 400 ppm. In an embodiment, the amount of inorganic residuals is ND to about 300 ppm. In an embodiment, the amount of inorganic residuals is ND to about 200 ppm. In an embodiment, the amount of inorganic residuals is ND to about 100 ppm. In an embodiment, the amount of inorganic residuals is between 10 ppm and 1000 ppm.

As used herein, the term “substantially free of organic residuals” means that the composition exhibits residuals of 0.1% (w/w) or less, in an embodiment, substantially free of organic residuals refers to a composition that exhibits residuals of 0.05% (w/w) or less. In an embodiment, substantially free of organic residuals refers to a composition that exhibits residuals of 0.01% (w/w) or less. In an embodiment, the amount of organic residuals is between 0 ppm (“non-detectable” or “ND”) and 1000 ppm. In an embodiment, the amount of organic residuals is ND to about 500 ppm. In an embodiment, the amount of organic residuals is ND to about 400 ppm. In an embodiment, the amount of organic residuals is ND to about 300 ppm. In an embodiment, the amount of organic residuals is ND to about 200 ppm. In an embodiment, the amount of organic residuals is ND to about 100 ppm. In an embodiment, the amount of organic residuals is between 10 ppm and 1000 ppm.

Compositions of the present disclosure exhibit “biocompatibility” meaning that the compositions are compatible with living tissue or a living system by not being toxic, injurious, or physiologically reactive and not causing immunological rejection. Such biocompatibility can be evidenced by participants topically applying compositions of the present disclosure on their skin for an extended period of time. In an embodiment, the extended period of time is about 3 days. In an embodiment, the extended period of time is about 7 days, in an embodiment, the extended period of time is about 14 days, in an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

Compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

As used herein, in some embodiments the term “leather” and/or “leather substrate” refers to natural leather and may be derived from bovine skin, sheep skin, lamb skin, horse skin, crocodile skin, alligator skin, avian skin, or another known animal skin as would be appreciated by the art, or processed leather. Unprocessed, processed, coated, and/or repaired leather may include, without limitation, Altered leather, Aniline leather, Bonded leather, Brushed leather, Buffed leather, Bycast leather, Chamois leather, Chrome-tanned leather, Combination tanned leather, Cordovan leather, Corrected grain leather, Crockproof leather, Drummed leather, Embossed leather, Enhanced grain leather, Grained leather, Metallized leather, Naked leather, Natural grain leather, Nubuck leather, Patent leather, Pearlized leather, Plated leather, Printed leather, Protected leather, Pure Aniline leather, Tanned/Retanned leather, Round Hand leather, Saddle leather, Semi-Aniline leather Shrunken grain leather, Side leather, Split leather, Suede leather, and Wet blue. In some embodiments, the term “leather” may refer to synthetic or reconstituted leather, including, but not limited to, leather partially/fully constituted with cellulose, mushroom-based material, synthetic materials such as vinyl, synthetic materials such as polyamide or polyester.

As used herein, the term “hand” refers to the feel of a material, which may be further described as the feeling of softness, crispness, dryness, silkiness, smoothness, and combinations thereof. Material hand is also referred to as “drape.” A material with a hard hand is coarse, rough, and generally less comfortable for the wearer. A material with a soft hand is fluid and smooth and generally more comfortable for the wearer. Material hand can be determined by comparison to collections of material samples, or by use of methods such as the Kawabata Evaluation System (KES) or the Fabric Assurance by Simple Testing (FAST) methods. Behera and Hari, Ind. J. Fibre & Textile Res., 1994, 19, 168-71. In some embodiments, and as described herein, silk can change the hand of leather, as may be evaluated by SynTouch Touch-Scale methodology or another methodology as described herein.

As used herein, a “coating” refers to a material, or combination of materials, that form a substantially continuous layer or film on an exterior surface of a substrate, such as leather or leather article. In some embodiments, a portion of the coating may penetrate at least partially into the substrate. In some embodiments, the coating may penetrate at least partially into the interstices of a substrate. In some embodiments, the coating may be infused into a surface of the substrate such that the application of the coating, or coating process, may include infusing (at the melting temperature of the substrate) at least one coating component at least partially into a surface of the substrate. A coating may be applied to a substrate by one or more of the processes described herein.

In embodiments described where the coating may be infused into a surface of the substrate, the coating may be codissolved in a surface of the substrate such that a component of the coating may be intermixed in the surface of the substrate to a depth of at least about 1 nm, or at least about 2 nm, or at least about 3 nm, or at least about 4 nm, or at least about 5 nm, or at least about 6 nm, or at least about 7 nm, or at least about 8 nm, or at least about 9 nm, or at least about 10 nm, or at least about 20 nm, or at least about 30 nm, or at least about 40 nm, or at least about 50 nm, or at least about 60 nm, or at least about 70 nm, or at least about 80 nm, or at least about 90 nm, or at least about 100 nm. In some embodiments, the coating may be infused into a surface of the substrate where the substrate includes leather or a leather article.

As used herein, the term “bath coating” encompasses coating a material in a bath, immersing a material in a bath, and submerging a material in a bath. Concepts of bath coating are set forth in U.S. Pat. No. 4,521,458, the entirety of which is incorporated by reference. As used herein, and unless more specifically described, the term “drying” may refer to drying a coated material as described herein at a temperature greater than room temperature (i.e., 20° C.).

Following are non-limiting examples of suitable ranges for various parameters in and for preparation of the silk solutions of the present disclosure. The silk solutions of the present disclosure may include one or more, but not necessarily all, of these parameters and may be prepared using various combinations of ranges of such parameters.

In an embodiment, the percent SPF in the solution is less than 30.0 wt. %. In an embodiment, the percent SPF in the solution is less than 25.0 wt. %. In an embodiment, the percent SPF in the solution is less than 20.0 wt. %. In an embodiment, the percent SPF in the solution is less than 19.0 wt. %. In an embodiment, the percent SPF in the solution is less than 18.0 wt. %. In an embodiment, the percent SPF in the solution is less than 17.0 wt. %. In an embodiment, the percent SPF in the solution is less than 16.0 wt. %. In an embodiment, the percent SPF in the solution is less than 15.0 wt. %. In an embodiment, the percent SPF in the solution is less than 14.0 wt. %. In an embodiment, the percent SPF in the solution is less than 13.0 wt. %. In an embodiment, the percent SPF in the solution is less than 12.0 wt. %. In an embodiment, the percent SPF in the solution is less than 11.0 wt. %. In an embodiment, the percent SPF in the solution is less than 10.0 wt. %. In an embodiment, the percent SPF in the solution is less than 9.0 wt. %. In an embodiment, the percent SPF in the solution is less than 8.0 wt. %. In an embodiment, the percent SPF in the solution is less than 7.0 wt. %. In an embodiment, the percent SPF in the solution is less than 6.0 wt. %. In an embodiment, the percent SPF in the solution is less than 5.0 wt. %. In an embodiment, the percent SPF in the solution is less than 4.0 wt. %. In an embodiment, the percent SPF in the solution is less than 3.0 wt. %. In an embodiment, the percent SPF in the solution is less than 2.0 wt. %. In an embodiment, the percent SPF in the solution is less than 1.0 wt. %. In an embodiment, the percent SPF in the solution is less than 0.9 wt. %. In an embodiment, the percent SPF in the solution is less than 0.8 wt. %. In an embodiment, the percent SPF in the solution is less than 0.7 wt. %. In an embodiment, the percent SPF in the solution is less than 0.6 wt. %. In an embodiment, the percent SPF in the solution is less than 0.5 wt. %. In an embodiment, the percent SPF in the solution is less than 0.4 wt. %. In an embodiment, the percent SPF in the solution is less than 0.3 wt. %. In an embodiment, the percent SPF in the solution is less than 0.2 wt. %. In an embodiment, the percent SPF in the solution is less than 0.1 wt. %.

In an embodiment, the percent SPF in the solution is greater than 0.1 wt. %. In an embodiment, the percent SPF in the solution is greater than 0.2 wt. %. In an embodiment, the percent SPF in the solution is greater than 0.3 wt. %. In an embodiment, the percent SPF in the solution is greater than 0.4 wt. %. In an embodiment, the percent SPF in the solution is greater than 0.5 wt. %. In an embodiment, the percent SPF in the solution is greater than 0.6 wt. %. In an embodiment, the percent SPF in the solution is greater than 0.7 wt. %. In an embodiment, the percent SPF in the solution is greater than 0.8 wt. %. In an embodiment, the percent SPF in the solution is greater than 0.9 wt. %. In an embodiment, the percent SPF in the solution is greater than 1.0 wt. %. In an embodiment, the percent SPF in the solution is greater than 2.0 wt. %. In an embodiment, the percent SPF in the solution is greater than 3.0 wt. %. In an embodiment, the percent SPF in the solution is greater than 4.0 wt. %. In an embodiment, the percent SPF in the solution is greater than 5.0 wt. %. In an embodiment, the percent SPF in the solution is greater than 6.0 wt. %. In an embodiment, the percent SPF in the solution is greater than 7.0 wt. %. In an embodiment, the percent SPF in the solution is greater than 8.0 wt. %. In an embodiment, the percent SPF in the solution is greater than 9.0 wt. %. In an embodiment, the percent SPF in the solution is greater than 10.0 wt. %. In an embodiment, the percent SPF in the solution is greater than 11.0 wt. %. In an embodiment, the percent SPF in the solution is greater than 12.0 wt. %. In an embodiment, the percent SPF in the solution is greater than 13.0 wt. %. In an embodiment, the percent SPF in the solution is greater than 14.0 wt. %. In an embodiment, the percent SPF in the solution is greater than 15.0 wt. %. In an embodiment, the percent SPF in the solution is greater than 16.0 wt. %. In an embodiment, the percent SPF in the solution is greater than 17.0 wt. %. In an embodiment, the percent SPF in the solution is greater than 18.0 wt. %. In an embodiment, the percent SPF in the solution is greater than 19.0 wt. %. In an embodiment, the percent SPF in the solution is greater than 20.0 wt. %. In an embodiment, the percent SPF in the solution is greater than 25.0 wt. %.

In an embodiment, the percent SPF in the solution ranges from about 0.1 wt. % to about 30.0 wt. %. In an embodiment, the percent SPF in the solution ranges from about 0.1 wt. % to about 25.0 wt. %. In an embodiment, the percent SPF in the solution ranges from about 0.1 wt. % to about 20.0 wt. %. In an embodiment, the percent SPF in the solution ranges from about 0.1 wt. % to about 15.0 wt. %. In an embodiment, the percent SPF in the solution ranges from about 0.1 wt. % to about 10.0 wt. %. In an embodiment, the percent SPF in the solution ranges from about 0.1 wt. % to about 9.0 wt. %. In an embodiment, the percent SPF in the solution ranges from about 0.1 wt. % to about 8.0 wt. %. In an embodiment, the percent SPF in the solution ranges from about 0.1 wt. % to about 7.0 wt. %. In an embodiment, the percent SPF in the solution ranges from about 0.1 wt. % to about 6.5 wt. %. In an embodiment, the percent SPF in the solution ranges from about 0.1 wt. % to about 6.0 wt. %. In an embodiment, the percent SPF in the solution ranges from about 0.1 wt. % to about 5.5 wt. %. In an embodiment, the percent SPF in the solution ranges from about 0.1 wt. % to about 5.0 wt. %. In an embodiment, the percent SPF in the solution ranges from about 0.1 wt. % to about 4.5 wt. %. In an embodiment, the percent SPF in the solution ranges from about 0.1 wt. % to about 4.0 wt. %. In an embodiment, the percent SPF in the solution ranges from about 0.1 wt. % to about 3.5 wt. %. In an embodiment, the percent SPF in the solution ranges from about 0.1 wt. % to about 3.0 wt. %. In an embodiment, the percent SPF in the solution ranges from about 0.1 wt. % to about 2.5 wt %. In an embodiment, the percent SPF in the solution ranges from about 0.1 wt. % to about 2.0 wt. %. In an embodiment, the percent SPF in the solution ranges from about 0.1 wt. % to about 2.4 wt. %. In an embodiment, the percent SPF in the solution ranges from about 0.5 wt. % to about 5.0 wt. %. In an embodiment, the percent SPF in the solution ranges from about 0.5 wt. % to about 4.5 wt. %. In an embodiment, the percent SPF in the solution ranges from about 0.5 wt. % to about 4.0 wt. %. In an embodiment, the percent SPF in the solution ranges from about 0.5 wt. % to about 3.5 wt. %. In an embodiment, the percent SPF in the solution ranges from about 0.5 wt. % to about 3.0 wt. %. In an embodiment, the percent SPF in the solution ranges from about 0.5 wt. % to about 2.5 wt. %. In an embodiment, the percent SPF in the solution ranges from about 1.0 wt. % to about 4.0 wt. %. In an embodiment, the percent SPF in the solution ranges from about 1.0 wt. % to about 3.5 wt. %. In an embodiment, the percent SPF in the solution ranges from about 1.0 wt. % to about 3.0 wt. %. In an embodiment, the percent SPF in the solution ranges from about 1.0 wt. % to about 2.5 wt. %. In an embodiment, the percent SPF in the solution ranges from about 1.0 wt. % to about 2.4 wt. %. In an embodiment, the percent SPF in the solution ranges from about 1.0 wt. % to about 2.0 wt. %.

In an embodiment, the percent SPF in the solution ranges from about 20.0 wt. % to about 30.0 wt. %. In an embodiment, the percent SPF in the solution ranges from about 0.1 wt. % to about 10.0 wt. %. In an embodiment, the percent SPF in the solution ranges from about 1.0 wt. % to about 10.0 wt. %. In an embodiment, the percent SPF in the solution ranges from about 2 wt. % to about 10.0 wt. %. In an embodiment, the percent SPF in the solution ranges from about 0.1 wt. % to about 6.0 wt. %. In an embodiment, the percent SPF in the solution ranges from about 6.0 wt. % to about 10.0 wt. %. In an embodiment, the percent SPF in the solution ranges from about 6.0 wt. % to about 8.0 wt. %. In an embodiment, the percent SPF in the solution ranges from about 6.0 wt. % to about 9.0 wt. %. In an embodiment, the percent SPF in the solution ranges from about 10.0 wt. % to about 20.0 wt. %. In an embodiment, the percent SPF in the solution ranges from about 11.0 wt. % to about 19.0 wt. %. In an embodiment, the percent SPF in the solution ranges from about 12.0 wt. % to about 18.0 wt. %. In an embodiment, the percent SPF in the solution ranges from about 13.0 wt. % to about 17.0 wt. %. In an embodiment, the percent SPF in the solution ranges from about 14.0 wt. % to about 16.0 wt. %. In an embodiment, the percent SPF in the solution is about 1.0 wt. %. In an embodiment, the percent SPF in the solution is about 1.5 wt. %. In an embodiment, the percent SPF in the solution is about 2.0 wt. %. In an embodiment, the percent SPF in the solution is about 2.4 wt. %. In an embodiment, the percent SPF in the solution is 3.0 wt. %. In an embodiment, the percent SPF in the solution is 3.5 wt. %. In an embodiment, the percent SPF in the solution is about 4.0 wt. %. In an embodiment, the percent SPF in the solution is about 4.5 wt. %. In an embodiment, the percent SPF in the solution is about 5.0 wt. %. In an embodiment, the percent SPF in the solution is about 5.5 wt. %. In an embodiment the percent SPF in the solution is about 6.0 wt. %. In an embodiment, the percent SPF in the solution is about 6.5 wt. %. In an embodiment, the percent SPF in the solution is about 7.0 wt. %. In an embodiment, the percent SPF in the solution is about 7.5 wt. %. In an embodiment, the percent SPF in the solution is about 8.0 wt. %. In an embodiment, the percent SPF in the solution is about 8.5 wt. %. In an embodiment, the percent SPF in the solution is about 9.0 wt. %. In an embodiment, the percent SPF in the solution is about 9.5 wt. %. In an embodiment, the percent SPF in the solution is about 10.0 wt. %.

In an embodiment, the percent sericin in the solution is non-detectable to 25.0 wt. %. In an embodiment, the percent sericin in the solution is non-detectable to 5.0 wt. %. In an embodiment, the percent sericin in the solution is 1.0 wt. %. In an embodiment, the percent sericin in the solution is 2.0 wt. %. In an embodiment, the percent sericin in the solution is 3.0 wt. %. In an embodiment, the percent sericin in the solution is 4.0 wt. %. In an embodiment, the percent sericin in the solution is 5.0 wt. %. In an embodiment, the percent sericin in the solution is 10.0 wt. %. In an embodiment, the percent sericin in the solution is 25.0 wt. %.

In some embodiments, the silk fibroin protein fragments of the present disclosure are shelf stable (they will not slowly or spontaneously gel when stored in an aqueous solution and there is no aggregation of fragments and therefore no increase in molecular weight over time), from 10 days to 3 years depending on storage conditions, percent SPF, and number of shipments and shipment conditions. Additionally, pH may be altered to extend shelf life and/or support shipping conditions by preventing premature folding and aggregation of the silk. In an embodiment, the stability of the LiBr-silk fragment solution is 0 to 1 year. In an embodiment, the stability of the LiBr-silk fragment solution is 0 to 2 years. In an embodiment, the stability of the LiBr-silk fragment solution is 0 to 3 years. In an embodiment, the stability of the LiBr-silk fragment solution is 0 to 4 years. In an embodiment, the stability of the LiBr-silk fragment solution is 0 to 5 years. In an embodiment, the stability of the LiBr-silk fragment solution is 1 to 2 years. In an embodiment, the stability of the LiBr-silk fragment solution is 1 to 3 years. In an embodiment, the stability of the LiBr-silk fragment solution is 1 to 4 years. In an embodiment, the stability of the LiBr-silk fragment solution is 1 to 5 years. In an embodiment, the stability of the LiBr-silk fragment solution is 2 to 3 years. In an embodiment, the stability of the LiBr-silk fragment solution is 2 to 4 years. In an embodiment, the stability of the LiBr-silk fragment solution is 2 to 5 years. In an embodiment, the stability of the LiBr-silk fragment solution is 3 to 4 years. In an embodiment, the stability of the LiBr-silk fragment solution is 3 to 5 years. In an embodiment, the stability of the LiBr-silk fragment solution is 4 to 5 years.

In an embodiment, the stability of a composition of the present disclosure is 10 days to 6 months. In an embodiment, the stability of a composition of the present disclosure is 6 months to 12 months. In an embodiment, the stability of a composition of the present disclosure is 12 months to 18 months. In an embodiment, the stability of a composition of the present disclosure is 18 months to 24 months. In an embodiment, the stability of a composition of the present disclosure is 24 months to 30 months. In an embodiment, the stability of a composition of the present disclosure is 30 months to 36 months. In an embodiment, the stability of a composition of the present disclosure is 36 months to 48 months. In an embodiment, the stability of a composition of the present disclosure is 48 months to 60 months.

In an embodiment, a composition of the present disclosure having SPF has non-detectable levels of LiBr residuals. In an embodiment, the amount of the LiBr residuals in a composition of the present disclosure is between 10 ppm and 1000 ppm. In an embodiment, the amount of the LiBr residuals in a composition of the present disclosure is between 10 ppm and 300 ppm. In an embodiment, the amount of the LiBr residuals in a composition of the present disclosure is less than 25 ppm. In an embodiment, the amount of the Li Br residuals in a composition of the present disclosure is less than 50 ppm. In an embodiment, the amount of the LiBr residuals in a composition of the present disclosure is less than 75 ppm. In an embodiment, the amount of the LiBr residuals in a composition of the present disclosure is less than 100 ppm. In an embodiment, the amount of the LiBr residuals in a composition of the present disclosure is less than 200 ppm. In an embodiment, the amount of the LiBr residuals in a composition of the present disclosure is less than 300 ppm. In an embodiment, the amount of the LiBr residuals in a composition of the present disclosure is less than 400 ppm. In an embodiment, the amount of the LiBr residuals in a composition of the present disclosure is less than 500 ppm. In an embodiment, the amount of the LiBr residuals in a composition of the present disclosure is less than 600 ppm. In an embodiment, the amount of the LiBr residuals in a composition of the present disclosure is less than 700 ppm. In an embodiment, the amount of the LiBr residuals in a composition of the present disclosure is less than 800 ppm. In an embodiment, the amount of the LiBr residuals in a composition of the present disclosure is less than 900 ppm. In an embodiment, the amount of the LiBr residuals in a composition of the present disclosure is less than 1000 ppm. In an embodiment, the amount of the LiBr residuals in a composition of the present disclosure is non-detectable to 500 ppm. In an embodiment, the amount of the LiBr residuals in a composition of the present disclosure is non-detectable to 450 ppm. In an embodiment, the amount of the LiBr residue in a composition of the present disclosure is non-detectable to 400 ppm. In an embodiment, the amount of the LiBr residuals in a composition of the present disclosure is non-detectable to 350 ppm. In an embodiment, the amount of the LiBr residuals in a composition of the present disclosure is non-detectable to 300 ppm. In an embodiment, the amount of the LiBr residuals in a composition of the present disclosure is non-detectable to 250 ppm. In an embodiment, the amount of the LiBr residuals in a composition of the present disclosure is non-detectable to 200 ppm. In an embodiment, the amount of the LiBr residuals in a composition of the present disclosure is non-detectable to 150 ppm. In an embodiment, the amount of the LiBr residuals in a composition of the present disclosure is non-detectable to 100 ppm. In an embodiment, the amount of the LiBr residuals in a composition of the present disclosure is 100 ppm to 200 ppm. In an embodiment, the amount of the LiBr residuals in a composition of the present disclosure is 200 ppm to 300 ppm. In an embodiment, the amount of the LiBr residuals in a composition of the present disclosure is 300 ppm to 400 ppm. In an embodiment, the amount of the LiBr residuals in a composition of the present disclosure is 400 ppm to 500 ppm.

In an embodiment, a composition of the present disclosure having SPF, has non-detectable levels of Na₂CO₃ residuals. In an embodiment, the amount of the Na₂CO₃ residuals in a composition of the present disclosure is less than 100 ppm. In an embodiment, the amount of the Na₂CO₃ residuals in a composition of the present disclosure is less than 200 ppm. In an embodiment, the amount of the Na₂CO₃ residuals in a composition of the present disclosure is less than 300 ppm. In an embodiment, the amount of the Na₂CO₃ residuals in a composition of the present disclosure is less than 400 ppm. In an embodiment, the amount of the Na₂CO₃ residuals in a composition of the present disclosure is less than 500 ppm. In an embodiment, the amount of the Na₂CO₃ residuals in a composition of the present disclosure is less than 600 ppm. In an embodiment, the amount of the Na₂CO₃ residuals in a composition of the present disclosure is less than 700 ppm. In an embodiment, the amount of the Na₂CO₃ residuals in a composition of the present disclosure is less than 800 ppm. In an embodiment, the amount of the Na₂CO₃ residuals in a composition of the present disclosure is less than 900 ppm. In an embodiment, the amount of the Na₂CO₃ residuals in a composition of the present disclosure is less than 1000 ppm. In an embodiment, the amount of the Na₂CO₃ residuals in a composition of the present disclosure is non-detectable to 500 ppm. In an embodiment, the amount of the Na₂CO₃ residuals in a composition of the present disclosure is non-detectable to 450 ppm. In an embodiment, the amount of the Na₂CO₃ residuals in a composition of the present disclosure is non-detectable to 400 ppm. In an embodiment, the amount of the Na₂CO₃ residuals in a composition of the present disclosure is non-detectable to 350 ppm. In an embodiment, the amount of the Na₂CO₃ residuals in a composition of the present disclosure is non-detectable to 300 ppm. In an embodiment, the amount of the Na₂CO₃ residuals in a composition of the present disclosure is non-detectable to 250 ppm. In an embodiment, the amount of the Na₂CO₃ residuals in a composition of the present disclosure is non-detectable to 200 ppm. In an embodiment, the amount of the Na₂CO₃ residuals in a composition of the present disclosure is non-detectable to 150 ppm. In an embodiment, the amount of the Na₂CO₃ residuals in a composition of the present disclosure is non-detectable to 100 ppm. In an embodiment, the amount of the Na₂CO₃ residuals in a composition of the present disclosure is 100 ppm to 200 ppm. In an embodiment, the amount of the Na₂CO₃ residuals in a composition of the present disclosure is 200 ppm to 300 ppm. In an embodiment, the amount of the Na₂CO₃ residuals in a composition of the present disclosure is 300 ppm to 400 ppm. In an embodiment, the amount of the Na₂CO₃ residuals in a composition of the present disclosure is 400 ppm to 500 ppm.

A unique feature of the SPF compositions of the present disclosure are shelf stability (they will not slowly or spontaneously gel when stored in an aqueous solution and there is no aggregation of fragments and therefore no increase in molecular weight over time), from 10 days to 3 years depending on storage conditions, percent silk, and number of shipments and shipment conditions. Additionally pH may be altered to extend shelf-life and/or support shipping conditions by preventing premature folding and aggregation of the silk. In an embodiment, a SPF solution composition of the present disclosure has a shelf stability for up to 2 weeks at room temperature (RT). In an embodiment, a SPF solution composition of the present disclosure has a shelf stability for up to 4 weeks at RT. In an embodiment, a SPF solution composition of the present disclosure has a shelf stability for up to 6 weeks at RT. In an embodiment, a SPF solution composition of the present disclosure has a shelf stability for up to 8 weeks at RT. In an embodiment, a SPF solution composition of the present disclosure has a shelf stability for up to 10 weeks at RT. In an embodiment, a SPF solution composition of the present disclosure has a shelf stability for up to 12 weeks at RT. In an embodiment, a SPF solution composition of the present disclosure has a shelf stability ranging from about 4 weeks to about 52 weeks at RT.

Table R below shows shelf stability test results for embodiments of SPF compositions of the present disclosure.

TABLE R
Shelf Stability of SPF Compositions of the Present Disclosure

| % Silk | Temperature | Time to Gelation | |
|---|---|---|---|
| 2 | RT | 4 | weeks |
| 2 | 4° C. | >9 | weeks |
| 4 | RT | 4 | weeks |
| 4 | 4° C. | >9 | weeks |
| 6 | RT | 2 | weeks |
| 6 | 4° C. | >9 | weeks |

In some embodiments, the water solubility of the silk film derived from silk fibroin protein fragments as described herein can be modified by solvent annealing (water annealing or methanol annealing), chemical crosslinking, enzyme crosslinking and heat treatment.

In some embodiments, the process of annealing may involve inducing beta-sheet formation in the silk fibroin protein fragment solutions used as a coating material. Techniques of annealing (e.g., increase crystallinity) or otherwise promoting “molecular packing” of silk fibroin-protein based fragments have been described. In some embodiments, the amorphous silk film is annealed to introduce beta-sheet in the presence of a solvent selected from the group of water or organic solvent. In some embodiments, the amorphous silk film is annealed to introduce beta-sheet in the presence of water (water annealing process). In some embodiments, the amorphous silk fibroin protein fragment film is annealed to introduce beta-sheet in the presence of methanol. In some embodiments, annealing (e.g., the beta sheet formation) is induced by addition of an organic solvent. Suitable organic solvents include, but are not limited to methanol, ethanol, acetone, isopropanol, or combination thereof.

In some embodiments, annealing is carried out by so-called “water-annealing” or “water vapor annealing” in which water vapor is used as an intermediate plasticizing agent or catalyst to promote the packing of beta-sheets. In some embodiments, the process of water annealing may be performed under vacuum. Suitable such methods have been described in Jin H-J et al. (2005), Water-stable Silk Films with Reduced Beta-Sheet Content, Advanced Functional Materials, 15: 1241-1247; Xiao H. et al. (2011), Regulation of Silk Material Structure by Temperature-Controlled Water Vapor Annealing, Biomacromolecules, 12(5): 1686-1696.

The important feature of the water annealing process is to drive the formation of crystalline beta-sheet in the silk fibroin protein fragment peptide chain to allow the silk fibroin self-assembling into a continuous film. In some embodiments, the crystallinity of the silk fibroin protein fragment film is controlled by controlling the temperature of water vapor and duration of the annealing. In some embodiments, the annealing is performed at a temperature ranging from about 65° C. to about 110° C. In some embodiments, the temperature of the water is maintained at about 80° C. In some embodiments, annealing is performed at a temperature selected from the group of about 65° C., about 70° C., about 75° C., about 80° C., about 85° C., about 90° C., about 95° C., about 100° C., about 105° C., and about 110° C.

In some embodiments, the annealing process lasts a period of time selected from the group of about 1 minute to about 40 minutes, about 1 minute to about 50 minutes, about 1 minute to about 60 minutes, about 1 minute to about 70 minutes, about 1 minute to about 80 minutes, about 1 minute to about 90 minutes, about 1 minute to about 100 minutes, about 1 minute to about 110 minutes, about 1 minute to about 120 minutes, about 1 minute to about 130 minutes, about 5 minutes to about 40 minutes, about 5 minutes to about 50 minutes, about 5 minutes to about 60 minutes, about 5 minutes to about 70 minutes, about 5 minutes to about 80 minutes, about 5 minutes to about 90 minutes, about 5 minutes to about 100 minutes, about 5 minutes to about 110 minutes, about 5 minutes to about 120 minutes, about 5 minutes to about 130 minutes, about 10 minutes to about 40 minutes, about 10 minutes to about 50 minutes, about 10 minutes to about 60 minutes, about 10 minutes to about 70 minutes, about 10 minutes to about 80 minutes, about 10 minutes to about 90 minutes, about 10 minutes to about 100 minutes, about 10 minutes to about 110 minutes, about 10 minutes to about 120 minutes, about 10 minutes to about 130 minutes, about 15 minutes to about 40 minutes, about 15 minutes to about 50 minutes, about 15 minutes to about 60 minutes, about 15 minutes to about 70 minutes, about 15 minutes to about 80 minutes, about 15 minutes to about 90 minutes, about 15 minutes to about 100 minutes, about 15 minutes to about 110 minutes, about 15 minutes to about 120 minutes, about 15 minutes to about 130 minutes, about 20 minutes to about 40 minutes, about 20 minutes to about 50 minutes, about 20 minutes to about 60 minutes, about 20 minutes to about 70 minutes, about 20 minutes to about 80 minutes, about 20 minutes to about 90 minutes, about 20 minutes to about 100 minutes, about 20 minutes to about 110 minutes, about 20 minutes to about 120 minutes, about 20 minutes to about 130 minutes, about 25 minutes to about 40 minutes, about 25 minutes to about 50 minutes, about 25 minutes to about 60 minutes, about 25 minutes to about 70 minutes, about 25 minutes to about 80 minutes, about 25 minutes to about 90 minutes, about 25 minutes to about 100 minutes, about 25 minutes to about 110 minutes, about 25 minutes to about 120 minutes, about 25 minutes to about 130 minutes, about 30 minutes to about 40 minutes, about 30 minutes to about 50 minutes, about 30 minutes to about 60 minutes, about 30 minutes to about 70 minutes, about 30 minutes to about 80 minutes, about 30 minutes to about 90 minutes, about 30 minutes to about 100 minutes, about 30 minutes to about 110 minutes, about 30 minutes to about 120 minutes, about 30 minutes to about 130 minutes, about 35 minutes to about 40 minutes, about 35 minutes to about 50 minutes, about 35 minutes to about 60 minutes, about 35 minutes to about 70 minutes, about 35 minutes to about 80 minutes, about 35 minutes to about 90 minutes, about 35 minutes to about 100 minutes, about 35 minutes to about 110 minutes, about 35 minutes to about 120 minutes, about 35 minutes to about 130 minutes, about 40 minutes to about 50 minutes, about 40 minutes to about 60 minutes, about 40 minutes to about 70 minutes, about 40 minutes to about 80 minutes, about 40 minutes to about 90 minutes, about 40 minutes to about 100 minutes, about 40 minutes to about 110 minutes, about 40 minutes to about 120 minutes, about 40 minutes to about 130 minutes, about 45 minutes to about 50 minutes, about 45 minutes to about 60 minutes, about 45 minutes to about 70 minutes, about 45 minutes to about 80 minutes, about 45 minutes to about 90 minutes, about 45 minutes to about 100 minutes, about 45 minutes to about 110 minutes, about 45 minutes to about 120 minutes, and about 45 minutes to about 130 minutes. In some embodiments, the annealing process lasts a period of time ranging from about 1 minute to about 60 minutes. In some embodiments, the annealing process lasts a period of time ranging from about 45 minutes to about 60 minutes. The longer water annealing post-processing corresponded an increased crystallinity of silk fibroin protein fragments.

In some embodiments, the annealed silk fibroin protein fragment film is immersing the wet silk fibroin protein fragment film in 100% methanol for 60 minutes at room temperature. The methanol annealing changed the composition of silk fibroin protein fragment film from predominantly amorphous random coil to crystalline antiparallel beta-sheet structure.

### Silk Fibroin-Based Protein Fragments and Solutions Thereof

Provided herein are methods for producing pure and highly scalable silk protein fragment (SPF) mixture solutions that may be used to process and/or coat at least a portion of leather and/or leather articles, or to repair at least one defect in a portion of leather and/or leather article. In some embodiments, SPF mixture solutions may also refer to silk fibroin solutions (SFS), and vice versa. The solutions are generated from raw pure intact silk protein material and processed in order to remove any sericin and achieve the desired average weight average molecular weight (MW) and polydispersity of the fragment mixture. Select method parameters may be altered to achieve distinct final silk protein fragment characteristics depending upon the intended use. The resulting final fragment solution is pure silk protein fragments and water with PPM to non-detectable levels of process contaminants. The concentration, size and polydispersity of silk protein fragments in the solution may further be altered depending upon the desired use and performance requirements. In an embodiment, the pure silk fibroin-based protein fragments in the solution are substantially devoid of sericin, have an average weight average molecular weight ranging from about 6 kDa to about 17 kDa, and have a polydispersity ranging from about 1.5 and about 3.0. In an embodiment, the pure silk fibroin-based protein fragments in the solution are substantially devoid of sericin, have an average weight average molecular weight ranging from about 17 kDa to about 39 kDa, and have a polydispersity ranging from about 1.5 and about 3.0. In an embodiment, the pure silk fibroin-based protein fragments in the solution are substantially devoid of sericin, have an average weight average molecular weight ranging from about 39 kDa to about 80 kDa, and have a polydispersity ranging from about 1.5 and about 3.0. As used herein, the term “silk solution” may refer to solutions of silk proteins, including solutions of silk fibroin-based protein fragments.

Without wishing to be bound by any particular theory, any and all solutions described herein can be further used or processed to obtain a variety of silk and/or SPF compositions, including, but not limited to, silk non-Newtonian fluids, silk materials that can sustain a shear stress network spanning the system, silk solutions containing water or another solvent trapped inside a loose silk polymer network, silk materials that transition from a liquid form via bond percolation transition such as gels, silk immobile network entrapping a mobile solvent, silk materials forming reversible or irreversible crosslinks, silk materials that exhibit a shear modulus, silk elastomers or silk materials exhibiting thermoplastic behavior, silk materials formed by the processes of either glass formation, gelation, or colloidal aggregation, silk crystals, and/or silk crystals polish, glues, gels, pastes, putties, and/or waxes.

As used herein when referring to a number or a numerical range, the term “about” means that the stated number or numerical range is included together with numbers or numerical ranges within experimental variability, or within statistical experimental error from the stated number or numerical range, wherein the variation or error is from 0% to 15%, or from 0% to 10%, or from 0% to 5% of the stated number or numerical range. As used herein, “silk based proteins or fragments thereof” includes silk fibroin-based proteins or fragments thereof, natural silk based proteins or fragments thereof, recombinant silk based proteins or fragments thereof, and combinations thereof. Natural silk based proteins or fragments thereof include spider silk based proteins or fragments thereof, silkworm silk based proteins or fragments thereof, and combinations thereof. Silkworm based proteins or fragments thereof may include Bombyx mori silk based proteins or fragments thereof. The SPF mixture solutions described herein may include silk based proteins or fragments thereof. Moreover, SFS, as described herein, may be replaced with SPF mixture solutions. The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, and 9,545,369, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein.

As used herein, the terms “substantially sericin free” or “substantially devoid of sericin” refer to silk fibers in which a majority of the sericin protein has been removed. In an embodiment, silk fibroin that is substantially devoid of sericin refers to silk fibroin having between about 0.01% (w/w) and about 10.0% (w/w) sericin. In an embodiment, silk fibroin that is substantially devoid of sericin refers to silk fibroin having between about 0.010% (w/w) and about 9.0% (w/w) sericin. In an embodiment, silk fibroin that is substantially devoid of sericin refers to silk fibroin having between about 0.01% (w/w) and about 8.0% (w/w) sericin. In an embodiment, silk fibroin that is substantially devoid of sericin refers to silk fibroin having between about 0.01% (w/w) and about 7.0% (w/w) sericin. In an embodiment, silk fibroin that is substantially devoid of sericin refers to silk fibroin having between about 0.01% (w/w) and about 6.0% (w/w) sericin. In an embodiment, silk fibroin that is substantially devoid of sericin refers to silk fibroin having between about 0.01% (w/w) and about 5.0% (w/w) sericin. In an embodiment, silk fibroin that is substantially devoid of sericin refers to silk fibroin having between about 0% (w/w) and about 4.0% (w/w) sericin. In an embodiment, silk fibroin that is substantially devoid of sericin refers to silk fibroin having between about 0.05% (w/w) and about 4.0% (w/w) sericin. In an embodiment, silk fibroin that is substantially devoid of sericin refers to silk fibroin having between about 0.1% (w/w) and about 4.0% (w/w) sericin. In an embodiment, silk fibroin that is substantially devoid of sericin refers to silk fibroin having between about 0.5% (w/w) and about 4.0% (w/w) sericin. In an embodiment, silk fibroin that is substantially devoid of sericin refers to silk fibroin having between about 1.0% (w/w) and about 4.0% (w/w) sericin. In an embodiment, silk fibroin that is substantially devoid of sericin refers to silk fibroin having between about 1.5% (w/w) and about 4.0% (w/w) sericin. In an embodiment, silk fibroin that is substantially devoid of sericin refers to silk fibroin having between about 2.0% (w/w) and about 4.0% (w/w) sericin. In an embodiment, silk fibroin that is substantially devoid of sericin refers to silk fibroin having between about 2.5% (w/w) and about 4.0% (w/w) sericin. In an embodiment, silk fibroin that is substantially devoid of sericin refers to silk fibroin having a sericin content between about 0.01% (w/w) and about 0.1% (w/w). In an embodiment, silk fibroin that is substantially devoid of sericin refers to silk fibroin having a sericin content below about 0.1% (w/w). In an embodiment, silk fibroin that is substantially devoid of sericin refers to silk fibroin having a sericin content below about 0.05% (w/w). In an embodiment, when a silk source is added to a boiling (100° C.) aqueous solution of sodium carbonate for a treatment time of between about 30 minutes to about 60 minutes, a degumming loss of about 26 wt. % to about 31 wt. % is obtained.

As used herein, the term “substantially homogeneous” may refer to pure silk fibroin-based protein fragments that are distributed in a normal distribution about an identified molecular weight. As used herein, the term “substantially homogeneous” may refer to an even distribution of an additive, for example a pigment, throughout a composition of the present disclosure.

As used herein, “residuals” refer to materials related to one or more process steps in the manufacturing of silk fibroin solutions, silk fibroin fragments solutions, or concentrates thereof.

In some embodiments, compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which in some embodiments may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

In some embodiments, compositions and articles described herein, and methods of preparing the same, include silk coated leather or leather article. The leather or leather article may be a polymeric material such as those described elsewhere herein. The terms “infused” and/or “partially dissolved” includes mixing to form a dispersion of, e.g., a portion of leather or leather article with a portion of the silk based coating. In some embodiments, the dispersion may be a solid suspension (i.e., a dispersion comprising domains on the order of 10 nm) or a solid solution (i.e., a molecular dispersion) of silk. In some embodiments, the dispersion may be localized at the surface interface between the silk coating and the leather or leather article, and may have a depth of 1 nm, 2 nm, 5 nm, 10 nm, 25 nm, 50 nm, 75 nm, 100 nm, or greater than 100 nm, depending on the method of preparation. In some embodiments, the dispersion may be a layer sandwiched between the leather or leather article and the silk coating. In some embodiments, the dispersion may be prepared by coating silk, including silk fibroin with the characteristics described herein, onto the leather or leather article, and then performing an additional process to form the dispersion, including heating at a temperature of 100° C., 125° C., 150° C., 175° C., 200° C., 225° C., or 250° C. for a time period selected from the group consisting of 1 minute, 2 minutes, 5 minutes, 10 minutes, 15 minutes, 20 minutes, 30 minutes, 1 hour, 2 hours, 4 hours, 8 hours, 16 hours, or 24 hours. In some embodiments, heating may be performed at or above the glass transition temperature (T_{g}) of silk and/or the polymeric fabric or textile, which may be assessed by methods known in the art. In some embodiments, the dispersion may be formed by coating silk, including silk fibroin with the characteristics described herein, onto the leather or leather article, and then performing an additional process to impregnate the silk coating into the leather or leather article, including treatment with an organic solvent. Methods for characterizing the properties of polymers dissolved in one another are well known in the art and include differential scanning calorimetry and surface analysis methods capable of depth profiling, including spectroscopic methods.

In some embodiments, compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In some embodiments, where aqueous solutions are used to prepare SPF compositions or SPF containing coatings, the aqueous solutions are prepared using any type of water. In some embodiments, water may be DI water, tap water, or naturally available water. As used herein, “tap water” refers to potable water provided by public utilities and water of comparable quality, regardless of the source, without further refinement such as by reverse osmosis, distillation, and/or deionization. Therefore, the use of “DI water,” “RODI water,” or “water,” as set forth herein, may be understood to be interchangeable with “tap water” according to the processes described herein without deleterious effects to such processes.

Leather and Leather Articles Processed, Coated, and/or Repaired with Silk Fibroin-Based Protein Fragments

In one aspect, the present disclosure provides a coating composition comprising silk fibroin proteins or fragments thereof. In an embodiment, the silk fibroin proteins or fragments thereof have an average weight average molecular weight in a range selected from between about 1 kDa and about 5 kDa, between about 5 kDa and about 10 kDa, between about 6 kDa and about 17 kDa, between about 10 kDa and about 15 kDa, between about 14 kDa and about 30 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, the silk fibroin proteins or fragments thereof have any average weight average molecular weight described herein. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, of claim 1, wherein the silk fibroin proteins or fragments thereof have a polydispersity between about 4 and about 4.5. In some embodiments, the silk fibroin proteins or fragments thereof have a polydispersity between about 4.5 and about 5.

In an embodiment, the silk fibroin proteins or fragments thereof have any average weight average molecular weight and polydispersity described herein, and optionally any other limitations described herein, and about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%.

In an embodiment, the silk fibroin proteins or fragments thereof have any average weight average molecular weight and polydispersity described herein, and optionally any other limitations described herein, wherein the silk fibroin proteins or fragments thereof do not spontaneously or gradually gelate and do not visibly change in color or turbidity when in an aqueous solution for at least 10 days prior to being coated onto the article. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month prior to being coated on the article.

In one aspect, the present disclosure provides an article coated with the coating composition described elsewhere herein.

In an embodiment, the article is a leather article such as a leather substrate. Some methods for adding a protein to a substrate, including a leather substrate, are described in U.S. Pat. No. 8,993,065, incorporated herein by reference in its entirety. The disclosure also provides an article including a leather substrate and silk fibroin proteins or fragments thereof having any average weight average molecular weight and polydispersity described herein, and optionally any other limitations described herein, wherein: 1) a portion of the silk fibroin proteins or fragments thereof is coated on a surface of the leather substrate; or 2) a portion of the silk fibroin proteins or fragments thereof is infused into a layer of the leather substrate, in some embodiments, such layers having a thickness as described herein; or 3) a portion of the silk fibroin proteins or fragments thereof is in a recessed portion of the leather substrate selected from an opening, a crevice, and a defect in the leather substrate; or 4) any combination of the above.

In some embodiments, a portion of the silk fibroin proteins or fragments thereof, which is coated on a surface of the leather substrate can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm. In some embodiments, a coating including silk fibroin proteins or fragments thereof, and optionally rheology modifiers and/or plasticizer, which is coated on a surface of the leather substrate, can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm.

In some embodiments, a coating including silk fibroin proteins or fragments thereof, and optionally rheology modifiers and/or plasticizer, which is coated on a surface of the leather substrate, can have a thickness of less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, or less than about 30 μm. In some embodiments, a coating including silk fibroin proteins or fragments thereof, and optionally rheology modifiers and/or plasticizer, which is coated on a surface of the leather substrate, can have a thickness of greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, or greater than about 30 μm.

In another embodiment, the coating composition described elsewhere herein is formulated into paint. Therefore, in one embodiment, the article is an article that can be painted, such as a wall or a metal surface.

As described herein, the coating compositions can be coated on any surface of the article, or included in a recessed portion of the article. A recessed portion of the article can have various depths, including, without limitation, between about 1 μm and about 15 μm, between about 5 μm and about 25 μm, between about 10 μm and about 50 μm, between about 25 μm and about 75 μm, between about 50 m and about 150 μm, between about 75 μm and about 500 μm, and between about 100 μm and about 1000 μm. In some embodiments, a recessed portion of the article can have a depth of about 1 μm, about 2 μm, about 3 μm, about 4 μm, about 5 μm, about 6 μm, about 7 μm, about 8 μm, about 9 μm, about 10 μm, about 1 jm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 jm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, about 100 μm, about 101 μm, about 102 μm, about 103 μm, about 104 μm, about 105 μm, about 106 μm, about 107 μm, about 108 μm, about 109 μm, about 110 μm, about 111 μm, about 112 μm, about 113 μm, about 114 μm, about 115 μm, about 116 μm, about 117 μm, about 118 μm, about 119 μm, about 120 μm, about 121 μm, about 122 μm, about 123 μm, about 124 μm, about 125 μm, about 126 μm, about 127 μm, about 128 μm, about 129 μm, about 130 μm, about 131 μm, about 132 μm, about 133 μm, about 134 μm, about 135 μm, about 136 μm, about 137 μm, about 138 μm, about 139 μm, about 140 μm, about 141 μm, about 142 μm, about 143 μm, about 144 μm, about 145 μm, about 146 μm, about 147 μm, about 148 μm, about 149 μm, about 150 μm, about 151 μm, about 152 μm, about 153 μm, about 154 μm, about 155 μm, about 156 μm, about 157 μm, about 158 μm, about 159 μm, about 160 μm, about 161 μm, about 162 μm, about 163 μm, about 164 μm, about 165 μm, about 166 μm, about 167 μm, about 168 μm, about 169 μm, about 170 μm, about 171 μm, about 172 μm, about 173 μm, about 174 μm, about 175 μm, about 176 μm, about 177 μm, about 178 μm, about 179 μm, about 180 μm, about 181 μm, about 182 μm, about 183 μm, about 184 μm, about 185 μm, about 186 μm, about 187 μm, about 188 μm, about 189 μm, about 190 μm, about 191 μm, about 192 μm, about 193 μm, about 194 μm, about 195 μm, about 196 μm, about 197 μm, about 198 μm, about 199 μm, or about 200 μm. In some embodiments, a recessed portion of the article can have a depth of about 132 μm, about 151 μm, about 126 μm, about 132 μm, and/or about 63 μm.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 50% and about 75% of the depth of the recessed portion, at least between about 45% and about 80% of the depth of the recessed portion, at least between about 65% and about 85% of the depth of the recessed portion, at least between about 75% and about 95% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 53%, 52%, 51%, or 50% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 5% and about 25% of the depth of the recessed portion, at least between about 10% and about 35% of the depth of the recessed portion, at least between about 15% and about 50% of the depth of the recessed portion, at least between about 25% and about 75% of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, less than about 30 μm, less than about 31 μm, less than about 32 μm, less than about 33 μm, less than about 34 μm, less than about 35 μm, less than about 36 μm, less than about 37 μm, less than about 38 μm, less than about 39 μm, less than about 40 μm, less than about 41 μm, less than about 42 μm, less than about 43 μm, less than about 44 μm, less than about 45 μm, less than about 46 μm, less than about 47 μm, less than about 48 μm, less than about 49 μm, less than about 50 μm, less than about 51 μm, less than about 52 μm, less than about 53 μm, less than about 54 μm, less than about 55 μm, less than about 56 μm, less than about 57 μm, less than about 58 μm, less than about 59 μm, less than about 60 μm, less than about 61 μm, less than about 62 μm, less than about 63 μm, less than about 64 μm, less than about 65 μm, less than about 66 μm, less than about 67 μm, less than about 68 μm, less than about 69 μm, less than about 70 μm, less than about 71 μm, less than about 72 μm, less than about 73 μm, less than about 74 μm, less than about 75 μm, less than about 76 μm, less than about 77 μm, less than about 78 μm, less than about 79 μm, less than about 80 μm, less than about 81 μm, less than about 82 μm, less than about 83 μm, less than about 84 μm, less than about 85 μm, less than about 86 μm, less than about 87 μm, less than about 88 μm, less than about 89 μm, less than about 90 μm, less than about 91 μm, less than about 92 μm, less than about 93 μm, less than about 94 μm, less than about 95 μm, less than about 96 μm, less than about 97 μm, less than about 98 μm, less than about 99 μm, less than about 100 μm, less than about 101 μm, less than about 102 μm, less than about 103 μm, less than about 104 μm, less than about 105 μm, less than about 106 μm, less than about 107 μm, less than about 108 μm, less than about 109 μm, less than about 110 μm, less than about 111 μm, less than about 112 μm, less than about 113 μm, less than about 114 μm, less than about 115 μm, less than about 116 μm, less than about 117 μm, less than about 118 μm, less than about 119 μm, less than about 120 μm, less than about 121 μm, less than about 122 μm, less than about 123 μm, less than about 124 μm, less than about 125 μm, less than about 126 μm, less than about 127 μm, less than about 128 μm, less than about 129 μm, less than about 130 μm, less than about 131 μm, less than about 132 μm, less than about 133 μm, less than about 134 μm, less than about 135 μm, less than about 136 μm, less than about 137 μm, less than about 138 μm, less than about 139 μm, less than about 140 μm, less than about 141 μm, less than about 142 μm, less than about 143 μm, less than about 144 μm, less than about 145 μm, less than about 146 μm, less than about 147 μm, less than about 148 μm, less than about 149 μm, less than about 150 μm, less than about 151 μm, less than about 152 μm, less than about 153 μm, less than about 154 μm, less than about 155 μm, less than about 156 μm, less than about 157 μm, less than about 158 μm, less than about 159 μm, less than about 160 μm, less than about 161 μm, less than about 162 μm, less than about 163 μm, less than about 164 μm, less than about 165 μm, less than about 166 μm, less than about 167 μm, less than about 168 μm, less than about 169 μm, less than about 170 μm, less than about 171 μm, less than about 172 μm, less than about 173 μm, less than about 174 μm, less than about 175 μm, less than about 176 μm, less than about 177 μm, less than about 178 μm, less than about 179 μm, less than about 180 μm, less than about 181 μm, less than about 182 μm, less than about 183 μm, less than about 184 μm, less than about 185 μm, less than about 186 μm, less than about 187 μm, less than about 188 μm, less than about 189 μm, less than about 190 μm, less than about 191 μm, less than about 192 μm, less than about 193 μm, less than about 194 μm, less than about 195 μm, less than about 196 μm, less than about 197 μm, less than about 198 μm, less than about 199 μm, or less than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 132 μm, less than about 151 μm, less than about 126 μm, less than about 132 μm, and/or less than about 63 μm of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, greater than about 30 μm, greater than about 31 μm, greater than about 32 μm, greater than about 33 μm, greater than about 34 μm, greater than about 35 μm, greater than about 36 μm, greater than about 37 μm, greater than about 38 μm, greater than about 39 μm, greater than about 40 μm, greater than about 41 μm, greater than about 42 μm, greater than about 43 μm, greater than about 44 μm, greater than about 45 μm, greater than about 46 μm, greater than about 47 μm, greater than about 48 μm, greater than about 49 μm, greater than about 50 μm, greater than about 51 μm, greater than about 52 μm, greater than about 53 μm, greater than about 54 μm, greater than about 55 μm, greater than about 56 μm, greater than about 57 μm, greater than about 58 μm, greater than about 59 μm, greater than about 60 μm, greater than about 61 μm, greater than about 62 μm, greater than about 63 μm, greater than about 64 μm, greater than about 65 μm, greater than about 66 μm, greater than about 67 μm, greater than about 68 μm, greater than about 69 μm, greater than about 70 μm, greater than about 71 μm, greater than about 72 μm, greater than about 73 μm, greater than about 74 μm, greater than about 75 μm, greater than about 76 μm, greater than about 77 μm, greater than about 78 μm, greater than about 79 μm, greater than about 80 μm, greater than about 81 μm, greater than about 82 μm, greater than about 83 μm, greater than about 84 μm, greater than about 85 μm, greater than about 86 μm, greater than about 87 μm, greater than about 88 μm, greater than about 89 μm, greater than about 90 μm, greater than about 91 μm, greater than about 92 μm, greater than about 93 μm, greater than about 94 μm, greater than about 95 μm, greater than about 96 μm, greater than about 97 μm, greater than about 98 μm, greater than about 99 μm, greater than about 100 μm, greater than about 101 μm, greater than about 102 μm, greater than about 103 μm, greater than about 104 μm, greater than about 105 μm, greater than about 106 μm, greater than about 107 μm, greater than about 108 μm, greater than about 109 μm, greater than about 110 μm, greater than about 111 μm, greater than about 112 μm, greater than about 113 μm, greater than about 114 μm, greater than about 115 μm, greater than about 116 μm, greater than about 117 μm, greater than about 118 μm, greater than about 119 μm, greater than about 120 μm, greater than about 121 μm, greater than about 122 μm, greater than about 123 μm, greater than about 124 μm, greater than about 125 μm, greater than about 126 μm, greater than about 127 μm, greater than about 128 μm, greater than about 129 μm, greater than about 130 μm, greater than about 131 μm, greater than about 132 μm, greater than about 133 μm, greater than about 134 μm, greater than about 135 μm, greater than about 136 μm, greater than about 137 μm, greater than about 138 μm, greater than about 139 μm, greater than about 140 μm, greater than about 141 μm, greater than about 142 μm, greater than about 143 μm, greater than about 144 μm, greater than about 145 μm, greater than about 146 μm, greater than about 147 μm, greater than about 148 μm, greater than about 149 μm, greater than about 150 μm, greater than about 151 μm, greater than about 152 μm, greater than about 153 μm, greater than about 154 μm, greater than about 155 μm, greater than about 156 μm, greater than about 157 μm, greater than about 158 μm, greater than about 159 μm, greater than about 160 μm, greater than about 161 μm, greater than about 162 μm, greater than about 163 μm, greater than about 164 μm, greater than about 165 μm, greater than about 166 μm, greater than about 167 μm, greater than about 168 μm, greater than about 169 μm, greater than about 170 μm, greater than about 171 μm, greater than about 172 μm, greater than about 173 μm, greater than about 174 μm, greater than about 175 μm, greater than about 176 μm, greater than about 177 μm, greater than about 178 μm, greater than about 179 μm, greater than about 180 μm, greater than about 181 μm, greater than about 182 μm, greater than about 183 μm, greater than about 184 μm, greater than about 185 μm, greater than about 186 μm, greater than about 187 μm, greater than about 188 μm, greater than about 189 μm, greater than about 190 μm, greater than about 191 μm, greater than about 192 μm, greater than about 193 μm, greater than about 194 μm, greater than about 195 μm, greater than about 196 μm, greater than about 197 μm, greater than about 198 μm, greater than about 199 μm, or greater than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 132 μm, greater than about 151 μm, greater than about 126 μm, greater than about 132 μm, and/or greater than about 63 μm of the depth of the recessed portion.

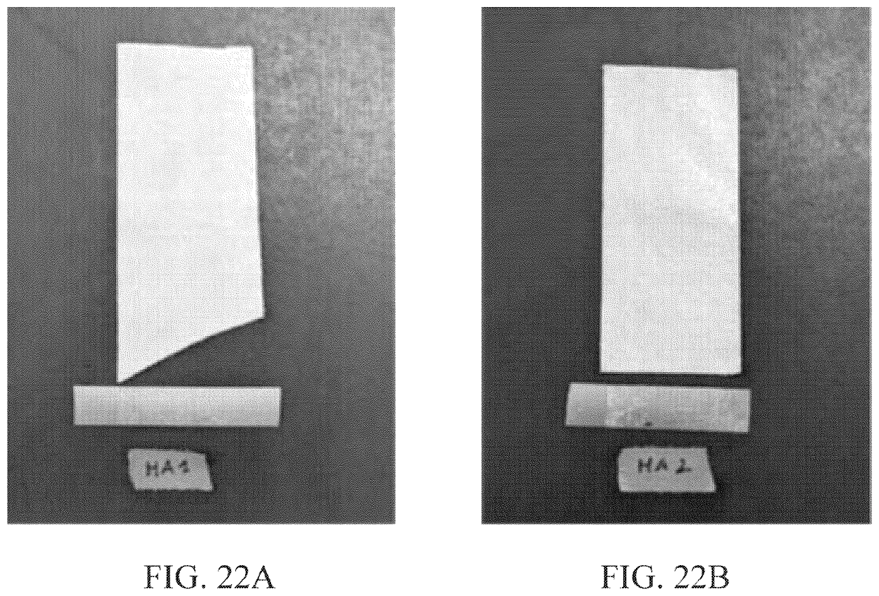

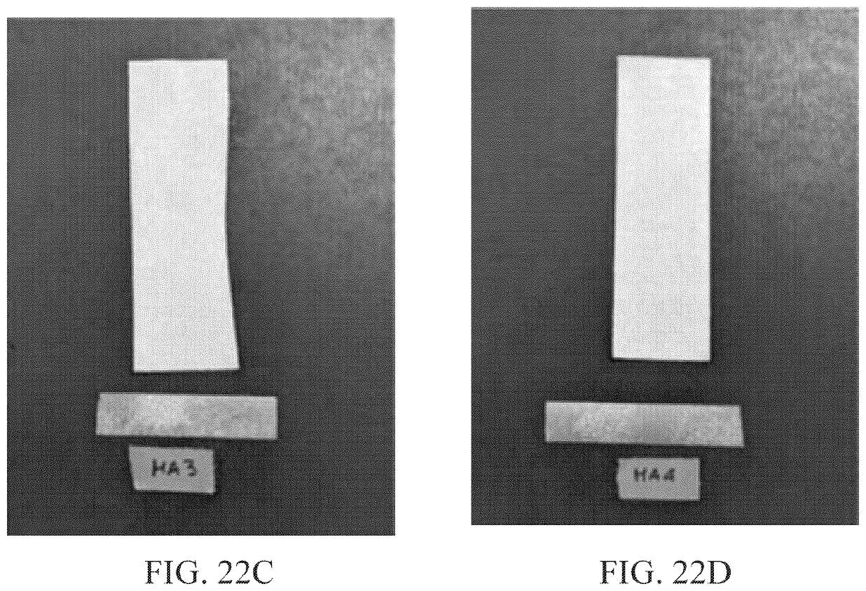

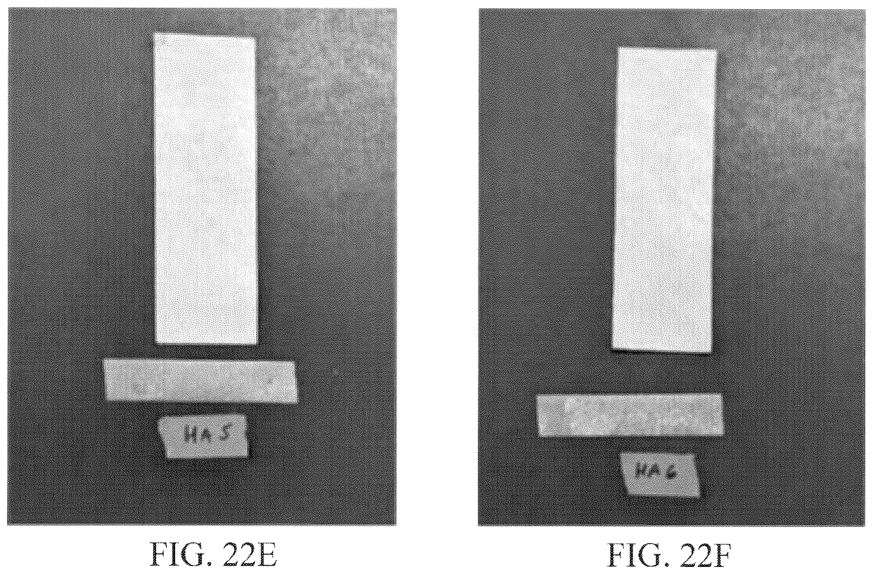

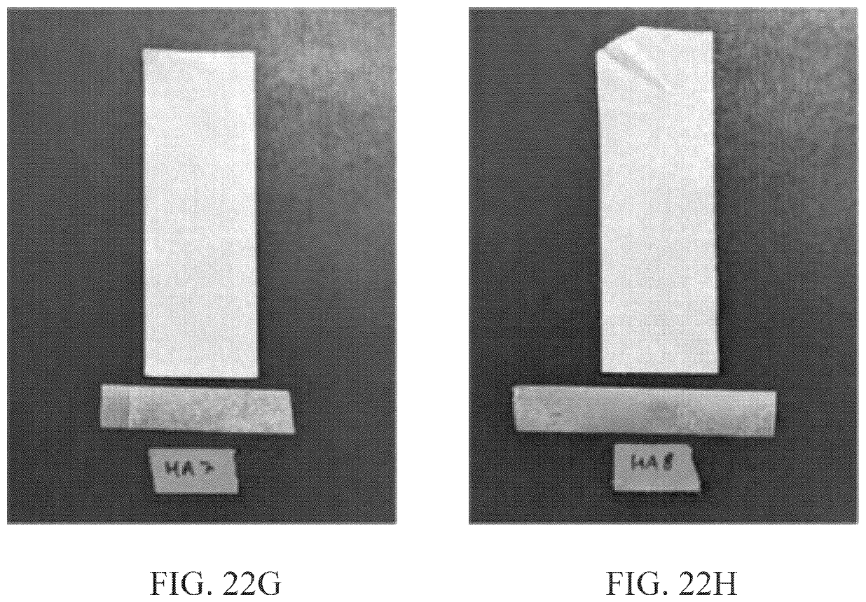

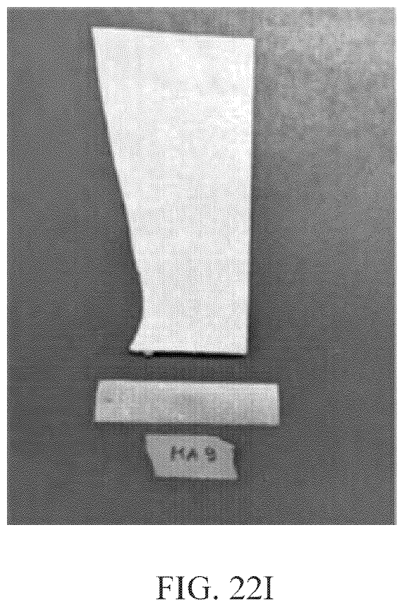

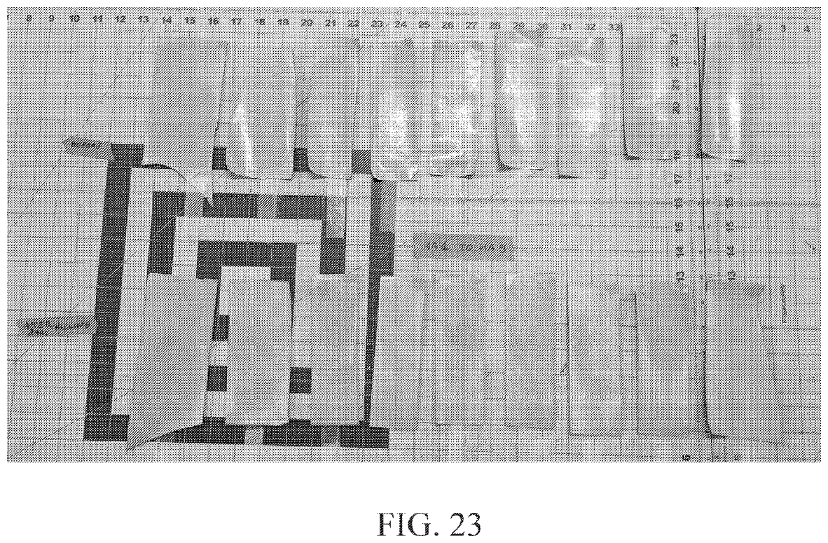

Referring to FIGS. 22A and 22B, the manner in which a portion of the silk fibroin proteins or fragments thereof is coated on a surface of the leather substrate, or the manner in which a portion of the silk fibroin proteins or fragments thereof is in a recessed portion of the leather substrate, can be described by way of a cross-section index, wherein a cross-section index is defined as the ratio between the area above the curve up to a baseline and the length of the cross section across which the area above the curve is determined. The cross-section index is reflected herein as a unitless value. The curve may reflect the leather surface (if uncoated or unfilled) along a cross-section, or a surface of a silk fibroin proteins or fragments thereof coating or filling along a cross-section. The baseline may reflect a horizontal plane approximating the surface of the leather substrate across the segment through which the cross-section index is determined.

As shown in FIG. 49A, a recessed portion is for example between the cross-section x1=about 210 μm, and x2=about 600 μm, and the cross-section index of this recessed portion can be calculated as described herein. In some embodiments, a recessed portion of the leather substrate has a cross-section index of about 6.50, about 6.75, about 7, about 7.25, about 7.50, about 7.75, about 8, about 8.25, about 8.50, about 8.75, about 9, about 9.25, about 9.50, about 9.75, or about 10. In some embodiments, a recessed portion of the leather substrate can have another cross-section index, for example about 5, about 5.1, about 5.2, about 5.3, about 5.4, about 5.5, about 5.6, about 5.7, about 5.8, about 5.9, about 6, about 6.1, about 6.2, bout 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, bout 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, or about 10. Also as shown in FIG. 49A, a substantially non-recessed portion of the leather substrate is for example between the cross-section x1=0 μm, and x2=about 210 μm, and the cross-section index of this substantially non-recessed portion can be calculated as described herein. In some embodiments, a substantially non-recessed portion of the leather substrate has a cross-section index of about 1.1, about 1.2, about 1.3, about 1.4, about 1.5, about 1.6, about 1.7, about 1.8, about 1.9, or about 2.0. In some embodiments, a substantially non-recessed portion of the leather substrate can have another cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

As shown in FIG. 22B, a recessed portion filled with silk fibroin proteins or fragments thereof is for example between the cross-section x1=about 210 μm, and x2=about 395 μm, and the cross-section index of this filled recessed portion can be calculated as described herein. In some embodiments, a filled recessed portion of the leather substrate can have a cross-section index of about 0.25, about 0.50, about 0.75, about 1, about 1.25, about 1.27, about 1.50, about 1.75, or about 2. In some embodiments, a filled recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3. Also as shown in FIG. 22B, a substantially non-recessed portion of the leather substrate coated with silk fibroin proteins or fragments thereof is for example between the cross-section x1=0 μm, and x2=about 210 μm, and the cross-section index of this recessed portion can be calculated as described herein. In some embodiments, a coated substantially non-recessed portion of the leather substrate has a cross-section index of about 0.05, about 0.1, about 0.15, about 0.2, about 0.25, about 0.50, about 0.75, about 1, about 1.25, about 1.27, about 1.50, about 1.75, or about 2. In some embodiments, a coated substantially non-recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

In some embodiments, a coated substantially non-recessed portion of the leather substrate may have a cross-section index lower than a substantially non-recessed portion of the leather substrate before coating. In some embodiments, a coated substantially non-recessed portion of the leather substrate has a cross-section index lower than a substantially non-recessed portion of the leather substrate before coating, wherein the cross-section index of the coated substantially non-recessed portion of the leather substrate is higher than 0. In some embodiments, a coated substantially non-recessed portion of the leather substrate has a cross-section index lower than a substantially non-recessed portion of the leather substrate before coating by a factor between 1% and 99%.

In some embodiments, a coated substantially non-recessed portion of the leather substrate may have a cross-section index lower than a substantially recessed portion of the leather substrate before filling. In some embodiments, a coated substantially non-recessed portion of the leather substrate has a cross-section index lower than a substantially recessed portion of the leather substrate before filling, wherein the cross-section index of the coated substantially non-recessed portion of the leather substrate is higher than 0. In some embodiments, a coated substantially non-recessed portion of the leather substrate has a cross-section index lower than a substantially recessed portion of the leather substrate before filling by a factor between 1% and 99%.

In some embodiments, a filled recessed portion of the leather substrate may have a cross-section index lower than a substantially non-recessed portion of the leather substrate before coating. In some embodiments, a filled recessed portion of the leather substrate may have a cross-section index lower than a substantially non-recessed portion of the leather substrate before coating, wherein the cross-section index of the filled recessed portion of the leather substrate is higher than 0. In some embodiments, a filled recessed portion of the leather substrate may have a cross-section index lower than a substantially non-recessed portion of the leather substrate before coating by a factor between 1% and 99%.

In some embodiments, a filled recessed portion of the leather substrate may have a cross-section index lower than a substantially non-recessed portion of the leather substrate before filling. In some embodiments, a filled recessed portion of the leather substrate may have a cross-section index lower than a substantially non-recessed portion of the leather substrate before filling, wherein the cross-section index of the filled recessed portion of the leather substrate is higher than 0. In some embodiments, a filled recessed portion of the leather substrate may have a cross-section index lower than a substantially non-recessed portion of the leather substrate before filling by a factor between 1% and 99%.

The disclosure also provides an article including a leather substrate and silk fibroin proteins or fragments thereof having any average weight average molecular weight and polydispersity described herein, and optionally any other limitations described herein, the article further including one or more polysaccharides selected from starch, cellulose, gum arabic, guar gum, xanthan gum, alginate, pectin, chitin, chitosan, carrageenan, inulin, and gellan gum. In some embodiments, the polysaccharide is gellan gum. In some embodiments, the gellan gum comprises low-acyl content gellan gum. In some embodiments, the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the polysaccharide is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1. about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the polysaccharide is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. The ratio between the silk fibroin proteins or fragments thereof and the polysaccharide can be determined by any method known in the art, for example a mass spectrometry method, a spectroscopic method such as IR or NMR, a surface analysis method, or the like.

The disclosure provides an article including a leather substrate and silk fibroin proteins or fragments thereof having an average weight average molecular weight between about 1 kDa and about 5 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 5 kDa and about 10 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 6 kDa and about 17 kDa, and a polydispersity between 1 and about 5, or 1 and about 3, or any other range described herein; the article optionally including about 0.001% (w/w) to about 10% (w/w) sericin relative to the silk fibroin proteins or fragments thereof, wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 10 kDa and about 15 kDa, and a polydispersity between 1 and about 5, or 1 and about 3, or any other range described herein; the article optionally including about 0.001% (w/w) to about 10% (w/w) sericin relative to the silk fibroin proteins or fragments thereof, wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 15 kDa and about 20 kDa, and a polydispersity between 1 and about 5, or 1 and about 3, or any other range described herein; the article optionally including about 0.001% (w/w) to about 10% (w/w) sericin relative to the silk fibroin proteins or fragments thereof, wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 17 kDa and about 39 kDa, and a polydispersity between 1 and about 5, or 1 and about 3, or any other range described herein; the article optionally including about 0.0010% (w/w) to about 10% (w/w) sericin relative to the silk fibroin proteins or fragments thereof, wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 20 kDa and about 25 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 25 kDa and about 30 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 30 kDa and about 35 kDa, and a polydispersity between 1 and about 5, or 1 and about 3, or any other range described herein; the article optionally including about 0.0010% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 35 kDa and about 40 kDa, and a polydispersity between 1 and about 5, or 1 and about 3, or any other range described herein; the article optionally including about 0.0010% (w/w) to about 10% (w/w) sericin relative to the silk fibroin proteins or fragments thereof, wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 39 kDa and about 80 kDa, and a polydispersity between 1 and about 5, or 1 and about 3, or any other range described herein; the article optionally including about 0.0010% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 40 kDa and about 45 kDa, and a polydispersity between 1 and about 5, or 1 and about 3, or any other range described herein; the article optionally including about 0.0010% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 45 kDa and about 50 kDa, and a polydispersity between 1 and about 5, or 1 and about 3, or any other range described herein; the article optionally including about 0.0010% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 60 kDa and about 100 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 80 kDa and about 144 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure also provides an article including a leather substrate and silk fibroin proteins or fragments thereof having any average weight average molecular weight and polydispersity described herein, and optionally any other limitations described herein, the article further including one or more polyols, and/or one or more polyethers. In some embodiments, the polyols include one or more of glycol, glycerol, sorbitol, glucose, sucrose, and dextrose. In some embodiments, the polyethers include one or more polyethyleneglycols (PEGs). In some embodiments, the w/w ratio between the silk fibroin proteins or fragments thereof and the one or more polyols and/or one or more polyethers is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5. about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the one or more polyols and/or one or more polyethers is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99

The disclosure also provides an article including a leather substrate and silk fibroin proteins or fragments thereof having any average weight average molecular weight and polydispersity described herein, and optionally any other limitations described herein, the article further including one or more of a silicone, a dye, a pigment, and a polyurethane as described herein.

In an embodiment, an aqueous coating composition described elsewhere herein is applied directly to the article. In an embodiment, a silk coating described elsewhere herein can be coated on the article to form a pattern or design on the article. In an embodiment, a coating composition described elsewhere herein is applied to a leather or leather article under tension and/or lax to vary penetration into the leather or leather article. In an embodiment, the disclosure provides leather and leather articles coated with a silk composition described herein. In an embodiment, the disclosure provides leather and leather articles repaired with a silk composition described herein, for example by filling, masking, or hiding a defect in the surface or structure of the leather.

In an embodiment, the disclosure provides leather and leather articles processed with any one of herein described silk compositions and a dye to provide colored leather and leather articles exhibiting enhanced color-saturation and excellent color-fixation properties.

In some embodiments, the silk composition may be applied currently with the dye. In some embodiments, the silk composition may be applied prior to the dyeing process. In some embodiments, the silk composition may be applied post the dyeing process. In some embodiments, the leather may include nubuck skin in crust, nubuck skin finished in black or blue color, suede skin fined in brown or turquoise color, bottom split suede, or top split wet blue suede.

The disclosure provides generally to methods and articles related to filling a recessed portion of a leather, such as, without limitation, an opening, a crevice, or a defect in a leather substrate, with silk fibroin proteins and/or fragments thereof. As used herein, the term “defect” or “leather defect,” refers to any imperfection in or on the surface, and/or the underlying structure of the leather. For example, removal of a hair and/or hair follicle may leave a visible void or gap in the surface or structure of the leather or hide. This disclosure is not limited to repairing visible defects, and thus it is contemplated that any defects can be repaired as described herein. This disclosure is likewise not limited to repairing defects of a certain size, and defects of any size can be repaired and/or filled. For example, silk and/or SPFs, and any and all compositions described herein, can be used to fill in or mask the appearance of larger defects occurring over larger areas of a defective skin surface.

As used herein, “repaired” or “repairing” leather refers to filling a defect with a composition including silk and/or SPF, wherein as a result of such repairing the defect is substantially eliminated. For example, a void or gap which is fully or partially filled with a composition as described herein may be a repaired defect.

In an embodiment, the disclosure provides a leather or leather article processed, coated, and/or repaired with silk fibroin-based proteins or fragments thereof. In an embodiment, the disclosure provides a leather or leather article processed, coated, or repaired with silk fibroin-based proteins or fragments thereof, wherein the leather or leather article is a leather or leather article used for human apparel, including apparel. In an embodiment, the disclosure provides a leather or leather article processed, coated, or repaired with silk fibroin-based proteins or fragments thereof, wherein the leather or leather article is used for automobile upholstery. In an embodiment, the disclosure provides a leather or leather article processed, coated, or repaired with silk fibroin-based proteins or fragments thereof, wherein the leather or leather article is used for aircraft upholstery. In an embodiment, the disclosure provides a leather or leather article processed, coated, or repaired with silk fibroin-based proteins or fragments thereof, wherein the leather or leather article is used for upholstery in transportation vehicles for public, commercial, military, or other use, including buses and trains. In an embodiment, the disclosure provides a leather or leather article processed, coated, or repaired with silk fibroin-based proteins or fragments thereof, wherein the leather or leather article is used for upholstery of a product that requires a high degree of resistance to wear as compared to normal upholstery.

In an embodiment, a leather or leather article is treated with a polymer, such as polyglycolide (PGA), polyethylene glycols, copolymers of glycolide, glycolide/L-lactide copolymers (PGA/PLLA), glycolide/trimethylene carbonate copolymers (PGA/TMC), polylactides (PLA), stereocopolymers of PLA, poly-L-lactide (PLLA), poly-DL-lactide (PDLLA), L-lactide/DL-lactide copolymers, co-polymers of PLA, lactide/tetramethylglycolide copolymers, lactide/trimethylene carbonate copolymers, lactide/δ-valerolactone copolymers, lactide/ε-caprolactone copolymers, poly depsipeptides, PLA/polyethylene oxide copolymers, unsymmetrically 3,6-substituted poly-1,4-dioxane-2,5-diones, poly-β-hydroxybutyrate (PHBA), PHBA/β-hydroxyvalerate copolymers (PHBA/HVA), poly-β-hydroxypropionate (PHPA), poly-p-dioxanone (PDS), poly-6-valerolactone, poly-ε-caprolactone, methylmethacrylate-N-vinyl pyrrolidine copolymers, polyesteramides, polyesters of oxalic acid, polydihydropyrans, polyalkyl-2-cyanoacrylates, polyurethanes (PU), polyvinylalcohols (PVA), polypeptides, poly-β-malic acid (PMLA), poly-β-alkanoic acids, polyvinylalcohol (PVA), polyethyleneoxide (PEO), chitine polymers, polyethylene, polypropylene, polyasetal, polyamides, polyesters, polysulphone, polyether ether ketone, polyethylene terephthalate, polycarbonate, polyaryl ether ketone, and polyether ketone ketone.

In an embodiment, an aqueous solution of pure silk fibroin-based protein fragments of the present disclosure is used to process and/or coat a leather or leather article. In an embodiment, the concentration of silk in the solution ranges from about 0.10% to about 20.0%. In an embodiment, the concentration of silk in the solution ranges from about 0.1% to about 15.0%. In an embodiment, the concentration of silk in the solution ranges from about 0.5% to about 10.0%. In an embodiment, the concentration of silk in the solution ranges from about 1.0% to about 5.0%. In an embodiment, an aqueous solution of pure silk fibroin-based protein fragments of the present disclosure is applied directly to a leather or leather article. Alternatively, silk microsphere and any additives may be used for processing and/or coating a leather or leather article. In an embodiment, additives can be added to an aqueous solution of pure silk fibroin-based protein fragments of the present disclosure before coating (e.g., alcohols) to further enhance material properties. In an embodiment, a silk coating of the present disclosure can have

In an embodiment, a composition of pure silk fibroin-based protein fragments of the present disclosure is used to repair a leather or leather article. In some embodiments, the composition is viscous. In some embodiments, the composition is thixotropic. In some embodiments, the composition is a gel, a putty, a wax, a paste, or the like. In some embodiments, the composition is shaped as a repairing bar, for example a repairing crayon. In some embodiments, the composition is delivered from a syringe, a delivery gun, a brush-type applicator, a roller-type applicator, a pen or marker-type applicator, or the like. In some embodiments, the composition is co-delivered from a multiple syringe, for example a double syringe, or a double delivery gun, along a different composition designed to harden, initiate curing of, or otherwise modify the SPF composition. In an embodiment, the concentration of silk in the composition ranges from about 0.1% to about 50.0%. In an embodiment, the concentration of silk in the solution ranges from about 0.1% to about 35.0%. In an embodiment, the concentration of silk in the solution ranges from about 0.5% to about 30.0%. In an embodiment, the concentration of silk in the solution ranges from about 1.0% to about 25.0%. In an embodiment, a composition of pure silk fibroin-based protein fragments of the present disclosure is applied directly to a leather or leather article, for example to a leather defect. Alternatively, silk microsphere and any additives may be used for repairing a leather or leather article. In an embodiment, additives can be added to the composition of pure silk fibroin-based protein fragments of the present disclosure before coating (e.g., alcohols) to further enhance material properties. In an embodiment, a composition is applied to a leather or leather article under tension and/or lax to vary penetration in to the leather, leather article, or leather defect. In an embodiment, the disclosure provides a leather or leather article coated with the coating composition describe elsewhere herein. In an embodiment, the leather or leather article is an aniline leather or leather article. In an embodiment, the leather or leather article is used for human apparel, automobile upholstery, aircraft upholstery, or upholstery in transportation vehicles for public, commercial, military, or other use, including buses and trains. In an embodiment, the disclosure provides a leather or leather article coated with the mattifying coating composition described elsewhere herein, wherein the leather or leather article is used for a product wherein a matte effect is desired. In another embodiment, the disclosure provides an aniline leather or aniline leather article coated with the water soluble dye fixing coating composition described elsewhere herein. In an embodiment, the aniline leather or aniline leather article is coated with a water soluble dye fixing coating composition described herein comprising a water soluble aniline leather dye. In an embodiment, the water soluble dye fixing coating composition described herein comprising a water soluble aniline leather dye fixes the aniline leather dye during aniline leather finishing, providing a dyed leather with a natural look and/or feel. In an embodiment, the concentration of the water soluble dye and/or water soluble aniline leather dye can be tuned to provide a deeper color of the dyed leather or a lighter color of the dyed leather.

Methods of Coating an Article with the Coating Composition

In yet another aspect, the present disclosure provides a method of coating an article with a coating composition, the method comprising applying the coating composition to one or more surfaces of the article.

The coating composition is described elsewhere herein. In an embodiment, the coating composition comprises silk fibroin proteins or fragments thereof and a mattifying silica and/or starch. In another embodiment, the coating composition comprises silk fibroin proteins or fragments thereof and a water soluble dye. In another embodiment, the coating composition is a two part coating composition wherein the first part comprises a water soluble dye and the second part comprises silk fibroin proteins or fragments thereof.

In an embodiment, the coating composition is a liquid, a gel, a paste, a wax, or a cream. In an embodiment, the coating composition is a liquid. In one embodiment, the coating composition comprises an aqueous solvent. In one embodiment wherein the coating composition is a liquid, the method further comprises the step of drying the article.

The coating composition described herein may be applied to the article using any method known to a person of skill in the art. Exemplary application methods include, but are not limited to, hand-spraying, spraying using a mechanical spray setup, applying by brush, rubbing, wet-mixing, washing, drumming, soaking, injecting, plastering, smearing, or the like. In an embodiment wherein the coating composition comprises silk fibroin proteins or fragments thereof and a water soluble dye, the coating composition is sprayed onto the article in one application of about 4 g/sqft. In an embodiment, the coating composition comprising silk fibroin proteins or fragments thereof and a water soluble dye is sprayed onto a leather article in one application of about 4 g/sqft.

In some embodiments, a coating composition described herein may be applied to an article alone, mixed with one or several chemicals (e.g., chemical agents), as one coat, multiple coats, or at multiple times using varied application methods. In an embodiment, the thickness of the coating is described elsewhere herein.

In embodiments wherein the coating composition is a two part coating composition, the step of applying the coating composition to one or more surfaces of the article comprises (a) applying the first part of the coating composition to one or more surfaces of the article. In an embodiment, a first part of the coating composition comprising a water soluble dye is applied to one or more surfaces of the article. In an embodiment, a first part of the coating composition comprising a water soluble dye is applied to one or more surfaces of a leather article. In an embodiment, the first part of the coating composition is applied to the leather article by spraying. In an embodiment, the first part of the coating composition is applied to the leather article by spraying a first layer at about 2 g/sqft onto the article.

In an embodiment, the method further comprises the step (b) of drying the leather article after the first layer of the first part of the coating composition is applied. In an embodiment, the method further comprises (c) applying a second layer of the first part of the coating composition to one or more surfaces of the dried leather article. In an embodiment, the first part of the coating composition is applied to the dried leather article by spraying. In an embodiment, the first part of the coating composition is applied to the dried leather article by spraying a second layer at about 2 g/sqft onto the article.

In some embodiments, the method further comprises (d) drying the leather article after the second layer of the first part of the coating composition is applied to the article.

In an embodiment, the method further comprises (e) applying the second part of the coating composition to one or more surfaces of the article. In an embodiment, a second part of the coating composition comprising silk fibroin proteins or fragments thereof is applied to one or more surfaces of the article. In an embodiment, a second part of the coating composition comprising silk fibroin proteins or fragments thereof is applied to one or more surfaces of a leather article. In an embodiment, the second part of the coating composition is applied to the leather article by spraying. In an embodiment, the second part of the coating composition is applied to the leather article by spraying a layer of the second part of the coating composition at about 4 g/sqft onto the article. In an embodiment, only one layer of the second part of the coating composition is applied to the leather article.

In an embodiment, the method further comprises (f) drying the leather article after the second part of the coating composition is applied to the article.

In an embodiment, the coating composition comprising silk fibroin proteins or fragments thereof and a water soluble dye as a one part coating composition has a comparable performance to the two part coating composition when applied as a coating on an article. In an embodiment, the one part coating composition has a similar ability to maintain colorfastness to rubbing as the two part coating composition.

### Leather Article

In an embodiment, the disclosure provides methods of preparing leather and leather articles coated or repaired with coating compositions described herein. In an embodiment, the coating composition comprises silk fibroin proteins or fragments thereof and a mattifying silica and/or starch.

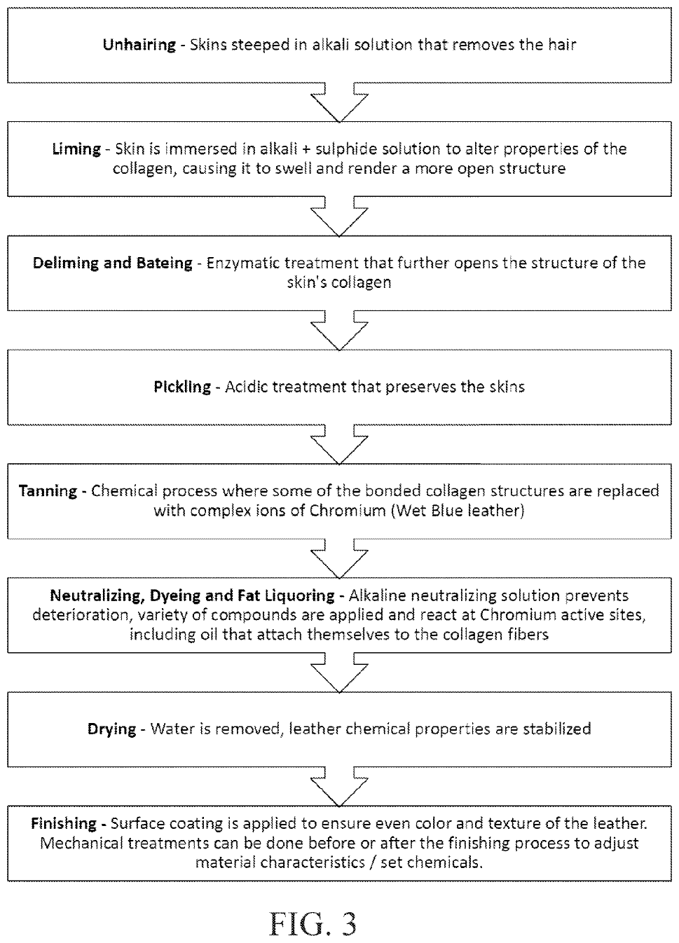

As shown in FIG. 3, the following steps may be used in a leather preparation process:
Unhairing—Skins steeped in alkali solution that removes hair;
Liming—Skin is immersed in alkali/sulphide solution to alter properties of the collagen, causing it to swell and render a more open structure;
Deliming and Bateing—Enzymatic treatment that further opens the structure of the skin's collagen;
Pickling—Acidic treatment that preserves the skins;
Tanning—Chemical process where some of the bonded collagen structures are replaced with complex ions of Chromium (wet blue leather);
Neutralizing, Dyeing and Fat Liquoring—Alkaline neutralizing solution prevents deterioration, variety of compounds are applied and react at Chromium active sites, including oil that attach themselves to the collagen fibers;
Drying—Water is removed, leather chemical properties are stabilized; and
Finishing—Surface coating is applied to ensure even color and texture of the leather. Mechanical treatments can be done before or after the finishing process to adjust material characteristics/set chemicals.

The disclosure provides a method of treating a leather substrate with a silk formulation, the method including applying on a surface of the leather a silk formulation including silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, any other average weight average molecular weights and polydispersities described herein can be used. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, the silk fibroin proteins or fragments thereof have a polydispersity between about 4 and about 4.5. In some embodiments, the silk fibroin proteins or fragments thereof have a polydispersity between about 4.5 and about 5.

The disclosure provides a method of coating a leather substrate with a coating composition, the method comprising applying the coating composition to one or more surfaces of the leather substrate.

In some embodiments the method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further comprises about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.10%, about 0.010%, or about 0.0010%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further includes about 0.001% (w/v) to about 10% (w/v) sericin. In some embodiments, the silk formulation further includes about 0.001% (w/v) sericin to about 0.01% (w/v) sericin, about 0.01% (w/v) sericin to about 0.1% (w/v) sericin, about 0.1% (w/v) sericin to about 1% (w/v) sericin, or about 1% (w/v) sericin to about 10% (w/v) sericin. In some embodiments, the silk formulation further includes about 1% (w/v) sericin, about 2% (w/v) sericin, about 3% (w/v) sericin, about 4% (w/v) sericin, about 5% (w/v) sericin, about 6% (w/v) sericin, about 7% (w/v) sericin, about 8% (w/v) sericin, about 9% (w/v) sericin, about 10% (w/v) sericin, about 11% (w/v) sericin, about 12% (w/v) sericin, about 12% (w/v) sericin, about 13% (w/v) sericin, about 14% (w/v) sericin, or about 15% (w/v) sericin.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in an aqueous solution for at least 10 days prior to being formulated and applied to the leather substrate. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in the formulation for at least 10 days prior to being applied to the leather substrate. In some embodiments, the silk fibroin proteins or fragments thereof do not spontaneously or gradually gelate and do not visibly change in color or turbidity when in the formulation for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments: 1) a portion of the silk formulation is coated on a surface of the leather substrate; or 2) a portion of the silk formulation is infused into a layer of the leather substrate; or 3) a portion of the silk formulation enters a recessed portion of the leather substrate selected from an opening, a crevice, and a defect in the leather substrate; or 4) any combination of the above. The silk formulation can be coated in any desired thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, coating thickness refers to wet coating. In some embodiments, coating thickness refers to after drying coating thickness. The silk formulation can be infused in a layer of the substrate having any thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, infusion layer thickness refers to wet infusion. In some embodiments, infusion layer thickness refers to after drying infusion.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a rheology modifier. In some embodiments, the rheology modifier includes one or more polysaccharides, including one or more of starch, cellulose, gum arabic, guar gum, xanthan gum, alginate, pectin, chitin, chitosan, carrageenan gum, inulin, and/or gellan gum. In some embodiments, the polysaccharides include gellan gum, including, but not limited to, low-acyl content gellan gum. In some embodiments, the w/w ratio between the silk fibroin proteins or fragments thereof and the rheology modifier in the silk formulation is about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the rheology modifier in the silk formulation is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1. about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the rheology modifier in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the rheology modifier in the silk formulation is between about 0.01% and about 5%. In some embodiments, the w/v concentration of the rheology modifier in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the rheology modifier in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a plasticizer. In some embodiments, the plasticizer includes one or more polyols, and/or one or more polyethers. In some embodiments, the polyols are selected from one or more of glycol, glycerol, sorbitol, glucose, sucrose, and dextrose. In some embodiments, the polyethers are one or more polyethyleneglycols (PEGs). In some embodiments, the w/w ratio between the silk fibroin proteins or fragments thereof and the plasticizer in the silk formulation is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1. about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the plasticizer in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the plasticizer in the silk formulation is between about 0.01% and about 10%. In some embodiments, the w/v concentration of the plasticizer in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the plasticizer in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a defoaming agent at a concentration between about 0.0010% and about 1%, between about 0.01% and about 2.5%, between about 0.1% and about 3%, between about 0.5% and about 5%, or between about 0.75% and about 7.5%. In some embodiments, the defoaming agent comprises a silicone. The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a deaeration agent at a concentration between about 0.001% and about 1%, between about 0.01% and about 2.5%, between about 0.1% and about 3%, between about 0.5% and about 5%, or between about 0.75% and about 7.5%. In some embodiments, the deaeration agent comprises a silicone.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation is a liquid, a gel, a paste, a wax, or a cream.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the concentration of silk fibroin proteins or fragments thereof in the silk formulation is between about 0.1% w/v and about 15% w/v. In some embodiments, the concentration of silk fibroin proteins or fragments thereof in the silk formulation is between about 0.5% w/v and about 12% w/v. In some embodiments, the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5%, w/v, about 7% w/v, about 7.5% w/v, about 8% w/v, about 8.5% w/v, about 9% w/v, about 9.5% w/v, or about 10% w/v. In some embodiments, the concentration of silk fibroin proteins or fragments thereof in the silk formulation is about 3% w/v, about 30.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 60.75% w/v, about 7% w/v, about 70.25% w/v, about 7.5% w/v, about 7.75% w/v, about 8% w/v, about 80.25% w/v, about 8.5% w/v, about 80.75% w/v, about 9% w/v, about 90.25% w/v, about 9.5% w/v, about 90.75% w/v, or about 10% w/v. In some embodiments, the concentration of silk fibroin proteins or fragments thereof in the silk formulation is between about 5 mg/mL and about 125 mg/mL. In some embodiments, the concentration of silk fibroin proteins or fragments thereof in the silk formulation is about 10 mg/mL, about 11 mg/mL, about 12 mg/mL, about 13 mg/mL. about 14 mg/mL, about 15 mg/mL, about 16 mg/mL, about 17 mg/mL, about 18 mg/mL, about 19 mg/mL, about 20 mg/mL, about 21 mg/mL, about 22 mg/mL, about 23 mg/mL, about 24 mg/mL, about 25 mg/mL, about 26 mg/mL, about 27 mg/mL, about 28 mg/mL. about 29 mg/mL, about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL. about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, about 90 mg/mL, about 91 mg/mL, about 92 mg/mL, about 93 mg/mL, about 94 mg/mL, about 95 mg/mL, about 96 mg/mL, about 97 mg/mL, about 98 mg/mL, about 99 mg/mL, about 100 mg/mL, about 101 mg/mL, about 102 mg/mL, about 103 mg/mL, about 104 mg/mL, about 105 mg/mL, about 106 mg/mL, about 107 mg/mL, about 108 mg/mL, about 109 mg/mL, or about 110 mg/mL.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further comprises a pH adjusting agent. In some embodiments, the pH adjusting agent includes one more of an acid and/or a base, including but not limited to, a weak acid and/or a weak base. In some embodiments, the pH adjusting agent includes one or more of ammonium hydroxide and citric acid. Any hydroxide, or weak carboxylic acid can be used interchangeably with any of the above. In some embodiments, the silk formulation has a pH of about 2, about 3, about 4, about 5, about 6, about 7, about 8, about 9, about 10, about 11, or about 12.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments treating the leather substrate with the silk formulation improves one or more of gloss, and/or color saturation, and/or smoothness.

In some embodiments the method further comprises one or more additional steps such as dyeing the leather substrate, drying the leather substrate, mechanically stretching the leather substrate, trimming the leather substrate, performing one or more polishing steps of the leather substrate, applying a pigment to the leather substrate, applying a colorant to the leather substrate, applying an acrylic formulation to the leather substrate, chemically fixing the leather substrate, stamping the leather substrate, applying a silicone finish to the leather substrate, providing a Uniflex treatment to the leather substrate, and/or providing a Finiflex treatment to the leather substrate, wherein the step of applying the coating composition to one or more on the leather substrate is performed before, during, or after the one or more additional steps.

As described herein, a silk and/or SPF composition described herein can be used before, during, or after any of these steps. In some embodiments, the leather preparation process may include the treating of the leather with a silk composition described herein. In some embodiments, the leather preparation process may include the repairing of the leather with a silk composition described herein. In some embodiments, the silk composition may include one or more chemical agents as described hereinbelow (e.g., silicone, polyurethane, etc.).

In some embodiments, a silk, but also by hand-spraying, spraying using a mechanical spray setup, applying by brush, rubbing, wet-mixing, washing, drumming, soaking, injecting, plastering, smearing, or the like.

In some embodiments, a silk composition described herein may be applied alone, mixed with one or several chemicals (e.g., chemical agents), as one coat, multiple coats, or defect filling composition, at multiple times using varied application methods, to leathers that have or have not been: dyed, chrome-treated, sprayed with: pigment, acrylic, fixation agents, finishing agents, and/or colorants. In some embodiments, a silk, but also by hand-spraying, spraying using a mechanical spray setup, applying by brush, rubbing, wet-mixing, washing, drumming, soaking, injecting, plastering, smearing, or the like.

In some embodiments, a silk composition described herein may be applied alone, mixed with one or several chemicals (e.g., chemical agents), as one coat, multiple coats, or defect filling composition, at multiple times using varied application methods, to leathers that have or have not been: dyed, chrome-treated, sprayed with: pigment, acrylic, fixation agents, finishing agents, and/or colorants.

The coating composition described herein may be applied to leather or a leather article by any of the methods described herein. In some embodiments, the coating composition described herein may be applied to a finished leather or leather article, a mechanically treated leather or leather article, or a drummed leather or leather article.

In some embodiments, a silk composition described herein (with or without one or more chemical agents) may be used to treat or repair leather before or after the liming step. In some embodiments, a silk composition described herein (with or without one or more chemical agents) may be used to treat or repair leather before or after the deliming and/or bateing steps. In some embodiments, a silk composition described herein (with or without one or more chemical agents) may be used to treat or repair leather before or after the pickling step. In some embodiments, a silk composition described herein (with or without one or more chemical agents) may be used to treat or repair leather before or after the tanning step. In some embodiments, a silk composition described herein (with or without one or more chemical agents) may be used to treat or repair leather before or after the neutralizing, dyeing, and/or fat liquoring steps. In some embodiments, a silk composition described herein (with or without one or more chemical agents) may be used to treat or repair leather before or after the drying step. In some embodiments, a silk composition described herein (with or without one or more chemical agents) may be used to treat or repair leather before or after any finishing step.

In some embodiments, a silk composition described herein (with or without one or more chemical agents) may be used to treat or repair leather during the liming step. In some embodiments, a silk composition described herein (with or without one or more chemical agents) may be used to treat or repair leather during the deliming and/or bateing steps. In some embodiments, a silk composition described herein (with or without one or more chemical agents) may be used to treat or repair leather during the pickling step. In some embodiments, a silk composition described herein (with or without one or more chemical agents) may be used to treat or repair leather during the tanning step. In some embodiments, a silk composition described herein (with or without one or more chemical agents) may be used to treat or repair leather during the neutralizing, dyeing, and/or fat liquoring steps. In some embodiments, a silk composition described herein (with or without one or more chemical agents) may be used to treat or repair leather during the drying step. In some embodiments, a silk composition described herein (with or without one or more chemical agents) may be used to treat or repair leather during the finishing step. In some embodiments, a silk composition described herein (with or without one or more chemical agents) may be used during the finishing step or as part of the finishing step.

In an embodiment, the coating composition described herein (with or without one or more chemical agents) may be used during the finishing step or as part of the finishing step. In another embodiment, the coating composition described herein (with or without one or more chemical agents) may be used as a stand-alone step, for example a stand-alone coating and/or repairing step.

In some embodiments, the leather preparation process may include treating or repairing the leather with a chemical agent described herein below. In some embodiments, a chemical agent described herein below may be used to treat or repair leather before or after the drying step. In some embodiments, a chemical agent described herein below may be used to treat or repair leather before or after the finishing step. In some embodiments, a chemical agent described herein below may be used during the finishing step or as part of the finishing step.

In some embodiments, specific leather types may include a variety of other steps. In some embodiments, the disclosure provides methods of making high-quality finished leather, for example high quality black leather, and plongé leather. With regard to the manufacturing of high-quality finished leather, for example high quality black leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process. In some embodiments, a silk composition described herein (with or without one or more chemical agents) may be used to treat or repair leather before or after the polishing process, or as part of the polishing process. In some embodiments, a silk composition described herein (with or without one or more chemical agents) may be used to treat or repair leather before or after the pigment spray process, or as part of the pigment spray process. In some embodiments, a silk composition described herein (with or without one or more chemical agents) may be used to treat or repair leather before or after the chemical fixation process, or as part of the chemical fixation process. In some embodiments, a silk composition described herein (with or without one or more chemical agents) may be used to treat or repair leather before or after the stamping process, or as part of the stamping process. In some embodiments, a silk composition described herein (with or without one or more chemical agents) may be used to treat or repair leather before or after the silicone-coating step of the finishing process, or as part of the silicone finishing process. In some embodiments, a silk composition described herein (with or without one or more chemical agents) may be used to treat or repair leather before or after the Uniflex process, or as part of the Uniflex process.

With regard to the manufacturing of plongé leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process.

In some embodiments, a silk composition described herein (with or without one or more chemical agents) may be used to treat or repair leather before or after the first polishing process, or as part of the first polishing process. In some embodiments, a silk composition described herein (with or without one or more chemical agents) may be used to treat or repair leather before or after the color spray process, or as part of the color spray process. In some embodiments, a silk composition described herein (with or without one or more chemical agents) may be used to treat or repair leather before or after the second polish process, or as part of the second polish process. In some embodiments, a silk composition described herein (with or without one or more chemical agents) may be used to treat or repair leather before or after the Finiflex process, or as part of the Finiflex process.

In some embodiments, the silk compositions that may be used for coating or repairing leather and/or leather articles according to the processes described herein may include one or more silk compositions recited in Table 1.

In an embodiment, the disclosure provides a method of treating or repairing leather with a silk composition described herein, wherein the method may include the steps of: dyeing the leather; mechanically stretching the leather; trimming the leather; polishing the leather; applying (optionally by spray application) a pigment, and/or an acrylic; chemically fixing the leather, stamping the leather, applying a silicone finish to the leather; and/or providing a Uniflex treatment to the leather; wherein one or more of the foregoing steps includes applying the silk composition to the leather before, during, or after the recited steps.

In an embodiment, the disclosure provides a method of treating or repairing leather with a silk composition described herein, wherein the method may include the steps of: dyeing the leather, drying the leather; mechanically stretching the leather; trimming the leather; performing a first polish of the leather; applying (optionally by spray application) a colorant, and/or an acrylic; performing a second polish of the leather, and/or providing a Finiflex treatment to the leather; wherein one or more of the foregoing steps includes applying the silk composition to the leather before, during, or after the recited steps. In some embodiments of the methods described herein, silk compositions described herein may be integrated into the leather treatment processes (e.g. during, before or after: pigment+acrylic, pigment+acrylic spray, colorant spray, dyeing, fixation spray, finishing spray). In some embodiments, silk compositions described herein may be applied at any part of the larger leathering process described in FIG. 3. In some embodiments of the foregoing methods, drying may be of hand or autosprayed leather materials. In some embodiments, a drying step may be provided after each and/or before each spraying of the leather material. In some embodiments, the leather materials may be dried in an oven. In some embodiments, the drying processes may be at a temperature of less than about 70, 71, 72, 73, 74, or 75° C.; or greater than about 70, 71, 72, 73, 74, or 75° C.; or about 70, 71, 72, 73, 74, or 75° C. In some embodiments, each drying step of the leather materials may be for a period of less than about 1, 2, 3, 4, 5, 6, 7, 8, 9, 10, 11, 12, 13, 14, 15, 16, 17, 18, 19, 20,21, 22, 23, 24, 25, 26, 27, 28, 29, or 30 seconds; or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds; or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds.

In some embodiments of the foregoing methods, stamping may be used during a native production process by pressing the leather material between a top plate and a bottom plate. In some embodiments, the top plate may be at an operating temperature of less than about 50, 51, 52, 53, 54, 55, 56, 57, 58, 59, 60, 61, 62, 63, 64, or 65° C.; or greater than about 50, 51, 52, 53, 54, 55, 56, 57, 58, 59, 60, 61, 62, 63, 64, or 65° C.; or about 50, 51, 52, 53, 54, 55, 56, 57, 58, 59, 60, 61, 62, 63, 64, or 65° C. In some embodiments, the stamping step may include pressing the leather material between the first and the second plates at the top plate temperature for a period of less than about 1, 2, 3, 4, or 5 seconds; or greater than about 1, 2, 3, 4, or 5 seconds; or about 1, 2, 3, 4, or 5 seconds. In some embodiments, the stamping step may include pressing the leather material between the first and the second plates at the top plate temperature at a pressure of about 75 to about 125 kg/cm², or about 90 to about 110 kg/cm², or about 100 kg/cm².

In some embodiments of the foregoing methods, the Finiflex treatment may include compressing the leather material between two heated rotating metallic wheels at a temperature of about 75 to about 125° C., or about 93° C., at a pressure of about 5 to about 30 kg/m², or about 20 kg/m², and for a period of about 1 to about 10 seconds, or about 4 seconds.

In some embodiments of the foregoing methods, the Uniflex treatment includes pressing the leather material through two pressing cylinders, where the top cylinder is heated to a temperature of about 50 to about 100° C., or about 60° C., while the bottom cylinder may be unheated, and the two cylinders compress the leather material at about 10 to about 50 bar, or about 30 bar, for a period of about 1 to about 10 seconds, or about 3 to about 5 seconds.

In some embodiments, coated leather materials prepared by the foregoing methods may undergo mechanical quality testing according to one or more of a Veslic Process, a Martindale Process, a Water Drop Process, a Hydration Test, and a UV Test.

Veslic Process—Dry (n=50) and wet (n=10) cycles performed at f=1.0 Hz, 1 cm² abrasion cube applied at 1 kg/cm². Visually scored 0-5 (leather and abrasion cube) based on how much color rubs off the leather and onto cube. In some embodiments, dry cycles may from 0-100; wet cycles may be from 0-30; frequency may be from 0.1-2 Hz; and pressure may be from 0-5 kg/cm².

Martindale Process—11 cm² circular cuts of leather samples are rubbed against an abrasive in a lissajous figure pattern (Bowditch curve shape) for n=1500 cycles at a frequency of 0.66-1.0 Hz at 9 kPa. Visually scored 0-5 based on how much color rubs off the leather and onto cube. In some embodiments, the cycles may be from 0-5000; frequency may be from 0.1-2 Hz; and pressure may be from 0-50 kPa.

Water Drop Process—2-4 droplets are allowed to run the length of a vertically-oriented leather sample; after 1 minute the sample is judged negatively if water streaks remain on the surface. Visually scored 0-5 based on appearance of water streaks on the leather.

Hydration Test—Two circular replicants of the same leather sample are pressed surface-to-surface by a 300 g weight in a humidity chamber (90% Residual Humidity; 50° C.) for 72 hr. Scored based on how easily samples separate from one another after testing and if any color rubs off. In some embodiments, the weight may be from 0-1 kg; the residual humidity may be from 70-95%; the temperature may be from 40-80° C.; and time may be from 24-100 hr.

UV Test—Samples are placed under UV light for 25 hr and observed for color loss. Xe lamp: 42 W/m², 50° C., λ_{incident}=300-400 nm. Visually scored 0-5 based on how much color fades out of the leather over the testing period. In some embodiments, the time may be from 20-40 hr; lamp intensity may be from 20-60 W/m²; temperature may be from 40-80° C.; and the λ_{incident} may be about 250-450 nm.

In one embodiment, applying the mattifying coating composition described herein at the finishing stage (high-quality finished process) provides a leather article with a matte look. In another embodiment, applying the water soluble dye fixing coating composition described herein at the finishing stage (high-quality finished process) provides a leather article dyed with the water soluble dye. In one embodiment, the leather article is an aniline leather article dyed with a water soluble aniline leather dye.

### Polyamidamine Dendrimer for Adhering Silk Fibroin Fragments Compositions to a Cellulose Derivative

In some embodiments, a polyamidamine compound, e.g., a dendrimer, could be used to adhere silk fibroin fragments compositions or any other coating composition to a cellulose derivative composition and/or coating. In some embodiments, the polyamidamine compound is Cartaretin F liquid, an aqueous solution of a polyamidamine. In some embodiments, the polyamidamine compound is cationic. In some embodiments, the cellulose derivative is methyl cellulose, ethyl cellulose, carboxymethyl cellulose, hydroxyethyl cellulose, hydroxypropyl cellulose, cellulose acetate, cellulose acetate propionate, cellulose acetate butyrate, or microcrystalline cellulose. In some embodiments, the polyamidamine dendrimer is diluted to a concentration of 0% to 0.1%, 0.1% to 0.2%, 0.2% to 0.3%, 0.3% to 0.4%, 0.4% to 0.5%, 0.5% to 0.6%, 0.6% to 0.7%, 0.7% to 0.8%, 0.8% to 0.9%, 0.9% to 1.0%, 1.0% to 1.1%, 1.1% to 1.2%, 1.2% to 1.3%, 1.3% to 1.4%, or 1.4% to 1.5%. In some embodiments, the dosage of the polyamidamine dendrimer is 0.05% to 0.10%, 0.10% to 0.15%, 0.15% to 0.20%, 0.20% to 0.25%, 0.25% to 0.30%, 0.30% to 0.35%, 0.35% to 0.40%, 0.40% to 0.45%, or 0.45% to 0.50%.

In some embodiments, silk may be used to finish or repair a leather variant requiring lighter coloring treatment. The lighter volumes of colorant and pigment used may render silk more effective at locking in color.

In some embodiments, silk may be used at the wet stages of high-quality finished leather processing (e.g., in the small volume mixing drum) to replace another chemical during the colorant mixing stage.

In some embodiments, a silk wax may be used (or other silk composition described herein) to remove defects/holes in the raw leather (stemming from a follicle or a feed-stock related defect) through application of the silk material onto the skin along any point in the treatment process. If done early in the process, it may be used to change the quality classification of the pre-treated leather to be selected to make a high-quality end product. This effectively provides increased yield (amount of usable leather for a given quality of end product).

### Dye Assistant

In some embodiments, a dye assistant (e.g., Optifix E50 liq.) is used to improve the wet-fastness properties of dyed leather. In some embodiments the dyeing assistant is an aliphatic polyamine. In some embodiments the aliphatic polyamine is cationic. The dye assistant can either be applied after the treatment of the dyed leather or intermediately (top dyeing). In some embodiments, the dye assistant is applied in the wet-end stage.

In some embodiments the dye assistant is applied at 30° C., 35° C., 40° C., 45° C., or 50° C. In some embodiments the dye assistant is applied with an acid (eg., formic acid) and water.

### Mushroom-Based Material

In some embodiments, the substrate comprises, without limitation, a mycological material, a mushroom-based material, a mycelium-based material, or a fungal-based material, and/or a like material. All terms, including without limitations, a mycological material, a mushroom-based material, a mycelium-based material, a fungal-based material, are used herein interchangeably

As used herein, unless otherwise specified, the term “mycological material,” “mushroom-based material,” “mycelium-based material,” “fungal-based material,” and “fungal biomass” refers in certain embodiments to a mass of a fungus that has been cultured, fermented, or grown by any suitable process. In some embodiments, it is to be expressly understood that a fungal biomass may be produced by any of a number of methods known in the art, including but not limited to surface fermentation methods, submerged fermentation methods, solid-substrate submerged fermentation (SSSF) methods.

In some embodiments, fungal leather analog materials made from inactivated fungal biomass. Additionally, leather analog materials according to the present disclosure may be biodegradable, i.e. biodegrade more quickly under a given set of conditions than true leather.

### Plant-Based Material

In some embodiments, the substrate comprises, without limitation, a plant-based material. Some non-limiting examples of sources for a plant-based leather include, pineapples, corn, bananas, apples, cacti, green tea, coffee grounds, coconut water, flowers, palm leaves, cork, grapes, kombucha, leaves, paper, cotton, cool stone, tree bark, washi, agave, nettles, and hemp plant.

Additionally, plant-based leather materials according to the present disclosure may be biodegradable, i.e. biodegrade more quickly under a given set of conditions than true leather.

### Edible Materials

In some embodiments, the substrate comprises, without limitation, edible materials, or foodstuff. In some embodiments, the foodstuff is selected from the group consisting of powdery food, dry solid food, oily food, perishable good, vegetable, fruit, meat, egg, and seafood. In some embodiments, the perishable good is selected from vegetable, fruit, meat, egg, and seafood. In some embodiments, the perishable good is selected from the group consisting of vegetable and fruit. In some embodiments, the perishable good is vegetable. In some embodiments, the vegetable is carrot. In some embodiments, the perishable good is fruit. In some embodiments, the fruit is selected from the group consisting of strawberry, orange, apple, pear, plum, banana, grape, and grapefruit. In some embodiments, the fruit is any berry known in the art. In some embodiments, the fruit is any drupe known in the art. In some embodiments, the fruit is any pome known in the art. In some embodiments, the fruit is any citrus known in the art. In some embodiments, the fruit is any melon known in the art. In some embodiments, the fruit is any dried fruit known in the art, such as raisins, prunes, dates, apricots, etc. In some embodiments, the fruit is any stone fruit known in the art. In some embodiments, the perishable good is any vegetable known in the art. In some embodiments, the perishable good is any seed known in the art.

In some embodiments, the perishable good is meat. In some embodiments, the meat is poultry, pork, beef, veal, lamb, bison, ostrich, rabbit, game, fish, eel, shellfish, or seafood. In some embodiments, the poultry is selected from the group consisting of poultry chicken, turkey, duck, goose, and pigeon.

### Textiles

In some embodiments, the substrate comprises, without limitation, textiles. In an embodiment, a textile comprises a synthetic textile, including polyester, Mylar, cotton, nylon, polyester-polyurethane copolymer, rayon, acetate, aramid (aromatic polyamide), acrylic, ingeo (polylactide), lurex (polyamide-polyester), olefin (polyethylene-polypropylene), and combinations thereof.

In an embodiment, a textile comprises a natural textile, including alpaca fiber, alpaca fleece, alpaca wool, lama fiber, lama fleece, lama wool, cotton, cashmere and sheep fiber, sheep fleece, sheep wool.

### Fillers and Particles

In some embodiments, the coating system comprises, without limitation, fillers. In some embodiments, the filler is selected from the group consisting of starch-derived filler, calcium carbonate, calcite, aragonite, vaterite, amorphous alumina, alumino-silicate, talc, clay, kaolin, sepiolite, palygorskite, and combinations thereof.

In some embodiments, the coating system comprises, without limitation, particles. The particle may include polymeric particle, mica, silica, mud, and clay. In some embodiments, the substrate comprises clay particles. Throughout this specification, the term “clay” is intended to mean fine-grained earthy materials that become plastic when mixed with water. The clay may be a natural, synthetic or chemically modified clay. Clays include hydrous aluminum silicates that contain impurities, e.g. potassium, sodium, magnesium, or iron in small amounts.

In one embodiment, the clay is a material containing from 38.8% to 98.2% of SiO2 and from 0.3% to 38.0% of Al2O3, and further contains one or more of metal oxides selected from Fe2O3, CaO, MgO, TiO2, ZrO2, Na2O and K2O. In some embodiments, the clay has a layered structure comprising hydrous sheets of octahedrally coordinated aluminium, magnesium or iron, or of tetrahedrally coordinated silicon.

In one embodiment, the clay is selected from the group consisting of kaolin, talc, 2:1 phyllosilicates, 1:1 phyllosilicates, smectite, bentonite, montmorillonites (also known as bentonites), hectorites, volchonskoites, nontronites, saponites, beidelites, sauconites, and mixtures thereof. In one embodiment, the clay is kaolin or bentonite. In some embodiments, the clay is a synthetic hectorite. In another embodiment, the clay is a bentonite.

In some embodiments, the clays have a cation exchange capacity of from about 0.7 meq/100 g to about 150 meq/100 g. In some embodiments, the clays have a cation exchange capacity of from about 30 meq/100 g to about 100 meq/100 g.

In some embodiments, the coating system optionally comprise a composite particle having an anionically charged clay electrostatically complexed with the cationically charged skin conditioning agents as disclosed herein.

Commercially available synthetic hectorites include those products sold under the trade names Laponite® RD, Laponite® RDS, Laponite® XLG, Laponite®. XLS, Laponite® D, Laponite® DF, Laponite® DS, Laponite® S, and Laponite® JS (Southern Clay products, Texas, USA). Commercially available bentonites include those products sold under the trade names Gelwhite® GP, Gelwhite®) H, Gelwhite® L, Mineral Colloid® BP, Mineral Colloid® MO, Gelwhite® MAS 100 (sc), Gelwhite® MAS 101, Gelwhite® MAS 102, Gelwhite® MAS 103, Bentolite® WH, Bentolite® L10, Bentolite® H, Bentolite® L, Permont® SX10A, Permont® SC20, and Permont® HN24 (Southern Clay Products, Texas, USA); Bentone® EW and Bentone® MA (Dow Corning); and Bentonite® USP BL 670 and Bentolite® H4430 (Whitaker, Clarke & Daniels).

In some embodiments, the coating system further comprises a powder component selected from the group consisting of clay mineral powders such as talc, mica, sericite, silica, magnesium silicate, synthetic fluorophlogopite, calcium silicate, aluminum silicate, bentonite, montmorillonite; pearl powders such as alumina, barium sulfate, calcium secondary phosphate, calcium carbonate, titanium oxide, zirconium oxide, zinc oxide, hydroxy apatite, iron oxide, iron titanate, ultramarine blue, Prussian blue, chromium oxide, chromium hydroxide, cobalt oxide, cobalt titanate, titanium oxide coated mica; organic powders such as polyester, polyethylene, polystyrene, methyl methacrylate resin, cellulose, 12-nylon, 6-nylon, styrene-acrylic acid copolymers, polypropylene, vinyl chloride polymer, tetrafluoroethylene polymer, boron nitride, fish scale guanine, laked tar color dyes, laked natural color dyes, spherical alumina, polyacrylates, silicates, sulfates, metal dioxides, carbonates, celluloses, polyalkylenes, vinyl acetates, polystyrenes, polyamides, acrylic acid ethers, silicones, and combinations thereof.

### Coating System Additives

In some embodiments, the coating system further comprises an additive selected from the group consisting of an antioxidant, a synthetic emulsifier, a solvent, a colorant, a surfactant (e.g., sophorolipid), an astringent, a plant extract, an essential oil, a coolant, a humectant, a moisturizer, a structurant, a gelling agent, a sequestering agent, a preserving agent, a filler, a fragrance, a thickener, a wetting agent, a dye, a pigment, a glitter, and combinations thereof.

Chemical Agents for Use with Leather and Leather Articles Coated with Silk Fibroin-Based Protein Fragments

In certain embodiments, chemical agents may be used to pretreat, treat, and/or post-treat a leather or leather article described herein. In some embodiments, the silk and/or SPF solutions (e.g., SFS), or compositions, described herein, may include one or more of the chemical agents described herein. In some embodiments, the silk and/or SPF solutions or compositions described herein, may replace one or more of the chemical agents described herein. In some embodiments, the chemical agents may be selected from the group consisting of silicone, casein, an acidic agent, a dyeing agent, a pigment dye, a traditional finishing agent, and a technical finishing agent. In some embodiments, chemical agents may include one or more agents recited in Table 2. In some embodiments, the chemical agent may be selected from the group consisting of aqueous lacquers, waxes, oils, binders (protein or other), fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, acidic dyes, basic dyes, dyes (chromium-based or other), colorants, and combinations thereof.

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a wetting agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a wetting agent.

In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a wetting agent. In an embodiment, the wetting agent improves one or more coating properties. Suitable wetting agents are known to those of skill in the art. Exemplary, non-limiting examples of wetting agents from a representative supplier, Lamberti SPA, are given in the following table.

| | |
|---|---|
| Imbitex NDT | Non silicone low foaming with high wetting in both hot |
| | or cold conditions, with good detergency and good |
| | stability to alkalis. |
| Imbitex TBL | Wetting and de-aerating agent. |
| Imbitex MRC | Wetting and penetrating agent for mercerizing of cotton. |
| Tensolam Na | Low foam, special wetting and dispersing agent for non- |
| liq. | woven wet treatments. |
| Imbitex NRW3 | Wetting agent for water-and oil repellent finishing. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a detergent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a detergent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a detergent. In an embodiment, the detergent improves one or more coating properties. Suitable detergents are known to those of skill in the art. Exemplary, non-limiting examples of detergents from a representative supplier, Lamberti SPA, are given in the following table.

| | |
|---|---|
| Biorol | Wetting and detergent agent with alkaline stability in NaOH |
| CPNN | up to 10° C. Recommended for continuous scouring, |
| | bleaching, and Jigger applications. |
| Biorol | Wetting and detergent agent with extremely low foam |
| JK new | properties, recommended for high bath turbulence machine |
| | (e.g., jet, overflow, etc.). |
| Biorol | General-purpose wetting and detergent agent suitable for |
| OW 60 | desizing, scouring, and bleaching processes. |
| Biorol | Detergent/wetting agent, low foaming, high concentration, |
| OWK | recommended for over-flow. Useful for removal of silicone |
| | oil on Lycra blends. |
| Cesapon | Specific scouring, de-gumming agent for silk. |
| Silk liq. | |
| Cesapon | High detergent power product containing solvent. |
| Extra | |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a sequestering or dispersing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a sequestering or dispersing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a sequestering or dispersing agent. Suitable sequestering or dispersing agents are known to those of skill in the art. Exemplary, non-limiting examples of sequestering or dispersing agents from a representative supplier, Lamberti SPA, are given in the following table.

| | |
|---|---|
| Lamegal | Dispersing and anti-redepositing agent useful for preparation |
| DSP | dyeing and after soaping of dyed and printed materials with |
| | reactive and vat dyes. This product is also useful as an anti- |
| | oligomer agent in reduction clearing of polyester, dyed or |
| | printed with disperse dyes. |
| Chelam | Multi-purpose sequestering and dispersing agent for a wide |
| TLW/T | variety of textile processes. No shade variation on dyestuff |
| | containing metals. |
| Lamegal | Multi-purpose sequestring and dispersing agent for a wide |
| TL5 | variety of textile processes. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an enzyme. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an enzyme. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an enzyme. Suitable enzymes are known to those of skill in the art. Exemplary, non-limiting examples of enzymes from a representative supplier, Lamberti SPA, are given in the following table.

| | |
|---|---|
| Lazim HT | Thermo-stable amylase for rapid high temperature desizing. |
| Lazim PE | Specific enzyme for bioscouring; provides optimal |
| | wettability, it improves dyeing and color fastness without |
| | causing depolymerization and fabric strength loss. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with a bleaching agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with a bleaching agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with a bleaching agent. Suitable bleaching agents are known to those of skill in the art. Exemplary, non-limiting examples of bleaching agents from a representative supplier, Lamberti SPA, are given in the following table.

| | |
|---|---|
| Stabilox | Highly concentrated stabilizer for alkaline bleaching with |
| OTN conc. | hydrogen peroxide. Suitable for a wide variety of processes. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an antifoaming agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an antifoaming agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an antifoaming agent. Suitable antifoaming agents are known to those of skill in the art. Exemplary, non-limiting examples of antifoaming agents from a representative supplier, Lamberti SPA, are given in the following table.

| | |
|---|---|
| Antifoam SE 47 | General purpose defoaming agent. |
| Defomex JET | Silicone defoamer effective up to 130° C. |
| | Recommended for HT and JET dyeing systems. |
| Defomex 2033 | Non-silicone defoamer. |

In an embodiment, the disclosure provides a leather or leather article processed with a composition comprising silk based proteins or fragments thereof having an average weight average molecular weight range of about 5 kDa to about 144 kDa, wherein the leather or leather article is pretreated with an anti-creasing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is pretreated with an anti-creasing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is pretreated with an anti-creasing agent. Suitable anti-creasing agents are known to those of skill in the art. Exemplary, non-limiting examples of anti-creasing agents from a representative supplier, Lamberti SPA, are given in the following table.

| | |
|---|---|
| Lubisol AM | Lubricating and anti-creasing agent for rope wet operation |
| | on all kind of fibers and machines. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye dispersing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye dispersing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye dispersing agent. Suitable dye dispersing agents are known to those of skill in the art. Exemplary, non-limiting examples of dye dispersing agents from a representative supplier, Lamberti SPA, are given in the following table.

| | |
|---|---|
| Lamegal BO | Liquid dispersing agent (non-ionic), suitable for |
| | direct, reactive, disperse dyeing and PES |
| | stripping. |
| Lamegal DSP | Dispersing and anti back-staining agent in |
| | preparation, dyeing and soaping of dyed and |
| | printed materials. Antioligomer agent. |
| Lamegal 619 | Effective low foam dispersing leveling agent for |
| | dyeing of PES. |
| Lamegal TL5 | Multi-purpose sequestering and dispersing agent |
| | for a variety of textile processes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye leveling agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye leveling agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye leveling agent. Suitable dye leveling agents are known to those of skill in the art. Exemplary, non-limiting examples of dye leveling agents from a representative supplier, Lamberti SPA, are given in the following table.

| | |
|---|---|
| Lamegal A 12 | Leveling agent for dyeing on wool, polyamide |
| | and its blends with acid or metal complex dyes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye fixing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye fixing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye fixing agent. Suitable dye fixing agents are known to those of skill in the art. Exemplary, non-limiting examples of dye fixing agents from a representative supplier, Lamberti SPA, are given in the following table.

| | |
|---|---|
| Lamfix L | Fixing agent for direct and reactive dyestuffs, |
| | containing formaldehyde. |
| Lamfix LU conc. | Formaldehyde free cationic fixing agent for |
| | direct and reactive dyes. It does not affect the |
| | shade and light fastness. |
| Lamfix PA/TR | Fixing agent to improve the wet fastness of acid |
| | dyes on polyamide fabrics, dyed or printed and |
| | polyamide yarns. Retarding agent in dyeing of |
| | Polyamide/cellulosic blends with direct dyes. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye special resin agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye special resin agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye special resin agent. Suitable dye special resin agents are known to those of skill in the art. Exemplary, non-limiting examples of dye special resin agents from a representative supplier, Lamberti SPA, are given in the following table.

| | |
|---|---|
| Denifast TC | Special resin for cationization of cellulose fibers |
| | to obtain special effects (“DENIFAST system” |
| | and “DENISOL system”). |
| Cobral DD/50 | Special resin for cationization of cellulose fibers |
| | to obtain special effect (“DENIFAST system” |
| | and “DENISOL system”). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a dye anti-reducing agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a dye anti-reducing agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a dye anti-reducing agent. Suitable dye anti-reducing agents are known to those of skill in the art. Exemplary, non-limiting examples of dye anti-reducing agents from a representative supplier, Lamberti SPA, are given in the following table.

| | |
|---|---|
| Lamberti Redox | Anti-reducing agent in grain form. 100% active |
| L2S gra | content. |
| Lamberti Redox | Anti-reducing agent in liquid form for automatic |
| L2S liq. | dosage. |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system anti-migrating agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system anti-migrating agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system anti-migrating agent. Suitable pigment dye system anti-migrating agents are known to those of skill in the art. Exemplary, non-limiting examples of pigment dye system anti-migrating agents from a representative supplier, Lamberti SPA, are given in the following table.

| | |
|---|---|
| Neopat Compound | Compound, developed as migration inhibitor for |
| 96/m conc. | continuous dyeing process with pigments (pad- |
| | dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system binder. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system binder. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system binder. Suitable pigment dye system binders are known to those of skill in the art. Exemplary, non-limiting examples of pigment dye system binders from a representative supplier, Lamberti SPA, are given in the following table.

| | |
|---|---|
| Neopat Binder PM/S | Concentrated version of a specific binder used to |
| conc. | prepare pad-liquor for dyeing with pigments |
| | (pad-dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a pigment dye system binder and anti-migrating agent combination. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a pigment dye system binder and anti-migrating agent combination. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with pigment dye system binder and anti-migrating agent combination. Suitable pigment dye system binder and anti-migrating agent combinations are known to those of skill in the art. Exemplary, non-limiting examples of pigment dye system binder and anti-migrating agent combinations from a representative supplier, Lamberti SPA, are given in the following table.

| | |
|---|---|
| Neopat Compound | Highly concentrated all-in-one product |
| PK1 | specifically developed as migration inhibitor |
| | with specific binder for continuous dyeing |
| | process with pigments (pad-dry process). |

In an embodiment, the disclosure provides a leather or leather article processed with a composition comprising silk based proteins or fragments thereof having an average weight average molecular weight range of about 5 kDa to about 144 kDa, wherein the leather or leather article is treated with a delave agent. In an embodiment, the disclosure provides a leather or leather article having a coating, wherein the coating comprises silk based proteins or fragments thereof having an average weight average molecular weight range of about 5 kDa to about 144 kDa, wherein the leather or leather article is treated with a delave agent. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is treated with a delave agent. Suitable delave agents are known to those of skill in the art. Exemplary, non-limiting examples of delave agents from a representative supplier, Lamberti SPA, are given in the following table.

| | |
|---|---|
| Neopat compound | Highly concentrated compound of surfactants |
| FTN | and polymers specifically developed for pigment |
| | dyeing and pigment-reactive dyeing process; |
| | especially for medium/dark shades for wash off |
| | effect. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a wrinkle free treatment. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a wrinkle free treatment. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a wrinkle free treatment. Suitable wrinkle free treatments are known to those of skill in the art. Exemplary, non-limiting examples of wrinkle free treatments from a representative supplier, Lamberti SPA, are given in the following table.

| | |
|---|---|
| Cellofix ULF | Anti-crease modified glyoxalic resin for finishing of |
| conc. | cottons, cellulosics and blends with synthetics fibers. |
| Poliflex PO | Polyethilenic resin for waxy, full and slippy handle |
| 40 | by foulard applications. |
| Rolflex WF | Aliphatic waterborne Nano-PU dispersion used as |
| | extender for wrinkle free treatments. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a softener. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a softener. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a softener. Suitable softeners are known to those of skill in the art. Exemplary, non-limiting examples of softeners from a representative supplier, Lamberti SPA, are given in the following table.

| | |
|---|---|
| Texamina | Cationic softening agent with a very soft handle particularly |
| C/FPN | recommended for application by exhaustion for all kind of |
| | fabrics. Suitable also for cone application. |
| Texamina C | 100% cationic softening agent in flakes form for all type of |
| SAL flakes | fabrics. Dispersible at room temperature. |
| Texamina | Anphoteric softening agent for all types of fabrics. Not |
| CL LIQ. | yellowing. |
| Texamina | Anphoteric softening agent for woven and knitted fabrics of |
| HVO | cotton, other cellulosics and blends. Provides a soft, smooth |
| | and dry handle. Applied by padding. |
| Texamina | Nonionic silicon dispersion in water. Excellent softening, |
| SIL | lubricating and anti-static properties for all fibre types by |
| | padding. |
| Texamina | Special cationic softener with silk protein inside. Provides a |
| SILK | “swollen touch” particularly suitable for cellulosic, |
| | wool, silk. |
| Lamfinish | All-in compound based on special polymeric hydrophilic |
| LW | softeners; by coating, foulard, and exhaustion. |
| Elastolam | General purpose mono-component silicone elastomeric |
| E50 | softener for textile finishing. |
| Elastolam | Modified polysiloxane micro-emulsion which gives a |
| EC 100 | permanent finishing, with extremely soft and silky handle. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a handle modifier. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a handle modifier. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a handle modifier. Suitable handle modifiers are known to those of skill in the art. Exemplary, non-limiting examples of handle modifiers from a representative supplier, Lamberti SPA, are given in the following table.

| | |
|---|---|
| Poliflex CSW | Cationic anti-slipping agent. |
| Poliflex R 75 | Parafine finishing agent to give waxy handle. |
| Poliflex s | Compound specifically developed for special |
| | writing effects. |
| Poliflex m | Compound for special dry-waxy handle. |
| Lamsoft SW 24 | Compound for special slippy handle specifically |
| | developed for coating application. |
| Lamfinish | All-in-one compound to get a slippy touch; by |
| SLIPPY | coating. |
| Lamfinish | All-in-one compound to get a gummy touch; by coating. |
| GUMMY | |
| Lamfinish | All-in-one compound to get dry-sandy touch especially |
| OLDRY | suitable for vintage effects; by coating. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a waterborne polyurethane (PU) dispersion. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a waterborne polyurethane (PU) dispersion. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a waterborne polyurethane (PU) dispersion. Suitable waterborne polyurethane dispersions for traditional finishing are known to those of skill in the art. Exemplary, non-limiting examples of waterborne polyurethane dispersions for traditional finishing from a representative supplier, Lamberti SPA, are given in the following table.

| | |
|---|---|
| Rolflex | Aliphatic waterborne PU dispersion particularly suggested for |
| LB 2 | the formulation of textile coatings where bright and rigid top |
| | finish is required. It is particularly suitable as a finishing |
| | agent for organza touch on silk fabrics. Transparent and |
| | shiny. |
| Rolflex | Aliphatic waterborne PU dispersion particularly suggested for |
| HP 51 | the formulation of textile coatings for outwear, luggage, |
| | technical articles especially where hard and flexible touch is |
| | required. Transparent and shiny. |
| Rolflex | Aliphatic waterborne PU dispersion particularly suggested for |
| PU 879 | the formulation of textile coatings for outwear, luggage, |
| | technical articles where a medium-hard and flexible touch is |
| | required. |
| Rolflex | Aliphatic waterborne PU dispersion particularly suggested for |
| ALM | the formulation of textile coatings for outwear, luggage, |
| | technical articles where a soft and flexible touch is required. |
| | Can be also suitable for printing application. |
| Rolflex | Aliphatic waterborne PU dispersion particularly suggested for |
| AP | the formulation of textile coatings for outwear, fashion where |
| | a soft and gummy touch is required. |
| Rolflex | Aliphatic waterborne PU dispersion particularly suggested for |
| W4 | the formulation of textile coatings for clothing, outwear where |
| | a full, soft and non sticky touch is required. |
| Rolflex | Aliphatic waterborne PU dispersion particularly suggested for |
| ZB7 | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex | Aliphatic waterborne PU dispersion particularly suggested for |
| BZ 78 | the formulation of textile coatings for clothing, outwear, |
| | sportswear, fashion and technical articles for industrial |
| | applications. The product has an excellent hydrolysis |
| | resistance, a very high charge digestion and electrolytes |
| | stability and an excellent mechanical and tear resistance. Can |
| | be also suitable for foam coating and printing application. |
| Rolflex | Gives to the coated fabric a full, soft, and slightly sticky |
| K 110 | handle with excellent fastness on all types of fabrics. |
| Rolflex | Aliphatic waterborne PU dispersion particularly suggested for |
| OP 80 | the formulation of textile coatings for outwear, luggage and |
| | fashion finishes where an opaque non writing effect is |
| | desired. |
| Rolflex | Aliphatic waterborne PU dispersion generally used by |
| NBC | padding application as a filling and zero formaldehyde sizing |
| | agent. Can be used for outwear and fashion finishing where a |
| | full, elastic and non-sticky touch is required. |
| Rolflex | Aliphatic waterborne PU dispersion specifically designed for |
| PAD | padding application for outwear, sportswear and fashion |
| | applications where a full, elastic and non sticky touch is |
| | required. Excellent washing and dry cleaning fastness as well |
| | as good bath stability. |
| Rolflex | Aliphatic waterborne PU dispersion generally applied by |
| PN | padding application for outerwear and fashion high quality |
| | applications where strong, elastic non sticky finishes are |
| | required. |
| Elafix | Aliphatic blocked isocyanate nano-dispersion used in order to |
| PV 4 | give anti-felting and anti-pilling properties to pure wool |
| | fabrics and his blend. |
| Rolflex | Aliphatic waterborne PU dispersion particularly suggested to |
| SW3 | be used by padding application for the finishing of outwear, |
| | sportswear and fashion where a slippery and elastic touch is |
| | required. It is also a good anti-pilling agent. Excellent in wool |
| | application. |
| Rolflex | Aliphatic cationic waterborne PU dispersion particularly |
| C 86 | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex | Aliphatic cationic waterborne PU dispersion particularly |
| CN 29 | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the disclosure provides a leather or leather article processed with a composition comprising silk based proteins or fragments thereof having an average weight average molecular weight range of about 5 kDa to about 144 kDa, wherein the leather or leather article is traditionally finished with a finishing resin. In an embodiment, the disclosure provides a leather or leather article having a coating, wherein the coating comprises silk based proteins or fragments thereof having an average weight average molecular weight range of about 5 kDa to about 144 kDa, wherein the leather or leather article is traditionally finished with a finishing resin. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is traditionally finished with a finishing resin. Suitable finishing resins are known to those of skill in the art. Exemplary, non-limiting examples of finishing resins from a representative supplier, Lamberti SPA, are given in the following table.

| | |
|---|---|
| Textol 110 | Handle modifier with very soft handle for coating finishes |
| Textol RGD | Water emulsion of acrylic copolymer for textile coating, |
| | with very rigid handle. |
| Textol | Butadienic resin for finishing and binder for textile printing |
| SB 21 | |
| Appretto | Vinylacetate water dispersion for rigid stiffening |
| PV/CC | |
| Amisolo B | CMS water dispersion for textile finishing as stiffening |
| | agent |
| Lamovil RP | PVOH stabilized solution as stiffening agent |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a waterborne polyurethane dispersion. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a waterborne polyurethane dispersion. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a waterborne polyurethane dispersion. Suitable waterborne polyurethane dispersions for technical finishing are known to those of skill in the art. Exemplary, non-limiting examples of waterborne polyurethane dispersions for technical finishing from a representative supplier, Lamberti SPA, are given in the following table.

| | |
|---|---|
| Rolflex | Aliphatic polyether polyurethane dispersion in water. The |
| AFP | product has high hydrolysis resistance, good breaking load |
| | resistance and excellent tear resistance. |
| Rolflex | Aliphatic polycarbonate polyurethane dispersion in water. The |
| ACF | product shows good PU and PVC bonding properties, |
| | excellent abrasion resistance as well as chemical resistance, |
| | included alcohol. |
| Rolflex | Aliphatic polyether/acrylic copolymer polyurethane dispersion |
| V 13 | in water. The product has good thermoadhesive properties and |
| | good adhesion properties on PVC. |
| Rolflex | Aliphatic polyether/acrylic copolymer polyurethane dispersion |
| K 80 | in water. ROLFLEX K 80 is specifically designed as a high |
| | performing adhesive for textile lamination. The product has |
| | excellent perchloroethylene and water fastness. |
| Rolflex | Aliphatic polyether polyurethane dispersion in water. |
| ABC | Particularly, the product presents very high water column, |
| | excellent electrolyte resistance, high LOI index, high |
| | resistance to multiple bending. |
| Rolflex | Aliphatic polyether polyurethane dispersion in water. The |
| ADH | product has a very high water column resistance. |
| Rolflex | Aliphatic waterborne PU dispersion particularly suggested for |
| W4 | the formulation of textile coatings for clothing, outwear where |
| | a full, soft and non-sticky touch is required. |
| Rolflex | Aliphatic waterborne PU dispersion particularly suggested for |
| ZB7 | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex | Aliphatic waterborned PU dispersion particularly suggested |
| BZ 78 | for the formulation of textile coatings for clothing, outwear, |
| | sportswear, fashion and technical articles for industrial |
| | applications. The product has an excellent hydrolysis |
| | resistance, a very high charge digestion and electrolytes |
| | stability and an excellent mechanical and tear resistance. Can |
| | be also suitable for foam coating and printing application. |
| Rolflex | Aliphatic polyether polyurethane dispersion in water. This |
| PU 147 | product shows good film forming properties at room |
| | temperature. It has high fastness to light and ultraviolet |
| | radiation and good resistance to water, solvent and chemical |
| | agents, as well as mechanical resistance. |
| Rolflex | Aliphatic polyether polyurethane dispersion in water. Due to |
| SG | its thermoplastic properties it is suggested to formulate heat |
| | activated adhesives at low temperatures. |
| Elafix | Aliphatic blocked isocyanate nano-dispersion used in order to |
| PV 4 | give antifelting and antipilling properties to pure wool fabrics |
| | and his blend. |
| Rolflex | Aliphatic cationic waterborne PU dispersion particularly |
| C 86 | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex | Aliphatic cationic waterborne PU dispersion particularly |
| CN 29 | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with an oil or water repellant. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with an oil or water repellant. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with an oil or water repellant. Suitable oil or water repellants for technical finishing are known to those of skill in the art. Exemplary, non-limiting examples of oil or water repellants for technical finishing from a representative supplier, Lamberti SPA, are given in the following table.

| | |
|---|---|
| Lamgard | General purpose fluorocarbon resin for water and oil |
| FT 60 | repellency; by padding application. |
| Lamgard | High performance fluorocarbon resin for water and oil |
| 48 | repellency; by padding application. High rubbing fastness. |
| Imbitex | Wetting agent for water-and oil repellent finishing. |
| NRW3 | |
| Lamgard | Crosslinker for fluorocarbon resins to improve washing |
| EXT | fastness. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a flame retardant. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a flame retardant. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a flame retardant. Suitable flame retardants for technical finishing are known to those of skill in the art. Exemplary, non-limiting examples of flame retardants for technical finishing from a representative supplier, Lamberti SPA, are given in the following table.

| | |
|---|---|
| Piroflam | Non-permanent flame retardant compound for padding and |
| 712 | spray application. |
| Piroflam | Alogen free flame retardant compound for back coating |
| ECO | application for all kind of fibers. |
| Piroflam | Flame retardant compound for back coating application for all |
| UBC | kind of fibers. |

In an embodiment, the disclosure provides a leather or leather article processed with a composition comprising silk based proteins or fragments thereof having an average weight average molecular weight range of about 5 kDa to about 144 kDa, wherein the leather or leather article is technically finished with a crosslinker. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a crosslinker. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a crosslinker. Suitable crosslinkers for technical finishing are known to those of skill in the art. Exemplary, non-limiting examples of crosslinkers for technical finishing from a representative supplier, Lamberti SPA, are given in the following table.

| | |
|---|---|
| Rolflex | Aromatic blocked polyisocyanate in water dispersion. It is |
| BK8 | suggested as a cross-linking agent in coating pastes based of |
| | polyurethane resins to improve washing fastness. |
| Fissativo | Water dispersible aliphatic polyisocyanate suitable as |
| 05 | crosslinking agent for acrylic and polyurethane dispersions to |
| | improve adhesion and wet and dry scrub resistance. |
| Resina | Melammine-formaldheyde resin. |
| MEL | |
| Cellofix | Low formaldhey de malammine resin. |
| VLF | |

In an embodiment, the disclosure provides a leather or leather article processed with a composition comprising silk based proteins or fragments thereof having an average eight average molecular weight range of about 5 kDa to about 144 kDa, wherein the leather or leather article is technically finished with a thickener for technical finishing. In an embodiment, the disclosure provides a leather or leather article having a coating, wherein the coating comprises silk based proteins or fragments thereof having an average weight average molecular weight range of about 5 kDa to about 144 kDa, wherein the leather or leather article is technically finished with a thickener for technical finishing. In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is technically finished with a thickener for technical finishing. Suitable thickeners for technical finishing are known to those of skill in the art. Exemplary, non-limiting examples of thickeners for technical finishing from a representative supplier, Lamberti SPA, are given in the following table.

| Lambicol | Fully neutralized synthetic thickener for pigment printing in |
|---|---|
| CL 60 | oil/water emulsion; medium viscosity type |
| Viscolam | Nonionic polyurethane based thickener with pseudoplastic |
| PU conc. | behavior. |
| Viscolam | Acrylic thickener; not neutralized. |
| 115 new | |
| Viscolam | Nonionic polyurethane based thickener with newtonian |
| PS 202 | behavior. |
| Viscolam | Nonionic polyurethane based thickener with moderate |
| 1022 | pseudoplastic behavior. |

In an embodiment, the disclosure provides a leather or leather article processed with a composition comprising silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the disclosure provides a leather or leather article having a coating, wherein the coating comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the disclosure provides a leather or leather article including a defect repairing filling, wherein the filling comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). Other suitable Union Specialties products such as finishes, additive, and/or oils and waxes are known to those of skill in the art. Exemplary, non-limiting examples of Union Specialties products are given in the following table:

| | |
|---|---|
| Silky Top | NMP-free water-based spray wax top; can be used on any |
| 7425 NF | leather, e.g., sheepskin for garment and nappa; can be sprayed |
| | and then iron on a Finiflex to give desired gloss and feel; can |
| | be sprayed undiluted (for maximum effect) or diluted with |
| | water 1:1 or 1:2. |
| Uniseal | Slightly cationic pre-bottom for corrected grain leathers to |
| 9049 | give uniformity and filling properties; pigment can be added |
| | to UNISEAL 9049 up to 10% for added coverage; can be |
| | sprayed and then plate the leather prior to finishing; can be |
| | diluted and applied by spray method as follows; can be mixed |
| | for 30 minutes under medium shear before using. |
| Unithane | Medium/soft, lightfast, NMP-free waterborne polyurethane, |
| 351 NF | designed for use as a resin binder for basecoats where it has |
| | superior elasticity and recovery adhesion, water resistance and |
| | abrasion resistance; has good filling properties on porous |
| | substrates and very good compatibility with waterborne |
| | pigments and other additives that are commonly used in |
| | waterborne applications. |
| Unithane | NMP-free diamond clear, bright medium-hard topcoat that |
| 2132 NF | gives a feel similar to a nitrocellulose lacquer; when a light |
| | coat is sprayed at a ratio of 1:1 with water onto full grain |
| | leather, the UNITHANE 2132 NF has abrasion resistance and |
| | creates a clear film on leather. |

In any of the foregoing leather or leather article embodiments, the processing composition comprises silk based proteins or fragments thereof having an average weight average molecular weight range of about 5 kDa to about 144 kDa. In any of the foregoing leather or leather article embodiments, the processing composition comprises silk based proteins or fragments thereof having an average weight average molecular weight range of about 6 kDa to about 17 kDa. In any of the foregoing leather or leather article embodiments, the processing composition comprises silk based proteins or fragments thereof having an average weight average molecular weight range of about 17 kDa to about 39 kDa. In any of the foregoing leather or leather article embodiments, the processing composition comprises silk based proteins or fragments thereof having an average weight average molecular weight range of about 39 kDa to about 80 kDa.

In any of the foregoing leather or leather article embodiments, the coating comprises silk based proteins or fragments thereof having an average weight average molecular weight range of about 5 kDa to about 144 kDa. In any of the foregoing leather or leather article embodiments, the coating comprises silk based proteins or fragments thereof having an average weight average molecular weight range of about 6 kDa to about 17 kDa. In any of the foregoing leather or leather article embodiments, the coating comprises silk based proteins or fragments thereof having an average weight average molecular weight range of about 17 kDa to about 39 kDa. In any of the foregoing leather or leather article embodiments, the coating comprises silk based proteins or fragments thereof having an average weight average molecular weight range of about 39 kDa to about 80 kDa.

In any of the foregoing leather or leather article embodiments, the defect repairing filling comprises silk based proteins or fragments thereof having an average weight average molecular weight range of about 5 kDa to about 144 kDa. In any of the foregoing leather or leather article embodiments, the defect repairing filling comprises silk based proteins or fragments thereof having an average weight average molecular weight range of about 6 kDa to about 17 kDa. In any of the foregoing leather or leather article embodiments, the defect repairing filling comprises silk based proteins or fragments thereof having an average weight average molecular weight range of about 17 kDa to about 39 kDa. In any of the foregoing leather or leather article embodiments, the defect repairing filling comprises silk based proteins or fragments thereof having an average weight average molecular weight range of about 39 kDa to about 80 kDa.

In any of the foregoing leather or leather article embodiments, the processing composition comprises silk based proteins or fragments thereof a low molecular weight silk.

In any of the foregoing leather or leather article embodiments, the processing composition comprises a medium molecular weight silk. In any of the foregoing leather or leather article embodiments, the processing composition comprises a heavy molecular weight silk. In any of the foregoing leather or leather article embodiments, the processing composition comprises silk based proteins or fragments thereof that comprise one or more of low, medium, and high molecular weight silk.

In any of the foregoing leather or leather article embodiments, the coating comprises silk based proteins or fragments thereof a low molecular weight silk. In any of the foregoing leather or leather article embodiments, the coating comprises a medium molecular weight silk. In any of the foregoing leather or leather article embodiments, the coating comprises a heavy molecular weight silk. In any of the foregoing leather or leather article embodiments, the coating comprises silk based proteins or fragments thereof that comprise one or more of low, medium, and high molecular weight silk.

In any of the foregoing leather or leather article embodiments, the defect repairing filling comprises silk based proteins or fragments thereof a low molecular weight silk. In any of the foregoing leather or leather article embodiments, the defect repairing filling comprises a medium molecular weight silk. In any of the foregoing leather or leather article embodiments, the defect repairing filling comprises a heavy molecular weight silk. In any of the foregoing leather or leather article embodiments, the defect repairing filling comprises silk based proteins or fragments thereof that comprise one or more of low, medium, and high molecular weight silk.

In any of the foregoing leather or leather article embodiments, the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and optionally wherein the proteins or protein fragments, prior to processing, coating, and/or repairing the leather or leather article, do not spontaneously or gradually gelate and do not visibly change in color or turbidity when in a solution for at least 10 days.

### Processes for Production of Silk Fibroin-Based Protein Fragments and Solutions Thereof

As used herein, the term “fibroin” includes silkworm fibroin and insect or spider silk protein. In an embodiment, fibroin is obtained from Bombyx mori. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk).

The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, 9,545,369, and 10,166,177, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein. Methods of using silk fibroin or silk fibroin fragments in coating applications are known and are described for example in U.S. Pat. Nos. 10,287,728 and 10,301,768.

Following are non-limiting examples of suitable ranges for various parameters in and for preparation of the silk solutions and/or compositions of the present disclosure. The silk solutions of the present disclosure may include one or more, but not necessarily all, of these parameters and may be prepared using various combinations of ranges of such parameters.

In an embodiment, the percent silk in the solution or composition is less than 50%. In an embodiment, the percent silk in the solution or composition is less than 45%. In an embodiment, the percent silk in the solution or composition is less than 40%. In an embodiment, the percent silk in the solution or composition is less than 35%. In an embodiment, the percent silk in the solution or composition is less than 30%. In an embodiment, the percent silk in the solution or composition is less than 25%. In an embodiment, the percent silk in the solution or composition is less than 20%. In an embodiment, the percent silk in the solution or composition is less than 19%. In an embodiment, the percent silk in the solution or composition is less than 18%. In an embodiment, the percent silk in the solution or composition is less than 17%. In an embodiment, the percent silk in the solution or composition is less than 16%. In an embodiment, the percent silk in the solution or composition is less than 15%. In an embodiment, the percent silk in the solution or composition is less than 14%. In an embodiment, the percent silk in the solution or composition is less than 13%. In an embodiment, the percent silk in the solution or composition is less than 12%. In an embodiment, the percent silk in the solution or composition is less than 110%. In an embodiment, the percent silk in the solution or composition is less than 10%. In an embodiment, the percent silk in the solution or composition is less than 9%. In an embodiment, the percent silk in the solution or composition is less than 8%. In an embodiment, the percent silk in the solution or composition is less than 7%. In an embodiment, the percent silk in the solution or composition is less than 6%. In an embodiment, the percent silk in the solution or composition is less than 5%. In an embodiment, the percent silk in the solution or composition is less than 4%. In an embodiment, the percent silk in the solution or composition is less than 3%. In an embodiment, the percent silk in the solution or composition is less than 2%. In an embodiment, the percent silk in the solution or composition is less than 1%. In an embodiment, the percent silk in the solution or composition is less than 0.9%. In an embodiment, the percent silk in the solution or composition is less than 0.8%. In an embodiment, the percent silk in the solution or composition is less than 0.7%. In an embodiment, the percent silk in the solution or composition is less than 0.6%. In an embodiment, the percent silk in the solution or composition is less than 0.5%. In an embodiment, the percent silk in the solution or composition is less than 0.4%. In an embodiment, the percent silk in the solution or composition is less than 0.3%. In an embodiment, the percent silk in the solution or composition is less than 0.2%. In an embodiment, the percent silk in the solution or composition is less than 0.1%. In an embodiment, the percent silk in the solution or composition is less than 0.010%. In an embodiment, the percent silk in the solution or composition is less than 0.001%.

In an embodiment, the percent silk in the solution or composition is greater than 0.001%. In an embodiment, the percent silk in the solution or composition is greater than 0.010%. In an embodiment, the percent silk in the solution or composition is greater than 0.1%. In an embodiment, the percent silk in the solution or composition is greater than 0.2%. In an embodiment, the percent silk in the solution or composition is greater than 0.3%. In an embodiment, the percent silk in the solution or composition is greater than 0.4%. In an embodiment, the percent silk in the solution or composition is greater than 0.5%. In an embodiment, the percent silk in the solution or composition is greater than 0.6%. In an embodiment, the percent silk in the solution or composition is greater than 0.7%. In an embodiment, the percent silk in the solution or composition is greater than 0.8%. In an embodiment, the percent silk in the solution or composition is greater than 0.9%. In an embodiment, the percent silk in the solution or composition is greater than 1%. In an embodiment, the percent silk in the solution or composition is greater than 2%. In an embodiment, the percent silk in the solution or composition is greater than 3%. In an embodiment, the percent silk in the solution or composition is greater than 4%. In an embodiment, the percent silk in the solution or composition is greater than 5%. In an embodiment, the percent silk in the solution or composition is greater than 6%. In an embodiment, the percent silk in the solution or composition is greater than 7%. In an embodiment, the percent silk in the solution or composition is greater than 8%. In an embodiment, the percent silk in the solution or composition is greater than 9%. In an embodiment, the percent silk in the solution or composition is greater than 10%. In an embodiment, the percent silk in the solution or composition is greater than 11%. In an embodiment, the percent silk in the solution or composition is greater than 12%. In an embodiment, the percent silk in the solution or composition is greater than 13%. In an embodiment, the percent silk in the solution or composition is greater than 14%. In an embodiment, the percent silk in the solution or composition is greater than 15%. In an embodiment, the percent silk in the solution or composition is greater than 16%. In an embodiment, the percent silk in the solution or composition is greater than 17%. In an embodiment, the percent silk in the solution or composition is greater than 18%. In an embodiment, the percent silk in the solution or composition is greater than 19%. In an embodiment, the percent silk in the solution or composition is greater than 20%. In an embodiment, the percent silk in the solution or composition is greater than 25%. In an embodiment, the percent silk in the solution or composition is greater than 30%. In an embodiment, the percent silk in the solution or composition is greater than 35%. In an embodiment, the percent silk in the solution or composition is greater than 40%. In an embodiment, the percent silk in the solution or composition is greater than 45%. In an embodiment, the percent silk in the solution or composition is greater than 50%.

In an embodiment, the percent silk in the solution or composition is between 0.1% and 50%. In an embodiment, the percent silk in the solution or composition is between 0.1% and 45%. In an embodiment, the percent silk in the solution or composition is between 0.1% and 40%. In an embodiment, the percent silk in the solution or composition is between 0.1% and 35%. In an embodiment, the percent silk in the solution or composition is between 0.1% and 30%. In an embodiment, the percent silk in the solution or composition is between 0.1% and 25%. In an embodiment, the percent silk in the solution or composition is between 0.1% and 20%. In an embodiment, the percent silk in the solution or composition is between 0.1% and 15%. In an embodiment, the percent silk in the solution or composition is between 0.1% and 10%. In an embodiment, the percent silk in the solution or composition is between 0.1% and 9%. In an embodiment, the percent silk in the solution or composition is between 0.10% and 8%. In an embodiment, the percent silk in the solution or composition is between 0.10% and 7%. In an embodiment, the percent silk in the solution or composition is between 0.10% and 6.5%. In an embodiment, the percent silk in the solution or composition is between 0.1% and 6%. In an embodiment, the percent silk in the solution or composition is between 0.1% and 5.5%. In an embodiment, the percent silk in the solution or composition is between 0.1% and 5%. In an embodiment, the percent silk in the solution or composition is between 0.1% and 4.5%. In an embodiment, the percent silk in the solution or composition is between 0.1% and 4%. In an embodiment, the percent silk in the solution or composition is between 0.1% and 3.5%. In an embodiment, the percent silk in the solution or composition is between 0.1% and 3%. In an embodiment, the percent silk in the solution or composition is between 0.1% and 2.5%. In an embodiment, the percent silk in the solution or composition is between 0.1% and 2.0%. In an embodiment, the percent silk in the solution or composition is between 0.1% and 2.4%. In an embodiment, the percent silk in the solution or composition is between 0.5% and 5%. In an embodiment, the percent silk in the solution or composition is between 0.5% and 4.5%. In an embodiment, the percent silk in the solution or composition is between 0.5% and 4%. In an embodiment, the percent silk in the solution or composition is between 0.5% and 3.5%. In an embodiment, the percent silk in the solution or composition is between 0.5% and 3%. In an embodiment, the percent silk in the solution or composition is between 0.5% and 2.5%. In an embodiment, the percent silk in the solution or composition is between 1 and 4%. In an embodiment, the percent silk in the solution or composition is between 1 and 3.5%. In an embodiment, the percent silk in the solution or composition is between 1 and 3%. In an embodiment, the percent silk in the solution or composition is between 1 and 2.5%. In an embodiment, the percent silk in the solution or composition is between 1 and 2.4%. In an embodiment, the percent silk in the solution or composition is between 1 and 2%. In an embodiment, the percent silk in the solution or composition is between 20% and 30%. In an embodiment, the percent silk in the solution or composition is between 0.1% and 6%. In an embodiment, the percent silk in the solution or composition is between 6% and 10%. In an embodiment, the percent silk in the solution or composition is between 6% and 8%. In an embodiment, the percent silk in the solution or composition is between 6% and 9%. In an embodiment, the percent silk in the solution or composition is between 10% and 20%. In an embodiment, the percent silk in the solution or composition is between 11% and 19%. In an embodiment, the percent silk in the solution or composition is between 12% and 18%. In an embodiment, the percent silk in the solution or composition is between 13% and 17%. In an embodiment, the percent silk in the solution or composition is between 14% and 16%. In an embodiment, the percent silk in the solution or composition is 2.4%. In an embodiment, the percent silk in the solution or composition is 2.0%.

In an embodiment, the percent sericin in the solution or composition is non-detectable to 30%. In an embodiment, the percent sericin in the solution or composition is non-detectable to 5%. In an embodiment, the percent sericin in the solution or composition is 1%.

In an embodiment, the percent sericin in the solution or composition is 2%. In an embodiment, the percent sericin in the solution or composition is 3%. In an embodiment, the percent sericin in the solution or composition is 4%. In an embodiment, the percent sericin in the solution or composition is 5%. In an embodiment, the percent sericin in the solution or composition is 10%. In an embodiment, the percent sericin in the solution or composition is 30%.

In an embodiment, a solution or composition of the present disclosure includes pure silk fibroin-based protein fragments having an average weight average molecular weight ranging from 6 kDa to 17 kDa. In an embodiment, a solution or composition of the present disclosure includes pure silk fibroin-based protein fragments having an average weight average molecular weight ranging from 17 kDa to 39 kDa. In an embodiment, a solution or composition of the present disclosure includes pure silk fibroin-based protein fragments having an average weight average molecular weight ranging from 39 kDa to 80 kDa.

In an embodiment, a composition of the present disclosure includes pure silk fibroin-based protein fragments having an average weight average molecular weight ranging from 1 to 5 kDa. In an embodiment, a composition of the present disclosure includes pure silk fibroin-based protein fragments having an average weight average molecular weight ranging from 5 to 10 kDa. In an embodiment, a composition of the present disclosure includes pure silk fibroin-based protein fragments having an average weight average molecular weight ranging from 10 to 15 kDa. In an embodiment, a composition of the present disclosure includes pure silk fibroin-based protein fragments having an average weight average molecular weight ranging from 15 to 20 kDa. In an embodiment, a composition of the present disclosure includes pure silk fibroin-based protein fragments having an average weight average molecular weight ranging from 20 to 25 kDa. In an embodiment, a composition of the present disclosure includes pure silk fibroin-based protein fragments having an average weight average molecular weight ranging from 25 to 30 kDa. In an embodiment, a composition of the present disclosure includes pure silk fibroin-based protein fragments having an average weight average molecular weight ranging from 30 to 35 kDa. In an embodiment, a composition of the present disclosure includes pure silk fibroin-based protein fragments having an average weight average molecular weight ranging from 35 to 40 kDa. In an embodiment, a composition of the present disclosure includes pure silk fibroin-based protein fragments having an average weight average molecular weight ranging from 40 to 45 kDa. In an embodiment, a composition of the present disclosure includes pure silk fibroin-based protein fragments having an average weight average molecular weight ranging from 45 to 50 kDa. In an embodiment, a composition of the present disclosure includes pure silk fibroin-based protein fragments having an average weight average molecular weight ranging from 50 to 55 kDa. In an embodiment, a composition of the present disclosure includes pure silk fibroin-based protein fragments having an average weight average molecular weight ranging from 55 to 60 kDa. In an embodiment, a composition of the present disclosure includes pure silk fibroin-based protein fragments having an average weight average molecular weight ranging from 60 to 65 kDa. In an embodiment, a composition of the present disclosure includes pure silk fibroin-based protein fragments having an average weight average molecular weight ranging from 65 to 70 kDa. In an embodiment, a composition of the present disclosure includes pure silk fibroin-based protein fragments having an average weight average molecular weight ranging from 70 to 75 kDa. In an embodiment, a composition of the present disclosure includes pure silk fibroin-based protein fragments having an average weight average molecular weight ranging from 75 to 80 kDa. In an embodiment, a composition of the present disclosure includes pure silk fibroin-based protein fragments having an average weight average molecular weight ranging from 80 to 85 kDa. In an embodiment, a composition of the present disclosure includes pure silk fibroin-based protein fragments having an average weight average molecular weight ranging from 85 to 90 kDa. In an embodiment, a composition of the present disclosure includes pure silk fibroin-based protein fragments having an average weight average molecular weight ranging from 90 to 95 kDa. In an embodiment, a composition of the present disclosure includes pure silk fibroin-based protein fragments having an average weight average molecular weight ranging from 95 to 100 kDa. In an embodiment, a composition of the present disclosure includes pure silk fibroin-based protein fragments having an average weight average molecular weight ranging from 100 to 105 kDa. In an embodiment, a composition of the present disclosure includes pure silk fibroin-based protein fragments having an average weight average molecular weight ranging from 105 to 110 kDa. In an embodiment, a composition of the present disclosure includes pure silk fibroin-based protein fragments having an average weight average molecular weight ranging from 110 to 115 kDa. In an embodiment, a composition of the present disclosure includes pure silk fibroin-based protein fragments having an average weight average molecular weight ranging from 115 to 120 kDa. In an embodiment, a composition of the present disclosure includes pure silk fibroin-based protein fragments having an average weight average molecular weight ranging from 120 to 125 kDa.

In an embodiment, a composition of the present disclosure includes pure silk fibroin-based protein fragments having an average weight average molecular weight ranging from 125 to 130 kDa. In an embodiment, a composition of the present disclosure includes pure silk fibroin-based protein fragments having an average weight average molecular weight ranging from 130 to 135 kDa. In an embodiment, a composition of the present disclosure includes pure silk fibroin-based protein fragments having an average weight average molecular weight ranging from 135 to 140 kDa. In an embodiment, a composition of the present disclosure includes pure silk fibroin-based protein fragments having an average weight average molecular weight ranging from 140 to 145 kDa. In an embodiment, a composition of the present disclosure includes pure silk fibroin-based protein fragments having an average weight average molecular weight ranging from 145 to 150 kDa. In an embodiment, a composition of the present disclosure includes pure silk fibroin-based protein fragments having an average weight average molecular weight ranging from 150 to 155 kDa. In an embodiment, a composition of the present disclosure includes pure silk fibroin-based protein fragments having an average weight average molecular weight ranging from 155 to 160 kDa.

In an embodiment, a composition of the present disclosure includes pure silk fibroin-based protein fragments having an average weight average molecular weight ranging from 160 to 165 kDa. I In an embodiment, a composition of the present disclosure includes pure silk fibroin-based protein fragments having an average weight average molecular weight ranging from 165 to 170 kDa. In an embodiment, a composition of the present disclosure includes pure silk fibroin-based protein fragments having an average weight average molecular weight ranging from 170 to 175 kDa. In an embodiment, a composition of the present disclosure includes pure silk fibroin-based protein fragments having an average weight average molecular weight ranging from 175 to 180 kDa. In an embodiment, a composition of the present disclosure includes pure silk fibroin-based protein fragments having an average weight average molecular weight ranging from 180 to 185 kDa. In an embodiment, a composition of the present disclosure includes pure silk fibroin-based protein fragments having an average weight average molecular weight ranging from 185 to 190 kDa. In an embodiment, a composition of the present disclosure includes pure silk fibroin-based protein fragments having an average weight average molecular weight ranging from 190 to 195 kDa.

In an embodiment, a composition of the present disclosure includes pure silk fibroin-based protein fragments having an average weight average molecular weight ranging from 195 to 200 kDa. In an embodiment, a composition of the present disclosure includes pure silk fibroin-based protein fragments having an average weight average molecular weight ranging from 200 to 205 kDa. In an embodiment, a composition of the present disclosure includes pure silk fibroin-based protein fragments having an average weight average molecular weight ranging from 205 to 210 kDa. In an embodiment, a composition of the present disclosure includes pure silk fibroin-based protein fragments having an average weight average molecular weight ranging from 210 to 215 kDa. In an embodiment, a composition of the present disclosure includes pure silk fibroin-based protein fragments having an average weight average molecular weight ranging from 215 to 220 kDa. In an embodiment, a composition of the present disclosure includes pure silk fibroin-based protein fragments having an average weight average molecular weight ranging from 220 to 225 kDa. In an embodiment, a composition of the present disclosure includes pure silk fibroin-based protein fragments having an average weight average molecular weight ranging from 225 to 230 kDa.

In an embodiment, a composition of the present disclosure includes pure silk fibroin-based protein fragments having an average weight average molecular weight ranging from 230 to 235 kDa. In an embodiment, a composition of the present disclosure includes pure silk fibroin-based protein fragments having an average weight average molecular weight ranging from 235 to 240 kDa. In an embodiment, a composition of the present disclosure includes pure silk fibroin-based protein fragments having an average weight average molecular weight ranging from 240 to 245 kDa. In an embodiment, a composition of the present disclosure includes pure silk fibroin-based protein fragments having an average weight average molecular weight ranging from 245 to 250 kDa. In an embodiment, a composition of the present disclosure includes pure silk fibroin-based protein fragments having an average weight average molecular weight ranging from 250 to 255 kDa. In an embodiment, a composition of the present disclosure includes pure silk fibroin-based protein fragments having an average weight average molecular weight ranging from 255 to 260 kDa. In an embodiment, a composition of the present disclosure includes pure silk fibroin-based protein fragments having an average weight average molecular weight ranging from 260 to 265 kDa.

In an embodiment, a composition of the present disclosure includes pure silk fibroin-based protein fragments having an average weight average molecular weight ranging from 265 to 270 kDa. In an embodiment, a composition of the present disclosure includes pure silk fibroin-based protein fragments having an average weight average molecular weight ranging from 270 to 275 kDa. In an embodiment, a composition of the present disclosure includes pure silk fibroin-based protein fragments having an average weight average molecular weight ranging from 275 to 280 kDa. In an embodiment, a composition of the present disclosure includes pure silk fibroin-based protein fragments having an average weight average molecular weight ranging from 280 to 285 kDa. In an embodiment, a composition of the present disclosure includes pure silk fibroin-based protein fragments having an average weight average molecular weight ranging from 285 to 290 kDa. In an embodiment, a composition of the present disclosure includes pure silk fibroin-based protein fragments having an average weight average molecular weight ranging from 290 to 295 kDa. In an embodiment, a composition of the present disclosure includes pure silk fibroin-based protein fragments having an average weight average molecular weight ranging from 295 to 300 kDa.

In an embodiment, a composition of the present disclosure includes pure silk fibroin-based protein fragments having an average weight average molecular weight ranging from 300 to 305 kDa. In an embodiment, a composition of the present disclosure includes pure silk fibroin-based protein fragments having an average weight average molecular weight ranging from 305 to 310 kDa. In an embodiment, a composition of the present disclosure includes pure silk fibroin-based protein fragments having an average weight average molecular weight ranging from 310 to 315 kDa. In an embodiment, a composition of the present disclosure includes pure silk fibroin-based protein fragments having an average weight average molecular weight ranging from 315 to 320 kDa. In an embodiment, a composition of the present disclosure includes pure silk fibroin-based protein fragments having an average weight average molecular weight ranging from 320 to 325 kDa. In an embodiment, a composition of the present disclosure includes pure silk fibroin-based protein fragments having an average weight average molecular weight ranging from 325 to 330 kDa. In an embodiment, a composition of the present disclosure includes pure silk fibroin-based protein fragments having an average weight average molecular weight ranging from 330 to 335 kDa.

In an embodiment, a composition of the present disclosure includes pure silk fibroin-based protein fragments having an average weight average molecular weight ranging from 35 to 340 kDa. In an embodiment, a composition of the present disclosure includes pure silk fibroin-based protein fragments having an average weight average molecular weight ranging from 340 to 345 kDa. In an embodiment, a composition of the present disclosure includes pure silk fibroin-based protein fragments having an average weight average molecular weight ranging from 345 to 350 kDa.

In an embodiment, a composition of the present disclosure includes silk protein fragments having an average weight average molecular weight ranging from 6 kDa to 17 kDa. In an embodiment, a composition of the present disclosure includes silk protein fragments having an average weight average molecular weight ranging from 17 kDa to 39 kDa. In an embodiment, a composition of the present disclosure includes silk protein fragments having an average weight average molecular weight ranging from 39 kDa to 80 kDa.

In an embodiment, a composition of the present disclosure includes silk protein fragments having an average weight average molecular weight of about 1 kDa to about 350 kDa, or about 1 kDa to about 300 kDa, or about 1 kDa to about 250 kDa, or about 1 kDa to about 200 kDa, or about 1 kDa to about 150 kDa, or about 1 kDa to about 100 kDa, or about 1 kDa to about 50 kDa, or about 1 kDa to about 25 kDa.

In an embodiment, silk fibroin-based protein fragments incorporated into the silk compositions described herein have having an average weight average molecular weight ranging from 1 kDa to 6 kDa. In an embodiment, silk fibroin-based protein fragments incorporated into the silk compositions described herein have an average weight average molecular weight ranging from 6 kDa to 16 kDa. In an embodiment, silk fibroin-based protein fragments incorporated into the silk compositions described herein have an average weight average molecular weight ranging from 16 kDa to 38 kDa. In an embodiment, silk fibroin-based protein fragments incorporated into the silk compositions described herein have an average weight average molecular weight ranging from 38 kDa to 80 kDa. In an embodiment, silk fibroin-based protein fragments incorporated into the silk compositions described herein have an average weight average molecular weight ranging from 80 kDa to 150 kDa.

In an embodiment, silk fibroin-based protein fragments incorporated into the silk compositions described herein have an average weight average molecular weight ranging from 1 kDa to 250 kDa. In an embodiment, silk fibroin-based protein fragments incorporated into the silk compositions described herein have an average weight average molecular weight ranging from 1 kDa to 240 kDa. In an embodiment, silk fibroin-based protein fragments incorporated into the silk compositions described herein have an average weight average molecular weight ranging from 1 kDa to 230 kDa. In an embodiment, silk fibroin-based protein fragments incorporated into the silk compositions described herein have an average weight average molecular weight ranging from 1 kDa to 220 kDa. In an embodiment, silk fibroin-based protein fragments incorporated into the silk compositions described herein have an average weight average molecular weight ranging from 1 kDa to 210 kDa. In an embodiment, silk fibroin-based protein fragments incorporated into the silk compositions described herein have an average weight average molecular weight ranging from 1 kDa to 200 kDa. In an embodiment, silk fibroin-based protein fragments incorporated into the silk compositions described herein have an average weight average molecular weight ranging from 1 kDa to 190 kDa. In an embodiment, silk fibroin-based protein fragments incorporated into the silk compositions described herein have an average weight average molecular weight ranging from 1 kDa to 180 kDa. In an embodiment, silk fibroin-based protein fragments incorporated into the silk compositions described herein have an average weight average molecular weight ranging from 1 kDa to 170 kDa. In an embodiment, silk fibroin-based protein fragments incorporated into the silk compositions described herein have an average weight average molecular weight ranging from 1 kDa to 160 kDa. In an embodiment, silk fibroin-based protein fragments incorporated into the silk compositions described herein have an average weight average molecular weight ranging from 1 kDa to 150 kDa. In an embodiment, silk fibroin-based protein fragments incorporated into the silk compositions described herein have an average weight average molecular weight ranging from 1 kDa to 140 kDa. In an embodiment, silk fibroin-based protein fragments incorporated into the silk compositions described herein have an average weight average molecular weight ranging from 1 kDa to 130 kDa. In an embodiment, silk fibroin-based protein fragments incorporated into the silk compositions described herein have an average weight average molecular weight ranging from 1 kDa to 120 kDa. In an embodiment, silk fibroin-based protein fragments incorporated into the silk compositions described herein have an average weight average molecular weight ranging from 1 kDa to 110 kDa. In an embodiment, silk fibroin-based protein fragments incorporated into the silk compositions described herein have an average weight average molecular weight ranging from 1 kDa to 100 kDa. In an embodiment, silk fibroin-based protein fragments incorporated into the silk compositions described herein have an average weight average molecular weight ranging from 1 kDa to 90 kDa. In an embodiment, silk fibroin-based protein fragments incorporated into the silk compositions described herein have an average weight average molecular weight ranging from 1 kDa to 80 kDa. In an embodiment, silk fibroin-based protein fragments incorporated into the silk compositions described herein have an average weight average molecular weight ranging from 1 kDa to 70 kDa. In an embodiment, silk fibroin-based protein fragments incorporated into the silk compositions described herein have an average weight average molecular weight ranging from 1 kDa to 60 kDa. In an embodiment, silk fibroin-based protein fragments incorporated into the silk compositions described herein have an average weight average molecular weight ranging from 1 kDa to 50 kDa. In an embodiment, silk fibroin-based protein fragments incorporated into the silk compositions described herein have an average weight average molecular weight ranging from 1 kDa to 40 kDa. In an embodiment, silk fibroin-based protein fragments incorporated into the silk compositions described herein have an average weight average molecular weight ranging from 1 kDa to 30 kDa. In an embodiment, silk fibroin-based protein fragments incorporated into the silk compositions described herein have an average weight average molecular weight ranging from 1 kDa to 20 kDa. In an embodiment, silk fibroin-based protein fragments incorporated into the silk compositions described herein have an average weight average molecular weight ranging from 1 kDa to 10 kDa.

In an embodiment, a composition of the present disclosure includes silk protein fragments having an average weight average molecular weight ranging from 1 to 5 kDa. In an embodiment, a composition of the present disclosure includes silk protein fragments having an average weight average molecular weight ranging from 5 to 10 kDa. In an embodiment, a composition of the present disclosure includes silk protein fragments having an average weight average molecular weight ranging from 10 to 15 kDa. In an embodiment, a composition of the present disclosure includes silk protein fragments having an average weight average molecular weight ranging from 15 to 20 kDa. In an embodiment, a composition of the present disclosure includes silk protein fragments having an average weight average molecular weight ranging from 20 to 25 kDa. In an embodiment, a composition of the present disclosure includes silk protein fragments having an average weight average molecular weight ranging from 25 to 30 kDa. In an embodiment, a composition of the present disclosure includes silk protein fragments having an average weight average molecular weight ranging from 30 to 35 kDa. In an embodiment, a composition of the present disclosure includes silk protein fragments having an average weight average molecular weight ranging from 35 to 40 kDa. In an embodiment, a composition of the present disclosure includes silk protein fragments having an average weight average molecular weight ranging from 40 to 45 kDa. In an embodiment, a composition of the present disclosure includes silk protein fragments having an average weight average molecular weight ranging from 45 to 50 kDa. In an embodiment, a composition of the present disclosure includes silk protein fragments having an average weight average molecular weight ranging from 50 to 55 kDa. In an embodiment, a composition of the present disclosure includes silk protein fragments having an average weight average molecular weight ranging from 55 to 60 kDa. In an embodiment, a composition of the present disclosure includes silk protein fragments having an average weight average molecular weight ranging from 60 to 65 kDa. In an embodiment, a composition of the present disclosure includes silk protein fragments having an average weight average molecular weight ranging from 65 to 70 kDa. In an embodiment, a composition of the present disclosure includes silk protein fragments having an average weight average molecular weight ranging from 70 to 75 kDa. In an embodiment, a composition of the present disclosure includes silk protein fragments having an average weight average molecular weight ranging from 75 to 80 kDa. In an embodiment, a composition of the present disclosure includes silk protein fragments having an average weight average molecular weight ranging from 80 to 85 kDa. In an embodiment, a composition of the present disclosure includes silk protein fragments having an average weight average molecular weight ranging from 85 to 90 kDa. In an embodiment, a composition of the present disclosure includes silk protein fragments having an average weight average molecular weight ranging from 90 to 95 kDa. In an embodiment, a composition of the present disclosure includes silk protein fragments having an average weight average molecular weight ranging from 95 to 100 kDa. In an embodiment, a composition of the present disclosure includes silk protein fragments having an average weight average molecular weight ranging from 100 to 105 kDa. In an embodiment, a composition of the present disclosure includes silk protein fragments having an average weight average molecular weight ranging from 105 to 110 kDa. In an embodiment, a composition of the present disclosure includes silk protein fragments having an average weight average molecular weight ranging from 110 to 115 kDa. In an embodiment, a composition of the present disclosure includes silk protein fragments having an average weight average molecular weight ranging from 115 to 120 kDa. In an embodiment, a composition of the present disclosure includes silk protein fragments having an average weight average molecular weight ranging from 120 to 125 kDa. In an embodiment, a composition of the present disclosure includes silk protein fragments having an average weight average molecular weight ranging from 125 to 130 kDa. In an embodiment, a composition of the present disclosure includes silk protein fragments having an average weight average molecular weight ranging from 130 to 135 kDa. In an embodiment, a composition of the present disclosure includes silk protein fragments having an average weight average molecular weight ranging from 135 to 140 kDa. In an embodiment, a composition of the present disclosure includes silk protein fragments having an average weight average molecular weight ranging from 140 to 145 kDa. In an embodiment, a composition of the present disclosure includes silk protein fragments having an average weight average molecular weight ranging from 145 to 150 kDa. In an embodiment, a composition of the present disclosure includes silk protein fragments having an average weight average molecular weight ranging from 150 to 155 kDa. In an embodiment, a composition of the present disclosure includes silk protein fragments having an average weight average molecular weight ranging from 155 to 160 kDa. In an embodiment, a composition of the present disclosure includes silk protein fragments having an average weight average molecular weight ranging from 160 to 165 kDa. I In an embodiment, a composition of the present disclosure includes silk protein fragments having an average weight average molecular weight ranging from 165 to 170 kDa. In an embodiment, a composition of the present disclosure includes silk protein fragments having an average weight average molecular weight ranging from 170 to 175 kDa. In an embodiment, a composition of the present disclosure includes silk protein fragments having an average weight average molecular weight ranging from 175 to 180 kDa. In an embodiment, a composition of the present disclosure includes silk protein fragments having an average weight average molecular weight ranging from 180 to 185 kDa. In an embodiment, a composition of the present disclosure includes silk protein fragments having an average weight average molecular weight ranging from 185 to 190 kDa. In an embodiment, a composition of the present disclosure includes silk protein fragments having an average weight average molecular weight ranging from 190 to 195 kDa. In an embodiment, a composition of the present disclosure includes silk protein fragments having an average weight average molecular weight ranging from 195 to 200 kDa. In an embodiment, a composition of the present disclosure includes silk protein fragments having an average weight average molecular weight ranging from 200 to 205 kDa. In an embodiment, a composition of the present disclosure includes silk protein fragments having an average weight average molecular weight ranging from 205 to 210 kDa. In an embodiment, a composition of the present disclosure includes silk protein fragments having an average weight average molecular weight ranging from 210 to 215 kDa. In an embodiment, a composition of the present disclosure includes silk protein fragments having an average weight average molecular weight ranging from 215 to 220 kDa. In an embodiment, a composition of the present disclosure includes silk protein fragments having an average weight average molecular weight ranging from 220 to 225 kDa. In an embodiment, a composition of the present disclosure includes silk protein fragments having an average weight average molecular weight ranging from 225 to 230 kDa. In an embodiment, a composition of the present disclosure includes silk protein fragments having an average weight average molecular weight ranging from 230 to 235 kDa. In an embodiment, a composition of the present disclosure includes silk protein fragments having an average weight average molecular weight ranging from 235 to 240 kDa. In an embodiment, a composition of the present disclosure includes silk protein fragments having an average weight average molecular weight ranging from 240 to 245 kDa. In an embodiment, a composition of the present disclosure includes silk protein fragments having an average weight average molecular weight ranging from 245 to 250 kDa. In an embodiment, a composition of the present disclosure includes silk protein fragments having an average weight average molecular weight ranging from 250 to 255 kDa. In an embodiment, a composition of the present disclosure includes silk protein fragments having an average weight average molecular weight ranging from 255 to 260 kDa. In an embodiment, a composition of the present disclosure includes silk protein fragments having an average weight average molecular weight ranging from 260 to 265 kDa. In an embodiment, a composition of the present disclosure includes silk protein fragments having an average weight average molecular weight ranging from 265 to 270 kDa. In an embodiment, a composition of the present disclosure includes silk protein fragments having an average weight average molecular weight ranging from 270 to 275 kDa. In an embodiment, a composition of the present disclosure includes silk protein fragments having an average weight average molecular weight ranging from 275 to 280 kDa. In an embodiment, a composition of the present disclosure includes silk protein fragments having an average weight average molecular weight ranging from 280 to 285 kDa. In an embodiment, a composition of the present disclosure includes silk protein fragments having an average weight average molecular weight ranging from 285 to 290 kDa. In an embodiment, a composition of the present disclosure includes silk protein fragments having an average weight average molecular weight ranging from 290 to 295 kDa. In an embodiment, a composition of the present disclosure includes silk protein fragments having an average weight average molecular weight ranging from 295 to 300 kDa. In an embodiment, a composition of the present disclosure includes silk protein fragments having an average weight average molecular weight ranging from 300 to 305 kDa. In an embodiment, a composition of the present disclosure includes silk protein fragments having an average weight average molecular weight ranging from 305 to 310 kDa. In an embodiment, a composition of the present disclosure includes silk protein fragments having an average weight average molecular weight ranging from 310 to 315 kDa. In an embodiment, a composition of the present disclosure includes silk protein fragments having an average weight average molecular weight ranging from 315 to 320 kDa. In an embodiment, a composition of the present disclosure includes silk protein fragments having an average weight average molecular weight ranging from 320 to 325 kDa. In an embodiment, a composition of the present disclosure includes silk protein fragments having an average weight average molecular weight ranging from 325 to 330 kDa. In an embodiment, a composition of the present disclosure includes silk protein fragments having an average weight average molecular weight ranging from 330 to 335 kDa. In an embodiment, a composition of the present disclosure includes silk protein fragments having an average weight average molecular weight ranging from 35 to 340 kDa. In an embodiment, a composition of the present disclosure includes silk protein fragments having an average weight average molecular weight ranging from 340 to 345 kDa. In an embodiment, a composition of the present disclosure includes silk protein fragments having an average weight average molecular weight ranging from 345 to 350 kDa.

In an embodiment, a composition of the present disclosure includes silk protein fragments having an average weight average molecular weight of about 5 kDa. In an embodiment, a composition of the present disclosure includes silk protein fragments having an average weight average molecular weight of about 6 kDa. In an embodiment, a composition of the present disclosure includes silk protein fragments having an average weight average molecular weight of about 7 kDa. In an embodiment, a composition of the present disclosure includes silk protein fragments having an average weight average molecular weight of about 8 kDa. In an embodiment, a composition of the present disclosure includes silk protein fragments having an average weight average molecular weight of about 9 kDa. In an embodiment, a composition of the present disclosure includes silk protein fragments having an average weight average molecular weight of about 10 kDa.

In an embodiment, a composition of the present disclosure includes silk protein fragments having an average weight average molecular weight of about 11 kDa. In an embodiment, a composition of the present disclosure includes silk protein fragments having an average weight average molecular weight of about 12 kDa. In an embodiment, a composition of the present disclosure includes silk protein fragments having an average weight average molecular weight of about 13 kDa. In an embodiment, a composition of the present disclosure includes silk protein fragments having an average weight average molecular weight of about 14 kDa. In an embodiment, a composition of the present disclosure includes silk protein fragments having an average weight average molecular weight of about 15 kDa. In an embodiment, a composition of the present disclosure includes silk protein fragments having an average weight average molecular weight of about 16 kDa. In an embodiment, a composition of the present disclosure includes silk protein fragments having an average weight average molecular weight of about 17 kDa. In an embodiment, a composition of the present disclosure includes silk protein fragments having an average weight average molecular weight of about 18 kDa. In an embodiment, a composition of the present disclosure includes silk protein fragments having an average weight average molecular weight of about 19 kDa. In an embodiment, a composition of the present disclosure includes silk protein fragments having an average weight average molecular weight of about 20 kDa.

In an embodiment, a composition of the present disclosure includes silk protein fragments having an average weight average molecular weight of about 21 kDa. In an embodiment, a composition of the present disclosure includes silk protein fragments having an average weight average molecular weight of about 22 kDa. In an embodiment, a composition of the present disclosure includes silk protein fragments having an average weight average molecular weight of about 23 kDa. In an embodiment, a composition of the present disclosure includes silk protein fragments having an average weight average molecular weight of about 24 kDa. In an embodiment, a composition of the present disclosure includes silk protein fragments having an average weight average molecular weight of about 25 kDa. In an embodiment, a composition of the present disclosure includes silk protein fragments having an average weight average molecular weight of about 26 kDa. In an embodiment, a composition of the present disclosure includes silk protein fragments having an average weight average molecular weight of about 27 kDa. In an embodiment, a composition of the present disclosure includes silk protein fragments having an average weight average molecular weight of about 28 kDa. In an embodiment, a composition of the present disclosure includes silk protein fragments having an average weight average molecular weight of about 29 kDa. In an embodiment, a composition of the present disclosure includes silk protein fragments having an average weight average molecular weight of about 30 kDa.

In an embodiment, a composition of the present disclosure includes silk protein fragments having an average weight average molecular weight of about 31 kDa. In an embodiment, a composition of the present disclosure includes silk protein fragments having an average weight average molecular weight of about 32 kDa. In an embodiment, a composition of the present disclosure includes silk protein fragments having an average weight average molecular weight of about 33 kDa. In an embodiment, a composition of the present disclosure includes silk protein fragments having an average weight average molecular weight of about 34 kDa. In an embodiment, a composition of the present disclosure includes silk protein fragments having an average weight average molecular weight of about 35 kDa. In an embodiment, a composition of the present disclosure includes silk protein fragments having an average weight average molecular weight of about 36 kDa. In an embodiment, a composition of the present disclosure includes silk protein fragments having an average weight average molecular weight of about 37 kDa. In an embodiment, a composition of the present disclosure includes silk protein fragments having an average weight average molecular weight of about 38 kDa. In an embodiment, a composition of the present disclosure includes silk protein fragments having an average weight average molecular weight of about 39 kDa. In an embodiment, a composition of the present disclosure includes silk protein fragments having an average weight average molecular weight of about 40 kDa.

In an embodiment, a composition of the present disclosure includes silk protein fragments having an average weight average molecular weight of about 41 kDa. In an embodiment, a composition of the present disclosure includes silk protein fragments having an average weight average molecular weight of about 42 kDa. In an embodiment, a composition of the present disclosure includes silk protein fragments having an average weight average molecular weight of about 43 kDa. In an embodiment, a composition of the present disclosure includes silk protein fragments having an average weight average molecular weight of about 44 kDa. In an embodiment, a composition of the present disclosure includes silk protein fragments having an average weight average molecular weight of about 45 kDa. In an embodiment, a composition of the present disclosure includes silk protein fragments having an average weight average molecular weight of about 46 kDa. In an embodiment, a composition of the present disclosure includes silk protein fragments having an average weight average molecular weight of about 47 kDa. In an embodiment, a composition of the present disclosure includes silk protein fragments having an average weight average molecular weight of about 48 kDa. In an embodiment, a composition of the present disclosure includes silk protein fragments having an average weight average molecular weight of about 49 kDa. In an embodiment, a composition of the present disclosure includes silk protein fragments having an average weight average molecular weight of about 50 kDa.

In an embodiment, a composition of the present disclosure includes silk protein fragments having an average weight average molecular weight of about 51 kDa. In an embodiment, a composition of the present disclosure includes silk protein fragments having an average weight average molecular weight of about 52 kDa. In an embodiment, a composition of the present disclosure includes silk protein fragments having an average weight average molecular weight of about 53 kDa. In an embodiment, a composition of the present disclosure includes silk protein fragments having an average weight average molecular weight of about 54 kDa. In an embodiment, a composition of the present disclosure includes silk protein fragments having an average weight average molecular weight of about 55 kDa. In an embodiment, a composition of the present disclosure includes silk protein fragments having an average weight average molecular weight of about 56 kDa. In an embodiment, a composition of the present disclosure includes silk protein fragments having an average weight average molecular weight of about 57 kDa. In an embodiment, a composition of the present disclosure includes silk protein fragments having an average weight average molecular weight of about 58 kDa. In an embodiment, a composition of the present disclosure includes silk protein fragments having an average weight average molecular weight of about 59 kDa. In an embodiment, a composition of the present disclosure includes silk protein fragments having an average weight average molecular weight of about 60 kDa.

In an embodiment, a composition of the present disclosure includes silk protein fragments having an average weight average molecular weight of about 61 kDa. In an embodiment, a composition of the present disclosure includes silk protein fragments having an average weight average molecular weight of about 62 kDa. In an embodiment, a composition of the present disclosure includes silk protein fragments having an average weight average molecular weight of about 63 kDa. In an embodiment, a composition of the present disclosure includes silk protein fragments having an average weight average molecular weight of about 64 kDa. In an embodiment, a composition of the present disclosure includes silk protein fragments having an average weight average molecular weight of about 65 kDa. In an embodiment, a composition of the present disclosure includes silk protein fragments having an average weight average molecular weight of about 66 kDa. In an embodiment, a composition of the present disclosure includes silk protein fragments having an average weight average molecular weight of about 67 kDa. In an embodiment, a composition of the present disclosure includes silk protein fragments having an average weight average molecular weight of about 68 kDa. In an embodiment, a composition of the present disclosure includes silk protein fragments having an average weight average molecular weight of about 69 kDa. In an embodiment, a composition of the present disclosure includes silk protein fragments having an average weight average molecular weight of about 70 kDa.

In an embodiment, a composition of the present disclosure includes silk protein fragments having an average weight average molecular weight of about 71 kDa. In an embodiment, a composition of the present disclosure includes silk protein fragments having an average weight average molecular weight of about 72 kDa. In an embodiment, a composition of the present disclosure includes silk protein fragments having an average weight average molecular weight of about 73 kDa. In an embodiment, a composition of the present disclosure includes silk protein fragments having an average weight average molecular weight of about 74 kDa. In an embodiment, a composition of the present disclosure includes silk protein fragments having an average weight average molecular weight of about 75 kDa. In an embodiment, a composition of the present disclosure includes silk protein fragments having an average weight average molecular weight of about 76 kDa. In an embodiment, a composition of the present disclosure includes silk protein fragments having an average weight average molecular weight of about 77 kDa. In an embodiment, a composition of the present disclosure includes silk protein fragments having an average weight average molecular weight of about 78 kDa. In an embodiment, a composition of the present disclosure includes silk protein fragments having an average weight average molecular weight of about 79 kDa. In an embodiment, a composition of the present disclosure includes silk protein fragments having an average weight average molecular weight of about 80 kDa.

In an embodiment, a composition of the present disclosure includes silk protein fragments having an average weight average molecular weight of about 81 kDa. In an embodiment, a composition of the present disclosure includes silk protein fragments having an average weight average molecular weight of about 82 kDa. In an embodiment, a composition of the present disclosure includes silk protein fragments having an average weight average molecular weight of about 83 kDa. In an embodiment, a composition of the present disclosure includes silk protein fragments having an average weight average molecular weight of about 84 kDa. In an embodiment, a composition of the present disclosure includes silk protein fragments having an average weight average molecular weight of about 85 kDa. In an embodiment, a composition of the present disclosure includes silk protein fragments having an average weight average molecular weight of about 86 kDa. In an embodiment, a composition of the present disclosure includes silk protein fragments having an average weight average molecular weight of about 87 kDa. In an embodiment, a composition of the present disclosure includes silk protein fragments having an average weight average molecular weight of about 88 kDa. In an embodiment, a composition of the present disclosure includes silk protein fragments having an average weight average molecular weight of about 89 kDa. In an embodiment, a composition of the present disclosure includes silk protein fragments having an average weight average molecular weight of about 90 kDa.

In an embodiment, a composition of the present disclosure includes silk protein fragments having an average weight average molecular weight of about 91 kDa. In an embodiment, a composition of the present disclosure includes silk protein fragments having an average weight average molecular weight of about 92 kDa. In an embodiment, a composition of the present disclosure includes silk protein fragments having an average weight average molecular weight of about 93 kDa. In an embodiment, a composition of the present disclosure includes silk protein fragments having an average weight average molecular weight of about 94 kDa. In an embodiment, a composition of the present disclosure includes silk protein fragments having an average weight average molecular weight of about 95 kDa. In an embodiment, a composition of the present disclosure includes silk protein fragments having an average weight average molecular weight of about 96 kDa. In an embodiment, a composition of the present disclosure includes silk protein fragments having an average weight average molecular weight of about 97 kDa. In an embodiment, a composition of the present disclosure includes silk protein fragments having an average weight average molecular weight of about 98 kDa. In an embodiment, a composition of the present disclosure includes silk protein fragments having an average weight average molecular weight of about 99 kDa. In an embodiment, a composition of the present disclosure includes silk protein fragments having an average weight average molecular weight of about 100 kDa.

In an embodiment, a composition of the present disclosure includes silk protein fragments having an average weight average molecular weight of about 101 kDa. In an embodiment, a composition of the present disclosure includes silk protein fragments having an average weight average molecular weight of about 102 kDa. In an embodiment, a composition of the present disclosure includes silk protein fragments having an average weight average molecular weight of about 103 kDa. In an embodiment, a composition of the present disclosure includes silk protein fragments having an average weight average molecular weight of about 104 kDa. In an embodiment, a composition of the present disclosure includes silk protein fragments having an average weight average molecular weight of about 105 kDa. In an embodiment, a composition of the present disclosure includes silk protein fragments having an average weight average molecular weight of about 106 kDa.

In an embodiment, a composition of the present disclosure includes silk protein fragments having an average weight average molecular weight of about 107 kDa. In an embodiment, a composition of the present disclosure includes silk protein fragments having an average weight average molecular weight of about 108 kDa. In an embodiment, a composition of the present disclosure includes silk protein fragments having an average weight average molecular weight of about 109 kDa. In an embodiment, a composition of the present disclosure includes silk protein fragments having an average weight average molecular weight of about 110 kDa.

In an embodiment, a composition of the present disclosure includes silk protein fragments having an average weight average molecular weight of about 111 kDa. In an embodiment, a composition of the present disclosure includes silk protein fragments having an average weight average molecular weight of about 112 kDa. In an embodiment, a composition of the present disclosure includes silk protein fragments having an average weight average molecular weight of about 113 kDa. In an embodiment, a composition of the present disclosure includes silk protein fragments having an average weight average molecular weight of about 114 kDa. In an embodiment, a composition of the present disclosure includes silk protein fragments having an average weight average molecular weight of about 115 kDa. In an embodiment, a composition of the present disclosure includes silk protein fragments having an average weight average molecular weight of about 116 kDa. In an embodiment, a composition of the present disclosure includes silk protein fragments having an average weight average molecular weight of about 117 kDa. In an embodiment, a composition of the present disclosure includes silk protein fragments having an average weight average molecular weight of about 118 kDa. In an embodiment, a composition of the present disclosure includes silk protein fragments having an average weight average molecular weight of about 119 kDa. In an embodiment, a composition of the present disclosure includes silk protein fragments having an average weight average molecular weight of about 120 kDa.

In an embodiment, a composition of the present disclosure includes silk protein fragments having an average weight average molecular weight of about 121 kDa. In an embodiment, a composition of the present disclosure includes silk protein fragments having an average weight average molecular weight of about 122 kDa. In an embodiment, a composition of the present disclosure includes silk protein fragments having an average weight average molecular weight of about 123 kDa. In an embodiment, a composition of the present disclosure includes silk protein fragments having an average weight average molecular weight of about 124 kDa. In an embodiment, a composition of the present disclosure includes silk protein fragments having an average weight average molecular weight of about 125 kDa. In an embodiment, a composition of the present disclosure includes silk protein fragments having an average weight average molecular weight of about 126 kDa.

In an embodiment, a composition of the present disclosure includes silk protein fragments having an average weight average molecular weight of about 127 kDa. In an embodiment, a composition of the present disclosure includes silk protein fragments having an average weight average molecular weight of about 128 kDa. In an embodiment, a composition of the present disclosure includes silk protein fragments having an average weight average molecular weight of about 129 kDa. In an embodiment, a composition of the present disclosure includes silk protein fragments having an average weight average molecular weight of about 130 kDa.

In an embodiment, a composition of the present disclosure includes silk protein fragments having an average weight average molecular weight of about 131 kDa. In an embodiment, a composition of the present disclosure includes silk protein fragments having an average weight average molecular weight of about 132 kDa. In an embodiment, a composition of the present disclosure includes silk protein fragments having an average weight average molecular weight of about 133 kDa. In an embodiment, a composition of the present disclosure includes silk protein fragments having an average weight average molecular weight of about 134 kDa. In an embodiment, a composition of the present disclosure includes silk protein fragments having an average weight average molecular weight of about 135 kDa. In an embodiment, a composition of the present disclosure includes silk protein fragments having an average weight average molecular weight of about 136 kDa.

In an embodiment, a composition of the present disclosure includes silk protein fragments having an average weight average molecular weight of about 137 kDa. In an embodiment, a composition of the present disclosure includes silk protein fragments having an average weight average molecular weight of about 138 kDa. In an embodiment, a composition of the present disclosure includes silk protein fragments having an average weight average molecular weight of about 139 kDa. In an embodiment, a composition of the present disclosure includes silk protein fragments having an average weight average molecular weight of about 140 kDa.

In an embodiment, a composition of the present disclosure includes silk protein fragments having an average weight average molecular weight of about 141 kDa. In an embodiment, a composition of the present disclosure includes silk protein fragments having an average weight average molecular weight of about 142 kDa. In an embodiment, a composition of the present disclosure includes silk protein fragments having an average weight average molecular weight of about 143 kDa. In an embodiment, a composition of the present disclosure includes silk protein fragments having an average weight average molecular weight of about 144 kDa.

In an embodiment, a composition of the present disclosure includes silk fibroin-based protein fragments having one or more of low molecular weight, medium molecular weight, and high molecular weight. In an embodiment, a composition of the present disclosure includes silk fibroin-based protein fragments having low molecular weight and silk fibroin-based protein fragments having medium molecular weight. In an embodiment, a composition of the present disclosure includes silk fibroin-based protein fragments having low molecular weight and silk fibroin-based protein fragments having high molecular weight. In an embodiment, a composition of the present disclosure includes silk fibroin-based protein fragments having medium molecular weight and silk fibroin-based protein fragments having high molecular weight. In an embodiment, a composition of the present disclosure includes silk fibroin-based protein fragments having low molecular weight, silk fibroin-based protein fragments having medium molecular weight, and silk fibroin-based protein fragments having high molecular weight.

In an embodiment, a composition of the present disclosure includes silk fibroin-based protein fragments having low molecular weight and silk fibroin-based protein fragments having medium molecular weight. In some embodiments, the w/w ratio between low molecular weight silk fibroin-based protein fragments and medium molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and medium molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and medium molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight and silk fibroin-based protein fragments having high molecular weight. In some embodiments, the w/w ratio between low molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having medium molecular weight and silk fibroin-based protein fragments having high molecular weight. In some embodiments, the w/w ratio between medium molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight, silk fibroin-based protein fragments having medium molecular weight, and silk fibroin-based protein fragments having high molecular weight. In an embodiment, the w/w ratio between low molecular weight silk fibroin-based protein fragments, medium molecular weight silk fibroin-based protein fragments, and high molecular weight silk fibroin-based protein fragments is about 1:1:8, about 1:2:7, about 1:3:6, about 1:4:5, about 1:5:4, about 1:6:3, about 1:7:2, about 1:8:1, about 2:1:7, about 2:2:6, about 2:3:5, about 2:4:4, about 2:5:3, about 2:6:2, about 2:7:1, about 3:1:6, about 3:2:5, about 3:3:4, about 3:4:3, about 3:5:2, about 3:6:1, about 4:1:5, about 4:2:4, about 4:3:3, about 4:4:2, about 4:5:1, about 5:1:4, about 5:2:3, about 5:3:2, about 5:4:1, about 6:1:3, about 6:2:2, about 6:3:1, about 7:1:2, about 7:2:1, or about 8:1:1.

In some embodiments, the silk compositions provided herein may be applied as mixtures to an article to be processed or in stepwise processes to the article. For example, a silk composition that includes low molecular weight silk and medium molecular weight silk may be applied to an article to be processed. Alternatively, a low molecular weight silk composition may be applied to an article to be processed, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be coated or in stepwise processes to form coating layers on the article. For example, a silk composition that includes low molecular weight silk and medium molecular weight silk may be applied to an article to be coated. Alternatively, a low molecular weight silk composition may be applied to an article to be coated, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be repaired or in stepwise processes to form fillings in or on the article. For example, a silk composition that includes low molecular weight silk and medium molecular weight silk may be applied to an article to be repaired. Alternatively, a low molecular weight silk composition may be applied to an article to be repaired, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, where multiple layers of silk compositions are applied to an article to be coated, they may have at least one layer, or 1 layer to 1 million layers, or 1 layer to 100,000 layers, or 1 layer to 10,000 layers, or 1 layer to 1,000 layers of such silk compositions, wherein the layers may have the same or different thicknesses. For example, in some embodiments, the layers may have a thickness of from about 1 nm to about 1 mm, or about 1 nm to about 1 μm, or about 1 nm to about 500 nm, or about 1 nm to about 400 nm, or about 1 nm to about 300 nm, or about 1 nm to about 200 nm, or about 1 nm to about 100 nm, or about 1 nm to about 75 nm, or about 1 nm to about 50 nm, or about 1 nm to about 25 nm, or about 1 nm to about 20 nm, or about 1 nm to about 15 nm, or about 1 nm to about 10 nm, or about 1 nm to about 5 nm.

In an embodiment, a composition of the present disclosure having pure silk fibroin-based protein fragments has a polydispersity ranging from about 1 to about 5.0. In an embodiment, a composition of the present disclosure having pure silk fibroin-based protein fragments has a polydispersity ranging from about 1.5 to about 3.0. In an embodiment, a composition of the present disclosure having pure silk fibroin-based protein fragments has a polydispersity ranging from about 1 to about 1.5. In an embodiment, a composition of the present disclosure having pure silk fibroin-based protein fragments has a polydispersity ranging from about 1.5 to about 2.0. In an embodiment, a composition of the present disclosure having pure silk fibroin-based protein fragments has a polydispersity ranging from about 2.0 to about 2.5. In an embodiment, a composition of the present disclosure having pure silk fibroin-based protein fragments, has a polydispersity ranging from about is 2.0 to about 3.0. In an embodiment, a composition of the present disclosure having pure silk fibroin-based protein fragments, has a polydispersity ranging from about is 2.5 to about 3.0.

In an embodiment, a composition of the present disclosure having silk protein fragments has a polydispersity ranging from about 1 to about 5.0. In an embodiment, a composition of the present disclosure having silk protein fragments has a polydispersity ranging from about 1.5 to about 3.0. In an embodiment, a composition of the present disclosure having silk protein fragments has a polydispersity ranging from about 1 to about 1.5. In an embodiment, a composition of the present disclosure having silk protein fragments has a polydispersity ranging from about 1.5 to about 2.0. In an embodiment, a composition of the present disclosure having silk protein fragments has a polydispersity ranging from about 2.0 to about 2.5. In an embodiment, a composition of the present disclosure having silk protein fragments, has a polydispersity ranging from about is 2.0 to about 3.0. In an embodiment, a composition of the present disclosure having silk protein fragments, has a polydispersity ranging from about is 2.5 to about 3.0.

In some embodiments the polydispersity of low molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of medium molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of high molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments, in compositions described herein having combinations of low, medium, and/or high molecular weight silk protein fragments, such low, medium, and/or high molecular weight silk proteins may have the same or different polydispersities.

### Bio-Based Polyurethane

In some embodiments, the coating system comprises, without limitation, a bio-based polyurethane. In some embodiments, the bio-based polyurethane is biodegradable. Biodegradable polyurethanes can be obtained using biodegradable soft segments and isomannide hard segments. In the biodegradable soft segment, polyurethanes, such as those containing poly(ϵ-caprolactone) (PCL), have been obtained, along with poly(ethylene oxide) (PEO) and poly(1-lactide) PLA. In the biodegradable hard segments, the diisocyanate and the chain extender can be designed from a variety of biologically relevant molecules. Some non-limiting examples of bio-based polyurethanes are further described in sciencedirect.com/topics/engineering/biodegradable-polyurethane and ncbi.nlm.nih.gov/pmc/articles/PMC4108296/.

### Compositions and Processes Including Silk Fibroin-Based Processing Compositions, Coatings, or Fillings

In an embodiment, the disclosure may include leather or leather articles that may be processed, coated, or repaired with an SPF mixture solution (i.e., silk fibroin solution (SFS)), and/or composition, as described herein to produce a processed, coated, or repaired article. In an embodiment, the processed, coated, or repaired articles described herein may be treated with additional chemical agents that may enhance the properties of the coated article. In an embodiment, the SFS may enhance the properties of the coated or repaired article, or the SFS may include one or more chemical agents that may enhance the properties of the coated or repaired article.

In some embodiments, chemical finishes may be applied to leather or leather articles before or after such leather or leather articles are processed, coated, or repaired with SFS. In an embodiment, chemical finishing may be intended as the application of chemical agents and/or SFS to leather or leather articles to modify the original leather's or leather articles' properties and achieve properties in the leather or leather articles that would be otherwise absent. With chemical finishes, leather or leather articles treated with such chemical finishes may act as surface treatments and/or the treatments may modify the elemental analysis of treated leather or leather article base polymers.

In an embodiment, a type of chemical finishing may include the application of certain silk-fibroin based solutions to leather or leather articles. For example, SFS may be applied to a leather or leather article after it is dyed, but there are also scenarios that may require the application of SFS during processing, during dyeing, or after a garment is assembled from a selected leather or leather article. In some embodiments, after its application, SFS may be dried with the use of heat. In some embodiments, SFS may then be fixed to the surface of the leather or leather article in a processing step called curing.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 10%, or greater than about 0.10%, or greater than about 0.010%, or greater than about 0.001%, or greater than about 0.00010%, or greater than about 0.00001%.

In some embodiments, the solution concentration and the wet pick of the material determines the amount of silk fibroin solution (SFS), which may include silk-based proteins or fragments thereof, that may be fixed or otherwise adhered to the leather or leather article being coated. The wet pick up may be expressed by the following formula:

$$wet pick up ( \% ) = \frac{weight of SFS applied \times 100}{weight of dry textile material} .$$

The total amount of SFS added to the leather or leather article may be expressed by the following formula:

$$SFS added ( \% ) = \frac{weight of dry SFS coated material \times 100}{weight of dry material before coating} .$$

In one embodiment, silk-based protein films are naturally derived, renewable and biodegradable. Without wishing to be bound by any particular theory, it is believed that expanding applications of silk-based biomaterials can potentially replace synthetic chemicals and promote sustainability and safety for commercial products. In most cases, silk crystallizes and forms rigid structure that has high young modulus and low elongation at break. This mainly due to inter-chain hydrogen bonding and hydrophobic interactions. This tight and crystalline structure can be disrupted and concerted into amorphous structure, a structure that is believed to make protein soft and flexible.

In one embodiment, converting brittle/rigid films into flexible films is by adding plasticizer such as glycerol. Glycerol can interfere with inter-chain non-covalent bonding; thus, it creates space between protein chains and reduces “chain friction”. However, this technique has limitations. Adding excess amount of glycerol may “over plasticize” protein and difficult to form films; adding right amount of glycerol can only improve stretchability from 4% to 40%, which is still lower than commercial stretchy leather finishing topcoat resins whose elongation is over 500%.

In one embodiment, the disruption of silk fibroin interactions can occur by adding salts. Salts are strongly charged and highly soluble in water, allowing them to strongly interact with protein segment. Specifically, anions can interact with positively charged NH3+ while cations can interact with —COO—. This strong electrostatic attraction may prevent proteins from forming beta-sheet, a crystalline structure responsible for its brittleness.

In some embodiments, the incorporation of salts can improve silk film flexibility.

Regarding methods for applying SFS to leather or leather articles more broadly, SFS may be applied to leather or leather articles through a pad or roller application on process, a saturation and removal process, and/or a topical application process. Moreover, the methods of silk application (i.e., SFS application or coating) may include bath coating, kiss rolling, spray coating, and/or two-sided rolling. In some embodiments, the coating processes (e.g., bath coating, kiss rolling, spray coating, two-sided rolling, roller application, saturation and removal application, and/or topical application), drying processes, and curing processes may be varied as described herein to modify one or more selected leather or leather article properties of the resulting coated leather or leather article wherein such properties.

In an embodiment, the drying and/or curing temperature for the processes of the disclosure may be less than about 70° C., or less than about 75° C., or less than about 80° C., or less than about 85° C., or less than about 90° C., or less than about 95° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C., or less than about 230° C.

In an embodiment, the drying and/or curing temperature for the processes of the disclosure may be greater than about 70° C., or greater than about 75° C., or greater than about 80° C., or greater than about 85° C., or greater than about 90° C., or greater than about 95° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C., or greater than about 230° C.

In an embodiment, the drying time for the processes of the disclosure may be less than about 10 seconds, or less than about 20 seconds, or less than about 30 seconds, or less than about 40 seconds, or less than about 50 seconds, or less than about 60 seconds, or less than about 2 minutes, or less than about, 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the drying time for the processes of the disclosure may be greater than about 10 seconds, or greater than about 20 seconds, or greater than about 30 seconds, or greater than about 40 seconds, or greater than about 50 seconds, or greater than about 60 seconds, or greater than about 2 minutes, or greater than about, 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In an embodiment, the curing time for the processes of the disclosure may be less than about 1 second, or less than about 2 seconds, or less than about 3 seconds, or less than about 4 seconds, or less than about 5 seconds, or less than about 6 seconds, or less than about 7 seconds, or less than about 8 seconds, or less than about 9 seconds, or less than about 10 seconds, or less than about 20 seconds, or less than about 30 seconds, or less than about 40 seconds, or less than about 50 seconds, or less than about 60 seconds, or less than about 2 minutes, or less than about 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the curing time for the processes of the disclosure may be greater than about 1 second, or greater than about 2 seconds, or greater than about 3 seconds, or greater than about 4 seconds, or greater than about 5 seconds, or greater than about 6 seconds, or greater than about 7 seconds, or greater than about 8 seconds, or greater than about 9 seconds, or greater than about 10 seconds, or greater than about 20 seconds, or greater than about 30 seconds, or greater than about 40 seconds, or greater than about 50 seconds, or greater than about 60 seconds, or greater than about 2 minutes, or greater than about 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In some embodiments, a silk fibroin processed or coated material may be heat resistant to a selected temperature where the selected temperature is chosen for drying, curing, and/or heat setting a dye that may be applied to the material (e.g., a coated leather or leather article). As used herein, a “heat resistant” may refer to a property of the silk fibroin coating deposited on the material where the silk fibroin coating and/or silk fibroin protein does not exhibit a substantial modification (i.e., “substantially modifying”) in silk fibroin coating performance as compared to a control material having a comparable silk fibroin coating that was not subjected to the selected temperature for drying, curing, wash cycling, and/or heat setting purposes. In some embodiments, the selected temperature is the glass transition temperature (Tg) for the material upon which the silk fibroin coating is applied. In some embodiments, the selected temperature is greater than about 65° C., or greater than about 70° C., or greater than about 80° C., or greater than about 90° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 65° C., or less than about 70° C., or less than about 80° C., or less than about 90° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In some embodiments, the SFS processed, coated, or repaired article may be subjected to heat setting in order to set one or more dyes that may be applied to the SFS coated article in order to permanently set the one or more dyes on the SFS coated or repaired article. In some embodiments, the SFS processed, coated, or repaired article may be heat setting resistant, wherein the SFS coating on the SFS coated article may resist a heat setting temperature of greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In an embodiment, a material processed, coated, or repaired by the silk fibroin coating or filling composition as described herein may partially dissolved or otherwise partially incorporated within a portion of the material after the silk fibroin coated or repaired material is subjected to heating and/or curing as described herein. Without being limited to any one theory, where the silk fibroin processed, coated, or repaired material is heated to greater than about the glass transition temperature (Tg) for the material that is processed, coated, or repaired, the silk fibroin coating may become partially dissolved or otherwise partially incorporated within a portion of the material.

In some embodiments, a material processed, coated, or repaired by the silk fibroin coating as described herein may be sterile or may be sterilized to provide a sterilized silk fibroin coated material. Alternatively, or in addition thereto, the methods described herein may include a sterile SFS prepared from sterile silk fibroin.

In some embodiments, SFS may be used in an SFS processing composition, coating, or repairing composition, where such composition or coating includes one or more chemical agents (e.g., a silicone). SFS may be provided in such an SFS coating at a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.01%, or less than about 0.001%. In some embodiments, SFS may be provided in such an SFS coating at a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 11%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.10%, or greater than about 0.01%, or greater than about 0.001%.

In some embodiments, chemical fabric softeners may include silicones as described herein.

In some embodiments, the chemical agents may include the following, which are supplied by CHT Bezema and are associated with certain selected leather's or leather article's properties, which may be used to strengthen SFS binding on coated or repaired surfaces and/or SFS may be used for enhancing the following chemical agents' properties.

### Alpaprint Clear

Silicone printing and coating
Component B is mentioned in the technical leaflet
Dry handle
Good rubbing fastness
Good washfastness

### Alpaprint Elastic Add

Silicone printing and coating
Component B is mentioned in the technical leaflet
Good rubbing fastness
Good washfastness
Suited for yardage printing

### Alpaprint White

Silicone printing and coating
Component B is mentioned in the technical leaflet
Dry handle
Good rubbing fastness
Good washfastness

### Alpatec 30142 A

Textile finishing
Coating
Silicone printing and coating
Component B is mentioned in the technical leaflet
Suitable for narrow ribbon coating
Good rubbing fastness
Good washfastness

### Alpatec 30143 A

Silicone printing and coating
Component B is mentioned in the technical leaflet
Good rubbing fastness
Good washfastness
Suited for yardage printing

### Alpatec 30191 A

Silicone printing and coating
Component B is mentioned in the technical leaflet
Suitable for narrow ribbon coating
High transparency
Coating

### Alpatec 30203 A

Silicone printing and coating
Component B is mentioned in the technical leaflet
Suitable for narrow ribbon coating
High transparency
Coating
   Alpatec 3040 Lsr Komp. A
Functional coatings, Silicone printing and coating
Component B is mentioned in the technical leaflet
High abrasion resistance
High transparency
Coating
   Alpatec 3060 Lsr Komp. A
Functional coatings, Silicone printing and coating
Component B is mentioned in the technical leaflet
High abrasion resistance
High transparency
Coating

### Alpatec 530

Silicone printing and coating
Suitable for narrow ribbon coating
High transparency
Coating
One component system

### Alpatec 540

Silicone printing and coating
Suitable for narrow ribbon coating
High transparency
Coating
One component system

### Alpatec 545

Silicone printing and coating
Suitable for narrow ribbon coating
High transparency
Coating
One component system

### Alpatec 550

Silicone printing and coating
Suitable for narrow ribbon coating
High transparency
Coating
One component system

### Alpatec 730

Silicone printing and coating
Suitable for narrow ribbon coating
Good washfastness
High abrasion resistance
High transparency

### Alpatec 740

Silicone printing and coating
Suitable for narrow ribbon coating
Good washfastness
High abrasion resistance
High transparency

### Alpatec 745

Silicone printing and coating
Suitable for narrow ribbon coating
Good washfastness
High abrasion resistance
High transparency

### Alpatec 750

Silicone printing and coating
Suitable for narrow ribbon coating
Good washfastness
High abrasion resistance
High transparency

### Alpatec Bandage A

Silicone printing and coating
Component B is mentioned in the technical leaflet
Suitable for narrow ribbon coating
Coating
Two component system

### Apyrol Base2 E

Flame retardants
Liquid
Soft handle
For BS 5852/1+2
Suited for paste coating

### Apyrol FCR-2

Water repellency/oil repellency
Cationic
High effectiveness
Water-based
Liquid

### Apyrol FFD E

Flame retardants
Liquid
Suited for polyester
Suited for polyamide
Flame inhibiting filler

### Apyrol FR Conc E

Flame retardants, Functional coatings
Liquid
Suited for polyester
Suited for polyamide
Flame inhibiting filler

### Apyrol GBO-E

Flame retardants, Functional coatings
Suited for polyester
Black-out coating
For DIN 4102/B1
Containing halogen

### Apyrol LV 21

Flame retardants, Functional coatings
For DIN 4102/B1
Suited for paste coating
Suited for backcoating of black-out vertical blinds and roller blinds
Containing halogen

### Apyrol PP 31

Flame retardants
Liquid
Free from antimony
Flame inhibiting filler
For BS 5852/1+2

### Apyrol PP 46

Flame retardants
Powder
Free from antimony
Flame inhibiting filler
Suited for paste coating

### Apyrol Prem E

Flame retardants
Soft handle
For BS 5852/1+2
Containing halogen
Semi-permanent

### Apyrol Prem2 E

Flame retardants
Soft handle
For BS 5852/1+2
Containing halogen
Semi-permanent

### Colordur 005 White

Flock adhesives, Functional coatings, Silicone printing and coating
Based on silicone
Dyestuff pigment suspension

### Colordur 105 Lemon

Flock adhesives, Functional coatings, Silicone printing and coating
Based on silicone
Dyestuff pigment suspension

### Colordur 115 Golden Yellow

Flock adhesives, Functional coatings, Silicone printing and coating
Based on silicone
Dyestuff pigment suspension

### Colordur 185 Orange

Flock adhesives, Functional coatings, Silicone printing and coating
Based on silicone
Dyestuff pigment suspension

### Colordur 215 Red

Flock adhesives, Functional coatings, Silicone printing and coating
Based on silicone
Dyestuff pigment suspension

### Colordur 225 Dark Red

Flock adhesives, Functional coatings, Silicone printing and coating
Based on silicone
Dyestuff pigment suspension

### Colordur 285 Violet

Flock adhesives, Functional coatings, Silicone printing and coating
Based on silicone
Dyestuff pigment suspension

### Colordur 305 Blue

Flock adhesives, Functional coatings, Silicone printing and coating
Based on silicone
Dyestuff pigment suspension

### Colordur 355 Marine

Flock adhesives, Functional coatings, Silicone printing and coating
Based on silicone
Dyestuff pigment suspension

### Colordur 405 Green

Flock adhesives, Functional coatings, Silicone printing and coating
Based on silicone
Dyestuff pigment suspension

### Colordur 465 Olive Green

Flock adhesives, Functional coatings, Silicone printing and coating
Based on silicone
Dyestuff pigment suspension

### Colordur 705 Black

Flock adhesives, Functional coatings, Silicone printing and coating
Based on silicone
Dyestuff pigment suspension

### Colordur Am Additive

Flock adhesives, Silicone printing and coating
Based on silicone
Migration prevention
Dyestuff pigment suspension

### Colordur FL 1015 Yellow

Flock adhesives, Functional coatings, Silicone printing and coating
Based on silicone
Dyestuff pigment suspension

### Colordur FL 1815 Orange

Flock adhesives, Functional coatings, Silicone printing and coating
Based on silicone
Dyestuff pigment suspension

### Colordur FL 2415 Pink

Flock adhesives, Functional coatings, Silicone printing and coating
Based on silicone
Dyestuff pigment suspension

### Colordur FL 4015 Green

Flock adhesives, Functional coatings, Silicone printing and coating
Based on silicone
Dyestuff pigment suspension

### Ecoperl 1

Water repellency/oil repellency
Washfast
Sprayable
Based on special functionalised polymers/waxes
Cationic

### Ecoperl Active

Water repellency/oil repellency
Washfast
Based on special functionalised polymers/waxes
Cationic
High effectiveness

### Lamethan 1 ET 25 BR 160

Functional coatings, Lamination
Washfast
Transparent
25 μm strong
Film based on polyester urethane

### Lamethan ADH-1

Functional coatings, Lamination
Breathable
Suited for dry laminating
Good stability to washing at 40° C.
Stable foam adhesive

### Lamethan ADH-L

Functional coatings, Lamination
Washfast
Transparent
Suited for paste coating
Suited for wet laminating

### Lamethan ALF-K

Functional coatings, Lamination
Adhesive additive for bondings
Suited for dry laminating
Stable foam adhesive
Suited for stable foam coating

### Lamethan LB 15-T BR 152DK

Functional coatings, Lamination
Transparent
15 μm strong
Breathable
Suited for dry laminating

### Lamethan LB 25 BR 155

Functional coatings, Lamination
Transparent
25 μm strong
Suited for dry laminating
Good stability to washing at 40° C.

### Lamethan LB 25 W BR 152

Lamination
25 μm strong
Breathable
Suited for dry laminating
Good stability to washing at 40° C.

### Lamethan Tape DE 80

Functional coatings, Lamination
Polymer base: polyurethane
Transparent
Good stability to washing at 40° C.
Tape for seam sealing

### Lamethan Tape ME 160

Functional coatings, Lamination
Polymer base: polyurethane
Transparent
Good stability to washing at 40° C.
Tape for seam sealing

### Lamethan VL-H920 O BR150

Functional coatings, Lamination
Two coats with membrane and PES charmeuse
Breathable
Suited for dry laminating
Good stability to washing at 40° C.

### Lamethan VL-H920 S BR 150

Functional coatings, Lamination
Two coats with membrane and PES charmeuse
Breathable
Suited for dry laminating
Good stability to washing at 40° C.

### Lamethan VL-H920 W BR150

Functional coatings, Lamination
Two coats with membrane and PES charmeuse
Breathable
Suited for dry laminating
Good stability to washing at 40° C.

### Tubicoat A 12 E

Binders, Functional coatings
Anionic
Liquid
Formaldehyde-free
Polymer base: polyacrylate

### Tubicoat A 17

Binders, Functional coatings
Suitable for tablecloth coating
Anionic
Liquid
Self-crosslinking

### Tubicoat A 19

Binders, Functional coatings
Washfast
Anionic
Formaldehyde-free
Good stability to washing

### Tubicoat A 22

Binders, Functional coatings
Washfast
Medium-hard film
Anionic
Liquid

### Tubicoat A 23

Binders
Medium-hard film
Anionic
Liquid
Application for varying the handle

### Tubicoat A 28

Binders, Functional coatings
Anionic
Liquid
Formaldehyde-free
Good stability to washing

### Tubicoat A 36

Binders, Functional coatings
Washfast
Anionic
Liquid
Low formaldehyde

### Tubicoat A 37

Binders, Functional coatings
Washfast
Suitable for tablecloth coating
Anionic
Liquid

### Tubicoat A 41

Binders, Functional coatings
Anionic
Liquid
Self-crosslinking
Good fastnesses

### Tubicoat A 61

Binders, Functional coatings
Suitable for tablecloth coating
Liquid
Non-ionic
Self-crosslinking

### Tubicoat A 94

Binders, Functional coatings
Anionic
Liquid
Self-crosslinking
Good fastnesses

### Tubicoat AIB 20

Fashion coatings
Transparent
Suited for foam coating
Pearl Gloss Finish

### Tubicoat AOS

Foaming auxiliaries
Non-ionic
Foaming
Suited for the fluorocarbon finishing

### Tubicoat ASK

Functional coatings, Lamination
Adhesive additive for bondings
Transparent
Suited for paste coating
Suited for dry laminating

### Tubicoat B-H

Binders, Functional coatings
Polymer base: Styrene butadiene
Anionic
Liquid
Formaldehyde-free

### Tubicoat B 45

Binders, Functional coatings
Washfast
Polymer base: Styrene butadiene
Anionic
Liquid

### Tubicoat BO-NB

Functional coatings
Medium hard
Suited for black-out coating
Good flexibility at low temperatures
Suited for stable foam coating

### Tubicoat BO-W

Functional coatings
Suited for black-out coating
Impermeable for light
Suited for stable foam coating
Water vapour permeable

### Tubicoat BOS

Foaming auxiliaries
Anionic
Foaming
Foam stabilizer

### Tubicoat DW-FI

Functional coatings, Special products
Anionic
Suited for coating pastes
Suited for stable foam
Foamable

### Tubicoat E 4

Binders
Anionic
Self-crosslinking
Low formaldehyde
Polymer base: polyethylene vinyl acetate

### Tubicoat ELC

Functional coatings
Suited for paste coating
Black
Electrically conductive
Soft

### Tubicoat Emulgator HF

Functional coatings, Special products
Anionic
Dispersing
Suited for coating pastes
Suited for stable foam

### Tubicoat Entschaumer N

Defoamers and deaerators
Liquid
Non-ionic
Silicone-free
Suited for coating pastes

### Tubicoat FIX FC

Fixing agents
Cationic
Water-based
Liquid
Formaldehyde-free

### Tubicoat Fix ICB CONC.

Fixing agents
Liquid
Non-ionic
Formaldehyde-free
Suited for crosslinking

### Tubicoat Fixierer AZ

Fixing agents
Liquid
Suited for crosslinking
Based on polyaziridin
Unblocked

### Tubicoat Fixierer FA

Fixing agents
Anionic
Water-based
Liquid
Low formaldehyde

### Tubicoat Fixierer H 24

Fixing agents
Anionic
Water-based
Liquid
Formaldehyde-free

### Tubicoat Fixierer HT

Fixing agents
Water-based
Liquid
Non-ionic
Suited for crosslinking

### Tubicoat Foamer NY

Foaming auxiliaries
Non-ionic
Foaming
Suited for the fluorocarbon finishing
Non-yellowing

### Tubicoat GC PU

Fashion coatings
Washfast
Soft handle
Polymer base: polyurethane
Transparent

### Tubicoat GRIP

Functional coatings
Slip resistant
Suited for stable foam coating
Soft

### Tubicoat HEC

Thickeners
Powder
Non-ionic
Stable to electrolytes
Stable to shear forces

### Tubicoat HOP-S

Special products
Anionic
Suited for coating pastes
Coating
Adhesion promoter

### Tubicoat HS 8

Binders
Anionic
Liquid
Formaldehyde-free
Hard film

### Tubicoat HWS-1

Functional coatings
Suited for paste coating
Water-proof
Suited for giant umbrellas and tents

### Tubicoat KL-TOP F

Fashion coatings, Functional coatings
Washfast
Polymer base: polyurethane
Transparent
Suited for paste coating

### Tubicoat KLS-M

Fashion coatings, Functional coatings
Washfast
Soft handle
Polymer base: polyurethane
Breathable

### Tubicoat MAF

Fashion coatings
Washfast
Matrix effect
Improves the rubbing fastnesses
Soft handle

### Tubicoat MD TC 70

Fashion coatings
Vintage wax
Suited for foam coating
Suited for topcoats

### Tubicoat MEA

Functional coatings
Washfast
Polymer base: polyurethane
Suited for paste coating
Suited for topcoat coatings

### Tubicoat MG-R

Fashion coatings
Washfast
Soft handle
Suited for paste coating
Duo Leather Finish

### Tubicoat MOP NEU

Functional coatings, Special products
Washfast
Anionic
Foamable
Finish

### Tubicoat MP-D

Fashion coatings, Functional coatings
Washfast
Soft handle
Medium hard
Breathable

### Tubicoat MP-W

Functional coatings
Washfast
Polymer base: polyurethane
Breathable
Water-proof

### Tubicoat NTC-SG

Functional coatings
Washfast
Transparent
Suited for paste coating
Medium hard

### Tubicoat PERL A22-20

Fashion coatings
Suited for paste coating
Suited for foam coating
Pearl Gloss Finish

### Tubicoat PERL HS-1

Functional coatings
Suited for paste coating
Suited for black-out coating
Suited for pearlescent coating
Suited for topcoat coatings

### Tubicoat PERL PU SOFT

Fashion coatings
Washfast
Scarabaeus effect
Soft handle
Polymer base: polyurethane

### Tubicoat PERL VC CONC.

Fashion coatings, Functional coatings
Soft handle
Polymer base: polyurethane
Suited for paste coating
Suited for black-out coating

### Tubicoat PHV

Functional coatings
Medium hard
Suited for three-dimensional dot coating

### Tubicoat PSA 1731

Functional coatings, Lamination
Transparent
Suited for paste coating
Suited for dry laminating
Non-breathable

### Tubicoat PU-UV

Binders
Anionic
Liquid
Formaldehyde-free
Good fastnesses

### Tubicoat PU 60

Binders
Anionic
Liquid
Application for varying the handle
Formaldehyde-free

### Tubicoat PU 80

Binders, Functional coatings
Washfast
Anionic
Liquid
Can be washed off

### Tubicoat PUH-BI

Binders
Anionic
Liquid
Formaldehyde-free
Hard film

### Tubicoat PUL

Functional coatings
Polymer base: polyurethane
Suited for paste coating
Suited for three-dimensional dot coating
Slip resistant

### Tubicoat PUS

Binders, Functional coatings
Anionic
Liquid
Formaldehyde-free
Polymer base: polyurethane

### Tubicoat PUW-M

Binders
Medium-hard film
Anionic
Liquid
Formaldehyde-free

### Tubicoat PUW-S

Binders
Anionic
Liquid
Formaldehyde-free
Good stability to washing

### Tubicoat PW 14

Binders, Functional coatings
Anionic
Formaldehyde-free
Heat-sealable
Not wetting

### Tubicoat SA-M

Functional coatings
Washfast
Suited for paste coating
Suited for three-dimensional dot coating

### Tubicoat Schaumer HP

Foaming auxiliaries, Functional coatings
Non-ionic
Foaming
Suited for the fluorocarbon finishing

### Tubicoat SF-BASE

Fashion coatings
Washfast
Soft handle
Suited for foam coating
Silk gloss effect

### Tubicoat SHM

Foaming auxiliaries
Anionic
Foam stabilizer

### Tubicoat SI 55

Special products
Pseudo-cationic
Suited for coating pastes
Foamable
Coating

### Tubicoat Stabilisator RP

Foaming auxiliaries
Anionic
Foam stabilizer

### Tubicoat STC 100

Fashion coatings, Functional coatings
Transparent
Breathable
Suited for stable foam coating

### Tubicoat STC 150

Fashion coatings, Functional coatings
Washfast
Soft handle
Transparent
Breathable

### Tubicoat STL

Functional coatings
Washfast
Slip resistant
Suited for stable foam coating
Soft

### Tubicoat TCT

Fashion coatings, Functional coatings
Washfast
Polymer base: polyurethane
Transparent
Suited for paste coating

### Tubicoat VA 10

Binders
Anionic
Liquid
Formaldehyde-free
Hard film

### Tubicoat VCP

Functional coatings
Suited for paste coating
Medium hard
Suited for black-out coating

### Tubicoat VERDICKER 17

Thickeners
Anionic
High efficiency
Synthetic

### Tubicoat VERDICKER ASD

Thickeners
Anionic
Quick swelling
Stable to shear forces
Pseudoplastic

### Tubicoat VERDICKER LP

Thickeners
Anionic
Stable to shear forces
Pseudoplastic
Dispersible

### Tubicoat VERDICKER PRA

Thickeners
Anionic
Liquid
Stable to electrolytes
Rheological additive

### Tubicoat WBH 36

Special products
Finish
Application for preventing roller deposits

### Tubicoat WBV

Special products
Non-ionic
Finish
Application for preventing roller deposits

### Tubicoat Weiss EU

Functional coatings, Special products
Suited for coating pastes
Suited for stable foam
Suited for topcoat coatings
Titanium dioxide paste

### Tubicoat WLI-LT KONZ

Functional coatings
Washfast
Suited for paste coating
Slip resistant
Soft

### Tubicoat WLI

Fashion coatings, Functional coatings
Washfast
Scarabaeus effect
Soft handle
Suited for paste coating

### Tubicoat WOT

Fashion coatings
Washfast
Soft handle
Suited for paste coating
Wash-out effect

### Tubicoat WX-TCA 70

Fashion coatings, Functional coatings
Vintage wax
Suited for paste coating
Suited for topcoat coatings

### Tubicoat WX BASE

Fashion coatings
Vintage wax
Soft handle
Suited for paste coating
Application in the prime coat

### Tubicoat ZP NEU

Water repellency/oil repellency
Zircon-paraffine base
Suited for aqueous systems
Cationic
Foamable

### Tubiguard 10-F

Water repellency/oil repellency
Washfast
Sprayable
Cationic
Liquid

### Tubiguard 21

Water repellency/oil repellency
Washfast
Cationic
High effectiveness
Water-based

### Tubiguard 25-F

Water repellency/oil repellency
Washfast
Sprayable
Cationic
High effectiveness

### Tubiguard 270

Functional coatings, Water repellency/oil repellency
Washfast
Cationic
High effectiveness
Liquid

### Tubiguard 30-F

Water repellency/oil repellency
Washfast
Sprayable
Cationic
High effectiveness

### Tubiguard 44 N

Water repellency/oil repellency
Washfast
Sprayable
Suited for aqueous systems
Liquid

### Tubiguard 44N-F

Water repellency/oil repellency
Suited for aqueous systems
Non-ionic
Suited for polyester
Foamable

### Tubiguard 66

Water repellency/oil repellency
Washfast
Sprayable
High effectiveness
Liquid

### Tubiguard 90-F

Water repellency/oil repellency
Washfast
Cationic
High effectiveness
Liquid

### Tubiguard AN-F

Water repellency/oil repellency
Washfast
Sprayable
Cationic
High effectiveness

### Tubiguard FA2-F

Water repellency/oil repellency
Sprayable
Cationic
Suited for polyester
Foamable

### Tubiguard PC3-F

Functional coatings, Water repellency/oil repellency
Washfast
Cationic
Liquid
Paste

### Tubiguard SR 2010-F W

Water repellency/oil repellency
Cationic
High effectiveness
Foamable
Based on C6 fluorocarbon

In some embodiments, the chemical agents may include the following, which are supplied by CHT Bezema and are associated with certain selected leather or leather article) properties, which may be used to strengthen SFS binding to inkjet printing dye:
CHT-ALGINAT MVU
   Ink jet printing preparation, Thickeners
   Cationic
   Powder
   Anionic
   High colour brilliance
PRISULON CR-F 50
   Ink jet printing preparation, Thickeners
   Liquid
   Good outlines
   High surface levelness
   Good penetration
TUBIJET DU 01
   Ink jet printing preparation
   Antimigrant
   Anionic
   Liquid
   Formaldehyde-free
TUBIJET NWA
   Ink jet printing preparation
   Liquid
   Non-ionic
   Without impact on the handle
   Formaldehyde-free
TUBIJET PUS
   Ink jet printing preparation
   Film forming
   Anionic
   Liquid
   Formaldehyde-free
TUBIJET VDK
   Ink jet printing preparation
   Liquid
   Formaldehyde-free
   Halogen-free
   Flame protection effect
TUBIJET WET
   Ink jet printing preparation
   Anionic
   Liquid
   Without impact on the handle
   Formaldehyde-free

In some embodiments, the chemical agents of the disclosure may include the following inkjet printing dyes, which are supplied by CHT Bezema and are associated with certain selected leather or leather article properties, which may be used in combination with SFS:
BEZAFLUOR BLUE BB
   Pigments
   High Performance
   BEZAFLUOR (fluorescent pigments)
BEZAFLUOR GREEN BT
   Pigments
   High Performance
   BEZAFLUOR (fluorescent pigments)
BEZAFLUOR ORANGE R
   Pigments
   High Performance
   BEZAFLUOR (fluorescent pigments)
BEZAFLUOR PINK BB
   Pigments
   High Performance
   BEZAFLUOR (fluorescent pigments)
BEZAFLUOR RED R
   Pigments
   High Performance
   BEZAFLUOR (fluorescent pigments)
BEZAFLUOR VIOLET BR
   Pigments
   High Performance
   BEZAFLUOR (fluorescent pigments)
BEZAFLUOR YELLOW BA
   Pigments
   High Performance
   BEZAFLUOR (fluorescent pigments)
BEZAPRINT BLACK BDC
   Pigments
   Advanced
   BEZAPRINT (classic pigments)
BEZAPRINT BLACK DT
   Pigments
   Advanced
   BEZAPRINT (classic pigments)
BEZAPRINT BLACK DW
   Pigments
   Advanced
   BEZAPRINT (classic pigments)
BEZAPRINT BLACK GOT
   Pigments
   High Performance
   BEZAKTIV GOT (GOTS)
BEZAPRINT BLUE BN
   Pigments
   Advanced
   BEZAPRINT (classic pigments)
BEZAPRINT BLUE BT
   Pigments
   Advanced
   BEZAPRINT (classic pigments)
BEZAPRINT BLUE GOT
   Pigments
   High Performance
   BEZAKTIV GOT (GOTS)
BEZAPRINT BLUE RR
   Pigments
   Advanced
   BEZAPRINT (classic pigments)
BEZAPRINT BLUE RT
   Pigments
   Advanced
   BEZAPRINT (classic pigments)
BEZAPRINT BLUE RTM
   Pigments
   Advanced
   BEZAPRINT (classic pigments)
BEZAPRINT BLUE TB
   Pigments
   Advanced
   BEZAPRINT (classic pigments)
BEZAPRINT BORDEAUX K2R
   Pigments
   Advanced
   BEZAPRINT (classic pigments)
BEZAPRINT BROWN RP
   Pigments
   Advanced
   BEZAPRINT (classic pigments)
BEZAPRINT BROWN TM
   Pigments
   Advanced
   BEZAPRINT (classic pigments)
BEZAPRINT CITRON 10G
   Pigments
   Advanced
   BEZAPRINT (classic pigments)
BEZAPRINT CITRON GOT
   Pigments
   High Performance
   BEZAKTIV GOT (GOTS)
BEZAPRINT GREEN 2B
   Pigments
   Advanced
   BEZAPRINT (classic pigments)
BEZAPRINT GREEN BS
   Pigments
   Advanced
   BEZAPRINT (classic pigments)
BEZAPRINT GREEN BT
   Pigments
   Advanced
   BEZAPRINT (classic pigments)
BEZAPRINT GREY BB
   Pigments
   Advanced
   BEZAPRINT (classic pigments)
BEZAPRINT NAVY GOT
   Pigments
   High Performance
   BEZAKTIV GOT (GOTS)
BEZAPRINT NAVY RRM
   Pigments
   Advanced
   BEZAPRINT (classic pigments)
BEZAPRINT NAVY TR
   Pigments
   Advanced
   BEZAPRINT (classic pigments)
BEZAPRINT OLIVE GREEN BT
   Pigments
   Advanced
   BEZAPRINT (classic pigments)
BEZAPRINT ORANGE 2G
   Pigments
   Advanced
   BEZAPRINT (classic pigments)
BEZAPRINT ORANGE GOT
   Pigments
   High Performance
   BEZAKTIV GOT (GOTS)
BEZAPRINT ORANGE GT
   Pigments
   Advanced
   BEZAPRINT (classic pigments)
BEZAPRINT ORANGE RG
   Pigments
   Advanced
   BEZAPRINT (classic pigments)
BEZAPRINT PINK BW
   Pigments
   Advanced
   BEZAPRINT (classic pigments)
BEZAPRINT RED 2BN
   Pigments
   Advanced
   BEZAPRINT (classic pigments)
BEZAPRINT RED GOT
   Pigments High Performance BEZAKTIV GOT (GOTS)
BEZAPRINT RED KF
   Pigments
   Advanced
   BEZAPRINT (classic pigments)
BEZAPRINT RED KGC
   Pigments
   Advanced
   BEZAPRINT (classic pigments)
BEZAPRINT SCARLET GRL
   Pigments
   Advanced
   BEZAPRINT (classic pigments)
BEZAPRINT SCARLET RR
   Pigments
   Advanced
   BEZAPRINT (classic pigments)
BEZAPRINT TURQUOISE GT
   Pigments
   Advanced
   BEZAPRINT (classic pigments)
BEZAPRINT VIOLET FB
   Pigments
   Advanced
   BEZAPRINT (classic pigments)
BEZAPRINT VIOLET KB
   Pigments
   Advanced
   BEZAPRINT (classic pigments)
BEZAPRINT VIOLET R
   Pigments
   Advanced
   BEZAPRINT (classic pigments)
BEZAPRINT VIOLET TN
   Pigments
   Advanced
   BEZAPRINT (classic pigments)
BEZAPRINT YELLOW 2GN
   Pigments
   Advanced
   BEZAPRINT (classic pigments)
BEZAPRINT YELLOW 3GT
   Pigments
   Advanced
   BEZAPRINT (classic pigments)
BEZAPRINT YELLOW 4RM
   Pigments
   Advanced
   BEZAPRINT (classic pigments)
BEZAPRINT YELLOW GOT
   Pigments High Performance BEZAKTIV GOT (GOTS)
BEZAPRINT YELLOW RR
   Pigments
   Advanced
   BEZAPRINT (classic pigments)

In some embodiments, the chemical agents of the disclosure may include the following, which are supplied by Lamberti SPA and are associated with certain selected leather or leather article properties, which may be used to strengthen SFS binding on coated or repaired surfaces or SFS may be used for enhancing such chemical agent properties:

### Pre Treatment:

### Waterborne Polyurethanes Dispersions

Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

### Oil and Water Repellents

Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3
   Wetting agent for water-and oil repellent finishing.
Lamgard EXT.
   Crosslinker for fluorocarbon resins to improve washing fastness.

### Flame Retardants

Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers.

### Crosslinkers

Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polvisocyanate suitable as crosslinking agent for acrylic and polyurethane dispersions to improve adhesion and wet and dry scrub resistance.
Resina MEL.
   Melamine-formaldehyde resin.
Cellofix VLF.
   Low formaldehyde melamine resin.

### Thickeners

Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior
Viscolam 1022.
   Nonionic polyurethane based thickener with moderate pseudoplastic behavior.

### Dyeing

### Dispersing Agents

Lamegal BO.
   Liquid dispersing agent non ionic, suitable for direct, reactive, disperse dyeing and PES stripping
Lamegal DSP.
   Dispersing/anti back-staining agent in preparation, dyeing and soaping of dyed and printed materials. Antioligomer agent.
Lamegal 619.
   Effective low foam dispersing leveling agent for dyeing of PES
Lamegal TL5.
   Multi-purpose sequestring and dispersing agent for all kind of textile process

### Levelling Agents

Lamegal A 12.
   Leveling agent for dyeing on wool, polyamide and its blends with acid or metalcomplex dyes

### Fixing Agents

Lamfix L.
   Fixing agent for direct and reactive dyestuffs, containing formaldheyde
Lamfix LU conc.
   Formaldehyde free cationic fixing agent for direct and reactive dyes. It does not affect the shade and light fastness.
Lamfix PA/TR.
   Fixing agent to improve the wet fastness of acid dyes on polyamide fabrics, dyed or printed and polyamide yarns. Retarding agent in dyeing of Polyamide/cellulosic blends with direct dyes.

### Special Resins

Denifast TC.
   Special resin for cationization of cellulose fibers to obtain special effects (“DENIFAST system” and “DENISOL system”).
Cobral DD/50.
   Special resin for cationization of cellulose fibers to obtain special effect (“DENIFAST system” and “DENISOL system”).

### Antireducing Agents

Lamberti Redox L2S gra.
   Anti-reducing agent in grain form. 100% active content
Lamberti Redox L2S liq.
   Anti-reducing agent in liquid form for automatic dosage.

### Anticreasing Agent

Lubisol AM.
   Lubricating and anti creasing agent for rope wet operation on all kind of fibers and machines.

### Pigment Dye

### Antimigrating Agent

Neopat Compound 96/m conc.
   Compound, developed as migration inhibitor for continuous dyeing process with pigments (pad-dry process).

### Binding Agent

Neopat Binder PM/S conc.
   Concentrated version of a specific binder used to prepare pad-liquor for dyeing with pigments (pad-dry process).
      All in One agent
Neopat Compound PKl.
   High concentrated compound specifically developed as migration inhibitor with specific binder for continuous dyeing process with pigments (pad-dry process)all in one

### Delavé Agent

Neopat compound FTN.
   High concentrated compound of surfactants and polymers specifically developed for pigment dyeing and pigment-reactive dyeing process; especially for medium/dark shades for wash off effect

### Traditional Finishing Agents

### Wrinkle Free Treatment

Cellofix ULF conc.
   Anti-crease modified glyoxalic resin for finishing of cottons, cellulosics and blend with synthetics fibers.
Poliflex PO 40.
   Polyethilenic resin for waxy, full and slippy handle by foulard applications.
Rolflex WF.
   Aliphatic waterborned Nano-PU dispersion used as extender for wrinkle free treatments.

### Softeners

Texamina C/FPN.
   Cationic softening agent with a very soft handle particularly recommended for application by exhaustion for all kind of fabrics. Suitable also for cone application.
Texamina C SAL flakes.
   100% cationic softening agent in flakes form for all type of fabrics. Dispersible at room temperature.
Texamina CL LIQ.
   Anphoteric softening agent for all types of fabrics. Not yellowing.
Texamina HVO.
   Anphoteric softening agent for woven and knitted fabrics of cotton, other cellulosics and blends. Gives a soft, smooth and dry handle. Applied by padding.
Texamina SIL.
   Nonionic silicon dispersion in water. Excellent softening, lubricating and anti-static properties for all fibre types by padding.
Texamina SILK.
   Special cationic softener with silk protein inside. Gives a “swollen touch” particularly suitable for cellulosic, wool, silk.
Lamfinish LW.
   All-in compound based on special polymeric hydrophilic softeners; by coating, foulard, and exhaustion.
Elastolam E50.
   General purpose mono-component silicone elastomeric softener for textile finishing.
Elastolam EC 100.
   Modified polysiloxane micro-emulsion which gives a permanent finishing, with extremely soft and silky handle.

### Handle Modifier

Poliflex CSW.
   Cationic anti-slipping agent.
Poliflex R 75.
   Parafine finishing agent to give waxy handle.
Poliflex s.
   Compound specifically developed for special writing effects.
Poliflex m.
   Compound for special dry-waxy handle.
Lamsoft SW 24.
   Compound for special slippy handle specifically developed for coating application.
Lamfinish SLIPPY.
   All-in compound to get a slippy touch; by coating.
Lamfinish GUMMY.
   All-in compound to get a gummy touch; by coating.
Lamfinish OLDRY.
   All-in compound to get dry-sandy touch especially suitable for vintage effects; by coating

### Waterborne Polyurethanes Dispersions

Rolflex LB 2.
   Aliphatic waterborned PU dispersion particularly suggested for the formulation of textile coatings where bright and rigid top finish is required. It is particularly suitable as a finishing agent for organza touch on silk fabrics. Transparent and shiny.
Rolflex HP 51.
   Aliphatic waterborned PU dispersion particularly suggested for the formulation of textile coatings for outwear, luggage, technical articles especially where hard and flexible touch is required. Transparent and shiny.
Rolflex PU 879.
   Aliphatic waterborned PU dispersion particularly suggested for the formulation of textile coatings for outwear, luggage, technical articles where a medium-hard and flexible touch is required.
Rolflex ALM.
   Aliphatic waterborned PU dispersion particularly suggested for the fonnulation of textile coatings for outwear, luggage, technical articles where a soft and flexible touch is required. Can be also suitable for printing application.
Rolflex AP.
   Aliphatic waterborned PU dispersion particularly suggested for the formulation of textile coatings for outwear, fashion where a soft and gummy touch is required.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex K 110.
   Gives to the coated fabric a full, soft, and slightly sticky handle with excellent fastness on all types of fabrics.
Rolflex OP 80.
   Aliphatic waterborned PU dispersion particularly suggested for the formulation of textile coatings for outwear, luggage and fashion finishes where an opaque non writing effect is desired.
Rolflex NBC.
   Aliphatic waterborned PU dispersion generally used by padding application as a filling and zero formaldheyde sizing agent. Can be used for outwear and fashion finishings where a full, elastic and non sticky touch is required.
Rolflex PAD.
   Aliphatic waterborned PU dispersion specifically designed for padding application for outwear, sportswear and fashion applications where a full, elastic and non sticky touch is required. Excellent washing and dry cleaning fastness as well as good bath stability.
Rolflex PN.
   Aliphatic waterborned PU dispersion generally applied by padding application for outerwear and fashion high quality applications where strong, elastic non sticky finishes are required.
Elafix PV 4.
   Aliphatic blocked isocyanate Nano-dispersion used in order to give antifelting and antipilling properties to pure wool fabrics and his blend.
Rolflex SW3.
   Aliphatic waterborned PU dispersion particularly suggested to be used by padding application for the finishing of outwear, sportswear and fashion where a slippery and elastic touch is required. It is also a good antipilling agent. Excellent in wool application.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

### Other Resins

Textol 110.
   Handle modifier with very soft handle for coating finishes
Textol RGD.
   Water emulsion of acrylic copolymer for textile coating, with very rigid handle.
Textol SB 21.
   Butadienic resin for finishing and binder for textile printing Appretto PV/CC.
   Vinylacetate water dispersion for rigid stiffening Amisolo B.
   CMS water dispersion for textile finishing as stiffening agent Lamovil RP.
   PVOH stabilized solution as stiffening agent

### Technical Finishing Agents

### Waterborne Polyurethanes Dispersions

Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

### Oil and Water Repellents

Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3.
   Wetting agent for water-and oil repellent finishing.
Lamgard EXT.
   Crosslinker for fluorocarbon resins to improve washing fastness.

### Flame Retardants

Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers

### Crosslinkers

Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polvisocyanate suitable as crosslinking agent for acrylic and polyurethane dispersions to improve adhesion and wet and dry scrub resistance.
Resina MEL.
   Melammine-formaldheyde resin.
Cellofix VLF.
   Low formaldheyde malammine resin.

### Thickeners

Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior Viscolam 1022.
   Nonionic polyurethane based thickener with moderate pseudoplastic behavior.

In some embodiments, the chemical agent may include one or more of a silicone, an acidic agent, a dyeing agent, a pigment dye, a traditional finishing agent, and a technical finishing agent. The dyeing agent may include one or more of a dispersing agent, a levelling agent, a fixing agent, a special resin, an antireducing agent, and an anticreasing agent. The pigment dye may include one or more of an antimigrating agent, a binding agent, an all in one agent, and a delave agent. The traditional finishing agent may include one or more of a wrinkle free treatment, a softener, a handle modifier, a waterborne polyurethanes dispersion, and other resins. The technical finishing agent may include one or more of a waterborne polyurethanes dispersion, an oil repellant, a water repellant, a crosslinker, and a thickener.

In some embodiments, certain chemical agents of the disclosure may be provided by one or more of the following chemical suppliers: Adrasa, AcHitex Minerva, Akkim, Archroma, Asutex, Avocet dyes, BCC India, Bozzetto group, CHT, Clariant, Clearity, Dilube, Dystar, Eksoy, Erca group, Genkim, Giovannelli e Figli, Graf Chemie, Huntsman, KDN Bio, Lamberti, LJ Specialties, Marlateks, Montegauno, Protex, Pulcra Chemicals, Ran Chemicals, Fratelli Ricci, Ronkimya, Sarex, Setas, Silitex, Soko Chimica, Tanatex Chemicals, Union Specialties, Zaitex, Zetaesseti, and Z Schimmer.

In some embodiments, the chemical agent may include an acidic agent. Accordingly, in some embodiments, SFS may include an acidic agent. In some embodiments, an acidic agent may be a Bronsted acid. In an embodiment, the acidic agent includes one or more of citric acid and acetic acid. In an embodiment, the acidic agent aids the deposition and coating of SPF mixtures (i.e., SFS coating) on the leather or leather article to be coated as compared to the absence of such acidic agent. In an embodiment, the acidic agent improves crystallization of the SPF mixtures at the textile to be coated.

In an embodiment, the acidic agent is added at a concentration by weight (% w/w or % w/v) or by volume (v/v) of greater than about 0.001%, or greater than about 0.002%, or greater than about 0.003%, or greater than about 0.004%, or greater than about 0.005%, or greater than about 0.006%, or greater than about 0.007%, or greater than about 0.008%, or greater than about 0.009%, or greater than about 0.01%, or greater than about 0.02%, or greater than about 0.03%, or greater than about 0.04%, or greater than about 0.05%, or greater than about 0.06%, or greater than about 0.07%, or greater than about 0.08%, or greater than about 0.09%, or greater than about 0.10%, or greater than about 0.2%, or greater than about 0.3%, or greater than about 0.4%, or greater than about 0.5%, or greater than about 0.6%, or greater than about 0.7%, or greater than about 0.8%, or greater than about 0.9%, or greater than about 1.0% or greater than about 2.0%, or greater than about 3.0%, or greater than about 4.0%, or greater than about 5.0%.

In an embodiment, the acidic agent is added at a concentration by weight (% w/w or % w/v) or by volume (v/v) of less than about 0.001%, or less than about 0.002%, or less than about 0.003%, or less than about 0.004%, or less than about 0.005%, or less than about 0.006%, or less than about 0.007%, or less than about 0.008%, or less than about 0.009%, or less than about 0.01%, or less than about 0.02%, or less than about 0.03%, or less than about 0.04%, or less than about 0.05%, or less than about 0.06%, or less than about 0.07%, or less than about 0.08%, or less than about 0.09%, or less than about 0.1%, or less than about 0.2%, or less than about 0.3%, or less than about 0.4%, or less than about 0.5%, or less than about 0.6%, or less than about 0.7%, or less than about 0.8%, or less than about 0.9%, or less than about 1.0% or less than about 2.0%, or less than about 3.0%, or less than about 4.0%, or less than about 5.0%.

In some embodiments, SFS may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In some embodiments, SFS may include an acidic agent, and may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In an embodiment, the chemical agent may include silicone. In some embodiments, a SFS may include silicone. In some embodiments, the leather or leather article may be pretreated (i.e., prior to SFS application) or post-treated (i.e., after SFS application) with silicone.

In some embodiments, silicone may include a silicone emulsion.

The term “silicone,” may generally refer to a broad family of synthetic polymers, mixtures of polymers, and/or emulsions thereof, that have a repeating silicon-oxygen backbone including, but not limited to, polysiloxanes. In some embodiments, a silicone may include any silicone species disclosed herein.

Describing the compositions and coatings more broadly, silicone may be used, for example to improve hand, but may also increase the water repellency (or reduce water transport properties) of a material coated with silicone.

In some embodiments, SFS may include silicone in a concentration by weight (% w/w or % w/v) or by volume (v/v) of less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.010%, or less than about 0.0010%.

In some embodiments, SFS may include silicone in a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 1%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.1%, or greater than about 0.01%, or greater than about 0.001%.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 10%, or greater than about 0.1%, or greater than about 0.01%, or greater than about 0.001%, or greater than about 0.0001%, or greater than about 0.00001%.

In some embodiments, an SFS coating may include SFS, as described herein. In some embodiments, SFS may include a silicone and/or an acidic agent. In some embodiments, SFS may include a silicone and an acidic agent. In some embodiments, the SFS may include a silicone, an acidic agent, and/or an additional chemical agent, wherein the additional chemical agent may be one or more of the chemical agents described herein. In some embodiments, SFS may include a silicone emulsion and an acidic agent, such as acetic acid or citric acid.

In some embodiments, the coating processes of the disclosure may include a finishing step for the resulting coated materials. In some embodiments, the finishing or final finishing of the materials that are coated with SFS under the processes of the disclosure may include sueding, steaming, brushing, polishing, compacting, raising, tigering, shearing, heatsetting, waxing, air jet, calendaring, pressing, shrinking, treatment with polymerizer, coating, lamination, and/or laser etching. In some embodiments, finishing of the SFS coated materials may include treatment of the textiles with an AIRO® 24 dryer that may be used for continuous and open-width tumbling treatments of woven, non-woven, and knitted fabrics.

### Coating Performance Testing

In embodiments, the coating system described herein passes a wet color fastness rubbing test up to 600 cycles, passes an adhesive tape test, and passes a Bally flex test up to 20,000 cycles with no delamination observed. Some non-limiting examples of performance tests are further described below.

### Veslic Test/Color Fastness Rubbing Test

Dry rubbing color fastness refers to the situation of fading and staining of dyed fabric when rubbed with piece of cloth, felt, or something similar. Wet rubbing color fastness refers to the situation of fading and staining of dyed fabric when rubbed with piece of cloth, felt, or something similar which water content is 95% to 105%. In embodiments, the coating system described herein passes a Dry CFR test up to 1,000 cycles with a score of 5. In other words, little or no fading on the leather or staining on the rubbing material was observed up to 1,000 cycles. In embodiments, the coating system described herein passes a dry CFR test up to 1,000 cycles with a grade 5, up to 1,000 cycles with a grade 4, up to 1,000 cycles with a grade 3, up to 1,000 cycles with a grade 2, or up to 1,000 cycles with a grade 1. In embodiments, the coating system described herein passes a dry CFR test up to 900 cycles with a grade 5, up to 900 cycles with a grade 4, up to 900 cycles with a grade 3, up to 900 cycles with a grade 2, or up to 900 cycles with a grade 1. In embodiments, the coating system described herein passes a dry CFR test up to 800 cycles with a grade 5, up to 800 cycles with a grade 4, up to 800 cycles with a grade 3, up to 800 cycles with a grade 2, or up to 800 cycles with a grade 1. In embodiments, the coating system described herein passes a dry CFR test up to 700 cycles with a grade 5, up to 700 cycles with a grade 4, up to 700 cycles with a grade 3, up to 700 cycles with a grade 2, or up to 700 cycles with a grade 1. In embodiments, the coating system described herein passes a dry CFR test up to 600 cycles with a grade 5, up to 600 cycles with a grade 4, up to 600 cycles with a grade 3, up to 600 cycles with a grade 2, or up to 600 cycles with a grade 1. In embodiments, the coating system described herein passes a dry CFR test up to 500 cycles with a grade 5, up to 500 cycles with a grade 4, up to 500 cycles with a grade 3, up to 500 cycles with a grade 2, or up to 500 cycles with a grade 1. In embodiments, the coating system described herein passes a dry CFR test up to 400 cycles with a grade 5, up to 400 cycles with a grade 4, up to 400 cycles with a grade 3, up to 400 cycles with a grade 2, or up to 400 cycles with a grade 1. In embodiments, the coating system described herein passes a dry CFR test up to 300 cycles with a grade 5, up to 300 cycles with a grade 4, up to 300 cycles with a grade 3, up to 300 cycles with a grade 2, or up to 300 cycles with a grade 1. In embodiments, the coating system described herein passes a dry CFR test up to 200 cycles with a grade 5, up to 200 cycles with a grade 4, up to 200 cycles with a grade 3, up to 200 cycles with a grade 2, or up to 200 cycles with a grade 1. In embodiments, the coating system described herein passes a dry CFR test up to 100 cycles with a grade 5, up to 400 cycles with a grade 4, up to 100 cycles with a grade 3, up to 100 cycles with a grade 2, or up to 100 cycles with a grade 1. In embodiments, the coating system described herein passes a dry CFR test from 800 to 1000 cycles with a grade 5, from 800 to 1000 cycles with a grade 4, from 800 to 1000 cycles with a grade 3, from 800 to 1000 cycles with a grade 2, or from 800 to 1000 cycles with a grade 1. In embodiments, the coating system described herein passes a dry CFR test from 600 to 800 cycles with a grade 5, from 600 to 800 cycles with a grade 4, from 600 to 800 cycles with a grade 3, from 600 to 800 cycles with a grade 2, or from 600 to 800 cycles with a grade 1. In embodiments, the coating system described herein passes a dry CFR test from 500 to 600 cycles with a grade 5, from 500 to 600 cycles with a grade 4, from 500 to 600 cycles with a grade 3, from 500 to 600 cycles with a grade 2, or from 500 to 600 cycles with a grade 1. In embodiments, the coating system described herein passes a dry CFR test from 400 to 500 cycles with a grade 5, from 400 to 500 cycles with a grade 4, from 400 to 500 cycles with a grade 3, from 400 to 500 cycles with a grade 2, or from 400 to 500 cycles with a grade 1. In embodiments, the coating system described herein passes a dry CFR test from 500 to 1000 cycles with a grade 5, from 500 to 1000 cycles with a grade 4, from 500 to 1000 cycles with a grade 3, from 500 to 1000 cycles with a grade 2, or from 500 to 1000 cycles with a grade 1. In embodiments, the coating system described herein passes a dry CFR test from 100 to 500 cycles with a grade 5, from 100 to 500 cycles with a grade 4, from 100 to 500 cycles with a grade 3, from 100 to 500 cycles with a grade 2, or from 100 to 500 cycles with a grade 1.

In embodiments, the coating system described herein passes a Wet CFR test up to 600 cycles with a grade 5, up to 600 cycles with a grade 4, up to 600 cycles with a grade 3, up to 600 cycles with a grade 2, or up to 600 cycles with a grade 1. In embodiments, the coating system described herein passes a Wet CFR test up to 600 cycles with a grade 5, up to 600 cycles with a grade 4, up to 600 cycles with a grade 3, up to 600 cycles with a grade 2, or up to 600 cycles with a grade 1. In embodiments, the coating system described herein passes a Wet CFR test up to 500 cycles with a grade 5, up to 500 cycles with a grade 4, up to 500 cycles with a grade 3, up to 500 cycles with a grade 2, or up to 500 cycles with a grade 1. In embodiments, the coating system described herein passes a Wet CFR test up to 400 cycles with a grade 5, up to 400 cycles with a grade 4, up to 400 cycles with a grade 3, up to 400 cycles with a grade 2, or up to 400 cycles with a grade 1. In embodiments, the coating system described herein passes a Wet CFR test up to 300 cycles with a grade 5, up to 300 cycles with a grade 4, up to 300 cycles with a grade 3, up to 300 cycles with a grade 2, or up to 300 cycles with a grade 1. In embodiments, the coating system described herein passes a Wet CFR test (also referred to as Wet Veslic Test) up to 200 cycles with a grade 5, up to 200 cycles with a grade 4, up to 200 cycles with a grade 3, up to 200 cycles with a grade 2, or up to 200 cycles with a grade 1. In embodiments, the coating system described herein passes a Wet CFR test up to 100 cycles with a grade 5, up to 100 cycles with a grade 4, up to 100 cycles with a grade 3, up to 100 cycles with a grade 2, or up to 100 cycles with a grade 1. In embodiments, the coating system described herein passes a Wet CFR test up to 50 cycles with a grade 5, up to 50 cycles with a grade 4, up to 50 cycles with a grade 3, up to 50 cycles with a grade 2, or up to 50 cycles with a grade 1. In embodiments, the coating system described herein passes a Wet CFR test up to 20 cycles with a grade 5, up to 20 cycles with a grade 4, up to 20 cycles with a grade 3, up to 20 cycles with a grade 2, or up to 20 cycles with a grade 1. In embodiments, the coating system described herein passes a wet CFR test from 100 to 500 cycles with a grade 5, from 100 to 500 cycles with a grade 4, from 100 to 500 cycles with a grade 3, from 100 to 500 cycles with a grade 2, or from 100 to 500 cycles with a grade 1. In embodiments, the coating system described herein passes a wet CFR test from 500 to 600 cycles with a grade 5, from 500 to 600 cycles with a grade 4, from 500 to 600 cycles with a grade 3, from 500 to 600 cycles with a grade 2, or from 500 to 600 cycles with a grade 1. In embodiments, the coating system described herein passes a wet CFR test from 400 to 500 cycles with a grade 5, from 400 to 500 cycles with a grade 4, from 400 to 500 cycles with a grade 3, from 400 to 500 cycles with a grade 2, or from 400 to 500 cycles with a grade 1. In embodiments, the coating system described herein passes a wet CFR test from 200 to 400 cycles with a grade 5, from 200 to 400 cycles with a grade 4, from 200 to 400 cycles with a grade 3, from 200 to 400 cycles with a grade 2, or from 200 to 400 cycles with a grade 1. In embodiments, the coating system described herein passes a wet CFR test from 100 to 200 cycles with a grade 5, from 100 to 200 cycles with a grade 4, from 100 to 200 cycles with a grade 3, from 100 to 200 cycles with a grade 2, or from 100 to 200 cycles with a grade 1. In embodiments, the coating system described herein passes a wet CFR test from 10 to 100 cycles with a grade 5, from 10 to 100 cycles with a grade 4, from 10 to 100 cycles with a grade 3, from 10 to 100 cycles with a grade 2, or from 10 to 100 cycles with a grade 1.

### Bally Flex Test

A Bally Flex Test is conducted to determine leather flex resistance by flexing leather in a certain angle and speed. Samples are loaded into 12-Station Bally Flex Tester (Schap Specialty Machine) an subjected to cycles of flexing. In embodiments, the substrate and a coating system disclosed herein passes a Bally Flex test up to 1,000 cycles, up to 5,000 cycles, up to 10,000 cycles, up to 15,000 cycles, and up to 20,000 cycles with no delamination, in other words, there is no separation between the coating system and the substrate. In embodiments, the substrate and a coating system disclosed herein passes a Bally Flex test from 1,000 cycles to 5,000 cycles, from 5,000 cycles to 10,000 cycles, from 10.000 cycles to 15,000 cycles, or from 15,000 cycles to 20,000 cycles with no delamination.

### Adhesive Tape Test

In an adhesive tape test, a piece of tape (i.e. Scotch Tape) is applied to leather, pressed firmly by hand, then ripped off and inspected to see if any particles come off of leather. If no particles are seen on the tape, it can be inferred there was no delamination or separation observed between the substrate and coating. In embodiments of the present disclosure, no delamination was observed using 4 g/sqft L5267 and 6 g/sqft of L0822.

The following clauses describe certain embodiments.

Clause 1. An article comprising a leather substrate and silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

Clause 2. The article of clause 1, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

Clause 3. The article of clause 1 or 2, further comprising about 0.001% (w/w) to about 10% (w/w) sericin relative to the silk fibroin proteins or fragments thereof.

Clause 4. The article of any one of clauses 1 to 3, wherein the silk fibroin proteins or fragments thereof do not spontaneously or gradually gelate and do not visibly change in color or turbidity when in an aqueous solution for at least 10 days prior to being added to the leather substrate.

Clause 5. The article of any one of clauses 1 to 4, wherein a portion of the silk fibroin proteins or fragments thereof is coated on a surface of the leather substrate.

Clause 6. The article of any one of clauses 1 to 5, wherein a portion of the silk fibroin proteins or fragments thereof is infused into a layer of the leather substrate.

Clause 7. The article of any one of clauses 1 to 6, wherein a portion of the silk fibroin proteins or fragments thereof is in a recessed portion of the leather substrate.

Clause 8. The article of any one of clauses 1 to 7, the article further comprising one or more polysaccharides selected from starch, cellulose, gum arabic, guar gum, xanthan gum, alginate, pectin, chitin, chitosan, carrageenan, inulin, and gellan gum.

Clause 9. The article of clause 8, wherein the gellan gum comprises low-acyl content gellan gum.

Clause 10. The article of clause 8 or 9, wherein the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1. about 23:1. about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

Clause 11. The article of clause 8 or 9, wherein the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1. about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

Clause 12. The article of any one of clauses 1 to 11, the article further comprising one or more polyols, and/or one or more polyethers.

Clause 13. The article of clause 12, wherein the polyols comprise one or more of glycol, glycerol, sorbitol, D-sorbitol, glucose, sucrose, mannitol, D-mannitol, and dextrose.

Clause 14. The article of clause 12, wherein the polyethers comprise one or more polyethyleneglycols (PEGs).

Clause 15. The article of any one of clauses 12 to 14, wherein the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1. about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

Clause 16. The article of any one of clauses 1 to 15, the article further comprising one or more of a silicone, a dye, a pigment, and a polyurethane.

Clause 17. The article of any one of clauses 1 to 16, the article further comprising one or more of a crosslinker, a crosslinker adduct, or a crosslinker reaction derivative.

Clause 18. The article of any one of clauses 1 to 16, the article further comprising one or more of: an isocyanate, isocyanate adduct, and/or isocyanate reaction derivative; a poly diisocyanate, poly diisocyanate adduct, and/or poly diisocyanate reaction derivative; an aziridine, aziridine adduct, and/or aziridine reaction derivative; a carbodiimide, carbodiimide adduct, and/or carbodiimide reaction derivative; an aldehyde, aldehyde adduct, and/or aldehyde reaction derivative; a polyisocyanate, polyisocyanate adduct, and/or polyisocyanate reaction derivative; a polyaziridine, polyaziridine adduct, and/or polyaziridine reaction derivative; a poly carbodiimide, polycarbodiimide adduct, and/or polycarbodiimide reaction derivative; a polyaldehyde, polyaldehyde adduct, and/or polyaldehyde reaction derivative; a polyurethane, polyurethane adduct, and/or polyurethane reaction derivative; a polyacrylate, polyacrylate adduct, and/or polyacrylate reaction derivative; a polyester, polyester adduct, and/or polyester reaction derivative; a wax, wax adduct, and/or wax reaction derivative; a protein, protein adduct, and/or protein reaction derivative; or an alcohol, alcohol adduct, and/or alcohol reaction derivative.

Clause 19. A method of treating a leather substrate with a silk formulation, the method comprising applying on a surface of the leather a silk formulation comprising silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

Clause 20. The method of clause 19, wherein the silk fibroin proteins or fragments thereof have a polydispersity between 1 and about 1.5, between about 1.5 and about 2, between about 2 and about 2.5, between about 2.5 and about 3, between about 3 and about 3.5, between about 3.5 and about 4, between about 4 and about 4.5, or between about 4.5 and about 5.

Clause 21. The method of clause 19 or 20, wherein the silk formulation further comprises about 0.0010% (w/w) to about 10% (w/w) sericin relative to the silk fibroin proteins or fragments thereof.

Clause 22. The method of any one of clauses 19 to 21, wherein the silk formulation further comprises about 0.001% (w/v) to about 10% (w/v) sericin.

Clause 23. The method of any one of clauses 19 to 22, wherein the silk fibroin proteins or fragments thereof do not spontaneously or gradually gelate and do not visibly change in color or turbidity when in an aqueous solution for at least 10 days prior to being formulated and applied to the leather substrate.

Clause 24. The method of any one of clauses 19 to 23, wherein a portion of the silk formulation is coated on a surface of the leather substrate, and/or a portion of the silk formulation is infused into a layer of the leather substrate, and/or a portion of the silk formulation enters a recessed portion of the leather substrate.

Clause 25. The method of any one of clauses 19 to 24, wherein the silk formulation further comprises a rheology modifier.

Clause 26. The method of clause 25, wherein the rheology modifier comprises one or more polysaccharides selected from starch, cellulose, gum arabic, guar gum, xanthan gum, alginate, pectin, chitin, chitosan, carrageenan gum, inulin, and gellan gum.

Clause 27. The method of clause 26, wherein the gellan gum comprises low-acyl content gellan gum.

Clause 28. The method of any one of clauses 25 to 27, wherein the w/w ratio between the silk fibroin proteins or fragments thereof and the rheology modifier in the silk formulation is selected from about 25:1, about 24:1. about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

Clause 29. The method of any one of clauses 25 to 27, wherein the w/w ratio between the silk fibroin proteins or fragments thereof and the rheology modifier in the silk formulation is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1. about 0.8:1, about 0.7:1, about 0.6:1, about 0.5:1, about 0.4:1, about 0.3:1, about 0.2:1, and about 0.1:1.

Clause 30. The method of any one of clauses 25 to 27, wherein the w/v concentration of the rheology modifier in the silk formulation is between about 0.01% and about 5%, or between about 0.1% and about 1%.

Clause 31. The method of any one of clauses 19 to 30, wherein the silk formulation further comprises a plasticizer.

Clause 32. The method of clause 31, wherein the plasticizer comprises one or more polyols, and/or one or more polyethers.

Clause 33. The method of clause 32, wherein the polyols are selected from one or more of glycol, glycerol, sorbitol, D-sorbitol, glucose, sucrose, mannitol, mannitol, D-mannitol, and dextrose.

Clause 34. The method of clause 32, wherein the polyethers are one or more polyethyleneglycols (PEGs).

Clause 35. The method of any one of clauses 31 to 34, wherein the w/w ratio between the silk fibroin proteins or fragments thereof and the plasticizer in the silk formulation is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1. about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

Clause 36. The method of any one of clauses 31 to 34, wherein the w/v concentration of the plasticizer in the silk formulation is between about 0.01% and about 10%.

Clause 37. The method of any one of clauses 19 to 36, wherein the silk formulation further comprises a defoaming agent at a concentration between about 0.001% and about 1%.

Clause 38. The method of clause 37, wherein the defoaming agent comprises a silicone.

Clause 39. The method of any one of clauses 19 to 38, wherein the silk formulation further comprises one or more of an isocyanate, a poly diisocyanate, an aziridine, a carbodiimide, an aldehyde, a polyisocyanate, a polyaziridine, a polycarbodiimide, a polyaldehyde, a polyurethane, a polyacrylate, a polyester, a wax, a protein, and/or an alcohol.

Clause 40. The method of any one of clauses 19 to 39, wherein the silk formulation is a liquid, a gel, a paste, a wax, or a cream.

Clause 41. The method of any one of clauses 19 to 40, wherein the silk formulation comprises one or more sub-formulations to be applied at the same time or at different times.

Clause 42. The method of any one of clauses 19 to 41, wherein the concentration of silk fibroin proteins or fragments thereof in the silk formulation is between about 0.1% w/v and about 15% w/v.

Clause 43. The method of any one of clauses 19 to 41, wherein the concentration of silk fibroin proteins or fragments thereof in the silk formulation is between about 0.5% w/v and about 12% w/v.

Clause 44. The method of any one of clauses 19 to 41, wherein the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v.

Clause 45. The method of any one of clauses 19 to 41, wherein the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 60.75% w/v, about 7% w/v, about 7.25% w/v, about 7.5% w/v, about 70.75% w/v, about 8% w/v, about 8.25% w/v, about 8.5% w/v, about 8.75% w/v, about 9% w/v, about 90.25% w/v, about 9.5% w/v, about 90.75% w/v, or about 10% w/v.

Clause 46. The method of any one of clauses 19 to 41, wherein the concentration of silk fibroin proteins or fragments thereof in the silk formulation is between about 5 mg/mL and about 125 mg/mL.

Clause 47. The method of any one of clauses 19 to 41, wherein the concentration of silk fibroin proteins or fragments thereof in the silk formulation is about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL. about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, or about 90 mg/mL.

Clause 48. The method of any one of clauses 19 to 47, the method further comprising one or more additional steps selected from dyeing, drying, water annealing, mechanical stretching, trimming, polishing, applying a pigment, applying a colorant, applying an acrylic formulation, applying an urethane formulation, chemical fixing, stamping, applying a silicone finish, providing a Uniflex treatment, and/or providing a Finiflex treatment, wherein the step of applying the silk formulation on a surface of the leather is performed before, during, or after the one or more additional steps.

Clause 49. The method of any one of clauses 19 to 48, wherein treating the leather substrate with the silk formulation results in one or more of the following: increase in gloss, increase in color saturation, color enhancement, increase in color fixation, reduced dye use, and/or improved colorfastness.

Clause 50. The method of clause 49, wherein the improvement is as to a leather substrate not similarly treated with a silk formulation.

Clause 101. A composite comprising a first polymeric macromolecular species or polymer and a second polymeric macromolecular species or polymer.

Clause 102. The composite of clause 101, wherein a portion of the first polymeric macromolecular species or polymer and a portion of the second polymeric macromolecular species or polymer are physically entangled. In some embodiments, physical entanglement is as measured by a Coating Performance Testing described herein. In some embodiments, physical entanglement is as measured by a Veslic Test described herein. In some embodiments, physical entanglement is as measured by a Color Fastness Rubbing Test described herein. In some embodiments, physical entanglement is as measured by a Bally Flex Test described herein. In some embodiments, physical entanglement is as measured by an Adhesive Tape Test described herein. In some embodiments, physical entanglement can be obtained, without limitation, via melting, polymerization, dissolving, curing, cross-linking, and/or coacervation. Clause 102-a. The composite of clause 101, wherein a portion of the first polymeric macromolecular species or polymer and a portion of the second polymeric macromolecular species or polymer are chemically entangled. In some embodiments, chemical entanglement is as measured by a Coating Performance Testing described herein. In some embodiments, chemical entanglement is as measured by a Veslic Test described herein.

In some embodiments, chemical entanglement is as measured by a Color Fastness Rubbing Test described herein. In some embodiments, chemical entanglement is as measured by a Bally Flex Test described herein. In some embodiments, chemical entanglement is as measured by an Adhesive Tape Test described herein. In some embodiments, chemical entanglement can be obtained, without limitation, via melting, polymerization, dissolving, curing, cross-linking, and/or coacervation. Clause 102-b. The composite of clause 101, wherein a portion of the first polymeric macromolecular species or polymer and a portion of the second polymeric macromolecular species or polymer are molecularly entangled. In some embodiments, molecular entanglement is as measured by a Coating Performance Testing described herein. In some embodiments, molecular entanglement is as measured by a Veslic Test described herein. In some embodiments, molecular entanglement is as measured by a Color Fastness Rubbing Test described herein. In some embodiments, molecular entanglement is as measured by a Bally Flex Test described herein. In some embodiments, molecular entanglement is as measured by an Adhesive Tape Test described herein. In some embodiments, molecular entanglement can be obtained, without limitation, via melting, polymerization, dissolving, curing, cross-linking, and/or coacervation.

Clause 103. The composite of clause 101, wherein a portion of the first polymeric macromolecular species or polymer are physically and/or chemically crosslinked. In some embodiments, physical and/or chemical crosslinking is as measured by a Coating Performance Testing described herein. In some embodiments, physical and/or chemical crosslinking is as measured by a Veslic Test described herein. In some embodiments, physical and/or chemical crosslinking is as measured by a Color Fastness Rubbing Test described herein. In some embodiments, physical and/or chemical crosslinking is as measured by a Bally Flex Test described herein. In some embodiments, physical and/or chemical crosslinking is as measured by an Adhesive Tape Test described herein.

Clause 104. The composite of clause 101, wherein a portion of the second polymeric macromolecular species or polymer are physically and/or chemically crosslinked. In some embodiments, physical and/or chemical crosslinking is as measured by a Coating Performance Testing described herein. In some embodiments, physical and/or chemical crosslinking is as measured by a Veslic Test described herein. In some embodiments, physical and/or chemical crosslinking is as measured by a Color Fastness Rubbing Test described herein. In some embodiments, physical and/or chemical crosslinking is as measured by a Bally Flex Test described herein. In some embodiments, physical and/or chemical crosslinking is as measured by an Adhesive Tape Test described herein.

Clause 105. The composite of clause 101, wherein a portion of the first polymeric macromolecular species or polymer are chemically and/or physically integrated into a portion of the second polymeric macromolecular species or polymer. In some embodiments, physical and/or chemical integration is as measured by a Coating Performance Testing described herein. In some embodiments, physical and/or chemical integration is as measured by a Veslic Test described herein. In some embodiments, physical and/or chemical integration is as measured by a Color Fastness Rubbing Test described herein. In some embodiments, physical and/or chemical integration is as measured by a Bally Flex Test described herein. In some embodiments, physical and/or chemical integration is as measured by an Adhesive Tape Test described herein.

Clause 106. The composite of clause 101, wherein a portion of the first polymeric macromolecular species or polymer and a portion of the second polymeric macromolecular species or polymer are not separable. In some embodiments, degree of separation or lack thereof is as measured by a Coating Performance Testing described herein. In some embodiments, degree of separation or lack thereof is as measured by a Veslic Test described herein. In some embodiments, degree of separation or lack thereof is as measured by a Color Fastness Rubbing Test described herein. In some embodiments, degree of separation or lack thereof is as measured by a Bally Flex Test described herein. In some embodiments, degree of separation or lack thereof is as measured by an Adhesive Tape Test described herein.

Clause 107. The composite of clause 101, wherein a portion of the first polymeric macromolecular species or polymer and/or a portion of the second polymeric macromolecular species or polymer are cross-linked. In some embodiments, crosslinking is as measured by a Coating Performance Testing described herein. In some embodiments, crosslinking is as measured by a Veslic Test described herein. In some embodiments, crosslinking is as measured by a Color Fastness Rubbing Test described herein. In some embodiments, crosslinking is as measured by a Bally Flex Test described herein. In some embodiments, crosslinking is as measured by an Adhesive Tape Test described herein.

Clause 108. The composite of clause 101, wherein a portion of the first polymeric macromolecular species or polymer and/or a portion of the second polymeric macromolecular species or polymer are partially organized and/or crystallized. In some embodiments, degree of organization and/or crystallization is as measured by a Coating Performance Testing described herein. In some embodiments, degree of organization and/or crystallization is as measured by a Veslic Test described herein. In some embodiments, degree of organization and/or crystallization is as measured by a Color Fastness Rubbing Test described herein. In some embodiments, degree of organization and/or crystallization is as measured by a Bally Flex Test described herein. In some embodiments, degree of organization and/or crystallization is as measured by an Adhesive Tape Test described herein.

Clause 109. The composite of clause 101, wherein a portion of the first polymeric macromolecular species or polymer and a portion of the second polymeric macromolecular species or polymer cannot be delaminated. In some embodiments, degree of delamination or lack thereof is as measured by a Coating Performance Testing described herein. In some embodiments, degree of delamination or lack thereof is as measured by a Veslic Test described herein. In some embodiments, degree of delamination or lack thereof is as measured by a Color Fastness Rubbing Test described herein. In some embodiments, degree of delamination or lack thereof is as measured by a Bally Flex Test described herein. In some embodiments, degree of delamination or lack thereof is as measured by an Adhesive Tape Test described herein.

Clause 110. The composite of clause 101, wherein a portion of the first polymeric macromolecular species or polymer and a portion of the second polymeric macromolecular species or polymer are self-assembled. In some embodiments, degree of self-assembly is as measured by a Coating Performance Testing described herein. In some embodiments, degree of self-assembly is as measured by a Veslic Test described herein. In some embodiments, degree of self-assembly is as measured by a Color Fastness Rubbing Test described herein. In some embodiments, degree of self-assembly is as measured by a Bally Flex Test described herein. In some embodiments, degree of self-assembly is as measured by an Adhesive Tape Test described herein.

Clause 111. The composite of any one of clauses 101 to 110, wherein a portion of the first polymeric macromolecular species or polymer in the composite has a second structure different than a first structure of the first polymeric macromolecular species or polymer.

Clause 111-a. The composite of any one of clauses 101 to 110, wherein a portion of the first polymeric macromolecular species or polymer in the composite has a second structure different than a first structure of the first polymeric macromolecular species or polymer when not in the composite. As used herein, in this clause or any other clause herein, “structure” may include, without limitation, protein folding, protein self-assembly, protein degree of crystallinity, polymer degree of crystallinity, polycarbohydrate degree of crystallinity, polycarbohydrate folding, polycarbohydrate self-assembly, protein glass transition, polycarbohydrate glass transition, polymer self-assembly, and/or polymer glass transition.

Clause 112. The composite of any one of clauses 101 to 110, wherein a portion of the second polymeric macromolecular species or polymer in the composite has a second structure different than a first structure of the second polymeric macromolecular species or polymer. Clause 112-a. The composite of any one of clauses 101 to 110, wherein a portion of the second polymeric macromolecular species or polymer in the composite has a second structure different than a first structure of the second polymeric macromolecular species or polymer when not in the composite.

Clause 113. The composite of any one of clauses 101 to 110, wherein a portion of the first polymeric macromolecular species or polymer in the composite has a second structure different than a first structure of the first polymeric macromolecular species or polymer, and a portion of the second polymeric macromolecular species or polymer in the composite has a second structure different than a first structure of the second polymeric macromolecular species or polymer. Clause 113-a. The composite of any one of clauses 101 to 110, wherein a portion of the first polymeric macromolecular species or polymer in the composite has a second structure different than an unstructured first polymeric macromolecular species or polymer, and a portion of the second polymeric macromolecular species or polymer in the composite has a second structure different than an unstructured second polymeric macromolecular species or polymer. Clause 113-b. The composite of any one of clauses 101 to 110, wherein a portion of the first polymeric macromolecular species or polymer in the composite has a first structure different than an unstructured first polymeric macromolecular species or polymer, and a portion of the second polymeric macromolecular species or polymer in the composite has a first structure different than an unstructured second polymeric macromolecular species or polymer.

Clause 114. The composite of any one of clauses 101 to 113, wherein the first polymeric macromolecular species or polymer comprises a protein component.

Clause 115. The composite of clause 114, wherein the protein component comprises one or more of silk fibroin proteins or fragments, collagen, elastin, gelatin, corn zein, wheat gluten, pectin, chitin, casein, and/or whey.

Clause 116. The composite of any one of clauses 101 to 113, wherein the first polymeric macromolecular species or polymer comprises a biodegradable polymer.

Clause 117. The composite of any one of clauses 101 to 113, wherein the first polymeric macromolecular species or polymer comprises one or more of a polyurethane component.

Clause 118. The composite of any one of clauses 101 to 113, wherein the first polymeric macromolecular species or polymer comprises a poly lactic acid (PLA) component, a poly(lactic-co-glycolic acid) (PLGA) component, or both.

Clause 119. The composite of any one of clauses 101 to 118, wherein the second polymeric macromolecular species or polymer comprises a cellulose and/or cellulose derivative component.

Clause 120. The composite of clause 119, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

Clause 121. The composite of clause 119, wherein the cellulose derivative is ethyl cellulose.

Clause 122. The composite of clause 121, wherein the ethoxyl content in ethyl cellulose is from 45.0% to 49.5%, from 45.0% to 46.0%, from 45.0% to 47.0%, from 47.0% to 48.0%, or from 48.0% to 49.5%.

Clause 123. The composite of clause 121, wherein the degree of substitution of the ethyl cellulose is 0.5 to 1, 1 to 1.5, 1.5 to 2, 2 to 2.5, or 2.5 to 3.

Clause 124. The composite of any one of clauses 119 to 123, wherein a second structure of the cellulose derivative comprises a degree of crystallinity of less than 100%.

Clause 125. The composite of any one of clauses 119 to 123, wherein a second structure of the cellulose derivative comprises a degree of crystallinity of between about 5% and less than about 100%.

Clause 126. The composite of any one of clauses 119 to 123, wherein a second structure of the cellulose derivative comprises a degree of crystallinity of between about 10% and about 20%, between about 20% and about 30%, between about 30% and about 40%, between about 40% and about 50%, between about 50% and about 60%, between about 60% and about 70%, between about 70% and about 80%, between about 80% and about 90%, between about 90% and about 99%, or between about 90% and about 100%.

Clause 127. The composite of any one of clauses 119 to 123, wherein a second structure of the cellulose derivative comprises a degree of crystallinity of less than about 99%, less than about 98%, less than about 97%, less than about 96%, less than about 95%, less than about 94%, less than about 93%, less than about 92%, less than about 91%, less than about 90%, less than about 89%, less than about 88%, less than about 87%, less than about 86%, less than about 85%, less than about 84%, less than about 83%, less than about 82%, less than about 81%, less than about 80%, less than about 79%, less than about 78%, less than about 77%, less than about 76%, less than about 75%, less than about 74%, less than about 73%, less than about 72%, less than about 71%, less than about 70%, less than about 69%, less than about 68%, less than about 67%, less than about 66%, less than about 65%, less than about 64%, less than about 63%, less than about 62%, less than about 61%, less than about 60%, less than about 59%, less than about 58%, less than about 57%, less than about 56%, less than about 55%, less than about 54%, less than about 53%, less than about 52%, less than about 51%, less than about 50% less than about 49%, less than about 48%, less than about 47%, less than about 46%, less than about 45%, less than about 44%, less than about 43%, less than about 42%, less than about 41%, less than about 40%, less than about 39%, less than about 38%, less than about 37%, less than about 36%, less than about 35%, less than about 34%, less than about 33%, less than about 32%, less than about 31%, less than about 30% less than about 29%, less than about 28%, less than about 27%, less than about 26%, less than about 25%, less than about 24%, less than about 23%, less than about 22%, less than about 210%, less than about 20% less than about 19%, less than about 18%, less than about 17%, less than about 16%, less than about 15%, less than about 14%, less than about 13%, less than about 12%, less than about 11%, or less than about 10%.

Clause 128. The composite of any one of clauses 101 to 127, wherein the w/w ratio between the first polymeric macromolecular species or polymer and the second polymeric macromolecular species polymer in the composite is between about 1:100 and about 100:1.

Clause 129. The composite of any one of clauses 101 to 127, wherein the w/w ratio between the first polymeric macromolecular species or polymer and the second polymeric macromolecular species polymer in the composite is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

Clause 130. The composite of any one of clauses 101 to 127, wherein the w/w ratio between the first polymeric macromolecular species or polymer and the second polymeric macromolecular species polymer in the composite is about 10:1, about 10:2, about 10:3, about 10:4, about 10:5, about 10:6, about 10:7, about 10:8, about 10:9, or about 10:10.

Clause 131. The composite of any one of clauses 101 to 130, wherein the first polymeric macromolecular species or polymer is distributed isotropically over a cross section of the composite.

Clause 132. The composite of any one of clauses 101 to 130, wherein the first polymeric macromolecular species or polymer is distributed anisotropically over a cross section of the composite.

Clause 133. The composite of clause 132, wherein a concentration of the first polymeric macromolecular species or polymer closer to a first surface of the composite is higher than a concentration of the first polymeric macromolecular species or polymer closer to a second surface of the composite.

Clause 134. The composite of clause 132 or 133, wherein the first polymeric macromolecular species or polymer is substantially undetectable at a second surface of the composite.

Clause 135. The composite of any one of clauses 101 to 134, wherein the second polymeric macromolecular species or polymer is distributed isotropically over a cross section of the composite.

Clause 136. The composite of any one of clauses 101 to 134, wherein the second polymeric macromolecular species or polymer is distributed anisotropically over a cross section of the composite.

Clause 137. The composite of clause 136, wherein a concentration of the second polymeric macromolecular species or polymer closer to a second surface of the composite is higher than a concentration of the second polymeric macromolecular species or polymer closer to a first surface of the composite.

Clause 138. The composite of clause 136 or 137, wherein the second polymeric macromolecular species or polymer is substantially undetectable at a first surface of the composite substrate-coating interface.

Clause 139. The composite of any one of clauses 101 to 138, wherein a first surface of the composite is adhesive.

Clause 140. The composite of any one of clauses 101 to 138, wherein a second surface of the composite is adhesive.

Clause 141. The composite of any one of clauses 101 to 138, wherein a first surface of the composite is adhesive, and a second surface of the composite is adhesive.

Clause 142. The composite of any one of clauses 101 to 138, wherein a first surface of the composite is adhesive, and a second surface of the composite is non-adhesive.

Clause 143. The composite of any one of clauses 101 to 142, wherein the composite has an increased water resistance compared to one of: i) a non-composite material comprising the first polymeric macromolecular species or polymer, but excluding the second polymeric macromolecular species or polymer, ii) a non-composite material comprising the second polymeric macromolecular species or polymer, but excluding the first polymeric macromolecular species or polymer, or iii) a non-composite material comprising the first polymeric macromolecular species or polymer and the second polymeric macromolecular species or polymer, wherein the polymeric macromolecular species or polymers are not physically and/or chemically molecularly entangled. In some embodiments, water resistance is as measured by a water resistance test described herein.

Clause 144. The composite of any one of clauses 101 to 142, wherein the composite has an increased water vapor permeability compared to one of i) a non-composite material comprising the first polymeric macromolecular species or polymer, but excluding the second polymeric macromolecular species or polymer, ii) a non-composite material comprising the second polymeric macromolecular species or polymer, but excluding the first polymeric macromolecular species or polymer, or iii) a non-composite material comprising the first polymeric macromolecular species or polymer and the second polymeric macromolecular species or polymer, wherein the polymeric macromolecular species or polymers are not physically and/or chemically molecularly entangled. In some embodiments, water vapor permeability is as measured by a water vapor permeability test described herein.

Clause 145. An article comprising a substrate and a coating, the coating comprising the composite of any one of clauses 101 to 144.

Clause 146. The article of clause 145, wherein the substrate comprises an irregular surface.

Clause 147. The article of clause 145, wherein the coating has a thickness between about 10 μm and about 1000 μm. Clause 147-a. The article of clause 145, wherein the coating has a thickness of about 10 μm, about 20 μm, about 30 μm, about 40 μm, about 50 μm, about 60 μm, about 70 μm, about 80 μm, about 90 μm, about 100 μm, about 125 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1000 μm. Clause 147-b. The article of clause 145, wherein the coating has a thickness of about 1.1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, about 3.6 mm, about 3.7 mm, about 3.8 mm, about 3.9 mm, about 4 mm, about 4.1 mm, about 4.2 mm, about 4.3 mm, about 4.4 mm, about 4.5 mm, about 4.6 mm, about 4.7 mm, about 4.8 mm, about 4.9 mm, or about 5 mm, Clause 148. The article of any one of clauses 145 to 147, wherein the amount of coating on the substrate is between about 0.01 g/ft² and about 25 g/ft². Clause 148-a. The article of any one of clauses 145 to 147, wherein the amount of coating on the substrate is between about 0.01 g/ft² and about 0.1 g/ft². Clause 148-b. The article of any one of clauses 145 to 147, wherein the amount of coating on the substrate is between about 0.1 g/ft² and about 0.5 g/ft². Clause 148-c. The article of any one of clauses 145 to 147, wherein the amount of coating on the substrate is between about 0.5 g/ft² and about 1 g/ft². Clause 148-d. The article of any one of clauses 145 to 147, wherein the amount of coating on the substrate is between about 1 g/ft² and about 2.5 g/ft². Clause 148-e. The article of any one of clauses 145 to 147, wherein the amount of coating on the substrate is between about 2.5 g/ft² and about 5 g/ft². Clause 148-f. The article of any one of clauses 145 to 147, wherein the amount of coating on the substrate is between about 5 g/ft² and about 7.5 g/ft². Clause 148-g. The article of any one of clauses 145 to 147, wherein the amount of coating on the substrate is between about 7.5 g/ft² and about 10 g/ft². Clause 148-h. The article of any one of clauses 145 to 147, wherein the amount of coating on the substrate is between about 10 g/ft² and about 15 g/ft². Clause 148-i. The article of any one of clauses 145 to 147, wherein the amount of coating on the substrate is between about 15 g/ft² and about 25 g/ft². Clause 148-j. The article of any one of clauses 145 to 147, wherein the amount of coating on the substrate is between about 25 g/ft² and about 50 g/ft².

Clause 149. The article of any one of clauses 145 to 148, wherein the amount of first polymeric macromolecular species or polymer in the coating on the substrate is between about 0.001 g/ft² and about 20 g/ft². Clause 149-a. The article of any one of clauses 145 to 148, wherein the amount of first polymeric macromolecular species or polymer in the coating on the substrate is between about 0.001 g/ft² and about 0.1 g/ft². Clause 149-b. The article of any one of clauses 45 to 48, wherein the amount of first polymeric macromolecular species or polymer in the coating on the substrate is between about 0.1 g/ft² and about 1 g/ft². Clause 149-c. The article of any one of clauses 145 to 148, wherein the amount of first polymeric macromolecular species or polymer in the coating on the substrate is between about 1 g/ft² and about 10 g/ft². Clause 149-d. The article of any one of clauses 145 to 148, wherein the amount of first polymeric macromolecular species or polymer in the coating on the substrate is between about 10 g/ft² and about 25 g/ft².

Clause 150. The article of any one of clauses 145 to 149, wherein the amount of second polymeric macromolecular species or polymer in the coating on the substrate is between about 0.001 g/ft² and about 15 g/ft². Clause 150-a. The article of any one of clauses 145 to 148, wherein the amount of second polymeric macromolecular species or polymer in the coating on the substrate is between about 0.001 g/ft² and about 0.1 g/ft². Clause 150-b. The article of any one of clauses 145 to 148, wherein the amount of second polymeric macromolecular species or polymer in the coating on the substrate is between about 0.1 g/ft² and about 1 g/ft². Clause 150-c. The article of any one of clauses 145 to 148, wherein the amount of second polymeric macromolecular species or polymer in the coating on the substrate is between about 1 g/ft² and about 10 g/ft². Clause 150-d. The article of any one of clauses 145 to 148, wherein the amount of second polymeric macromolecular species or polymer in the coating on the substrate is between about 10 g/ft² and about 25 g/ft².

Clause 151. The article of any one of clauses 145 to 150, wherein the substrate comprises a substantially flexible material.

Clause 152. The article of any one of clauses 145 to 151, wherein the substrate comprises a leather material or a textile material.

Clause 153. The article of any one of clauses 145 to 152, wherein the substrate comprises one or more of collagen, cellulose, and/or lignin.

Clause 154. A method of coating a substrate, the method comprising applying to a surface of the substrate a first composition comprising a first polymeric macromolecular species or polymer, and a second composition comprising a second polymeric macromolecular species or polymer.

Clause 155. The method of clause 154, wherein the first composition comprises an unstructured first polymeric macromolecular species or polymer, or a first structure of the first polymeric macromolecular species or polymer.

Clause 156. The method clause 154 or 155, wherein the first polymeric macromolecular species or polymer comprises a protein component.

Clause 157. The method of any one of clauses 154 to 156, wherein the protein component comprises one or more of silk fibroin proteins or fragments, collagen, elastin, gelatin, corn zein, wheat gluten, pectin, chitin, casein, and/or whey.

Clause 158. The method of clause 154 or 155, wherein the first polymeric macromolecular species or polymer comprises a biodegradable polymer.

Clause 159. The method of any one of clauses 154 to 158, wherein the first polymeric macromolecular species or polymer comprises one or more of a polyurethane component.

Clause 160. The method of any one of clauses 154 to 158, wherein the first polymeric macromolecular species or polymer comprises a poly lactic acid (PLA) component, a poly(lactic-co-gly colic acid) (PLGA) component, or both.

Clause 161. The method of any one of clauses 154 to 160, wherein the second composition comprises an unstructured second polymeric macromolecular species or polymer, or a first structure of the second polymeric macromolecular species or polymer.

Clause 162. The method of any one of clauses 154 to 160, wherein the second polymeric macromolecular species or polymer comprises a cellulose and/or cellulose derivative component.

Clause 163. The method of clause 162, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

Clause 164. The method of clause 162, wherein the cellulose derivative is ethyl cellulose.

Clause 165. The method of clause 164, wherein the ethoxyl content in ethyl cellulose is from 45.0% to 49.5%, from 45.0% to 46.0%, from 45.0% to 47.0%, from 47.0% to 48.0%, or from 48.0% to 49.5%.

Clause 166. The method of clause 164, wherein the degree of substitution of the ethyl cellulose is 0.5 to 1, 1 to 1.5, 1.5 to 2, 2 to 2.5, or 2.5 to 3.

Clause 167. The method of any one of clauses 162 to 166, wherein the cellulose derivative comprises a first structure of the cellulose derivative having a degree of crystallinity lower than a second structure of the cellulose derivative comprising a degree of crystallinity of between about 5% and less than about 100%.

Clause 168. The method of any one of clauses 154 to 167, wherein the second composition comprising a second polymeric macromolecular species or polymer further comprises a solvent component.

Clause 169. The method of clause 168, wherein the solvent component comprises an alcohol and/or an alcohol derivative.

Clause 170. The method of clause 168 or 169, wherein the solvent component comprises one or more of an alcohol, an ether, a ketone, an aldehyde, and/or a ketal.

Clause 171. The method of any one of clauses 168 to 170, wherein the solvent component is from about 75% w/w to about 99% w/w of the composition, from about 80% w/w to about 98% w/w of the composition, from about 85% w/w to about 97.5% w/w of the composition, or from about 85% w/w to about 95% w/w of the composition. Clause 171-a. The method of any one of clauses 168 to 170, wherein the solvent component is about 95% w/w, about 95.5% w/w, about 96% w/w, about 96.5% w/w, about 97% w/w, about 97.5% w/w, about 98% w/w, about 98.5% w/w, about 99% w/w, or about 99.5% w/w of the composition Clause 172. The method of any one of clauses 168 to 171, wherein the solvent component comprises one or more of methanol, ethanol, n-propanol, 2-propanol, n-butanol, 2-butanol, pentanol, hexanol, acetone, butanone, methoxypropanol, di-isopropylidene glycerol, 2,2-dimethyl-4-hydroxymethyl-1,3-dioxolane, 2,2-dimethyl-1,3-dioxolane-4-methanol, or any combination thereof.

Clause 173. The method of any one of clauses 154 to 172, wherein a first composition comprising a first polymeric macromolecular species or polymer further comprises one or more of a polyethylene glycol (PEG) component, a polypropylene glycol (PPG) component, and/or a polyether component.

Clause 174. The method of any one of clauses 154 to 172, wherein a first composition comprising a first polymeric macromolecular species or polymer further comprises one or more of fatty acid or fatty acid derived amide, and/or a monoglyceride, diglyceride, and/or triglyceride.

Clause 175. The method of any one of clauses 154 to 172, wherein a first composition comprising a first polymeric macromolecular species or polymer further comprises one or more of a triethylene glycol monomethyl ether component, a diethylene glycol butyl ether component, a diethylene glycol ethyl ether component, a dimethyl tetradecanedioate component, an erucamide component, and/or a glyceryl stearate component.

Clause 176. The method of any one of clauses 154 to 172, wherein a first composition comprising a first polymeric macromolecular species or polymer comprises one or more of an isocyanate component, a polyol component, a blocked isocyanate component, and/or a blocked polyol component.

Clause 177. The method of any one of clauses 154 to 172, wherein a first composition comprising a first polymeric macromolecular species or polymer comprises a partially polymerized, partially crosslinked, and/or partially cured polyurethane component.

Clause 178. The method of any one of clauses 154 to 172, wherein a first composition comprising a first polymeric macromolecular species or polymer further comprises a polyurethane prepolymer component.

Clause 179. The method of any one of clauses 154 to 172, wherein a first composition comprising a first polymeric macromolecular species or polymer further comprises water.

Clause 180. The method of any one of clauses 154 to 172, wherein a surface of the substrate is coated first with the first composition comprising a first polymeric macromolecular species or polymer, and then coated with the second composition comprising a second polymeric macromolecular species or polymer.

Clause 181. The method of clause 180, further comprising a drying or partial drying step between the two coating steps.

Clause 182. The method of clause 180 or 181, wherein the first composition comprising a first polymeric macromolecular species or polymer is only partially polymerized, partially dried, and/or partially cured before the second composition comprising a second polymeric macromolecular species or polymer is applied.

Clause 183. The method of any one of clauses 154 to 182, wherein the second composition comprising a second polymeric macromolecular species or polymer is applied at a temperature above a glass transition temperature (T_{g}) of the first polymeric macromolecular species or polymer.

Clause 184. The method of any one of clauses 154 to 182, wherein the second composition comprising a second polymeric macromolecular species or polymer is applied at a temperature above a glass transition temperature (T_{g}) of the second polymeric macromolecular species or polymer.

Clause 185. The method of any one of clauses 154 to 184, wherein the first composition comprising a first polymeric macromolecular species or polymer is applied one or more times at a rate from about 0.5 mL/ft² to about 5 mL/ft².

Clause 186. The method of any one of clauses 154 to 185, wherein the second composition comprising a second polymeric macromolecular species or polymer is applied one or more times at a rate from about 0.5 mL/ft² to about 5 mL/ft².

Clause 187. An article comprising a substrate and a coating, the article made by a method of any one of clauses 154 to 186.

Clause 188. The article of clause 187, wherein the first polymeric macromolecular species or polymer is distributed isotropically over a cross section of the coating from a substrate-coating interface to an external surface of the coating.

Clause 189. The article of clause 187, wherein the first polymeric macromolecular species or polymer is distributed anisotropically over a cross section of the coating from a substrate-coating interface to an external surface of the coating.

Clause 190. The article of clause 187, wherein a concentration of the first polymeric macromolecular species or polymer closer to a substrate-coating interface is higher than a concentration of the first macromolecular species or polymer closer to an external surface of the coating.

Clause 191. The article of clause 187, wherein the first polymeric macromolecular species or polymer is substantially undetectable at an external surface of the coating.

Clause 192. The article of any one of clauses 187 to 191, wherein the second polymeric macromolecular species or polymer is distributed isotropically over a cross section of the coating from a substrate-coating interface to an external surface of the coating.

Clause 193. The article of any one of clauses 187 to 191, wherein the second polymeric macromolecular species or polymer is distributed anisotropically over a cross section of the coating from a substrate-coating interface to an external surface of the coating.

Clause 194. The article of any one of clauses 187 to 191, wherein a concentration of the second polymeric macromolecular species or polymer closer to a substrate-coating interface is lower than a concentration of the second polymeric macromolecular species or polymer closer to an external surface of the coating.

Clause 195. The article of any one of clauses 187 to 191, wherein the second polymeric macromolecular species or polymer is substantially undetectable at a substrate-coating interface.

Clause 201. An article comprising a substrate and a coating, the coating comprising a first crosslinked and/or polymeric macromolecular species or polymer, and a second crosslinked and/or polymeric macromolecular species and/or polymer.

Clause 202. The article of clause 201, wherein the substrate comprises a substantially flexible material.

Clause 203. The article of clause 201, wherein the substrate comprises a leather material or a textile material.

Clause 204. The article of clause 201, wherein the substrate comprises collagen, cellulose, or lignin.

Clause 205. The article of any one of clauses 201 to 204, wherein the first crosslinked and/or polymeric macromolecular species and/or polymer comprises a polyurethane component, or a protein component. In some embodiments, a protein component comprises any protein disclosed herein.

Clause 206. The article of any one of clauses 201 to 205, wherein the second crosslinked and/or polymeric macromolecular species and/or polymer comprises a cellulose and/or cellulose derivative component.

Clause 207. The article of clause 206, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

Clause 208. The article of clause 206, wherein the cellulose derivative is ethyl cellulose.

Clause 209. The article of clause 208, wherein the ethoxyl content in ethyl cellulose is from 45.0% to 49.5%, from 45.0% to 46.0%, from 45.0% to 47.0%, from 47.0% to 48.0%, or from 48.0% to 49.5%.

Clause 210. The article of clause 208, wherein the degree of substitution of the ethyl cellulose is 0.5 to 1, 1 to 1.5, 1.5 to 2, 2 to 2.5, or 2.5 to 3.

Clause 211. The article of any one of clauses 206 to 210, wherein the cellulose derivative has a degree of crystallinity less than 100%.

Clause 212. The article of any one of clauses 206 to 210, wherein the cellulose derivative has a degree of crystallinity between about 50% and about 60%, between about 60% and about 70%, between about 70% and about 80%, between about 80% and about 90%, between about 90% and about 99%, or between about 90% and about 100%.

Clause 213. The article of any one of clauses 206 to 210, wherein the cellulose derivative has a degree of crystallinity less than 99%, less than 98%, less than 97%, less than 96%, less than 95%, less than 94%, less than 93%, less than 92%, less than 91%, less than 90%, less than 89%, less than 88%, less than 87%, less than 86%, less than 85%, less than 84%, less than 83%, less than 82%, less than 81%, less than 80%, less than 79%, less than 78%, less than 77%, less than 76%, less than 75%, less than 74%, less than 73%, less than 72%, less than 71%, or less than 70%.

Clause 214. The article of any one of clauses 201 to 213, wherein the w/w ratio between the first crosslinked and/or polymeric macromolecular species or polymer and the second crosslinked and/or polymeric macromolecular species and/or polymer in the coating is between about 1:100 and about 100:1. Clause 214-a. The article of any one of clauses 201 to 213, wherein the w/w ratio between the first crosslinked and/or polymeric macromolecular species or polymer and the second crosslinked and/or polymeric macromolecular species and/or polymer in the coating is any ratio disclosed herein.

Clause 215. The article of any one of clauses 201 to 214, wherein the first crosslinked and/or polymeric macromolecular species or polymer is distributed isotropically over a cross section of the coating from a substrate-coating interface to an external surface of the coating.

Clause 216. The article of any one of clauses 201 to 214, wherein the first crosslinked and/or polymeric macromolecular species or polymer is distributed anisotropically over a cross section of the coating from a substrate-coating interface to an external surface of the coating.

Clause 217. The article of clause 216, wherein a concentration of the first crosslinked and/or polymeric macromolecular species or polymer closer to a substrate-coating interface is higher than a concentration of the first crosslinked and/or polymeric macromolecular species or polymer closer to an external surface of the coating.

Clause 218. The article of clause 216, wherein the first crosslinked and/or polymeric macromolecular species or polymer is substantially undetectable at an external surface of the coating.

Clause 219. The article of any one of clauses 201 to 218, wherein the second crosslinked and/or polymeric macromolecular species or polymer is distributed isotropically over a cross section of the coating from a substrate-coating interface to an external surface of the coating.

Clause 220. The article of any one of clauses 201 to 218, wherein the second crosslinked and/or polymeric macromolecular species or polymer is distributed anisotropically over a cross section of the coating from a substrate-coating interface to an external surface of the coating.

Clause 221. The article of clause 220, wherein a concentration of the second crosslinked and/or polymeric macromolecular species or polymer closer to a substrate-coating interface is lower than a concentration of the first crosslinked and/or polymeric macromolecular species or polymer closer to an external surface of the coating.

Clause 222. The article of clause 220, wherein the second crosslinked and/or polymeric macromolecular species or polymer is substantially undetectable at a substrate-coating interface.

Clause 223. The article of any one of clauses 201 to 222, wherein the thickness of the coating is between about 10 μm and about 1000 μm. Clause 223-a. The article of any one of clauses 201 to 222, wherein the thickness of the coating is any thickness disclosed herein.

Clause 224. The article of any one of clauses 201 to 223, wherein the amount of coating on the substrate is between about 0.1 g/ft² and about 15 g/ft².

Clause 225. The article of any one of clauses 201 to 224, wherein the amount of first crosslinked and/or polymeric macromolecular species or polymer in the coating on the substrate is between about 0.1 g/ft² and about 14.99 g/ft².

Clause 226. The article of any one of clauses 201 to 225, wherein the amount of second crosslinked and/or polymeric macromolecular species or polymer in the coating on the substrate is between about 0.01 g/ft² and about 12 g/ft².

Clause 301. A method of making an article comprising a substrate and a coating, the method comprising coating a surface of the substrate with a composition comprising a cellulose derivative and a solvent component.

Clause 302. The method of clause 301, wherein the substrate comprises a substantially flexible material.

Clause 303. The method of clause 301, wherein the substrate comprises a leather material.

Clause 304. The method of any one of clauses 301 to 303, wherein the solvent component comprises an alcohol and/or an alcohol derivative.

Clause 305. The method of any one of clauses 301 to 303, wherein the solvent component comprises one or more of an alcohol, an ether, a ketone, an aldehyde, and/or a ketal.

Clause 306. The method of any one of clauses 301 to 305, wherein the solvent component is from about 75% w/w to about 99% w/w of the composition, from about 80% w/w to about 98% w/w of the composition, or from about 85% w/w to about 95% w/w of the composition.

Clause 307. The method of any one of clauses 301 to 306, wherein the solvent component comprises one or more of methanol, ethanol, n-propanol, 2-propanol, n-butanol, 2-butanol, pentanol, hexanol, acetone, butanone, methoxypropanol, di-isopropylidene glycerol, 2,2-dimethyl-4-hydroxymethyl-1,3-dioxolane, 2,2-dimethyl-1,3-dioxolane-4-methanol, or any combination thereof.

Clause 308. The method of any one of clauses 301 to 307, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

Clause 309. The method of any one of clauses 301 to 307, wherein the cellulose derivative is ethyl cellulose.

Clause 310. The method of clause 309, wherein the ethoxyl content is from 45.0% to 49.5%, from 45.0% to 46.0%, from 45.0% to 47.0%, from 47.0% to 48.0%, or from 48.0% to 49.5%.

Clause 311. The method of clause 309, wherein the degree of substitution of the ethyl cellulose is 0.5 to 1, 1 to 1.5, 1.5 to 2, 2 to 2.5, or 2.5 to 3.

Clause 312. The method of any one of clauses 301 to 311, wherein the cellulose derivative has a degree of crystallinity less than 100%.

Clause 313. The method of any one of clauses 301 to 311, wherein the cellulose derivative has a degree of crystallinity between about 50% and about 60%, between about 60% and about 70%, between about 70% and about 80%, between about 80% and about 90%, between about 90% and about 99%, or between about 90% and about 100%.

Clause 314. The method of any one of clauses 301 to 311, wherein the cellulose derivative has a degree of crystallinity less than 99%, less than 98%, less than 97%, less than 96%, less than 95%, less than 94%, less than 93%, less than 92%, less than 91%, less than 90%, less than 89%, less than 88%, less than 87%, less than 86%, less than 85%, less than 84%, less than 83%, less than 82%, less than 81%, less than 80%, less than 79%, less than 78%, less than 77%, less than 76%, less than 75%, less than 74%, less than 73%, less than 72%, less than 71%, or less than 70%.

Clause 315. The method of any one of clauses 301 to 314, further comprising coating a surface of the substrate with a composition comprising a resin mixture component and a solvent component.

Clause 316. The method of clause 315, wherein the resin mixture comprises one or more of a polyethylene glycol (PEG) component, a polypropylene glycol (PPG) component, and/or a polyether component.

Clause 317. The method of clause 315 or 316, wherein the resin mixture comprises one or more of fatty acid or fatty acid derived amide, and/or a monoglyceride, diglyceride, and/or triglyceride.

Clause 318. The method of clause 315 or 316, wherein the resin mixture comprises one or more of a triethylene glycol monomethyl ether component, a diethylene glycol butyl ether component, a diethylene glycol ethyl ether component, a dimethyl tetradecanedioate component, an erucamide component, and/or a glyceryl stearate component.

Clause 319. The method of any one of clauses 315 to 318, wherein the resin mixture comprises one or more of an isocyanate component, a polyol component, a blocked isocyanate component, and/or a blocked polyol component.

Clause 320. The method of any one of clauses 315 to 318, wherein the resin mixture comprises a partially polymerized, partially crosslinked, and/or partially cured polyurethane component.

Clause 321. The method of any one of clauses 315 to 318, wherein the resin mixture comprises a polyurethane prepolymer component.

Clause 322. The method of any one of clauses 315 to 318, wherein the resin mixture is from about 15% to about 35% of the composition.

Clause 323. The method of any one of clauses 315 to 322, wherein the composition further comprises water.

Clause 324. The method of any one of clauses 315 to 323, wherein the composition further comprises silk fibroin proteins or fragments thereof having an average weight average molecular weight selected from between about 1 kDa and about 5 kDa, from between about 5 kDa and about 10 kDa, from between about 6 kDa and about 17 kDa, from between about 10 kDa and about 15 kDa, from between about 14 kDa and about 30 kDa, from between about 15 kDa and about 20 kDa, from between about 17 kDa and about 39 kDa, from between about 20 kDa and about 25 kDa, from between about 25 kDa and about 30 kDa, from between about 30 kDa and about 35 kDa, from between about 35 kDa and about 40 kDa, from between about 39 kDa and about 54 kDa, from between about 39 kDa and about 80 kDa, from between about 40 kDa and about 45 kDa, from between about 45 kDa and about 50 kDa, from between about 50 kDa and about 55 kDa, from between about 55 kDa and about 60 kDa, from between about 60 kDa and about 100 kDa, or from between about 80 kDa and about 144 kDa, and a polydispersity ranging from 1 to about 5.

Clause 325. The method of any one of clauses 315 to 324, wherein the composition further comprises a crosslinker.

Clause 326. The method of any one of clauses 315 to 325, wherein a surface of the substrate is coated first with the composition comprising a resin mixture, and then coated second with the composition comprising a cellulose derivative and a solvent component.

Clause 327. The method of clause 326, further comprising a drying or partial drying step between the two coating steps.

Clause 328. The method of clause 326 or 327, wherein the composition comprising a resin mixture is only partially polymerized, partially dried, and/or partially cured before the composition comprising a cellulose derivative is applied.

Clause 329. The method of any one of clauses 326 to 328, wherein the composition comprising a cellulose derivative and a solvent component is applied at a temperature above a glass transition temperature (T_{g}) of at least one component in the composition.

Clause 330. The method of any one of clauses 326 to 328, wherein the composition comprising a cellulose derivative and a solvent component is applied at a temperature above a glass transition temperature (T_{g}) of the cellulose derivative.

Clause 331. The method of any one of clauses 326 to 330, wherein the composition comprising a cellulose derivative and a solvent component is applied at a temperature above a glass transition temperature (T_{g}) of at least one component in the composition comprising a resin mixture.

Clause 332. The method of any one of clauses 326 to 330, wherein the composition comprising a cellulose derivative and a solvent component is applied at a temperature above a glass transition temperature (T_{g}) of at least a polyurethane component or part thereof in the composition comprising a resin mixture.

Clause 333. An article comprising a substrate and a coating comprising a cellulose derivative, the article made by a method of any one of clauses 301 to 332.

### EXAMPLES

The following examples are put forth so as to provide those of ordinary skill in the art with a complete disclosure and description of how to make and use the described embodiments, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1: Colorfastness to Rubbing

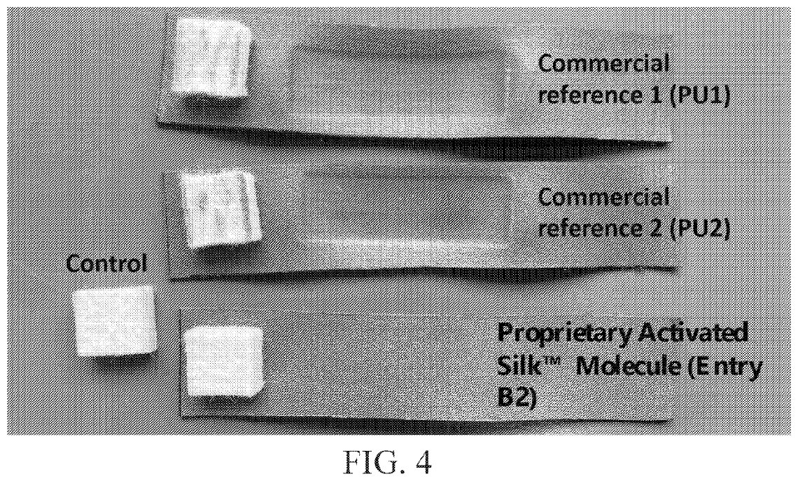

Colorfastness to rubbing (Wet Veslic Testing) is one of the most important and difficult technical specifications to achieve for leather finishing chemicals. Herein, it is shown silk fibroin fragment compositions described herein (Activated Silk, Entry B2) outperforms polyurethane systems specifically designed as top-coats (Stahl WT-13-097) with enhanced CFR performance (Stahl WT-42-518) at lower dry mass loadings deposited on the surface of the leather. Specifically, the silk fibroin fragments compositions are able to endure>600 rub cycles without any deterioration in the appearance or water repellency of the leather thereby stage for the complete replacement of polyurethanes in leather finishing. In terms of CFR requirements for various use cases, the luxury sector requires a minimum of 10 cycles, the furnishing market requires a minimum of 500 cycles and the automotive market requires 500-1000 cycles. The performance disclosed here demonstrates that the silk fibroin fragments (Entry B2) far exceeds the CFR requirements for luxury goods and is an early indicator for the use of the Activated Silk™ in use cases such as automotive leather and furnishing which demand greater performance (See FIG. 4 Photograph of the felt pads (and associated leather samples) after 600 continuous cycles of Wet Veslic Rubbing, comparing silk fibroin fragment compositions (bottom sample—Entry B2) treated leather samples to polyurethane (top 2 samples) treated leather samples. Note the damage to the polyurethane samples and loss of dye from the leather to the felt after 600 cycles).

### Materials

AS™ Formulations: The evaluated formulation consists of 2 components deposited sequentially via spray coating on the surface of the leather sample:
Component 1: silk fibroin fragment compositions (Activated Silk™) with 0-5% crosslinker in water.
Component 2: Proprietary auxiliary delivered in ethanol.

### Polyurethane Reference Samples:

PU1: Stahl WT-42-518 crosslinked with 5% Melio 09S11. Total solids content of Stahl WT-42-518 is 10%.
PU2: Stahl WT-13-097 crosslinked with 5% Melio 09S11. Total solids content of Stahl WT-13-097 is 8.75%.
Leather samples: Bodin Brown (Color 872) plongé leather samples were obtained from Bodin-Joyeux and were used as received.

### Procedures

### Coating Process

Components 1 and 2: were sequentially delivered to the leather surface via spray coating. Spray applications were applied from a distance of 2 ft and at an outlet pressure of 60 psi. The wet mass loading for each layer was set to 3 g/ft² and measured directly after deposition. Samples were allowed to visually dry between deposition steps.
PU1 and PU2: were delivered in a single pass using the same spray coating methodology as described herein. The target wet mass loading was 3 g/ft².
Colorfastness to Wet Veslic Rubbing (ISO 11640): Testing was completed as described in EBN-SOP-TXTL-035. Samples were allowed to rest for 48 hours prior to testing.

### Results

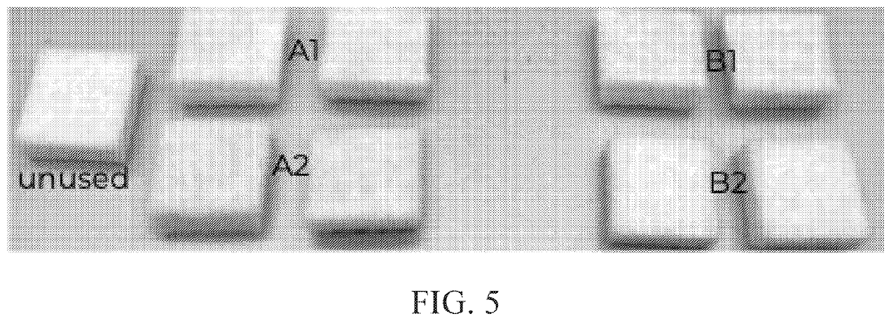

Initial screening results show a marked improvement in Colorfastness to Wet Veslic Rubbing (10 cycles) when using the silk fibroin fragments (Activated Silk™). The data is summarized in Table 1 and in FIG. 5. Reproducibility of the solution is highlighted in Table 2. Table 1 comprises the CFR results for multiple formulations. FIG. 5: Photographs of the felt pads after 10 cycles of Wet Veslic Rubbing on silk fibroin fragments treated leather samples. Table 2: Reproducibility of silk fibroin fragments results for Colorfastness to Wet Veslic Rubbing (ISO 11640) (600 Cycles). FIG. 5. Photographs of the felt pads after 10 cycles of Wet Veslic Rubbing on Entries A1, A2, BT and B2 (from Table 1) treated leather samples.

TABLE 1
Initial screening results for Colorfastness to Wet Veslic Rubbing (ISO 11640)

| | | | Total | | |
|---|---|---|---|---|---|
| | | | Deposited | | |
| | | | Dry Mass | | |
| Entry | Component 1 | Component 2 | (g/ft²) | Wet CFR Rating | |
| A1 | silk fibroin fragment | 0.1-10% ethyl | 0.075 | 2.5 | (10 cycles) |
| | compositions | cellulose^{a} + | | | |
| | (Activated Silk ™) | 0.05-5% | | | |
| | (14-30 KD, 6% aq) | triethyl citrateb | | | |
| A2 | silk fibroin fragment | 0.1-10% ethyl | 0.076 | 2.5 | (10 cycles) |
| | compositions | cellulose^{a} + | | | |
| | (Activated Silk ™) | 0.05-5% | | | |
| | (14-30 KD, 6% aq) | triethyl citrateb | | | |
| | + 0.05% crosslinkerc | | | | |
| B1 | silk fibroin fragment | 0.1-10% ethyl | 0.255 | 2.5 | (10 cycles) |
| | compositions | cellulose^{a} + | | | |
| | (Activated Silk ™) | 0.05-5% | | | |
| | 14-30 KD, 6% aq) | triethyl | | | |
| | | citrateb % | | | |
| B2 | silk fibroin fragment | 0.1-10% ethyl | 0.256 | 4.5-5.0 | (10 cycles) |
| | compositions | cellulose^{a} + | | 4.5-5.0 | (600 cycles) |
| | (Activated Silk ™) | 0.05-5% | | | |
| | 14-30 KD, 6% aq) + | triethyl citrate^{b} | | | |
| | 0.05% crosslinkerc | | | | |
| PU-1 | Stahl WT-42-518 | N/A | 0.45 | 3.5-4 | (10 cycles) |
| | crosslinked with 5% | | | 1-1.5 | (600 cycles) |
| | crosslinker” | | | | |
| PU-2 | Stahl WT-13-097 | N/A | 0.4125 | 3.5-4 | (10 cycles) |
| | crosslinked with 5% | | | 1-1.5 | (600 cycles) |
| | crosslinkerc | | | | |

^{a}Cellulose derivatives are methyl cellulose, ethyl cellulose, carboxymethyl cellulose, hydroxyethyl cellulose, hydroxypropyl cellulose, cellulose acetate, cellulose acetate propionate, cellulose acetate butyrate, microcrystalline cellulose.
^{b}Plasticizers are triethyl citrate, dibutyl sebacate, triacetin, glycerol, 1,3-propanediol, propylene glycol, pentylene glycol, epoxidized vegetable oils, isosorbide esters, succinic acid derivatives, acetic acid ester of monoglycerides.
*Crosslinkers are polyisocyanates, polycarbodiimides, polyaziridines, polyureas, glutaraldehyde, starch dialdehyde.

TABLE 2
Reproducibility of silk fibroin fragment compositions
(Activated Silk ™) results for Colorfastness
to Wet Veslic Rubbing (ISO 11640) (600 Cycles)

| | Total Deposited Dry | |
|---|---|---|
| Entry | Mass (g/ft²) | Wet CFR Rating |
| B2-002 | 0.256 | 4.5-5.0 (600 cycles) |
| B2-003 | 0.256 | 4.5-5.0 (600 cycles) |
| B2-004 | 0.256 | 4.5-5.0 (600 cycles) |
| B2-005 | 0.256 | 4.5-5.0 (600 cycles) |
| B2-006 | 0.256 | 4.5-5.0 (600 cycles) |
| B2-007 | 0.256 | 4.5-5.0 (600 cycles) |
| B2-008 | 0.256 | 4.5-5.0 (600 cycles) |

With these results in hand, the Colorfastness to Wet Veslic Rubbing was extended from 10 cycles to 600 cycles for the formulation described in Entry B2. The results of this experiment are shown in FIG. 4. These experiments were repeated using standard crosslinked polyurethane coating systems for comparison (PU1 and PU2). FIG. 4: comparison photographs of the felt pads and associated leather samples after 600 continuous cycles of Wet Veslic Rubbing. Top: commercial references (crosslinked polyurethanes PU1 and PU2); Bottom: silk fibroin fragments. FIG. 4. Photograph of the felt pads (and associated leather samples) after 600 continuous cycles of Wet Veslic Rubbing, comparing silk fibroin fragment compositions (Activated Silk™) (Entry B2) treated leather samples to PUT and PU2 (commercial references) treated leather samples.

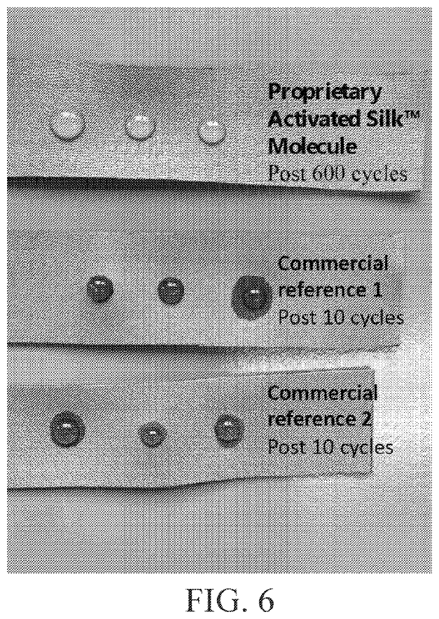

The water repellency of silk fibroin fragments is qualitatively depicted in FIG. 6. FIG. 6 depicts the water repellency of silk fibroin fragments treated leather after 600 cycles of Wet Veslic Rubbing as compared to crosslinked polyurethanes PUT and PU2 after 10 cycles. FIG. 6. Photograph of water droplets placed on samples treated either with silk fibroin fragments or a crosslinked polyurethane coating system after Wet Veslic Rubbing has been performed. In the case of silk fibroin fragments (Entry B2), the sample was exposed to 600 cycles of rubbing whereas the polyurethane samples only endured 10 cycles. The photograph was taken 5 minutes after placing the water droplets. Note the penetration of water into the leather matrix when using the commercial reference systems designed as top-coats.

### Conclusions

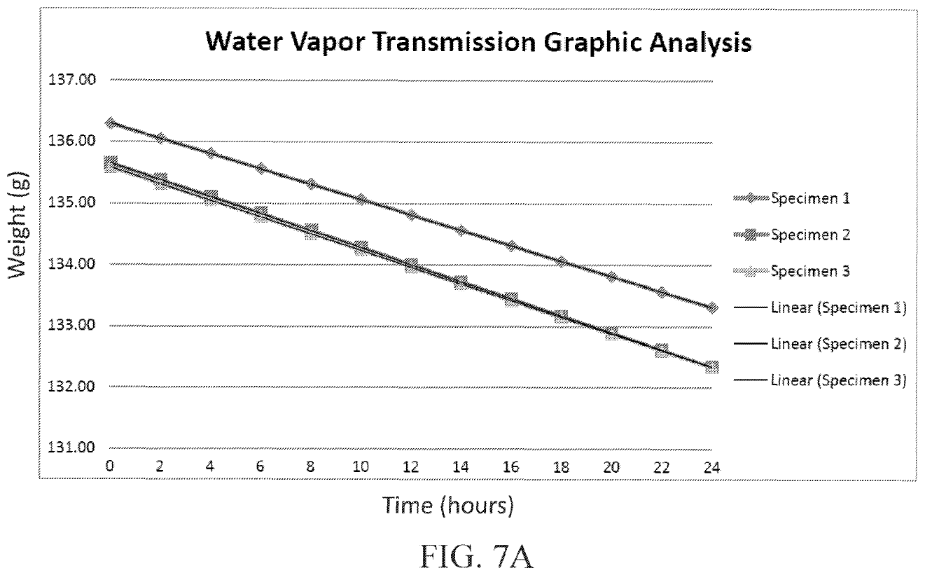

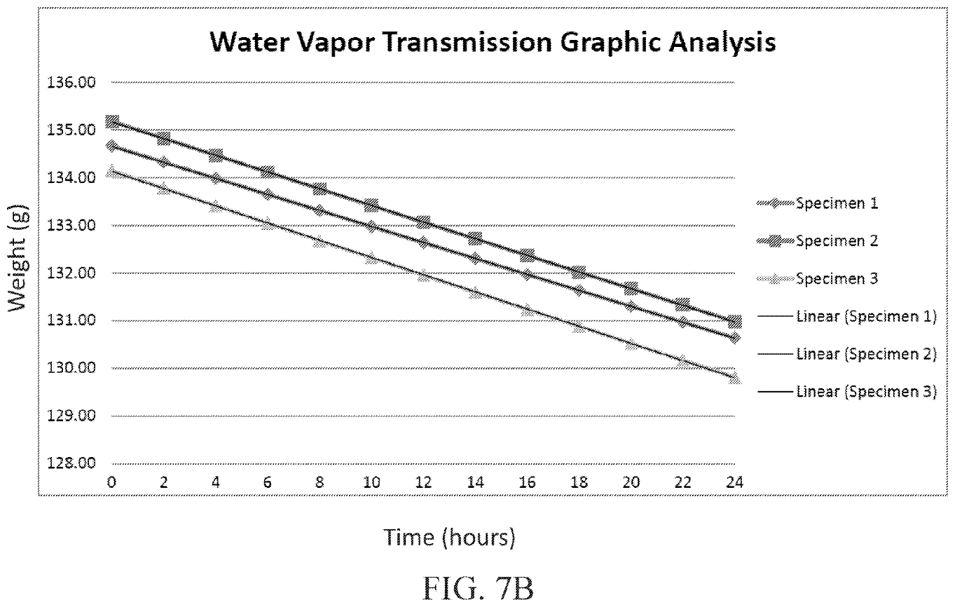

The results shown in FIGS. 4-7 and Tables 1-2 demonstrate a marked improvement in the wet CFR performance of silk fibroin fragments (Entry B2) deposited on Bodin Brown leather. The performance extends to at least 600 continuous cycles without deterioration in wet CFR performance and outperforms conventional crosslinked polyurethane systems.

Silk fibroin fragments provide enhanced water repellency that endures after the abrasion encountered during the Wet Veslic Rubbing as shown in FIG. 6.

### Example 2: Coating Aniline Leather

In some embodiments, the leather coating may contain multiple layers, including an optional adhesive layer, and a topcoat layer. The optional adhesive layer may contain bio-derived polyurethane (e.g., Biopur 3015), optionally silk fibroin fragments compositions (e.g., AS-104 LS), and a solvent (e.g., water). The bio-derived polyurethane content may be from 20% to 21%, from 21% to 22%, from 22% to 23%, or from 23% to 24%. The silk fibroin fragments compositions content may be 0.1%, 0.2%, 0.3%, 0.4%, 0.5%, 0.6%, 0.7%, 0.8%, 0.9%, or 1%.

The topcoat layer may contain a cellulose derivative, alcohol solvents, and a glycerin derivative (e.g., Solketal (AUGEO SL 191)). In some embodiments, the cellulose derivative is selected from methyl cellulose, ethyl cellulose, carboxymethyl cellulose, hydroxyethyl cellulose, hydroxypropyl cellulose, cellulose acetate, cellulose acetate propionate, cellulose acetate butyrate, and microcrystalline cellulose. The cellulose derivative content may be 1%, 2%, 3%, 4%, 5%, 6%, 7%, 8%, 9%, or 10%. The glycerin derivative content may be from 5% to 6%, from 6% to 7%, from 7% to 8%, from 8% to 9%, from 9% to 10%, from 10% to 11%, from 11% to 12%, from 12% to 13%, from 13% to 14%, or from 14% to 15%. Suitable solvents include, but are not limited to methanol, ethanol, acetone, isopropanol, n-Butanol, or combination thereof. The topcoat layer may contain 40% to 41%, 41% to 42%, 42% to 43%, 43% to 44%, 44% to 45%, 45% to 46%, 46% to 47%, 47% to 48%, 48% to 49%, or 49% to 50% ethanol. The topcoat layer may contain 30% to 31%, 31% to 32%, 32% to 33%, 33% to 34%, 34% to 35%, 35% to 36%, 36% to 37%, 37% to 38%, 38% to 39%, or 39% to 40% n-Butanol. Without wishing to be bound by any particular theory, it is believed that a solvent used in any layer described herein, would provide maximum benefit during a coating application step and/or method, and would thereafter be largely removed during a drying step and/or method. The application rate on the solids for the various layers may be from about 0.25 to about 1.5 g/ft², e.g., and without limitation, about 0.728 g/ft² for the optional adhesive layer, and from about 0.015 to about 0.15 g/ft², e.g., and without limitation, about 0.05 g/ft² for the topcoat layer. Table 3 below shows a non-limiting example of the topcoat and adhesive layer components.

TABLE 3
Adhesive and Topcoat Layers' components.

| Adhesive Layer | Topcoat Layer |
|---|---|
| Biopur 3015: 22.5% | Ethyl cellulose: 5% |
| Activated Silk (AS) 104 | Ethanol: 47.5% |
| LS: 0.5% (optional) | |
| Solvent (water) | n-Butanol: 33.25% |
| | Solketal (AUGEO SL |
| | 191): 9.5% |

### Example 3: Activated Silk on Nubuck Leather

### Purpose/Scope of the Study

The main purpose of this study was to evaluate the potential of silk fibroin fragments compositions (e.g., 117-AS) as dye fixing agent for leather. The idea was to compare classical fixing agents used in leather dyeing with silk fibroin fragments compositions and evaluate comparative performance as well as effect on leather (color & feel). The fixing agent that was used as reference is OPTIFIX E-50 liq, an aliphatic polyamine.

### Substrate Used/Preparations

Nubuck leather was used as a substrate dyed with a leather dye with poor rubbing fastness, DORAN IL ORANGE BROWN S3R, to be able to see the effect of fixing agents in fastness improvement. Nubuck was dyed with an offer of 4% plus 2% in top after acidification (on shaved weight). OPTIFIX ESO was used as a fixing agent this fixing agent is normally used in the wet-end stage, and it was applied as such at a temperature of 40° C.:
300% Water
0.2% Formic acid
Run 10′
2% Optifix ESO
Run 20′
0.4% Formic acid
Drain and wash
Dry to crust

The activated silk was applied in the finishing stage, through spraying.

Crosslinking of the activated silk was done through two different systems:
a. with CARTARETIN F liq. an aqueous solution of polyamidamine used in paper industry, and that has shown very good results as crosslinker of bio-based acrylics.
b. with MELIO 09-S-11 (Stahl)

TABLE 4
Preparations done.

| | 117 AS | | Melio | | Optifix | |
|---|---|---|---|---|---|---|
| reference | (sol 5%) | Cartaretin F | 09-S-11 | Water | E-50 | notes |
| 0 | | | | | | blank |
| | | | | | | reference |
| 1 | | | | | 2% | bath - |
| | | | | | | wet end |
| 2 | 17 | 8 | — | 75 | | spray |
| 3 | 25 | 12 | — | 63 | | spray |
| 4 | 35 | 16 | — | 49 | | spray |
| 5 | 17 | — | 8 | 75 | | spray |
| 6 | 25 | — | 12 | 63 | | spray |
| 7 | 35 | — | 16 | 49 | | spray |

### Additional Notes

Optifix E-50 liq was applied in separate bath, at pH 3.8-4.0, running 30 min, Amounts in refs. 2 to 7 are parts per 100. All of them applied by spraying, two crosses.

### Results

Pieces treated with different systems were allowed to cure during 24 hand brought to rubbing test, ISO 105-X12.

A summary of the results was collected in the table below:

TABLE 5
Results: change in color, feel & fastness

| | | change in | change in | Rubbing fastness | |
|---|---|---|---|---|---|
| reference | description | colour | touch | Dry | Wet |
| 0 | blank | — | — | 2-3 | 1-2 |
| 1 | Optifix E50 | 5 | 5 | 3 | 2-3 |
| 2 | 17% 117-AS + Cartaretin F | 2 | 3-4 | 4 | 3-4 |
| 3 | 25% 117-AS + Cartaretin F | 2-3 | 3 | 3-4 | 3-4 |
| 4 | 35% 117-AS + Cartaretin F | 3 | 2 | 4 | 3 |
| 5 | 17% 117-AS + Melio 09-S-11 | 3-4 | 4 | 4 | 2 |
| 6 | 25% 117-AS + Melio 09-S-11 | 3 | 4 | 3 | 2 |
| 7 | 35% 117-AS + Malio 09-S-11 | 3 | 3-4 | 3-4 | 2 |

Notes:
All valuations are in scale of 1 to 5, meaning:
change in color/touch: 5 minimum effect/change
rubbing fastness: 5 maximum resistance = minimum staining

### Conclusions

Dry rubbing fastness improvement with 117-AS was remarkable, in both systems. Wet rubbing fastness improvement was considerably lower, even nothing in the case of Isocyanate. The best scores were achieved with a moderate amount of 117-AS in the formulation (around 17%). The finishing spray always gives a filming effect not helping in nubuck leather.

### Example 4: Silk Solutions Used for Treating Leather

A number of silk solutions are prepared for the treatment of leather, as described in Table 6, and maybe used as described herein.

TABLE 6
Silk formulations for different stages of leather treatment.

| Type of Silk | Titration Agent (TA) | Formulation Process |
|---|---|---|
| 6% 1:1 | Ammonium Hydroxide | Mix 1 part low MW with 1 part med MW; Titrate stepwise |
| (L:M) pH 8 | | with dilute TA (1:100 stock) |
| 6% 2:1 | Ammonium Hydroxide | Mix 2 parts low MW with 1 part med MW; Titrate stepwise |
| (L:M) pH 8 | | with dilute TA (1:100 stock) |
| 6% 3:1 | Ammonium Hydroxide | Mix 3 parts low MW with 1 part med MW; Titrate stepwise |
| (L:M) pH 8 | | with dilute TA (1:100 stock) |
| 6% 4:1 | Ammonium Hydroxide | Mix 4 parts low MW with 1 part med MW; Titrate stepwise |
| (L:M) pH 8 | | with dilute TA (1:100 stock) |
| 6% 5:1 | Ammonium Hydroxide | Mix 5 parts low MW with 1 part med MW; Titrate stepwise |
| (L:M) pH 8 | | with dilute TA (1:100 stock) |
| 6% 6:1 | Ammonium Hydroxide | Mix 6 parts low MW with 1 part med MW; Titrate stepwise |
| (L:M) pH 8 | | with dilute TA (1:100 stock) |
| 6% 7:1 | Ammonium Hydroxide | Mix 7 parts low MW with 1 part med MW; Titrate stepwise |
| (L:M) pH 8 | | with dilute TA (1:100 stock) |
| 6% 8:1 | Ammonium Hydroxide | Mix 8 parts low MW with I part med MW; Titrate stepwise |
| (L:M) pH 8 | | with dilute TA (1:100 stock) |
| 6% 9:1 | Ammonium Hydroxide | Mix 9 parts low MW with 1 part med MW; Titrate stepwise |
| (L:M) pH 8 | | with dilute TA (1:100 stock) |
| 6% 1:2 | Ammonium Hydroxide | Mix 1 part low MW with 2 parts med MW; Titrate stepwise |
| (L:M) pH 8 | | with dilute TA (1:100 stock) |
| 6% 1:3 | Ammonium Hydroxide | Mix 1 part low MW with 3 parts med MW; Titrate stepwise |
| (L:M) pH 8 | | with dilute TA (1:100 stock) |
| 6% 1:4 | Ammonium Hydroxide | Mix 1 part low MW with 4 parts med MW; Titrate stepwise |
| (L:M) pH 8 | | with dilute TA (1:100 stock) |
| 6% 1:5 | Ammonium Hydroxide | Mix 1 part low MW with 5 parts med MW; Titrate stepwise |
| (L:M) pH 8 | | with dilute TA (1:100 stock) |
| 6% 1:6 | Ammonium Hydroxide | Mix 1 part low MW with 6 parts med MW; Titrate stepwise |
| (L:M) pH 8 | | with dilute TA (1:100 stock) |
| 6% 1:7 | Ammonium Hydroxide | Mix 1 part low MW with 7 parts med MW; Titrate stepwise |
| (L:M) pH 8 | | with dilute TA (1:100 stock) |
| 6% 1:8 | Ammonium Hydroxide | Mix 1 part low MW with 8 parts med MW; Titrate stepwise |
| (L:M) pH 8 | | with dilute TA (1:100 stock) |
| 6% 1:9 | Ammonium Hydroxide | Mix 1 part low MW with 9 parts med MW; Titrate stepwise |
| (L:M) pH 8 | | with dilute TA (1:100 stock) |
| 6% 1:1 | Acetic Acid | Mix 1 part low MW with 1 part med MW; Titrate stepwise |
| (L:M) pH 4 | | with stock TA |
| 6% 2:1 | Acetic Acid | Mix 2 parts low MW with 1 part med MW; Titrate stepwise |
| (L:M) pH 4 | | with stock TA |
| 6% 3:1 | Acetic Acid | Mix 3 parts low MW with 1 part med MW; Titrate stepwise |
| (L:M) pH 4 | | with stock TA |
| 6% 4:1 | Acetic Acid | Mix 4 parts low MW with 1 part med MW; Titrate stepwise |
| (L:M) pH 4 | | with stock TA |
| 6% 5:1 | Acetic Acid | Mix 5 parts low MW with 1 part med MW; Titrate stepwise |
| (L:M) pH 4 | | with stock TA |
| 6% 6:1 | Acetic Acid | Mix 6 parts low MW with 1 part med MW; Titrate stepwise |
| (L:M) pH 4 | | with stock TA |
| 6% 7:1 | Acetic Acid | Mix 7 parts low MW with 1 part med MW; Titrate stepwise |
| (L:M) pH 4 | | with stock TA |
| 6% 8:1 | Acetic Acid | Mix 8 parts low MW with 1 part med MW; Titrate stepwise |
| (L:M) pH 4 | | with stock TA |
| 6% 9:1 | Acetic Acid | Mix 9 parts low MW with 1 part med MW; Titrate stepwise |
| (L:M) pH 4 | | with stock TA |
| 6% 1:2 | Acetic Acid | Mix 1 part low MW with 2 parts med MW; Titrate stepwise |
| (L:M) pH 4 | | with stock TA |
| 6% 1:3 | Acetic Acid | Mix 1 part low MW with 3 parts med MW; Titrate stepwise |
| (L:M) pH 4 | | with stock TA |
| 6% 1:4 | Acetic Acid | Mix 1 part low MW with 4 parts med MW; Titrate stepwise |
| (L:M) pH 4 | | with stock TA |
| 6% 1:5 | Acetic Acid | Mix 1 part low MW with 5 parts med MW; Titrate stepwise |
| (L:M) pH 4 | | with stock TA |
| 6% 1:6 | Acetic Acid | Mix 1 part low MW with 6 parts med MW; Titrate stepwise |
| (L:M) pH 4 | | with stock TA |
| 6% 1:7 | Acetic Acid | Mix 1 part low MW with 7 parts med MW; Titrate stepwise |
| (L:M) pH 4 | | with stock TA |
| 6% 1:8 | Acetic Acid | Mix 1 part low MW with 8 parts med MW; Titrate stepwise |
| (L:M) pH 4 | | with stock TA |
| 6% 1:9 | Acetic Acid | Mix 1 part low MW with 9 parts med MW; Titrate stepwise |
| (L:M) pH 4 | | with stock TA |
| 1% 1:1 | Ammonium Hydroxide | Dilute silk stocks to 1% w/v; Mix 1 part low MW with 1 part |
| (L:M) pH 8 | | med MW; Titrate stepwise with dilute TA (1:100 stock) |
| 1% 2:1 | Ammonium Hydroxide | Dilute silk stocks to 1% w/v; Mix 2 parts low MW with 1 part |
| (L:M) pH 8 | | med MW; Titrate stepwise with dilute TA (1:100 stock) |
| 1% 3:1 | Ammonium Hydroxide | Dilute silk stocks to 1% w/v; Mix 3 parts low MW with 1 part |
| (L:M) pH 8 | | med MW; Titrate stepwise with dilute TA (1:100 stock) |
| 1% 4:1 | Ammonium Hydroxide | Dilute silk stocks to 1% w/v; Mix 4 parts low MW with 1 part |
| (L:M) pH 8 | | med MW; Titrate stepwise with dilute TA (1:100 stock) |
| 1% 5:1 | Ammonium Hydroxide | Dilute silk stocks to 1% w/v; Mix 5 parts low MW with 1 part |
| (L:M) pH 8 | | med MW; Titrate stepwise with dilute TA (1:100 stock) |
| 1% 6:1 | Ammonium Hydroxide | Dilute silk stocks to 1% w/v; Mix 6 parts low MW with 1 part |
| (L:M) pH 8 | | med MW; Titrate stepwise with dilute TA (1:100 stock) |
| 1% 7:1 | Ammonium Hydroxide | Dilute silk stocks to 1% w/v; Mix 7 parts low MW with 1 part |
| (L:M) pH 8 | | med MW; Titrate stepwise with dilute TA (1:100 stock) |
| 1% 8:1 | Ammonium Hydroxide | Dilute silk stocks to 1% w/v; Mix 8 parts low MW with 1 part |
| (L:M) pH 8 | | med MW; Titrate stepwise with dilute TA (1:100 stock) |
| 1% 9:1 | Ammonium Hydroxide | Dilute silk stocks to 1% w/v; Mix 9 parts low MW with 1 part |
| (L:M) pH 8 | | med MW; Titrate stepwise with dilute TA (1:100 stock) |
| 1% 1:2 | Ammonium Hydroxide | Dilute silk stocks to 1% w/v; Mix 1 part low MW with 2 parts |
| (L:M) pH 8 | | med MW; Titrate stepwise with dilute TA (1:100 stock) |
| 1% 1:3 | Ammonium Hydroxide | Dilute silk stocks to 1% w/v; Mix 1 part low MW with 3 parts |
| (L:M) pH 8 | | med MW; Titrate stepwise with dilute TA (1:100 stock) |
| 1% 1:4 | Ammonium Hydroxide | Dilute silk stocks to 1% w/v; Mix 1 part low MW with 4 parts |
| (L:M) pH 8 | | med MW; Titrate stepwise with dilute TA (1:100 stock) |
| 1% 1:5 | Ammonium Hydroxide | Dilute silk stocks to 1% w/v; Mix 1 part low MW with 5 parts |
| (L:M) pH 8 | | med MW; Titrate stepwise with dilute TA (1:100 stock) |
| 1% 1:6 | Ammonium Hydroxide | Dilute silk stocks to 1% w/v; Mix 1 part low MW with 6 parts |
| (L:M) pH 8 | | med MW; Titrate stepwise with dilute TA (1:100 stock) |
| 1% 1:7 | Ammonium Hydroxide | Dilute silk stocks to 1% w/v; Mix 1 part low MW with 7 parts |
| (L:M) pH 8 | | med MW; Titrate stepwise with dilute TA (1:100 stock) |
| 1% 1:8 | Ammonium Hydroxide | Dilute silk stocks to 1% w/v; Mix 1 part low MW with 8 parts |
| (L:M) pH 8 | | med MW; Titrate stepwise with dilute TA (1:100 stock) |
| 1% 1:9 | Ammonium Hydroxide | Dilute silk stocks to 1% w/v; Mix 1 part low MW with 9 parts |
| (L:M) pH 8 | | med MW; Titrate stepwise with dilute TA (1:100 stock) |
| 6% med pH 13 | Ammonium Hydroxide | Titrate 6% Med MW silk stepwise with dilute TA (1:100 stock) |
| 6% med pH 12 | Ammonium Hydroxide | Titrate 6% Med MW silk stepwise with dilute TA (1:100 stock) |
| 6% med pH 11 | Ammonium Hydroxide | Titrate 6% Med MW silk stepwise with dilute TA (1:100 stock) |
| 6% med pH 10 | Ammonium Hydroxide | Titrate 6% Med MW silk stepwise with dilute TA (1:100 stock) |
| 6% med pH 9 | Ammonium Hydroxide | Titrate 6% Med MW silk stepwise with dilute TA (1:100 stock) |
| 6% med pH 8 | Ammonium Hydroxide | Titrate 6% Med MW silk stepwise with dilute TA (1:100 stock) |
| 6% med pH 7 | Ammonium Hydroxide | Titrate 6% Med MW silk stepwise with dilute TA (1:100 stock) |
| | and/or Acetic Acid | |
| 6% low pH 6 | Acetic Acid | Titrate 6% low MW silk stepwise with stock TA |
| 6% low pH 5 | Acetic Acid | Titrate 6% low MW silk stepwise with stock TA |
| 6% low pH 4 | Acetic Acid | Titrate 6% low MW silk stepwise with stock TA |
| 6% med pH 3 | Acetic Acid | Titrate 6% med MW silk stepwise with stock TA |
| 6% low pH 2 | Acetic Acid | Titrate 6% low MW silk stepwise with stock TA |
| 1% low pH 6 | Acetic Acid | Dilute 6% silk low MW stock to 1% w/v; Titrate stepwise with |
| | | stock TA |
| 1% low pH 5 | Acetic Acid | Dilute 6% silk low MW stock to 1% w/v; Titrate stepwise with |
| | | stock TA |
| 1% low pH 4 | Acetic Acid | Dilute 6% silk low MW stock to 1% w/v; Titrate stepwise with |
| | | stock TA |
| 1% low pH 3 | Acetic Acid | Dilute 6% silk low MW stock to 1% w/v; Titrate stepwise with |
| | | stock TA |
| 1% low pH 2 | Acetic Acid | Dilute 6% silk low MW stock to 1% w/v; Titrate stepwise with |
| | | stock TA |
| 1% med pH 6 | Acetic Acid | Dilute 6% silk med MW stock to 1% w/v; Titrate stepwise with |
| | | stock TA |
| 1% med pH 5 | Acetic Acid | Dilute 6% silk med MW stock to 1% w/v; Titrate stepwise with |
| | | stock TA |
| 1% med pH 4 | Acetic Acid | Dilute 6% silk med MW stock to 1% w/v; Titrate stepwise with |
| | | stock TA |
| 1% med pH 3 | Acetic Acid | Dilute 6% silk med MW stock to 1% w/v; Titrate stepwise with |
| | | stock TA |
| 1% med pH 2 | Acetic Acid | Dilute 6% silk med MW stock to 1% w/v; Titrate stepwise with |
| | | stock TA |

Silk formulations as described herein may be used before, during, or after various leather processing steps, including:

Drying—Drying of hand and autosprayed skins may be done in production line ovens used during normal leather processing. The autosprayed skins may be dried one or more times in between one or more spray treatments, e.g., spray>dry>spray>dry. Oven temperature may vary between 70-75° C. and each dry round may last ˜25 seconds.

Stamping—Stamping may be used during the production process of leathers. During the process, a skin is compressed (treated side up) between two metal plates (approx. 5-6 m²), the top plate operating at 57° C. The skin is compressed at this temperature for 2 seconds at 100 kg/cm². Qualitatively speaking, the stamping process may add sheen to the leather sample.

Finiflex—A typical processing step for plongé leathers, this mechanical treatment may be used as a final step for silk-doped leathers. The skin is processed in two halves on this machine—the skin half is lifted into and compressed by a rotating heated metallic wheel (93° C.; 20 kg/m²; dwheel=0.3 m) for 4 seconds. The skin is then pulled out, flipped, and the other half is treated in the same way.

Uniflex—The Uniflex treatment is similar to the Finiflex treatment, used at the final stage of leather processing. During this process, a skin is fed onto a feeder belt into two pressing cylinders (each 0.3 m in diameter). The top cylinder is heated to 60° C., while the bottom cylinder is unheated. Together, the cylinders compress the skin at 30 bar for 3-5 seconds.

Polishing—The polisher shaves off some of the surface treatment(s) done on the leather in prior processing steps (physical abrasion). At earlier stages in leather processing this serves to “open up” the skin for more effective adhesion of fixation/pigmentation agents in a similar way to the mechanical stretching process which occurs right before trimming of the skins.

Autosprayer—Unless otherwise noted, when skins are sprayed using the in-house automatic spray machine they may be sprayed in one or more rounds with intermediate drying treatments. Spraying fluid (silk, silicone treatment, etc.) may be pumped into the nozzle feed lines at 3 bar, and fed into the nozzle inlet (D_{nozzle}=0.6 mm) at a pressure between 0.8-1.2 bar. The spray volume of the AUTO sprayer may vary between 0.8-1.0 g/ft². The residence volume of the spraying fluid may be approximately 2-2.5 L. Various silk formulations described herein may be able to be fed into such machine and sprayed evenly onto skins.

The hand spray process may involve one or more coats, e.g., two passes each of different orientation, coat 1 vertically oriented spray pattern, and coat 2 horizontally-oriented spray pattern, of silk deposited onto half of one skin, with the other half covered up as a control. Hand-spray coating volumes may be approximately 50 mL per coat.

6% coated skins may have a noticeably darker sheen when placed under viewing light, and may be slightly stiffer to the touch compared to the untreated control half.

### Example 5: Formulation Preparation

Materials: Selected salts include calcium chloride (CaCl₂)), sodium chloride (NaCl), magnesium sulfate heptahydrate (MgSO₄), guanidine hydrochloride (GdmCl), L-Arginine hydrochloride (ArgCl), urea, magnesium chloride (MgCl₂), calcium lactobionate (CaLact), ammonium sulfate {(NH₄)₂SO₄} and calcium sulfate dihydrate (CaSO₄). Plasticizer. Glycerol is used as plasticizer. AS-104 (6%) low molecular weight (14-30 kDa) is used as main components for film formation.

Prepare 20 mL of 1 M salts stock solution based on Table 7. Weight proper amount of solid salt and dissolve in 20 mL deionized water. After dissolving, using stirring plate to stir for 10 minutes. Then keep salts solution in fridge. Calcium lactobionate concentration is reduced to 0.5 M due to solubility limitation.

TABLE 7
Salt Stock Solution Preparation.

| | Weight | Concentration |
|---|---|---|
| Salts entry | (g) | (M) |
| Urea | 1.2 | 1.0 |
| Calcium sulfate | 3.4 | 1.0 |
| Calcium chloride | 2.2 | 1.0 |
| Sodium chloride | 1.2 | 1.0 |
| Calcium lactobionate | 7.6 | 0.5 |
| Magnesium chloride | 1.9 | 1.0 |
| Ammonium sulfate | 2.6 | 1.0 |
| Guanidinium chloride | 1.9 | 1.0 |
| L-Arginine hydrochloride | 4.2 | 1.0 |
| Magnesium sulfate | 4.9 | 1.0 |
| heptahydrate | | |

Prepared salts solution was stirred at room temperature for 10 minutes. Salts solutions are kept in fridge before use.

Weight 15 g of AS-104 silk solution, then mix it with 0.3 g glycerol. Place AS-104+glycerol mixture onto stirring plate and stir for 30 minutes. Then add 75, 150, 375 and 750 uL salt stock solutions into AS-104-Glycerol mixtures to make salts concentration as 5, 10, 25 and 50 mM. Continue to stir the mixture for 1 hour. Keep the stir bar rpm lower enough to avoid foaming. After 1 hour stirring, move mixture to vacuum and de-gas for 1 hour.

Thoroughly clean a silicone mold (3-in diameter), pre-wet silicone mold with deionized water and then cast around 10 g of prepared mixture onto silicone mold. Record mass of both silicone mold-alone and silicone mold+liquid mixture. Ensure liquid spreads and cover the entire bottom of silicone mold. Place silicone mold in incubator at 35 Celsius and 40% relative humidity. Dry the mixture for 12 hours.

### Example 6: Testing Method

Instron Tensile Testing: After 12 hours, bend the edge of silicone mold and peel off films. Trim films edge out and keep the middle part of films. Cut three 15 by 45 mm testing area. Measure and record film thickness before tensile testing. Trace out 10 mm on both ends of cut films. Use grinding paper to clap 10 mm and place sample on Instron Tester and set strain rate as 5 mm/minute. Shore A Hardness of Thin Films and Veslic testing was performed.

### Example 7: Results Summary

TABLE 8
Elongation and Tensile Strength of AS-104-based Films
Assisted by Various Salts and concentrations.

| Formulations | Elongation (%) | UTS (MPa) |
|---|---|---|
| 6% AS ™-104 | 4 ± 1 | 37.52 ± 9.71 |
| 6% AS ™-104 + 2% Glycerol | 38 ± 5 | 3.91 ± 0.24 |
| 6% AS ™-104 + 2% Glycerol + 5 mM GdmCl | 48 ± 18 | 1.53 ± 0.38 |
| 6% AS ™-104 + 2% Glycerol + 10 mM GdmCl | 27 ± 11 | 1.72 ± 0.48 |
| 6% AS ™-104 + 2% Glycerol + 25 mM GdmCl | 48 ± 26 | 1.02 ± 0.31 |
| 6% AS ™-104 + 2% Glycerol + 50 mM GdmCl | 18 ± 3 | 1.06 ± 0.15 |
| 6% AS ™-104 + 2% Glycerol + 5 mM NaCl | 28 ± 7 | 1.98 ± 0.54 |
| 6% AS ™-104 + 2% Glycerol + 10 mM NaCl | 40 ± 7 | 1.09 ± 0.05 |
| 6% AS ™-104 + 2% Glycerol + 25 mM NaCl | 32 ± 5 | 0.42 ± 0.10 |
| 6% AS ™-104 + 2% Glycerol + 50 mM NaCl | — | — |
| 6% AS ™-104 + 2% Glycerol + 5 mM Urea | 54 ± 35 | 1.53 ± 0.02 |
| 6% AS ™-104 + 2% Glycerol + 10 mM Urea | 32 ± 19 | 1.72 ± 0.38 |
| 6% AS ™-104 + 2% Glycerol + 25 mM Urea | 37 ± 7 | 1.92 ± 1.30 |
| 6% AS ™-104 + 2% Glycerol + 50 mM Urea | 40 ± 6 | 1.89 ± 0.18 |
| 6% AS ™-104 + 2% Glycerol + 5 mM ArgCl | 46 ± 9 | 1.33 ± 0.69 |
| 6% AS ™-104 + 2% Glycerol + 10 mM ArgCl | 38 ± 9 | 2.19 ± 0.32 |
| 6% AS ™-104 + 2% Glycerol + 25 mM ArgCl | 93 ± 36 | 0.33 ± 0.18 |
| 6% AS ™-104 + 2% Glycerol + 50 mM ArgCl | — | — |
| 6% AS ™-104 + 2% Glycerol + 5 mM MgSO₄ | 43 ± 39 | 1.79 ± 0.11 |
| 6% AS ™-104 + 2% Glycerol + 10 mM MgSO₄ | 118 ± 38 | 0.31 ± 0.19 |
| 6% AS ™-104 + 2% Glycerol + 25 mM MgSO₄ | 130 ± 8 | 1.69 ± 0.12 |
| 6% AS ™-104 + 2% Glycerol + 50 mM MgSO₄ | 351 ± 39 | 1.24 ± 1.45 |
| 6% AS ™-104 + 2% Glycerol + 5 mM NH₄SO₄ | 32 ± 13 | 2.67 ± 1.00 |
| 6% AS ™-104 + 2% Glycerol + 10 mM NH₄SO₄ | 59 ± 38 | 1.54 ± 0.25 |
| 6% AS ™-104 + 2% Glycerol + 25 mM NH₄SO₄ | 40 ± 28 | 1.70 ± 1.33 |
| 6% AS ™-104 + 2% Glycerol + 50 mM NH₄SO₄ | 65 ± 6 | 2.10 ± 0.28 |
| 6% AS ™-104 + 2% Glycerol + 5 mM CaCl₂ | 59 ± 8 | 1.67 ± 0.36 |
| 6% AS ™-104 + 2% Glycerol + 10 mM CaCl₂ | 56 ± 4 | 1.53 ± 0.16 |
| 6% AS ™-104 + 2% Glycerol + 25 mM CaCl₂ | — | — |
| 6% AS ™-104 + 2% Glycerol + 50 mM CaCl₂ | — | — |
| 6% AS ™-104 + 2% Glycerol + 5 mM MgCl₂ | 49 ± 4 | 1.69 ± 0.46 |
| 6% AS ™-104 + 2% Glycerol + 10 mM MgCl₂ | — | — |
| 6% AS ™-104 + 2% Glycerol + 25 mM MgCl₂ | 57 ± 19 | 2.14 ± 0.66 |
| 6% AS ™-104 + 2% Glycerol + 50 mM MgCl₂ | — | — |
| 6% AS ™-104 + 2% Glycerol + 5 mM CaSO₄ | — | — |
| 6% AS ™-104 + 2% Glycerol + 10 mM CaSO₄ | — | — |
| 6% AS ™-104 + 2% Glycerol + 25 mM CaSO₄ | 41 ± 2 | 0.84 ± 0.53 |
| 6% AS ™-104 + 2% Glycerol + 50 mM CaSO₄ | 43 ± 10 | 1.52 ± 0.21 |
| 6% AS ™-104 + 2% Glycerol + 5 mM CaLact | — | — |
| 6% AS ™-104 + 2% Glycerol + 10 mM CaLact | — | — |
| 6% AS ™-104 + 2% Glycerol + 25 mM CaLact | — | — |
| 6% AS ™-104 + 2% Glycerol + 50 mM CaLact | 105 ± 38 | 0.38 ± 0.16 |
| 6% AS ™-104 + 2% Glycerol + 100 mM CaLact | 128 ± 53 | 0.31 ± 0.09 |

TABLE 9
Shore A Hardness of AS-104-based Films Assisted
by Various Salts and concentrations.

| | Shore |
|---|---|
| Formulations | Hardness |
| 6% AS ™-104 | 60 |
| 6% AS ™-104 + 2% Glycerol | 44 |
| 6% AS ™-104 + 2% Glycerol + 5 mM ArgCl | 43 |
| 6% AS ™-104 + 2% Glycerol + 10 mM ArgCl | 43 |
| 6% AS ™-104 + 2% Glycerol + 25 mM ArgCl | 33 |
| 6% AS ™-104 + 2% Glycerol + 50 mM ArgCl | 35 |
| 6% AS ™-104 + 2% Glycerol + 50 mM MgSO₄ | 31 |
| 6% AS ™-104 + 2% Glycerol + 5 mM CaCl₂ | 37 |
| 6% AS ™-104 + 2% Glycerol + 10 mM CaCl₂ | 33 |
| 6% AS ™-104 + 2% Glycerol + 25 mM CaCl₂ | 12 |
| 6% AS ™-104 + 2% Glycerol + 50 mM CaCl₂ | 10 |

TABLE 10
Combination Formulations

| | Chemical | Particular | |
|---|---|---|---|
| Type | Classes | Products | Formulations |
| Crosslinkers | Polyisocyanates | Melio 09S11 (Stahl) | 15% AS-104-LS + 0.5% Melio 09S11 |
| | | | 15% AS-104-LS + 1% Melio 09S11 |
| | | | 15% AS-104-LS + 1.5% Melio 09S11 |
| | | | 15% AS-104-LS + 2% Melio 09S11 |
| | | | 15% AS-104-LS + 2.5% Melio 09S11 |
| | | | 15% AS-104-LS + 3% Melio 09S11 |
| | | | 15% AS-104-LS + 3.5% Melio 09S11 |
| | | | 15% AS-104-LS + 4% Melio 09S11 |
| | | | 15% AS-104-LS + 4.5% Melio 09S11 |
| | | | 15% AS-104-LS + 5% Melio 09S11 |
| | | | 15% AS-104-LS + 5.5% Melio 09S11 |
| | | | 15% AS-104-LS + 6% Melio 09S11 |
| | | | 15% AS-104-LS + 6.5% Melio 09S11 |
| | | | 15% AS-104-LS + 7% Melio 09S11 |
| | | | 15% AS-104-LS + 7.5% Melio 09S11 |
| | | | 15% AS-104-LS + 8% Melio 09S11 |
| | | | 15% AS-104-LS + 8.5% Melio 09S11 |
| | | | 15% AS-104-LS + 9% Melio 09S11 |
| | | | 15% AS-104-LS + 9.5% Melio 09S11 |
| | | | 15% AS-104-LS + 10% Melio 09S11 |
| | | | 16% AS-104-LS + 0.5% Melio 09S11 |
| | | | 16% AS-104-LS + 1% Melio 09S11 |
| | | | 16% AS-104-LS + 1.5% Melio 09S11 |
| | | | 16% AS-104-LS + 2% Melio 09S11 |
| | | | 16% AS-104-LS + 2.5% Melio 09S11 |
| | | | 16% AS-104-LS + 3% Melio 09S11 |
| | | | 16% AS-104-LS + 3.5% Melio 09S11 |
| | | | 16% AS-104-LS + 4% Melio 09S11 |
| | | | 16% AS-104-LS + 4.5% Melio 09S11 |
| | | | 16% AS-104-LS + 5% Melio 09S11 |
| | | | 16% AS-104-LS + 5.5% Melio 09S11 |
| | | | 16% AS-104-LS + 6% Melio 09S11 |
| | | | 16% AS-104-LS + 6.5% Melio 09S11 |
| | | | 16% AS-104-LS + 7% Melio 09S11 |
| | | | 16% AS-104-LS + 7.5% Melio 09S11 |
| | | | 16% AS-104-LS + 8% Melio 09S11 |
| | | | 16% AS-104-LS + 8.5% Melio 09S11 |
| | | | 16% AS-104-LS + 9% Melio 09S11 |
| | | | 16% AS-104-LS + 9.5% Melio 09S11 |
| | | | 16% AS-104-LS + 10% Melio 09S11 |
| | | | 17% AS-104-LS (=1% SF solids) + 0.5% Melio 09S11 |
| | | | 17% AS-104-LS (=1% SF solids) + 1% Melio 09S11 |
| | | | 17% AS-104-LS (=1% SF solids) + 1.5% Melio 09S11 |
| | | | 17% AS-104-LS (=1% SF solids) + 2% Melio 09S11 |
| | | | 17% AS-104-LS (=1% SF solids) + 2.5% Melio 09S11 |
| | | | 17% AS-104-LS (=1% SF solids) + 3% Melio 09S11 |
| | | | 17% AS-104-LS (=1% SF solids) + 3.5% Melio 09S11 |
| | | | 17% AS-104-LS (=1% SF solids) + 4% Melio 09S11 |
| | | | 17% AS-104-LS (=1% SF solids) + 4.5% Melio 09S11 |
| | | | 17% AS-104-LS (=1% SF solids) + 5% Melio 09S11 |
| | | | 17% AS-104-LS (=1% SF solids) + 5.5% Melio 09S11 |
| | | | 17% AS-104-LS (=1% SF solids) + 6% Melio 09S11 |
| | | | 17% AS-104-LS (=1% SF solids) + 6.5% Melio 09S11 |
| | | | 17% AS-104-LS (=1% SF solids) + 7% Melio 09S11 |
| | | | 17% AS-104-LS (=1% SF solids) + 7.5% Melio 09S11 |
| | | | 17% AS-104-LS (=1% SF solids) + 8% Melio 09S11 |
| | | | 17% AS-104-LS (=1% SF solids) + 8.5% Melio 09S11 |
| | | | 17% AS-104-LS (=1% SF solids) + 9% Melio 09S11 |
| | | | 17% AS-104-LS (=1% SF solids) + 9.5% Melio 09S11 |
| | | | 17% AS-104-LS (=1% SF solids) + 10% Melio 09S11 |
| | | | 18% AS-104-LS + 0.5% Melio 09S11 |
| | | | 18% AS-104-LS + 1% Melio 09S11 |
| | | | 18% AS-104-LS + 1.5% Melio 09S11 |
| | | | 18% AS-104-LS + 2% Melio 09S11 |
| | | | 18% AS-104-LS + 2.5% Melio 09S11 |
| | | | 18% AS-104-LS + 3% Melio 09S11 |
| | | | 18% AS-104-LS + 3.5% Melio 09S11 |
| | | | 18% AS-104-LS + 4% Melio 09S11 |
| | | | 18% AS-104-LS + 4.5% Melio 09S11 |
| | | | 18% AS-104-LS + 5% Melio 09S11 |
| | | | 18% AS-104-LS + 5.5% Melio 09S11 |
| | | | 18% AS-104-LS + 6% Melio 09S11 |
| | | | 18% AS-104-LS + 6.5% Melio 09S11 |
| | | | 18% AS-104-LS + 7% Melio 09S11 |
| | | | 18% AS-104-LS + 7.5% Melio 09S11 |
| | | | 18% AS-104-LS + 8% Melio 09S11 |
| | | | 18% AS-104-LS + 8.5% Melio 09S11 |
| | | | 18% AS-104-LS + 9% Melio 09S11 |
| | | | 18% AS-104-LS + 9.5% Melio 09S11 |
| | | | 18% AS-104-LS + 10% Melio 09S11 |
| | | | 19% AS-104-LS + 0.5% Melio 09S11 |
| | | | 19% AS-104-LS + 1% Melio 09S11 |
| | | | 19% AS-104-LS + 1.5% Melio 09S11 |
| | | | 19% AS-104-LS + 2% Melio 09S11 |
| | | | 19% AS-104-LS + 2.5% Melio 09S11 |
| | | | 19% AS-104-LS + 3% Melio 09S11 |
| | | | 19% AS-104-LS + 3.5% Melio 09S11 |
| | | | 19% AS-104-LS + 4% Melio 09S11 |
| | | | 19% AS-104-LS + 4.5% Melio 09S11 |
| | | | 19% AS-104-LS + 5% Melio 09S11 |
| | | | 19% AS-104-LS + 5.5% Melio 09S11 |
| | | | 19% AS-104-LS + 6% Melio 09S11 |
| | | | 19% AS-104-LS + 6.5% Melio 09S11 |
| | | | 19% AS-104-LS + 7% Melio 09S11 |
| | | | 19% AS-104-LS + 7.5% Melio 09S11 |
| | | | 19% AS-104-LS + 8% Melio 09S11 |
| | | | 19% AS-104-LS + 8.5% Melio 09S11 |
| | | | 19% AS-104-LS + 9% Melio 09S11 |
| | | | 19% AS-104-LS + 9.5% Melio 09S11 |
| | | | 19% AS-104-LS + 10% Melio 09S11 |
| | | | 20% AS-104-LS + 0.5% Melio 09S11 |
| | | | 20% AS-104-LS + 1% Melio 09S11 |
| | | | 20% AS-104-LS + 1.5% Melio 09S11 |
| | | | 20% AS-104-LS + 2% Melio 09S11 |
| | | | 20% AS-104-LS + 2.5% Melio 09S11 |
| | | | 20% AS-104-LS + 3% Melio 09S11 |
| | | | 20% AS-104-LS + 3.5% Melio 09S11 |
| | | | 20% AS-104-LS + 4% Melio 09S11 |
| | | | 20% AS-104-LS + 4.5% Melio 09S11 |
| | | | 20% AS-104-LS + 5% Melio 09S11 |
| | | | 20% AS-104-LS + 5.5% Melio 09S11 |
| | | | 20% AS-104-LS + 6% Melio 09S11 |
| | | | 20% AS-104-LS + 6.5% Melio 09S11 |
| | | | 20% AS-104-LS + 7% Melio 09S11 |
| | | | 20% AS-104-LS + 7.5% Melio 09S11 |
| | | | 20% AS-104-LS + 8% Melio 09S11 |
| | | | 20% AS-104-LS + 8.5% Melio 09S11 |
| | | | 20% AS-104-LS + 9% Melio 09S11 |
| | | | 20% AS-104-LS + 9.5% Melio 09S11 |
| | | | 20% AS-104-LS + 10% Melio 09S11 |
| | | Roda Link C 70 (TFL) | 15% AS-104-LS + 0.5% Roda Link C70 |
| | | | 15% AS-104-LS + 1% Roda Link C70 |
| | | | 15% AS-104-LS + 1.5% Roda Link C70 |
| | | | 15% AS-104-LS + 2% Roda Link C70 |
| | | | 15% AS-104-LS + 2.5% Roda Link C70 |
| | | | 15% AS-104-LS + 3% Roda Link C70 |
| | | | 15% AS-104-LS + 3.5% Roda Link C70 |
| | | | 15% AS-104-LS + 4% Roda Link C70 |
| | | | 15% AS-104-LS + 4.5% Roda Link C70 |
| | | | 15% AS-104-LS + 5% Roda Link C70 |
| | | | 15% AS-104-LS + 5.5% Roda Link C70 |
| | | | 15% AS-104-LS + 6% Roda Link C70 |
| | | | 15% AS-104-LS + 6.5% Roda Link C70 |
| | | | 15% AS-104-LS + 7% Roda Link C70 |
| | | | 15% AS-104-LS + 7.5% Roda Link C70 |
| | | | 15% AS-104-LS + 8% Roda Link C70 |
| | | | 15% AS-104-LS + 8.5% Roda Link C70 |
| | | | 15% AS-104-LS + 9% Roda Link C70 |
| | | | 15% AS-104-LS + 9.5% Roda Link C70 |
| | | | 15% AS-104-LS + 10% Roda Link C70 |
| | | | 16% AS-104-LS + 0.5% Roda Link C70 |
| | | | 16% AS-104-LS + 1% Roda Link C70 |
| | | | 16% AS-104-LS + 1.5% Roda Link C70 |
| | | | 16% AS-104-LS + 2% Roda Link C70 |
| | | | 16% AS-104-LS + 2.5% Roda Link C70 |
| | | | 16% AS-104-LS + 3% Roda Link C70 |
| | | | 16% AS-104-LS + 3.5% Roda Link C70 |
| | | | 16% AS-104-LS + 4% Roda Link C70 |
| | | | 16% AS-104-LS + 4.5% Roda Link C70 |
| | | | 16% AS-104-LS + 5% Roda Link C70 |
| | | | 16% AS-104-LS + 5.5% Roda Link C70 |
| | | | 16% AS-104-LS + 6% Roda Link C70 |
| | | | 16% AS-104-LS + 6.5% Roda Link C70 |
| | | | 16% AS-104-LS + 7% Roda Link C70 |
| | | | 16% AS-104-LS + 7.5% Roda Link C70 |
| | | | 16% AS-104-LS + 8% Roda Link C70 |
| | | | 16% AS-104-LS + 8.5% Roda Link C70 |
| | | | 16% AS-104-LS + 9% Roda Link C70 |
| | | | 16% AS-104-LS + 9.5% Roda Link C70 |
| | | | 16% AS-104-LS + 10% Roda Link C70 |
| | | | 17% AS-104-LS (=1% SF solids) + 0.5% Roda Link C70 |
| | | | 17% AS-104-LS (=1% SF solids) + 1% Roda Link C70 |
| | | | 17% AS-104-LS (=1% SF solids) + 1.5% Roda Link C70 |
| | | | 17% AS-104-LS (=1% SF solids) + 2% Roda Link C70 |
| | | | 17% AS-104-LS (=1% SF solids) + 2.5% Roda Link C70 |
| | | | 17% AS-104-LS (=1% SF solids) + 3% Roda Link C70 |
| | | | 17% AS-104-LS (=1% SF solids) + 3.5% Roda Link C70 |
| | | | 17% AS-104-LS (=1% SF solids) + 4% Roda Link C70 |
| | | | 17% AS-104-LS (=1% SF solids) + 4.5% Roda Link C70 |
| | | | 17% AS-104-LS (=1% SF solids) + 5% Roda Link C70 |
| | | | 17% AS-104-LS (=1% SF solids) + 5.5% Roda Link C70 |
| | | | 17% AS-104-LS (=1% SF solids) + 6% Roda Link C70 |
| | | | 17% AS-104-LS (=1% SF solids) + 6.5% Roda Link C70 |
| | | | 17% AS-104-LS (=1% SF solids) + 7% Roda Link C70 |
| | | | 17% AS-104-LS (=1% SF solids) + 7.5% Roda Link C70 |
| | | | 17% AS-104-LS (=1% SF solids) + 8% Roda Link C70 |
| | | | 17% AS-104-LS (=1% SF solids) + 8.5% Roda Link C70 |
| | | | 17% AS-104-LS (=1% SF solids) + 9% Roda Link C70 |
| | | | 17% AS-104-LS (=1% SF solids) + 9.5% Roda Link C70 |
| | | | 17% AS-104-LS (=1% SF solids) + 10% Roda Link C70 |
| | | | 18% AS-104-LS + 0.5% Roda Link C70 |
| | | | 18% AS-104-LS + 1% Roda Link C70 |
| | | | 18% AS-104-LS + 1.5% Roda Link C70 |
| | | | 18% AS-104-LS + 2% Roda Link C70 |
| | | | 18% AS-104-LS + 2.5% Roda Link C70 |
| | | | 18% AS-104-LS + 3% Roda Link C70 |
| | | | 18% AS-104-LS + 3.5% Roda Link C70 |
| | | | 18% AS-104-LS + 4% Roda Link C70 |
| | | | 18% AS-104-LS + 4.5% Roda Link C70 |
| | | | 18% AS-104-LS + 5% Roda Link C70 |
| | | | 18% AS-104-LS + 5.5% Roda Link C70 |
| | | | 18% AS-104-LS + 6% Roda Link C70 |
| | | | 18% AS-104-LS + 6.5% Roda Link C70 |
| | | | 18% AS-104-LS + 7% Roda Link C70 |
| | | | 18% AS-104-LS + 7.5% Roda Link C70 |
| | | | 18% AS-104-LS + 8% Roda Link C70 |
| | | | 18% AS-104-LS + 8.5% Roda Link C70 |
| | | | 18% AS-104-LS + 9% Roda Link C70 |
| | | | 18% AS-104-LS + 9.5% Roda Link C70 |
| | | | 18% AS-104-LS + 10% Roda Link C70 |
| | | | 19% AS-104-LS + 0.5% Roda Link C70) |
| | | | 19% AS-104-LS + 1% Roda Link C70 |
| | | | 19% AS-104-LS + 1.5% Roda Link C70 |
| | | | 19% AS-104-LS + 2% Roda Link C70 |
| | | | 19% AS-104-LS + 2.5% Roda Link C70 |
| | | | 19% AS-104-LS + 3% Roda Link C70 |
| | | | 19% AS-104-LS + 3.5% Roda Link C70 |
| | | | 19% AS-104-LS + 4% Roda Link C70 |
| | | | 19% AS-104-LS + 4.5% Roda Link C70 |
| | | | 19% AS-104-LS + 5% Roda Link C70 |
| | | | 19% AS-104-LS + 5.5% Roda Link C70 |
| | | | 19% AS-104-LS + 6% Roda Link C70 |
| | | | 19% AS-104-LS + 6.5% Roda Link C70 |
| | | | 19% AS-104-LS + 7% Roda Link C70 |
| | | | 19% AS-104-LS + 7.5% Roda Link C70 |
| | | | 19% AS-104-LS + 8% Roda Link C70 |
| | | | 19% AS-104-LS + 8.5% Roda Link C70 |
| | | | 19% AS-104-LS + 9% Roda Link C70 |
| | | | 19% AS-104-LS + 9.5% Roda Link C70 |
| | | | 19% AS-104-LS + 10% Roda Link C70 |
| | | | 20% AS-104-LS + 0.5% Roda Link C70 |
| | | | 20% AS-104-LS + 1% Roda Link C70 |
| | | | 20% AS-104-LS + 1.5% Roda Link C70 |
| | | | 20% AS-104-LS + 2% Roda Link C70 |
| | | | 20% AS-104-LS + 2.5% Roda Link C70 |
| | | | 20% AS-104-LS + 3% Roda Link C70 |
| | | | 20% AS-104-LS + 3.5% Roda Link C70 |
| | | | 20% AS-104-LS + 4% Roda Link C70 |
| | | | 20% AS-104-LS + 4.5% Roda Link C70 |
| | | | 20% AS-104-LS + 5% Roda Link C70 |
| | | | 20% AS-104-LS + 5.5% Roda Link C70) |
| | | | 20% AS-104-LS + 6% Roda Link C70 |
| | | | 20% AS-104-LS + 6.5% Roda Link C70 |
| | | | 20% AS-104-LS + 7% Roda Link C70 |
| | | | 20% AS-104-LS + 7.5% Roda Link C70 |
| | | | 20% AS-104-LS + 8% Roda Link C70 |
| | | | 20% AS-104-LS + 8.5% Roda Link C70 |
| | | | 20% AS-104-LS + 9% Roda Link C70 |
| | | | 20% AS-104-LS + 9.5% Roda Link C70 |
| | | | 20% AS-104-LS + 10% Roda Link C70 |
| | | XR-5350 (Stahl) | 15% AS-104-LS + 5% XR-5350 |
| | | | 15% AS-104-LS + 5.5% XR-5350 |
| | | | 15% AS-104-LS + 6% XR-5350 |
| | | | 15% AS-104-LS + 6.5% XR-5350 |
| | | | 15% AS-104-LS + 7% XR-5350 |
| | | | 15% AS-104-LS + 7.5% XR-5350 |
| | | | 15% AS-104-LS + 8% XR-5350 |
| | | | 15% AS-104-LS + 8.5% XR-5350 |
| | | | 15% AS-104-LS + 9% XR-5350 |
| | | | 15% AS-104-LS + 9.5% XR-5350 |
| | | | 15% AS-104-LS + 10% XR-5350 |
| | | | 15% AS-104-LS + 10.5% XR-5350 |
| | | | 15% AS-104-LS + 11% XR-5350 |
| | | | 15% AS-104-LS + 11.5% XR-5350 |
| | | | 15% AS-104-LS + 12% XR-5350 |
| | | | 15% AS-104-LS + 12.5% XR-5350 |
| | | | 15% AS-104-LS + 13% XR-5350 |
| | | | 15% AS-104-LS + 13.5% XR-5350 |
| | | | 15% AS-104-LS + 14% XR-5350 |
| | | | 15% AS-104-LS + 14.5% XR-5350 |
| | | | 15% AS-104-LS + 15% XR-5350 |
| | | | 16% AS-104-LS + 5% XR-5350 |
| | | | 16% AS-104-LS + 5.5% XR-5350 |
| | | | 16% AS-104-LS + 6% XR-5350 |
| | | | 16% AS-104-LS + 6.5% XR-5350 |
| | | | 16% AS-104-LS + 7% XR-5350 |
| | | | 16% AS-104-LS + 7.5% XR-5350 |
| | | | 16% AS-104-LS + 8% XR-5350 |
| | | | 16% AS-104-LS + 8.5% XR-5350 |
| | | | 16% AS-104-LS + 9% XR-5350 |
| | | | 16% AS-104-LS + 9.5% XR-5350 |
| | | | 16% AS-104-LS + 10% XR-5350 |
| | | | 16% AS-104-LS + 10.5% XR-5350 |
| | | | 16% AS-104-LS + 11% XR-5350 |
| | | | 16% AS-104-LS + 11.5% XR-5350 |
| | | | 16% AS-104-LS + 12% XR-5350 |
| | | | 16% AS-104-LS + 12.5% XR-5350 |
| | | | 16% AS-104-LS + 13% XR-5350 |
| | | | 16% AS-104-LS + 13.5% XR-5350 |
| | | | 16% AS-104-LS + 14% XR-5350 |
| | | | 16% AS-104-LS + 14.5% XR-5350 |
| | | | 16% AS-104-LS + 15% XR-5350 |
| | | | 17% AS-104-LS (=1% SF solids) + 5% XR-5350 |
| | | | 17% AS-104-LS (=1% SF solids) + 5.5% XR-5350 |
| | | | 17% AS-104-LS (=1% SF solids) + 6% XR-5350 |
| | | | 17% AS-104-LS (=1% SF solids) + 6.5% XR-5350 |
| | | | 17% AS-104-LS (=1% SF solids) + 7% XR-5350 |
| | | | 17% AS-104-LS (=1% SF solids) + 7.5% XR-5350 |
| | | | 17% AS-104-LS (=1% SF solids) + 8% XR-5350 |
| | | | 17% AS-104-LS (=1% SF solids) + 8.5% XR-5350 |
| | | | 17% AS-104-LS (=1% SF solids) + 9% XR-5350 |
| | | | 17% AS-104-LS (=1% SF solids) + 9.5% XR-5350 |
| | | | 17% AS-104-LS (=1% SF solids) + 10% XR-5350 |
| | | | 17% AS-104-LS (=1% SF solids) + 10.5% XR-5350 |
| | | | 17% AS-104-LS (=1% SF solids) + 11% XR-5350 |
| | | | 17% AS-104-LS (=1% SF solids) + 11.5% XR-5350 |
| | | | 17% AS-104-LS (=1% SF solids) + 12% XR-5350 |
| | | | 17% AS-104-LS (=1% SF solids) + 12.5% XR-5350 |
| | | | 17% AS-104-LS (=1% SF solids) + 13% XR-5350 |
| | | | 17% AS-104-LS (=1% SF solids) + 13.5% XR-5350 |
| | | | 17% AS-104-LS (=1% SF solids) + 14% XR-5350 |
| | | | 17% AS-104-LS (=1% SF solids) + 14.5% XR-5350 |
| | | | 17% AS-104-LS (=1% SF solids) + 15% XR-5350 |
| | | | 18% AS-104-LS + 5% XR-5350 |
| | | | 18% AS-104-LS + 5.5% XR-5350 |
| | | | 18% AS-104-LS + 6% XR-5350 |
| | | | 18% AS-104-LS + 6.5% XR-5350 |
| | | | 18% AS-104-LS + 7% XR-5350 |
| | | | 18% AS-104-LS + 7.5% XR-5350 |
| | | | 18% AS-104-LS + 8% XR-5350 |
| | | | 18% AS-104-LS + 8.5% XR-5350 |
| | | | 18% AS-104-LS + 9% XR-5350 |
| | | | 18% AS-104-LS + 9.5% XR-5350 |
| | | | 18% AS-104-LS + 10% XR-5350 |
| | | | 18% AS-104-LS + 10.5% XR-5350 |
| | | | 18% AS-104-LS + 11% XR-5350 |
| | | | 18% AS-104-LS + 11.5% XR-5350 |
| | | | 18% AS-104-LS + 12% XR-5350 |
| | | | 18% AS-104-LS + 12.5% XR-5350 |
| | | | 18% AS-104-LS + 13% XR-5350 |
| | | | 18% AS-104-LS + 13.5% XR-5350 |
| | | | 18% AS-104-LS + 14% XR-5350 |
| | | | 18% AS-104-LS + 14.5% XR-5350 |
| | | | 18% AS-104-LS + 15% XR-5350 |
| | | | 19% AS-104-LS + 5% XR-5350 |
| | | | 19% AS-104-LS + 5.5% XR-5350 |
| | | | 19% AS-104-LS + 6% XR-5350 |
| | | | 19% AS-104-LS + 6.5% XR-5350 |
| | | | 19% AS-104-LS + 7% XR-5350 |
| | | | 19% AS-104-LS + 7.5% XR-5350 |
| | | | 19% AS-104-LS + 8% XR-5350 |
| | | | 19% AS-104-LS + 8.5% XR-5350 |
| | | | 19% AS-104-LS + 9% XR-5350 |
| | | | 19% AS-104-LS + 9.5% XR-5350 |
| | | | 19% AS-104-LS + 10% XR-5350 |
| | | | 19% AS-104-LS + 10.5% XR-5350 |
| | | | 19% AS-104-LS + 11% XR-5350 |
| | | | 19% AS-104-LS + 11.5% XR-5350 |
| | | | 19% AS-104-LS + 12% XR-5350 |
| | | | 19% AS-104-LS + 12.5% XR-5350 |
| | | | 19% AS-104-LS + 13% XR-5350 |
| | | | 19% AS-104-LS + 13.5% XR-5350 |
| | | | 19% AS-104-LS + 14% XR-5350 |
| | | | 19% AS-104-LS + 14.5% XR-5350 |
| | | | 19% AS-104-LS + 15% XR-5350 |
| | | | 20% AS-104-LS + 5% XR-5350 |
| | | | 20% AS-104-LS + 5.5% XR-5350 |
| | | | 20% AS-104-LS + 6% XR-5350 |
| | | | 20% AS-104-LS + 6.5% XR-5350 |
| | | | 20% AS-104-LS + 7% XR-5350 |
| | | | 20% AS-104-LS + 7.5% XR-5350 |
| | | | 20% AS-104-LS + 8% XR-5350 |
| | | | 20% AS-104-LS + 8.5% XR-5350 |
| | | | 20% AS-104-LS + 9% XR-5350 |
| | | | 20% AS-104-LS + 9.5% XR-5350 |
| | | | 20% AS-104-LS + 10% XR-5350 |
| | | | 20% AS-104-LS + 10.5% XR-5350 |
| | | | 20% AS-104-LS + 11% XR-5350 |
| | | | 20% AS-104-LS + 11.5% XR-5350 |
| | | | 20% AS-104-LS + 12% XR-5350 |
| | | | 20% AS-104-LS + 12.5% XR-5350 |
| | | | 20% AS-104-LS + 13% XR-5350 |
| | | | 20% AS-104-LS + 13.5% XR-5350 |
| | | | 20% AS-104-LS + 14% XR-5350 |
| | | | 20% AS-104-LS + 14.5% XR-5350 |
| | | | 20% AS-104-LS + 15% XR-5350 |
| | Polyaziridines | Aqualen AKU | 30% AS-104-LS + 0.05% Aqualen AKU |
| | | (OR equivalent | 30% AS-104-LS + 0.10% Aqualen AKU |
| | | Picassian XL-048 | 30% AS-104-LS + 0.15% Aqualen AKU |
| | | (Stahl) OR | 30% AS-104-LS + 0.20% Aqualen AKU |
| | | equivalent | 30% AS-104-LS + 0.25% Aqualen AKU |
| | | Picassian XL-746 | 30% AS-104-LS + 0.30% Aqualen AKU |
| | | (Stahl)) | 30% AS-104-LS + 0.35% Aqualen AKU |
| | | | 30% AS-104-LS + 0.40% Aqualen AKU |
| | | | 30% AS-104-LS + 0.45% Aqualen AKU |
| | | | 30% AS-104-LS + 0.50% Aqualen AKU |
| | | | 31% AS-104-LS + 0.05% Aqualen AKU |
| | | | 31% AS-104-LS + 0.10% Aqualen AKU |
| | | | 31% AS-104-LS + 0.15% Aqualen AKU |
| | | | 31% AS-104-LS + 0.20% Aqualen AKU |
| | | | 31% AS-104-LS + 0.25% Aqualen AKU |
| | | | 31% AS-104-LS + 0.30% Aqualen AKU |
| | | | 31% AS-104-LS + 0.35% Aqualen AKU |
| | | | 31% AS-104-LS + 0.40% Aqualen AKU |
| | | | 31% AS-104-LS + 0.45% Aqualen AKU |
| | | | 31% AS-104-LS + 0.50% Aqualen AKU |
| | | | 32% AS-104-LS + 0.05% Aqualen AKU |
| | | | 32% AS-104-LS + 0.10% Aqualen AKU |
| | | | 32% AS-104-LS + 0.15% Aqualen AKU |
| | | | 32% AS-104-LS + 0.20% Aqualen AKU |
| | | | 32% AS-104-LS + 0.25% Aqualen AKU |
| | | | 32% AS-104-LS + 0.30% Aqualen AKU |
| | | | 32% AS-104-LS + 0.35% Aqualen AKU |
| | | | 32% AS-104-LS + 0.40% Aqualen AKU |
| | | | 32% AS-104-LS + 0.45% Aqualen AKU |
| | | | 32% AS-104-LS + 0.50% Aqualen AKU |
| | | | 33% AS-104-LS + 0.05% Aqualen AKU |
| | | | 33% AS-104-LS + 0.10% Aqualen AKU |
| | | | 33% AS-104-LS + 0.15% Aqualen AKU |
| | | | 33% AS-104-LS + 0.20% Aqualen AKU |
| | | | 33% AS-104-LS + 0.25% Aqualen AKU |
| | | | 33% AS-104-LS + 0.30% Aqualen AKU |
| | | | 33% AS-104-LS + 0.35% Aqualen AKU |
| | | | 33% AS-104-LS + 0.40% Aqualen AKU |
| | | | 33% AS-104-LS + 0.45% Aqualen AKU |
| | | | 33% AS-104-LS + 0.50% Aqualen AKU |
| | | | 34% AS-104-LS + 0.05% Aqualen AKU |
| | | | 34% AS-104-LS + 0.10% Aqualen AKU |
| | | | 34% AS-104-LS + 0.15% Aqualen AKU |
| | | | 34% AS-104-LS + 0.20% Aqualen AKU |
| | | | 34% AS-104-LS + 0.25% Aqualen AKU |
| | | | 34% AS-104-LS + 0.30% Aqualen AKU |
| | | | 34% AS-104-LS + 0.35% Aqualen AKU |
| | | | 34% AS-104-LS + 0.40% Aqualen AKU |
| | | | 34% AS-104-LS + 0.45% Aqualen AKU |
| | | | 34% AS-104-LS + 0.50% Aqualen AKU |
| | | | 35% AS-104-LS (=1% SF solids) + 0.05% Aqualen AKU |
| | | | 35% AS-104-LS (=1% SF solids) + 0.10% Aqualen AKU |
| | | | 35% AS-104-LS (=1% SF solids) + 0.15% Aqualen AKU |
| | | | 35% AS-104-LS (=1% SF solids) + 0.20% Aqualen AKU |
| | | | 35% AS-104-LS (=1% SF solids) + 0.25% Aqualen AKU |
| | | | 35% AS-104-LS (=1% SF solids) + 0.30% Aqualen AKU |
| | | | 35% AS-104-LS (=1% SF solids) + 0.35% Aqualen AKU |
| | | | 35% AS-104-LS (=1% SF solids) + 0.40% Aqualen AKU |
| | | | 35% AS-104-LS (=1% SF solids) + 0.45% Aqualen AKU |
| | | | 35% AS-104-LS (=1% SF solids) + 0.50% Aqualen AKU |
| | | | 36% AS-104-LS + 0.05% Aqualen AKU |
| | | | 36% AS-104-LS + 0.10% Aqualen AKU |
| | | | 36% AS-104-LS + 0.15% Aqualen AKU |
| | | | 36% AS-104-LS + 0.20% Aqualen AKU |
| | | | 36% AS-104-LS + 0.25% Aqualen AKU |
| | | | 36% AS-104-LS + 0.30% Aqualen AKU |
| | | | 36% AS-104-LS + 0.35% Aqualen AKU |
| | | | 36% AS-104-LS + 0.40% Aqualen AKU |
| | | | 36% AS-104-LS + 0.45% Aqualen AKU |
| | | | 36% AS-104-LS + 0.50% Aqualen AKU |
| | | | 37% AS-104-LS + 0.05% Aqualen AKU |
| | | | 37% AS-104-LS + 0.10% Aqualen AKU |
| | | | 37% AS-104-LS + 0.15% Aqualen AKU |
| | | | 37% AS-104-LS + 0.20% Aqualen AKU |
| | | | 37% AS-104-LS + 0.25% Aqualen AKU |
| | | | 37% AS-104-LS + 0.30% Aqualen AKU |
| | | | 37% AS-104-LS + 0.35% Aqualen AKU |
| | | | 37% AS-104-LS + 0.40% Aqualen AKU |
| | | | 37% AS-104-LS + 0.45% Aqualen AKU |
| | | | 37% AS-104-LS + 0.50% Aqualen AKU |
| | | | 38% AS-104-LS + 0.05% Aqualen AKU |
| | | | 38% AS-104-LS + 0.10% Aqualen AKU |
| | | | 38% AS-104-LS + 0.15% Aqualen AKU |
| | | | 38% AS-104-LS + 0.20% Aqualen AKU |
| | | | 38% AS-104-LS + 0.25% Aqualen AKU |
| | | | 38% AS-104-LS + 0.30% Aqualen AKU |
| | | | 38% AS-104-LS + 0.35% Aqualen AKU |
| | | | 38% AS-104-LS + 0.40% Aqualen AKU |
| | | | 38% AS-104-LS + 0.45% Aqualen AKU |
| | | | 38% AS-104-LS + 0.50% Aqualen AKU |
| | Polycarbodiimides | Roda Link 5777 (TFL) | 15% AS-104-LS + 1% Roda Link 5777 |
| | | (OR equivalent | 15% AS-104-LS + 2% Roda Link 5777 |
| | | Picassian XL-745 | 15% AS-104-LS + 3% Roda Link 5777 |
| | | (Stahl) OR | 15% AS-104-LS + 4% Roda Link 5777 |
| | | equivalent | 15% AS-104-LS + 5% Roda Link 5777 |
| | | Picassian XL-732) | 15% AS-104-LS + 6% Roda Link 5777 |
| | | | 15% AS-104-LS + 7% Roda Link 5777 |
| | | | 15% AS-104-LS + 8% Roda Link 5777 |
| | | | 15% AS-104-LS + 9% Roda Link 5777 |
| | | | 15% AS-104-LS + 10% Roda Link 5777 |
| | | | 16% AS-104-LS + 1% Roda Link 5777 |
| | | | 16% AS-104-LS + 2% Roda Link 5777 |
| | | | 16% AS-104-LS + 3% Roda Link 5777 |
| | | | 16% AS-104-LS + 4% Roda Link 5777 |
| | | | 16% AS-104-LS + 5% Roda Link 5777 |
| | | | 16% AS-104-LS + 6% Roda Link 5777 |
| | | | 16% AS-104-LS + 7% Roda Link 5777 |
| | | | 16% AS-104-LS + 8% Roda Link 5777 |
| | | | 16% AS-104-LS + 9% Roda Link 5777 |
| | | | 16% AS-104-LS + 10% Roda Link 5777 |
| | | | 17% AS-104-LS (=1% SF solids) + 1% Roda Link 5777 |
| | | | 17% AS-104-LS (=1% SF solids) + 2% Roda Link 5777 |
| | | | 17% AS-104-LS (=1% SF solids) + 3% Roda Link 5777 |
| | | | 17% AS-104-LS (=1% SF solids) + 4% Roda Link 5777 |
| | | | 17% AS-104-LS (=1% SF solids) + 5% Roda Link 5777 |
| | | | 17% AS-104-LS (=1% SF solids) + 6% Roda Link 5777 |
| | | | 17% AS-104-LS (=1% SF solids) + 7% Roda Link 5777 |
| | | | 17% AS-104-LS (=1% SF solids) + 8% Roda Link 5777 |
| | | | 17% AS-104-LS (=1% SF solids) + 9% Roda Link 5777 |
| | | | 17% AS-104-LS (=1% SF solids) + 10% Roda Link 5777 |
| | | | 18% AS-104-LS + 1% Roda Link 5777 |
| | | | 18% AS-104-LS + 2% Roda Link 5777 |
| | | | 18% AS-104-LS + 3% Roda Link 5777 |
| | | | 18% AS-104-LS + 4% Roda Link 5777 |
| | | | 18% AS-104-LS + 5% Roda Link 5777 |
| | | | 18% AS-104-LS + 6% Roda Link 5777 |
| | | | 18% AS-104-LS + 7% Roda Link 5777 |
| | | | 18% AS-104-LS + 8% Roda Link 5777 |
| | | | 18% AS-104-LS + 9% Roda Link 5777 |
| | | | 18% AS-104-LS + 10% Roda Link 5777 |
| | | | 19% AS-104-LS + 1% Roda Link 5777 |
| | | | 19% AS-104-LS + 2% Roda Link 5777 |
| | | | 19% AS-104-LS + 3% Roda Link 5777 |
| | | | 19% AS-104-LS + 4% Roda Link 5777 |
| | | | 19% AS-104-LS + 5% Roda Link 5777 |
| | | | 19% AS-104-LS + 6% Roda Link 5777 |
| | | | 19% AS-104-LS + 7% Roda Link 5777 |
| | | | 19% AS-104-LS + 8% Roda Link 5777 |
| | | | 19% AS-104-LS + 9% Roda Link 5777 |
| | | | 19% AS-104-LS + 10% Roda Link 5777 |
| | | | 20% AS-104-LS + 1% Roda Link 5777 |
| | | | 20% AS-104-LS + 2% Roda Link 5777 |
| | | | 20% AS-104-LS + 3% Roda Link 5777 |
| | | | 20% AS-104-LS + 4% Roda Link 5777 |
| | | | 20% AS-104-LS + 5% Roda Link 5777 |
| | | | 20% AS-104-LS + 6% Roda Link 5777 |
| | | | 20% AS-104-LS + 7% Roda Link 5777 |
| | | | 20% AS-104-LS + 8% Roda Link 5777 |
| | | | 20% AS-104-LS + 9% Roda Link 5777 |
| | | | 20% AS-104-LS + 10% Roda Link 5777 |
| | Polyaldehydes | Roda Link 3315/F | |
| | | Glutaraldehyde | |
| Resins | Polyurethanes | | |
| | Polyacrylates | | |
| | Polyesters | | |
| | Waxes | | |
| | Proteins | | |
| Plasticizers | Alcohols | Glycerol | {5-90% AS-104-LS (=0.3-5.4% SF |
| | | | solids)} + 0.5-5% Glycerol |
| | | Sorbitol | |

### Example 9: Water Vapor Transmission Test (WVT) of Leather

### Test Used:

ASTM Standard E96/E96M-21, “Standard Test Methods for Gravimetric Determination of Water Vapor Transmission Rate of Materials,” (Modified), ASTM International, West Conshohocken, PA, 2016, astm.org. The purpose of these tests is to obtain, by means of simple apparatus, reliable values for water vapor transfer rate through materials, expressed in suitable units. These test methods cover the determination of water vapor transmission rate (WVTR) of materials, such as, but not limited to, paper, plastic films, other sheet materials, coatings, foams, fiberboards, gypsum and plaster products, wood products, and plastics.

### Testing Information:

Procedure B (water method) used
Test Temperature: 23.00° C.
Relative Humidity: 50.00%
The Face of fabric was exposed to Water the back of the fabric was exposed to Air
Test Equipment: TEXTEST FX 3180 Cupmaster with aluminum cups, sealed with NBR and Teflon gaskets, and twist-down clamp ring
A higher MVTR value indicates there is a greater passage of moisture vapor through the material

### Results

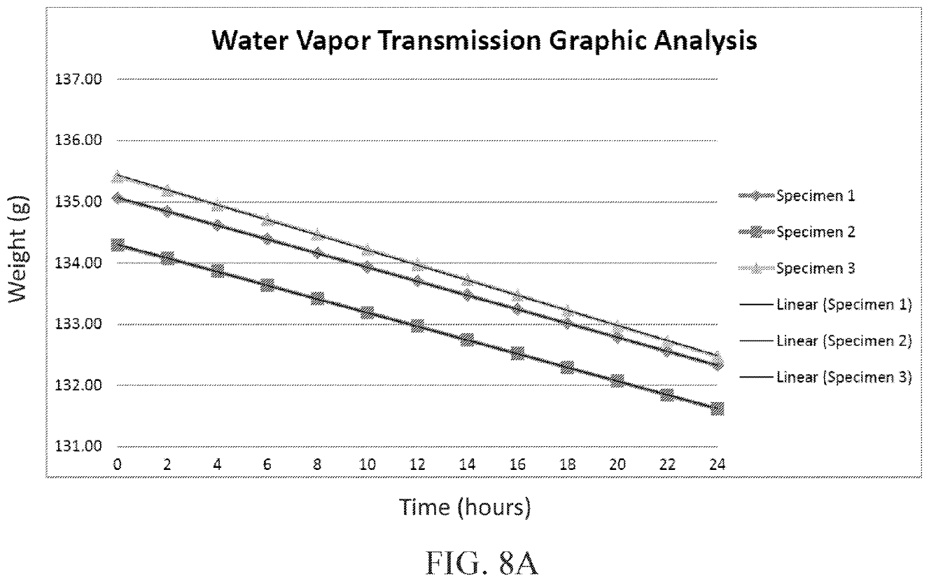

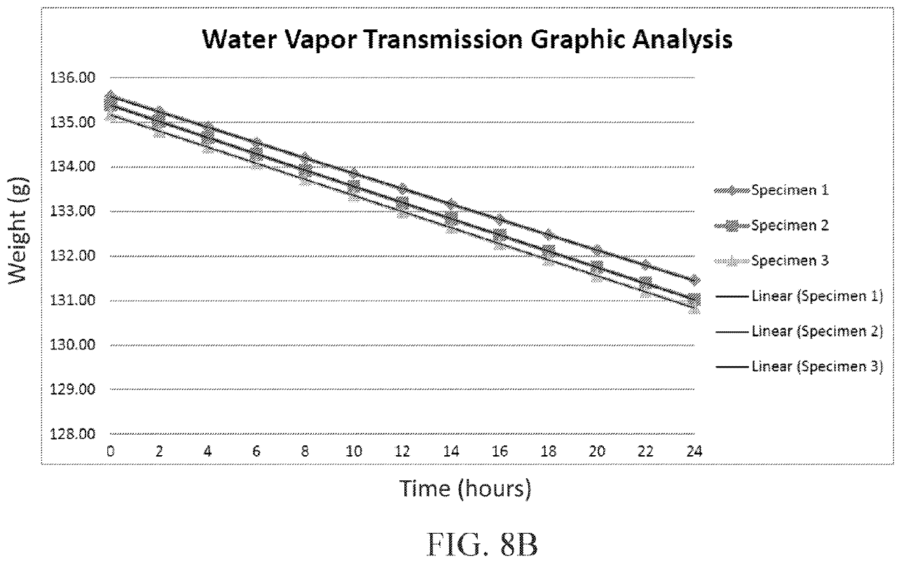

Water Vapor Transmission Test on Leather with Coating System #1: Results from this test are illustrated in FIG. 8A and Table 12a below.

TABLE 12a
WVT Testing Results on Coated Leather Test #1

| | Specimen 1 | | Specimen 2 | | Specimen 3 | |
|---|---|---|---|---|---|---|
| Start Weight | 136.292 | g | 135.647 | g | 135.578 | g |
| Finish Weight | 133.308 | g | 132.337 | g | 132.330 | g |
| Time Elapsed | 24 | hr. | 24 | hr. | 24 | hr. |
| Area of circle | 0.005 | m² | 0.005 | m² | 0.005 | m² |
| Rate of Water Vapor | 596.800 g/m²/24 hr | | 662.000 g/m²/24 hr | | 649.600 g/m²/24 hr | |
| Transmission | | | | | | |

| Average WVT | 636.133 g/m²/24 hr |
|---|---|
| Standard | 34.623 |
| Deviation | |

Water Vapor Transmission Test on Leather Crust (no coating) #1: Results from this test are illustrated in FIG. 8B and Table 12b below.

TABLE 12b
WVT Testing Results on Uncoated Leather Test #1

| | Specimen 1 | | Specimen 2 | | Specimen 3 | |
|---|---|---|---|---|---|---|
| Start Weight | 134.667 | g | 135.185 | g | 134.147 | g |
| Finish Weight | 130.638 | g | 130.985 | g | 129.814 | g |
| Time Elapsed | 24 | hr. | 24 | hr. | 24 | hr. |
| Area of circle | 0.005 | m² | 0.005 | m² | 0.005 | m² |

| Rate of Water | 805.800 g/m²/24 hr | 840.000 g/m²/24 hr | 866.600 g/m²/24 hr |
|---|---|---|---|
| Vapor Transmission | | Average WVT | 837.467 g/m²/24 hr |
| | | Standard | 30.479 |

Deviation

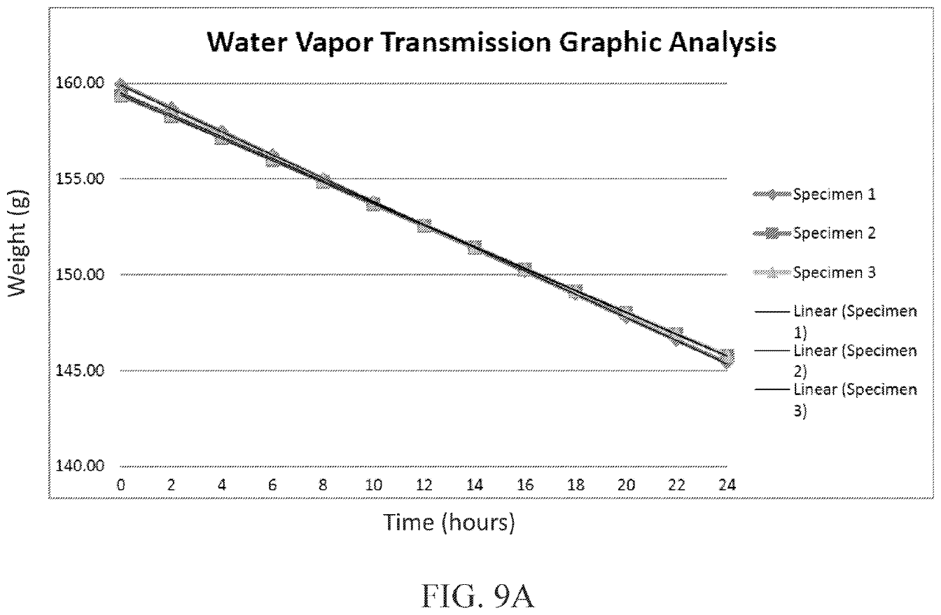

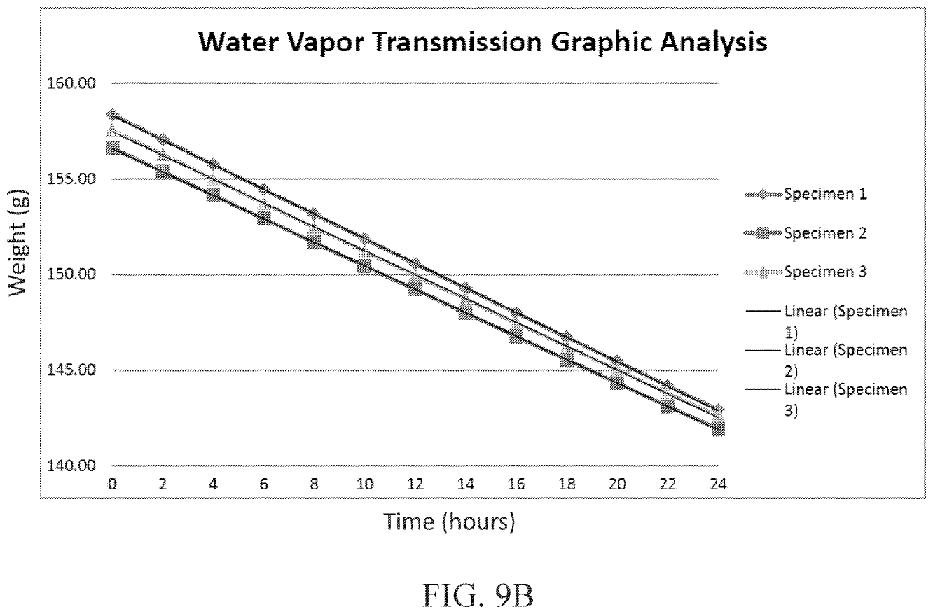

Water Vapor Transmission on Leather with Coating System Test on Leather with Coating System #2: Results from this test are illustrated in FIG. 9A and Table 13a below.

TABLE 13a
WVT Testing Results on Coated Leather Test #2

| | Specimen 1 | | Specimen 2 | | Specimen 3 | |
|---|---|---|---|---|---|---|
| Start Weight | 135.058 | g | 134.289 | g | 135.412 | g |
| Finish Weight | 132.323 | g | 131.616 | g | 132.475 | g |
| Time Elapsed | 24 | hr. | 24 | hr. | 24 | hr. |
| Area of circle | 0.005 | m² | 0.005 | m² | 0.005 | m² |

| Rate of Water | 547.000 g/m²/24 hr | 534.600 g/m²/24 hr | 587.400 g/m²/24 hr |
|---|---|---|---|
| Vapor Transmission | | Average WVT | 556.333 g/m²/24 hr |
| | | Standard | 27.610 |

Deviation

Water Vapor Transmission Test on Leather Crust (no coating) #2: Results from this test are illustrated in FIG. 8B and Table 12b below.

TABLE 12b
WVT Testing Results on Uncoated Leather Test #2

| | Specimen 1 | | Specimen 2 | | Specimen 3 | |
|---|---|---|---|---|---|---|
| Start Weight | 135.590 | g | 135.393 | g | 135.175 | g |
| Finish Weight | 131.455 | g | 131.032 | g | 130.845 | g |
| Time Elapsed | 24 | hr. | 24 | hr. | 24 | hr. |
| Area of circle | 0.005 | m² | 0.005 | m² | 0.005 | m² |

| Rate of Water | 827.000 g/m²/24 hr | 872.200 g/m²/24 hr | 866.000 g/m²/24 hr |
|---|---|---|---|
| Vapor Transmission | | Average WVT | 855.067 g/m²/24 hr |
| | | Standard | 24.503 |

Deviation

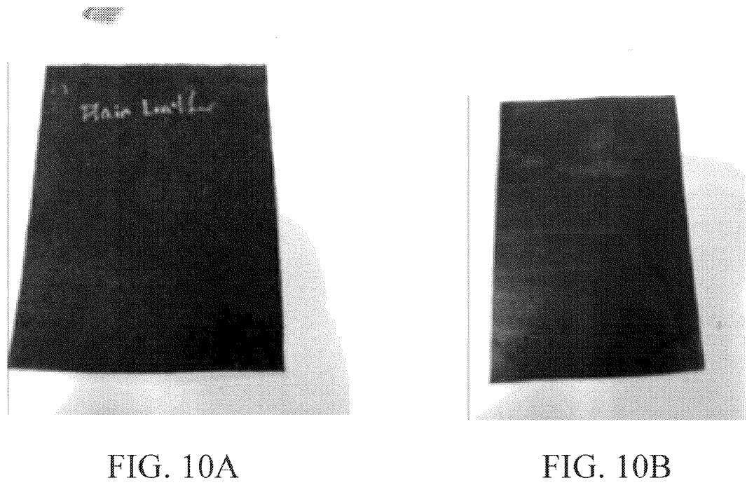

Water Vapor Transmission Test on Leather with Coating System #3: Results from this test are illustrated in FIG. 10A and Table 13a below.

TABLE 13a
WVT Testing on Coated Leather Results Test #3

| | Specimen 1 | | Specimen 2 | | Specimen 3 | |
|---|---|---|---|---|---|---|
| Start Weight | 159.930 | g | 159.340 | g | 159.440 | g |
| Finish Weight | 145.400 | g | 145.780 | g | 145.790 | g |
| Time Elapsed | 24 | hr. | 24 | hr. | 24 | hr. |
| Area of circle | 0.005 | m² | 0.005 | m² | 0.005 | m² |

| Rate of Water | 2906.000 g/m²/24 hr | 2712.000 g/m²/24 hr | 2730.000 g/m²/24 hr |
|---|---|---|---|
| Vapor Transmission | | Average WVT | 2782.667 g/m²/24 hr |
| | | Standard | 107.188 |

Deviation

Water Vapor Transmission Test on Leather Crust (no coating) #3: Results from this test are illustrated in FIG. 10B and Table 13b below.

TABLE 13b
WVT Testing Results on Uncoated Leather Test #3

| | Specimen 1 | | Specimen 2 | | Specimen 3 | |
|---|---|---|---|---|---|---|
| Start Weight | 158.365 | g | 156.617 | g | 157.544 | g |
| Finish Weight | 142.928 | g | 141.923 | g | 142.595 | g |
| Time Elapsed | 24 | hr. | 24 | hr. | 24 | hr. |
| Area of circle | 0.005 | m² | 0.005 | m² | 0.005 | m² |

| Rate of Water | 3087.400 g/m²/24 hr | 2938.800 g/m²/24 hr | 2989.800 g/m²/24 hr |
|---|---|---|---|
| Vapor Transmission | | Average WVT | 3005.333 g/m²/24 hr |
| | | Standard | 75.508 |

Deviation

These results show that the coated leather allowed the passage of water vapor. This illustrates the breathability of the leather coating, while still providing waterproofing properties. Water droplets were unable to pass, but water vapor was able to pass through the specimen.

### Example 10: Oil Repellency Test on Leather

Test Method: AATCC TM118-2020, Test Method for Oil Repellency: Hydrocarbon Resistance Test Testing Information:
Specimen size: 8″×8″
The scale ranges from zero to eight, with a rating of eight signifying the most repellent surface.
Sample brought to moisture equilibrium; Testing Conditions: 21° C. (L 2° C.) and 65% RH (5% RH)

TABLE 14a
Results from Oil Repellency Test on Leather with Coating System

| | |
|---|---|
| Specimen 1 | 6.0 |
| Specimen 2 | 6.0 |
| Specimen 3 | N/A (Reported only if Specimen 1 & 2 |
| | are not the same) |
| Median | 6.0 |

TABLE 14b
Results from Oil Repellency Test on Leather Crust (no coating)

| | |
|---|---|
| Specimen 1 | 0 |
| Specimen 2 | 0 |
| Specimen 3 | N/A (Reported only if Specimen 1 & 2 |
| | are not the same) |
| Median | 0 |

The results shown in Tables 14a-14b show that coated leather, graded with a 6 out of 8, exhibited far better oil repellency over uncoated leather, graded a 0 out of 8.

### Example 11: Soil Release Test on Leather

Test Method for Soil Release: Oily Stain Release—AATCC TM130-2018t—Modified

### Testing Information:

Modification=Stains used:
   French's® 100% Natural Classic Yellow® Mustard
   100% Natural Hunt's® Tomato Ketchup®
   Distilled Water
   Wine Cube® Merlot California
   Top Soil—25% Top Soil
   Mazola Corn Oil
   Stars and Stripes Cola
   French's® Dressing
   Artificial Urine
A grade of 5 indicates excellent stain removal; A grade of 1 indicates very poor stain removal
Sample brought to moisture equilibrium; Testing Conditions: 21° C. (±2° C.) and 65% RH (5% RH)
AATCC Stain Release Replica version 2013 used for grading
Modified hand washing procedure using a soft cloth with 1% Tide® detergent solution and
105° F. water
Rinsed using a soft cloth and 80° F. water
Air Dryed

### Testing Results

TABLE 15a
Results from Soil Release Test on Leather with Coating System

| | | Specimen 1 | Specimen 2 |
|---|---|---|---|
| Mustard Stain | Grade 1 | 5.0 | N/A |
| | Grade 2 | 5.0 | N/A |
| | Average | 5.0 | |
| Ketchup Stain | Grade 1 | 5.0 | N/A |
| | Grade 2 | 5.0 | N/A |
| | Average | | 5.0 |
| Water Stain | Grade 1 | 5.0 | N/A |
| | Grade 2 | 5.0 | N/A |
| | Average | | 5.0 |
| Wine Stain | Grade 1 | 5.0 | N/A |
| | Grade 2 | 5.0 | N/A |
| | Average | | 5.0 |
| Soil Stain | Grade 1 | 5.0 | N/A |
| | Grade 2 | 5.0 | N/A |
| | Average | | 5.0 |
| Oil Stain | Grade 1 | 5.0 | N/A |
| | Grade 2 | 5.0 | N/A |
| | Average | | 5.0 |
| Soda Stain | Grade 1 | 5.0 | N/A |
| | Grade 2 | 5.0 | N/A |
| | Average | | 5.0 |
| French Dressing | Grade 1 | 5.0 | N/A |
| Stain | Grade 2 | 5.0 | N/A |
| | Average | 5.0 | |
| Urine Stain | Grade 1 | 5.0 | N/A |
| | Grade 2 | 5.0 | N/A |
| | Average | 5.0 | |

TABLE 15b
Results from Soil Release Test on Leather Crust (no coating)

| | | Specimen 1 | Specimen 2 |
|---|---|---|---|
| Mustard Stain | Grade 1 | 2.0 | N/A |
| | Grade 2 | 1.5 | N/A |
| | Average | | 1.8 |
| Ketchup Stain | Grade 1 | 2.0 | N/A |
| | Grade 2 | 2.0 | N/A |
| | Average | | 2.0 |
| Water Stain | Grade 1 | 4.0 | N/A |
| | Grade 2 | 4.0 | N/A |
| | Average | | 4.0 |
| Wine Stain | Grade 1 | 3.0 | N/A |
| | Grade 2 | 3.0 | N/A |
| | Average | | 3.0 |
| Soil Stain | Grade 1 | 3.0 | N/A |
| | Grade 2 | 3.5 | N/A |
| | Average | | 3.3 |
| Oil Stain | Grade 1 | 2.0 | N/A |
| | Grade 2 | 2.0 | N/A |
| | Average | | 2.0 |
| Soda Stain | Grade 1 | 3.0 | N/A |
| | Grade 2 | 2.5 | N/A |
| | Average | | 2.8 |
| French Dressing | Grade 1 | 2.0 | N/A |
| Stain | Grade 2 | 1.5 | N/A |
| | Average | | 1.8 |
| Urine Stain | Grade 1 | 3.0 | N/A |
| | Grade 2 | 3.0 | N/A |
| | Average | | 3.0 |

As shown in Tables 15a and 15b above, the coated leather received all 5/5 grades, demonstrating excellent stain removal. The uncoated leather did not receive any 5.0 ratings.

### Example 12: Colorfastness to Light: Xenon Arc Test

Test Method: AATCC TM16.3-2020, Test Method for Colorfastness to Light: Xenon-Arc—OPTION 3

### Testing Information:

Option 3—Xenon Arc Lamp, Continuous Light, Black Panel Option
Face of the material exposed. The test specimen is compared to original, unexposed specimen and is backed.
Shade change of the masked portion as compared to the original: 5.0
If result of above is not a 5.0, the textile has been affected by some agent other than light, such as heat or a reactive gas in the atmosphere. The exact cause is unknown.
Xenon Test Chamber Model QSun Xe-2-HSE
Rotating drum horizontal specimen rack; 45×330 mm double panel holders, Panel Capacity=15.5
AATCC EP1-2020, Evaluation Procedure for Gray Scale for Color Change
Graded under Illuminant D65 “Daylight”, Geometry Option C, Gretag Macbeth SpectraLight III
A grade of 5 indicates negligible or no color change; a grade of 1 indicates much color change
See Table IV—Reporting Form
Sample brought to moisture equilibrium; Grading Conditions: 21° C. (±2° C.) and 65% RH (+5% RH)

### Test Results

TABLE 16
Results from Colorfastness to Light Test

| | Shade Change Grade | |
|---|---|---|
| | Fading Units : 20 AFU's | Fading Units : 40AFU's |
| Observer #1 | 4.0 | 3.0 |
| Observer #2 | 4.0 | 3.0 |
| Observer #3 | N/A | N/A |
| Average | 4.0 | 3.0 |

### Example 13: Colorfastness to Perspiration Test

### Test Method: Test Method for Colorfastness to Perspiration—AATCC TM15-2013e

### Testing Information:

Number 10 Multi-Fiber Test Fabric
Acid Perspiration Solution=pH 4.3±0.2
Alkaline Perspiration Solution=pH 8.0
AATCC EP2-2018, Gray Scale for Staining used for evaluation
AATCC EP1-2018, Gray Scale for Color Change used for evaluation
Graded under Illuminant D65 “Daylight”, Geometry Option C, Gretag Macbeth SpectraLight III
A grade of 5 indicates negligible or no staining and negligible or no color change
A grade of 1 indicates heavy staining and much color change
Sample brought to moisture equilibrium; Grading Conditions: 21° C. (L 2° C.) and 65% RH (5% RH)
Note: Specimen size increased so cut edges of specimen were not in contact with edge of fiber strip

### Test Results

TABLE 17
Results from Colorfastness to Perspiration Test

| | | | | | | | Sample | Sample |
|---|---|---|---|---|---|---|---|---|
| | Staining | Staining | Staining | Staining | Staining | Staining | Shade | Self |
| | Acetate | Cotton | Nylon | Polyester | Acrylic | Wool | Change | Staining |
| Alkaline | 3.0 | 2.0 | 2.0 | 3.0 | 3.5 | 2.0 | 4.5 | N/A |
| Solution | | | | | | | | |
| Acid | 4.0 | 5.0 | 3.5 | 5.0 | 5.0 | 5.0 | 4.5 | N/A |
| Solution | | | | | | | | |

### Example 14: Polyurethane and Silk System Stability

A polyurethane/silk system with mid-molecular weight silk may form a gel. The addition of silk and the type of silk will enable tuning of the final product.

TABLE 18
Polyurethane/ Silk System Gel Formation

| | Formulation (g) | A | B | D | C |
|---|---|---|---|---|---|
| BioPur 3015 | 9 | 225587 | 225587 | 225587 | 225587 |
| AS-104 TS (Low | 0.05 | — | TS- | TS- | TS21336-001 |
| tablet form) | | | 21301-01 | 21301-01 | |
| Condition | | 37° C. | 37° C. | 37° C. | 37° C. |
| Observation after 24 | | liquid | liquid | liquid | Liquid |
| Days * | | | | | * (after 8 days) |
| Observation after 36 | | liquid | liquid | liquid | |
| days | | | | | |
| BioPur 3015 lot # | 9 | 225587 | 225587 | 225587 | 225587 |
| AS-104 (LOW) LS lot | 1 | 22095 | 22109 | 22131 | 22264 |
| # | | | | | |
| Storage Condition | | 37° C. | 37° C. | 37° C. | 37° C. |
| Observation after 1 | | liquid | liquid | liquid | liquid |
| day | | | | | |
| Observation after 12 | | liquid | liquid | liquid | liquid |
| days | | | | | |
| BioPur 3015 lot# | 9 | 225587 | | | |
| AS-105 LS (MID) lot# | 1 | 22236 | | | |
| Storage Condition | | 37° C. | | | |
| Observation after 1 | | Starting | | | |
| day | | to gel | | | |
| Observation after 12 | | gcl | | | |
| days | | | | | |

### Example 16: Fourier Transform Infrared (FTIR) Imaging—Heated ATR Imaging

For this FTIR analysis, a JASCO Heated ATR—Diamond Crystal was used. Two liquid silk solution samples (60 mg/mL) were tested.

### Instrument Information:

Measurement Modes: Attenuated total reflectance (ATR)
Objectives. A wide area microscopic ATR “ATR-5000-WG” was used. This instrument is a 1600×1600 μm imaging measurement by 1 contact. It is ideal for surface analysis of soft samples such as foreign matter, rubber, biological sample, etc.

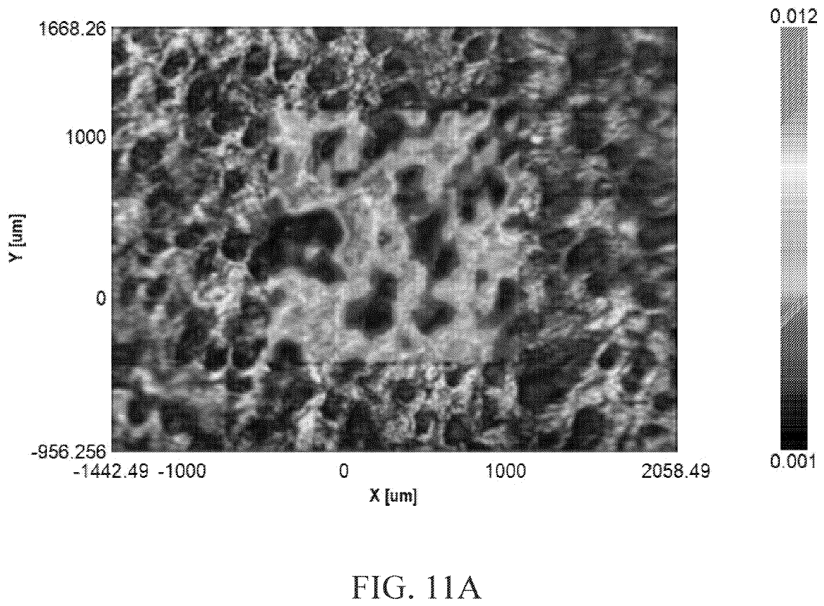

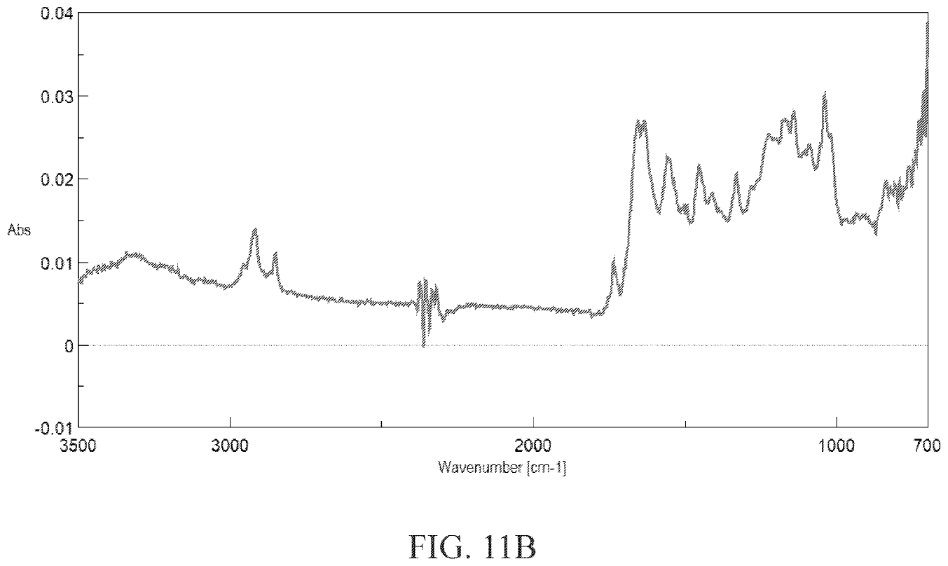

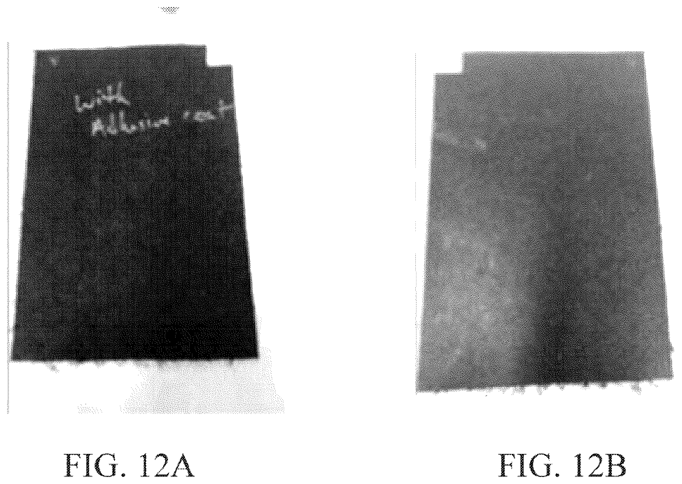

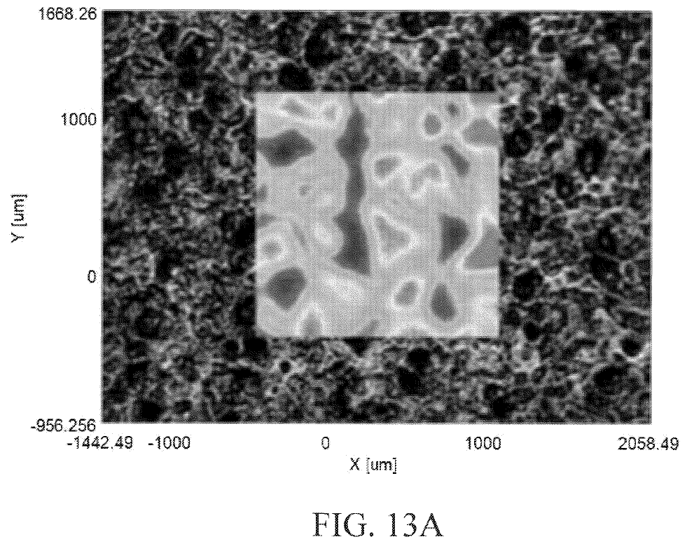

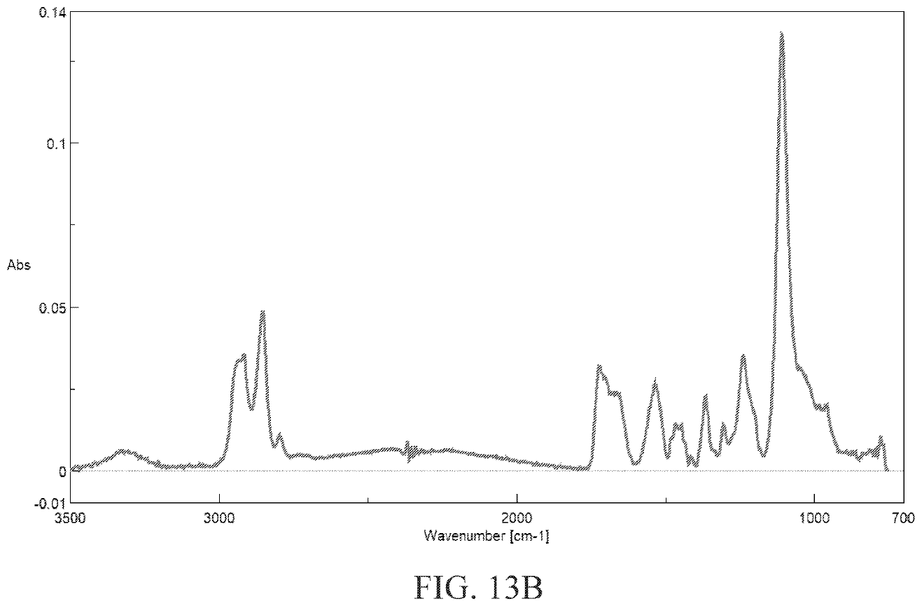

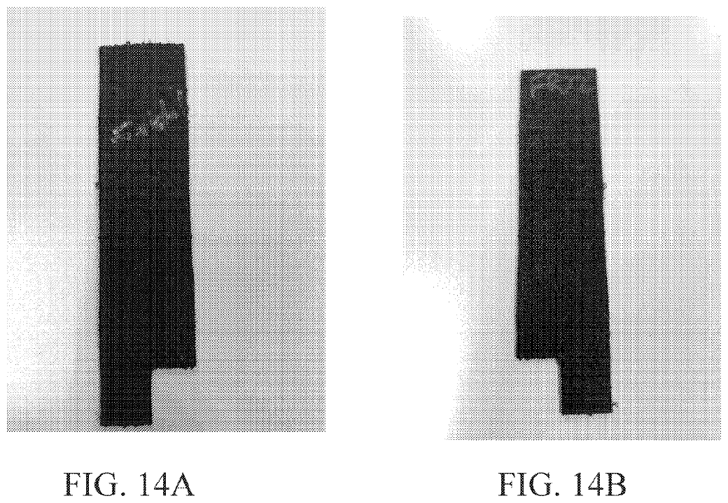

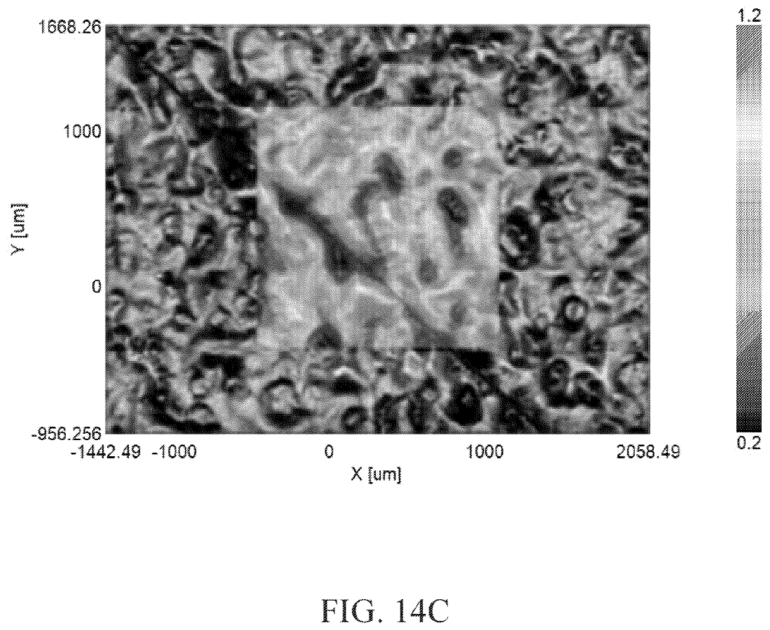

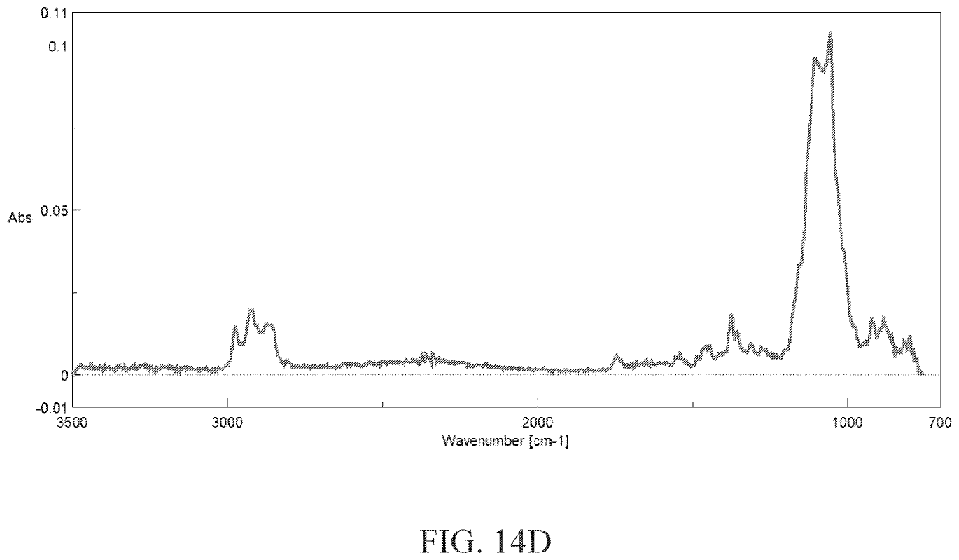

The FTIR results for plain leather can be seen in FIGS. 11A-11D. The FTIR results for coated leather can be seen in FIGS. 12A-12D. The FTIR results for top-coated leather can be seen in FIGS. 13A-13D.

TABLE A
Secondary structure estimation of LS-22348 L

| Temperature | | | | |
|---|---|---|---|---|
| (C.) | α - Helix | β- sheet | Turn | Other |
| 35 | 24 | 32 | 5 | 38 |
| 40 | 24 | 33 | 5 | 38 |
| 45 | 24 | 36 | 6 | 34 |
| 50 | 24 | 33 | 5 | 38 |
| 55 | 24 | 33 | 5 | 37 |
| 60 | 24 | 34 | 5 | 37 |
| 65 | 24 | 34 | 4 | 37 |
| 70 | 24 | 35 | 4 | 36 |
| 75 | 24 | 36 | 4 | 36 |

TABLE B
Secondary structure estimation of ms-so-000339

| Temperature | | | | |
|---|---|---|---|---|
| (C.) | α - Helix | β- sheet | Turn | Other |
| 35 | 24 | 33 | 5 | 38 |
| 40 | 24 | 33 | 5 | 38 |
| 45 | 24 | 33 | 6 | 38 |
| 50 | 24 | 34 | 5 | 37 |
| 55 | 24 | 34 | 5 | 37 |
| 60 | 24 | 35 | 5 | 37 |
| 65 | 23 | 35 | 4 | 37 |
| 70 | 23 | 36 | 4 | 36 |
| 75 | 23 | 35 | 4 | 36 |

### Example 17: Fourier Transform Infrared (FTIR) Imaging—Macro ATR Imaging

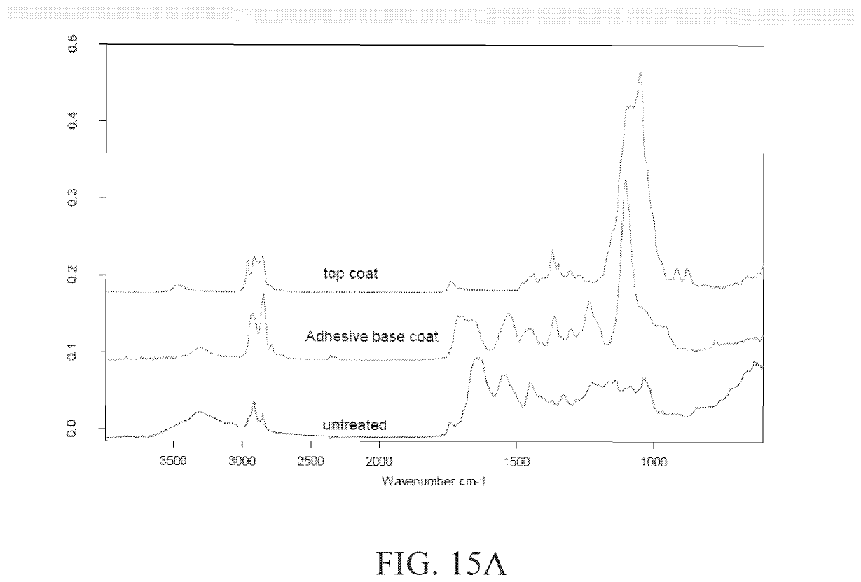

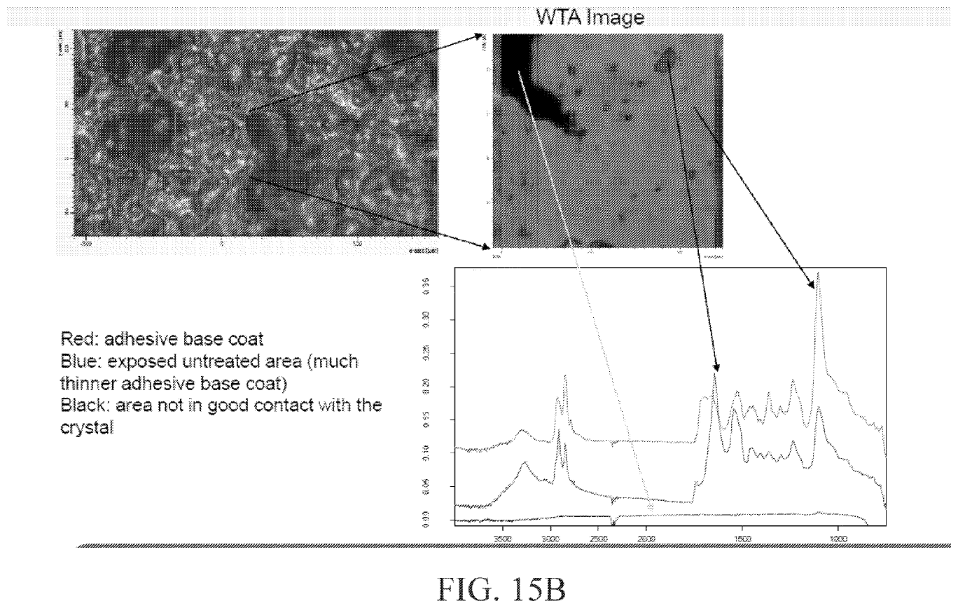

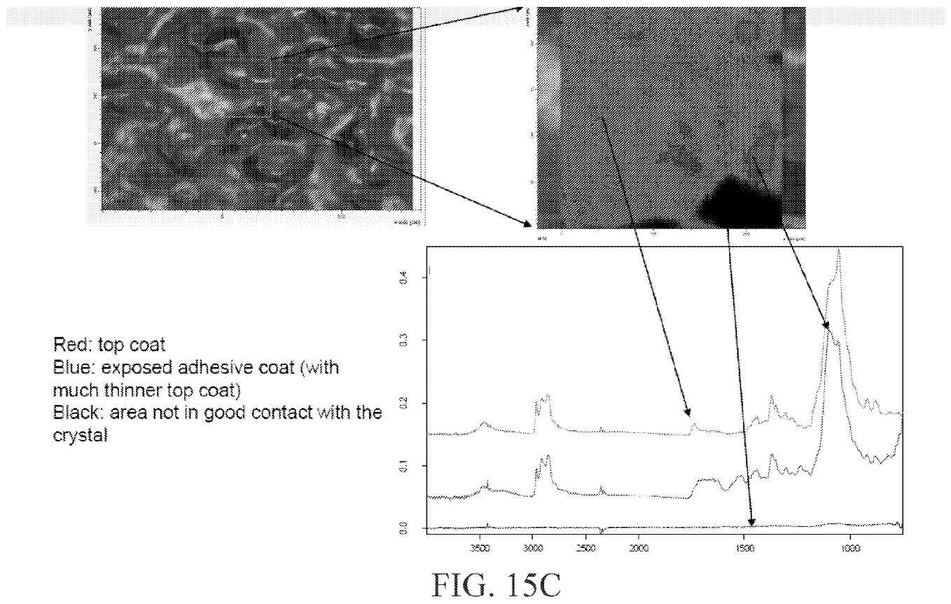

ATR measurements have been used to measure the coated rubber samples either with the single element MCT detector or the 32×32 FPA detector. Imaging with the FPA detector and a macro ATR accessory helps to resolve details of the coating distribution. Results can be seen in FIGS. 15A through 15C.

### Example 18: Biofinishing Coating System Validation Study

The objective of this study was to document performance results with a Coating System described herein and compare it to the user needs requirements.

TABLE 19
Summary of Test Results

| Item | | Design | | Pass/ |
|---|---|---|---|---|
| # | User Need | Requirement | Actual | Accepted |
| 1 | Topcoat delivers | >50 wet cycles | 600 wet cycles met using 4 g/sqft L5267 | Pass |
| | colorfastness to rubbing | for minimum | and 6 g/sqft of L0822. | |
| | | viable product | | |
| 2 | Flexibility for processing | Bally flex of 10- | 20k cycles met using 4 g/sqft L5267 and 6 | Pass |
| | | 20k | g/sqft of L0822. | |
| 3 | Imparts a glossy look | No requirements | Not Applicable | Pass |
| | | for MVP | | |
| 4 | Adhesion | Tape test | No delamination observed using 4 g/sqft | Pass |
| | | | L5267 and 6 g/sqft of L0822. | |
| 5 | >70% biobased | Literature | EBN-CM-XXXX, Rev A - 70% Biobased | Pass |
| | | assessment | Claim for Activated Silk L1 BioFinishing | |
| | | where possible. | System Produced By Evolved By Nature | |
| | | ASTM D6866 | | |
| | | testing where | | |
| | | necessary. | | |
| 6 | Stable at fluctuating | EBN Stability | Refer to TDR-TXTL-064. L1 system is | Accepted |
| | temperatures, from | Study of kit | stable at RT to 40C. Freezing condition is | with |
| | freezing to 40° C., during | components | not recommended for L5267. The | conditions |
| | the period from which it | | polyurethane dispersion used is not stable at | |
| | leaves the chemical | | freezing temperature per supplier TDS and | |
| | company to the point it is | | SDS. Transportation accommodation to be | |
| | used by the tannery, at | | made to ensure above freezing conditions. | |
| | least 6 months | | | |
| 7 | Can be used in scaled up | Can be applied | L0822 at 2.5% (application solids) is 100- | Pass |
| | processes and is also | via spray | 130 cP | |
| | compatible with standard | Pass: Viscosity < | L5267 at 18% (application solids) is 15-30 | |
| | leather finishing | 500 cP | cP | |
| | processes and ranges to | Not sticky when | Both can be applied via spray | |
| | provide an even coating | dried | Both coats are not sticky when dried | |
| | on the leather | | | |

### Stain Resistance Test

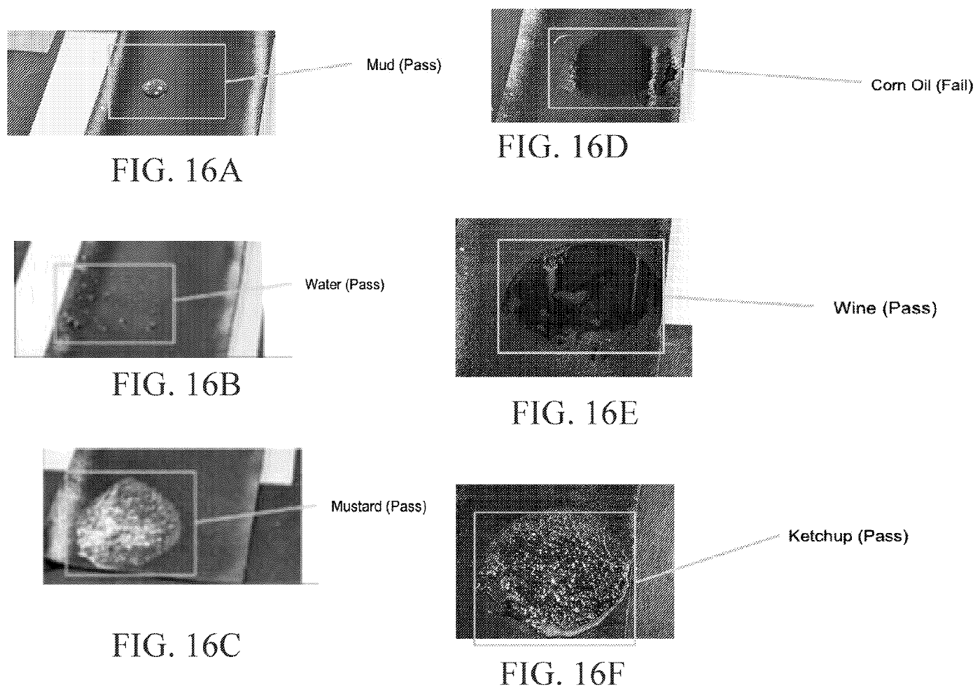

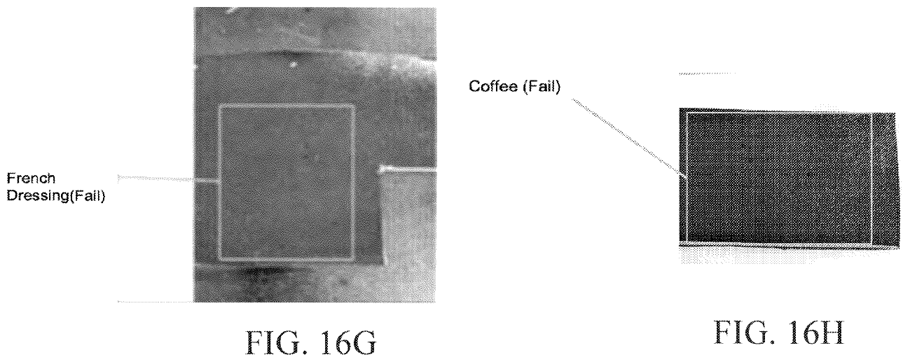

Summary of the results of the stain resistance test on leather treated with a coating system described herein can be seen in Table 20 below and FIGS. 16A through 16H.

TABLE 20
Summary of Stain Resistance Testing on Coated Leather

| Stain | Performance |
|---|---|
| Mustard | Pass |
| Water | Pass |
| Mud | Pass |
| Ketchup | Pass |
| Wine | Pass |
| French Dressing | Fail |
| Corn Oil | Fail |
| Coffee (41.5° C) | Fail |

### Industrialization Trial Results

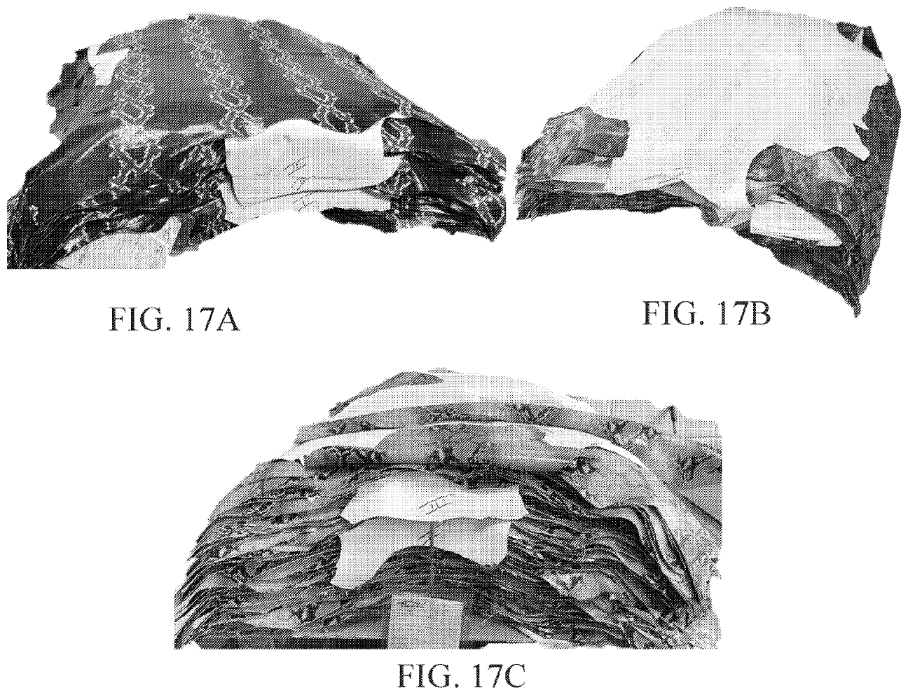

Samples used can be seen in Table 21 below and FIGS. 17A-17C. The results of this Trial are summarized in Table 21 below.

TABLE 21
Summary of industrialization Trial Results on Coated Leather

| | Dutti Multi Big | Dutti Multi Big | Dutti Multi Big | Dutti Multi Big |
|---|---|---|---|---|
| | in Multi Black | in Multi Green | in Multi Beige | in Multi Black |
| Material processed | 2099 sqft | 2786 sqft | 2422 sqft | 1561 sqft |
| | sheepskin | sheepskin | sheepskin | sheepskin |
| L5267 consumed (kg)* | 28 | 16 | 14 | 13 |
| L0822 consumed (kg)* | 40 | 55 | 40 | 34 |
| Basecoat formulation | 45% L5267 | 45% L5267 | 45% L5267 | 45% L5267 |
| | 45% Water | 45% Water | 45% Water | 45% Water |
| | 10% Glossy 23 | 10% Glossy 23 | 10% Glossy 23 | 10% Glossy 23 |
| Topcoat formulation | 50% L0822 | 50% L0822 | 50% L0822 | 50% L0822 |
| | 50% Ethanol | 50% Ethanol | 50% Ethanol | 50% Ethanol |
| Colorfastness to water | No stain | No stain | No stain | No stain |
| at 30 min and 36 Hrs | | | | |
| Veslic dry rub fastness | 100 cycle grade | 100 cycle grade | 100 cycle grade | 100 cycle grade |
| | 4-5 | 4-5 | 4-5 | 4-5 |
| Veslic wet rub | 20 cycles grade 4 | 20 cycles grade 4 | 20 cycles grade 4 | 20 cycles grade 4 |
| fastness | | | | |
| Crock meter | 3200 cycles grade | 3200 cycles grade | 3200 cycles grade | 3200 cycles grade |
| | 4 | 4 | 4 | 4 |
| Colorfastness to PVC | Grade 3-4 | Grade OK | Grade OK | Grade 3-4 |
| migration | | | | |
| Ballyflex | 20000 cycles | 20000 cycles no | 20000 cycles no | 20000 cycles |
| | slight break | damage | damage | slight break |
| Climatic chamber | 24 hrs ok | 24 hrs ok | 24 hrs ok | 24 hrs ok |
| Pass/ Fail | Passed all tests | Passed all tests | Passed all tests | Passed all tests |

*Note
consumption include setup/waste

### Wet Color Fastness Rubbing Test/Wet Veslic Test

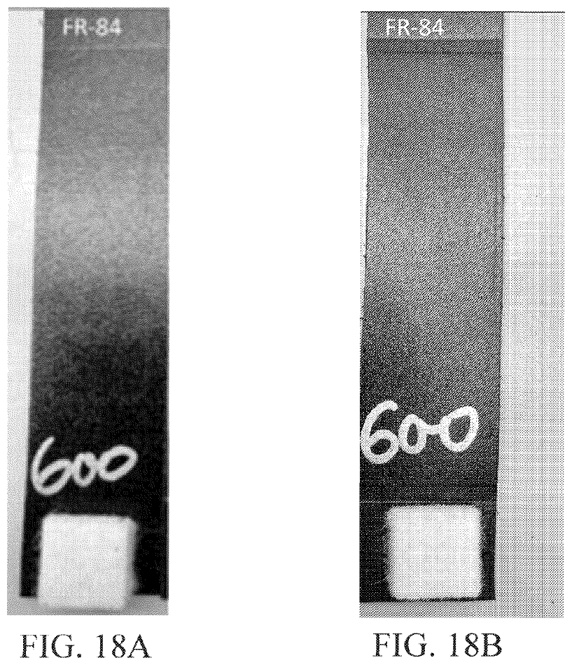

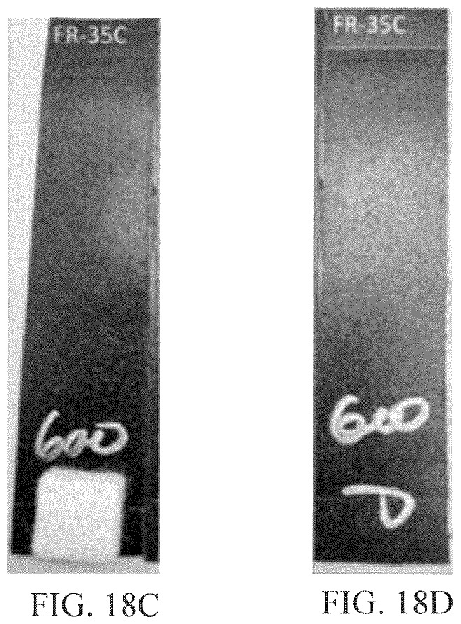

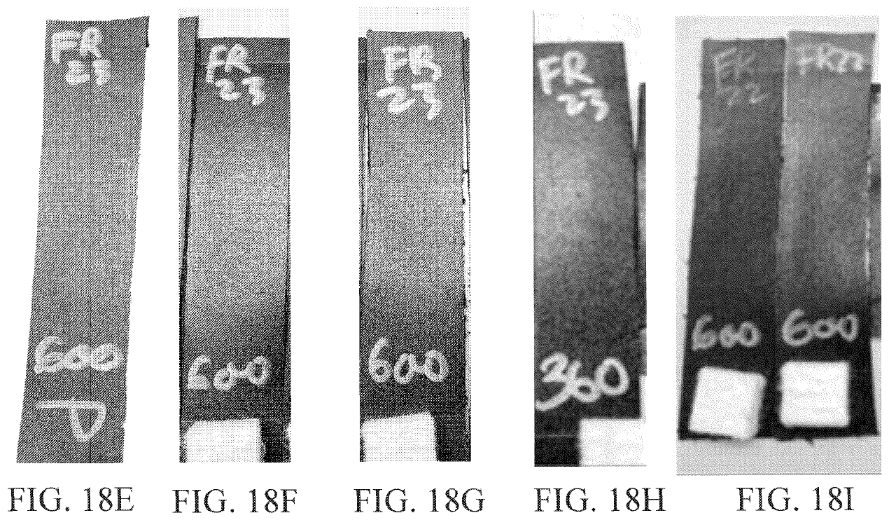

Conditions and results for this test are summarized in Table 22 below and illustrated in FIGS. 18A-18I.

TABLE 22
Summary of Wet CFR Test Conditions

| | | | | | Adhesive | Topcoat | Wet | |
|---|---|---|---|---|---|---|---|---|
| Sample | | | | | coat Applied | Applied | CFR | |
| # | Leather | Color | Grain | Treatment | (g/sqft) | (g/sqft) | (cycles) | Grade |
| NM-FR- | Francopel | Black | Full | L5267 & | 4 | 6 | 600 | 4-5 |
| AD-22 | | | | L0822 | | | | |
| | | | | (MP from | | | | |
| | | | | Fisher | | | | |
| | | | | Scientific) | | | | |
| NM-FR- | Francopel | Black | Full | L5267 & | 4 | 6 | 600 | 4-5 |
| AD-23 | | | | L0822 | | | | |
| | | | | (MP from | | | | |
| | | | | Fisher | | | | |
| | | | | Scientific) | | | | |
| NM-FR- | Francopel | Black | Full | L5267 & | 4 | 6 | 600 | 4-5 |
| AD-35C | | | | L0822 | | | | |
| | | | | (MP from | | | | |
| | | | | Fisher | | | | |
| | | | | Scientific) | | | | |
| NM-FR- | Francopel | Black | Full | L5267 & | 4 | 6 | 600 | 4-5 |
| AD-84 | | | | L0822 | | | | |
| | | | | (MP from | | | | |
| | | | | Fisher | | | | |
| | | | | Scientific) | | | | |

### Bally Flex Test

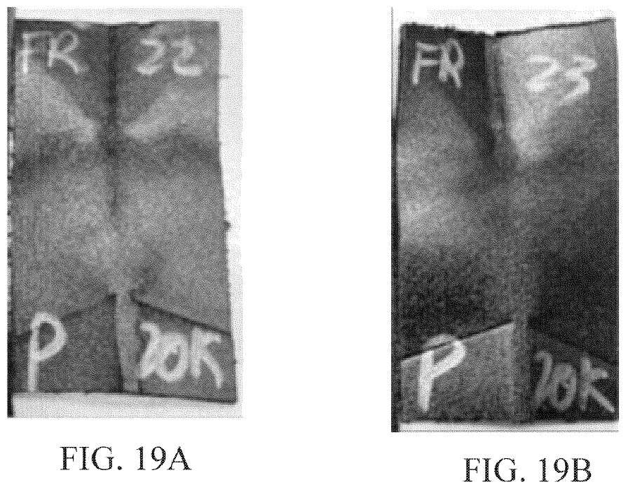

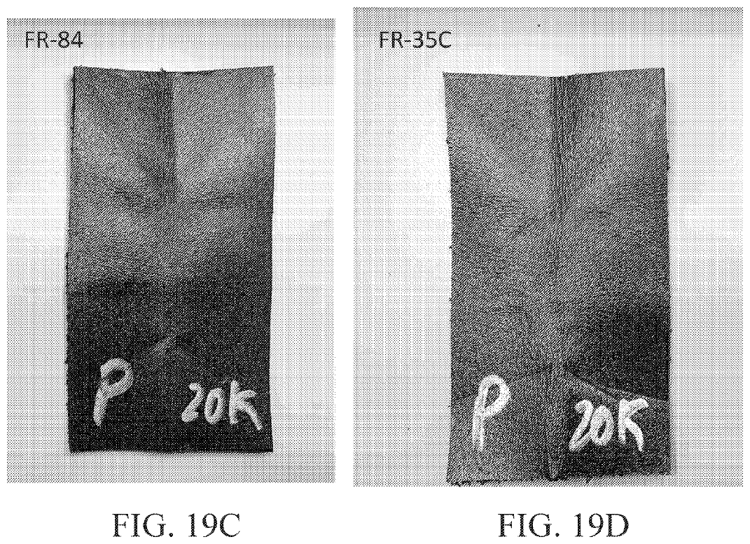

Conditions and results for this test are summarized in Table 23 below and FIGS. 19A-19D.

TABLE 23
Summary of Bally Flex Test Conditions

| | | | | | Adhesive | Topcoat | Bally |
|---|---|---|---|---|---|---|---|
| Sample | | | | | coat Applied | Applied | Flex |
| # | Leather | Color | Grain | Treatment | (g/sqft) | (g/sqft) | (cycles) |
| NM-FR- | Francopel | Black | Full | L5267 & | 4 | 6 | 20k |
| AD-22 | | | | L0822 | | | |
| | | | | (MP from | | | |
| | | | | Fisher | | | |
| | | | | Scientific) | | | |
| NM-FR- | Francopel | Black | Full | L5267 & | 4 | 6 | 20k |
| AD-23 | | | | L0822 | | | |
| | | | | (MP from | | | |
| | | | | Fisher | | | |
| | | | | Scientific) | | | |
| NM-FR- | Francopel | Black | Full | L5267 & | 4 | 6 | 20k |
| AD-35C | | | | L0822 | | | |
| | | | | (MP from | | | |
| | | | | Fisher | | | |
| | | | | Scientific) | | | |
| NM-FR- | Francopel | Black | Full | L5267 & | 4 | 6 | 20k |
| AD-84 | | | | L0822 | | | |
| | | | | (MP from | | | |
| | | | | Fisher | | | |
| | | | | Scientific) | | | |

From this results, it was shown that the substrate and coating system passed a Bally Flex test up to 20,000 cycles. The substrate and coating system passed a Bally Flex test up to 1,000 cycles, up to 5,000 cycles, up to 10,000 cycles, up to 15,000 cycles, and up to 20,000 cycles. The coating system did not separate from the substrate.

### Tape Test

Conditions and results for this test are summarized in Table 24 below.

TABLE 24
Summary of Tape Test Conditions and Results

| | | | | | Adhesive | Topcoat | |
|---|---|---|---|---|---|---|---|
| Sample | | | | | coat Applied | Applied | Tape |
| # | Leather | Color | Grain | Treatment | (g/sqft) | (g/sqft) | Test |
| NM-FR- | Francopel | Black | Full | L5267 & | 4 | 6 | Pass |
| AD-22 | | | | L0822 | | | |
| | | | | (MP from | | | |
| | | | | Fisher | | | |
| | | | | Scientific) | | | |
| NM-FR- | Francopel | Black | Full | L5267 & | 4 | 6 | Pass |
| AD-23 | | | | L0822 | | | |
| | | | | (MP from | | | |
| | | | | Fisher | | | |
| | | | | Scientific) | | | |
| NM-FR- | Francopel | Black | Full | L5267 & | 4 | 6 | Pass |
| AD-35C | | | | L0822 | | | |
| | | | | (MP from | | | |
| | | | | Fisher | | | |
| | | | | Scientific) | | | |
| NM-FR- | Francopel | Black | Full | L5267 & | 4 | 6 | Pass |
| AD-84 | | | | L0822 | | | |
| | | | | (MP from | | | |
| | | | | Fisher | | | |
| | | | | Scientific) | | | |

### Conclusions

Li system passed technical user need requirements with conditions approved at Stage Gate 2.
L5267 is not stable upon freezing based on supplier provided Technical Data Sheet and Safety Data Sheet. Temperature controlled storage and transportation was implemented to ensure quality.

The coating system of Example 18 is deemed to be validated based on results of the tests described herein.

### Example 19: Adhesive Tape Test for Basecoat Testing

The following coating recipes were used for this Adhesive Tape Test.

TABLE 24
Basecoat Recipes for Adhesive Tape Test

| | |
|---|---|
| HA1 | no adhesive coat control |
| HA2 | 17% AS-104 |
| | 0.25% Melio 09S11 |
| | water |
| HA3 | 17% AS-104 |
| | 0.25% Melio 09S11 |
| | 10% 2-Propanol |
| | water |
| HA4 | 17% AS-105 |
| | 0.25% Melio 09S11 |
| | water |
| HA5 | 17% AS-105 |
| | 0.25% Melio 09S11 |
| | 10% 2-Propanol |
| | water |
| HA6 | AS-105 17% |
| | 0.25% Gelatin type B |
| | 0.5% glycerol |
| | 1% Elastin |
| | water |
| HA7 | AS-105 17% |
| | 0.25% Gelatin type B |
| | 0.5% glycerol |
| | 1% Elastin |
| | 0.25% Melio 09S11 |
| | water |
| HA8 | AS-105 17% |
| | 0.25% Gelatin type B |
| | 0.5% glycerol |
| | 1% Elastin |
| | 0.5% TG + MD |
| | water |
| HA9 | AS-105 17% |
| | 0.25% Gelatin type B |
| | 0.5% glycerol |
| | 1% Elastin |
| | 5% TG + MD |
| | water |
| Basecoat | AS-105 5% (L) |
| | 0.25% Gelatin type B |
| | 0.5% glycerol |
| | 1% Rice Quat |
| | 60 gr/L gray pigments |
| | AS-105 liqu |
| | water |

TABLE 25
Adhesive Coat Test Summary

| Sample | | Description | | Hand |
|---|---|---|---|---|
| # | Description adhesive | basecoat | Tape test | observation |
| HA1 | No adhesive | New basecoat | great | good |
| HA2 | 17% AS104, 0.25% ISO | formula w | good | acceptable |
| HA3 | 17% AS104, 0.25% ISO, 10% | 60 gr/L | good | acceptable |
| | 2-propanol | | | |
| HA4 | 17% AS-105, 0.25% ISO | pigments gray | acceptable | acceptable |
| | | formula | | |
| HA5 | 17% AS-105, 0.25% ISO, 10% | | good | acceptable |
| | 2-propanol | | | |
| HA6 | Basecoat formula without | | acceptable | acceptable |
| | crosslinker | | | |
| HA7 | Basecoat formula w/o enzyme | | good | acceptable |
| | crosslinker, 0.25% Melio 09S11 | | | |
| HA8 | Basecoat formula | | good | acceptable |
| HA9 | Basecoat formula 5x enzyme | | good | acceptable |
| | crosslinker | | | |

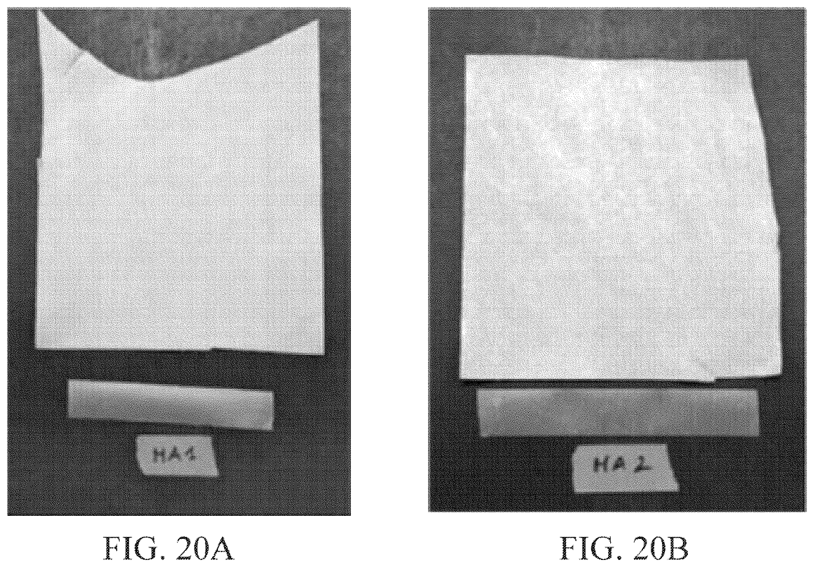

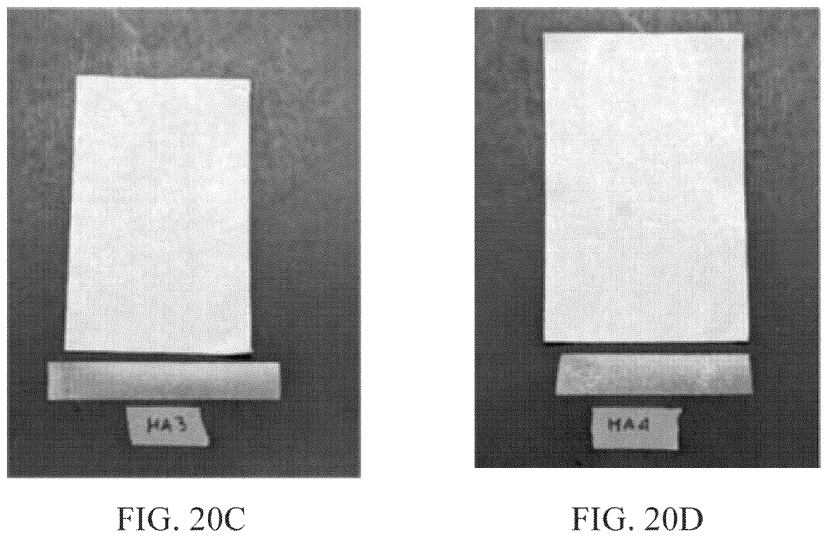

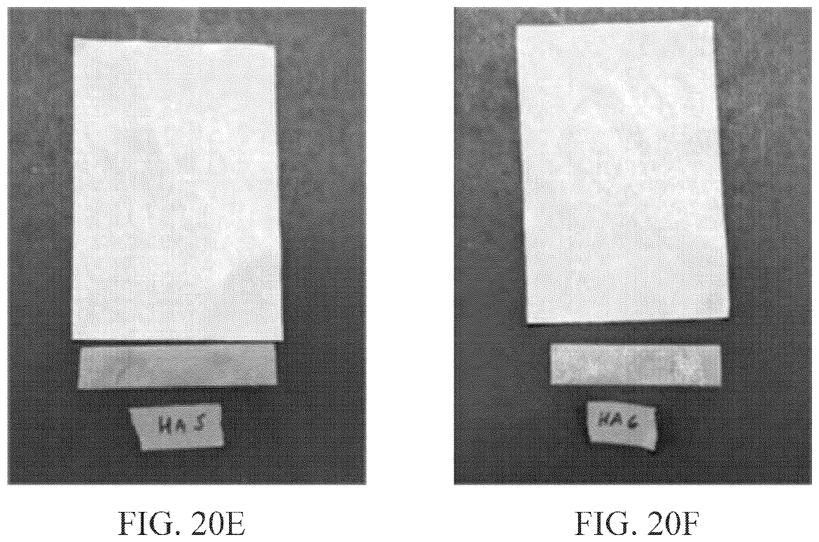

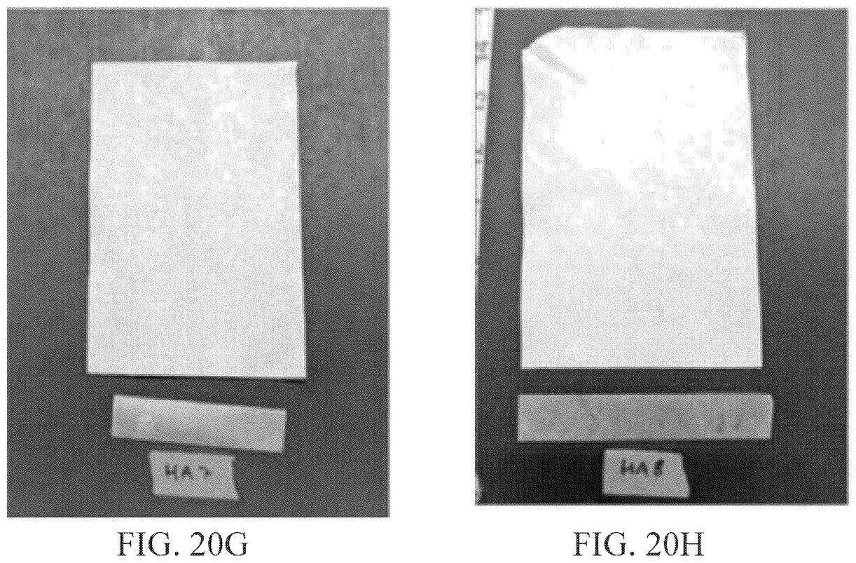

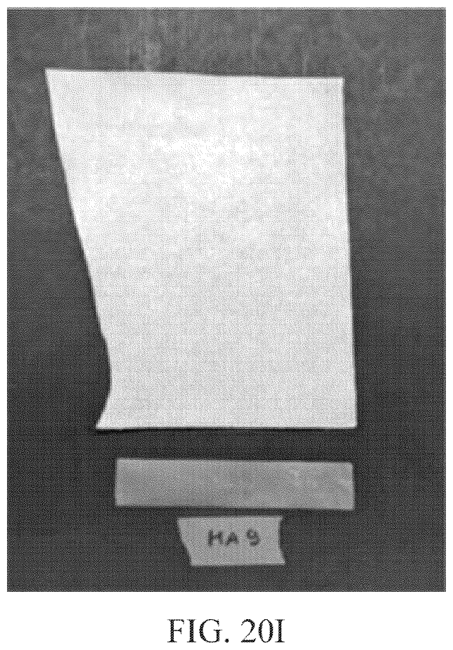

TABLE 26
Summary of Tape Test Results

| Sample # | Description of Results | Figure Illustrating Results |
|---|---|---|
| HA1 | Adhesive Tape Test: | FIG. 20A |
| | Small amount of pigments left on the | |
| | tape | |
| | No skin film delamination | |
| | Hand Observation: | |
| | No sticky | |
| | Good touch | |
| HA2 | Adhesive Tape Test: | FIG. 20B |
| | Small amount of pigments left on the | |
| | tape | |
| | No skin film delamination | |
| | Hand Observation: | |
| | A little sticky | |
| | Acceptable touch | |
| | A little uneven distribution of pigments | |
| HA3 | Adhesive Tape Test: | FIG. 20C |
| | Small amount of pigments left on the | |
| | tape | |
| | No skin film delamination | |
| | Hand Observation: | |
| | A little sticky | |
| | Acceptable touch | |
| | A little uneven distribution of pigments | |
| HA4 | Adhesive Tape Test: | FIG. 20D |
| | Pigments left on the tape | |
| | No skin film delamination | |
| | Hand Observation: | |
| | Not sticky | |
| | Acceptable touch | |
| | A little uneven distribution of pigments | |
| HA5 | Adhesive Tape Test: | FIG. 20E |
| | Small amount of pigments left on the | |
| | tape | |
| | No skin film delamination | |
| | Hand Observation: | |
| | A little sticky | |
| | Acceptable touch | |
| | A little uneven distribution of pigments | |
| HA6 | Adhesive Tape Test: | FIG. 20F |
| | Pigments left on the tape | |
| | No skin film delamination | |
| | Hand Observation: | |
| | A little sticky | |
| | Smooth touch | |
| | A little uneven distribution of pigments | |
| HA7 | Adhesive Tape Test: | FIG. 20G |
| | Small amount of pigments left on the | |
| | tape | |
| | No skin film delamination | |
| | Hand Observation: | |
| | Not sticky | |
| | Acceptable touch | |
| | A little uneven distribution of pigments | |
| HA8 | Adhesive Tape Test: | FIG. 20H |
| | Small amount of pigments left on the | |
| | tape | |
| | No skin film delamination | |
| | Hand observation: | |
| | A little sticky | |
| | Acceptable touch | |
| | A little uneven distribution of pigments | |
| HA9 | Adhesive Tape Test: | FIG. 20I |
| | Small amount of pigments left on the | |
| | tape | |
| | No skin film delamination | |
| | Hand observation: | |
| | A little sticky | |
| | Acceptable touch | |
| | A little uneven distribution of pigments | |

Based on the results shown in Tables 25 and 26, there was no delamination. This demonstrates the effectiveness of the coating system described in Table 24.

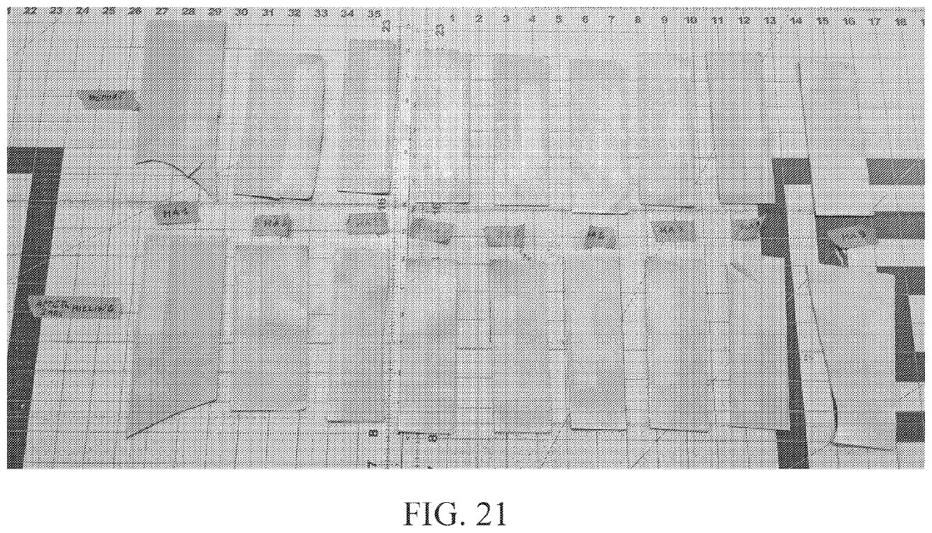

The samples were then cut in half and milled for three hours, then the adhesive test was repeated. The milling includes processing the samples in a dryer for 3 hours using a mix of ballast composed of scrap leather pieces and wool panels. The updated Adhesive Coat Test Summary results are shown below in Tables 27 and 28 and FIGS. 21 and 22A-221.

TABLE 27
Updated Adhesive Coat Test Summary

| | | | | | Tape | Hand |
|---|---|---|---|---|---|---|
| | | | | | test | observation |
| | | | Tape | Hand | T = 0 | T = 0 |
| Sample | Description | Description | test | observation | after | after |
| # | adhesive | basecoat | T = 0 | T = 0 | milling | milling |
| HA1 | No adhesive | New | great | good | good | very soft |
| HA2 | 17% AS104, | basecoat | good | acceptable | acceptable | good |
| | 0.25% ISO | formula w | | | | |
| HA3 | 17% AS104, | 60 gr/L | good | acceptable | acceptable | good |
| | 0.25% ISO, | pigments | | | | |
| | 10% 2-propanol | gray | | | | |
| HA4 | 17% AS-105, | formula | acceptable | acceptable | acceptable | good |
| | 0.25% ISO | | | | | |
| HA5 | 17% AS-105, | | good | acceptable | good | good |
| | 0.25% ISO, | | | | | |
| | 10% 2-propanol | | | | | |
| HA6 | Basecoat formula | | acceptable | acceptable | acceptable | good |
| | without crosslinker | | | | | |
| HA7 | Basecoat formula | | good | acceptable | acceptable | good |
| | w/o enzyme | | | | | |
| | crosslinker, | | | | | |
| | 0.25% Melio 09S11 | | | | | |
| HA8 | Basecoat formula | | good | acceptable | acceptable | good |
| HA9 | Basecoat formula | | good | acceptable | good | good |
| | 5x enzyme | | | | | |
| | crosslinker | | | | | |

TABLE 28
Summary of Updated Tape Test Results

| Sample # | Description of Results | Figure Illustrating Results |
|---|---|---|
| HA1 | Adhesive Tape Test: | FIG. 22A |
| | Small amount of pigments left on the | |
| | tape | |
| | No skin film delamination | |
| | Hand Observation: | |
| | A little sticky | |
| | Soft touch improved from T = 0 and no | |
| | brakes | |
| HA2 | Adhesive Tape Test: | FIG. 22B |
| | Small amount of pigment left on the tape | |
| | No skin film delamination | |
| | Hand observation: | |
| | A little sticky | |
| | Soft touch improved from T = 0 and no | |
| | brakes | |
| HA3 | Adhesive Tape Test: | FIG. 22C |
| | Some amount of pigment left on the tape | |
| | No skin film delamination | |
| | Hand observation: | |
| | A little sticky | |
| | Soft touch improved from T = 0 and no | |
| | brakes | |
| HA4 | Adhesive Tape Test: | FIG. 22D |
| | Small amount of pigment left on the tape | |
| | No skin film delamination | |
| | Hand observation: | |
| | A little sticky | |
| | Soft touch improved from T = 0 and no | |
| | brakes | |
| HA5 | Adhesive Tape Test: | FIG. 22E |
| | Small amount of pigment left on the tape | |
| | No skin film delamination | |
| | Hand observation: | |
| | A little sticky | |
| | Soft touch improved from T = 0 and no | |
| | brakes | |
| HA6 | Adhesive Tape Test: | FIG. 22F |
| | Some amount of pigment left on the tape | |
| | No skin film delamination | |
| | Hand observation: | |
| | A little sticky | |
| | Soft touch improved from T = 0 and no | |
| | brakes | |
| HA7 | Adhesive Tape Test: | FIG. 22G |
| | Some amount of pigment left on the tape | |
| | No skin film delamination | |
| | Hand observation: | |
| | A little sticky | |
| | Soft touch improved from T = 0 and no | |
| | brakes | |
| HA8 | Adhesive Tape Test: | FIG. 22H |
| | Small amount of pigment left on the tape | |
| | No skin film delamination | |
| | Hand observation: | |
| | A little sticky | |
| | Soft touch improved from T = 0 and no | |
| | brakes | |
| HA9 | Adhesive Tape Test: | FIG. 22I |
| | Small amount of pigment left on the tape | |
| | No skin film delamination | |
| | Hand observation: | |
| | A little sticky | |
| | Soft touch improved from T = 0 and no | |
| | brakes | |

Based on the results of Tables 27 and 28 and FIGS. 21 and 22A-221, even after the milling process, the coating system still proved effective.

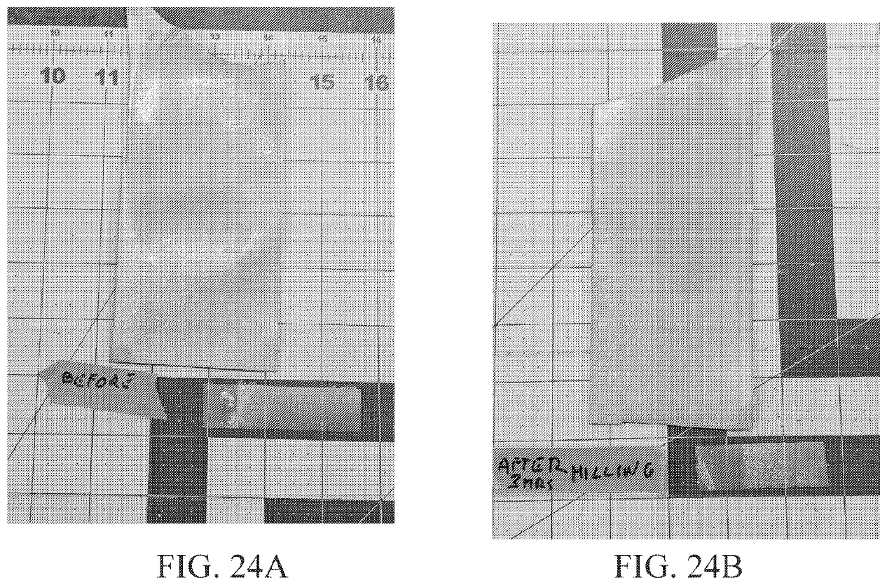

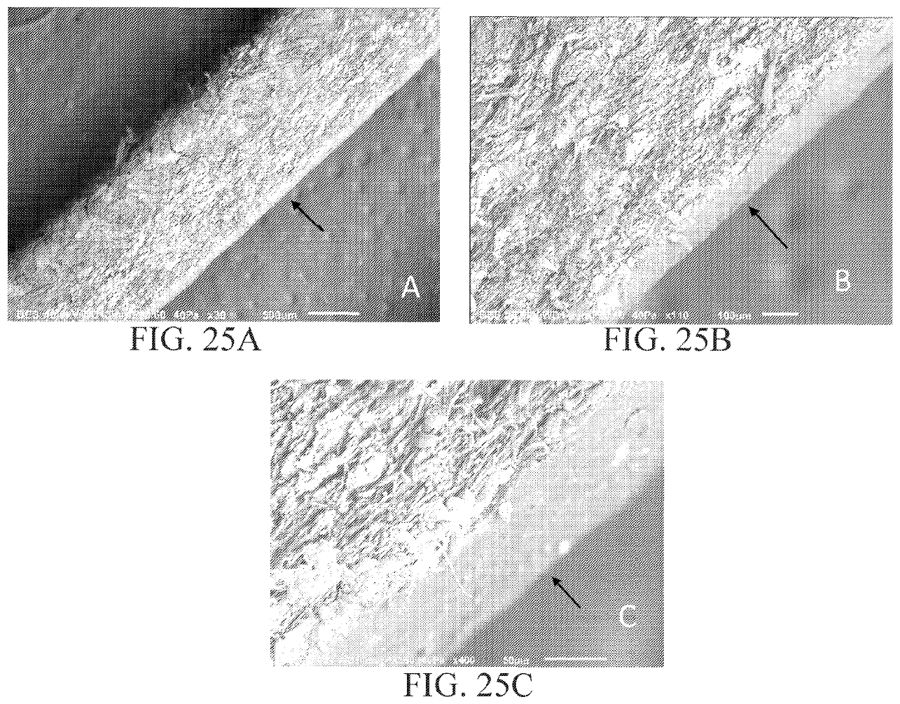

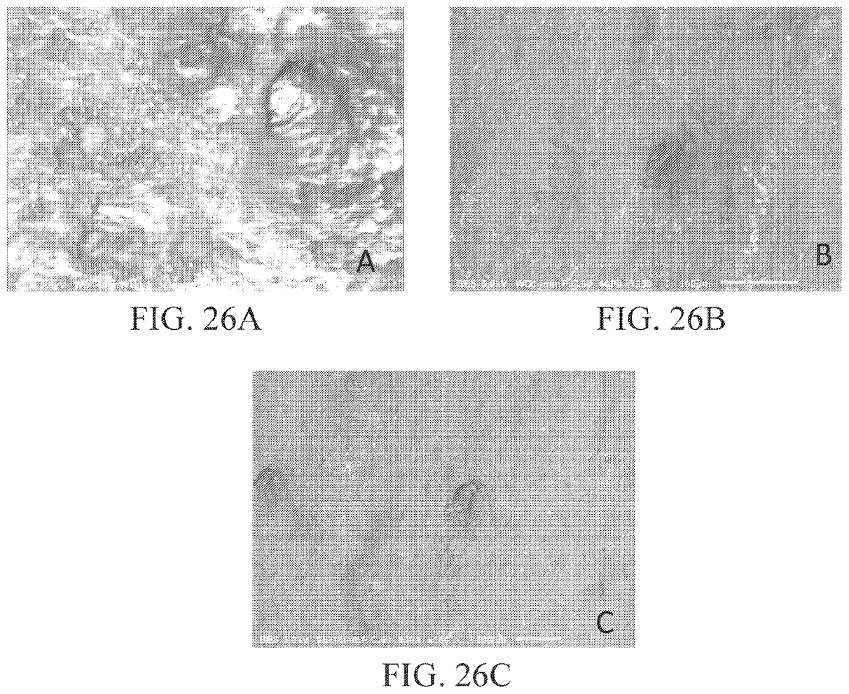

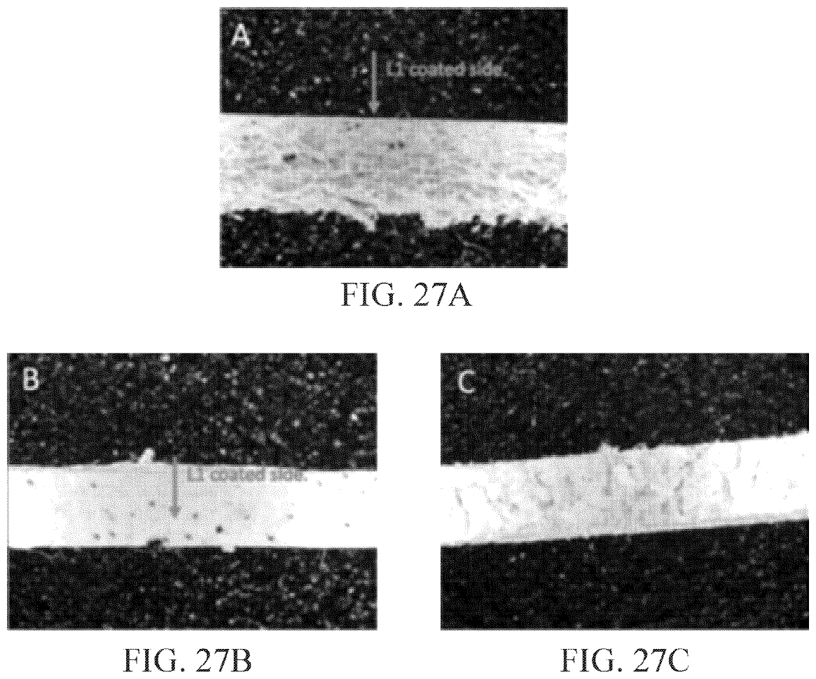

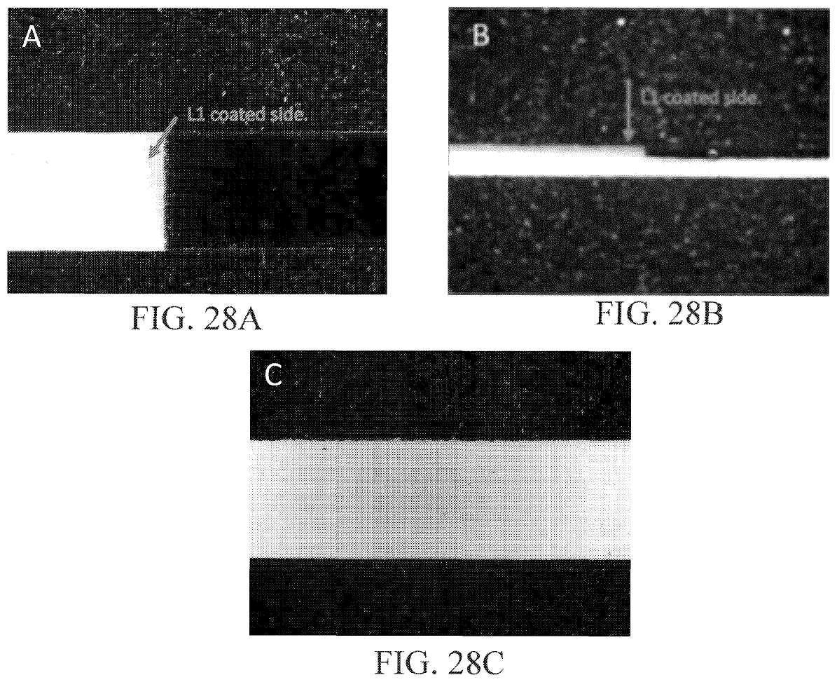

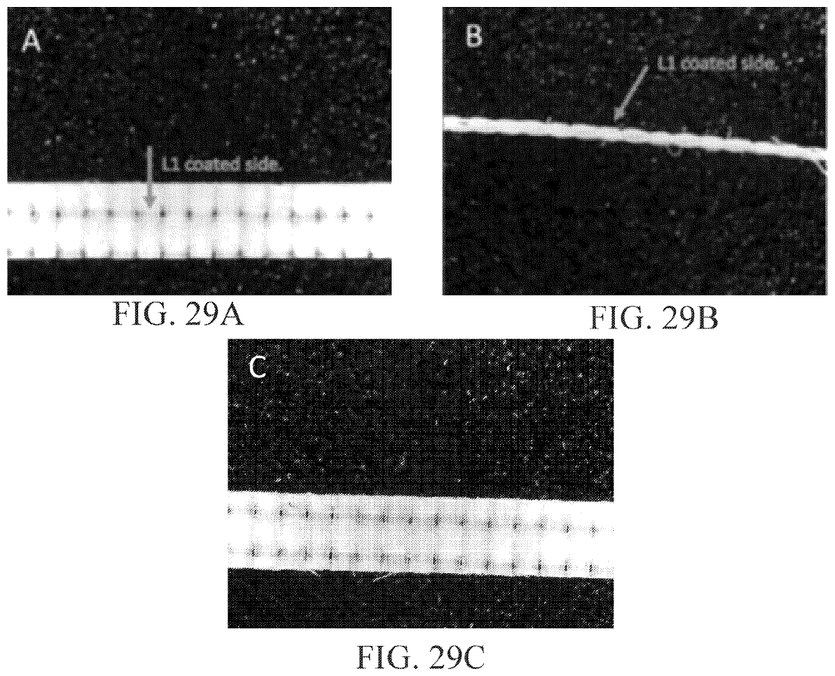

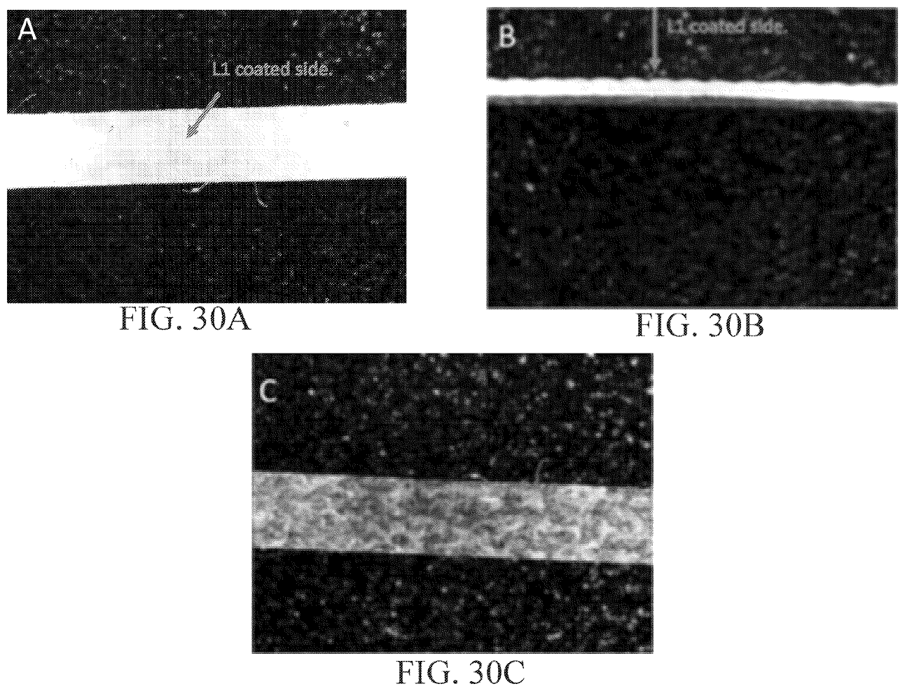

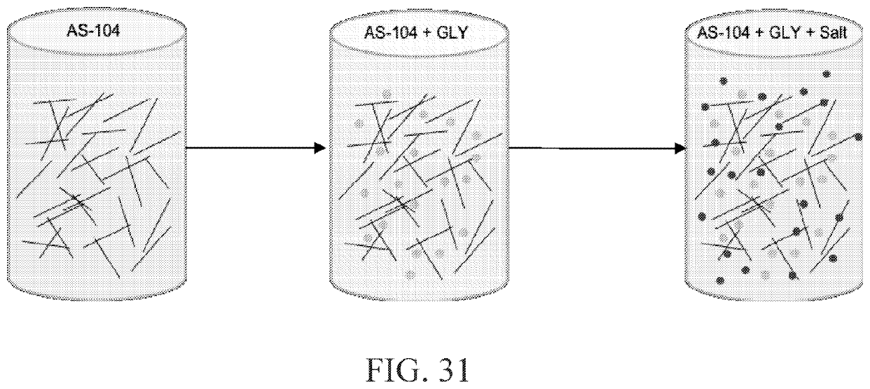

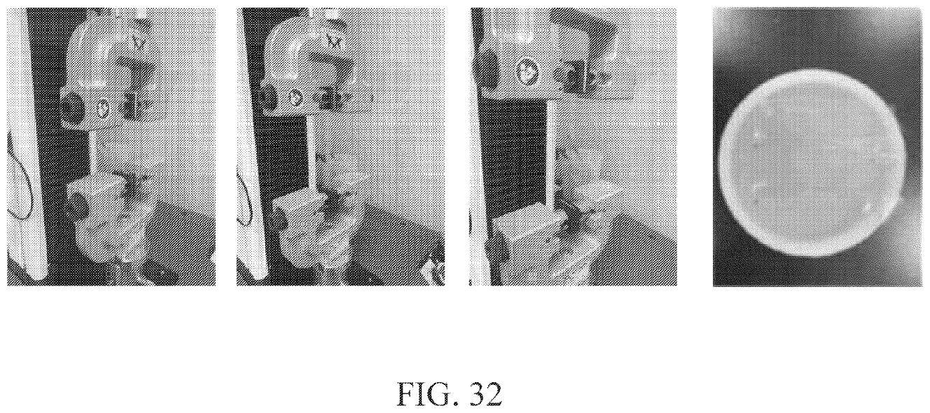

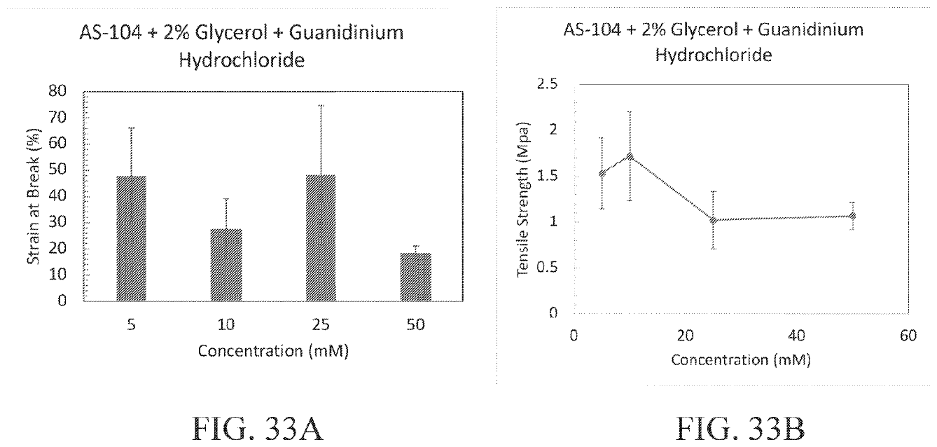

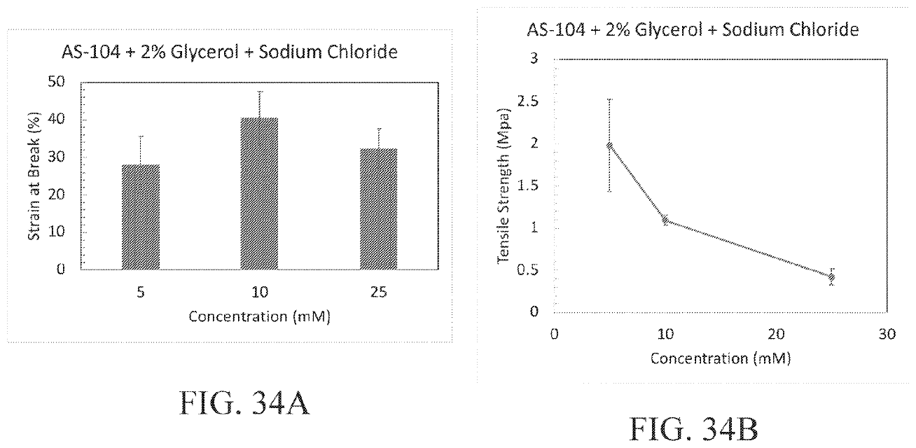

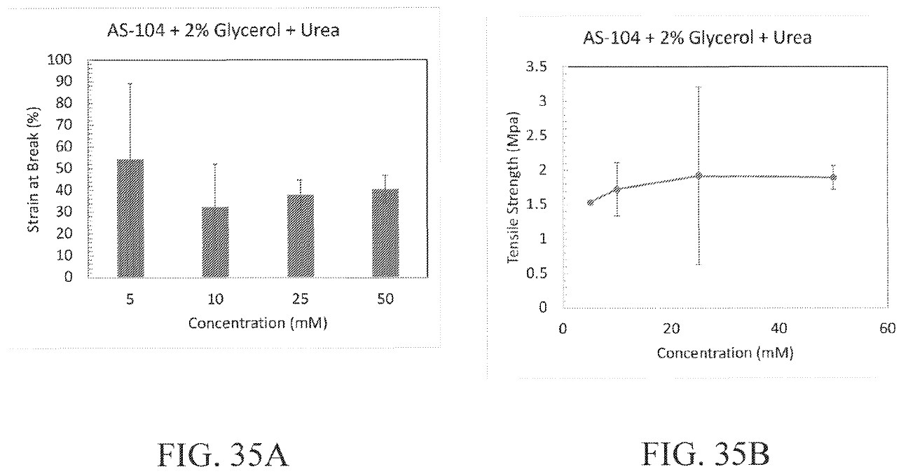

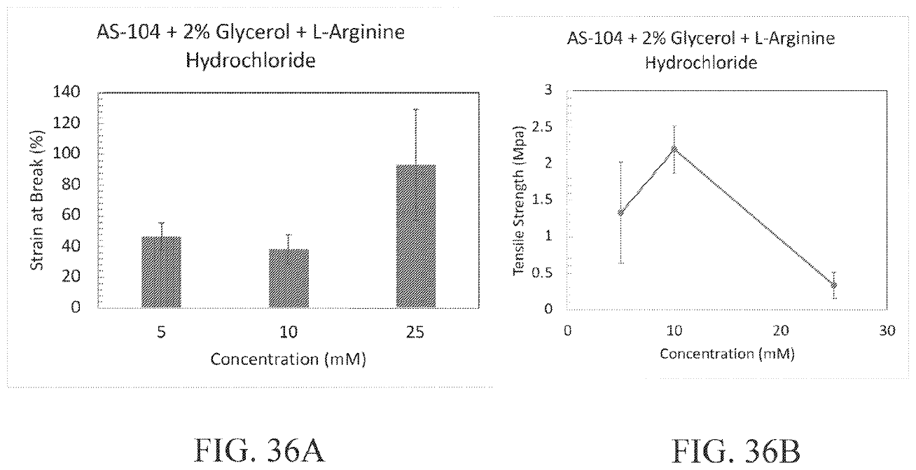

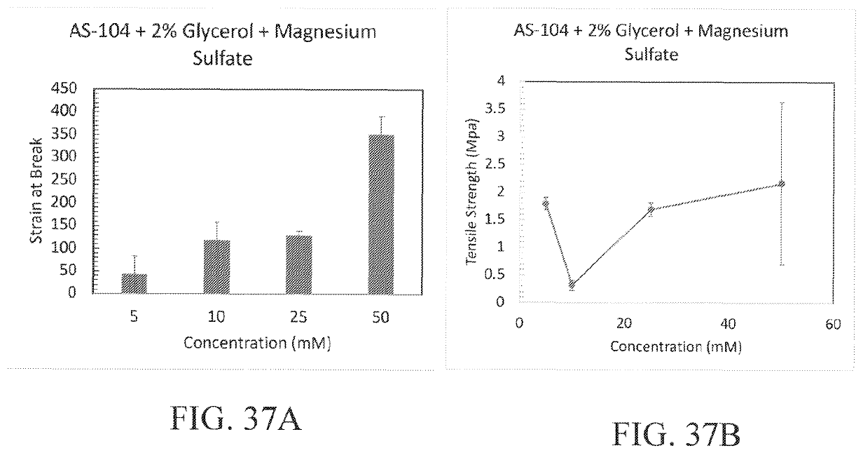

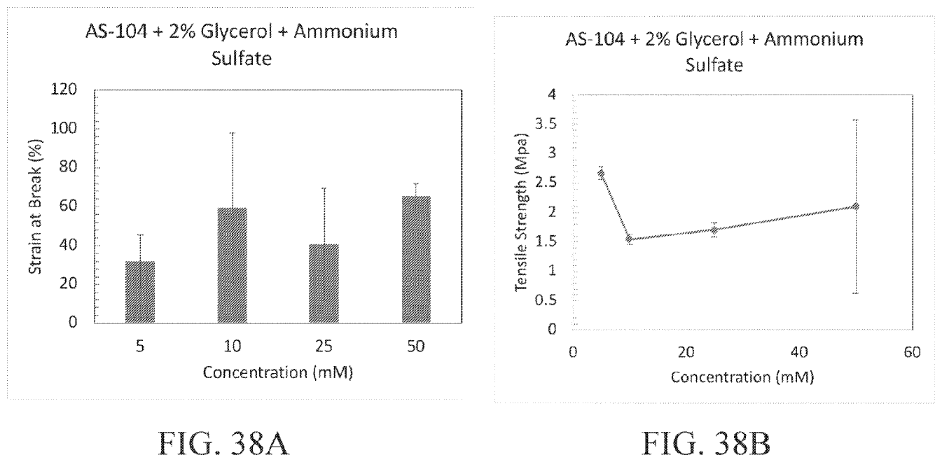

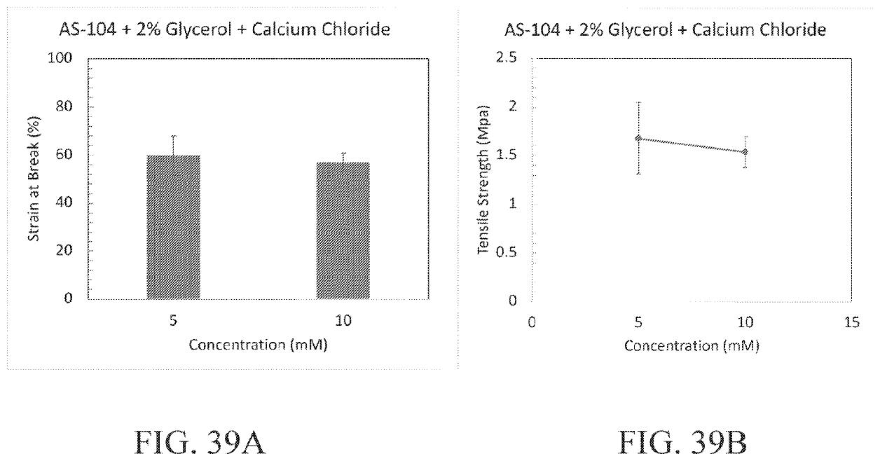

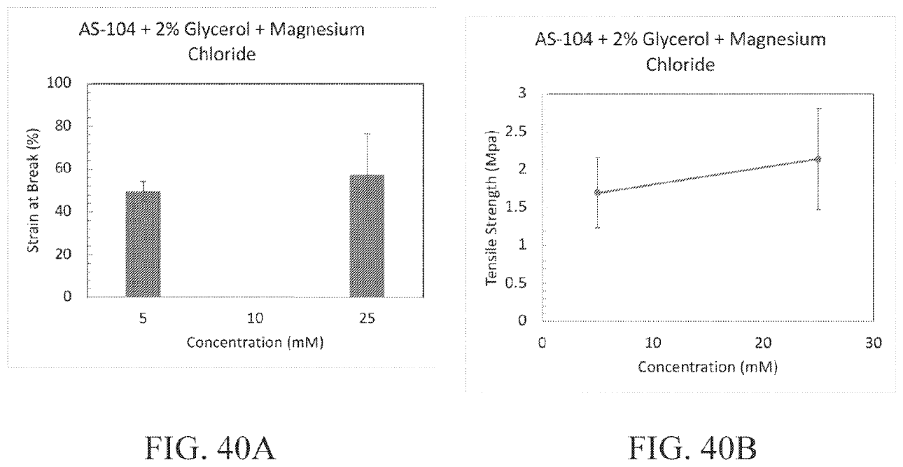

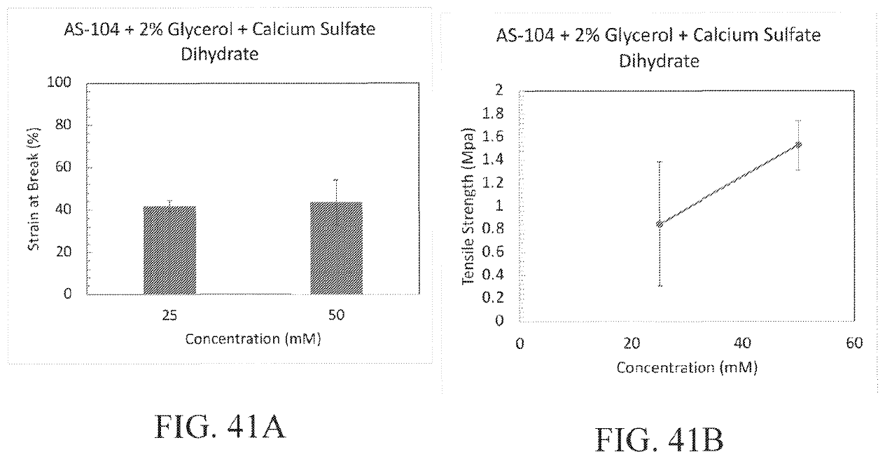

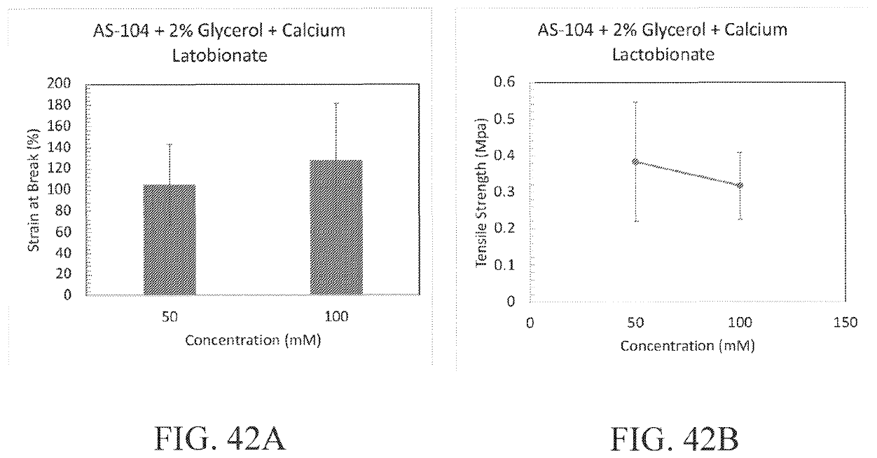

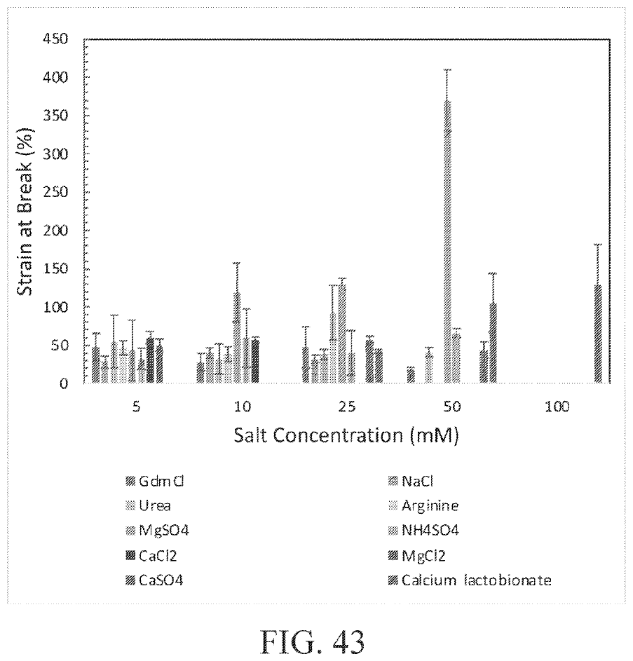

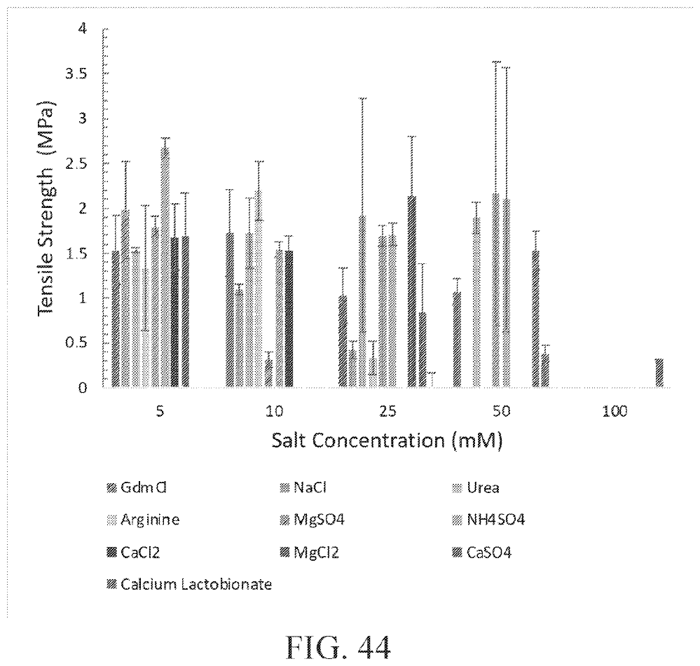

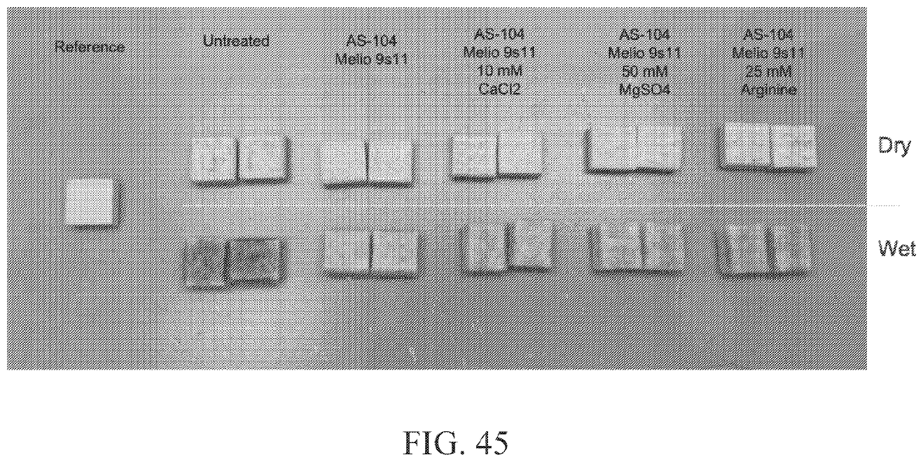

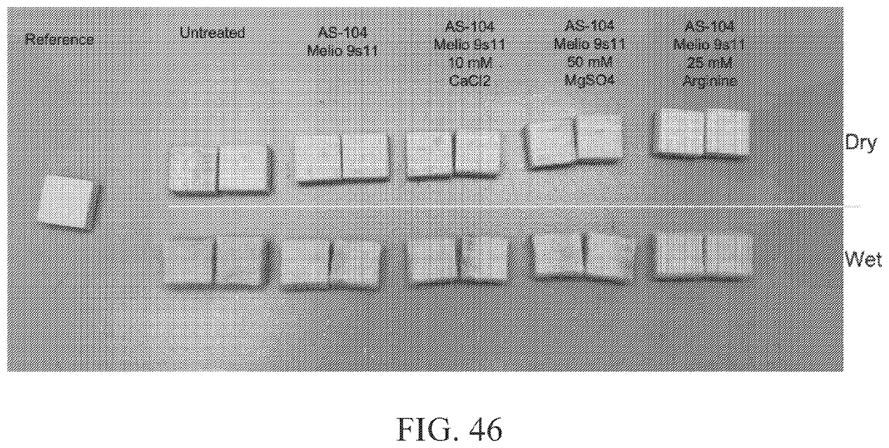

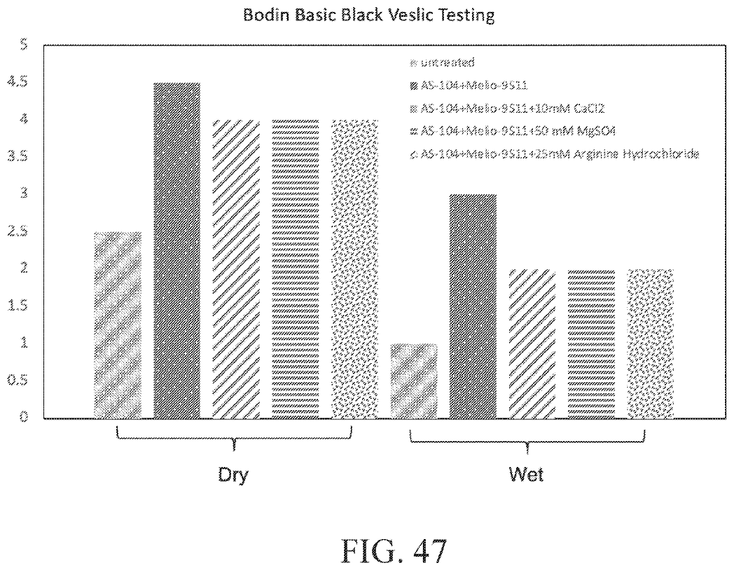

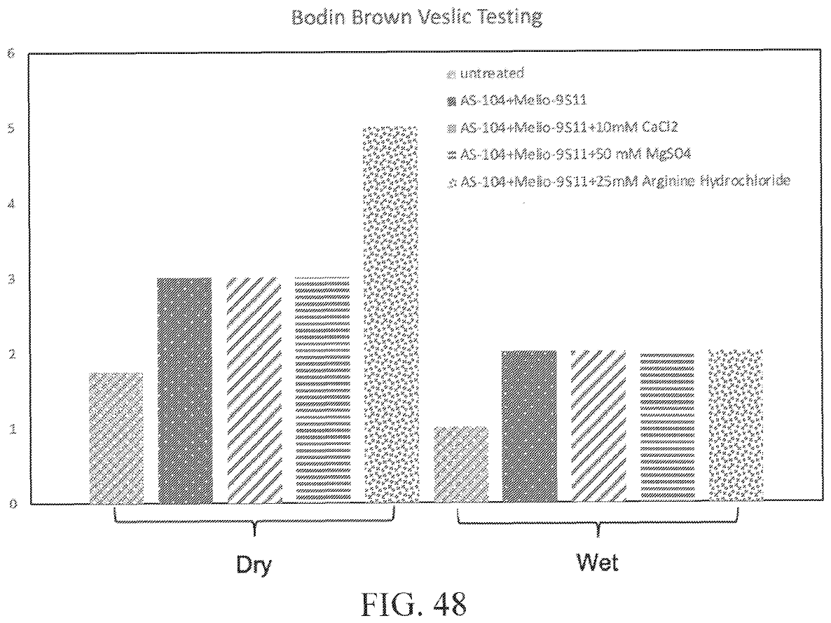

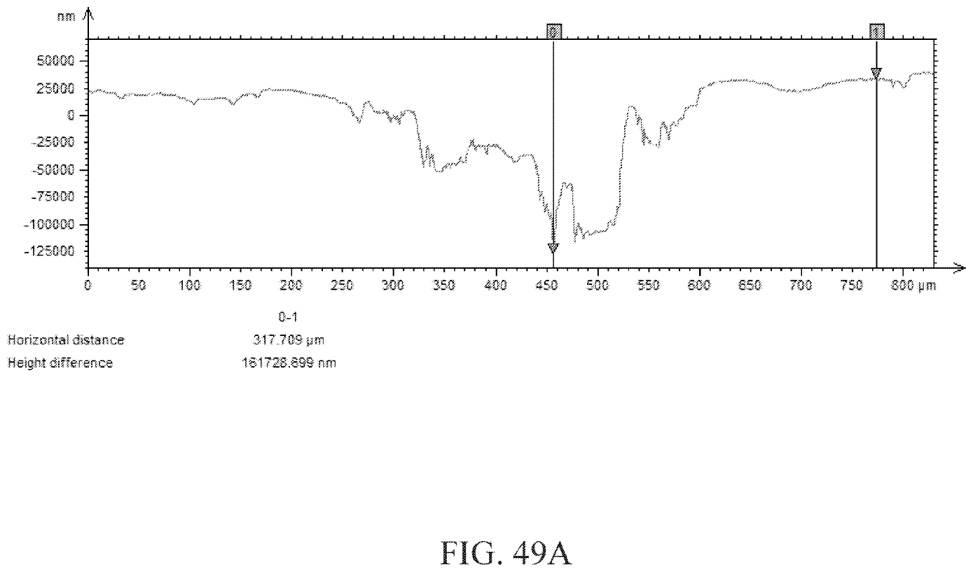

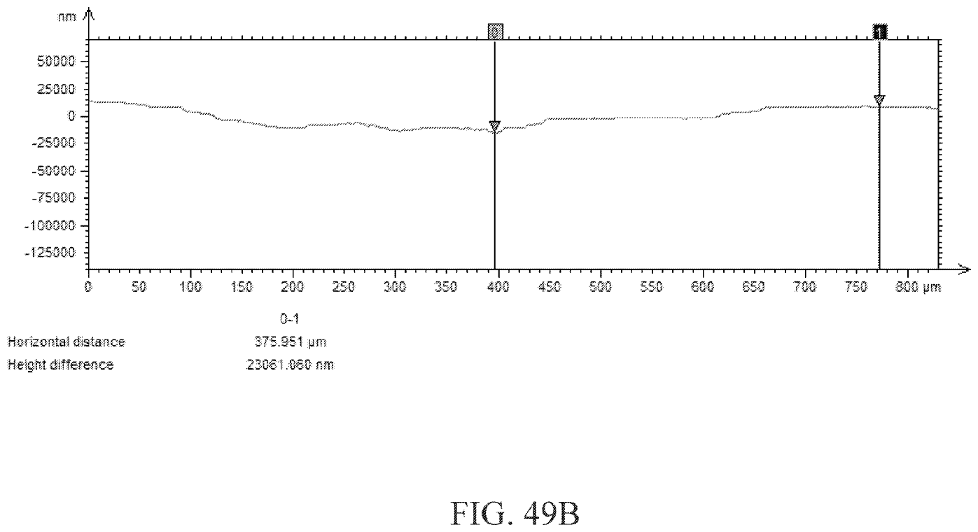

Samples were also tested after CFR application before and after the milled basecoat. Two HA samples were tested by the Adhesive Tape Test, one that was not milled before the topcoat was applied and one that was milled before the topcoat was applied. The results can be seen in Table 29 below and FIGS. 24A-24B.

TABLE 29
Summary of Updated Tape Test Results

| Sample # | Description of Results | Figure Illustrating Results |
|---|---|---|
| HA1 - no | Adhesive Tape Test: | FIG. 24A |
| milling | Film removed and transfer to the tape | |
| before | Similar results for all pre-milled samples | |
| topcoat | Hand observation: | |
| | No stickiness | |
| | After a quick hand milling, all topcoat is | |
| | removed, film is brittle | |
| HA1 - | Adhesive Tape Test: | FIG. 24B |
| milling | Film removed in particles and transfer to | |
| before | the tape | |
| topcoat | Similar results for all pre-milled samples | |
| | Different than with no milling | |
| | Hand observation: | |
| | No stickiness | |
| | After a quick hand milling, all topcoat is | |
| | remove, film is brittle | |

### Example 20: Leather Coating Recipes for a Coating System

The following formulations summarized in Table 30 are non-limiting exemplary coating recipes in accordance with a coating system of the present disclosure.

TABLE 30
Exemplary Coating Recipes

| PRODUCTS/ | SOLUTIONS/STEPS | | | | | | | |
|---|---|---|---|---|---|---|---|---|
| FORMULATIONS | A | B | C | D | E | F | G | PROCESSES/PROCEDURE |

Example 20 -001

| | | | |
|---|---|---|---|
| MTX organic | 10 | | A) 2X |
| Pigments | | | |
| BIO GLOSSY 19 | 30 | | |
| BIO CERAL 78 | 50 | | B) 3 X |
| WATER | 400 | | |
| L5267 | 100 | | ROTOPRESS 85* C. |
| BIO PUR 3008 | 100 | | |
| BIO PEN 80 | 20 | | DRY MILLING 2 HOURS |
| L0822 | | 100 | |

Example 20 -002

| | | | | | |
|---|---|---|---|---|---|
| MTX | 10 | | | A | 2 X |
| BIO GLOSSY 19 | 50 | 50 | | | PLATING 85 C. |
| BIO CERAL 78 | 50 | 50 | | | |
| WATER | 400 | 300 | | | |
| L5267 | 125 | 100 | | B | 2 X |
| BIO PUR 3001 | 75 | | | | PLATING 85 C. |
| AS 122 | 100 | 100 | | | |
| BIO PUR 5400 | | 100 | | C | 3 X |
| L0822 | | | 100 | | |

Example 20 -003

| | | | | |
|---|---|---|---|---|
| BIO GLOSSY 19 | 50 | | | |
| BIO COMP 1007 | 400 | | A | 2X Spray |
| L5267 | 100 | | | HAIRCELL 100 Atm 2″ 70 C. |
| PIGMENT DPE | 70 | | | 2X SPRAY |
| DYE MFE | 20 | | | |
| WATER | 450 | | B | 2X Spray |
| L0822 | | 100 | | PLATING 85* C. |

Example 20 -004

| | | | | | |
|---|---|---|---|---|---|
| BIO GLOSSY 19 | 50 | | | | DRYMILLING OVER NIGHT |
| BIO COMP 1007 | 400 | | | A | 2x Spray |
| L5267 | 100 | | | | Plate 80 C. 100 Atm 1″ |
| PIGMENT DPE | 70 | | | | 2x Spray |
| DYE MFE | 20 | | | | |
| WATER | 450 | | 100 | B | 2x |
| L0822 | | 100 | | | Plating 85 C. |
| EM 127 OPACO | | | 100 | | Dry milling |
| Tatto Seta | | | 10 | | |
| | | | | C | 1x Spray |

Example 20 -005

| | | | | | | |
|---|---|---|---|---|---|---|
| BIOSOLV 22 | 400 | 400 | | | A) | 2X Spray |
| WATER | 500 | 500 | | 100 | | Mill O/N |
| MFE DYES | 100 | 100 | | | | |
| L0822 | | | 100 | | B) | 1X Spray |
| EM 127 OPACO | | | | 100 | | |
| TATTO SETA | | | | 10 | C) | 3X Spray |
| | | | | | D) | 1x Spray |

Example 20 -006

| | | | | |
|---|---|---|---|---|
| L5267 | 200 | | | |
| BIO PUR 1878 | 100 | | A) | 3x Spray |
| BIO CERAL 78 | 100 | | | Haircell 200 Atm 2″ 70 C. |
| Filler B/55 | 30 | | | 3x Spray |
| BIO COMPAT 1007 | 100 | | | |
| AS 122 LS | 200 | | B) | 3x Spray |
| WATER | 300 | | | Roto 90 C. 40 Atm |
| PIGMENT | 100 | | | |
| TATTO SETA | 5 | | | |
| L0822 | | 100 | | |

Example 20 -007

| | | | | | | |
|---|---|---|---|---|---|---|
| BIO GLOSSY 19 | 50 | | 50 | | | DRYMILLING OVER NIGHT |
| BIO COMP 1007 | 400 | | 400 | | A | 2x Spray |
| L5267 | 100 | | 100 | | | |
| PIGMENT DPE | 70 | | 70 | | B | 1x Spray |
| DYE MFE | 20 | | 20 | | | Emboss “lola” |
| WATER | 450 | 100 | 450 | | | Drymill O/N |
| EM 1235 FA | | 100 | | | | |
| L0822 | | | | 100 | C | 2x Spray |
| | | | | | D | 3x Spray |
| | | | | | | Roto 90 C. |

Example 20 -008

| | | | | |
|---|---|---|---|---|
| DPE PIGMENT MIX | 10 | | | |
| L5267 | 60 | | A | 1 X |
| WATER | 60 | | | |
| BIO GLOSSY 23 | 10 | | | |
| AS 122 | 20 | | B | 3 X |
| L0822 | | 100 | | |
| AS122 | 20 | | | |
| L5267 | 60 | | A | 2 X |
| WATER | 60 | | | |
| BIO GLOSSY 23 | 10 | | | |
| L0822 | | 100 | B | 3 X |
| | | | | SAND BLAST? |

Example 20 -009

| | | | | | | | |
|---|---|---|---|---|---|---|---|
| L5267 | 100 | | 100 | | | | |
| WATER | 200 | | 200 | | 100 | A) | 1x Spray |
| Metoxy Propanol | 200 | | 200 | | | | |
| AS 124 | | 800 | | | | B) | 3x Spray |
| GROUND 512K | | 40 | | | | | Haircell 100 Atm 1′5″ |
| WATER | | 100 | | | | | 3x Spray |
| DPE PIGMENTS MF | | 60 | | | | | |
| L0822 | | | | 1000 | | C) | 1x Spray |
| BIO EM 1235 FA | | | | | 100 | | |
| SILT 99 | | | | | 2 | D) | 3x Spray |
| | | | | | | E) | 1x Spray |
| | | | | | | | Plate 90 C. |
| | | | | | | | Mill |

Example 20 -010

| | | | | | | |
|---|---|---|---|---|---|---|
| L5267 | 100 | | 100 | | | |
| WATER | 200 | | 200 | | A) | 1x Spray |
| Metoxy Propanol | 200 | | 200 | | | |
| AS 124 | | 1000 | | | B) | 3x Spray |
| DPE PIGMENTS | | 100 | | | | Haircell 100 Atm 1′5″ |
| L0822 | | | | 1000 | | 3x Spray |
| | | | | | C) | 1x Spray |
| | | | | | D) | 3x Spray |

Example 20 -011

| | | | | | |
|---|---|---|---|---|---|
| AS122 | 20 | | | | SHAVING 0.6/0.7 MM |
| L5267 | 60 | | | A | 2 X |
| WATER | 60 | | 100 | | |
| BIO GLOSSY 23 | 20 | | | | |
| L0822 | | 100 | | B | 2 X |
| EM 127 OPACO | | | 100 | | |
| | | | | | SAND BLAST? |
| | | | | C | 1 X |

Example 20 -012

| | | | | |
|---|---|---|---|---|
| L5267 | 100 | | | |
| WATER | 100 | | A) | 2x Spray (light) |
| PU/30 | 5 | | | |
| L0822 | | 1000 | B) | 3x Spray |
| | | | | Roto |

Example 20 -013

| | | | | | | |
|---|---|---|---|---|---|---|
| MFE NERO N | 12 | | | | | |
| MFE BRUNO | 15 | | | | A | 1 LIGHT HAND PADDING |
| SCURO | | | | | | |
| IPA | 500 | | | | | |
| BIO GLOSSY 19 | | 10 | | | B | 1 X |
| WATER | | 60 | | 100 | | |
| L5267 | | 60 | | | C | 2 X |
| AS 122 | | 20 | | | | |
| L0822 | | | 100 | | | SAND BLAST |
| EM 127 OPACO | | | | 100 | | |
| | | | | | D | 1 X |
| | | | | | | STEAKING OR DRYMILLING |

Example 20 -014

| | | | | |
|---|---|---|---|---|
| L5267 | 200 | | | |
| ECOMP 1007 | 200 | | A) | 2X SPRAY |
| AS 122 LS | 200 | | | PLATE 80 C. |
| WATER | 400 | | | 2X SPRAY |
| L0822 | | 1000 | | |
| | | | B) | 3X SPRAY |
| | | | | ROTO 95 C. |

Example 20 -015

| | | | | | | |
|---|---|---|---|---|---|---|
| MID Basecoat | 1000 | 800 | | | | Buff Flesh Side |
| DPE Pigments | 60 | 30 | | | | |
| L5267 | | 200 | | | A) | 3x Spray |
| MTX Pigments | | 10 | | | | Haircell |
| PU/30 | | 5 | 1 | | | |
| Bio pur 5000 | | | 100 | | B) | 3x Spray |
| Water | | | 100 | | | Sandblast |
| L0822 | | | | 1000 | | |
| | | | | | C) | 1x Spray |
| | | | | | D) | 3x Spray |
| | | | | | | Sandblast |
| | | | | | | Haircell “microfiore” |

Example 20 -016

| | | | | | |
|---|---|---|---|---|---|
| L5267 | 150 | | | | |
| BIO CERAL 78 | 100 | | | A) | 2x Spray |
| AS-104 LS | 300 | | | | Plate |
| Water | 450 | | 500 | | 2x Spray |
| L0822 | | 1000 | | | |
| Bio EM 1235 | | | 500 | B) | 1x Spray |
| Silt 99 | | | 10 | | |
| | | | | C) | 1x Spray |
| | | | | | Plate |
| | | | | | Mill 1 h |
| | | | | | Plate |

Example 20 -017

| | | | | | | |
|---|---|---|---|---|---|---|
| DPE PIGMENTS | 10 | | | | | DRYMILLING |
| GROUND 93 | 100 | | | | | 2 HOURS 20* C. 90% UMIDITY |
| AS-105 | 50 | 100 | 100 | | | 4 HOURS. 35* C. 35% UMIDITY |
| GLOSSY 19 | 50 | 50 | 50 | | | |
| WATER | 200 | 400 | 400 | | | TOGGLING |
| MTX PIGMENT | | 10 | 10 | | | |
| BIO CERAL 78 | | 100 | 100 | | A | 2 X |
| L5267 | | 125 | 100 | | | FELT POLISH |
| BIO PUR 3008 | | 75 | | | | |
| BIO PUR 5000 | | | 100 | | B | 2 X |
| L0822 | | | | 100 | | PLATING |
| | | | | | C | 2 X |
| | | | | | | PLATING |
| | | | | | D | 2-3 X |

Example 20 -018

| | | | | | |
|---|---|---|---|---|---|
| Ceral 659 | 300 | | | | |
| Biopur 3015 | 200 | 150 | | A | 2x Spray |
| Bio glossy 19 | 100 | | | | FF cogolo senza rose 60 Atm |
| Water | 400 | 450 | | | |
| BIO CERAL 78 | | 100 | | B | 2x Spray |
| AS-104 LS | | 300 | | | Microfiore |
| L0822 | | | 1000 | | 2x Spray |
| | | | | C | 1x Spray |

Example 20 -019

| | | | | | | |
|---|---|---|---|---|---|---|
| WATER | 500 | 520 | 500 | | | |
| BIOSOLV 22 | 500 | | | | A | 2 X |
| MFE Dyes | 100 | 10 | | | | |
| L5267 | | 150 | | | B | 2 X |
| AS 122 | | 150 | 100 | | | ROTOPRESS 80* C. |
| BIO CERAL 78 | | 100 | | | | 2 X |
| GLOSSSY 19 | | 100 | | | | |
| DPE pigments | | 20 | | | | |
| CERAL 63 N | | 30 | | | C | 3 X |
| EPR 302 | | | 300 | | | ROTOPRESS 95* C. |
| GLOSSY 21 | | | 100 | | | |
| L0822 | | | | 100 | D | 2 X |
| | | | | | | ROTOPRESS 100* C. |

Example 20 -020

| | | | | | |
|---|---|---|---|---|---|
| L5267 | 150 | | | | |
| BIO CERAL 78 | 100 | | | A) | 2x Spray |
| AS-104 LS | 300 | | | | Haircell |
| Water | 450 | | 500 | | 2x Spray |
| L0822 | | 1000 | | | |
| Bio EM 1235 | | | 500 | B) | 2x Spray |
| Silt 99 | | | 10 | | |
| DPE pigments | 60 | | | C) | 1x Spray |
| | | | | | Plate |
| | | | | | Microfiore |

Example 20 -021

| | | | | | |
|---|---|---|---|---|---|
| L5267 | 150 | | | | |
| BIO CERAL 78 | 100 | | | A) | 2x Spray |
| AS-104 LS | 300 | | | | Plate |
| Water | 450 | | 500 | | 2x Spray |
| L0822 | | 1000 | | | |
| Bio EM 1235 | | | 500 | B) | 1x Spray |
| Silt 99 | | | 10 | | |
| MTX | 40 | | | C) | 1x Spray |
| | | | | | Plate |
| | | | | | Microfiore |

Example 20 -022

| | | | | | |
|---|---|---|---|---|---|
| L5267 | 150 | | | | |
| BIO CERAL 78 | 100 | | | A) | 2x Spray |
| AS-104 LS | 300 | | | | Plate + Mill O/N |
| Water | 450 | | 500 | | 2x Spray |
| L0822 | | 1000 | | | |
| EM 127 OPACO | | | 500 | B) | 1x Spray |
| Silt 99 | | | 10 | | |
| DPE | 60 | | | C) | 2x Spray |
| | | | | | Plate |

Example 20 -023

| | | | | | | |
|---|---|---|---|---|---|---|
| 204/N | 100 | | | | A | 1 X FLESH SIDE |
| WATER | 100 | 50 | | 100 | | |
| L5267 | | 90 | | | B | 2 X |
| AS-104 | | 10 | | | | |
| L0822 | | | 100 | | | PLATING 75* C. |
| EM 127 OPACO | | | | 100 | | |
| | | | | | C | 2 X |
| | | | | | D | 1 X |
| | | | | | | SAND BLAST 85* C. |

Example 20 -024

| | | | | | |
|---|---|---|---|---|---|
| Biopur 3015 | 270 | | | | |
| AS-104 LS | 30 | | | A) | 2x Spray |
| BIO CERAL 78 | 100 | | | | Emboss FF |
| Glossy 19 | 50 | | | | 2x Spray |
| Water | 550 | | 100 | | |
| DPE Pigments | 60 | | | B) | 2x Spray |
| L0822 | | 1000 | | | |
| Bio EM 1235 | | | 100 | C) | 1x Spray |
| Silt 99 | | | 10 | | Plate |
| | | | | | Emboss Microfiore |

Example 20 -025

| | | | | | |
|---|---|---|---|---|---|
| Biopur 3015 | 270 | | | | |
| AS-104 LS | 30 | | | A) | 2x Spray |
| BIO CERAL 78 | 100 | | | | Emboss FF |
| Glossy 19 | 50 | | | | 2x Spray |
| Water | 550 | | 100 | | |
| DPE Pigments | 60 | | | B) | 2x Spray |
| L0822 | | 1000 | | | |
| Bio EM 1235 | | | 100 | C) | 1x Spray |
| Silt 99 | | | 10 | | Plate |
| | | | | | Emboss Microfiore |

Example 20 -026

| | | | | | |
|---|---|---|---|---|---|
| Biopur 3015 | 270 | | | | |
| AS-104 LS | 30 | | | A) | 2x Spray |
| BIO CERAL 78 | 100 | | | | Microfiore + Mill 4 H |
| Glossy 19 | 50 | | | | 2x Spray |
| Water | 550 | | 100 | | |
| DPE Pigments | 60 | | | B) | 1x Spray |
| L0822 | | 1000 | | | |
| Bio EM 1235 | | | 100 | C) | 1x Spray |
| Silt 99 | | | 10 | | Sandblast |
| | | | | | Mill 20″ |

Example 20 -027

| | | | | | |
|---|---|---|---|---|---|
| BIOPUR 3015 | 270 | | | | |
| AS-104 | 30 | | | A) | 2X |
| BIO CERAL 78 | 50 | | | | PLATE |
| BIO GLOSSY 19 | 50 | | | | 2X |
| WATER | 400 | | 100 | | |
| PIGMENT | 40 | | | B) | 1X |
| L0822 | | 100 | | | |
| BIO EM 1235 | | | 100 | C) | 1X |
| SILT 99 | | | 10 | | PLATE |
| | | | | | MILL 30″ |

Example 20 -028

| | | | | |
|---|---|---|---|---|
| BIO PUR 1878 | 270 | | | |
| AS-104 LS | 30 | | A) | 2x |
| BIO CERAL 78 | 70 | | | |
| TOP 201 MATT | 30 | | B) | 2x |
| WATER | 500 | | | Roto 90 |
| DPE PIGMENTS | 50 | | | Stake |
| Metoxy Propanol | 10 | | | |
| L0822 | | 100 | | |

Example 20 -029

| | | | | |
|---|---|---|---|---|
| BIOPUR 3015 | 90 | | | |
| AS-104 LS | 10 | | A) | 2x Spray |
| WATER | 100 | | | Plate 70 C. |
| MTX | 20 | | | |
| L0822 | | 100 | B) | 2x Spray |
| | | | | Plate |
| | | | | Mill 1 H |

Example 20 -030

| | | | | |
|---|---|---|---|---|
| BIOPUR 3015 | 90 | | | |
| AS-104 LS | 10 | | A) | 2x Spray |
| WATER | 100 | | | Plate 70 C. |
| MTX | 20 | | | |
| L0822 | | 100 | B) | 2x Spray |
| | | | | Plate |
| | | | | Mill 1 H |

Example 20 -031

| | | | | | | | |
|---|---|---|---|---|---|---|---|
| Biopur 3015 | 150 | | 150 | | | | |
| BIO PUR 1878 | 150 | | 150 | | | A) | 2x |
| BIO CERAL 78 | 25 | | 25 | | | | |
| Ground 001 | 50 | | 50 | | | B) | 1x |
| Water | 400 | 100 | 400 | | 100 | | FF Veneto |
| DPE | 100 | | 70 | | | | Mill O/N |
| Bio EM 1235 | | 100 | | | 100 | | |
| MTX | | | 30 | | | C) | 2x |
| L0822 | | | | 100 | | | |
| Silt 99 | | | | | 1 | D) | 2x |
| | | | | | | E) | 1x |
| | | | | | | | Plate |
| | | | | | | | Mill 1 h |

Example 20 -032

| | | | | | |
|---|---|---|---|---|---|
| DPE PIGMENTS | 10 | | | | |
| L5267 | 90 | | | A | 2 X |
| AS-104 | 10 | | | | |
| WATER | 50 | | 100 | | MICRO HAIR CELL 50* C. |
| L0822 | | 100 | | | |
| EM 1235 | | | 50 | B | 2 X |
| EM 127 OPACO | | | 50 | | |
| | | | | C | 1 X |
| | | | | | PLATING 50* C. |

Example 20 -033

| | | | | |
|---|---|---|---|---|
| BIO PUR 1878 | 270 | | | |
| AS-104 LS | 30 | | A) | 2x |
| BIO CERAL 78 | 70 | | | MICRO HAIR CELL |
| TOP 201 MATT | 30 | | B) | 2x |
| WATER | 500 | | | MICRO HAIR CELL |
| MTX BLACK | 30 | | | |
| Metoxy Propanol | 10 | | | |
| L0822 | | 100 | | |
| DX BLACK | | 6 | | |

Example 20 -034

| | | | | |
|---|---|---|---|---|
| Biopur 3015 | 100 | | | |
| Water | 200 | | A) | 1X Wet |
| Metoxy Propanol | 200 | | | |
| L0822 | | 100 | B) | 2x |

Example 20 -035

| | | | | |
|---|---|---|---|---|
| DPE PIGMENT | 10 | | | |
| L5267 | 100 | | A | 2 X |
| WATER | 80 | | | PLATE MICRO HAIR CELL |
| TOP 201 | 20 | | | 1 X |
| L0822 | | 100 | | |
| | | | B | 2 X |
| | | | | ROTOPRESS |

Example 20 -036

| | | | | | |
|---|---|---|---|---|---|
| DPE PIGMENT | 10 | | | | |
| L5267 | 100 | | | A | 2 X |
| WATER | 80 | | 100 | | PLATE MICRO HAIR CELL |
| TOP 201 | 20 | | | | 1 X |
| L0822 | | 100 | | | |
| EM 1235 | | | 100 | B | 2 X |
| | | | | | SAND BLAST |
| | | | | C | 1 X |

Example 20 -037

| | | | | | |
|---|---|---|---|---|---|
| Bio Comp RC | 90 | | | | |
| AS-104 LS | 10 | | | A) | 2x Spray |
| Bio Top 201 Matt | 20 | | | | Plate 70 |
| DPE | 20 | | | | 2x Spray |
| Water | 100 | | | | |
| L0822 | | 100 | | B) | 3x Spray |
| Bio Em Cod. | | | 100 | | |
| | | | | C) | 1x |
| | | | | | Roto 120 C. |

Example 20 -038

| | | | | | |
|---|---|---|---|---|---|
| Bio Comp RC | 90 | | | | |
| AS-104 LS | 10 | | | A) | 2x Spray |
| Bio Top 201 Matt | 20 | | | | Plate 70 |
| DPE | 20 | | | | 2x Spray |
| Water | 100 | | | | |
| L0822 | | 100 | | B) | 3x Spray |
| Bio em 1235 | | | 100 | | Plate 70 C. (light) |
| | | | | C) | 2x Spray |

Example 20 -039

| | | | | | |
|---|---|---|---|---|---|
| Bio Comp RC | 90 | | | | |
| AS-104 LS | 10 | | | A) | 2x Spray |
| Bio Top 201 Matt | 20 | | | | Plate 70 C. 100 Atm 1″ |
| DPE | 20 | | | | 2x Spray |
| Water | 100 | | | | |
| L0822 | | 100 | | B) | 3x Spray |
| Bio em 1235 | | | 100 | | |
| Silt 99 | | | 1 | C) | 1x Spray |
| | | | | | Plate 70 C. 100 Atm 1″ |

Example 20 -040

| | | | | | |
|---|---|---|---|---|---|
| Bio comp RC | 90 | | | | |
| AS-104 LS | 10 | | | A) | 3x |
| Water | 100 | | 100 | | FF cogolo nuovo |
| | | | | | Marianelli C 70 Atm |
| DPE | 20 | | | | 2x |
| L0822 | | 100 | | | |
| Top 201 matt | 15 | | | B) | 3x |
| EM 1235 FA | | | 100 | | |
| Silt 99 | | | 1 | C) | 2x |
| | | | | | Stake |
| | | | | | Microfiore 70 C. 50 Atm |

Example 20 -041

| | | | | | |
|---|---|---|---|---|---|
| Bio comp RC | 90 | | | | |
| AS-104 LS | 10 | | | A) | 3x |
| Water | 100 | | 100 | | Plate 70 C. |
| DPE | 20 | | | | 2x |
| L0822 | | 100 | | | |
| Top 201 matt | 15 | | | B) | 3x |
| EM 1235 FA | | | 100 | | |
| Silt 99 | | | 1 | C) | 2x |
| | | | | | Plate 80 C. |
| | | | | | Dinovac |

Example 20 -042

| | | | | | |
|---|---|---|---|---|---|
| GROUND 93 | 40 | | | | |
| 96T | 100 | | | A) | 1X |
| 512K | 30 | | | | POLISH + STAKE |
| PU 304 CAT | 15 | | | | |
| WATER | 250 | 100 | | B) | 4X |
| BIOPUR 3015 | | 90 | | | |
| AS-104 | | 10 | | C) | 3X |
| TOP 201 MATT | | 20 | | | HAIRCELL MICROFIORE |
| DYE | | 4 | | | |
| L0822 | | | 100 | | |
| E-LACK SMB | | | 20 | | |
| Metoxy Propanol | | | 60 | | |

Example 20 -043

| | | | | | | |
|---|---|---|---|---|---|---|
| TOP 201 | 30 | 20 | | | A | 4 SPRAY CROSS |
| BIO CERAL 78 | 30 | | | | | |
| AS-104 | 30 | 20 | 10 | | | EMBOSSED VENETO PLATE |
| WATER | 300 | 200 | 200 | | | 60° C.- 100 ATM - 1″ |
| L5267 | 70 | 100 | 90 | | | STACKING |
| Bio Comp RC | 100 | | | | | |
| PIG MIX | 30 | 10 | | | B | 2 CROSS |
| L0822 | | | | 100 | | |
| E LACK SMB | | | | 20 | C | 2 CROSS HEAVY |
| Metoxy Propanol | | | | 60 | | |
| | | | | | D | 2 CROSS HEAVY |
| | | | | | | HAIRCELL MICROFIORE |

Example 20 -044

| | | | | |
|---|---|---|---|---|
| Bio Comp RC | 400 | | | DRY MILLIN 1 HOUR |
| water | 400 | | | STACKING |
| FILLER B/55 | 40 | | | |
| PIG MIX | 60 | | A | 4 SPRAY CROSS |
| AS123 | | 200 | | EMBOSSED BOVINO ROTO |
| Metoxy Propanol | | 160 | | 80° C./90 ATM. LAMI |
| E-LACK SMB (SMB) | | 20 | | |
| SIL T99 | | 2 | | 4 SPRAY CROSS |
| | | | B | 2 SPRAY CROSS |
| | | | | STACKING |
| | | | | HAIRCELL ROTO 90° C./20 ATM |
| | | | | HAIRCELL PLATE 70° C./50 ATM |

Example 20 -045

| | | | | |
|---|---|---|---|---|
| Bio Comp RC | 400 | | | DRY MILLIN OVER NIGHT |
| water | 400 | | | TOGGLIN |
| FILLER B/55 | 40 | | | |
| PIG MIX | 60 | | A | 4 SPRAY CROSS |
| AS123 | | 200 | | EMBOSSED LILLY ROTO |
| Metoxy Propanol | | 160 | | 80° C./100 ATM. LAMI |
| SIL T99 | | 2 | | |
| | | | | 4 SPRAY CROSS |
| | | | B | 2 SPRAY CROSS |
| | | | | STACKING |
| | | | | IRON ROTOPRESS 90° C./20 ATM |
| | | | | DRY MILL 1 HOUR |
| | | | | IRON PLATE 80° C./50 ATM |

Example 20 -046

| | | | | | |
|---|---|---|---|---|---|
| Bio Comp RC 96 | 1000 | | | | |
| DPE PIGMENT | 150 | | | A) | 2RRC |
| BIO PUR 5000 | | 1000 | | | SANDBLAST |
| L0822 | | | 80 | | 1RRC |
| Lack SMB | | | 20 | | |
| Metoxy Propanol | | | 50 | B) | 2RRC |
| | | | | C) | 2X |
| | | | | | STAMPA PALMELLATO MIURA |

Example 20 -047

| | | | | | |
|---|---|---|---|---|---|
| AD 5 | 50 | | | | FELT POLISH |
| AD 302 | 50 | | | | DRY MILLIN 2 HOURS |
| Metoxy Propanol | 100 | | 25 | | STACKING |
| BIOPUR 3015 | | 200 | | | |
| TOP 201 OPACO | | 15 | | A | 1 SPRAYCROSS |
| BIO CERAL 78 | | 20 | | | |
| water | | 300 | | B | ⅔ SPRAY CROSS |
| PIGMENTS MIX | | 40 | | | |
| L0822 | | | 50 | C | 2 SPRAY CROSS |
| E LACK SMB | | | 5 | | |
| SIL T 99 | | | 0.5 | | ROTOPRESS 90° C.- 20 atm |

Example 20 -048

| | | | | | | |
|---|---|---|---|---|---|---|
| Bio Comp RC | 450 | | 450 | | | |
| AS-104 LS | 50 | | 50 | | A) | 2X |
| WATER | 500 | 100 | 500 | | | |
| DPE PIGMENTS | 100 | | 80 | | B) | 1X |
| BIO EM 1235 FA | | 100 | | | | STAMPA ERMELLINO |
| MTX | | | 20 | | | MILL O/N (HUMIDITY) |
| L0822 | | | | 90 | | |
| Lack SMB | | | | 10 | C) | 2X |
| Metoxy Propanol | | | | 100 | | |
| SILT 99 | | | | 2 | D) | 3X |
| | | | | | | ROTO 90° C. |
| | | | | | | MILL 1 H |
| | | | | | | PLATE 70° C. |

Example 20 -049

| | | | | | |
|---|---|---|---|---|---|
| Bio Comp RC | 450 | 450 | | | |
| AS-104 LS | 50 | 50 | | A) | 2X |
| WATER | 500 | 500 | | | FF VENETO ROTO |
| DPE PIGMENTS | 100 | 80 | | | |
| MTX | | 20 | | B) | 2X |
| Metoxy Propanol | | | 100 | | |
| L0822 | | | 90 | C) | 3X |
| Lack SMB | | | 10 | | ROTO 90° C. |
| SILT 99 | | | 2 | | STAKE |
| | | | | | FF MICROFIORE KISSPLATE |

Example 20 -050

| | | | | |
|---|---|---|---|---|
| Bio Comp RC 70 | 100 | | | |
| DPE | 10 | | A) | 2X |
| WATER | 200 | | | FF N4 MARIANELLI 40 ATM 1″ |
| L0822 | | 100 | | 2X |
| SILT 99 | | 1 | | |
| Metoxy Propanol | | 100 | B) | 2X |
| Lack SMB | | 5 | | SHAVE 0.5 MM |
| | | | | MILL 1 H |
| | | | | PLATE 90° C. |

Example 20 -051

| | | | | |
|---|---|---|---|---|
| Bio Comp RC 70 | 100 | | | |
| DPE | 10 | | A) | 2X |
| WATER | 200 | | | FF N4 MARIANELLI 40 ATM 1″ |
| L0822 | | 100 | | 2X |
| SILT 99 | | 1 | | |
| Metoxy Propanol | | 100 | B) | 3X |
| Lack SMB | | 15 | | PLATE 80° C. |

Example 20 -052

| | | | | |
|---|---|---|---|---|
| BIOPUR 3015 | 90 | | A | 2 SPRAYCROSS |
| AS-104 | 10 | | | |
| TOP 201 OPACO | 20 | | | H/C. PLATE 70° C./100 ATM |
| WATER | 80 | | | |
| MIX PIG | 10 | | | ⅔ SPRAYCROSS |
| L0822 | | 100 | | |
| E-LACK SMB | | 10 | B | 3 SPRAY CROSS |
| SIL T/99 | | 1 | | STACKING |
| Metoxy Propanol | | 50 | | ROTOPRESS 90° C./50 ATM |
| | | | | H/C 70° C./70 ATM PLATE |

Example 20 -053

| | | | | | | | |
|---|---|---|---|---|---|---|---|
| Isopropyl Alcohol | 500 | | | | | A | 2 SPRAYCROSS |
| UE DYES MIX | 100 | | | | | | STACKING |
| GROUND SPK | | 100 | | | | | |
| WATER | | 300 | 300 | 100 | | B | 2 SPRAY CROSS |
| BIOPUR 3015 | | | 150 | 100 | | | FELT POLISH |
| GLOSSY 19 | | | 30 | | | | |
| GLOSSY 23 | | | 20 | | | C | 2 SPRAYCROSS |
| CERAL 63 | | | 20 | | | | SANDBLAST 90° C./40 ATM |
| AS-104 | | | 30 | | | | 2 SPRAYCROSS |
| MTX PIG | | | 30 | | | | |
| MFE DYES | | | 20 | | | D | 2 SPRAYCROSS |
| L0822 | | | | | 70 | | |
| E-LACK SMB | | | | | 30 | E | 3 SPRAYCROSS |
| SIL T 99 | | | | | 2 | | |
| Metoxy Propanol | | | | | 50 | | STACKING |
| | | | | | | | F. FIORE VENETO 70° C./100 ATM |
| | | | | | | | 1 SPRAY CROSS |

Example 20 -054

| | | | | | |
|---|---|---|---|---|---|
| Bio Comp RC | 100 | | | | |
| WATER | 100 | | | A) | 2X |
| DPE | 10 | | | | EMBOSS ERMELLINO PASS. - |
| | | | | | 300 ATM 100° C. |
| L0822 | | 100 | 70 | | 2X |
| Metoxy Propanol | | 100 | 100 | | |
| Lack SMB | | 10 | 30 | B) | 1X |
| SILT 99 | | 1 | 1 | | |
| | | | | C) | 1X |
| | | | | | ROTO 90° C. |
| | | | | | PLATE 80° C. |

Example 20 -055

| | | | | | | |
|---|---|---|---|---|---|---|
| Bio Comp RC | 100 | | | | A | 3 SPRAY CROSS |
| WATER | 200 | 300 | | | | |
| BIOPUR 3015 | 50 | | | | | |
| TOP L 201 OPACO | 25 | | | | B | 1 SPRAY CROSS |
| AS-104 LS | 25 | | | | | |
| MIX PIGMENTS | 20 | | | | | SANDBLAST 90° C./50 ATM |
| DPE | | | | | | |
| EM 127 OPACO | | 100 | | | | |
| L0822 | | | 90 | 70 | | MILLING HUMIDITY |
| Lack SMB SMB | | | 10 | 30 | | |
| SIL T/99 | | | 1 | | C | 2 SPRAY CROSS |
| Metoxy Propanol | | | 100 | 100 | | |
| | | | | | D | 1 SPRAY CROSS |
| MIX DPE | | | | | | ROTOPRESS 80° C./5 ATM |
| PIGMENTS | | | | | | |
| DPE BLU | 90 | | | | | |
| DPE NERO | 10 | | | | | DRY MILL 15 MIN. |

Example 20 -056

| | | | | | |
|---|---|---|---|---|---|
| Bio Comp RC | 100 | | | | |
| WATER | 100 | | | A) | 2X |
| DPE | 10 | | | | EMBOSS ERMELLINO PASS. - |
| | | | | | 300 ATM 100° C. |
| L0822 | | 100 | 70 | | 2X |
| Metoxy Propanol | | 100 | 100 | | |
| Lack SMB | | 10 | 30 | B) | 1X |
| SILT 99 | | 1 | 1 | | |
| | | | | C) | 1X |
| | | | | | ROTO 90° C. |
| | | | | | PLATE 80° C. |

Example 20 -057

| | | | | | |
|---|---|---|---|---|---|
| Ground ptk | 100 | | | | |
| PIG | 10 | | | A) | 1x |
| Water | 100 | 100 | | | Polish |
| Bio Comp RC | | 100 | | | |
| DPE | | 10 | | | |
| L0822 | | | 100 | B) | 2x |
| Lack SMB | | | 10 | | Cogolo 40 Atm 70° C. |
| SILT | | | 1 | | 2x |
| Metoxy Propanol | | | 100 | | |
| | | | | C) | 2x |
| | | | | | Stake |
| | | | | | Roto 90° C. |
| | | | | | Plate 80° C. |

Example 20 -058

| | | | | |
|---|---|---|---|---|
| Bio comp RC | 90 | | | |
| AS-104 LS | 10 | | A) | 2x |
| Water | 100 | | | Cogolo roto 40 Atm 70° C. |
| DPE | 20 | | | 2x |
| L0822 | | 100 | | |
| Lack SMB | | 30 | B) | 3x |
| silt 99 | | 1 | | Stake |
| Metoxy Propanol | | 100 | | Sabbiato 70° C. |

Example 20 -059

| | | | | | | |
|---|---|---|---|---|---|---|
| Ground ptk | 100 | | | | | |
| Water | 100 | | | | A) | 2x |
| Pig | 5 | | | | | Polish + Microfiore |
| Bio Comp RC | | 90 | | | | |
| AS-104 | | 10 | 10 | | B) | ⅔x |
| Water | | 100 | 200 | | | |
| DPE | | 20 | | | C) | 2x |
| Biopur 3015 | | | 90 | | | Roto |
| MTX | | | 5 | | | |
| Glossy 21 | | | 10 | | D) | 3x |
| L0822 | | | | 100 | | roto 90° C. |
| silt 99 | | | | 1 | | Finiflex 100° C. |
| Metoxy Propanol | | | | 100 | | |

Example 20 -060

| | | | | | |
|---|---|---|---|---|---|
| BIOPUR 3015 FR | 100 | 100 | | A | 1 SPRAY CROSS AIRLESS |
| (38%) | | | | | 10GR. SQF |
| WATER | 25 | 50 | | | REST DRY WELL |
| MIX PIGMENTS | 20 | 20 | | | IRON PLATE OR SANDBLAST. |
| | | | | | 100° C. 250 ATM |
| AS-104 | 10 | 10 | | | 100° C./250 ATM |
| L0822 | | | 90 | | |
| Metoxy Propanol | | | 100 | B | 3SPRAYCROSS |
| Lack SMB SMB | | | 10 | | EMBOSSED ROTO 100° C. |
| SIL T/99 | | | 1 | | |
| | | | | C | 3 SPRAY CROSS |
| | | | | | IRON PLATE |

Example 20 -061

| | | | | | |
|---|---|---|---|---|---|
| BIOPUR 3015 FR | 100 | | | A | 1 SPRAY CROSS AIRLESS |
| (38%) | | | | | 10GR. SQF |
| WATER | 25 | | | | REST DRY WELL |
| MIX PIGMENTS | 20 | 100 | | | SANDBLAST. 100° C. 250 ATM |
| AS-104 | 10 | 25 | | | |
| L0822 | | | 100 | B | 2 ROLLER COAT 8/10 GR. SQ. FT |
| Metoxy Propanol | | | 100 | | |
| SIL T/99 | | | 1 | | EMBOSSED ROTO 100° C./ |
| Bio Comp RC | | 500 | | | |
| | | | | C | 3 SPRAY CROSS |
| | | | | | IRON PLATE |

Example 20 -062

| | | | | | |
|---|---|---|---|---|---|
| BIOPUR 3015 FR | 100 | | | A | 1 SPRAY CROSS AIRLESS |
| (38%) | | | | | 10GR. SQF |
| WATER | 25 | | | | REST DRY WELL |
| MIX PIGMENTS | 20 | 100 | | | SANDBLAST. 100° C. 250 ATM |
| AS-104 | 10 | 25 | | | |
| L0822 | | | 90 | B | 4 SPRAY CROSS |
| Metoxy Propanol | | | 100 | | |
| SIL T/99 | | | 1 | | EMBOSSED ROTO 100° C./ |
| Bio Comp RC | | 500 | | | |
| Lack SMB SMB | | | 10 | C | 3 SPRAY CROSS |
| | | | | | IRON PLATE |

Example 20 -063

| | | | | | |
|---|---|---|---|---|---|
| Bio Comp RC | 100 | | | | |
| WATER | 100 | | | A) | 2X |
| DPE | 10 | | | | EMBOSS ERMELLINO PASS. - |
| | | | | | 300 ATM 100° C. |
| L0822 | | 100 | 70 | | 2X |
| Metoxy Propanol | | 100 | 100 | | |
| Lack SMB | | 10 | 30 | B) | 1X |
| SILT 99 | | 1 | 1 | | |
| | | | | C) | 1X |
| | | | | | ROTO 90° C. |
| | | | | | PLATE 80° C. |

Example 20 -064

| | | | | | |
|---|---|---|---|---|---|
| Bio Comp RC | 100 | | | | |
| WATER | 100 | | | A) | 2X |
| DPE | 10 | | | | EMBOSS FF PASS. |
| L0822 | | 100 | 70 | | 2X |
| Metoxy Propanol | | 100 | 100 | | |
| Lack SMB | | 10 | 30 | B) | 1X |
| SILT 99 | | 1 | 1 | | |
| | | | | C) | 1X |
| | | | | | ROTO 90° C. |
| | | | | | PLATE 80° C. |

Example 20 -065

| | | | | | |
|---|---|---|---|---|---|
| Ethyl Alcohol | 400 | | | A | 2 SPRAYCROSS |
| Metoxy Propanol | 100 | | 100 | | |
| MFE DYES | 100 | 5 | | | FELT POLISH |
| BIOPUR 3015 | | 100 | | | |
| WATER | | 200 | | B | 2 SPRAYCROSS |
| AS-104 LS | | 20 | | | |
| L0822 | | | 90 | C | 3 SPRAY CROSS |
| Lack SMB SMB | | | 10 | | |
| SIL T 99 | | | 1 | | ROTOPRESS |

Example 20 -066

| | | | | | |
|---|---|---|---|---|---|
| BIOPUR 3015 FR | 100 | | | A | 1 SPRAY CROSS AIRLESS |
| (38%) | | | | | 10GR. SQF |
| WATER | 25 | | | | REST DRY WELL |
| MIX PIGMENTS | 20 | 100 | | | SANDBLAST. 100° C. 250 ATM |
| AS-104 | 10 | 25 | | | |
| L0822 | | | 70 | B | 2 ROLLER COAT 8/10 GR. SQ. FT |
| Metoxy Propanol | | | 100 | | |
| SIL T/99 | | | 1 | | EMBOSSED ROTO 100° C./ |
| Bio Comp RC | | 500 | | | |
| Lack SMB SMB | | | 30 | C | 3 SPRAY CROSS |
| | | | | | IRON PLATE |

Example 20 -067

| | | | | | | |
|---|---|---|---|---|---|---|
| I.P.A. | 300 | | | | A | PADDING FULL |
| MFE DYES | 50 | 5/10 | | | | REST ON AIR |
| GLOSSY 19 | | 80 | | | | |
| WATER | | 300 | 300 | | B | 2 SPRAY CROSS |
| BIO CERAL 78 | | 20 | 20 | | | FELT POLISH |
| EPR 302 | | 20 | 20 | | C | 2 X |
| BIOPUR 3015 | | | 150 | | | |
| L0822 | | | | 100 | D | 3X |
| Metoxy Propanol | | | | 50 | | |
| SIL T/99 | | | | 0.5 | | ROTOPRESS 90° C. |

Example 20 -068

| | | | | | | |
|---|---|---|---|---|---|---|
| I.P.A. | 300 | | | | A | 2 SPRAYCROSS |
| MFE DYES | 50 | 5/10 | | | | |
| GLOSSY 19 | | 80 | | | | |
| WATER | | 300 | 300 | | B | 2 SPRAY CROSS |
| BIO CERAL 78 | | 20 | 20 | | | FELT POLISH |
| EPR 302 | | 20 | 20 | | C | 2 X |
| BIOPUR 3015 | | | 150 | | | |
| L0822 | | | | 100 | D | 3X |
| Metoxy Propanol | | | | 50 | | |
| SIL T/99 | | | | 0.5 | | ROTOPRESS 90° C. |

Example 20 -069

| | | | | | | | |
|---|---|---|---|---|---|---|---|
| I.P.A. | 300 | | | | | A | PADDING FULL |
| MFE DYES | 50 | | 5/10 | | | | REST ON AIR |
| GLOSSY 19 | | | 80 | 80 | | B | 1 ROLLER COAT 6/7 GR. SQF. |
| WATER | | | 300 | 300 | | | REST ON AIR |
| BIO CERAL 78 | | | 20 | 20 | | | |
| EPR 302 | | | 20 | | | C | 2 SPRAY CROSS |
| BIOPUR 3015 | | | 150 | 150 | | | |
| L0822 | | | | | 100 | D | 2 SPRAY CROSS |
| Metoxy Propanol | | | | | 50 | E | 2 SPRAYCROSS |
| SIL T/99 | | | | | 0.5 | | |
| EDOL 114 | | 100 | | | | | APPLY CARTEGGIO 125° C. |

Example 20 -070

| | | | | | |
|---|---|---|---|---|---|
| IPA | 500 | | | A | 2 SPRAYCROSS |
| DYES MFE | 100 | | | | |
| Bio Comp RC | | 250 | | | |
| WATER | | 300 | | B | 2 SPRAY CROSS |
| BIO CERAL 78 | | 20 | | | SANDBLAST |
| AS-104 LS | | 20 | | | 2 SPRAY CROSS |
| BIOPUR 3015 | | 150 | | | |
| PIGMENTS DPE | | 80 | | D | 3 SPRAYCROSS |
| Metoxy Propanol | | | 50 | | |
| SIL T/99 | | | 1 | | SAND BLAST 80° C. |
| Lack SMB SMB | | | 20 | | |
| L0822 | | | 80 | | |

Example 20 -071

| | | | | | | |
|---|---|---|---|---|---|---|
| IPA | 500 | | | | A | 2 SPRAYCROSS |
| DYES MFE | 100 | 20 | | | | |
| | | | | | B | 2 SPRAY CROSS |
| WATER | | 150 | 150 | | | IRON PLATE 80 |
| AS-104 LS | | 20 | 20 | | C | 2 SPRAY CROSS |
| BIOPUR 3015 | | 150 | 150 | | | |
| | | | | | D | 3 SPRAYCROSS |
| Metoxy Propanol | | | | 150 | | |
| SIL T/99 | | | | 1 | | IRON PLATE 80° C. |
| Lack SMB SMB | | | | 20 | | |
| L0822 | | | | 80 | | |

Example 20 -072

| | | | | |
|---|---|---|---|---|
| BIOPUR 3015 | 90 | | A | 2 SPRAYCROSS |
| AS-104 | 10 | | | |
| WATER | 150 | | B | 2 SPRAY CROSS |
| Metoxy Propanol. | 50 | 50 | | |
| L0822 | | 80 | | SANDBLAST 90° C. |
| Lack SMB SMB | | 20 | | |
| SIL T 99 | | 2 | | |

Example 20 -073

| | | | | | |
|---|---|---|---|---|---|
| Bio Comp RC | 100 | | | | LIGHT BUFFED |
| BIOPUR 3015 | 100 | 90 | | | |
| WATER | 100 | 100 | | A | 3 SPRAY CROSS |
| DPE PIGMENTS | 30 | | | | |
| MIX | | | | | |
| AS-104 | 20 | 10 | | | EMBOSSED GRAIN |
| | | | | | ROTO 120° C. |
| L0822 | | | 80 | | |
| Lack SMB SMB | | | 20 | | |
| Metoxy Propanol. | | | 50 | | |
| SIL T 99 | | | 2 | B | 1 SPRAY CROSS |
| | | | | C | 2 SPRAY CROSS |
| | | | | | ROTOPRESS |

Example 20 -074

| | | | | |
|---|---|---|---|---|
| Bio Comp RC | 90 | | | |
| AS-104 LS | 10 | | A) | 2X |
| WATER | 100 | | | FF COGOLO S. ROSE |
| DPE | 10 | | | 1X |
| L0822 | | 80 | | |
| E-LACK SMB | | 20 | B) | 2X |
| SILT 99 | | 1 | | SANDBLAST 80° C. |

Example 20 -075

| | | | | |
|---|---|---|---|---|
| Bio Comp RC | 90 | | | |
| AS-104 LS | 10 | | A) | 2X |
| WATER | 100 | | | EMBOSS DOLLARO |
| DPE | 10 | | | MILL O/N |
| L0822 | | 80 | | 2X |
| E-LACK SMB | | 20 | | |
| SILT 99 | | 1 | B) | 2X |
| | | | | SANDBLAST 80° C. |

Example 20 -076

| | | | | | |
|---|---|---|---|---|---|
| Bio Comp RC | 200 | | | | DRY MILLIN OVER NIGHT |
| BIOPUR 3015 | 100 | 90 | | | TOGGLING |
| WATER | 250 | 150 | | | |
| AS-104 LS | 30 | 10 | | A | 4 SPRAYCROSS |
| MIX PIG DPE | 30 | | | | |
| L0822 | | | 80 | | EMBOSSED GRAIN |
| Lack SMB SMB | | | 20 | | |
| Metoxy Propanol | | | 50 | B | 1 SPRAYCROSS |
| SIL T/99 | | | 2 | | |
| | | | | C | 2 SPRAY CROSS |
| | | | | | ROTOPRESS |

Example 20 -077

| | | | | | |
|---|---|---|---|---|---|
| Bio Comp RC | 200 | | | | DRY MILLIN OVER NIGHT |
| BIOPUR 3015 | 100 | 90 | | | TOGGLING |
| WATER | 250 | 150 | | | |
| AS-104 LS | 30 | 10 | | A | 4 SPRAYCROSS |
| MIX PIG DPE | 30 | | | | |
| L0822 | | | 80 | | EMBOSSED GRAIN |
| Lack SMB SMB | | | 20 | | |
| Metoxy Propanol | | | 50 | B | 1 SPRAYCROSS |
| SIL T/99 | | | 2 | | |
| | | | | C | 2 SPRAY CROSS |
| | | | | | IRON PLATE |

Example 20 -078

| | | | | | |
|---|---|---|---|---|---|
| Bio Comp RC | 200 | | | | DRY MILLIN OVER NIGHT |
| BIOPUR 3015 | 100 | 90 | | | TOGGLING |
| WATER | 250 | 150 | | | |
| AS-104 LS | 30 | 10 | | A | 4 SPRAYCROSS |
| MIX PIG DPE | 30 | | | | |
| L0822 | | | 95 | | EMBOSSED GRAIN |
| Lack SMB SMB | | | 5 | | |
| Metoxy Propanol | | | 50 | B | 1 SPRAYCROSS |
| SIL T/99 | | | 2 | | |
| | | | | C | 2 SPRAY CROSS |

Example 20 -079

| | | | | | | |
|---|---|---|---|---|---|---|
| WATER | 100 | 100 | 150 | | | DRY MILLIN OVER NIGHT |
| DYES MFE | 50 | | 10 | | | TOGGLING |
| Ethyl Alcohol. | 150 | | | | | |
| GROUND PT/K | | 100 | | | A | 2 SPRAY CROSS |
| BIOPUR 3015 | | | 90 | | | |
| AS-104 LS | | | 10 | | | |
| GLOSSY 19 | | | 20 | | | |
| L0822 | | | | 90 | B | 2 SPRAY CROSS |
| Lack SMB SMB | | | | 10 | | |
| Metoxy Propanol | | | | 50 | | FELT POLISH |
| SIL T/99 | | | | 2 | | |
| | | | | | C | 3 SPRAY CROSS |
| | | | | | D | 2 SPRAY CROSS |
| | | | | | | ROTOPRESS |

Example 20 -080

| | | | | |
|---|---|---|---|---|
| Bio Comp RC | 200 | | A | 2 SPRAYCROSS |
| WATER | 250 | | | EMBOSSED H/C BOVINO |
| BIOPUR 3015 | 50 | | | 2 SPRAYCROSS |
| GLOSSY 19 | 30 | | | |
| AS-104 | 20 | | B | 2 SPRAY CROSS |
| PIGMENTS MTX | 40 | | | |
| L0822 | | 90 | | ROTOPRESS 90° C. |
| Lack SMB SMB | | 10 | | |
| SIL T 99 | | 2 | | |
| Metoxy Propanol | | 50 | | |

Example 20 -081

| | | | | |
|---|---|---|---|---|
| Bio Comp RC | 200 | | A | 2 SPRAYCROSS |
| WATER | 250 | | | SAND BLAST |
| BIOPUR 3015 | 50 | | | 2 SPRAYCROSS |
| GLOSSY 19 | 30 | | | |
| AS-104 | 20 | | B | 2 SPRAY CROSS |
| PIGMENTS MTX | 20 | | | |
| DPE MIX | 20 | | | SANDBLAST 90° C. |
| Lack SMB SMB | | 10 | | |
| SIL T 99 | | 2 | | |
| Metoxy Propanol | | 50 | | |
| L0822 | | 90 | | |

Example 20 -082

| | | | | |
|---|---|---|---|---|
| Bio Comp RC | 200 | | A | 2 SPRAYCROSS |
| WATER | 250 | | | SANDBLAST |
| BIOPUR 3015 | 50 | | | 2 SPRAY CROSS |
| AS-104 | 20 | | | |
| DPE PIGMEMTS | 40 | | B | 2 SPRAY CROSS |
| MIX | | | | |
| | | | | ROTOPRESS 90° C. |
| Lack SMB SMB | | 10 | | |
| SIL T 99 | | 2 | | |
| Metoxy Propanol | | 50 | | |
| L0822 | | 90 | | |

Example 20 -083

| | | | | |
|---|---|---|---|---|
| Bio Comp RC | 200 | | A | 4 SPRAYCROSS |
| WATER | 250 | | | |
| BIOPUR 3015 | 50 | | | EMBOSSED |
| AS-104 | 20 | | | |
| DPE PIGMEMTS | 40 | | B | 2 SPRAY CROSS |
| MIX | | | | |
| | | | | ROTOPRESS 90° C. |
| Lack SMB SMB | | 10 | | |
| SIL T 99 | | 2 | | |
| Metoxy Propanol | | 50 | | |
| L0822 | | 90 | | |

Example 20 -084

| | | | | |
|---|---|---|---|---|
| L5267 | 100 | | A) | 2X |
| FILLER B/55 | 5 | | | EMBOSS LILLY 50 ATM |
| GROUND 512K | 10 | | | MILL O/N |
| WATER | 150 | | | 2X |
| DPE | 10 | | | |
| L0822 | | 80 | B) | 2X |
| NL 61 XF | | 20 | | ROTO 90° C. |
| TOP MATT NM | | 10 | | MILL 1 H |
| SILT 99 | | 1 | | |
| ETHANOL | | 200 | | |

Example 20 -085

| | | | | |
|---|---|---|---|---|
| L5267 | 100 | | A) | 2X |
| FILLER B/55 | 5 | | | EMBOSS LILLY 50 ATM |
| GROUND 512K | 10 | | | MILL O/N |
| WATER | 150 | | | 2X |
| DPE | 10 | | | |
| L0822 | | 80 | B | 2 X |
| NL 61 XF | | 20 | | ROTO 90° C. |
| TOP MATT NM | | 10 | | MILL 1 H |
| SILT 99 | | 1 | | |
| ETHANOL | | 200 | | |

Example 20 -086

| | | | | |
|---|---|---|---|---|
| L5267 | 100 | | A) | 2X |
| FILLER B/55 | 5 | | | EMBOSS LILLY 50 ATM |
| GROUND 512K | 10 | | | MILL O/N |
| WATER | 150 | | | 2X |
| DPE | 10 | | | |
| L0822 | | 80 | B | 2 X |
| NL 61 XF | | 20 | | ROTO 90° C. |
| TOP MATT NM | | 10 | | MILL 1H |
| SILT 99 | | 1 | | |
| ETHANOL | | 200 | | |

Example 20 -087

| | | | | |
|---|---|---|---|---|
| L0822 | 100 | | A | 2 SPRAY CROSS |
| WATER | 150 | | | |
| L5267 | | 45 | B | 2 SPRAYCROSS |
| Lack SMB SMB | | 10 | | |
| Metoxy Propanol. | | 100 | | ROTOPRESS 120° C. |
| SIL. T/99 | | 1 | | |

Example 20 -088

| | | | | |
|---|---|---|---|---|
| L0822 | 100 | | A | 2 SPRAY CROSS |
| WATER | 150 | | | |
| L5267 | | 45 | B | 2 SPRAYCROSS |
| Lack SMB SMB | | 10 | | |
| Metoxy Propanol. | | 100 | | ROTOPRESS 70° C. |
| SIL. T/99 | | 1 | | |

Example 20 -089

| | | | | |
|---|---|---|---|---|
| L0822 | 150 | | A | 3 SPRAY CROSS |
| WATER | 150 | | | |
| GROUND 512 K | 20 | | B | 2 SPRAYCROSS |
| BIO CERAL 78 | 10 | | | |
| MIX PIGMENTO | 20 | | | SANDBLAST 90° C. |
| DPE | | | | |
| L 5267 | | 45 | | |
| Lack SMB SMB | | 10 | | |
| SIL T 99 | | 2 | | |
| Metoxy Propanol. | | 100 | | |

Example 20 -090

| | | | | | |
|---|---|---|---|---|---|
| EDOL 114 | 100 | | | A | 1 ROLLER COAT ⅚GR. SQ.FT. |
| L0822 | | 100 | | | REST O/N |
| WATER | | 150 | | B | 2 SPRAYCROSS |
| L 5267 | | | 45 | | |
| Lack SMB SMB | | | 10 | C | 2 SPRAY CROSS |
| SIL T 99 | | | 2 | | |
| Metoxy Propanol | | | 100 | | SANDBLAST 90° C. |

Example 20 -091

| | | | | | |
|---|---|---|---|---|---|
| EDOL 110 | 100 | | | A | 1 ROLLER COAT ⅚GR. SQ.FT. |
| L0822 | | 100 | | | REST O/N |
| WATER | | 150 | | B | 2 SPRAYCROSS |
| L 5267 | | | 45 | | |
| Lack SMB SMB | | | 10 | C | 2 SPRAY CROSS |
| SIL T 99 | | | 2 | | |
| Metoxy Propanol | | | 100 | | ROTOPRESS 120° C. |

Example 20 -092

| | | | | | |
|---|---|---|---|---|---|
| GLOSSY 19 | 100 | | | A | 1 X FLESH SIDE |
| WATER | 150 | 80 | | | |
| L5267 | | 100 | | B | 2 X |
| GLOSSY 201 MATT | | 20 | | | |
| L0822 | | | 80 | | SAND BLAST |
| NL 60/XF | | | 20 | | |
| BIOSOL V 22 | | | 100 | | |

Example 20 -093

| | | | | | |
|---|---|---|---|---|---|
| GROUND 512 K | 50 | | | | DRY MILLING 5 HOURS |
| TOP 201 OPACO | 50 | 100 | | | TOGGLING LIGHT |
| WATER | 300 | 300 | | | |
| L5267 | 300 | 300 | | A | 2 SPRAYCROSS |
| MIX PIG NPE | 80 | 80 | | | |
| | | | | | ROTO H/C BOVINO |
| L0822 | | | 50 | | 110° C./50 ATM |
| Ethyl Alcohol. | | | 50 | | |
| Metoxy Propanol | | | 50 | B | 2 SPRAYCROSS |
| NL60/XF | | | 20 | | |
| SIL T/99 | | | 2 | | |
| | | | | C | 2 SPRAY |
| | | | | | SANDBLAST 90° C./5 ATM |

Example 20 -094

| | | | | | |
|---|---|---|---|---|---|
| GROUND 512 K | 50 | | | | DRY MILLING 5 HOURS |
| TOP 201 OPACO | 50 | 100 | | | TOGGLING LIGHT |
| WATER | 300 | 300 | | | |
| L5267 | 300 | 200 | | A | 3 SPRAYCROSS |
| BLACK PIG NPE | 80 | | | | |
| MTX BLACK | | 50 | | | ROTO H/C BOVINO |
| L0822 | | | 50 | | 110° C./50 ATM |
| Ethyl Alcohol. | | | 50 | | |
| Metoxy Propanol | | | 50 | B | 1 SPRAYCROSS |
| NL60/XF | | | 20 | | |
| SIL T/99 | | | 2 | | |
| | | | | C | 2 SPRAY |
| | | | | | SANDBLAST 90° C./5 ATM |

Example 20 -095

| | | | | | |
|---|---|---|---|---|---|
| GROUND 512 K | 100 | | | | LEATHER ALREADY BUFFED |
| TOP 201 OPACO | 100 | | | | |
| WATER | 300 | 300 | | | |
| L5267 | 600 | | | A | 3 SPRAY CROSS |
| MIX PIGMENTS | 150 | | | | |
| NPE | | | | | |
| EM 127 OPACO | | 100 | | B | 1 SPRAY CROSS |
| L0822 | | | 50 | | |
| Ethyl Alcohol. | | | 50 | | EMBOSSED ROTO |
| Metoxy Propanol | | | 50 | | DOLLARO 95° C./600 ATM |
| NL60/XF | | | 20 | | |
| SIL T/99 | | | 2 | | MILLING HUMIDITY O/N |
| | | | | C | 2 SPRAY CROSS |
| | | | | | ROTOPRESS IRON 90° C./5 ATM |
| | | | | | MILLING 20 MIN. |

Example 20 -096

| | | | | |
|---|---|---|---|---|
| L 5267 | 100 | | A | 2 SPRAYCROSS |
| WATER | 100 | | | |
| MIX PIGMENTS | 15 | | | SANDBLAST |
| L0822 | | 100 | | 2 SPRAYCROSS |
| Ethyl Alcohol | | 75 | | |
| Metoxy Propanol | | 75 | B | 2 SPRAYCROSS |
| | | | | ROTOPRESS IRON |

Example 20 -097

| | | | |
|---|---|---|---|
| L0822 | 100 | A | 2 SPRAYCROSS |
| Metoxy Propanol | 50 | | |
| Ethyl Alcohol | 100 | | MICROFIORE |
| NL 60 XF | 20 | | |
| SIL T 99 | 2 | | |

Example 20 -098

| | | | | | |
|---|---|---|---|---|---|
| TOP 201 OPACO | 30 | | | A | 3 SPRAY CROSS |
| GROUND 512/K | 70 | | | | |
| WATER | 400 | 100 | | | EMBOSSED LILLY |
| | | | | | 80° C./50 ATM |
| L 5267 | 200 | 100 | | | |
| PIGMENTS NDE | 30 | | | | 2 SPRAY CROSS |
| L0822 | | | 100 | | |
| Metoxy Propanol | | | 50 | B | 1 SPRAYCROSS |
| Ethyl Alcohol | | | 100 | | |
| | | | | C | 3 SPRAYCROSS |
| | | | | | ROTOPRESS 90° C. |

Example 20 -099

| | | | | | |
|---|---|---|---|---|---|
| TOP 201 OPACO | 30 | | | A | 3 SPRAY CROSS |
| GROUND 512/K | 70 | | | | |
| WATER | 400 | 100 | | | MICROFIORE PLATE |
| L 5267 | 200 | 100 | | | 80 ATM/70° C. 3 SEC. |
| PIGMENTS NDE | 30 | | | | 2 SPRAY CROSS |
| L0822 | | | 150 | | |
| Metoxy Propanol | | | 150 | B | 1 SPRAYCROSS |
| Ethyl Alcohol | | | 150 | | |
| SIL T 99 | | | 3 | C | 2 SPRAYCROSS |
| NL 60/XF | | | 30 | | |
| | | | | | ROTOPRESS 90° C. |
| | | | | | MICROFIORE PLATE 70° C. |

Example 20 -100

| | | | | | | |
|---|---|---|---|---|---|---|
| L5267 | 300 | | | | A | 4 SPRAYCROSS |
| CERAL 63 | 25 | | | | | |
| BIO CERAL 78 | 25 | | | | B | TIPPING BY HAND |
| WATER | 300 | | | | | |
| PIGMENTS | 40 | | | | C | 4 SPRAY CROSS |
| L0822 | | 100 | 100 | 100 | | |
| DYES | | 10 | 10 | | D | 2 SPRAY CROSS |
| Metoxy Propanol | | | 150 | | | |
| Ethyl Alcohol. | | | 150 | 100 | | STACKING |
| | | | | | | APPLY CARTEGGIO |

Example 20 -101

| | | | | | |
|---|---|---|---|---|---|
| L5267 | 100 | | | | |
| DPE | 10 | | | A) | 2X |
| Metoxy Propanol | 1 | | | | ROTO 80° C. |
| WATER | 200 | | | | 2X |
| L0822 | | 100 | 80 | | |
| Ethyl Alcohol | | 100 | 100 | B) | 22.164 A |
| Lack SMB | | | 20 | | 3X + ROTO 90° C. |
| SILT 99 | | 1 | 1 | | |
| | | | | C) | 22.164 B |
| | | | | | 3X + SANDBLAST 80° C. |

Example 20 -102

| | | | | | |
|---|---|---|---|---|---|
| GLOSSY 21 | 60 | | | A | 4 SPRAYCROSS |
| GLOSSY 23 | 40 | | | | |
| WATER | 400 | | | | ROTOPRESS 90° C. |
| L 5267 | 200 | | | | |
| PIGMENTS DPE | 40 | | | B | ¾ SPRAYCROSS |
| | | | | | ROTOPRESS 120° C. |
| L0822 | | 100 | 100 | C | 2 SPRAY CROSS |
| Butyl Acetate | | 200 | 200 | | |
| BLACK DYES | | 5 | | | STACKING |
| | | | | | APPLY CARTEGGIO 130° C. |

Example 20 -103

| | | | | | |
|---|---|---|---|---|---|
| L5267 | 90 | | | | |
| WATER | 90 | | 100 | A | 2 X |
| BIO GLOSSY 19 | 10 | | | | |
| BIO CERAL 78 | 10 | | | B | 1 X |
| L0822 | | 100 | | | |
| ETHANOL | | 100 | | C | 1 X |
| EM 1235 FA | | | 100 | | |
| SIL T99 | | | 2 | | |

Example 20 -104

| | | | | | | |
|---|---|---|---|---|---|---|
| L5267 | 100 | | 100 | | | |
| DT 212 | 15 | | 15 | | A) | 2X |
| FILLER B/55 | 5 | | 5 | | | |
| WATER | 100 | 100 | 100 | | B) | 1X |
| DPE PIGMENTS | 10 | | 10 | | | MILL O/N |
| EM 1235 FA | | 100 | | | | |
| L0822 | | | | 100 | C) | 1X |
| Metoxy Propanol | | | | 200 | | |
| SILT 99 | | | | 2 | D) | 2X |
| NL 60 XF | | | | 20 | | SANDBLAST 80° C. |

Example 20 - 105

| | | | | | | |
|---|---|---|---|---|---|---|
| L5267 | 100 | | 100 | | | |
| DT 212 | 15 | | 15 | | A) | 2X |
| FILLER B/55 | 5 | | 5 | | | |
| WATER | 100 | 100 | 100 | | B) | 1X |
| DPE PIGMENTS | 10 | | 10 | | | EMBOSS ERMELLINO ROTO |
| EM 1235 FA | | 100 | | | | |
| L0822 | | | | 100 | C) | 1X |
| Metoxy Propanol | | | | 200 | | |
| SILT 99 | | | | 2 | D) | 2X |
| NL 60 XF | | | | 20 | | ROTO 90° C. |

Example 20 -106

| | | | | | | |
|---|---|---|---|---|---|---|
| PR 30 | 100 | | | | A | 1 SPRAY |
| Metoxy Propanol | 300 | | | | | |
| L 5267 | | 300 | | | B | 3 SPRAY CROSS LIGHT |
| FILLER B/55 | | 20 | | | | |
| DT 212 | | 40 | | | | SAND BLAST 90° C. |
| Metoxy Propanol | | 30 | | 400 | | |
| WATER | | 400 | 150 | | | 3 SPRAY CROSS |
| PIGMENT MIX | | 100 | | | | |
| EM 1235 FA | | | 100 | | C | 1 SPRAY CROSS |
| L0822 | | | | 200 | | |
| NL60 XF | | | | 30 | | EMBOSSED LILLY ROTO |
| SIL T 99 | | | | 2 | | |
| | | | | | D | 2 SPRAYCROSS |

Example 20 -107

| | | | | |
|---|---|---|---|---|
| L5267 | 100 | | | |
| DT 212 | 15 | | A) | 2X |
| FILLER B/55 | 5 | | | HAIRCELL BOVINO |
| | | | | 80° C. 50 ATM |
| WATER | 100 | | | 1X |
| DPE PIGMENTS | 1 | | | |
| | | | B) | 2X |
| L0822 | | 100 | | SANDBLAST 80° C. |
| Metoxy Propanol | | 200 | | |
| SILT 99 | | 1 | | |
| NL 60 XF | | 20 | | |

Example 20 -108

| | | | | | | |
|---|---|---|---|---|---|---|
| PR 30 | 100 | | | | A | 1 SPRAY |
| Metoxy Propanol | 300 | | | | | |
| L 5267 | | 300 | | | B | 3 SPRAY CROSS |
| BIO CERAL 78 | | 100 | | | | |
| DT 212 | | 100 | | | | H/C COGOLO 80° C./20 ATM |
| Metoxy Propanol | | 30 | | 400 | | |
| WATER | | 500 | 150 | | | 3 SPRAY CROSS |
| PIGMENT MIX | | 100 | | | | |
| EM 1235 FA | | | 100 | | C | 1 SPRAY CROSS |
| L0822 | | | | 200 | | |
| NL60 XF | | | | 50 | | SAND BLAST 90° C./30 ATM |
| SIL T 99 | | | | 5 | | DRY MILLIN O/N |
| | | | | | D | 2 SPRAYCROSS |
| | | | | | | SAND BLAST |
| | | | | | | MILLIN 15 MIN. |

Example 20 -109

| | | | | | |
|---|---|---|---|---|---|
| PR 30 | 100 | | | A | 1 SPRAY |
| Metoxy Propanol | 300 | | | | |
| L 5267 | | 700 | | B | 3 SPRAY CROSS |
| FILLER B/55 | | 40 | | | |
| DT 212 | | 50 | | | H/C COGOLO PLATE |
| | | | | | 80° C./200 ATM |
| Metoxy Propanol | | 30 | 400 | | |
| WATER | | 600 | | | 3 SPRAY CROSS |
| PIGMENT MIX | | 140 | | | |
| EM 1235 FA | | | | C | 2 SPRAY CROSS |
| L0822 | | | 200 | | |
| NL60 XF | | | 30 | | SAND BLAST 90° C. 5 ATM |
| SIL T 99 | | | 2 | | |
| BIO CERAL 78 | | 50 | | | |

Example 20 -110

| | | | | | | |
|---|---|---|---|---|---|---|
| PR 30 | 100 | | | | A | 1 SPRAY |
| Metoxy Propanol | 300 | | | | | |
| L 5267 | | 600 | | | B | 3 SPRAY CROSS |
| FILLER B/55 | | 25 | | | | |
| DT 212 | | 50 | | | | SAND BLAST 90° C. |
| Metoxy Propanol | | 30 | | 400 | | |
| WATER | | 600 | 150 | | | 3 SPRAY CROSS |
| PIGMENT MIX | | 120 | | | | |
| EM 1235 FA | | | 100 | | C | 1 SPRAY CROSS |
| L0822 | | | | 200 | | |
| NL60 XF | | | | 30 | | DRY MILLIN O/N |
| SIL T 99 | | | | 2 | | |
| BIO CERAL 78 | | 50 | | | D | 2 SPRAYCROSS |
| | | | | | | SAND BLAST 90° C. 5 ATM |
| | | | | | | MILLIN 30 MIN. |

Table 31 provides a short description of the ingredients included in the exemplary recipes of Table 30 and used throughout the present description.

TABLE 31
Ingredients Legend

| Ingredients | Description |
|---|---|
| L0822 | Ethyl cellulose in methoxy propanol |
| BIOSOLV 22 | Alcohol ethilic biobased |
| BIOPUR 3015 | Polyurethane component in L5267 |
| BIO PUR 3015 (20% | |
| SOLID) | |
| BIOPUR 3015 FR | |
| (38%) | |
| PR 30 | aromatic polyurethane for adhesion |
| ACTIVATE SILK 122 | AS with glycerol for improved elasticity |
| AS 122 | |
| AS 122 LS | |
| AS122 | |
| AS 124 | basecoat natural derived |
| FILLER B/55 | biobased filler with matte effect |
| BIO GLOSSY 23 | Casein |
| GLOSSY 23 | |
| TOP 201 | casein base product for matte optics and |
| TOP 201 MATT | plate release at ironing |
| Top 201 matt | |
| TOP 201 OPACO | |
| TOP L 201 OPACO | |
| Bio Top 201 Matt | Casein for optics, matte, plate release |
| GLOSSY 201 MATT | |
| BIO GLOSSY 19 | |
| GLOSSY 19 | |
| GLOSSY 19 | |
| GLOSSY 21 | casein for sheen effect |
| PU 304 CAT | cationic polyurethane for ground |
| 96T | cationic wax for preground and basecoat |
| BLACK DYES | dye |
| BLACK PIG NPE | |
| DX BLACK | |
| DYE | |
| DYE MFE | |
| MFE BRUNO SCURO | |
| MFE DYES | |
| MFE NERO N | |
| UE DYES MIX | |
| Bio Em Cod. | emulsion for sheen effect |
| ETHANOL | ethanol |
| Bio Comp RC | formulated compound for ground |
| BIOCOMP RC | |
| SIL T 99 | hand modifier silicon base |
| Tatto Seta | |
| IPA | Isopropyl Alcohol |
| ACTIVATED SILK 123 | L0822 equivalent |
| AS 123 | |
| AS 123 F13 | |
| AS 123 F19 | |
| AS 123 F23 | |
| AS 123 F3 | |
| AS 123 F32 | |
| AS 123 LS | |
| AS 123 LS F13 | |
| AS 123 MP NO PL | |
| AS123 | |
| AS123 F 32 | |
| BIO EM 1235 | Lacquer emulsion |
| BIO EM 1235 FA | |
| EM 1235 | |
| EM 1235 FA | |
| AS-104 | Low Molecular Weight Activated Silk |
| AS-104 LS | |
| EM 127 OPACO | matt lacquer emulsion |
| NL 60 XF | matting agent solvent based (silicate |
| NL 61 XF | dispersed in nitrocell) |
| NL60 XF | |
| NL60/XF | |
| E LACK SMB | matting wax for topcoat |
| AS-105 | Mid Molecular Weight Activated Silk |
| EDOL 110 | mineral oil for soft hand and pull-up effect |
| EDOL 114 | |
| BIO PEN 80 | penetrant agent for adhesion |
| MIX DPE PIGMENTS | pigments |
| MIX PIG | |
| MIX PIG DPE | |
| MIX PIG NPE | |
| MIX PIGMENTO DPE | |
| MIX PIGMENTS | |
| MIX PIGMENTS DPE | |
| MIX PIGMENTS NPE | |
| MT | |
| MTX | |
| MTX BLACK | |
| MTX PIGMENT | |
| PIG | |
| PIG MIX | |
| PIGMENT | |
| PIGMENT DPE | |
| PIGMENT MIX | |
| PIGMENTS | |
| PIGMENTS DPE | |
| PIGMENTS MIX | |
| PIGMENTS MTX | |
| PIGMENTS NDE | |
| DPE | pigments with dyes |
| DPE BLU | |
| DPE MIX | |
| DPE NERO | |
| DPE PIGMEMTS MIX | |
| DPE PIGMENT | |
| DPE PIGMENT MIX | |
| DPE PIGMENTS MF | |
| PU/30 | polyisocianate crosslinker |
| EPR 302 | Polyurethane adhesive for topcoat |
| BIO PUR 1878 | polyurethane biobased for ground with soft |
| BIO PUR 3001 | hand |
| BIOPUR 1878 | |
| BIOPUR 3008 | |
| BIO PUR 5400 | |
| BIOPUR 5000 | |
| AD 302 | polyurethane for adhesion |
| AD 5 | |
| L5267 | Polyurethane with silk |
| MID Basecoat | protein base basecoat |
| 204/N | protein binder |
| ECOMP 1007 | Polyurethane for basecoat biobased |
| BIO COMP 1007 | |
| BIO COMPAT 1007 | |
| CERAL 63 | wax emulsion |
| CERAL 63 N | |
| Ceral 659 | |
| Ground 001 | wax emulsion for filler effect |
| Ingredients | Description |
| GROUND 93 | |
| GROUND PT/K | |
| Ground ptk | |
| GROUND SPK | |
| DT 212 | wax emulsion for optics and haptics |
| TOP MATT NM | wax emulsion for matte effect |
| E-LACK SMB | wax emulsion with dull effect for topcoat |
| GROUND 512 K | wax for optics and coverage |
| GROUND 512 K | |
| 512K | Wax for optics and coverage |
| BIO CERAL 78 | wax for optics and soft touch |
| WATER | |

### Example 21. Basecoat for Leather

A combination of hydrolyzed silk, gelatin, and elastin proteins with a plasticizer and transglutaminase crosslinker to deliver a fully biobased base coat to be applied to leathers during the finishing process.

Base coats are commonly used in the leather manufacturing industry as a method of delivering pigments and covering crust repairs. These products are utilized to create favorable hand feel and optical properties by modifying the leather surface. During finishing process, they are combined with a topcoat to create a color fast leather product with appealing tactile properties. However, current commercially available base coat formulations are (i) generated from petrochemical resources causing sustainability issues and (ii) non-biodegradable resulting in problems with processing waste disposal and finished leather product disposal.

In some embodiments, the disclosure provides a product which delivers an optically uniform, stretchy, and elastic coat onto a leather surface and anchor the topcoat to the leather.

### Description

### Casting to Film

1. Take 40 grams of prepared basecoat solution and pour in a silicon mold.
2. Place filled silicon mold in a convection oven for 12 hrs at 140° C.
3. Remove mold from oven and allow film to equilibrate for 1 hr.
4. Remove film from silicon mold.

### Solution Preparation (Crust Adhesive Coat)

1. Add 414 grams of water to a container
2. Add 85 grams of low molecular weight silk solution to the solution and stir for 5 minutes.
3. Add 1.25 grams of Melios 09s11 crosslinker to the solution and stir for 5 minutes.

### Solution Preparation (Base Adhesive Coat)

1. Add 414 grams of water to a container
2. Add 85 grams of mid molecular weight silk solution to the solution and stir for 5 minutes.
3. Add 1.25 grams of Melios 09s11 crosslinker to the solution and stir for 5 minutes.

### Solution Preparation (Basecoat)

1. Add 1 kilogram of water to a container and heat to 60° C.
2. Add 2.5 grams of gelatin and 5 grams of glycerol to the container and stir for 30 minutes.
3. Remove the solution from heat.
4. Add 10 grams of elastin to the solution and stir for 5 minutes
5. Add 10 grams of transglutaminase/maltodextrin powder and 170 grams of mid molecular weight silk solution into the solution and stir for 5 minutes.
6. Adjust the solution pH to 10 using ammonia.
7. Add 20 grams of TP Black E pigment from First Source Worldwide.

### Solution Preparation (Topcoat)

1. Add 500 mL of 100% ethanol to a container.
2. Add 8.3 grams of triethyl citrate and 13.5 grams of Prisorine (isostearic acid) to the solution and stir for 5 minutes.
3. Slowly, to prevent clumping, add 12.5 grams of ethyl cellulose to the solution and stir overnight (at least 12 hours). Note, make sure to stir in a covered vessel to prevent evaporation of ethanol and concentration of ethyl cellulose.

### Spray Coating on Fabric

1. On an unfinished leather skin, spray the crust adhesive coat using a 1.3 mm spray nozzle at a 45° cone pattern and 35-40 psi adding 1 gr/ft² of material.
2. Take the sample and dry in an oven at 130° C. for 30-60 seconds (until dry).
3. Next, spray the base coat onto the leather again using a 1.3 mm spray nozzle at a 45° cone pattern and 35-40 psi adding 1 gr/ft² of material.
4. Take the sample and dry in an oven at 130° C. for 30-60 seconds (until dry).
5. Iron the sample using a roller iron at 98° C. under 50 kg/f pressure at a 6 m/min speed.
6. Apply two more coats of basecoat formula using steps 3 and 4.
7. Finally, spray the topcoat formula onto the leather using a 1.3 mm spray nozzle at a 45° cone pattern and 45-50 psi adding 1 gr/ft² of material.
8. Take the sample and dry in an oven at 130° C. for 30-60 seconds (until dry).
9. Repeat steps 7-8 two more times.
10. Iron the sample using a roller iron at 98° C. under 50 kg/f pressure at a 5 m/min speed.

### Performance Testing Methods

### Film Testing

All films were tested in house qualitatively based on bendability, stretch, elasticity, and water drop resistance. Each test was performed on a scale of 1-4 with 1 being the worst and 4 being the best.
For bendability, the film was creased in two directions if the film could not bend it was given a score of 1 and if it could crease without leaving a mark it was given a score of 4.
For stretch, the film was pulled into opposite directions, if it broke without any elongation, it was given a score of 1 and if it could elongation past twice its size it was given a score of 4.
For elasticity, the film was stretched, if it could not stretch any distance without permanently deforming it was given a score of 1 and if it could stretch to twice its length and still recover its shape it was given a score of 4.
For water drop resistance, a drop of water was applied to the surface using an eye dropper, if the film immediately dissolved it was given a score of 1 and if no change occurred after the water was applied and evaporated it was given a score of 4.

### Leather Testing

All leather coated samples were tested using the Veslic test to ensure colorfastness to rubbing and bally flex test to ensure adhesion between all layers and to prevent cracking. The Veslic test follows the ISO 11640 testing procedure and the bally flex test follows the ISO 5402 testing procedure.

### Test Results

### Film Test Results

All film test results can be seen in Table 1. From the film testing data, the silk/elastin/gelatin formulation crosslinked by transglutaminase gives the best films. In all formulations, activated silk (AS-105) and gelatin are present to give the film structure and body. Glycerol is also added to the film as a plasticizer to add bendability. Originally, Etocas 200 (a highly ethoxylated castor oil) was added to make the film soft as seen in experiments 1-3, however, the bendability was sometimes subpar, and the films had little to no stretch and elasticity as well as poor water resistance. To increase water resistance and stretch Etocas 200 was substituted with Span 120 (sorbitan isostearate). This increased the water resistance, however, just like Etocas 200 it was lacking in stretch elasticity as seen in experiments 4-5.

Elastin was used to increased stretchability and transglutaminase was tested to improve elasticity. AS seen through experiments 7-18, stretchability and elasticity were greatly improved when elastin and transglutaminase was added. To find the optimal concentrations standard curves were made for each ingredient as can be seen in experiments 19-36, leaving the optimal ratio to be 0.25:1:1 Gelatin to Transglutaminase to Elastin. With the optimal ratio identified, the optimal concentration of total non-silk solids in the solution was investigated resulting in an optimal concentration of 2.75% additives.

### Leather Coating

For each leather coating experiment, four layers were applied. First an adhesive layer consisting of low molecular weight activated silk (AS-104) and Melios-09s11 crosslinker was applied to the leather crust. Next the basecoat was applied at a 3 g/ft² application rate. Then an adhesive layer between the basecoat and topcoat consisting of mid molecular weight activated silk (AS-105) and Melios-09s11 was applied to the surface. And finally, the topcoat was sprayed on the surface.

TABLE 32
Film casting qualitive assessments.

| # | Study | Additive 1 | Additive 2 | Additive 3 | Additive 4 | Additive 5 | Bend | Stretch | Elasticity | WD | Note |
|---|---|---|---|---|---|---|---|---|---|---|---|
| 1 | Etocas Study | 0.5% Gelatin | 0.25% glycerol | 1% Etocas | — | — | 3 | 2 | 1 | 2 | |
| 2 | | | | 0.5% Etocas | | | 4 | 2 | 0 | 2 | |
| 3 | | | | 0.25% Etocas | | | 4 | 2 | 1 | 1 | |
| 4 | Span Study | 0.25% Gelatin | 0.5% glycerol | 1% Span | 0.25% Tween | 0.95% Ethanol | 2 | 0 | 0 | 3 | |
| 5 | | | | 0.5% Span | | | 4 | 2 | 1 | 3 | |
| 6 | | | | 0.25% Span | | | 4 | 2 | 1 | 2 | |
| 7 | TG and | 0.25% Gelatin | 0.5% glycerol | 1% TG | 0.25% Tween | — | 4 | 4 | 3 | 2 | O |
| 8 | Elastin Study | | | 0.5% TG | | | 4 | 4 | 3 | 2 | O |
| 9 | | | | 0.25% TG | | | 3 | 2 | 1 | 2 | O |
| 10 | | | | 2% Elastin | | | 4 | 4 | 4 | 2 | HE |
| 11 | | | | 1% Elastin | | | 4 | 4 | 4 | — | HE |
| 12 | | | | 0.5% Elastin | | | — | — | — | — | NF |
| 13 | | | | 1% TG | 1% Elastin | 0.25% Tween | 4 | 3 | 2 | 2 | |
| 14 | | | | 0.5% TG | | | 4 | 3 | 2 | 2 | |
| 15 | | | | 0.25% TG | | | 4 | 3 | 3 | 2 | S |
| 16 | | | | 0.5% TG | 2% Elastin | | 4 | 4 | 3 | 1 | NH |
| 17 | | | | | 1% Elastin | | 4 | 4 | 3 | 1 | |
| 18 | | | | | 0.5% Elastin | | 4 | 4 | 3 | 1 | |
| 19 | Elastin | 0.25% Gelatin | 0.5% glycerol | 0.5% TG | 4% Elastin | 0.25% Tween | 3 | 4 | 2 | 3 | |
| 20 | Standard | | | | 2% Elastin | | 4 | 4 | 3 | 2 | |
| 21 | Curve | | | | 1% Elastin | | 4 | 4 | 3 | 2 | |
| 22 | | | | | 0.5% Elastin | | 4 | 3 | 3 | 2 | |
| 23 | | | | | 0.25% Elastin | | 4 | 3 | 2 | 1 | |
| 24 | | | | | 0.125% Elastin | | 3 | 2 | 1 | 1 | |
| 25 | TG Standard | 0.25% Gelatin | 0.5% glycerol | 2% TG | 1% Elastin | 0.25% Tween | 4 | 3 | 2 | 2 | S |
| 26 | Curve | | | 1% TG | | | 4 | 3 | 3 | 1 | S |
| 27 | | | | 0.5% TG | | | 4 | 3 | 3 | 2 | S |
| 28 | | | | 0.25% TG | | | 4 | 3 | 2 | 2 | NH |
| 29 | | | | 0.125% TG | | | 4 | 4 | 3 | 2 | |
| 30 | | | | 0.0625% TG | | | 4 | 4 | 3 | 2 | |
| 31 | Gelatin | 2% Gelatin | 0.5% glycerol | 1% TG | 1% Elastin | — | 1 | 0 | 0 | 1 | |
| 32 | Standard | 1% Gelatin | | | | | 1 | 1 | 0 | 1 | |
| 33 | Curve | 0.5% Gelatin | | | | | 4 | 4 | 3 | 1 | |
| 34 | | 0.25% Gelatin | | | | | 4 | 4 | 3 | 1 | |
| 35 | | 0.125% Gelatin | | | | | 4 | 4 | 2 | 1 | |
| 36 | | 0.0625% Gelatin | | | | | 2 | 2 | 2 | 1 | |
| 37 | Non-Silk | 1% Gelatin | 2% glycerol | 4% TG | 4% Elastin | — | 2 | 1 | 1 | 2 | |
| 38 | Solid Mass | 0.5% Gelatin | 1% glycerol | 2% TG | 2% Elastin | | 3 | 2 | 1 | 2 | |
| 39 | Standard | 0.375% Gelatin | 0.75% glycerol | 1.5% TG | 1.5% Elastin | | 3 | 3 | 3 | 2 | |
| 40 | Curve | 0.25% Gelatin | 0.5% glycerol | 1% TG | 1% Elastin | | 4 | 4 | 3 | 1 | |
| 41 | | 0.0625% Gelatin | 0.125% glycerol | 0.25% TG | 0.25% Elastin | | 1 | 1 | 1 | 1 | |

Each film contains 0.85% Activated Silk (AS-105).
Ingredient abbreviations (Tween = Tween 80, TG = Transglutaminase + Maltodextrin, Etocas = Etocas 200, Span = Span 120).
Note abbreviations (NH = Non homogenous, NF = No film formed, S = Sticky, HE = Highly elastic, O = Opaque).
Also, WD is an abbreviation for water drop.

TABLE 33
Wet Veslic data from leather spray coat experiments.

| | | | | | | | | | Veslic Test |
|---|---|---|---|---|---|---|---|---|---|
| # | Basecoat Additives | | | | | | Topcoat Additive | | (After 300 Cycles) |
| 1 | — | — | — | — | — | — | 3.33% TEC | 1.67% ISA | P |
| 2 | 0.25% Gel | 0.25% Gly | 0.5% E200 | 0.25% T80 | 1% Eth | — | 3.33% TEC | 1.67% ISA | P, TD (50 cycles) |
| 3 | 0.25% Gel | 0.25% Gly | 0.5% E200 | 0.25% T80 | 1% Eth | — | 3.33% TEC | 1.67% ISA | P, TD (50 cycles) |
| 4 | 0.25% Gel | 0.25% Gly | 0.5% E200 | 0.25% T80 | 1% Eth | — | 2.5% TEC | 5% S120 | NP |
| 5 | — | — | — | — | — | — | 2.5% TEC | 5% S120 | NP |
| 6 | 0.25% Gel | 0.25% Gly | 0.5% S120 | 0.25% T80 | 1% Eth | 0.25% Melio 09s11 | 2.5% TEC | 5% S120 | NP, TD |
| 7 | 0.25% Gel | 0.25% Gly | 0.5% S120 | 0.25% T80 | 1% Eth | 0.25% Bayhydur | 2.5% TEC | 5% S120 | NP, RI |
| 8 | 0.25% Gel | 0.25% Gly | 0.5% S120 | 0.25% T80 | 1% Eth | 0.25% Glutaraldehyde | 2.5% TEC | 5% S120 | NP, RI |
| 9 | 0.25% Gel | 0.25% Gly | 0.5% S120 | 0.25% T80 | 1% Eth | 0.25% Rodalink 3315 | 2.5% TEC | 5% S120 | NP |
| 10 | 0.25% Gel | 0.25% Gly | 0.5% S120 | 0.25% T80 | 1% Eth | 0.25% Rodalink R77 | 2.5% TEC | 5% S120 | NP, RI |
| 11 | 0.25% Gel | 0.25% Gly | 0.5% S120 | 0.25% T80 | 1% Eth | 0.25% Azaridine | 2.5% TEC | 5% S120 | NP, RI |
| 12 | 0.25% Gel | 0.25% Gly | 0.25% TG | 1% Elastin | — | — | 2.5% TEC | 5% S120 | NP |

All basecoat layers have 0.85% AS-105 and all topcoat layers have ethyl cellulose in them.
The ingredient abbreviations are (Gel = Gelatin, Gly = glycerol, S120 = Span 120, T80 = Tween 80, E200 = Etocas 200, Eth = Ethanol, TG = Transglutaminase, TEC = Triethyl Citrate, and ISA = Isostearic Acid, Rice Quat. = Quaternized Rice Protein).
The result abbreviations are (P = Pigment detected on scrubbing pad, NP = No pigment detected on scrubbing pad, TD = Topcoat began to detach, and RI = Rub indent present)

TABLE 34
Bally flex data from leather spray coat experiments.

| | | | | | | | | Bally Flex Test |
|---|---|---|---|---|---|---|---|---|
| # | Basecoat Additive | | | | | Topcoat Additive | | (8000 cycles) |
| 1 | 0.25% Gel | 0.25% Gly | 0.5% E200 | 0.25% T80 | 1% Eth | 3.33% TEC | 1.67% ISA | TD |
| 2 | 0.25% Gel | 0.25% Gly | 0.5% E200 | 0.25% T80 | 1% Eth | 2.5% TEC | 5% S120 | TD |
| 3 | — | — | — | — | — | 3.33% TEC | 1.67% ISA | SD |
| 4 | — | — | — | — | — | 2.5% TEC | 5% S120 | SD |
| 5 | 0.25% Gel | 0.25% Gly | 0.5% S120 | 0.25% T80 | 1% Eth | 3.33% TEC | 1.67% ISA | SD |
| 6 | 0.25% Gel | 0.25% Gly | 0.5% S120 | 0.25% T80 | 1% Eth | 2.5% TEC | 5% S120 | SD |
| 7 | 0.25% Gel | 0.5% Gly | 0.25% TG | 1% Elastin | — | — | — | NSF |
| 8 | — | — | — | — | — | — | — | NSF |
| 9 | 0.25% Gel | 0.5% Gly | 0.25% TG | 1% Elastin | — | 2.5% TEC | 5% S120 | NSF |

All basecoat layers have 0.85% AS-105 and all topcoat layers have ethyl cellulose in them.
The ingredient abbreviations are (Gel = Gelatin, Gly = glycerol, S120 = Span 120, T80 = Tween 80, E200 = Etocas 200, Eth = Ethanol, TG = Transglutaminase, TEC = Triethyl Citrate, and ISA = Isostearic Acid).
The test result abbreviations are (NSF = No significant Failure, SD = Slight Detachment, and TD = Total Detachment)

### Veslic Test Results

All Veslic test results can be seen in Table 32. For both samples with no basecoat and Etocas 200 as the main additive, if the topcoat contains isostearic acid it will rub off causing pigments to leach onto the scrubbing pad as can be seen in experiments 1-3. However, if Span 120 is used in the topcoat it will stay on up to 300 cycles as can be seen in experiments 4-5. If Span 120 is used in the basecoat with a crosslinker, the topcoat will prevent the pigment from leaching onto the scrubbing pad. However, the surface of the leather becomes deformed after rubbed (except for the use of Rodalink 3315 crosslinker) and the use of a petrochemical derived crosslinker makes this formulation not 100% biobased. But, if elastin is used with a transglutaminase, no pigment leeches out as well as the surface remains unaltered as can be seen in experiment 12. The use of elastin and transglutaminase also makes the formulation 100% biobased.

### Bally Flex Test Results

All bally flex test results can be seen in Table 33. The use of Etocas 200 in the basecoat causes samples to undergo total topcoat detachment from the basecoat at 8000 cycles as can be seen in experiments 1-2. Furthermore, by removing Etocas 200 from the basecoat the samples do not undergo total detachment, however, they still experience slight detachment as can be seen in experiments 3-4. Even experiments which contain Span 120 in the basecoat undergo slight detachment as can be seen in experiments 5-6. But samples containing elastin and transglutaminase in the basecoat do not undergo any form of detachment up to 8000 cycles.

All patents, patent applications, and published references cited herein are hereby incorporated by reference in their entirety. While the methods of the present disclosure have been described in connection with the specific embodiments thereof, it will be understood that it is capable of further modification. Further, this application is intended to cover any variations, uses, or adaptations of the methods of the present disclosure, including such departures from the present disclosure as come within known or customary practice in the art to which the methods of the present disclosure pertain.

### Example 22. Basecoat and Topcoat Components for Coating System

Below arc examples of the amount of various products that may be included in the topcoat and basecoat in accordance with a coating system described herein.

TABLE 35
Basecoat and Topcoat Grams per sq. ft.

| | | | | | Solid Grams in | | |
|---|---|---|---|---|---|---|---|
| | | | | Grams solids | 1 Gram of | Minimum | |
| | | | % in | in 1 Liter | Application | application | Total Grams |
| Component | Product | CAS | formulation | Final Solution | Volume | ml/sq. ft | per sqft |
| L5267 | Biopur 3015 | | 11.3% | 112.5 | 0.1125 | 2 | 0.225 |
| basecoat | AS 104 | | 0.3% | 2.5 | 0.003 | 2 | 0.005 |
| | | | | | Solid Grams in | | |
| | | | | Grams solids | 1 Gram of | minimum | |
| | | | % in | in 1 Liter | Application | application | Total Grams |
| | Top coat | CAS | formulation | Final Solution | Volume | ml/sq. ft | per sqft |
| L0822 | Ethyl cellulose | 9004- | 2.50% | 25 | 0.025 | 2 | 0.05 |
| topcoat | 200 (Ethocel | 57-3 | | | | | |
| | Standard 200 | | | | | | |
| | Industrial) | | | | | | |
| | Methoxy | 107- | 97.50% | 975 | 0.975 | 2 | 1.95 |
| | Propanol | 98-2 | | | | | |

### Example 23. BIOPUR 3015 Adhesive Study

The minimum viable amount of BIOPUR 3015 needed to pass the adhesion test was evaluated.

TABLE 36
Amount of BIOPUR 3015 Needed to Pass the Adhesion Test

| | | | | | Scotch |
|---|---|---|---|---|---|
| | | | Topcoat | | Tape |
| Sample | Basecoat | Topcoat | Solvent | Penetration | Test |
| J 1 | 10% BIOPUR 3015 | 2.5% EC | Methoxy | Poor | Pass |
| J 2 | 5% BIOPUR 3015 | 2.5% EC | Methoxy | Medium | Pass |
| J 3 | 2.5% BIOPUR 3015 | 2.5% EC | Methoxy | Good | Pass |
| J 4 | 1% BIOPUR 3015 | 2.5% EC | Methoxy | Good | Pass |
| J 5 | 0.5% BIOPUR 3015 | 2.5% EC | Methoxy | Good | Pass |
| J 6 | 0.1% BIOPUR 3015 | 2.5% EC | Methoxy | Good | Fail* |
| J 7 | 0.05% BIOPUR 3015 | 2.5% EC | Methoxy | Good | Fail |

As can be seen in Table 36, the cutoff for passing the scotch tape test is around 0.5% BIOPUR 3015.

To further evaluate variations in performance, water resistance was measured by adding a drop of water to the surface and observing if it absorbs into the leather over a period of 5 minutes.

| | | | | Water drop |
|---|---|---|---|---|
| | | | Water drop | with scratch |
| Sample | Basecoat | Topcoat | without scratch | (control) |
| J 1 | 10% BIOPUR 3015 | 2.5% EC | Partial | Deformation |
| | | | Deformation | |
| J 2 | 5% BIOPUR 3015 | 2.5% EC | Deformation | Deformation |
| J 3 | 2.5% BIOPUR | 2.5% EC | Deformation | Deformation |
| | 3015 | | | |
| J 4 | 1% BIOPUR 3015 | 2.5% EC | Deformation | Deformation |
| J 5 | 0.5% BIOPUR | 2.5% EC | Deformation | Deformation |
| | 3015 | | | |
| J 6 | 0.1% BIOPUR | 2.5% EC | Deformation | Deformation |
| | 3015 | | | |
| J 7 | 0.05% BIOPUR | 2.5% EC | Deformation | Deformation |
| | 3015 | | | |

A study was then performed adding different numbers of layers of 10% BIOPUR 3015.

| | | | Water drop | Water drop |
|---|---|---|---|---|
| | | | without | with scratch |
| Sample | Basecoat | Topcoat | scratch | (control) |
| J 1 | 10% BIOPUR 3015 (4 g/sf | 2.5% | Partial | Deformation |
| | 1 g/sf per layer) | EC | Deformation | |
| J 9 | 10% BIOPUR 3015 (8 g/sf \| | 2.5% | No Deformation | Deformation |
| | 1 g/sf per layer) | EC | | |
| J 10 | 10% BIOPUR 3015 (12 g/sf \| | 2.5% | No Deformation | Deformation |
| | 1 g/sf per layer) | EC | | |
| J 11 | 10% BIOPUR 3015 (16 g/sf | 2.5% | No Deformation | Deformation |
| | 1 g/sf per layer) | EC | | |

To better understand the effects activated silk has on the topcoat adhesion. An adhesive layer with BIOPUR 3015 and the minimum amount of silk needed to reach 80% biobased was made.

| | | | | Scotch | Water |
|---|---|---|---|---|---|
| Sample | Basecoat | Topcoat | Topcoat Solvent | Tape Test | Drop test |
| K1 | 1% BIOPUR | 2.5% | Methoxypropanol | Fail* | Fail |
| | 3015 \| 0.17% | EC | | | |
| | AS 14A(4 | | | | |
| | g/sf \| 1 g/sf | | | | |
| | per layer) | | | | |
| K2 | 1% BIOPUR | 2.5% | Methoxypropanol | Fail* | Fail |
| | 3015 \| 0.17% | EC | | | |
| | AS 105TS(4 | | | | |
| | g/sf \| 1 g/sf | | | | |
| | per layer) | | | | |

### REFERENCES

### The Following Documents May be Referenced as Sources of Data

| Document | Description of Document |
|---|---|
| EBN-SOP-TXTL- | Veslic Testing Procedures (developed according |
| 035 | to ISO 11640). |
| ETHOCEL ™ | Technical Data Sheet for ETHOCELIM Standard |
| Standard 200 | 200 Industrial Ethylcellulose |
| Industrial | |
| Ethylcellulose | |

All patents, patent applications, and published references cited herein are hereby incorporated by reference in their entirety. While the methods of the present disclosure have been described in connection with the specific embodiments thereof, it will be understood that it is capable of further modification. Further, this application is intended to cover any variations, uses, or adaptations of the methods of the present disclosure, including such departures from the present disclosure as come within known or customary practice in the art to which the methods of the present disclosure pertain.

1. A composite comprising a first polymeric macromolecular species or polymer and a second polymeric macromolecular species or polymer.

2. The composite of claim 1, wherein a portion of the first polymeric macromolecular species or polymer and a portion of the second polymeric macromolecular species or polymer are physically and/or chemically entangled.

3. The composite of claim 1, wherein a portion of the first polymeric macromolecular species or polymer are physically and/or chemically crosslinked.

4. The composite of claim 1, wherein a portion of the second polymeric macromolecular species or polymer are physically and/or chemically crosslinked.

5. The composite of claim 1, wherein a portion of the first polymeric macromolecular species or polymer are chemically and/or physically integrated into a portion of the second polymeric macromolecular species or polymer.

6. The composite of claim 1, wherein a portion of the first polymeric macromolecular species or polymer and a portion of the second polymeric macromolecular species or polymer are not separable.

7. The composite of claim 1, wherein a portion of the first polymeric macromolecular species or polymer and/or a portion of the second polymeric macromolecular species or polymer are cross-linked.

8. The composite of claim 1, wherein a portion of the first polymeric macromolecular species or polymer and/or a portion of the second polymeric macromolecular species or polymer are partially organized and/or crystallized.

9. The composite of claim 1, wherein a portion of the first polymeric macromolecular species or polymer and a portion of the second polymeric macromolecular species or polymer cannot be delaminated.

10. The composite of claim 1, wherein a portion of the first polymeric macromolecular species or polymer and a portion of the second polymeric macromolecular species or polymer are self-assembled

11. The composite of any one of claims 1 to 10, wherein a portion of the first polymeric macromolecular species or polymer in the composite has a second structure different than a first structure of the first polymeric macromolecular species or polymer.

12. The composite of any one of claims 1 to 10, wherein a portion of the second polymeric macromolecular species or polymer in the composite has a second structure different than a first structure of the second polymeric macromolecular species or polymer.

13. The composite of any one of claims 1 to 10, wherein a portion of the first polymeric macromolecular species or polymer in the composite has a second structure different than a first structure of the first polymeric macromolecular species or polymer, and a portion of the second polymeric macromolecular species or polymer in the composite has a second structure different than a first structure of the second polymeric macromolecular species or polymer.

14. The composite of any one of claims 1 to 13, wherein the first polymeric macromolecular species or polymer comprises a protein component.

15. The composite of claim 14, wherein the protein component comprises one or more of silk fibroin proteins or fragments, collagen, elastin, gelatin, corn zein, wheat gluten, pectin, chitin, casein, and/or whey.

16. The composite of any one of claims 1 to 13, wherein the first polymeric macromolecular species or polymer comprises a biodegradable polymer.

17. The composite of any one of claims 1 to 13, wherein the first polymeric macromolecular species or polymer comprises one or more of a polyurethane component.

18. The composite of any one of claims 1 to 13, wherein the first polymeric macromolecular species or polymer comprises a poly lactic acid (PLA) component, a poly(lactic-co-glycolic acid) (PLGA) component, or both.

19. The composite of any one of claims 1 to 18, wherein the second polymeric macromolecular species or polymer comprises a cellulose and/or cellulose derivative component.

20. The composite of claim 19, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

21. The composite of claim 19, wherein the cellulose derivative is ethyl cellulose.

22. The composite of claim 21, wherein the ethoxyl content in ethyl cellulose is from 45.0% to 49.5%, from 45.0% to 46.0%, from 45.0% to 47.0%, from 47.0% to 48.0%, or from 48.0% to 49.5%.

23. The composite of claim 21, wherein the degree of substitution of the ethyl cellulose is 0.5 to 1, 1 to 1.5, 1.5 to 2, 2 to 2.5, or 2.5 to 3.

24. The composite of any one of claims 19 to 23, wherein a second structure of the cellulose derivative comprises a degree of crystallinity of less than 100%.

25. The composite of any one of claims 19 to 23, wherein a second structure of the cellulose derivative comprises a degree of crystallinity of between about 5% and less than about 100%.

26. The composite of any one of claims 19 to 23, wherein a second structure of the cellulose derivative comprises a degree of crystallinity of between about 10% and about 20%, between about 20% and about 30%, between about 30% and about 40%, between about 40% and about 50%, between about 50% and about 60%, between about 60% and about 70%, between about 70% and about 80%, between about 80% and about 90%, between about 90% and about 99%, or between about 90% and about 100%.

27. The composite of any one of claims 19 to 23, wherein a second structure of the cellulose derivative comprises a degree of crystallinity of less than about 99%, less than about 98%, less than about 97%, less than about 96%, less than about 95%, less than about 94%, less than about 93%, less than about 92%, less than about 91%, less than about 90%, less than about 89%, less than about 88%, less than about 87%, less than about 86%, less than about 85%, less than about 84%, less than about 83%, less than about 82%, less than about 81%, less than about 80%, less than about 79%, less than about 78%, less than about 77%, less than about 76%, less than about 75%, less than about 74%, less than about 73%, less than about 72%, less than about 71%, less than about 70%, less than about 69%, less than about 68%, less than about 67%, less than about 66%, less than about 65%, less than about 64%, less than about 63%, less than about 62%, less than about 61%, less than about 60%, less than about 59%, less than about 58%, less than about 57%, less than about 56%, less than about 55%, less than about 54%, less than about 53%, less than about 52%, less than about 51%, less than about 50% less than about 49%, less than about 48%, less than about 47%, less than about 46%, less than about 45%, less than about 44%, less than about 43%, less than about 42%, less than about 41%, less than about 40%, less than about 39%, less than about 38%, less than about 37%, less than about 36%, less than about 35%, less than about 34%, less than about 33%, less than about 32%, less than about 31%, less than about 30% less than about 29%, less than about 28%, less than about 27%, less than about 26%, less than about 25%, less than about 24%, less than about 23%, less than about 22%, less than about 21%, less than about 20% less than about 19%, less than about 18%, less than about 17%, less than about 16%, less than about 15%, less than about 14%, less than about 13%, less than about 12%, less than about 11%, or less than about 10%.

28. The composite of any one of claims 1 to 27, wherein the w/w ratio between the first polymeric macromolecular species or polymer and the second polymeric macromolecular species polymer in the composite is between about 1:100 and about 100:1.

29. The composite of any one of claims 1 to 27, wherein the w/w ratio between the first polymeric macromolecular species or polymer and the second polymeric macromolecular species polymer in the composite is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

30. The composite of any one of claims 1 to 27, wherein the w/w ratio between the first polymeric macromolecular species or polymer and the second polymeric macromolecular species polymer in the composite is about 10:1, about 10:2, about 10:3, about 10:4, about 10:5, about 10:6, about 10:7, about 10:8, about 10:9, or about 10:10.

31. The composite of any one of claims 1 to 30, wherein the first polymeric macromolecular species or polymer is distributed isotropically over a cross section of the composite.

32. The composite of any one of claims 1 to 30, wherein the first polymeric macromolecular species or polymer is distributed anisotropically over a cross section of the composite.

33. The composite of claim 32, wherein a concentration of the first polymeric macromolecular species or polymer closer to a first surface of the composite is higher than a concentration of the first polymeric macromolecular species or polymer closer to a second surface of the composite.

34. The composite of claim 32 or 33, wherein the first polymeric macromolecular species or polymer is substantially undetectable at a second surface of the composite.

35. The composite of any one of claims 1 to 34, wherein the second polymeric macromolecular species or polymer is distributed isotropically over a cross section of the composite.

36. The composite of any one of claims 1 to 34, wherein the second polymeric macromolecular species or polymer is distributed anisotropically over a cross section of the composite.

37. The composite of claim 36, wherein a concentration of the second polymeric macromolecular species or polymer closer to a second surface of the composite is higher than a concentration of the second polymeric macromolecular species or polymer closer to a first surface of the composite.

38. The composite of claim 36 or 37, wherein the second polymeric macromolecular species or polymer is substantially undetectable at a first surface of the composite substrate-coating interface.

39. The composite of any one of claims 1 to 38, wherein a first surface of the composite is adhesive.

40. The composite of any one of claims 1 to 38, wherein a second surface of the composite is adhesive.

41. The composite of any one of claims 1 to 38, wherein a first surface of the composite is adhesive, and a second surface of the composite is adhesive.

42. The composite of any one of claims 1 to 38, wherein a first surface of the composite is adhesive, and a second surface of the composite is non-adhesive.

43. The composite of any one of claims 1 to 42, wherein the composite has an increased water resistance compared to one of: i) a non-composite material comprising the first polymeric macromolecular species or polymer, but excluding the second polymeric macromolecular species or polymer, ii) a non-composite material comprising the second polymeric macromolecular species or polymer, but excluding the first polymeric macromolecular species or polymer, or iii) a non-composite material comprising the first polymeric macromolecular species or polymer and the second polymeric macromolecular species or polymer, wherein the polymeric macromolecular species or polymers are not physically and/or chemically molecularly entangled.

44. The composite of any one of claims 1 to 42, wherein the composite has an increased water vapor permeability compared to one of: i) a non-composite material comprising the first polymeric macromolecular species or polymer, but excluding the second polymeric macromolecular species or polymer, ii) a non-composite material comprising the second polymeric macromolecular species or polymer, but excluding the first polymeric macromolecular species or polymer, or iii) a non-composite material comprising the first polymeric macromolecular species or polymer and the second polymeric macromolecular species or polymer, wherein the polymeric macromolecular species or polymers are not physically and/or chemically molecularly entangled.

45. An article comprising a substrate and a coating, the coating comprising the composite of any one of claims 1 to 44.

46. The article of claim 45, wherein the substrate comprises an irregular surface.

47. The article of claim 45, wherein the coating has a thickness between about 10 μm and about 1000 μm.

48. The article of any one of claims 45 to 47, wherein the amount of coating on the substrate is between about 0.01 g/ft² and about 25 g/ft².

49. The article of any one of claims 45 to 48, wherein the amount of first polymeric macromolecular species or polymer in the coating on the substrate is between about 0.001 g/ft² and about 20 g/ft².

50. The article of any one of claims 45 to 49, wherein the amount of second polymeric macromolecular species or polymer in the coating on the substrate is between about 0.001 g/ft² and about 15 g/ft².

51. The article of any one of claims 45 to 50, wherein the substrate comprises a substantially flexible material.

52. The article of any one of claims 45 to 51, wherein the substrate comprises a leather material or a textile material.

53. The article of any one of claims 45 to 52, wherein the substrate comprises one or more of collagen, cellulose, and/or lignin.

54. A method of coating a substrate, the method comprising applying to a surface of the substrate a first composition comprising a first polymeric macromolecular species or polymer, and a second composition comprising a second polymeric macromolecular species or polymer.

55. The method of claim 54, wherein the first composition comprises an unstructured first polymeric macromolecular species or polymer, or a first structure of the first polymeric macromolecular species or polymer.

56. The method claim 54 or 55, wherein the first polymeric macromolecular species or polymer comprises a protein component.

57. The method of any one of claims 54 to 56, wherein the protein component comprises one or more of silk fibroin proteins or fragments, collagen, elastin, gelatin, corn zein, wheat gluten, pectin, chitin, casein, and/or whey.

58. The method of claim 54 or 55, wherein the first polymeric macromolecular species or polymer comprises a biodegradable polymer.

59. The method of any one of claims 54 to 58, wherein the first polymeric macromolecular species or polymer comprises one or more of a polyurethane component.

60. The method of any one of claims 54 to 58, wherein the first polymeric macromolecular species or polymer comprises a poly lactic acid (PLA) component, a poly(lactic-co-glycolic acid) (PLGA) component, or both.

61. The method of any one of claims 54 to 60, wherein the second composition comprises an unstructured second polymeric macromolecular species or polymer, or a first structure of the second polymeric macromolecular species or polymer.

62. The method of any one of claims 54 to 60, wherein the second polymeric macromolecular species or polymer comprises a cellulose and/or cellulose derivative component.

63. The method of claim 62, wherein the cellulose derivative is selected from methyl cellulose, ethyl cellulose, ethyl methyl cellulose, hydroxyethyl methyl cellulose, hydroxypropyl methyl cellulose, ethyl hydroxyethyl cellulose, cellulose triacetate, cellulose propionate, cellulose nitrate, cellulose sulfate, carboxymethyl cellulose, hydroxyethyl cellulose, hydroxypropyl cellulose, cellulose acetate, cellulose acetate propionate, cellulose acetate butyrate, and microcrystalline cellulose.

64. The method of claim 62, wherein the cellulose derivative is ethyl cellulose.

65. The method of claim 64, wherein the ethoxyl content in ethyl cellulose is from 45.0% to 49.5%, from 45.0% to 46.0%, from 45.0% to 47.0%, from 47.0% to 48.0%, or from 48.0% to 49.5%.

66. The method of claim 64, wherein the degree of substitution of the ethyl cellulose is 0.5 to 1, 1 to 1.5, 1.5 to 2, 2 to 2.5, or 2.5 to 3.

67. The method of any one of claims 62 to 66, wherein the cellulose derivative comprises a first structure of the cellulose derivative having a degree of crystallinity lower than a second structure of the cellulose derivative comprising a degree of crystallinity of between about 5% and less than about 100%.

68. The method of any one of claims 54 to 67, wherein the second composition comprising a second polymeric macromolecular species or polymer further comprises a solvent component.

69. The method of claim 68, wherein the solvent component comprises an alcohol and/or an alcohol derivative.

70. The method of claim 68 or 69, wherein the solvent component comprises one or more of an alcohol, an ether, a ketone, an aldehyde, and/or a ketal.

71. The method of any one of claims 68 to 70, wherein the solvent component is from about 75% w/w to about 99% w/w of the composition, from about 80% w/w to about 98% w/w of the composition, from about 85% w/w to about 97.5% w/w of the composition, or from about 85% w/w to about 95% w/w of the composition.

72. The method of any one of claims 68 to 71, wherein the solvent component comprises one or more of methanol, ethanol, n-propanol, 2-propanol, n-butanol, 2-butanol, pentanol, hexanol, acetone, butanone, methoxypropanol, di-isopropylidene glycerol, 2,2-dimethyl-4-hydroxymethyl-1,3-dioxolane, 2,2-dimethyl-1,3-dioxolane-4-methanol, or any combination thereof.

73. The method of any one of claims 54 to 72, wherein a first composition comprising a first polymeric macromolecular species or polymer further comprises one or more of a polyethylene glycol (PEG) component, a polypropylene glycol (PPG) component, and/or a polyether component.

74. The method of any one of claims 54 to 72, wherein a first composition comprising a first polymeric macromolecular species or polymer further comprises one or more of fatty acid or fatty acid derived amide, and/or a monoglyceride, diglyceride, and/or triglyceride.

75. The method of any one of claims 54 to 72, wherein a first composition comprising a first polymeric macromolecular species or polymer further comprises one or more of a triethylene glycol monomethyl ether component, a diethylene glycol butyl ether component, a diethylene glycol ethyl ether component, a dimethyl tetradecanedioate component, an erucamide component, and/or a glyceryl stearate component.

76. The method of any one of claims 54 to 72, wherein a first composition comprising a first polymeric macromolecular species or polymer comprises one or more of an isocyanate component, a polyol component, a blocked isocyanate component, and/or a blocked polyol component.

77. The method of any one of claims 54 to 72, wherein a first composition comprising a first polymeric macromolecular species or polymer comprises a partially polymerized, partially crosslinked, and/or partially cured polyurethane component.

78. The method of any one of claims 54 to 72, wherein a first composition comprising a first polymeric macromolecular species or polymer further comprises a polyurethane prepolymer component.

79. The method of any one of claims 54 to 72, wherein a first composition comprising a first polymeric macromolecular species or polymer further comprises water.

80. The method of any one of claims 54 to 72, wherein a surface of the substrate is coated first with the first composition comprising a first polymeric macromolecular species or polymer, and the coated with the second composition comprising a second polymeric macromolecular species or polymer.

81. The method of claim 80, further comprising a drying or partial drying step between the two coating steps.

82. The method of claim 80 or 81, wherein the first composition comprising a first polymeric macromolecular species or polymer is only partially polymerized, partially dried, and/or partially cured before the second composition comprising a second polymeric macromolecular species or polymer is applied.

83. The method of any one of claims 54 to 82, wherein the second composition comprising a second polymeric macromolecular species or polymer is applied at a temperature above a glass transition temperature (T_{g}) of the first polymeric macromolecular species or polymer.

84. The method of any one of claims 54 to 82, wherein the second composition comprising a second polymeric macromolecular species or polymer is applied at a temperature above a glass transition temperature (T_{g}) of the second polymeric macromolecular species or polymer.

85. The method of any one of claims 54 to 84, wherein the first composition comprising a first polymeric macromolecular species or polymer is applied one or more times at a rate from about 0.5 mL/ft² to about 5 mL/ft².

86. The method of any one of claims 54 to 85, wherein the second composition comprising a second polymeric macromolecular species or polymer is applied one or more times at a rate from about 0.5 mL/ft² to about 5 mL/ft².

87. An article comprising a substrate and a coating, the article made by a method of any one of claims 54 to 86.

88. The article of claim 87, wherein the first polymeric macromolecular species or polymer is distributed isotropically over a cross section of the coating from a substrate-coating interface to an external surface of the coating.

89. The article of claim 87, wherein the first polymeric macromolecular species or polymer is distributed anisotropically over a cross section of the coating from a substrate-coating interface to an external surface of the coating.

90. The article of claim 87, wherein a concentration of the first polymeric macromolecular species or polymer closer to a substrate-coating interface is higher than a concentration of the first macromolecular species or polymer closer to an external surface of the coating.

91. The article of claim 87, wherein the first polymeric macromolecular species or polymer is substantially undetectable at an external surface of the coating.

92. The article of any one of claims 87 to 91, wherein the second polymeric macromolecular species or polymer is distributed isotropically over a cross section of the coating from a substrate-coating interface to an external surface of the coating.

93. The article of any one of claims 87 to 91, wherein the second polymeric macromolecular species or polymer is distributed anisotropically over a cross section of the coating from a substrate-coating interface to an external surface of the coating.

94. The article of any one of claims 87 to 91, wherein a concentration of the second polymeric macromolecular species or polymer closer to a substrate-coating interface is lower than a concentration of the second polymeric macromolecular species or polymer closer to an external surface of the coating.

95. The article of any one of claims 87 to 91, wherein the second polymeric macromolecular species or polymer is substantially undetectable at a substrate-coating interface.
